(19) United States
(12) Patent Application Publication
(10) Pub. No.: US 2025/0006958 A1
(43) Pub. Date: Jan. 2, 2025

(54) Intelligent Buffered Fuel Cell With Low Impedance

(71) Applicant: Richard K. Williams, Cupertino, CA (US)

(72) Inventor: RICHARD K. WILLIAMS, Cupertino, CA (US)

(21) Appl. No.: 18/756,703

(22) Filed: Jun. 27, 2024

Related U.S. Application Data
(60) Provisional application No. 63/511,384, filed on Jun. 30, 2023.
(60) Provisional application No. 63/513,890, filed on Jul. 16, 2023.
(60) Provisional application No. 63/608,395, filed on Dec. 11, 2023.

(51) Int. Cl. H01M 8/04119; H01M 8/04537; H01M 8/10; H01M 8/1004

(52) U.S. Cl. CPC H01M 8/04126; H01M 8/04559; H01M 8/1004; H01M 2008/1095; H01M 2250/20

(57) ABSTRACT

A buffered fuel cell able to convert fuel such as hydrogen into electricity and concurrently store generated electric charge electrochemically in a low-impedance electrical buffer capable of delivering high currents to a variety of electrical loads without significant voltage sag. A charge transfer regulator controlling energy flow between an array of series-connected or series-parallel connected fuel cells and an electrical buffer limiting fuel cell current densities, controlling charging C-rates, and preventing buffer overcharging. An intelligent system for managing a buffered fuel cell by dynamically matching fuel cell stack voltage to an electrochemical buffer thereby expanding its usable humidity and temperature operating ranges, preventing buffer damage from excessive load currents or improper voltage operation, and actively regulating cell temperature and humidity. Electrical isolated fuel cell modules enabling stacked operation at high voltages, disabling and bypassing unused or redundant modules, and facilitating galvanically isolated electrical charging, voltage balancing, and system communication.

### REFERENCE TO RELATED APPLICATIONS

This application claims the priority of the following: U.S. Provisional Application No. 63/511,384, titled “Intelligent Buffered Fuel Cell With Low Impedance,” filed on Jun. 30, 2023, U.S. Provisional Application No. 63/513,890, titled “Advanced Fuel Cell Design, Apparatus and Fabrication,” filed on Jul. 16, 2023, and U.S. Provisional Application No. 63/608,395, titled “Ion Exchange Membranes and Applications Thereof,” filed on Dec. 11, 2023.

### SCOPE OF THE INVENTION

The invention relates to fuel cells and their roles in primary and secondary power generation, energy storage, and applications thereof.

The foregoing applications are incorporated herein by reference in their entirety.

### BACKGROUND OF THE INVENTION

The availability of clean reliable electrical energy is becoming increasingly important in modern technological society, as it is plays a pivotal role in nearly every activity and industry today. Applications requiring electrical power include computing; communication, networking; and the Internet; transportation; telephony; wired and wireless networks; consumer electronics and entertainment; home appliances; medical devices; security systems; motor drive; satellites; defense; and emergency response. Industries, enterprises, and personal uses relying on electrical power are far ranging, including business, commerce, and banking; residential and commercial buildings; infrastructure; factories and heavy industry; farming and agriculture; biotech and medtech; semiconductors and electronics; avionics, aircraft, airlines, and space travel; boats, ships; trains and rail transport; automobiles and trucks; motorbikes, all terrain vehicles (ATVs) and scooters; hospitals, clinics, and healthcare; computer and server farms; and more. Even electrical power generation requires electricity to manage control functions.

Primary Power. The source of power this myriad of electrical applications can be categorized into two classes: primary power and secondary power. Primary power is a fundamental source of energy occurring in nature and converted into electricity generally using mechanical motion of turbine turning a generator. A generator converts rotary or in some cases linear motion into electric current in accordance with Faraday's law by juxtaposing a magnet and a coil. In operation, one of the two elements, either the coil or the magnet is constantly moving relative to the other element, thereby magnetically inducing electric current in the coil. The output of a generator, i.e., the current induced in the conductive coil, may be alternating current (AC) or direct current (DC). A variant of a generator, called an alternator, produces only AC.

The force producing kinetic movement of a generator rotor may come from a variety of sources including thermal energy used to boil a fluid to turn a turbine. Primary power thermal sources include natural heat (geothermal, concentrated sunlight); chemical reactions or burning of fossil fuels releasing heat including coal, natural gas, refined oil products, and biofuels; or nuclear reactions used to generate heat via fission of heavy atoms (or potentially fusion of hydrogen). All primary power sources suffer from some major limitation. In primary power generation the burning of fossil fuels, especially coal, is largely responsible for most air pollution and anthropogenic carbon dioxide releases. Among fossil fuels, natural gas represents the cleanest source of power.

Although nuclear power is free of greenhouse gasses, the disposal and storage of nuclear waste represents a significant environmental challenge and safety risk. Another major issue with present day liquid-cooled nuclear plants is their need to be located near large bodies of water such as rivers, lakes, and oceans. Unfortunately, uncontrolled heating of the nuclear core, nuclear meltdown, can irrevocably contaminate water supplies causing radiation poisoning and cancer in residents, and poison livestock, fish, vegetables, and other food stuffs. Notorious nuclear disasters include the Three-Mile Island and Chernobyl Ukraine.

Another serious risk of nuclear power plants being located on the ocean is the risk of tsunami damage to the reactor facility itself. For example, on Mar. 11, 2011 the Fukushima nuclear disaster in Tohoku Japan occurred as a result of 9.1 magnitude quake followed by 14 meter high tsunami. The tsunami damaged the emergency generators causing backup power loss to circulating coolant pumps resulting in the nuclear meltdown of three nuclear cores. The cascade of failures simultaneously killed two people from radiation, burned 16 persons from hydrogen explosions, and released 18,000 terabecquerel (TBq) of radioactive caesium-137 into the Pacific during the accident. Since this event, much of the world are now decommissioning nuclear fission power plants.

As a safer cleaner alternative source of energy, the kinetic motion of fluids (wind, falling water, ocean waves) may be converted into electricity using a turbine and generator. Falling water also referred to as hydroelectric power is however limited geographically to rivers and lakes, including artificial lakes creating by dams. Although the hydroelectric energy production is carbon free, the use of dams is opposed by many environmentalists for disrupting wildlife and destroying wildlife habitats. Recently modern wind farms located in windy offshore locations have come under increased scrutiny for causing whale beachings and bird deaths.

Geothermal power is also geographically limited, specifically to within the vicinity of volcanos and hot springs where magma penetrates the mantle into the earth's upper crust. Unfortunately, volcanos are often associated with magmatic and tectonically active areas where earthquake risk and steam explosions must be considered as a safety hazard.

Solar energy, harvesting energy from sunlight, comes in two forms—thermal-solar power generation and direct photon conversion. In thermal-solar plants sunlight is focused by mirrors to a central boiler used to generate steam and drive turbines producing AC power. Despite its theoretical potential, commercial deployment of thermal-solar power production has proven to be technologically and economically unviable. Firstly, thermal-solar power generation requires large tracts of land where sunlight is plentiful and the sky is consistently free of clouds. As land is expensive, most thermal-solar power facilities must be located in deserts far from population centers. The long distance delivery of electrical power is however extremely problematic, especially using AC transmission.

Further complicating matters, diurnal temperature variations in dessert climates are extreme, ranging from below freezing in the night hours to over 55° C. (130° F.) by the afternoon. These large daily excursions in operating temperature have been found to damage mirrors, warp metal, and damage equipment resulting in unmanageably high repair and maintenance costs. As such several large projects solar-thermal projects have been abandoned. The alternative, centralized power generation via direct energy conversion of sunlight using photovoltaic (PV) cells for is similarly uneconomical, requiring vast swaths of land covered by expensive solar panels. Using cheaper land located far from metropolitan areas is even more problematic than solar-thermal farms as PV cells produce direct current, not AC power. High-voltage DC power transmission over large distances is currently too complex and expensive to be considered a viable technology for primary power.

A better alternative is to employ photovoltaic power generation, not as primary power for the electric grid, but locally as residential power generation for personal use. While the use of solar panels placed atop houses, apartments, and garages is becoming popular, it too faces serious technology and commercial challenges. Specifically, most residential solar owners use a solar inverter to convert DC into AC and to dump the power they generate back into the AC power grid receiving billing credits for “negative” power flow. This practice is intrinsically flawed and limited in its ability to scale. Firstly, like wind generation, solar power varies unpredictably with weather patterns and with cloud cover resulting in intermittent power unable to ensure a steady rate of power. Intermittent power can cause noise, power factor fluctuations, and destabilize the power grid impacting power quality for all users.

To offset the destabilizing impact of client-generated intermittent solar power, power utilities are forced to generate more AC power to mitigate transients and maintain a constant frequency for transmission. This action requires the utility burn more fossil fuels to counteract the intermittent power with generator power. Ironically, the more renewable energy is fed into the power grid, the more fossil fuel must be burned to compensate to create the grid working. As a result, many utilities no longer give credits to users for the power they generate. Instead, home owners and apartments are being asked to locally store the energy they generate.

The need for local power storage is part of even a broader topic—peak electrical demand management. A principal issue with primary power is the difficulty of synchronizing power generation with power consumption. Specifically, when power is plentiful, energy consumption may not be sufficient to utilize the generated power, causing power to go wasted. Conversely in times of peak demand, e.g., in the early evening, renewable sources such as solar are not be available, forcing increased production using fossil fuels causing pollution and requiring higher current handling capacity of power transmission lines.

In such instances, it is preferable to deliver power to local sub-grids off peak hours and to store it locally. Stored energy is referred to as secondary power. Secondary power and local storage offers numerous benefits. First, it reduces the ratio of peak power to average power carried by transmission lines comprising the power grid. When users demand more power, they are able to draw it from local storage rather than drawing it from the power plant. Secondly, local power storage provides a degree of redundancy in case the main grid suffers a brownout or a power failure. Lastly, local power storage acts as a buffer minimizing line voltage perturbations caused by non-sinusoidal power sources such as renewables. Secondary power may be stored in a variety of forms, not necessarily only using battery storage.

Secondary Power. The storage of power for subsequent use is referred to a secondary power. Once generated from primary sources, energy may be stored as electric charge or converted into a form of potential energy in gaseous, gravitational, or chemical form. For example, primary power may be used to pump water to a large container at a higher altitude storing energy gravitationally. When needed, the water is allowed to fall from its container using gravity to accelerate the fluid into a steady stream. The falling water is then used to turn a turbine and AC generator to produce electricity in a manner similar to hydroelectric power.

Similarly primary power can be stored hydrostatically as a pressurized air for subsequent use. In this case a pump powered by a primary power source is used to compress air to store in a container at an elevated pressure, typically several hundred times that of normal atmospheric pressure. When needed, the compressed air is released at a control flow rate turning a turbine and generator to make electricity for use. While both gravitational and pressurized gas can be used for local energy storage on a power grid, factory, building, or home, these forms of power storage are not portable. Less common energy retention and secondary power generation may employ temporarily stored energy comprising heat held in insulated containers or retained as momentum in large flywheels.

Another class of secondary power is chemical storage. In chemical storage, primary power can be used to separate chemicals into ions, reactive compounds, molecules, or elements. These components can be later converted into electrical power. The most common method of chemical energy storage is the use of an electrochemical cell known as a battery. In a battery reactive cations such as inorganic monovalent lithium ions are transported through the semipermeable separator propelled by an externally applied electric field. Delivered by a DC power supply called a charger, the applied electric field transfers power into the cell converting electrical energy into stored chemical energy. During charging, cations are transported across a semipermeable separator membrane accumulating on the anode electrode and increasing the cell voltage until the battery is fully charged. Once charged, the separator maintains the electrochemical potential between anode and cathode with minimal self-discharge leakage. The maximum stored charge and maximum cell voltage are limited. Exceeding this maximum voltage by overcharging may result in fire or explosion.

To recover power stored in the battery, an electrical load is connected across the cell's anode and cathode electrodes resulting in current flow in the battery, a process referred to as discharging. During discharge, electrons are removed from the anode flowing into the load. Concurrently, a corresponding number of cations must flow back across the separator to the cathode in order to maintain charge neutrality. This process discharges the battery lowering the electrochemical potential of the cell. In the case of lithium ion batteries, over-discharging of the cell may result in permanent cell damage subsequently leading to fire and possible explosion.

Another type of chemical storage is the process whereby electric power is used to form fuels or volatile chemical compounds to be used later for power generation. One such approach, called P2G or power-to-gas, employs electrolysis of water to produce hydrogen. The hydrogen may be used immediately to create electricity; stored in a pressurized canister for later use; or converted into another heavier fuel compounds such as syngas, methane, or liquid petroleum gas (LPG). These gasses may be stored, transported, and subsequently converted into electricity using conventional generators such as gas turbines.

Aside from electrolysis, hydrogen may also be produced from direct solar water splitting; thermochemical; and biological processes. Specifically, during direct solar water splitting also known as photolytic conversion, hydrogen is produced from water using sunlight and specialized photoelectrochemical semiconductors. In direct photolytic conversion, absorbed light energy dissociates water molecules into hydrogen and oxygen. Alternatively, in photolytic biological systems, microorganisms such as cyanobacteria or green microalgae absorb sunlight as a driver to break down organic matter, releasing hydrogen. Thermochemical hydrogen production involves converting various fuel sources such as natural gas, biomass, or coal through a thermal process to release hydrogen from their molecular structure. Examples include natural gas reforming aka steam methane reforming, biomass gasification, biomass-derived liquid reforming, and solar thermochemical hydrogen. Biological hydrogen production includes microbial biomass conversion and photobiological conversion.

Aside from its use a fuel source for heating, hydrogen may be converted directly into electrical current using a hydrogen fuel cell with water as a byproduct of the chemical reaction. Although many different types of fuel cells are available for a wide range of applications, the most promising category of fuel cell is the proton-exchange-membrane or polymer-electrolyte-membrane fuel cell, with the acronym PEM FC. Well suited for portable and transportation applications, the PEM layer acts as an electrolyte to control proton transport after catalytically splitting hydrogen atoms into a hydrogen ion and an associated electron. A key requirement of the membrane is to allow proton conduction without allowing gas exchange of hydrogen and oxygen isolated in cathode and anode chambers.

Comparing the diversity of secondary power sources available today, the lithium ion battery and the PEM hydrogen fuel cell represent the best prospects for secondary power generation and energy storage, especially in transportation and portable applications. Each technology however suffers from a number of challenges including fire risk and safety considerations.

Lithium Ion Battery Technology. By far the most common form of energy storage involves the use of batteries. A battery is an electrochemical cell that once fabricated is able to absorb and retain energy through a process referred to as “charging” and to release the stored energy later to power an electrical load, a processes referred to as “discharging.” Despite their ubiquitous use, batteries suffer numerous limitations and intrinsic weaknesses, including the following:
After discharging, a battery must be recharged to a substantial charge state before reusing, a process which takes time during which an electrical vehicle cannot be driven, home battery backup power is lost, and electronics are inoperable or operate with diminished function.
Cycle life of a battery is reduced by repeated charge-discharge cycles where the total capacity at full charge diminishes over time. All batteries, even the popular Li-ion battery suffer limited cycle-life. Eventually the battery life becomes so limited the entire pack must be replaced, often at a price higher than the product using it.
Some batteries such as the lead-acid battery used in motor vehicles contain caustic chemicals or acids as an electrolyte representing a contact safety risk to users and first responders.
The manufacture of batteries includes hazardous, caustic, and flammable materials, especially chemistries involving group-I elements in the periodic table such as lithium. Factories have burned to the ground in Japan and in China from lithium fires.
Some batteries such as the Li-ion battery, contain highly volatile chemicals as electrolytes that if leaked from the cells or over-heated, may smolder, catch on fire, or in extreme circumstances explode. Reports of battery smoke and fire disabling vehicles such as aircraft, electric vehicles, notebook computers, and cell phones appear commonly in media publications. In extreme cases, battery fires may result in death or permanent burn injury.
Research on fire resistant cell construction using solid state lithium ion batteries, where the liquid electrolyte is replaced by a ceramic material continues. Although reported energy densities have improved, serious material and performance issues persist including high contact resistance between conductive electrodes and the ceramic electrolyte, and significant changes in battery characteristics when exposed to air and moisture.
To protect against accidental or intentional misuse of a battery, active protection electronics must be integrated into battery cells and into the battery pack system including protection electronics to prevent overcurrent, overvoltage, and over-heating and to maintain balanced cell voltages. Other protection mechanisms include a pressure release valve. In the event pressure builds up in the battery enclosure (metal can) containing the electrolyte from over heating, the battery vents the excess fumes to reduce the risk of explosion. Another protective feature is the use of a heterogeneous bi-layer separator that reduces or impedes current as a cell heats. This novel separator construction comprises pores which penetrate a separator comprising polymers or plastic layers having different coefficients of thermal expansion, i.e., dissimilar TCEs. While at room temperature, the pores align allowing the full degree of current to flow across the membrane, at elevated temperatures the pores misalign restricting ion flow thereby reducing heating.
Batteries are heavy relative to the amount of energy they store—performance measured by a parameter called gravimetric energy density, i.e., battery energy per weight. Cell weight is generally dominated by cobalt and nickel used in their construction of the battery cathode electrode followed by the graphite used in the anode in Li-ion batteries. The weight of the Li-ion battery pack in an electric vehicle can range from 450 kg to 900 kg (1,000 to 2,000 pounds) depending on vehicle's range. Although increasing a vehicle's battery capacity commensurately extends its per-charge driving range, the added weight unavoidably offsets the benefit of the additional storage.
The manufacture of lithium ion batteries involves a significant adverse environmental impact in all phases of production including mining and extraction, purifying and processing, along with recycling and disposal. Effects include ground, air, and water pollution along with habitat destruction. Ground and water pollution includes heavy metals and toxins leaching into waterways and aquifers. Air pollution includes gaseous byproducts of chemical refining as well as CO₂ from mining equipment and electric power generation needed by battery factories.
Production of lithium ion batteries has a significant carbon footprint. The term CO₂e describes all the carbon released during the entire Li-ion battery production process where the subscript “e” denotes the term effective or equivalent estimated to be 73 kg CO₂e/kWh. This upfront consumption of energy used to mine and process raw materials and manufacture an EV battery pack means that a new electric vehicle starts at a carbon disadvantage compared to gas powered internal combustion engine, then makes up the initial deficit with each year of use. See discussion to follow.
The mining and production of lithium batteries has been criticized for their inhumane and unethical supply chain management including forced labor, child labor, and other forms of economic conscription of impoverished peoples. The United Nations and Amnesty International are seeking to combat the problem by attempting to pressure reform of the entire supply chain starting in the mines of the Democratic Republic of the Congo; in the cobalt smelters in China; in the battery manufacturers in China, Japan, and South Korea; and by promoting consumer awareness for change in the global consumer electronic and EV markets, especially in the USA, EU, and UK. Although Li-ion battery pack costs have declined significantly since 2008, coupling surging demand with improved pay and working conditions for those in the battery trade is expected to reverse this trend leading to increased battery costs.
The raw materials used in lithium ion battery manufacture are concentrated in certain countries including China and Russia. As energy is considered a strategic component of national security by most countries, the supply chain for sourcing ores and salts used in lithium ion production now carries geopolitical considerations.

A key application of the lithium ion battery is in electric vehicles or EVs. To fully assess the environmental benefit of a battery EV we must consider the total green house gasses emitted during both manufacturing and use. Of the 73 kg CO₂e/kWh total carbon dioxide produced during battery manufacturing, roughly 40% or 28.5 kg CO₂/kWh occurs during mining, conversion and refining of the nickel-cobalt-manganese NCM powder. The second most energy-demanding activity, cell production, requires 14 kg CO₂/kWh or 20% to power drying and heating in the manufacturing process. The third largest impact on greenhouse gasses is aluminum refining. An intrinsically energy intensive process, aluminum production is responsible for 12.4 kg CO₂/kWh or 17%. Another 6.8% is used to fabricate associated pack electronics with an added 5% consumed in producing the battery's graphite anode. The high carbon footprint is largely tied to the fact that China, a major battery producer derives 60% of its electric power from coal. Given a 73 kg CO₂e/kWh dependence of released carbon during manufacturing, the net carbon footprint for an eV battery with a range of 40 kWh (e.g., Nissan Leaf) is 2920 kg, while a 100 kWh (e.g., Tesla) requires 7300 kg of CO₂.

Unlike internal combustion engines which burn gasoline and release CO₂ and other pollutants, greenhouse gasses from an EV come not from the vehicle itself but from the power production needed to charge the EV battery. As a reference, the US DoE reports conventional gasoline fueled engines emit 2.4 kg CO₂e for every 10 km travelled. In contrast, studies report EVs emit 1.0±0.5 kg of CO₂e, i.e., from 5-to-15 kg per every 10 km travelled, depending on how and where the electricity used to charge the EV battery is produced. This means the beneficial reduction in CO₂ emissions ranges from 0.9-to-1.9 kg for every 10 km driven with a nominal saving of 1.4 kg for typical electrical grids used for charging. For an average driving distance of 25,000 km (15,500 miles) per annum, a combustion engine releases 6,000 kg (6 metric tons) of CO₂ while an EV emits 2,500 kg or 2.5 metric tons.

This means an EV reduces carbon emissions by 3,500 kg (3.5 metric tons) per annum per driver with a net savings of 60%. Considering as described previously, an EV's initial carbon footprint is 4-to-7 metric tons larger than a gasoline engine at manufacture, and that EVs save 3.5 metric tons of CO2e per annum, it means the break even point where an EV becomes “greener” than a gasoline engine occurs between 1-to-2 years of use. After 5 years use, a gasoline engine has released 30 metric tons of carbon dioxide while an EV has emitted an average of (5.5+5·1)=10.5 metric tons including the 5.5 metric ton initial offset due to battery manufacturing pollution. As such, over the lifetime of the car, an EV reduces greenhouse emissions by two-thirds.

Unfortunately, the ecological damage of mining and high volume manufacturing of Li-ion batteries cannot be measured by CO₂ emissions alone. As such efforts continue to find viable alternatives to the ubiquitous Li-ion battery.

Li-lon Battery Electrical Operation. The dynamic or time-dependent behavior of lithium ion cells involves the flow of electrons in a battery circuit and corresponding changes in the electrochemical and states within the cell corresponding to conduction. Normally, batteries alternate in three states of operation:
Charging: Conducting current in response to an external circuit comprising an electrical source power which increases the charge Q stored in the electrochemical cell, i.e., converting kinetic electrical energy into chemically stored potential energy.
Discharging: Conducting current in response to an external circuit comprising an electrical load which decreases the charge Q stored in the electrochemical cell, i.e., converting chemically stored potential energy into kinetic electrical energy.
Storage: The condition when a battery is electrically disconnected from any external electrical circuit whereby the charge Q stored in the electrochemical cell and the electrochemical potential therein does not change over time except for small changes in the internal electrochemical charge state within the battery itself (known as self-discharge).

In general, current in a battery varies as a function of time, i.e., I=f(t). Time variations in cell currents occur because most electrical networks to which a batteries are connected exhibit both transient and oscillatory properties, depending on operating mode of the system. These conditions arise when a battery is connected or disconnected to a power source (such as an AC-to-DC adapter), when an electrical device (like a cell phone) is turned on, or when the supply or demand of current in the battery naturally has time varying or reactive components.

An example of the transient behavior of current conduction in battery is shown in FIG. 1 where a battery pack 2 in circuit 1a containing one or more Li-ion cells 3 is connected in series with an electrical load represented by resistor 5 having a value R_{load} and capacitor 6 having capacitance C_{load}. For simplicities sake we will assume in this scenario the battery is already charged and capacitor 6 has no charge on it.

As shown in graph 1b, so long that switch 4 remains open, no current flows and I_{discharge} =0 as shown by line segment 10a. Once switch 4 is closed the current rapidly rises 10b from zero amperes to some momentary peak value 10c and then begins to decline 10d to a steady state value 38e. The excess current flowing (above the steady state value) is referred to as an inrush current. Current inrush can result from reactive components such as capacitance or from time varying resistances (e.g., a light bulb filament).

In many cases the peak inrush current is limited by resistance intrinsic to the battery pack itself and within the lithium ion cell's internal construction. The final steady-state current is typically modelled in simplified form by Ohms law as I_{discharge}=V_{bat}/R_{load} even though resistor 5 may represent a complex circuit or system such as a cell phone, tablet, notebook computer, or even an entire automobile. Although inrush currents are generally short in duration and unable to cause damage to the battery, too high of a peak current could inadvertently trip protection circuitry in the battery pack interrupting normal startup operation of the system. Another concern is how can battery protection electronics distinguish between transient inrush current and a dead short across the battery? While extended durations of excess battery currents may result from shorted component failures, other “virtual shorts” may include a motor with a stuck rotor, the flash-over current occurring during lighting of a gas discharge tube, or connecting a large array of discharged batteries in parallel with a charged battery pack (battery to battery charging).

FIG. 2A illustrates motor drive circuit 12a comprising battery pack 2 containing one-or-more series connected Li-ion cells with switch 4 and motor 12. Although switch 4 is shown as a simple idealized component in many instances it will comprise a low-resistance power metal-oxide-semiconductor field effect transistor, aka MOSFET. Since a motor is an electromechanical machine, circuit 11b represents the electrical equivalent model for a motor by equivalent circuit 12 comprising winding resistance 15 with resistance value R_{W}, winding inductance 13 with inductance value L_{w}, and back emf 14. Back emf, a phenomenological description of electromagnetic force represents an opposing voltage proportional to the motor rotational velocity ω, where V_{emf}=kₘω and where kₘ is the motor constant.

In FIG. 2B representative current I_{M}(t) and voltage V_{emf}(t) waveforms shown in graph 11c are contrasted against motor rotational velocity ω(t) in graph 11d. As shown before switch 4 is closed, motor current 25a is zero, motor rotational velocity 20a is zero, and back emf motor voltage 21b is zero. As soon as the circuit is completed and because the motor has not started turning, i.e., co(t)=0, current 25b jumps to a value Iₚₑₐₖ=V_{bat}/R_{w}. This situation exists until the magnetic field exceeds the inertial force from the static coefficient of friction, aka stiction, until the instant 21 rotation commences at time tᵣ. Thereafter, the motor rotational velocity 20b rises to a steady state speed ω where the motor torque balances the mass loading the rotor. Correspondingly the motor voltage rises to a steady state voltage V_{emf} slightly below the battery voltage 22 with value V_{bat}, specifically where voltage difference 24 is given by the formula ΔV=V_{bat}−V_{emf}(t). This voltage difference in turn along with the winding resistance R_{w} determines the motor current 25d, specifically where I_{M}(t)=ΔV/R_{w}.

FIG. 3 contrasts battery charging to discharging. As depicted schematically, charging is achieved by connecting the positive terminal of power source 30 to the positive (cathode) terminal of Li-ion cell 3 allowing conventional current I_{charge} to flow clockwise from the power source into the cathode of the battery. By definition, electron conduction e⁻ in the circuit's conductors flow in opposite direction, i.e., counter-clockwise.

Conversely, discharging is achieved by connecting electrical load 31 (depicted as a resistor) across the positive (cathode) to the negative (anode) terminals of Li-ion cell 3 allowing conventional current I_{discharge} to flow counter-clockwise from the power source emanating from the cathode of the battery and dissipating power in electrical load 3. By definition, electron conduction e⁻ in the circuit's conductors flow in opposite direction, i.e., clockwise.

The charging and discharging processes can be better understood by considering the electrochemistry of a lithium ion cells. More precisely, the cells themselves follow the same basic electrochemistry of a coupled redox reaction comprising concurrent oxidation and reduction in opposite halves of the cell. As shown in FIG. 4, a lithium ion battery comprises two electrodes of differing composition called an anode 35 and cathode 36 sharing a common enclosure 33 and immersed in a conductive liquid or gel called an electrolyte 34. Anode 35 connects to the external circuitry through electrode anode 32a. Cathode 65 connects to the external circuitry through electrode cathode 32b.

To limit the reactions to electrochemical ion exchanges, and not to purely chemical processes, the two cell halves are separated by a porous membrane called a separator 37. The separator, often made of a polymer sheet, contains pores large enough to allow lithium ions 39 to flow from chamber to chamber during charging or discharging. The pores are however sufficiently small as to prevent molecular transport across the barrier (except in the event of a tear or melting on separator 37, a destructive and potentially dangerous failure mode).

During discharge as illustrated by resistor 31 externally connecting cathode 32b and anode 32a, current I_{discharge} flows from the cell and through the resistor, dissipating energy as heat in the resistor and generating heat in any parasitic resistive elements in the cell. The chemical reaction occurring during discharge is exothermic, producing additional heat not related to Joule heating in the metallic electrodes. The actual direction of current flow in battery often confuses many people. Following conventional electrical notation, during discharging positive charges flow internally with the electrochemical cell from the anode and flow externally from the cathode (labelled with a +sign) to the anode (labelled by a − sign) to form a single continuous loop of current.

While it is true that Li⁺ ions, ionized lithium atoms 39, comprise positively charged ions, the lithium ions never leave the battery, instead forming lithium oxide complexes 38 within cathode 36. But since metallic electrodes and copper wires do not contain mobile positive charges, how can positive current flow in them? The simple answer is it doesn't.

Instead, conduction in metals is limited to electron flow (denoted by e⁻) in equal amount but opposite in direction to the current flow convention. That means during discharging, current external to the battery flows from the battery's negative anode terminal toward the battery's positive cathode terminal in the form of electrons, not positive charge. But Kirchhoff's current law, a variation of charge conservation, states that the total current flowing into a node must always equal zero, expressed algebraically as

$${\sum }_{k = 1}^{n} {I}_{k} = 0$$

This means positive charging flowing into the cathode must equal positive charge flow out. But another way to interpret the meaning of positive charge flowing out is to consider the current as negative charge (aka electrons) flowing into the node. Charge conservation states that since charges are neither created or destroyed the total charges must balance to a net zero. The manifestation of the charge conservation principle become self evident by inspection of the electrochemical reaction at the cathode for a lithium ion battery given by

Li₁₋ₓCoO₂+xLi⁺+e⁻→LiCoO₂
where a lithium metallic cathode comprising Li₁₋ₓCoO₂ is converted to LiCoO₂ by absorbing both positive charged lithium ions xLi⁺ and an electron e⁻. During the reaction the lithium ions are supplied to the cathode by charge transport across the separator and through the electrolyte while the electron is donated from the wire carrying negative charges into the battery's cathode terminal.

Concurrently at the carbon-lithium anode CLiₓ electrons e⁻ are released into the wire and lithium ions xLi⁺ are released into the electrolyte, where C is the chemical symbol for elemental carbon:

CLiₓ→C+xLi⁺+e⁻
thereby balancing the charges in the cell to a net zero change. Since the charges balance to zero, in doesn't matter that charge transport involves two different mechanisms—positive charge flow (lithium ions) inside the cells and electron flow outside the battery. Regardless the magnitude of current conduction in the loop (measured by coulombs per second, i.e., milli-amperes) is the same in the wire, the resistor, or the cell.

Therefore, the arbitrary adoption of positive charge flow as the standard definition of conventional current conduction offers the same mathematical precision and utility as a more detailed physics based mechanistic description but without the added complexity. Regardless, semiconductor physicists and battery chemists often casually intermix the current and electron flow terms without identifying the charge polarity or flow direction as it is self evident to those in the art.

In summary, during discharge a lithium battery converts stored energy into conduction current by converting CLiₓ into C at the anode and concurrently changing the metallic Li₁₋ₓCoO₂ into LiCoO₂ at the cathode. Since these compounds are in limited supply, the total charge Q available to power an electrical load by discharging the electrochemical cell is finite as given by the relation:

Q=∫ₒ^{t}Idt

While physicists measure charge in Coulombs (symbol Q), in battery powered electronics it is more useful to report a battery's capacity in milliamp-hours (mAh) or ratiometrically as C-rate where 1 mAh=3.6 coulombs. Care should be taken not to confuse the chemical symbol C meaning elemental carbon in chemical reactions with its use as the symbol C meaning coulombs, and also with its use as capacitance (where C is both a mathematical variable and a schematic element label).

Theoretically, charging a lithium ion cell should induce chemical reactions precisely the inverse to discharging, where during charging the anode must absorb electrons according to the reaction

C+xLi⁺+e⁻→CLiₓ

During charging electrons are supplied by power source 30 having its positive terminal connected to the battery's cathode (+terminal) and its negative terminal connected to the battery's anode (− terminal). Concurrently during charging lithium ions flow inside the cell through the electrolyte and across the separator from the cathode 36 to the anode 35. The resulting reaction at the cathode during charging comprises

LiCoO₂→Li₁₋ₓCoO₂+xLi⁺+e⁻

The thermodynamics of charging in endothermic, electrochemically the cell absorbs heat from its surroundings becomes cooler in temperature. This cooling effect is however offset by Joule heating in the electrodes carrying the charging current. In general, for a healthy Li-ion cell charging occur at a cooler temperature than discharging. Since the charging equations mirror the discharging equations, meaning the products and reactants are swapped (i.e., the arrow direction is flipped), then charging and discharging of a lithium ion battery represent a reversible electrochemical reaction. Because however, the thermodynamics of these two operating modes differ, the charging and discharging reactions occur at different rates and at different temperatures.

In both charging and discharging the amount of current flowing varies with time depending on load or power source connected to Li-ion cell, the construction of the battery and its capacity, and the cell's age. A battery's age is not simply measured in calendar years, but by cycle-life, the number of times the cells are repeatedly charged and discharged.

If the electrochemical reactions described previously were truly reversible a battery's cycle life would be unlimited, at least until its metallic electrodes corroded. But because the reactions are not purely symmetric, small changes in a cell's stoichiometry occurring within each charge-discharge cycle results in small but irrevocable changes in electrochemistry, even if electrical operation is limited to the manufacturer's specified operating conditions. Conditions affecting battery cycle life include rate of charging, discharging currents including surge currents, temperature during charging, temperature during discharging, depth of discharge, storage conditions, and state-of-charge (SoC) during storage.

To depict and model the electrical behavior of the cell, it is common to used a schematic referred to as a lumped element circuit model. In a lumped element model, electrical behavior are combined into simple elements such as resistors, capacitors, and voltage sources even though the physical mechanisms are distributed throughout the cell or over distance. Phenomena like polarization my also be modelled as a counterposing electrical potential offsetting a fixed potential even though it is describing voltage variations of an electrochemical process.

One simplified model shown in FIG. 5 combines two time-invariant elements with two dynamically-changing components, namely two voltage sources and two resistive elements. Specifically, the energy stored electrochemically is represented as a constant independent voltage source 40 having an open-circuit voltage V_{OCV}. Resistor 44 is also time invariant, modelling the series resistance of the electrodes within the cell having a lumped resistance value R_{ohmic}.

The other two components are dynamic including cell polarization voltage source 42 with time and frequency dependent voltage Vₚ(t) and dynamic cell polarization resistance 43 having an aggregate distributed resistance R_{cells}(t). Together these two time and frequency sensitive elements appear as a dynamic impedance Z(t) shown as subcircuit impedance 41. The terminal voltage V_{bat} of the single Li-ion cell as a function of current is then given by the relation

$${V}_{bat} = {V}_{OCV} - {V}_{P} - I \cdot ( {R}_{cells} + {R}_{ohmic} )$$

where −Vₚ−I·(R_{cells}) represents a dynamic (i.e., time-dependent) voltage drop affected by frequency and I(t). The total non-reactive component of resistance Rbat is therefore the real component of impedance as given by R_{bat}=(R_{cells}+R_{ohmic}). All of these components both real and reactive depend strongly on the cell's state of charge (SoC) a description of the ratio of the current cell charge Q (above the minimum charge Qₘᵢₙ) divided by the cell's full capacity charge Q_{capacity} where

$$SoC = ( Q - {Q}_{min} ) / {Q}_{capacity}$$

where Q_{capacity}=Qₘₐₓ−Qₘᵢₙ. For cases where Qₘᵢₙ<<Qₘₐₓ then

$$SoC = ( Q - {Q}_{min} ) / {Q}_{capacity} \approx Q / {Q}_{max}$$

For example, a 2500 mAh capacity cell holding 1000 mAh of residual charge has a SoC of 40%. As shown in the exemplary graph of FIG. 6 the open circuit voltage V_{OCV} 46 varies from 3.2V to 4.1V depending on the cell's SoC and chemistry. While some Li-ion cells exhibit a peak SoC voltage of 4.1V or 4.2V other chemistries employing different cathode metals only reach 3.6V to 3.7V. The polarization voltage V_{P} 45 shown in the same graph on the rightmost y-axis remains relatively constant at 30 mV until SOC drops below 10%, then rises sharply to 160 mV indicating cell chemistry changes significantly when deeply discharged.

This observation is further supported by considering a cell's ohmic resistance R_{ohmic} as a function of SoC shown in FIG. 7A. As shown the ohmic resistance during charging 47 is a constant 3.5 mΩ until SoC falls below 40% then rises linearly to 3.9 mΩ at 10% then jumps 41% to 5.5 mΩ. The effect of SoC on ohmic resistance during discharge 48 is even more pronounced than during charging, with R_{ohmic} exceeding 4.5 mΩ below 40% and doubling in resistance at 25%. This means the surge current capability is halved when a cell is discharged below a quarter of its rating.

A Li-ion cell's open circuit voltage V_{OCV}, also referred to as its cathode voltage, depends on the construction and composition of its electrolyte and electrodes. For example, a LiFePO₄ based cell fully charged to 3.5V achieves gravimetric energy densities up to 140 mAh/g. In contrast LiNi_{0.8}Co_{0.2}O₂ based chemistries exhibit voltages of 3.7V but when charged to higher energy densities of 200 mA/g increases to 4.2V. Energy densities also depend on crystalline structure. LiCo₂ and NMC with (111) crystal orientation both exhibit voltages between 4.0V and 4.2V while LiMn₂O₄ exhibits highest voltage at 4.25V at energy densities of 120 mAh/g.

Charging above these voltages can lead to catastrophic cell damage, overheating, smoke and fire. But since the voltage at full charge varies by cell chemistry, there is no way to design protection circuitry to prevent dangerous overvoltage conditions on all cell types. For example, protection for LiCo₂ cell at 4.2V cannot prevent fire for LiFePO₄ whose maximum safe voltage is 3.5V. For these safety risks, Li-ion cells cannot be sold and used in loose form like NiCd, NiMH, and alkaline batteries. Instead, each Li-ion cell must be assembled into a “battery pack” containing the cell and its corresponding protection circuitry.

The protection circuitry is designed to avoid a variety of failure modes including overvoltage, undervoltage, overcurrent, over-temperature, etc. In this sense, the safe use of Li-ion cells, both during charging and discharging is neither simple nor obvious as it depends on cell chemistry, material selection, and cell construction.

Since batteries vary by size and storage capacity, when comparing charging and discharging properties of cells it is convenient to use stored charge rather than current. If we consider the charge contained within a battery as charge Q measured in coulombs denoted by the capital letter C and that Q=I·t where I measured as amperes is defined as 1 A≡1 C/sec then a coulomb may also be expressed in terms of ampere-hours simply by adjusting time t by the conversion factor that 1 hour=3600 secs. When expressing Q not a coulombs but in units of A-hr or mA-hr, then current can be designated by the term “C-rate” algebraically represented as

$$C - rate = {Q}_{capacity} / t$$

As such, the C-rate of a battery is the total charge capacity of the battery (measured in mAh) normalized by time (in hours). For example, at a C-rate of 1C a battery having Q_{capacity}=1000 mAh battery will deliver 1000 mA for one hour. At a C-rate of 2C the same battery can deliver 2000 mA for 0.5 hours. Similarly, at a C-rate of 0.5C, a battery can deliver 500 mA for 2 hours, a C-rate of 0.2C can deliver 200 mA for 5 hours, and a C-rate of 0.1C can deliver 100 mA for 10 hours. Reformulating the prior C-rate equation

$${Q}_{capacity} = t \cdot C - rate$$

The hyperbolic relationship between C-rate and time becomes self-evident whereby discharge time is inversely proportional to C-rate with the constant of proportionality being the battery's charge storage capacity Q_{capacity}.

The advantage of describing battery capacity by C-rate is that it scales with current, making it convenient to determine how quickly a particular battery takes to charge or discharge as a ratio of current to its capacity. Since in physics charge is a conserved quantity, then C-rate can be considered a path independent state variable valid regardless of whether current is constant or time varying. This is important because Li-ion and many other battery chemistries must operate in a specified range of charge states designated as Qₘᵢₙ and Qₘₐₓ. Charging the cell above Qₘₐₓ or discharging it below Qₘᵢₙ can lead to cell damage and potentially cause overheating, fire, or explosion.

FIG. 7B summarizes the relationship between stored charge Q_{capacity}, state-of-charge (SoC), discharging time t, and battery current I_{bat} (expressed in terms of C-rate). As shown, a discharge C-rate of 1C shown by curve 48a will discharge a battery from a maximum stored-charge level of (Qₘᵢₙ +Q_{capacity}) to a minimum level 49a of stored charge Qₘᵢₙ in a duration of 1 hour. The removal of the stored charge Q_{capacity} can involve any discharge waveform comprising time varying load currents I(t) whereby

Q_{capacity}=∫₀^{t}I(t)dt

which can be expressed as an average current Iₐᵥₑ conducted over the discharge interval t where to fully discharge a battery

$${I}_{ave} = {Q}_{capacity} / t$$

Ideally, the equation is symmetric for both discharging and charging, where a charging current of 1C shown by curve 47a increases the charge on the battery from Qₘᵢₙ at point 49a to Qₘₐₓ where Qₘₐₓ=(Qₘᵢₙ+Q_{capacity}), the maximum charge 49b after 1 hour. Alternatively, charging at a C-rate of 0.5C shown by curve 47b requires 2 hours to increase the state of charge to 100%.

To avoid overcharging a cell, electronic protection must either monitor the charge charges in the cell, a process called coulomb counting, or precisely control the maximum and minimum cell voltages to stay within the safe operating area of SOA. Using voltage to define the safe operating area or SOA of a lithium ion battery is represented graphically in FIG. 7C. As shown, the safe operating voltage range 50f is bounded by line 50c representing the maximum safe voltage 56 and line 50a depicting the lowest safe voltage 53. Region 50b represents an over-discharged condition where a battery may already be permanently damaged reducing is capacity and possibly impeding normal charging.

Normal charging 52 commencing from point 53 may proceed up to point 56 without risk. Commencing charging in the over discharged state shown by curve 51 must be performed carefully to avoid battery malfunction, permanent damage, or worse. One such method is to use low charging currents (sometime called trickle charging) when operating in zone 50b. Whether damage actually occurs to the Li-ion battery depends on many variables leading to the battery's discharging including temperature, depth-of-discharge, the discharging current, and storage time.

Overvoltage conditions in a Li-ion battery are far less forgiving. Even slight overcharging a Li-ion battery above the voltage demarcated by line 50d in fire risk region 50e can lead to severe consequences including overheating during charging 57 and explosion 58 at only a slightly higher voltage. Although the numerical voltages displayed on the voltage axis are exemplary, the actual voltage varies by each lithium battery chemistry. The voltage difference between the top of the safe operating area 50c and the edge of fire risk condition 50d can be as little as 50 mV, so extreme care must be taken to avoid overcharging using voltage as a control parameter as depicted by curve 57.

Importantly, the process of Li-ion battery charging is not performed by simply applying a fixed voltage to the cell until the charging current decays but involves two different zones, constant current (CC) charging and constant voltage (CV) charging as represented in FIG. 8 by the charging curves I_{chrg(CC)} 59a and I_{chrg(CV)} 59b respectively. Moreover, charging currents may be controlled using continuous DC current or by employing pulse modulation and duty factor control to reduce heating. In general pulsed charging is capable of faster charge times than continuous charging. Other benefits of pulsed charging include extended battery cycle life.

Safe operating area is however, not only defined by voltage but also by current and temperature. Excessive charging or discharging currents can cause rapid heating leading to cell damage and fire risk. Protection circuitry is thereby required to prevent cell damage from operating outside the specified SOA for all four key parameters—overcharge voltage (V_{OC}) limit 50c, over-discharge voltage (V_{ODC}) limit 50a, along with over-current restrictions during charging and discharging, and an over-temperature protection (OTP) limit.

Although Li-ion operation is strictly interrupted in event of exceeding overcharge voltage (V_{OC}) limit 50c or dropping below over-discharge voltage (V_{ODC}) limit 50a, limitations in the safe operating range of current must be managed in a completely different way. A simple overcurrent detection circuit shutting off conduction above a defined level is not possible because of inrush current occurring when an electrical load is first connected to the battery as described previously in this disclosure.

If such a strict protective measure would be included the overcurrent protection would falsely trip from inrush every time the battery is connected to a load, rendering the battery totally useless. Instead, Li-ion batteries are manufactured to accommodate much higher currents than the specified ratings of the product sold both during charging and during discharging. The manufacturing involves testing to ensure the fabricated cell is not defective and able to handle transient currents much higher than the cell's steady-state current rating.

For example, during charging, a cell is rated to charge at a maximum charging current I_{chrg(max)} 60 at a specified C-rate of +1C. In order to ensure safe and reliable charging within the specified range, during manufacturing the cell is tested for safety at a charge current I_{chrg(test)} 62 at a C-rate of 2.5C, more than 2.5-times the cell's rating.

If the Li-ion cell is assembled into a battery pack prior to testing, then any overcurrent protection device must be chosen to trip at a level slightly exceeding the tested charge current I_{chrg(test)} 62 to avoid falsely triggering the protection mechanism during test charging. If, however, the cell is tested without any protection electronics, then the overcurrent protection device can be selected to trip at a level slightly below the tested charge current I_{chrg(test)} 62.

Note that the average charge current I_{chrg(CC)} 59a during constant-current mode charging is lower than specified current I_{chrg(max)} 60 which in turn is less than test current I_{chrg(test)} 62, where I_{chrg(CC)}<I_{chrg(max)}<I_{chrg(test)} is maintained. This guard band is deceptive as the constant-current vale I_{chrg(CC)} is an average value. If pulsed charging is used, the peak current for a 50% duty factor charging profile may be double the average current I_{chrg(CC)}, clearly beyond I_{chrg(max)} but still below I_{chrg(test)}.

The current guard band required for battery discharging is far more excessive than for charging. Unlike charging circuitry selected by a product system specifier, discharge current is determined by the electrical load which cannot be predicted, especially during load transients, inrush, and start-up conditions. Referring again to FIG. 8, a cell rated to carry a maximum steady-state discharge current [−I_{load(max)}] 61 at a specified C-rate of −2C is tested at a peak discharge current [−I_{load(test)}] 63 at a specified C-rate of −13.5C, a current nearly seven-times the recommended maximum discharge current [−I_{load(max)}] 61.

If over-current protective circuitry for battery discharging is included in battery pack it is normally included primarily for short circuit protection, and not to limit short duration current spikes. As such, the overcurrent shutdown threshold [−I_{OCSD}] is selected to be even greater in magnitude than [−I_{load(test)}] 63. For load currents greater in magnitude than [−I_{load(test)}] but less than [−I_{OCSD}], battery packs typically rely on over-temperature protection (OTP) to prevent safety hazards rather than over-current detection circuitry.

As described, the charging and discharging currents are not listed in terms of amperes but specified as C-rate. The actual current values thereby scale in accordance with the capacity of the battery. For example, the actual current for a 2C discharge rate using a 3000 mAh battery is 6 A while a 2C discharge rate using a 1000 mAh battery is only 2 A, one third the current. Similarly, a 1C charge rate charges for a 3000 mAh battery comprises a 3 A charge current while a 1000 mAh battery requires only 1 A.

Regardless of the battery capacity, the ratio of the rated discharge current to the rated charge current is two-to-one. The ratio of test current defining the SOA to the rated current varies significantly between charging and discharging conditions. While charging, the peak test current is only 2.5× the operating range, during discharging the ratio is 6.75. This asymmetry between charging and discharging is illustrated in the table below listing the SOA ratings for a differently rated Li-ion batteries.

| Cell capacity, coulomb equivalency | 1000 mAh | | 3000 mAh | |
|---|---|---|---|---|
| Charge current I_{chrg(CC)}, typical (average) | 700 mA | (0.7 C) | 2.1 A | (0.7 C) |
| Charge current I_{chrg(max)}, 1 C rated | 1 | A | 3 | A |
| Charge current I_{chrg(test)}, 2.5 C rated | 2.5 | A | 7 | A |
| Discharge current I_{load(max)}, 2 C rated | −2 | A | −6 | A |
| Discharge current I_{load(test)}, 13.5 C rated | −13.5 | A | −40.5 | A |
| Cell resistance | 12 | mΩ | 4 | mΩ |
| Short circuit current, 0Ω, 4.2 V full charge | 350 A | (350 C) | 1050 A | (350 C) |
| Overtemperature shutdown | 72-to-90° | C. | 72-to-90° | C. |

One key property of the lithium ion battery is its ability to deliver high currents on demand to an electrical load. For a 3000 mAh battery, a 13.5C test current is an impressive 40.5 amperes. Although this current is quite substantial it is no where near the peak current capability of a lithium ion cell. In this regard, the peak cell current defined as the short circuit current I_{sc} is given by the relation

$${I}_{sc} = \frac{{V}_{OC}}{{R}_{bat} + {R}_{short}} \leq \frac{4.2 V}{{R}_{ohmic}}$$

where V_{bat}=V_{OC}=4.2V, Rₛₕₒᵣₜ=0, and R_{bat}≈R_{ohmic}. For a standard 18650 cell, R_{ohmic}=4 mΩ in which case I_{sc}=1050 A, or a C-rate of 350C. The ratio of the short circuit current to the discharge test current is given by I_{SC}/I_{load(test)}=350C/17.5C=20X. This large ratio enables short circuit protection to be set at an intermediate value without limiting the transient current performance of the battery. Protection for high discharge currents of extended duration instead rely on overtemperature protection in the range 72-to-90° C.

Despite its high energy density capability one concern with cylindrical Li-ion cells is internal heating, especially in the event of an operational fault or a battery pack malfunction. As illustrated in FIG. 9, the temperature transient of a cylindrical cell during overheating shows the cell temperature immediately rise 64b above ambient temperature 64a when conduction commences then stabilize 64c during normal operation at a temperature well below the over-temperature shutdown detect limit T_{OTSD} 66.

Should excess heat generation from changing electrical conditions cause a further rise in cell temperature 64e, without properly functioning temperature protection the temperature can run away, rising uncontrollably until cell destruction or a fire 65 results. Because of its cylindrical construction heat in cell 67a concentrates in the center of the cell as shown by region 67b in radial temperature distribution 68 and centered lengthwise 69b at the peak of profile 69a. The cell centric concentration in heat causes the electrolyte to expends creating internal pressure which can cause the cell's metal can to burst in the center or explode. Another possibility is internal pressure causes the electrolyte to leak around chemical seal 67c and potentially combust in the presence of oxygen.

Because the fire risk is very real, the protection of lithium batteries is and continues to be a key concern in their widespread and ubiquitous use. Despite the numerous precautions detailed in this whitepaper, numerous inexplicable failures and fires persist. More effort is required to identify the root cause of such application failures and prevent further incidents.

Pros and Cons of Li-ion Batteries. In conclusion, the lithium ion battery is a complex electrochemical cell capable of supporting a wide range of applications but requiring careful control to operate within its safe operating area (SOA). Its merits include is low series resistance and high transient current capability when discharging. Its weaknesses are its sensitivity to overvoltage and over-discharging causing cell damage with a fire risk potential.

Like any battery, however, the Li-ion cell requires time to charge. This is particularly problematic in electric vehicle applications when a driver must interrupt travel to recharge. Battery charging is problematic for long journeys as it adds to travel time and driver fatigue. The availability of charging stations is another concern, especially in extremely cold weather where a car failure can be deadly. High global demand for high capacity lithium ion packs is another problem, facing supply chain challenges in scaling up Li-ion production, including unethical labor practices and the ecological impact of mining of cobalt, lithium, and other minerals needed in lithium ion battery pack assembly. Despite the foregoing issues, Li-ion battery represents the todays only viable technology for portable power in electronics and electric vehicles. The question persists what role if any can hydrogen fuel cells play in the future of power generation, distribution, and energy storage.

Hydrogen as a Fuel. The only realistic alternative to a lithium ion battery for portable energy and transportation is hydrogen fuel cell technology using hydrogen as a transportable source of power. Although a fuel cell may be considered as an energy generator rather than a form of energy storage, it does not represent a primary power source as it requires fuel, specifically hydrogen, to operate. This hydrogen must be extracted from another source, molecules containing hydrogen before a fuel cell can function. Common hydrogen sources include water, natural gas and methane, and fossil fuels. The hydrogen once produced is then converted into electricity by the fuel cell through an electrochemical process whose only byproduct is water, giving the appearance that a fuel cell is a pure pollution-free source of green electrical energy.

But are hydrogen fuel cells really a source of clean energy? As the adage goes—“the devil's in the details.” The key point is pure hydrogen does not naturally occur in nature (except in rare cases), but like many other sources of usable energy must first be extracted, i.e., refined. The process of hydrogen extraction however requires energy from a primary energy source, generally electricity generated from fossil fuels, natural gas, nuclear power, hydroelectric power, or from renewables such as solar energy and wind power. The pollution caused by a hydrogen fuel cell is therefore not the process of converting hydrogen into electric current, but the pollution and carbon gasses emitted during the production of its hydrogen fuel.

Accordingly, how “green” a hydrogen fuel cell depends on how polluting the power is to make its hydrogen production in the first place. Pollution emitted from hydrogen production is commonly referred to in accordance with the hydrogen color spectrum (even though it has nothing to do with light or color). Instead, hydrogen color is an environmental metaphor for how polluting the production of hydrogen was, primarily ranked by the carbon emissions of the primary power source or source material used to extract the hydrogen. The table to follow describes various means to extract hydrogen and the metaphoric term used to describe the process.

As a metaphor, however, the hydrogen spectrum is neither scientific nor arranged monotonically by color (wavelength) of light. For example, green and yellow hydrogen refer to H₂ production from clean energy of renewable sources while brown and black hydrogen refer to processes involving the burning fossil fuels. Every other color is in between.

| Primary power | H₂ Spectrum | Hydrogen Generation |
|---|---|---|
| Wind power | Green: 100% | Large scale wind farm T2G2G (turbine-to-gen-to-grid) |
| | renewable | Grid powers electrolysis |
| | | Wind farm T2G2G without power transmission |
| | | Local grid powers electrolysis in real time |
| | | Off-grid wind fan turbine-to-generator |
| | | Gen powers electrolysis off-grid in real time |
| | | Optional local storage for delayed electrolysis |
| Solar-thermal | Green: 100% | Large scale solar farm and boiler for T2G2G |
| | renewable | Grid powers electrolysis |
| Hydroelectric | Green: 100% | Hydroelectric T2G2G |
| | renewable | Grid powers electrolysis |
| Solar-PV | Green or | Photovoltaic arrays directly power electrolysis |
| | yellow: 100% | Requires DC/DC conversion & batteries to regulate rate |
| | renewable | Optional local high cap storage for delayed electrolysis |
| | | Photovoltaic arrays with MPPT (max power tracking) |
| | | DC/DC converter powers and controls electrolysis rate |
| | | Optional local storage for delayed electrolysis |
| Chlor-alkali | Yellow | Electrolysis of saturated sodium chloride solution (brine) |
| | or white | Grid power for sodium hydroxide & chlorine from salt |
| | | Capture free waste hydrogen (unless it is reburned) |
| Natural | White | Naturally occurring, geological hydrogen found in |
| hydrogen | | underground deposits, may occur in fracking projects |
| Nuclear-electric | Pink | Nuclear heat exchanger for T2G2G |
| | | Grid powers electrolysis |
| Thermo-nuclear | Purple | Nuclear heat exchanger for T2G2G powers electrolysis |
| Nuclear-electric | (violet) | Nuclear heat exchanger for chemo-thermal electrolysis |
| Thermo-nuclear | Red | Nuclear heat exchanger for chemo-thermal electrolysis |
| Natural gas | Blue | Steam methane reforming (SMR): steam + NG + catalyst |
| | | Produces H₂ with CO and CO₂ byproducts |
| | | Uses carbon capture, storage, utilization (CCSU) |
| | | Combines SMR with integrated fuel oxidation system |
| | | Improved carbon recapture |
| | Gray | Steam methane reforming (SMR): steam + NG + catalyst |
| | | Produces H₂ with CO and CO₂ byproducts |
| Methane | Turquoise | Methane pyrolysis with solid carbon byproduct |
| | | Thermal, plasma (Kvaerner), or catalytic decomposition |
| Igneous coal | Brown | Coal gasification for H₂ with CO and CO₂ byproducts |
| | | Benefits from carbon capture, storage, utilization (CCSU) |
| Bituminous coal | Black | Coal gasification for H₂ with CO and CO₂ byproducts |
| | | Benefits from carbon capture, storage, utilization (CCSU) |

Note in the table, the term T2G2G is an acronym for turbine-to-generator-to-grid where a turning turbine powers a generator delivering electricity into the power grid. The force used to drive the turbine may be derived from renewable energy or by consuming a fuel. Renewable sources for T2G2G electric power may include wind power, hydroelectric or geothermal sources, and solar power (aka yellow hydrogen). T2G2G assumes the power grid is capable of absorbing generated energy. Aside from supplying electric into the grid via T2G2G, other turbine-to-generator electric power methods may be employed to directly power electrolysis either contemporaneously or stored locally as electric charge in batteries for later hydrogen conversion, i.e., delayed electrolysis.

In photovoltaic (PV) direct conversion of sunlight, generated electricity may power electrolysis in real time or be temporarily stored in batteries and regulated by a DC/DC converter to maintain a steadier hydrogen generation rate. More elaborate PV systems may include MPPT, an acronym for maximum power point tracking where the solar panel track the suns movement to maximize power generation. Some papers refer to solar PV hydrogen as yellow hydrogen.

Nuclear power also provides numerous means to produce hydrogen. Although nuclear reactors produce radioactive nuclear isotopes as dangerous waste pollutants, nuclear fission does not produce carbon dioxide. So, considering atmospheric pollution nuclear power is clean despite representing a radiative contamination risk to soil and groundwater. Moreover, nuclear power is not truly renewable as it consumes nuclear fuel and produces waste. As such, nuclear generated electric power for water electrolysis is referred to as pink hydrogen. Purple or violet hydrogen combines pink hydrogen from nuclear-electric powered electrolysis with additional hydrogen generated thermally via a chemo-thermal electrolysis process. Red hydrogen uses high-temperature catalytic splitting of water with nuclear thermal power as its heat source.

Other colors of hydrogen production, such as blue, gray, and turquoise, using processes involving natural gas and methane processing are considered cleaner than coal and oil but are not really considered green-tech. For example, blue and gray hydrogen refer to steam methane reforming (SMR) or auto-thermal reforming (ATR) of gasses combined with or without carbon recapture. Turquoise hydrogen involves thermal splitting of methane via methane pyrolysis producing waste carbon in solid form, producing carbon products but not air pollution.

Black and brown hydrogen involves coal gasification. The environmental cleanliness of coal gasification varies dramatically based on the type of coal used, how its is chemically pretreated, the temperature of the chemical processing, pollutant gas reclaim methods, carbon sequestering, and more. As no single standard coal gasification process exists or is even possible, the carbon footprint of coal gas varies widely.

An even more complex question involves producing hydrogen as a secondary byproduct of regular chemical production, manufacturing performed whether the hydrogen is captured or just wasted. In this sense, even though the process may produce CO₂, the act of capturing the hydrogen doesn't produce any additional carbon dioxide. An example of this type involves the conversion of salts into important inorganic chemicals sodium hydroxide & chlorine. As part of chlor-alkali industry, chemical refining comprises electrolysis of saturated sodium chloride solution (brine) where hydrogen is a byproduct. The hydrogen can be captured and burned to generate heat needed in the process improving the overall energy efficiency of the manufacturing process. Otherwise, the hydrogen can either be captured or released into the atmosphere. Since the hydrogen capture did not result in any additional CO₂ generation, the hydrogen is referred to as white hydrogen. Some papers more broadly refer to free hydrogen as yellow hydrogen as they don't increase CO₂.

Other hydrogen generation methods involve waste recycling, converting biomass into methane and then into hydrogen. When mixed with gasifying coal, this process is called co-gasification. These processes capture hydrogen from waste gasses generated from methane naturally occurring in the decay of organic compounds and biomass. Efficiency and energy yield is enhanced by mixing, i.e., integrating, fuel sources. Such integrated technologies may combine coal-sawdust, coal-sewage sludge, coal-meat, and coal-bone meal into a source of hydrogen. The coal-meat and coal-bone meal mixtures reported exhibit the best results for hydrogen production. The carbon footprint varies widely depending on the mix of hydrogen sources and the reactions used.

In summary, innumerable means exist to convert primary energy into hydrogen fuel. The forgoing example include green renewable resources such solar and wind; polluting energy sources such as coal and biomass; and intermediate sources such as nuclear and natural gas.

A separate matter is the challenge of transporting hydrogen. This topic depends on the relative locations of the hydrogen production and where it is converted into electricity.

For example, hydrogen-to-electric-power conversion can occur close by the end user or nearby the hydrogen production source. If the conversion occurs near the electricity client, then the hydrogen fuel must be transported from its source to its targeted user community. Alternatively, if the H₂ to electric power conversion occurs near the hydrogen production facility, then the electric power must be transmitted over a grid or transmission line system to the user. Both distribution methods, hydrogen transportation and electric power transmission, face both efficiency and safety challenges.

Hydrogen distribution requires installed infrastructure to transport pure hydrogen as compressed gas or hydrogen compounds. Hydrogen distribution in vehicle transportation is even more complex as gas stations must be retrofitted to manage hydrogen fuel sales. The details of hydrogen transport are beyond the scope of this invention disclosure.

Conversely, electric power transmission means the hydrogen is converted locally but the resulting electrical power must be transmitted over great distances. Although DC transmission offers such capability, most power transmission occurs over AC power grids unaccustomed to non-sinusoidal variable power sources. Transmitting AC power or long distances can lead to instabilities in the power grid destroying transformers, causing fires, and even damaging client devices connected to the grid.

Regardless of the myriad of challenges of hydrogen production and distribution, the opportunity of hydrogen powered homes, factories, and vehicles is compelling. The key component in any of these implementation is the means to convert hydrogen into electric power—a device called a fuel cell.

Fuel Cell Operation. Unlike a battery which delivers energy stored previously during electrical charging, a fuel cell converts hydrogen fuel into electrical energy in real time creating electrical energy and simultaneously delivering it to an electrical load. As such, a fuel cell does not require charging, but instead needs processed fuel, generally hydrogen, to operate.

An example of a fuel cell 70 is shown in FIG. 10, where fuel in the form of hydrogen 75 is separated by a chemical catalyst 78 such as platinum into positive ions and negatively charged electrons, i.e., hydrogen ions 77a (aka protons) and electrons 76a. The anode redox reaction is

H₂→2H⁺+2e⁻

During fuel cell operation, hydrogen ions 77a in the anode travel across an electrolytic membrane 79 to become hydrogen ions in the cathode 77b. There they combine with electron 76b and a reducing agent 80 such as diatomic oxygen 70 to produce water 81. The cathode redox reaction is given by the half reaction

2H⁺+2e⁻+½O₂→H₂O

Because anodic electrons 76a cannot traverse electrolyte barrier 79, they must take an external path around the cell from anode 73 though load resistance 71 to cathode 74 resulting in usable electric current. In this manner the hydrogen fuel cell converts hydrogen and air (or oxygen) into electricity and water.

This type of fuel cell is referred to as a PEM FC, an acronym for proton exchange membrane or polymer electrolyte membrane. The source of hydrogen, supplied contemporaneously to the cell during operation, depends on the operating temperature range of the fuel cell. Charge transport through the PEM electrolyte occurs via ionized hydrogen cations, i.e., protons. Using a thin film solid electrolyte, PEM FCs do not risk leakage of caustic chemical, acids, or fires of flammable fluids like other older fuel cell technologies used by the space program.

Present-day PEM FCs commonly referred to as low-temperature or LT-PEM FCs employ a solid polymer membrane comprising a sulfonated poly tetrafluoroethylene (PTFE) based fluoropolymer-copolymer, chemical formula C₇HF₁₃O₅SC₂F₄. First branded Nafion by Dupont, tradenames of fluoropolymer-copolymer related compounds useful as proton exchange membranes include Aciplex, Flemion, Dowew, and fumapem F. Morphologically fluoropolymer-copolymer these materials comprise a nanometer-sized network of hydrophilic domains allowing movement of water and cations across the membrane in one direction but inhibiting the flow of electrons and anions in the opposite direction. As such, the ionomeric membrane favors transport of positively-charged hydrogen ions over negatively charged electrons, exemplifying a charge exclusion mechanism known as permselectivity. Phenomenologically, ionomers mimic subunit V of cytochrome-c oxidase (CCO-V), a mitochondrial transmembrane protein commonly known as ATP synthase responsible for creating and storing biochemical energy as adenosine triphosphate (ATP). Emulating the regulatory function of the electron transport chain in cell biology, synthetic ionomers comprise a blend of both electrically neutral repeating units and ionized units (typically carboxylic acids) covalently bonded to the polymer backbone.

By limiting ionized subgroups to 15 mole percent, the membrane splits positive and negative charges while managing current flow, in essence performing the same function as a semiconductor diode. Variations of the membrane are use in the separator of lithium ion batteries. That said, numerous deficiencies exist in present day proton exchange membranes, especially involving a strong temperature and humidity dependence and the inability to function at freezing temperatures.

The term “low temperature” in the acronym LT PEM FCs is a misnomer as it refers to operating temperatures lower than most other fuel cell varieties. Specifically, Nafion based PEM FCs typically operate in the 60° C.-to-80° C. range, significantly above normal ambient temperatures on earth. A variant of PEM fuel cells called a high temperature of HT PEM FC employs lead-doped Nafion and a modification of the platinum catalyst to platinum-ruthenium. With this modification, the operating temperature range increases to the range of 110° C.-to-180° C. Both LT and HT variants of Nafion PEM FCs are not useful at room temperatures of 25° C.-to-50° C. and are completely non-functional in freezing conditions at T 0° C. As such, Nafion based PEM FCs are unsuitable for consumer use or in transportation applications.

Another variation of the PEM FC, the direct methanol fuel cell replaces gaseous hydrogen with methane as the fuel. The change beneficially reduces the operating temperature to the 30° C.-to-60° C. range. The anodic reaction changes to CH₃OH+H₂O→CO₂+6H⁺+6e⁻ and the cathode reaction is modified to 1.5O₂+6H⁺+6e^{-→3}H₂O. Unfortunately, the direct methanol fuel cells emits carbon dioxide. In automotive applications this means that cars remain CO₂ polluters where carbon sequester methods are not useful. As such direct methane PEM FCs are unsuitable for consumer use or in transportation applications.

Although hydrogen PEM FC represents the most promising type of fuel cell, other fuel cells with different chemistries exist. FIG. 11 illustrates four exemplary non-PEM fuel cell types—the alkali fuel cell aka AFC, MCFC, PAFC, and SOFC.

Alkali fuel (AFC) cells operate on compressed hydrogen and oxygen with potassium hydroxide (KOH) as an electrolyte with H₂O as a byproduct. Ionic transport within the electrolyte involves negatively-charged hydroxyl (—OH) anions. Using a fluidic electrolyte means AFCs risk leakage. Moreover, the cells require high temperature operation, between 150° C.-to-200° C. Therefore, AFCs are not considered suitable or safe for consumer use or in transportation applications.

Molten carbonate fuel cells or MCFC comprise high-temperature compounds of sodium or magnesium carbonate salts such as Na₂CO₃ as their electrolyte. Charge transport comprises carbon trioxide (CO₃²⁻) anions. The fuel cell consumes H₂, O₂ and beneficially CO₂ and release water but is sensitive to carbon monoxide (CO) poisoning. Aside from consuming CO₂, another benefit in MCFC use inexpensive nickel rather than platinum as a catalyst. Its high operating temperature, roughly 650° C., renders MCFC unsuitable for consumer use or in transportation applications.

True to their namesake, phosphoric acid fuel cells or PAFCs use phosphoric acid, chemical notation H₃PO₄, as their electrolyte. Like PEM fuel cells, charge transport in a PAFC involves H⁺cations. In operation the cell consumes hydrogen and oxygen and produces water. Unfortunately, the presence of liquid phosphoric acid heated to 200° C. makes PAFC dangerous for use except for industrial applications. As such PAFCs are not considered safe for consumer use or transportation applications.

Solid oxide fuel cells or SOFCs utilize a metal infused ceramic compound such as oxides of zirconium or calcium (yes, calcium is a metal) as an electrolyte including YSZ, ScSZ, and GDC. Fed by hydrogen and oxygen and producing water, charge transport involves divalent oxygen O²⁻ anions for charge transport. Although the solid electrolyte cannot leak, the ceramic can crack from impact or repeated temperature cycling to its nominal operating condition of 1000° C. These excessive operating temps limit high temperature limits applications of SOFC units to large scale industrial applications, and unsuitable for consumer use or transportation applications.

In conclusion, as summarized in the table below, a variety of fuel cells exist, none of which are suitable to meet the consumer and transportation market requirements. The only low temperature fuel cell technology produces CO₂ as a waste gas. Of these technologies, PEM fuel cells have the best chance to being readapted for lower temperature operation.

| FC Name | Electrolyte | Ion Transport | Fuel | Effluent | Temp ° C. |
|---|---|---|---|---|---|
| Methane PEM | PEM | H⁺ | CH₃OH, H₂O | CO₂, H₂O | 30-60 |
| LT PEM | PEM | H⁺ | H₂, O₂ | H₂O | 60-80 |
| HT PEM | PEM | H⁺ | H₂, O₂ | H₂O | 110-180 |
| Alkali AFC | KOH | −OH | H₂, O₂ | H₂O | 150-200 |
| PAFC | H₃PO₄ | H⁺ | H₂, O₂ | H₂O | 180-200 |
| MCFC | Na₂CO₃ | CO₃²⁻ | H₂, O₂, CO₂ | H₂O | 650 |
| SOFC | YSZ, ScSZ, GDC | O²⁻ | H₂, O₂ | H₂O | 1000 |

Among the foregoing options PEM fuel cells continue to present the best opportunity for improvement and commercial adoption. Advantages of the PEM FC include its us of a thin solid electrolyte, ease of assembly, and no concern for leaking caustic chemicals or acid. FIG. illustrates a schematic of s single membrane PEM fuel cell absent the cell housing. As shown, an expanded view of cell construction illustrates two gas diffusion layers 90 and 94 where anode diffusion layer 90 includes a hydrogen fuel inlet and a second port, an outlet for recycling unused hydrogen.

Conversely, the cathode gas diffusion layer 94 has an oxygen inlet and a water outlet. Since fuel cell operation produces water, water removal is critical to maintain operation without flooding the cell electrolyte. Sandwiched between the gas diffuser layers are the anode catalyst 91, cathode catalyst 93, and the intervening proton exchange membrane (PEM) layer 92. PEM layer 92 comprises the permselective polymer of ionomer-impregnated PTFE film having thickness typically 100 microns thick.

Anode catalyst layer 91 includes platinum to dissociate hydrogen into protons (cations) and electrons bound within a carbon matrix. Because the oxygen reduction reaction (ORR) on the cathode side of the PEM more significantly affect the reaction rate and impedance of the fuel cell, Pt loading in the anode catalyst can be reduced without affecting electrical performance. While this strategy may appear to represent an opportunity for cost savings, low Pt anodes are at substantially greater risk for severe contamination from the chemical impurities present in the fuel. Contaminants such as carbon oxide, hydrogen sulfide or ammonia can react with platinum particles creating strong, nearly irreversible chemical bonds, consequently decreasing the electrochemical surface area and irrevocably damaging the cell. As such, very low anode catalyst loading is ill advised. New developments include tantalum-doped titanium dioxide (TiO₂) or alternatively combining TiO₂ with SiO₂ using vinyltrimethoxysilane (VTMS) as a binder.

On the cathode side, catalyst layer 93 accelerates the oxygen reduction reaction (ORR) combining electrons, protons, and oxygen to produce water. The stoichiometry and structure of the cathode catalyst layer continues to evolve. Present day designs comprise carbon infused with platinum. To reduce costs, new efforts attempt to develop alloys of PtNi, PtCo, Pt—Gd, Pt—Y, Pd, and PdₓAu. Other approaches include nanoparticles, nanostructures, nanosheets, and carbide cores.

Another important element in a PEM FC is the bipolar plates used to conduct current out of the fuel cell assembly and to form channels to carry coolants if needed. The properties of these metallic bipolar plates include
Good electrical conductivity (<10 Ω-cm)
Affordable cost (no rare materials, high volume capable)
RoHS compliant
Superior thermal conductivity (>20 W/cm²)
Low hydrogen permeability
High chemical and corrosion resistance
Mechanical stability against compression
Reliable during temperature cycling
Low weight per volume
Recyclable, inexpensive metal reclaim

PEM FC Electrical Characteristics. The electrical properties of a proton exchange membrane fuel cell depend on its design, materials, manufacturing, and fuel. Assessing the utility of various constructions of PEM fuel cells, however requires a common basis of comparison. Like the previous discussion regarding lithium ion batteries, a relevant comparison of electrical performance can be made using a lumped-element equivalent circuit model.

FIG. 13A illustrates one basic model for a fuel cell comprising an open circuit voltage 100 of magnitude V_{chem}, a DC resistance 104 of magnitude R_{ohmic}, and dynamic elements 103 comprising FC polarization voltage 101 of variable magnitude Vₚₒₗ and membrane resistance 102 of variable magnitude R_{memb}. The fuel cell terminal voltage V_{FC} is then given by the equation

$${V}_{FC} = {V}_{chem} - {V}_{pol} - I \cdot ( {Z}_{memb} + {R}_{ohmic} ) \approx {V}_{eff} - I \cdot ( {R}_{memb} )$$

where the dynamic impedance Z(t) is given by

$$Z ( t ) = \frac{{V}_{pol}}{I} + {Z}_{memb}$$

and where real components V_{eff}≈V_{chem}−Vₚₒₗ and R_{memb}≈Re{Z_{memb}}>>R_{ohmic}. This equivalent simplified model is depicted in FIG. 13B where the effective FC voltage 100 and DC membrane resistance 102 are both a function of temperature T, relative humidity of the anode RHA, relative humidity of the cathode RHC, and current density I/A.

To accommodate these interdependences a modified phenomenological model of a PEM fuel cell is depicted in FIG. 14A highlighting the role of humidity (water vapor) and water transport in the cell. Adapted from FIG. 10, the diagram includes the various roles of water in fuel cell operation. Identified elements include enclosure or encasement 120, PEM membrane 122 with anode catalyst layer 124a and cathode catalyst layer 124c. The catalyst layers are bounded by electrically conductive gas diffusion layers 123a and 123c on the anode and cathode side of the PEM membrane respectively.

The core of the fuel cell is the energy conversion element assembly commonly referred to as the membrane electrode assembly or MEA. The precise definition of the fuel cell core depends on how many layers are included. When referring to the PEM layer and its two catalyst layers, the sandwich may be referred to as a MEA3 in reference to its three constituent layers. The most common definition of a membrane electrode assembly is MEA5, meaning the MEA3 core plus its two enclosing gas diffusion layers. The term MEA7 refers to the structure comprising MEA5 plus two sealant rings inserted to prevent gaseous leaks between the gas diffusion layers and the conductive bipolar plates carrying gasses. MEA7 is considered a term-of-art not commonly referred to in the literature.

The role of water in PEM FC operation is critical. If the water content in the fuel cell is too low, reactivity drops, electrical impedance is increased, and delivered power is significantly reduced. To prevent the fuel cell from “drying out” water vapor must be mixed into hydrogen fed to the fuel cells. Specifically, gases supplied to anode chamber 121a comprising incoming hydrogen 75 must be humidified by water vapor 81a. The humified hydrogen 128a is then split in anode catalyst layer producing electrons and protons intermixed with H₂O molecules. Unused gasses 129a effused from anode gas channel 121a include both hydrogen and water vapor.

This mix can be resupplied, i.e., recirculated, to supply the inlet gasses 128a to the anode with no additional consumption of energy. Concurrently water vapor transported 127a through the anodic gas diffusion layer 129a reaching the anode catalyst layer 124a supports ion transport and fuel cell energy production. Unused excess water diffuses in the reverse direction 127a back across the diffuser layer returning to anode gas chamber 121a in an unused state.

The role of water in cathodic reactions is equally critical. In this example, humified air 128c is supplied to the fuel cell cathode gas channel 121c as a blend of air and/or oxygen 80 mixed with water vapor 81c, i.e., gaseous H₂O. Combining O₂ 60 with gaseous water 81c in the cathode gas channel 121c, the cathode mixture regulates the oxygen reduction reaction (ORR) in the cathode by traversing 127c the cathode diffusion layer 123 to the catalyst layer 124c thereby regulating proton cation reduction into water. In equilibrium, since the process generates additional water in the catalyst layer the excess water flows 127c across the diffusion layer in the reverse direction, increasing the humidity in cathode gas channel 121c which is regulated to the proper level by effluent removal 129c.

Since both water transport 127a in the anode and 127c in the cathode maintain equilibrium, the role of water is crucial in determining the fuel cell current and impedance. Too little water will dry out the cell, making start difficult. Too much water can adversely affect PEM FC performance. For example, excess humidity in the anode can reduce proton transport across the membrane, a phenomena referred to as electroosmotic drag shown by arrow 125. Excess humidity in the cathode can cause back diffusion of water 126 lowering cell efficiency and comingling anodic and cathodic water. In normal operation, water in the cathode should be separate from water vapor in the anode.

As such, even though the efficiency of a PEM FC is often described in reference to the relative humidity of the ambient, in more details the anode and cathode relative humidity are not the same and should be specified separately. For technical clarification, the term relative humidity or RH describes the percentage water vapor, i.e., the water vapor partial pressure, in a gas is defined by the ratio of the ambient gas temperature divided by the gas dew point temperature—the temperature where water comes out of solution changing from its gas phase into liquid.

For convenience sake it is common practice to specify the RH for a fuel cell as a single value for both anode and cathode with the understanding that better results may be obtained by optimizing the two RH values separately. Note also that the schematic shown in FIG. 14A represents the cross section where gas channels are present on both the anode and cathode side of the cell and where the bipolar plate electrodes are not visible. For further clarity FIG. 14B illustrates the addition of bipolar conductive plates to the cell carrying both electricity and gasses.

As depicted, anode gas channel 121a carrying humidified hydrogen 75 is formed within anode bipolar plate 119a. Some cross sections where anode bipolar plate 119a directly contacts the anode gas diffusion layer 123a do not include the gas channel. Instead, gas carried by gas channel 121a spreads in all directions 117a throughout anode gas diffusion layer 123a to uniformly reach the anode catalyst layer 124a. Various anode gas channel geometries not shown including grids and spirals have been investigated to provide maximum uniformity to the MEA3. In addition to housing the gas channel, anode bipolar plate 119a conducts electric current from the MEA5 via anode gas diffusion layer 123a. As such both anode gas diffusion layer 123a and anode bipolar plate 119a must feature lower electrical resistance.

Similarly, cathode gas channel 121c carrying humidified oxygen 80 is formed within cathode bipolar plate 119c. Some cross sections where cathode bipolar plate 119c directly contacts the cathode gas diffusion layer 123c do not include the gas channel. Instead gas carried by gas channel 121c spreads in all directions 117c throughout cathode gas diffusion layer 123c to uniformly reach the cathode catalyst layer 124c. Various cathode gas channel geometries not shown including grids and spirals have been investigated to provide maximum uniformity to the MEA3. In addition to housing the gas channel, cathode bipolar plate 119c conducts electric current from the MEA5 via cathode gas diffusion layer 123c.

As such both cathode gas diffusion layer 123c and cathode bipolar plate 119c must feature lower electrical resistance. Note also that depending in the location of the cross section, various combinations of bipolar plates and gas channels may or may not be present in an illustration. For example, the cross section shown in FIG. 14A depicts the cut line 118 of FIG. 14B.

As described the electrical characteristics of a PEM fuel cell primarily depend on the relative humidity RH of the anode and cathode, the cell temperature, and on current density. Low gas flow from inadequate supply pressure, localized heating (hot spots), and carbon monoxide (CO) poisoning of the catalyst may also impact operation.

The following sets of curves exemplify the electrical properties of prototype PEM fuel cells published in the literature, all of which suffer from serious performance and reliability challenges. They are included herein to provide mechanistic insight into FC operation. FIG. 15 illustrates the effective terminal voltage V_{FC} of a PTFC based fuel cell at 70° C. as a function of current density I/A for relative humidity ranging from 100% to 0%. Each curve exhibits a characteristic response comprising an electrochemical potential voltage 149 at near zero current of value V_{chem} which drops to a lower effective voltage 147 of magnitude V_{eff} with only a slight electrical current load. The difference is the no load polarization voltage 148 given by the relation Vₚₒₗ=V_{chem}−V_{eff}.

Aside from the initial voltage drop Vₚₒₗ at low current, each response curve above 27% relative humidity has a characteristic shape with increasing current comprising a quasi-constant voltage plateau followed higher current knee, beyond which a precipitous cell voltage drop-off occurs. The values of V_{chem}, Vₚₒₗ, V_{eff}, and V_{FC} (I/A) vary by fuel cell design and chemistry. For the illustrated example using a PTFC membrane, V_{chem}=1V and V_{eff}=0.83. At a current density of 400 mA/cm², the effective terminal voltage V_{FC} monotonically decreases with humidity, specifically 0.65V, 0.58V, 0.40V, and 0.35V respectively for different values of relative humidity, namely RH=100% for curve 140, 60% for curve 141, 35% for curve 142, and 27% for curve 143. Although higher values of relative humidity are able to maintain greater cell voltages at low current densities, the corresponding knee current at V_{FC}=0.2V occurs at monotonically lower current densities, e.g., at densities of 1.3, 1.25, 1.0, and 0.75 A/cm² for RH values of 27%, 35%, 60% and 100% respectively.

Below 20% humidity, the behavior of the fuel cell differs considerably from higher humidity operation. For example, at RH=20% curve 144 exhibits voltage collapse at any current over 0.1 A/cm² with no voltage plateau present. As indicated by curve 145, at 0% relative humidity the fuel cell is incapable of delivering any current whatsoever. Both of the curves represent a condition when inadequate water is present to support the fuel cell's minimum sustainable chemical reaction.

An important observation is that although the effective voltage V_{eff} 147 does not vary significantly with temperature and humidity, the fuel cell is incapable of generating and sourcing significant current at that voltage. For voltages below V_{eff}, the voltage-current characteristic spreads into a family of diverging curves each representing the relative humidity of the fuel cell ambient. The greater the current density the more divergent the electrical properties are. As such, it is difficult to maintain a useful load current and maintain a reasonable cell voltage.

FIG. 16 illustrates the same PEM fuel cell operating at 90° C. showing fuel cell voltage V_{FC}versus current density varies parametrically by relative humidity comprising curves 150, 151, 152, 153, 154, and 155 at RH values of 100%, 60%, 35%, 27%, 20%, and 0% respectively. Despite the fact that the cell voltage V_{chem} 156 and V_{eff} 157 remain nearly unchanged from operation at 70° C., the shape of the voltage-current conduction curves with humidity change substantially. Specifically, unlike its lower temperature behavior, at elevated temps (except for 100% humidity curve 150) cell voltage V_{FC} by current density is purely monotonic in both voltage and current with no voltage plateau or knee.

FIG. 17 replots the 70° C. fuel cell voltage against relative humidity varied parametrically by current density with curves 158, 159, and 160 for current densities 0.2, 0.6, and 0.76 A/cm² respectively. Although at low current densities such as 0.2 A/cm² the usable fuel cell voltage increases proportionally with RH, at high current densities the sustained voltage peaks at around RH=55% then declines, likely due to water logging effects such as electroosmotic drag and back diffusion described previously. With the exemplary PEM FC, if the maximum current density is limited, then the usable range of humidity depends on the minimum rated cell voltage.

As shown in the below table if the delivered current is 600 mA/cm² maximum, then to operate at RH≥45% only 0.5V per cell can be ensured. If the maximum guaranteed current is reduced to 200 mA/cm² then 45% humidity can deliver 0.55V. If the minimum guaranteed voltage is lowered to 0.5V, then the fuel cell can work down to 36%. Unfortunately, limiting cell voltages and current to function across a wider range of humidity is not a good tradeoff.

| Current Density, T = 70° C. | Minimum V_{FC} | Usable RH Range |
|---|---|---|
| 600 mA/cm² | 0.60 V | 100% |
| | 0.55 V | 57% to 100% |
| | 0.50 V | 46% to 100% |
| 200 mA/cm² | 0.60 V | 57% to 100% |
| | 0.55 V | 46% to 100% |
| | 0.50 V | 36% to 100% |

Another major concern is the high internal resistance of fuel cells. Unfortunately, the series resistance of a PEM FC is also highly sensitive to humidity. FIG. 18 illustrates the specific resistance of a PEM fuel cell for various relative humidity levels including curves 165-to-169 corresponding to RH values of 100%, 60%, 35%, 27% in the range of 100-to-800 mΩ-cm². Curve 169 shows resistance at 20% relative humidity is even higher, occurring n the range of 1200-to-1700 mΩ-cm² and limited to current densities below 300 mA/cm².

Specific resistance is the internal resistance of the PEM cell normalized by area. While current density I/A is rated by the current I divided by area A with units either as A/cm² or mA/cm², specific resistance is a measure of the resistance times the area having units of mΩ-cm². The best technologies offer the lowest [R_{FC}A] multiplicative product, allowing to trade off cost and performance. To calculate the resistance of a fuel cell of active area A, the resistance R_{FC} is given by

$$R = \frac{[ {R}_{FC} A ]}{A}$$

where [R_{Fc}A] is the technology dependent specific resistance of the fuel cell. Unlike the lithium ion battery whose resistance is dominated by the ohmic resistance of its conductive electrodes, fuel cell conduction is dominated by the real component of the membrane impedance, i.e., Re {Z_{memb}}.

As shown, specific resistance is inversely proportional to relative humidity, where 100% RH curve 165 is less than one-third the resistance of the 27% curve 168. As discussed, the membrane resistance is really an electrical representation of the electrochemical process occurring within the MEA. This explains why the specific resistance of the fuel cell decreases with increasing current, mechanistically explained by a more complete electrochemical reaction is occurring and because more water is produced at higher currents. In fact, inflection in the resistance curves above 0.3 A/cm² occurs because of enhanced water production.

The biggest problem of the hydrogen fuel cell is its intrinsically high membrane resistance. For a 1 cm² area, the fuel cell resistance RFC ranges from 300 mΩ to 900 mΩ. For the same area lithium ion battery, the resistance is between 4 mΩ and 12 mΩ depending on the cell design. As such the fuel cell resistance is between 10× to 75× higher than a comparable area Li-ion battery. The high resistance technologically prohibitive for delivering current spikes, rendering conventional PEM fuel cells unusable in most real world applications.

Unfortunately, the resistance disadvantage can be much worse than 75 times. This is because of the low almost unusable voltage of a single fuel cell. As described previously, even though today's fuel cells exhibit a maximum chemical potential of 1V, as described previously even low levels of current demand drop the cell voltage substantially. To cover even a modest range in relative humidity the cells can only be counted to deliver between 0.6V-to-0.5V depending on the humidity. Referencing this voltage to the ubiquitous 3.7V Li-ion cell, and equivalent voltage stack of fuel cells requires 5-to-8 stacked membranes with resistances as high as 89900 mΩ=7200 mΩ, i.e., 7.2Ω. Compared to the same area lithium ion battery at equivalent voltages, it means the series resistance of conventional PEM fuel cells compared to a nominal 18650 Li-ion battery is (7.2Ω/4 mΩ)=1800× higher.

The effect of series resistance is shown in FIG. 19 where a series stack of ‘n” fuel cells 170a to 170z arranged in a single string (m=1). The lumped element equivalent circuit of a voltage source 172 with the magnitude nV_{FC} and resistor 171 with an aggregate resistance of nR_{FC}. The voltage V_{FC} is the nominal voltage of a single fuel cell able to operate over the required range of humidity and temperatures, and R_{FC} is its resistance, e.g., 0.50V and 800 mΩ. Table 173 describes the equivalent resistance nR_{FC}, the total voltage nV_{FC}, and the total energy nQ_{FC} for a ns1p fuel cell array where the parallel strings m=1 and the number of series cells n varies from 1-to-8.

Compared to a lithium ion battery with a nominal voltage of 3.75V, a stack of fuel cells able to operate down to RH=36% and deliver 200 mA/cm², requires n>(3.75V/0.5V)=8 cells. The 8s1p array therefore exhibits a maximum voltage V_{FC}=8·0.5V≤4V and a series resistance of R_{FC}=8·800 mΩ=6.4Ω. Unlike a lithium battery, the peak output current of the 8s1p (i.e., n=8, m=1) fuel cell array cannot be calculated by the equation

$${I}_{sc} = \frac{{nV}_{FC}}{n ( {R}_{memb} + {R}_{short} )} = \frac{{nV}_{FC}}{{nR}_{FC}} = \frac{8 ( 0.5 ) V}{8 \cdot ( 800 m Ω )} = 625 mA$$

because the fuel cell voltage V_{FC} is a function of current. In accordance with the prior description in FIG. 17, a current of 600 mA for 1 cm² device can only maintain a cell voltage of 0.42V, not 0.50V. In such a case, the stack voltage drops from 4.0V to 3.3V. Commensurately, the peak current drops from the calculated value of 625 mA to an adjusted value of 525 mA. Without short circuit protection a lithium ion battery having the same active area can deliver between 300 A to 940 A, roughly 2000× the transient current of a n=8 fuel cell stack.

An alternative configuration which lowers fuel cell module electrical resistance is to parallel fuel cells instead of connecting them in series. This 1smp array configuration is shown in FIG. 20 for “m” parallel cells 180a-180z of FCs, each comprising a single cell (n=1). The equivalent circuit has an aggregate resistance 181 of R_{FC}/m. Unfortunately, as shown in table 183, the fuel cell voltage 182 is only V_{FC} in the range of 0.5V to 0.6V regardless of how many cells are paralleled.

Although fuel cells cannot compete in electrical performance, the total energy delivered by a fuel cell is unlimited because it consumes fuel rather than storing charge. That said, in all practical applications the total volume of gas available is always limited. As described in the table each fuel cell contributes energy in the form of total charge Q_{FC}to the array. Like voltage, energy supply is additive when a n=8 fuel cell array delivers 8 times the energy of a single cell despite the series connection. Calculating how much charge Q_{FC}each cell contributes to the total depends on how the charge is accounted for.

The total power contribution of each cell is based on two factors—the total hydrogen available and the total surface area of the MEA, i.e., the aggregate membrane area. Although the surface area of the PEM determines maximum steady state current delivery as well as transient current performance, over time all fuel will be consumed. Therefore, the true value of QFC is based on the amount of hydrogen it can consume without renewing its supply. In this sense, renewing a FC's hydrogen supply is the equivalent of recharging a battery. Assuming the maximum hydrogen supply is a fixed number per delivery and not continuous hydrogen generation, then the hydrogen supply must be divided by the total number of fuel cells it powers.

Given that the total number of hydrogen molecules is n_{H2} and that every H₂ molecule comprises two hydrogen atoms, then the number of charges produced from one hydrogen molecule is equal to Q_{H2}=2N_{H2} where the number of hydrogen molecules n_{H}2, a quantity depending on the volume, pressure, and temperature of the container that holds it.

Assuming this total charge Q_{H2} is divided across men fuel cells where Q_{H2}=2n_{H2} then according to the law of charge conservation

Q_{H2}=2n_{H2}=(mn)Q_{FC}

meaning the total charge is assume to be shared evenly among all fuel cells. Rearranging the terms produces the charge per fuel cell Q_{FC} as a 2/m·n fraction of the total hydrogen molecules.

$${Q}_{FC} = {Q}_{H 2} / ( mn ) = ( 2 {n}_{H 2} ) / ( mn )$$

When m=1 this ratio becomes Q_{FC}=Q_{H2}/n as shown previously in FIG. 19. Although it may seem like an apples-to-oranges comparison, an optimistic assessment of fuel cell capacity is to compares the stored charge in a lithium ion battery to the stored charge in the same volume of hydrogen gas. The same energy division is exhibited in parallel cells as shown previously in FIG. 20 where a total charge Q_{H2}=(mn)Q_{FC}=mΩ_{FC}. As such, when n=1 then Q_{FC}=Q_{H2}/m.

Volumetric Energy. When considering the energy stored in hydrogen, the container is important in determining how much hydrogen can be safely contained. Factor include the size, shape, the materials, and any reinforcement. FIG. 21 compares a variety of containers used as cans for lithium ion batteries. Although the cons are not designed for gas containment perse, Li-ion batteries may operate above atmospheric pressure depending on operating conditions. To avoid explosive venting, some Li-ion batteries include pressure relief valves.

As shown, an AA battery size canister 184a also known as a 14650 battery has a length of 5 mm and an outer diameter of 0.7 cm holding a volume of 17.5 ml (or cm³). The industry standard battery container, the so called 18650 canister 184b, has a length of 6.5 cm, an outer diameter of 1.8 cm, and an enclosed volume of 16.5 ml. The slightly larger 21700 canister 184d commonly used in EVs has a length of 7.0 cm, an outer diameter of 2.1 cm, and an enclosed volume of 24.2 ml. Both the 18650 and 21700 batteries include a pressure relief valve that releases gasses at 24 bars, i.e., twenty four times atmospheric pressure. As an alternative form factor, the thicker walled miniature gas canister 184c used by Coravin for delivering compressed argon gas for wine dispensing has dimensions of 6.3 cm in length and an outer diameter of 2.2 cm plus a narrow 2.8 cm long nose for high pressure connections with a total volume of 20.7 ml. Because of its thicker walls, the mini-canister supports a pressure of 179 bars, 7.5× greater than the Li-ion canisters. Despite holding 15% less volume than the 21700 can, the higher pressure allows more hydrogen to be compressed into a lesser volume, specifically 6.4 times more hydrogen and 12.8 times more coulombic charge. Using these ratings, it become possible to compare the energy storage potential of hydrogen in a direct comparison to lithium-ion batteries.

Although smaller form factors have potential application in portable devices and are useful in comparing volumetric performance of fuel cells and Li-ion batteries, larger form factors are needed in electric vehicle applications, such as container 185a shown in FIG. 22A and canister 185b shown in FIG. 22B. A discussion of large volume hydrogen containment is not a topic of this invention and will not be discussed further here.

A key motivation is normalizing hydrogen energy storage to Li-ion battery canister form factors allowing a direct comparison of energy densities. FIG. 23 is a graph of charge capacity Q_{T} versus canister volume, varied parametrically by canister pressure at 10 bars (line 191a), 20 bars (line 191b), 30 bars (line 191c), 50 bars (line 191d), and 100 bars (line 191e). As a volumetric reference, the graph includes the volume of the 14500 (AA) battery 190a, the 18650 canister 190b, the Coravin high pressure canister 190c, and the 21700 can 190d.

In order to calculate the charge present in a container of gas, it is first necessary to calculate the number of moles of gas it contains. Using the ideal gas equation PV_{g}=NR_{g}T where N is the number of moles, P is the pressure in pascals, V_{g} is gas volume (given 1 ml=1 cm³=10⁻⁶ m³), R_{g} is the ideal gas constant (8.314 J·K⁻¹·mol⁻¹), and T is the gas temperature (300° K), then for an exemplary pressure of 10 bars=1 MPa=10⁶ Pa, the number of moles is given by

$$N = \frac{p {V}_{g}}{{R}_{g} T} = \frac{( 1 {0}^{6} Pa ) ( {10}^{- 6} {cm}^{3} )}{( 8.3 \; 14 J \cdot {K}^{- 1} \cdot {mol}^{- 1} ) ( 300 ° K )} = 4 \times {10}^{- 4} mol$$

The molar concentration is converted into H₂ molecules using Avogadro's number N_{A}where N_{A}=6.022×10²³ mol⁻¹, where

$${N}_{H 2} = N {N}_{A} = ( 6.022 \times 1 {0}^{23} {mol}^{- 1} ) ( 4 \times {10}^{- 4} mol ) = 24 \times {10}^{19} {H}_{2} molecules$$

As a diatomic molecule having monovalent ionic charge where z=(2 electrons/H₂), the total charge Q_{H2} in coulombs per ml is given by Q_{H2}=Z_{H2}NH₂

$${Q}_{H 2} = ( 2 elec / {H}_{2} ) ( 24 \times {10}^{19} {H}_{2} ) ( 1.6 \times {10}^{- 19} coulombs / elec ) = 76.8 coulombs$$

Converting coulombs to mA-hr

$${Q}_{H 2} = 76.8 C = 76.8 Asec \frac{1000 mA}{A} \frac{hr}{60 \cdot 60 sec} = 76.8 Asec ( \frac{0.2 \; 78 mAhr}{A sec} ) = 21.35 mAhr$$

meaning at T=300° K and 10 bars of pressure. every milliliter of hydrogen contains 77 coulombs or 21.4 mAhr of electric charge, presuming the hydrogen is fully converted into electricity. As the ideal gas equation describes, the molar concentration of a gas and therefore the equivalent charge and cell capacity Q_{H2} increases linearly with pressure and volume.

| | Q_{H2}/V | Q_{H2} for | Q_{H2} for | Q_{H2}for | Q_{H2} for |
|---|---|---|---|---|---|
| Pressure | (mA-hr | 7.5 ml | 16 ml | 21 ml | 24 ml |
| (bars) | ml⁻¹) | (mA-hr) | (mA-hr) | (mA-hr) | (mA-hr) |
| 10 H₂ | 21.3 | 161 | 342 | 448 | 512 |
| 20 H₂ | 42.7 | 322 | 683 | 897 | 1025 |
| 30 H₂ | 64.1 | 483 | 1025 | 1345 | 1537 |
| 40 H₂ | 85.4 | 644 | 1366 | 1793 | 2050 |
| 50 H₂ | 106.8 | 805 | 1708 | 2242 | 2562 |
| Li-ion | 150-200 | 850 | 3000 | — | 4800 |
| 100 H₂ | 213.5 | 1610 | 3416 | 4484 | 5124 |
| 177 H₂ | 377.6 | 2847 | 6042 | 7930 | 9063 |

As shown, any increase in pressure results in an corresponding increase the volumetric energy density, measured in units of mAh per milliliter. At a pressure of 100 bars, the energy density of stored hydrogen exceeds that of lithium-ion. Direct comparisons of stored charge can be made for specific volumes.

For example, an AA-sized lithium battery, also referred to as a 14500 cell, when fully charged can deliver 850 mAh while the same volume of hydrogen at 100 bars while contains 1610 mAh. An industry standard 18650 lithium battery when fully charged, delivers around 3000 mAh while the same volume of hydrogen at 100 bars delivers 3400 mAh. A 21700 form factor stores 4800 mAh of energy in lithium-ions but over 5100 mAh of charge in H₂ at 100 bars.

FIG. 23, mentioned previously, is a graph of stored capacity Q_{H2} plotted against hydrogen storage volume in ml (or cm³) ranging from 7.5 to 50 ml with equivalent charge up to 8 A-hr. Each curve represents a different pressure include line 191a at 10 bars, 191b at 20 bars, 191c at 40 bars, 191d at 60 bars, and 191e at 100 bars. Also included are lines 191f at 177 bars and 191g at 200 bars. The two high pressure curves are depicted as dashed lines it is difficult to contain gas at such gas pressures in small form factors.

For direct volumetric comparison the graph also identifies specific sized containers, namely volume 190a for the 14500 canister 184a also referred to as AA size in battery vernacular, volume 190b for 18650 canister 184b, volume 190c for the canister 184c also known as a Coravin capsule, and volume 190d for the 21700 canister 184d. Except for canister 184c, all the metal can sizes shown are limited to a maximum of 2.4 bars. Because of its heavier construction, canister 184c is capable of supporting at least 177 bars of compressed argon, and is shown as evidence that high pressure gas can stored in small form factor containers without leakage.

Specifically, calculated values of stored charge Q_{H2} in canister 184c include approximately 1 A-hr at 20 bars shown by marker 193b, 2.9 A-hr at 60 bars shown by marker 193b, 2.9 A-hr at 60 bars shown by marker 193b, 4.6 A-hr at 100 bars shown by marker 193e, and nearly 8 A-hr at 177 bars the commercial rating for canister 184c as represented by marker 193f. For comparison, the volumetric energy for lithium-ion cells is depicted by AA-sized 14500 form factors of volume 190a illustrated by markers 192a, 18650 sized form factors of volume 190b illustrated by markers 192b, and 21700 sized form factors of volume 190d illustrated by markers 192e.

General observations of this analysis reveals that line 191b representing 20 bars of pressure transects markers 192a meaning hydrogen at 20 bars pressure contains similar charge to AA sized lithium ion batteries at comparable sizes. Similarly, line 191d representing 100 bars of pressure transects both markers 192b and 192e meaning hydrogen at 100 bars pressure contains similar charge to 18650 and 21700 sized lithium ion batteries at comparable sizes.

Benefitting from the higher pressure capability of canister 184c, hydrogen at 20 bars shown by marker 193a contains comparable charge to 14500 AA sized Li-ion batteries 192a and double the charge at 40 bars shown by marker 193c. Hydrogen at 60 bars shown by marker 193d contains comparable charge to 18650 Li-ion batteries 192b and 70% greater charge at 100 bars shown by marker 193e. Moreover, hydrogen at 100 bars shown by marker 193e contains comparable charge to larger volume 21700 Li-ion batteries 192e. At nearly 8 A-hr depicted by marker 193f, taking full advantage of the pressure capability of canister 184c, 177-bar hydrogen holds roughly 10× the charge of 14500 AA-sized Li-ion batteries 192a, 2.7× the charge of the 18650 Li-ion batteries 192b, and 1.6× the charge of 21700 Li-ion batteries 192e. This analysis concludes that on a volumetric basis hydrogen is capable of between 1× to 10× the energy density of the lithium ion battery even in small form containers.

FIG. 24 is a log-log graph of capacity Q_{H2} measured in A-hr against pressure p ranging from 10 to 1000 bars. Canister volume varied parametrically include the small form factor low pressure canisters shown by dashed lines 195a, 195b, 195c, and 195e corresponding to the 14500 AA-sized canister 184a, a 10 ml volume in an unspecified container, the 18650 canister 184b, and the 21700 canister 184d respectively. As such, the maximum pressure for these form factors is shown limited to 30 bars. In contrast, the Coravin type capsule shown by line 195d, 20 bar marker 193b, 60 bar marker 193d, and 177 bar marker 193f operates at much higher pressures than thin metal canisters can support.

For larger form factors capacity-pressure lines include line 195f at 40 ml; line 195g at 100 ml; line 195h at 300 ml; line 195i at 1 L; line 195j at 3 L; line 195k at 10 L; line 195l at 30 L; line 195m at 100 L; and line 195n at 300 L. Also included on the graph is the equivalent energy of a 60 L tank of gasoline containing 34 kW-hr of energy. Converted into kA-hr assuming V_{FC}=0.8V and It=Pt/V_{FC} then the equivalent electrical energy in 60 L of gasoline is 43 kA-hr or if converted into electrical energy 700 A-hr per liter. This comparison is not a direct comparison of the energy content of gasoline to hydrogen. Volumetrically, methane and gasoline contain three time the energy of hydrogen. But converting hydrogen into electric current in a fuel cell is a direct process conserving charge, electron for electron, where at higher hydrogen pressures, there is more charge available per volume. Alternatively converting gasoline into electrical power involves burning the fuel to produce heat, then converting the heat into electrical energy using a turbine and generator. This process has an overall energy efficiency of only 34%, as such even though gasoline holds 3× the power of hydrogen, it converts energy into electrical power at ⅓^{rd} the efficiency. This means as long as the hydrogen pressure exceeds 300 bar, a fuel cell EV has the potential to match or even outperform a hybrid electric vehicle but without the carbon footprint of a combustion engine.

Minimum Gas Flow Rate. In order to prevent fuel delivery from affecting electrical generation, a minimal flow rate must be maintained The required flow to prevent reaction rate limited current generation can be calculated Faraday's law of electrolysis

Q=It=(zN)F
which states in an electrochemical reaction the charge Q is equal to the number of electrons expressed in moles (zN) times Faraday's constant. Faraday's constant is defined as the charge of an electron q times Avogadro's number N_{A} or

$$F = q {N}_{A} = ( 1.6023 \times 1 {0}^{- 19} coulombs / electron ) ( 6 \times {10}^{23} electrons ) = 96 , 485 coulombs / mole$$

Rearranging Faraday's equation for the number of moles N yields

$$N = \frac{Q}{z F} = \frac{It}{z F}$$

Given the aforementioned ideal gas equation also solved for N

$$N = \frac{P {V}_{g}}{{R}_{g} T}$$

Equating the two yields the relationship

$$\frac{{V}_{g}}{It} = \frac{{R}_{g} T}{z F P}$$

where given the flow rate FR≡(V_{g}/t) having units of cm³/sec, or more commonly as mL/min the equation may be rewritten as

$$\frac{F R}{1} = \frac{1}{z} [ \frac{{R}_{g} T}{F P} ] [ \frac{60 s}{min} ]$$

Evaluated for STP, i.e., standard temperature and pressure of 173° K or 0° C. and P=1 bar or one atmosphere becomes

$$\frac{F R}{1} = [ \frac{0.013945}{z} ] \frac{L}{min \cdot A}$$

where the ratio [0.013945/z] is defined as the GSC gas stoichiometry constant which varies by molecular species. As a diatomic unipolar molecule hydrogen z=2 mole-e⁻/mole H₂ while for oxygen z=4 mole e⁻/mole O₂. As such, at 1 A of current the STP GSC for hydrogen is 6.97 mL/min while for oxygen is 3.49 mL/min. If airs is used instead of pure oxygen, the 20.95% concentration of oxygen requires a five times higher flow rate or 16.6 mL/min. At a higher temperature of 25° C. and 50° C., the required flow rates are increased by 14% and 29% respectively. As summary of the gas parameters are included in the table below:

| | | Temper- | | | | |
|---|---|---|---|---|---|---|
| FC Chamber | Pressure | ature | | Anode | Cathode | |
| Gas | X | X | | Hydrogen | Oxygen | Air |
| | | | | H₂ | O₂ | |
| Purity | X | X | | 100% | 100% | 20.95% |
| 1A GSC at | 1 bar | 0° | C. | 6.97 | 3.49 | 16.66 |
| STP | | | | mL/min | mL/min | mL/min |
| 1A GSC at | 1 bar | 25° | C. | 7.95 | 3.98 | 18.99 |
| 25° C. | | | | mL/min | mL/min | mL/min |
| 1A GSC at | 1 bar | 50° | C. | 8.99 | 4.50 | 21.49 |
| 50° C. | | | | mL/min | mL/min | mL/min |

While the above rates represent the minimum flow rate per ampere per cell, they do not take into account mass transport across wider PEM membranes. So, although the minimum flow rate is the product of the GSC times the number of discrete cells (mn), in reality some guard band is required to account for diffusion and catalysis. Semantically, this guard band is called stoichiometric ratio SR, at minimum having values of 1.1-to-1.5 for H₂, and 2-or-more for O₂. Since unused gas is recycled, there is no penalty for running a higher flow rate. An SR rate of 2 to 4 may be used.

The equation for calculating the flow rate cells comprising an m-by-n array of cells each conducting current I_{FC} is given by the equation

FR=(mn)I_{FC}(GSC)(SR)
where FR is flow rate is measured in mL/cm²; n is the number of series cells in a stack; m is the number of parallel stacks, and I_{FC} is the fuel cell current for a given area; and the GSC gas stoichiometry constant.

Limitations in Scaling Fuel Cell Power. From the foregoing we can conclude that fuel cells hold great promise as a source of clean electrical power but suffer a number of intrinsic deficiencies preventing their practical use and widespread adoption. The biggest challenges limiting the utility of a PEM fuel cell is not the energy density of hydrogen but its electrical and electrochemical characteristics, specifically
The fuel cell voltage is too low. As described, the best case maximum fuel cell voltage is 0.8V per cell. When considering humidity and temperature variations, a more realistic voltage is 0.5V-to-0.6V per cell. This voltage is 13%-to-16% of a 3.75V lithium-ion battery, the industry standard for electric vehicles.
The fuel cell resistance is too high. Considering temperature and humidity variations the nominal resistance for a best in class PEM fuel cell today is approximately 10 per cm² of fuel cell. Compared to the 4 mΩ resistance of a standard lithium ion battery, the resistance is hundreds of times too high to support high current load transients and start up current demands.
The PEM fuel cell characteristics are highly dependent on humidity and temperature. At cold temperatures or dry conditions the PEM FC ceases to operate and has no means to jump start itself into operation.
The manufacturing, material science, and reliability of PEM fuel cells is either unknown or substandard. Effects like CO poisoning and corrosion can irrevocably damage fuel cell operation. Temperature cycling reliability studies are unavailable. Moreover, the existing PEM FC designs are actually engineering prototypes and therefore cannot be used to project reliability and yield issues scaled to production levels.

Among these issues, the first two bullet points in combination essentially render the real world application of hydrogen fuel cells useless. This problem is exemplified by FIG. 25 describing options to optimize FC electrical performance based on a fixed amount of available fuel cell area, i.e., the PEM surface area. Specifically, if we consider the best possible use of five FCs each 1 cm² in area, two options emerge—either to parallel the cells or place them in series. Starting with one cell of 1 cm² having a resistance of 10 or a figure-of-merit in specific-resistance of 10 cm² shown at point 198, then the remaining four cells can either placed in series with the first cell into a series array as shown by curve 196, or placed in parallel into a parallel array shown by curve 197.

Both solutions are problematic. In the case of a series array the stacked cell voltage for 5 FCs is five time higher than one cell, e.g., 2.5V instead of 0.5V, but the series 196 resistance is also five times higher than its single cell resistance 198 increasing from 1Ω to 5Ω. In essence the current handling ability remains unchanged, going from 0.5V/1Ω=0.5 A for a singe cell to 2.5V/5Ω=0.5 A for five series cells. Connecting five cells in parallel decreases the equivalent resistance 197 to one-fifth its original value 198, and thereby increasing the current capability 5-times, going from 0.5V/1Ω=0.5 A for a single cell to 0.5V/0.2Ω=2.5 A for five parallel cells. Unfortunately, the cell voltage remains an unusable 0.5V. So the choice is either to raise the voltage and lose current through higher resistance of a series array, or to improve the current and reduce the resistance but retain too low a cell voltage to be useful. In engineering, such a tradeoff is referred to as a lose-lose scenario.

The only real solution to this quandary is to increase the total number of cells by a series-parallel array comprising parallel strings or “stacks” of series connected cells as represented in FIG. 26. As such the array comprises m parallel stacks each of n series connected cells. For example, stack “a” comprises n-connected series cells 200aa through 200za; stack “b” comprises n-connected series cells 200ab through 200zb; . . . , stack “y” comprise n-connected series cells 200ay through 200zy; and stack “z” comprises n-connected series cells 200az through 200zz, where the array contains m-parallel connected stacks. Note that to a first order approximation, paralleling cells is the identical to increasing the active area of the PEM membrane. Specifically connecting five 1 cm² cells in parallel is electrically identical to making a single FC with a PEM area of 5 cm². As such the depiction of parallel sells as discrete components is illustrative.

So, with m parallel stacks of n series connected FCs the same nomenclature nsmp used for batteries may be adopted to describe the array. For example, a {n=2, m=3} array or 2s3p comprises three stacks of fuel cells, each with 2 series connected PEM membranes. A {n=8, m=7} array or 8s7p comprises seven stacks of fuel cells, each with 8 series connected PEM membranes. The equivalent lumped element model for such an array comprises a voltage source 202 having a net voltage nV_{FC} and series resistance 201 having a equivalent resistance R_{FC}=(nR_{FC})/m where increases m reduces the net resistance and where increasing n increases the total resistance.

The total charge delivered by the array is the sum of all the fuel cells Q_{H2}=mnQ_{FC}. Considering however that the total available charge is the hydrogen reservoir containing a fixed Q_{H2} amount of ampere-hours, the a more meaningful version of the same equation is Q_{FC}=Q_{T}/mn, meaning the total energy is divided evenly amongst the constituent fuel cells.

FIG. 27 includes table 203 summarizing the series combination of fuel cells up to n=8. If the minimum voltage of each fuel cell is 0.5V then 8V_{FC}=4V, a voltage similar to a lithium ion battery. If however each fuel cell has a minimum voltage of 0.6 then 7V_{FC}=4.2V and 6V_{FC}=3.6V not precisely equal to a single Li-ion cell in voltage. The relative relationship between m and n is shown in FIG. 28 which compares specific resistance R_{FC}A in Ωcm² on the ordinate axis to the value n on the abscissa varied parametrically where m=1 for line 212, m=2 for line 213, m=3 for line 214, m=4 for line 215, and m=6 for line 216, where increasing m lowers the next resistance. Not that whenever m=n as shown by line 217, the net resistance is identical to the single cell resistance 210, in the example shown 1 Ωcm². For example, line 214 intersects line 217 when m=n=3.Therefore it can be concluded in order to maintain a cell resistance no greater than single cell, cell array design must follow the rule m≥n. So to minimize resistance while matching the voltage of a lithium ion battery, applicable arrays include a 8s8p, 7s7p, or 7s8p array to minimize the impact of series resistance when stacking cells for higher voltages.

Even with a large array of cells the net fuel cell resistance is around 10, a value far too high to be useful for powering motors or to supplant lithium ion packs. So despite the ability for hydrogen fuel cells to compete with lithium ion batteries on an energy density basis, the high cell resistance complicated by ambient sensitive voltage and current is prohibitive for the application of fuel cells in real applications like consumer electronics, computing, electric vehicles, and uninterrupted power.

Problematic Applications for Fuel Cells. For fuel cells to compete with the lithium ion battery it must perform adequately in real world applications including motor drive, communication, and computing. FIG. 29 illustrates two such applications, namely brushed DC motor drive and brushless DC motor drive. As shown, in brushed DC motor drive a DC power source, in this case fuel cell array 300 delivers current IL(t) to an electrical load, in this case brushed motor 301. In a brushed DC permanent magnet motor, the rotating magnetic field is creating by redirecting current into various coils via electrodes on the rotor using conductor brushes. Neglecting the power transistor used to turn the motor on and off, in this application the fuel cell array voltage V_{FCa} is applied directly to the motor 301, whereby V_{FCa} (t)=VL. Alternatively, in brushless motor drive commutation is performed electronically by motor drive circuit 302 inserted between the fuel cell array 300 and motor 301. In brushless motors, the motor includes 3, 6, or more phases, only one phase of which is shown in the schematic. In such cases, the total current supplied by the fuel cell I_{FCa} (t) is the aggregated sum of the load current into each phase.

In practice, the motor drive control module 302 as shown in FIG. 30 generally includes a voltage regulator 304 with an input filter capacitor 303 producing a low voltage regulated output Vₗᵥ used to power a microcontroller μC 305 and the multiphase power stage, i.e., motor driver 306. Since power is consumed by these three components, then necessarily I_{FCa}(t)>I_{L}(t). In the example shown, the low voltage regulator 304 output provides power to motor driver 306 and thereby motor 301, then the voltage is limited to low voltage, typically between 3V-to-24V with 5V being commonplace.

When higher motor torque is required, for example in an electric vehicle, a high voltage in preferable to low voltage motors because of lower currents and less heat loss to winding resistance in motor 301. In such instances motor drive module 302 includes both high voltage and low voltage components as shown in FIG. 31. As shown voltage input V_{FCa} from fuel cell array 300 filtered by capacitor 303 powers two DC/DC converters, generally comprising switching regulators including low voltage regulator 304 and high voltage regulator 307. Low voltage regulator 304 generally comprises a step down type regulator producing an output voltage Vₗᵥ lower than its input voltage V_{FCa} used to power microcontroller μC 305. The microcontroller in turn generates drive signals to control motor driver 306 connected to motor in one or more phases.

As a step down circuit, low voltage regulator 307 may comprise a linear regulator or a switching regulator comprising a Buck converter or synchronous Buck converter topology. The design of high voltage regulator circuit topology depends on the relative voltage of fuel cell 300 and the desired operating voltage of motor 301. If the fuel cell array has a lower voltage than the motor being driven, i.e., V_{FCa}<V_{L} then high voltage DC/DC converter 307 likely comprises a boost converter topology. Conversely, if the fuel cell array has a higher voltage than the motor being driven, i.e., where V_{FCa} >V_{L} then DC/DC converter 307 likely comprises a synchronous Buck topology or may be eliminated altogether directly connecting motor driver 306 to the fuel cell.

While these topologies appear to be good application prospects for fuel cells, in reality none of them work. The issue is the fuel cell has too have of an impedance to drive a motor directly, especially during startup where a high surge current is needed to overcome inertia called stiction. The motor startup problem is exemplified in the electrical waveforms FIG. 32 including the load current waveform IL(t), the pulse width modulator duty factor D(t) used in the high voltage DC/DC regulator 307 (in this example as a boost converter), the regulator output Vₕᵥ used to power the motor driver, and the motor rotational velocity w (t). Aside from small voltage drops across conducting power MOSFET transistors, when the motor is turned on regulator output Vₕᵥ and the motor voltage waveform V_{L}(t) are essentially identical. The graph is divided phenomenologically into four intervals of time described as (a) off, (b) stiction, (c) FC limits current, and (d) FC voltage collapses. Although the example described uses the high voltage terminology the waveforms are generally applicable for both high voltage and low voltage motor drive applications.

In the off interval before time 310b, the motor is off and load current IL(t) 311a is essentially zero except for small currents used to periodically monitor for faults such as open circuits, disconnections, etc. During this interval motor rotational speed 314a is zero, the high voltage supply voltage 313a is constant and unloaded, and the switching regulator is operating in light load mode with narrow pulses 312a. At t_{b} identified the time 310b, the motor drive is activated causing the motor current I_{L}(t) to rise rapidly 311b. Sensing a small drop in its Vₕᵥoutput voltage 313b, the pulse width modulator's duty factor immediately reacts to compensate, increasing 312b to transfer more energy to the load. Because the rotor has not started turning 314b, held in place by inertia referred to as the static coefficient of friction, aka stiction, then ω(t)=0, there is no back emf to counter the drive voltage and the current demand on the fuel cells is at its greatest level. At time t_{c} shown by time line 310c, the rotor starts turning 314c. Because of its poor current delivery capability and high resistance, fuel cell 300 is unable to fully supply the requisite current whereby the duty factor 312c immediately jumps to the maximum amount typically D=95% (but not 100% because they need to keep switching to maintain stable operation). Despite this rapid adjustment and longer switch on time, the regulator cannot maintain voltage and the output voltage Vhv (t) continues to sag 313c causing a corresponding drop in current 311c delivered to the motor. The motor rotation velocity 314c then stalls, unable to achieve a minimal ω(t) to overcome the dynamic coefficient of friction. With zero velocity, the back emf of the motor drops to zero 314c causing a last desperate attempt to jump start the motor through a temporary rise in motor current I_{L}(t) 311c just prior to time 310d labelled time t_{d}.

Failing this attempt the fuel cell or the motor begin to overheat resulting in a steady and decline in supply voltage Vₕᵥ (t) 313d and motor current I_{L}(t) 311d during the final interval following time 310d. This condition is generally irrevocable as the converter and fuel cell are doing everything possible to start the motor with the PWM duty factor 3212d maintained at its maximum, and the back emf remaining at zero because the rotor velocity 314 is stuck at zero. As such an unaided fuel cell cannot support motor drive.

Even if by some miracle the motor could start, for example by pushing the car or rolling it down a hill so that at time 310b, the rotor velocity ω(t_{b})>0 at turn on, unlike a conventional gasoline engine or an EV with regenerative braking any electricity has no where to go because conventional PEM fuel cells cannot operate reversibly by splitting water into hydrogen and oxygen the way electrolysis does. This means, EV driving range is further reduced as inertial energy routinely recovered during regenerative braking in al commercial battery powered electric motor driven vehicles will instead be lost as heat, not recovered.

Aside from electric vehicles for transportation including cars, trucks, vans, and recreational vehicles, motors are abundantly present in homes, factories, mass transit systems, airplane terminals, and construction. For example, motor powered homes appliances include refrigerators, washing machines, dryers, heating-ventilation-air-conditioning (HVAC) systems, room and exhaust fans, water pumps for pools and sump pumps, and more. Battery backup for home power will therefore be subject to all the same troubles as defined above except that the DC/DC converter is replaced by a DC-to-AC inverter, which functions must the same way as a boost converter except producing sinusoidal output power. As in home power backup, another big market is a power wall—a home storage device used for capturing energy produced from a photovoltaic array such as batteries. But a fuel cell cannot store electrical energy. Restaurants, schools, and hospitals have similar requirements for driving motors and for capturing and storing solar energy from photovoltaic arrays. Again, today's best in class fuel cells are incapable of supporting these use cases.

Another class of electrical load involves communication devices. Communication devices include WiFi routers, cable boxes, cell towers, along with mobile devices, emergency services, walkie talkies, cell phones, repeaters, emergency mobile towers, and more. More than virtually other use of power, communication systems require backup power during power outages and disasters when electricity is unavailable but when need is greatest. Examples of extended power outages include the Fukushima-Tohoku earthquake and tsunami disaster, the Katrina hurricane, the 2022 Texas deep freeze and power grid failure, the 2011 southwest blackout accident, California wildfire power failures attributed to PG&E such as the Dixie fire, and more. In many cases, the power grid remains inoperable for weeks. The value of hydrogen backup power in such scenarios cannot be overstated.

An example shown in FIG. 33 comprises a fuel cell array 300 powering an RF module 330. In one simplified yet exemplary schematic representation 330a, the RF module includes two dominant electrical loads comprising RF transceiver 331 and radio frequency power amplifier 334 and antenna 334a. Often these components are directly connected to a voltage source in able to suppliant extremely fast current transients of over 1000 A/μs. Unfortunately, unable to react to rapid electrical transients and suffering high series resistance, hydrogen fuel cells are poorly suited for such applications.

The load transient problem which can occur in servers and computers too, is especially problematic in communication as devices remain in a quiescent state doing essentially nothing the suddenly wake up without warning demanding full current. Rapid current demand occurs concurrently in both RF power amplifier 334 and in the digital or mixed signal RF integrated circuit used to realize transceiver 331, the combination of the two further exacerbating the current transient and the challenge of delivering power on demand without warning.

FIG. 34 illustrates typically waveforms of an RF communication module in three intervals (a) sleep, (b) sniff, and (d) active modes. In the sleep interval prior to time t_{b} shown by time event 335b, switching voltage regulation within the transceiver IC and RF PA operate in light load with narrow pulses 337a, load current demand I_{L}(t) 336a is very low, e.g., leakage current, and supply voltage V_{L}(t) 338g remains constant. At time t_{b} the transceiver wakes up to sniff for RF signals called pings used to update the local network router what devices are connected.

The sniff creates a short spike of current 336b and a temporary dip in voltage V_{L}(t) 338b causing a momentary increasing in duty factor 337b where the voltage recovers 338c as the current returns to its quiescent level 336c, after which the pulse widths return to their light load mode 337c. At time t_{d} shown by event line 335d, the module commences active communication whereby the current 336d instantly jumps to the full load condition I_{L}(t)=I_{xcvr}(t)+I_{rf}(t). Immediately the load voltage drops 338d, in part because the current increase is to fast and too great to be supplied by filter capacitors.

Sensing the voltage drop, the internal regulators within the transceiver and RF PA ICs jump to their maximum D value 337d allowing for some small voltage recovery 338e. Because of the slow response and high resistance, the greater duty factor cannot compensate for the performance degradation of the fuel cell and final voltage V_{L}(t) shown by 338f is below the minimum voltage specification 339 of the RF module, i.e., where V_{L}(t)<Vₘᵢₙ. Such a condition constitutes a system failure of the RF module.

Another class of application for fuel cell backup power is computing. As shown in FIG. 35, fuel cell array powering notebook 350 include implementation 350a comprising a lithium ion battery pack 351 with input current I_{bat}(t). The battery pack in turn powers computer system 352 with load current I_{L}(t). While it may appear than the fuel cell array is in parallel with the battery where V_{FCa}=V_{bat}, this is in fact not the case. Instead, as illustrated is FIG. 36, the lithium ion battery pack is actually a complex circuit comprising battery array 357, CI-CV charger 356 with input filter capacitor 355a, cell balancer 358, battery disconnect switch BDS 359 with an output filter capacitor 355b.

The functions of these components are quite complex. CI-CV charger 356 charges the cell array with a constant current (CC) mode until the cell array reaches a specified voltage, then the charger transitions to a constant voltage (CV) mode allowing the maximum possible charging current.

The function of cell balancer 358 is to make sure every cell connected in series maintains precisely the same voltage. The function of batter disconnect switch BDS 359 is to disconnect the battery array from the electrical load in the event of a shorted load, over current, battery overvoltage, or over temperature conditions.

The compatibility of using a fuel cell as a source of charge for an array of lithium ion cells depends on the relative voltage ratio of fuel cell array 300 versus the lithium ion cell array 357. In this regard the number of parallel fuel cells in the lithium ion array are not important for determining if a fuel cell can be used as a power source for a lithium ion pack, only how many Li-ion cells are connected in series. Accordingly FIG. 37 represents the lithium ion cell array as a series connection of four cells, namely 362a, 362b, 362c, and 362d. In the case of a direct connection between fuel cell 300a and 4s lithium ion stack 362a-362d, a 1s1p fuel cell 360, i.e., where n=1, m=1 with an effective area of 1 cm² has guaranteed minimum voltage of 0.5V and a series resistance 361 of R=1Ω. Because V_{FCa}<<V_{bat} it is not possible to for the fuel cell to charge the pack.

In order to boost the fuel cell voltage of the same 1s1p fuel cell array 300a, a boost converter is shown comprising inductor 363, power MOSFET 364, PWM controller 365, rectifier 366, and filter capacitor 367 powering 4s lithium ion stack 362a-362d. In operation, power MOSFET 364 is turned on. In a boost converter, the magnetizing half cycle involves energy being transferred from the power, in this case fuel cell array 300a, conducts current I_{FC}=I_{sw}(t)=V_{bat}/(R_{FC}+R_{sw})<0.5V/1Ω=500 mA assuming the power MOSFET switch resistance R_{sw}<<R_{FC}. In the second half cycle, the transfer phase, MOSFET 364 is turned off causing inductor 363 to drive the node voltage Vₓ above V_{bat} forward biasing rectifier 366 delivering power from inductor 363 into the lithium ion cell array.

To boost the voltage from 0.5V to 16V worst case requires a PWM duty factor determined by 1 minus the input-to-output voltage ratio, where D=(1−V_{FCa}/V_{bat})=(1-0.5/16V)=97%. Under the principal of energy conservation, input power must equal the output power whereby

$${P}_{i n} = ( {V}_{F C a} ) ( {I}_{s w} ) = ( {P}_{out} - {P}_{l o s s} ) \approx ( {V}_{b a t} ) ( {I}_{b a t} )$$

or by rearranging where I_{bat}=I_{sw}(V_{FCa}/V_{bat})=500 mA(0.5V/16V)=16 mA. This current is well below the targeted current of 5 A, specifically 97% undercurrent. As such a boost converter does not solve the power transfer problem.

An alternative shown in FIG. 38 is to employ a substantially higher voltage fuel cell, one where n=40, i.e., stacking 4o cells in series, but where m=1 meaning no cells are paralleled to reduce resistance. The resulting 40s1p fuel cell 300b is represented by a series combination of a voltage source 370 at V_{FC}=40(0.5V)=20V and resistor R_{FC}=40(1Ω)=40Ω. Given a 20V source powering a 4s lithium ion stack 362a-362d at 16V worse case, then the maximum current is given by I_{FC}=(20V−16V)/40Ω=100 mA which is only 0.2% of the required current. At 100 mA, this severe undercurrent renders a high voltage fuel cell stack useless when charging an industry standard 4s lithium ion pack.

The only option to increase the current in the forgoing design is to adjust the fuel cell array to 40s40p design, with n=40 series connected parallel banks of m=40 cells, each with an area of 1 cm². The resulting fuel cell array 300c shown in the rightmost schematic in previously shown FIG. 38 containing a total fuel cell membrane area of A=mnA_{FC}=(40)(40)(1 cm²)=1600 cm², an area 2.5 times that of a standard 650 cm² large notebook computer. This design rendering the fuel cell too large and expensive to power a notebook. Stacking the membranes reduces the area but not the cost per watt delivered.

Even with its large 40s40p fuel cell array, the design fails to meet the target 5A current. Specifically, at R_{FC}=10, the aggregate fuel cell array resistance 374 is still high. Directly charging a 4s stack of Li-ion cells 362a-362d at 16V from fuel cell voltage source 373 at 20V is limited in charging current to I_{chrg}=(V_{FCa}−V_{bat})/R_{FC}=(20V−16V)/1Ω=4 A, 20% less than the targeted changing current for a notebook battery pack. The charging undercurrent problem can, for added expense, be solved by utilizing a step down switching voltage regulator 379 comprising a synchronous Buck topology.

As shown the switching regulator 379 comprises P-channel MOSFET 374 acting as a converter switch, inductor 376, PWM controller 377, synchronous rectifier N-channel MOSFET 375a and integrated P-N diode 375b. Operation of the Buck converter involves two phases (i) passing energy to the load, and (ii) recirculating current. During the first phase, P-channel MOSFET switch 374 is turned on with a resistance R_{sw}, allowing current to flow from voltage source 373 at voltage V_{FCa} to the battery stack 362a-362d at voltage V_{bat}. The charging current I_{chrg} is then given by I_{chrg} =(V_{FCa}−V_{bat})/(R_{FC}+R_{sw})=4V/10=4 A assuming R_{sw}<<R_{FC}. During this interval, current in inductor 376 ramps up storing energy in its magnetic field.

In the second phase, P-channel MOSFET switch 374 is turned off during which time the inductor 376 drives the voltage V_{y} below ground forward biasing PN junction 375b of N-channel synchronous rectifier MOSFET 375a. Nearly synchronous to this voltage polarity change, the channel in synchronous rectifier MOSFET 375a is turned-on, shunting the diode current from PN junction 375b reducing the rectifier's net voltage drop, power loss, and stored charge. During this time inductor current recirculates through the synchronous rectifier and filter capacitor 378 draining energy out of inductor 376 and reducing its current.

After a fixed period, the N-channel synchronous rectifier MOSFET 375a is turned off and P-channel MOSFET switch 374 is turned off, repeating the entire cycle. So long that the switching frequency controlled by PWM controller 377 is high compared to the time constant of the filter circuit comprising inductor 376 and capacitor 378 the inductor acts like a quasi constant current source delivering a fixed charge to capacitor 378 regulated by feedback to a target voltage V_{bat}. From conservation of energy for a synchronous Buck regulator Pᵢₙ=Pₒᵤₜ whereby (V_{FC})(I_{chrg})=(_{bat})(V_{bat}). Rearranging terms I_{bat} =I_{chrg} (V_{FC}/V_{bat})=4 A (20/16)=5 A. As such, the output of the synchronous Buck converter is higher than its input, and therefore able to meet the voltage and current requirements for charging the batter, albeit the prohibitively high cost of a large fuel cell.

FIG. 39 illustrates the same system except that the fuel cell comprises a 40s20p design with a total PEM area of A_{FCa}=(mn)A_{FC}=(20)(40)(1 cm²)=800 cm². So although the voltage source 383 remains at 20V, unfortunately the fuel cell resistance 384 doubles to 20 decreasing the battery charging current to 2.5 A, resulting in an expensive yet slow charger. Worse yet a Buck converter cannot charge a lithium battery at a constant voltage without potentially damaging the cells or causing a fire. This is because a constant voltage (CV) charger will deliver any current necessary to reach the targeted voltage.

In the case of a discharged battery where each cell is 2.7V and V_{bat}=10.8 V, the charging current would be I_{bat}=[(20V−10.8V)/2Ω][20/(10.8)]=9.2 A(1.85)=17 A. This current is unsafe for charging. So when the battery is charged it charges at only 2.5 A resulting in unacceptably slow charging but when the battery is discharged the current is 17 A creating an unsafe condition. If a nominal charge condition is 5 A the maximum safe rating for a lithium ion battery would be Q=2C, or roughly 10 A. A conduction at 17 A corresponding to 3.5C is too high for safety.

The solution to this problem is employ a more complex charger circuit called a CI-CV charger, i.e., a charger that switches modes from a constant current source to a constant voltage source as the battery charges. A conceptual representation of CI-CV charger 403 is shown in FIG. 40. connecting fuel cell array 400 to Li-ion battery pack 407. Necessarily Li-ion battery pack 407 contains other protection electronics not shown in this schematic for the sake of clarity. As shown previously the actual ability for a fuel cell to charge a series array of Li-ion cells depends on the relative magnitudes of V_{FCa} and V_{bat} of fuel cell array 401 voltage and battery pack 407 respectively, along with fuel cell resistance R_{FC} represented by lumped element resistor 402. As depicted block function form, the functions of CI-CV charger 403 include a constant current (CI) mode linear charger 404, a constant voltage (CV) mode switching charger 405 implemented using synchronous Buck converter topology, and a mode selector switch 406 to automatically transition from Cl mode to CV mode during charging.

Exemplary waveforms of the CI-CV charger shown in FIG. 41 are arranged into three intervals, namely discharge; constant current (CC) charging; and constant voltage (CV) switch-mode charging. As depicted, prior to charging during discharge mode a negative current 391 flows out of the battery causing V_{bat}(t) the battery voltage 393a to discharge at a rate depending on the system's current consumption of its electrical load. During the discharge interval the charger current 392a remains at zero. To concurrently charge and deliver power to an electrical load requires additional circuitry not germane to this disclosure and is therefore not discussed here.

At time t_{cc} denoted by event time line 390b charging commences. If the battery is discharged, the charger immediately wakes up in the CI mode where I_{chrg} is a constant value 392b. Except for minor perturbations caused by temperature and small amounts of power consumed by battery pack electronics, the current flowing into the Li-ion cells is also constant 391b causing the cell to charge. Since the charge increase is constant, the voltage of the electrochemical cell increases linearly 393b as charge Q(t) is the time integral of current, and where V_{bat}(t)=Q(t)/C_{Li+} and where C_{Li+} is the battery's equivalent capacitance, essentially constant during Cl charging. At time t_{CV} when V_{bat} (t) reaches a specified voltage 393c, shown by line 390c, the charging mode changes to constant voltage (CV) charging imposing a constant voltage representing the target voltage for the battery.

At that time, I_{bat} immediately jumps to a current 391c, a level significantly higher than the CI current 391b. Accordingly the battery voltage 393d rises quickly slowing as its approaches it target value and the charging current 391 declines asymptotically. When the voltage reaches is final value the charging current goes to zero except to resupply any charge lost to self discharge. The importance of finishing lithium charging with a specified voltage limit is critical as constant current charging can cause an overvoltage condition in the battery leading to fire or explosion risks. Conversely switching to a PWM mode prematurely can cause excessive current demand on fuel cell 400. Because a fuel cell does not behave as a stiff voltage source, any significant demand by switching charger 405 can cause V_{FCa} of fuel cell stack 401 to drop whenever charger switch 374 turns on. This behavior is especially problematic in pulse charging mode using pulse width modulation (PWM mode).

As shown previously in FIG. 41, a common method for CV charging today uses PWM pulsed charging. The method employs high current pulses with initially high duty factors like pulse 392d which diminish in width 392e as the battery voltage approaches its target. FIG. 42 illustrates the average inductor current superimposed atop the pulse waveforms initially peaking at current 292c then declining 392z during charging. Although this waveform typifies pulsed charging from an AC adapter able to supply high currents, the current capability of a fuel cell is limited by a high series impedance and by a counterposing polarization voltage that effectively decrease V_{FCa} at high current densities.

The net effect of these two phenomena is that the fuel cell cannot deliver the required current instead producing a lower current pulse 394d resulting in an initial charging current 394c substantially lower than the current 392c. Because the current is limited by the fuel cells source, the on-time of successive pulses such as 394e remains higher in duty factor than 392e when pulse current is not limited. As such the charging curve 394z is significantly slower than the desired charging profile of curve 392z.

In actuality, pulse charging from a fuel cell source is even worse because of system partitioning. As shown in FIG. 43, fuel cell 400 does not connect directly to CI-CV charger 403 because the charger is actually located within or near battery pack 403 and cannot accept a widely varying unregulated voltage source such as fuel cell 400. Instead, the fuel cell voltage V_{FCa} shown as lumped-element voltage source 401 must be regulated by switching regulator 406 in order to power CI-CV charger 406. Even worse, every time the high side switch 408 in switching regulator 406 turns on, the sudden increased current demand can cause voltage V_{FCa}of fuel cell stack 401 to sag, thereby being unable to properly supply a usable voltage to C_-CV charger 403. The conflict between current spikes in switching regulator 406 and switching charger 405, means the unrelated switching waveforms for MOSFETs 374 and 408 may result in countless potential conflicts, electrical instabilities, and system malfunctions.

Summary of Existing Fuel Cell Limitations. Before summarizing the inventive features of the buffered fuel cell and intelligent buffered fuel cell, it is useful to review the problems the disclosed invention is designed to overcome. Simply put, the most fundamental challenge preventing the commercialization and widespread adoption of present day fuel cells is they don't work. Of its endless limitations, one of the greatest issues with fuel cells is their difficulty driving real-world electrical loads. This limitation is especially true of a PEM membrane hydrogen fuel cell which suffers from a low electrochemical potential i.e., a low cell voltage, too high of impedance, and a current-dependent cell voltage.

Together these effects cause the voltage of a fuel cell to drop precipitously with increasing load current. This voltage sag and rapid dropout means any reasonably sized fuel cell cannot be used as a stiff voltage source, essentially restricting the maximum load current. For example, operating a fuel cell at only 0.9 A/cm² a hydrogen fuel cell can lose 95% of its cell voltage. With such severe voltage dropout, oversizing a fuel size to lower its current density and mitigate dropout is not practical. For example, a fuel cell able to deliver 5 A may need to be oversized to conduct 100 A making the fuel cell overly large, heavy, and costly.

Aside from the current-density voltage sag problem, another challenge exacerbating fuel cell use is a low cell voltage. To match the 3.6V-to-4V range of a lithium ion battery a stack of fuel cells is required. Assuming a single cell voltage of V_{FC}=0.5V at a current density of 0.2 A/cm², the number of series connected fuel cells required to match or exceeds a battery's voltage is n≥8. Assuming a fuel cell area A_{FC}=2 cm², the resistance of a hydrogen PEM fuel cell is 0.6Ω. As such the series stack of fuel cell has a resistance nR_{FC}=8(0.6Ω)=4.8Ω. With a fuel cell stack voltage of 4V, the peak current delivered into a dead short is I_{FC}=nV_{FC}/nR_{FC}=V_{FC}/R_{FC}=4V/4.80=0.83 A. In a real world application, e.g., sourcing power to a 3V load, the fuel cell current is reduced to I_{FC}=(nV_{FC}−Vout)/nR_{FC}=(4V−3V)/4.80=0.21 A.

By contrast a 18650 Li-lon battery with an active anode area of 2 cm² has a resistance of 4 mΩ and its able to deliver 1000 A into a dead short and 250 A into a 3V load. This means the Li-ion battery's power delivery capability outperforms the fuel cell by more than three-orders-of-magnitude. In other words, a hydrogen fuel cell needs a lower impedance and a stiffer voltage to be useful. This prevents the fuel cell from driving loads, powering the input. Aside from its limited power delivery capability, the fuel cell voltage and resistance depends strongly on environmental conditions of relative humidity, temperature, and gas flow rates, especially problematic in dry cold climates.

For the foregoing reasons, a fuel cell is incapable of directly powering most electrical loads., including motors, digital and RF circuitry, and lithium ion batteries or their charge circuits. Electrical deficiencies of hydrogen fuel cells and especially PEM fuel cells include the following:
High internal cell resistance of approximately 1000 mΩcm² severely limiting transient current and steady-state DC current capability.
Low cell voltages, as low as 0.3V per cell.
Poor competitive performance against lithium ion batteries with resistances at 4V of up to 80, as much as 2000 times greater.
Cell voltages that decline with increased current conduction because of electrochemical effects (other than resistive voltage losses).
Electrical characteristics highly dependence on humidity and temperatures including inability to operate at relative humidity below 35% and inability to operate at temperatures below freezing.
Unknown electrical behavior driving high frequency loads with fuel cell AC impedance may affect system performance.
Inability to absorb or store energy from a generator, photovoltaic array, or any transient power source such as regenerative braking.
Inability to communicate fuel cell status to a system.
Inability to communicate with fuel storage to assess remaining energy capacity.
Inability to stack cells to high voltages without commensurate increases in resistance and a net reduction in transient current handling capability.
In ability to safely isolate fuel cells from high voltages present when stacking cells.

What is needed is a significant improvement and fundamental redesign to fuel cells to improve their electrical performance and functionality to be competitive with lithium-ion battery packs including the means to drive the full spectrum of electrical loads. Many of the foregoing problems are result of an energy, voltage, or impedance mismatch between the fuel cell and the electrical load it is intended to drive. Other improvements required include the ability to compensate for environmental effects of humidity, temperature, and power cycling, to communicate with the electrical system or load relying on the FC module's power, and the ability to absorb and retain recycled and environmentally harvested energy or grid power—a function fuel cells are incapable of performing today. Another important feature of the invention is high voltage isolation needed for ensuring safe operation.

Without the innovations described herein to address these enumerated issues, the fuel cell technology of 2023 is not a viable source of power.

### SUMMARY OF THE INVENTION

A buffered fuel cell able to safely generate electricity from a fuel source such as hydrogen or other fuel sources, store the generated charge, and supply the stored energy to an electrical load at a low electrical impedance is described herein.
in one embodiment of this invention, a buffered fuel cell BFC comprises a fuel cell stack, a charge transfer regulator QXR, and an electrical buffer whereby;
fuel cell stack converts fuel into electrical power using two or more coupled electrochemical processes typically involving oxidation and reduction reactions;
electrical buffer comprising a battery, capacitor, or electrochemical storage device concurrently stores the generated electric current as electric charge; and whereby
charge transfer regulator QXR controls charge transfer and regulates the buffer-charging process.

As such QXR operation guarantees (i) the buffer voltage remains within a specified range regardless of operating fuel cell voltages, (ii) the maximum fuel cell current does not exceed a specified current or current density; and (iii) the buffer charging current does not exceed some specified current or C-rate; where any current delivered to electrical load in excess of the current limit setting of QXR is supplied from electrical buffer, not from the fuel cell array; and where any fuel cell stack generated current in excess of current delivered to an electrical load is used to charge electrical buffer up to its maximum voltage, above which charging is terminated to avoid overcharging the buffer cells. In this manner, the buffered fuel cell essentially isolates the electrochemical fuel cell from the electrical load acting as an intermediary to protect the fuel cell from excessive current demands by an electrical load which the fuel cell cannot realistically supply even for very large area fuel cells.

In another embodiment, an electrical buffer in buffered fuel cell BFC is capable of being charged from multiple energy sources comprising both fuel cell stack and external electrical power source. Unlike an uninterrupted power supply or EV battery which requires a stable power source like the AC mains for charging, electrical power source may be intermittent comprising unstable power sources including renewable power from solar arrays, wind turbines, or from energy recovery such as regenerative braking. During operation, the BFC is capable of concurrent charging of ab electrical buffer from both an external electrical power source and from its fuel cell stack without overcharging the electrical buffer. Although QXR prevents its overcharging of electrical buffer from fuel cell stack, the basic buffered fuel cell BFC does not include protective provisions to prevent buffer cell overcharging from electrical power source, or to prevent over-discharging caused by electrical load. As an upgrade to BFC 1600, these intelligent protective embodiments referred to herein as an intelligent buffered fuel cell or iBFC involve additional circuitry not required in the basic BFC implementation.

In one embodiment of this invention, a QXR charge transfer regulator comprises a multi-function current-limited voltage-clamp controlling the current flow between input in output whereby (i) input current is limited to a specific current, (ii) or output current is limited to a specific current, or (iii) a voltage clamped output set not to exceed a specific output voltage, whereby QXR current is dominated by the most limiting of the three criteria. If none of the three limits are reached the QXR functions like a resistor. In another embodiment the QXR input comprises an energy source such as a fuel cell which may include a hydrogen PEM fuel cell. In yet another embodiment and output is connected to an electrical buffer able to store electric charge which may comprise a capacitor, a battery, or other charge storage element.

In various embodiments the charge storage buffer may comprise a single-cell lithium ion battery limited to under 4.2V, two lithium-ion cells connected in series limited to a maximum voltage of 8.4V, or four lithium-ion cells connected in series limited to a maximum voltage of 16.8V. In another set of embodiments the input is connected to a stack of fuel cells where the input current is limited to pre-defined current density ranging from 100 mA/cm² to 1000 mA/cm². In another set of embodiments the output is limited by the maximum charging current of a lithium ion cell such as 2C for a 1s1p buffer array, 4C for a 1s2p array, or multiples thereof.

In another set of embodiments the range in fuel cell output voltages exceeds, at least in part, the voltage range of the buffer cell and where the voltage of the buffer cell exceeds the required voltage of the load the buffer powers. In another set of embodiments the voltage rating of the process used to manufacture the QXR exceeds the maximum voltage of the fuel cell including a 5V process rated at 5.5V for a QXR charging a 1s Li-ion cell, a 12V process rated at 13.2V for a QXR charging a 1s or 2s Li-ion cell array, a 15V process rated at 18V for a QXR charging a 2s Li-ion cell array, or a 30V process used to facilitate QXR charging of a 4s Li-ion cell array. In another set of embodiments, the BFC buffer may be charged by either the fuel cell, an external electrical power source, or concurrently by both without exceeding the maximum safe buffer voltage.

In another set of embodiments an electrical load draws most of its power from the BFC buffer without substantially increasing the current demand on the fuel cell stack. In a related embodiment, fuel cell generated power recharges the charge depleted in the buffer whenever the load demand is low. In yet another embodiment, the QXR can disconnect the fuel cell stack from the buffer to disable buffer recharging during a fault condition, sleep mode, or while executing measurements.

Note that at any one instant only one of the three QXR functional criteria namely, a current limited input, a current limited output, and a voltage clamped output can determine the conduction. In some circumstances, none of these functions determine the QXR current. In general, however for any given fuel cell and buffer design at least two of the criteria are required over the BFC's spectrum of operating conditions—either output voltage clamping following input current limiting, output current limiting following output current limiting, or some scenario in which all three participate.

In one embodiment of this invention, the QXR charge transfer regulator controls the charging of the electrical buffer using multi-mode charging comprising a sequence of optional trickle charging, constant current CI-mode charging, and constant voltage CV-mode charging depending in the state-of-charge of the buffer. For deeply-discharged buffer cells where V_{buf}Vₘᵢₙ for example below 3V, trickle charging is performed at 10% of the current of the value of constant current charging. For buffer voltages greater than Vₘᵢₙ but below (Vₙₒₘ+6) constant charging current is employed comprising either a linear regulated current of Iₘₐₓ or PWM pulses each current limited to a magnitude Iₘₐₓ. For buffer voltages in the range from (Vₙₒₘ+6) to V_{OC} constant voltage charging either using a linear voltage-mode charger or a current-limited PWM charger where the current is limited to Imax. The value of voltage δ is a design parameter used to adjust the transition from CI mode to CV mode which may not be precisely the same voltage as the nominal battery voltage Vₙₒₘ.

Irrespective of performing charging in trickle, CI, or CV charging modes or whether using linear or PWM charging control, the maximum current conducted by the QXR is limited to a buffer charging current Iₘₐₓ where Iₘₐₓ is determined by either the maximum allowable current of the fuel cell I_{FC}(max) or the maximum allowable buffer charge rate I_{buf}(max), whichever is lower. This limitation distinguishes QXR charging over conventional battery charging which assumes a stiff voltage source with unlimited current capability as the charger input.

In one embodiment, the magnitude of the maximum charging current is limited by the fuel cell to a value Iₘₐₓ≤mA_{FC}[I_{FC}/A] where [I_{FC}/A] is a fuel cell specific design parameter ranging from 100 mA/cm² to 1000 mA/cm². In another embodiment magnitude of the maximum charging current is limited by the buffer to a charge rate of 2C which may by example comprise 6 A to 8 A for various 1s1p Li-ion buffers and 12 A to 16 A for various 1s2p Li-ion buffers.

In one embodiment an intelligent QXR charger has the ability to disconnect the QXR input connected to a fuel cell stack from the QXR output connected to an electrical buffer in order to perform voltage measurements, then use the measured data to determine the best charging conditions and algorithms. In another embodiment, the algorithm determines the optimum number of fuel cells n in the series stack to produce a total voltage nV_{FC} falling within a targeted band of voltages. The stack voltage is thereby dynamically adjusted by reconfiguring the fuel cell's topology either increasing or decreasing the number of cells in the series circuit using semiconductor switches such as MOSFETs. In another embodiment the iBFC is able to report the charging progress and battery condition over a serial communication bus to the system relying on its power.

In one embodiment the number of series connected fuel cells in the stack is selected using a digitally controlled analog multiplexer to select which cells are included in the string. In yet another embodiment, disabled cells are shunted by paralleled switches such as MOSFETs to divert current around the cell and concurrently microvalves are closed to disable gas flow to disabled cells.

In another embodiment, the operating band of voltages for the fuel cell stack should exceed the maximum buffer voltage V_{OC} so as to be capable of fully charge the buffer. In yet another embodiment, the stack voltage nV_{FC} shall remain below some maximum voltage Vₘₐₓ to prevent damage to the QXR transistors. Voltages of common integrated circuit processes used to fabricate the QXR and dynamic fuel cell switches include absolute maximum voltage values. of 5.5V, 13.2V, 18V and 30V. In another embodiment the fuel cell stack maintains the optimum voltage range for fully charging the buffer cell, the buffer cell is able to recharge itself, and the QXR supports the minimum voltage differential to maintain maximum operating efficiency.

An iBFC intelligent buffered fuel cell comprises a buffered fuel cell including a static or dynamic fuel cell array, a electrical buffer, and an intervening QXR charge transfer regulator that controls the transfer of energy between the fuel cell and buffer by preventing overcharging of the buffer and as needed limiting the current flow, and where said iBFC includes energy management functions comprising at least one of the following:
(i) an energy recovery circuit module able to safely transfer external electrical energy into the iBFC's electrical buffer in a manner preventing overcharging of the buffer, limiting the current to prevent damage, and providing protection against input fault conditions including excessive voltage, excessive current, and/or electrical noise,
(ii) an energy recovery circuit module able to accept DC, AC, or magnetically coupled power and convert it into a DC current to charge the electrical buffer, where buffer charging is controlled by a multimode charger able perform linear mode and/or pulse-mode methods during constant current CI-mode charging, and/or constant voltage CV-mode charging,
(iii) a BLA buffer load access circuit module able to control current flow magnitude and polarity between the iBFC buffer and an external load where current is either limited by regulation or by disconnection, and where reverse current flow from the load into the iBFC is prevented,
(iv) a BLA buffer load access circuit module able to disconnect the load from the iBFC in the event that the electrical buffer becomes over-discharged.
(v) a BLA buffer load access circuit module able to able to disable a iBFC module and bypass load current around the disabled module.

In another embodiment, a DC summing node electrically connects an electrical buffer to two or more power components comprising a fuel cell stack via a QXR charge transfer regulator, an external power source via an energy recovery module, and an electrical load via a buffer-load access module whereby either
(i) fuel cell current in an on-state QXR flows unidirectionally from the fuel cell into the DC summing node and into any discharged electrical buffer, but is blocked bidirectionally in the QXR off state, or
(ii) current from the ER energy recovery module flows unidirectionally from an external power source into the DC summing node and any discharged electrical buffer, but is blocked bidirectionally by the ER module in its off state, or
(iii) current flow unidirectionally from the DC summing node and electrical buffer to an electrical load through an on-state BLA buffer load access module, but its blocked bidirectionally in the BLA off state.
(iv) current flows around any disabled iBFC through a shunt transistor.

In another embodiment a series of iBFC are stacked in series with their output ports from the individual BLA buffer access modules connected in totem pole fashion, anode to cathode to anode, operating in one of three modes whereby
(i) an iBFC is active with load current flowing through and where the load is partly powered by its electrical buffer,
(ii) an iBFC in bypass mode is disabled and disconnected from a load, whereby load current flows around the iBFC module conducted through a bypass shunt device, or
(iii) an iBFC is turned off disconnected from the load with no bypass current conduction path.

In another embodiment, a stack of iBFCs are charged in series from the ER energy recovery module through a single DC circuit connected directly to the DC summing node of every module in the charging loop. In another embodiment, a stack of iBFCs are charged from the ER energy recovery module in parallel through multiple AC coupled galvanically isolated power sources or via a single multiple winding transformer or coupled inductor. In another embodiment a series of stacked iBFCs balance charge across all the iBFCs in the stack using a CBC charge balancing circuit where the CBC shares a common voltage reference and where either the reference voltage is DC coupled or AC coupled and galvanically isolated.

It will be understood that the methods and apparatus described herein are not limited to any specific fuel cell technology, buffer construction or battery cell chemistry, electrical load type, or electrical power source. Aside from matching the fuel cell type, the disclosure is not limited to any specific fuel or fuel production method and may include for example hydrogen produced by solar and wind power, chemical means, nuclear power, methane and natural gas, or clean coal technologies, i.e., fossil fuel power with carbon sequester technology.

In another embodiment, a multilayer fuel cell is divided into multiple separate μstacks, for example comprising 12 layer rather than 36 or 60 layers. These separate μstacks are then connected in series with a power multiplexer so the number of μstacks in the circuit can be adjusted to compensate for variations in temperature, humidity, and transient currents.

In one embodiment, the number of μstacks in the dynamic fuel cell array is inv=creased when the fuel cell voltage declines or increased if the fuel cell voltage rises. In this manner the output voltage of the fuel cell stack is semi-constant without the need for a voltage regulator which increases power losses.

In another embodiment, measure membrane characteristics exhibit a 75% energy conversion efficiency. In yet another embodiment, dividing the fuel cell into μstacks reduces the heating of the fuel cells. In one case, only a 1° C./W thermal impedance is required to keep the fuel cell in a nominal temperature range.

### BRIEF DESCRIPTION OF THE DRAWINGS

FIG. 1. Schematic and waveform of battery driving a resistive or capacitive load.

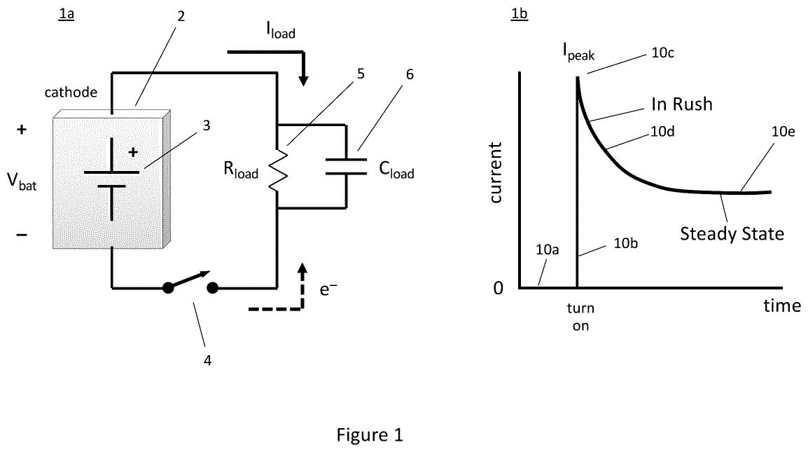

FIG. 2A. Schematic and equivalent circuit of a battery driving a motor.

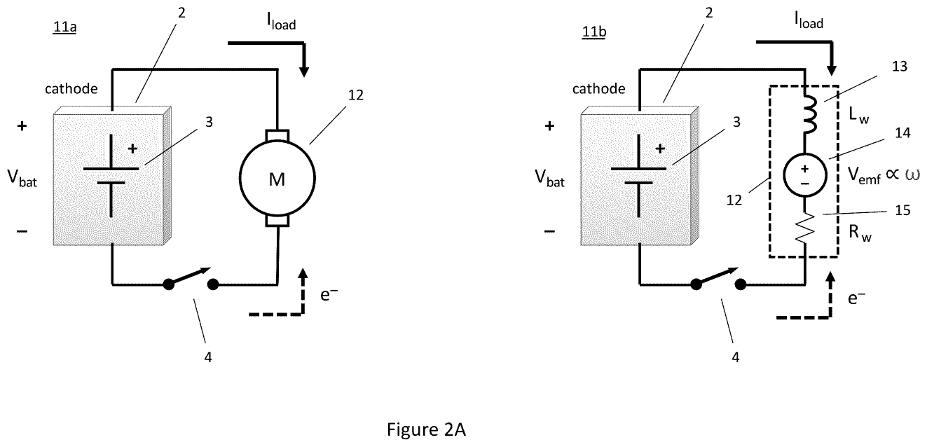

FIG. 2B. Example waveforms of a battery driving a motor.

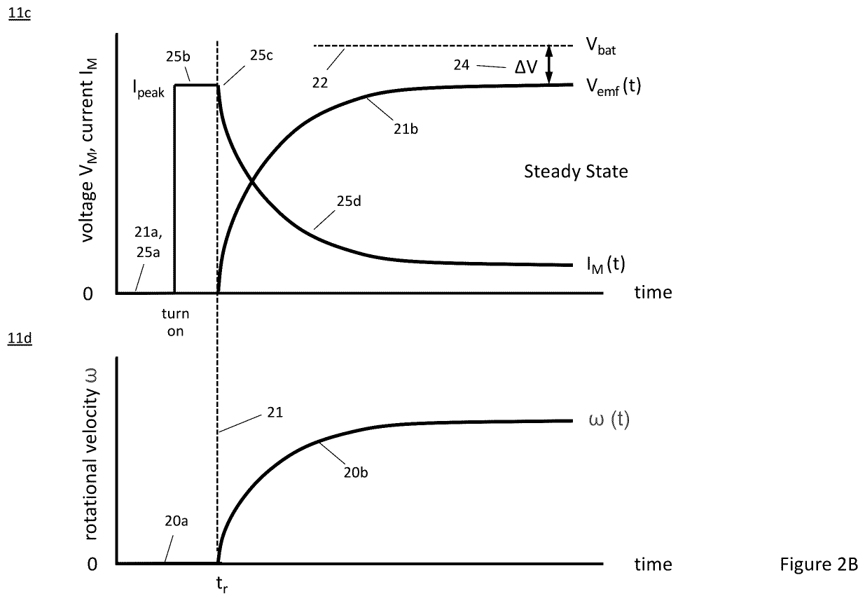

FIG. 3. Schematics of two operating modes for a battery comprising charging and discharging.

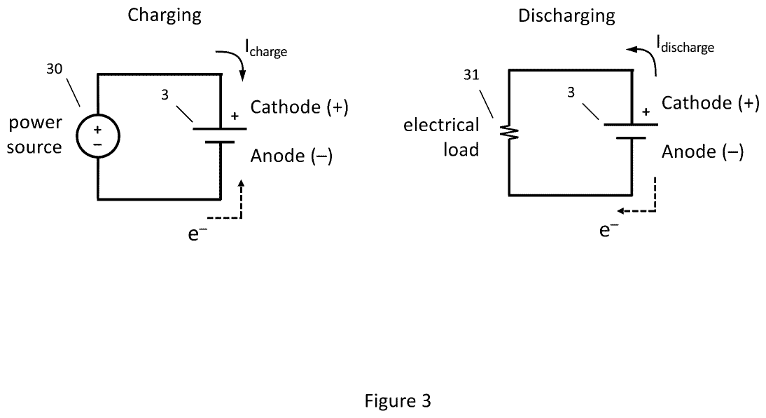

FIG. 4. Electrochemistry of a lithium ion battery during charging and discharging.

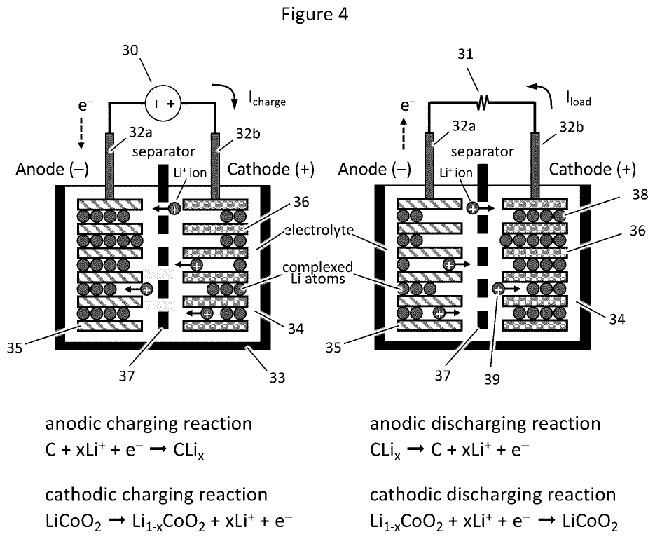

FIG. 5. Lumped element schematic representation of a lithium ion battery.

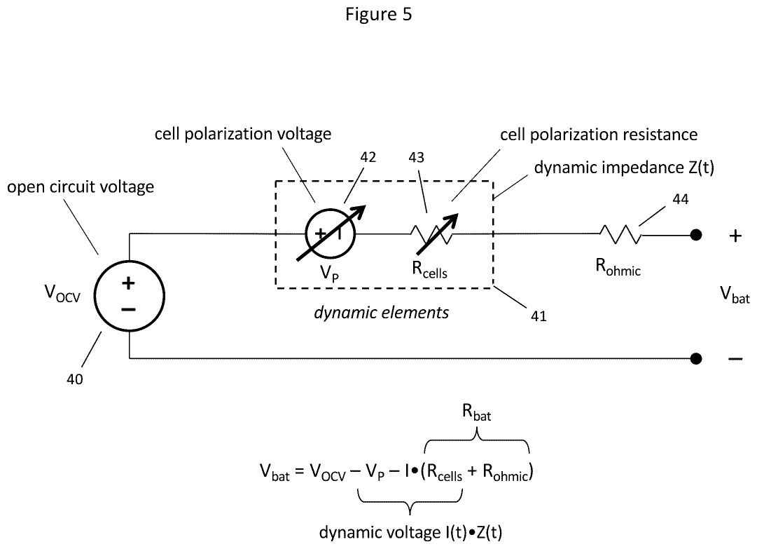

FIG. 6. Exemplary voltage components of Li-ion battery as a function of state-of-charge.

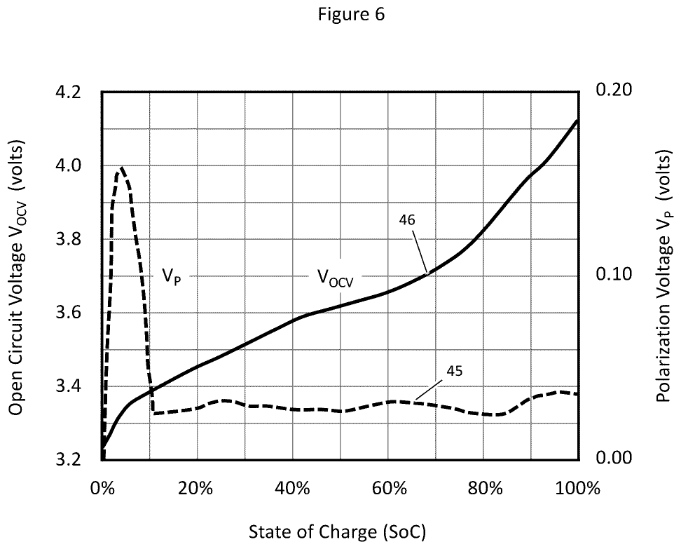

FIG. 7A. Exemplary resistance of Li-ion battery as a function of state-of-charge during charging and discharging.

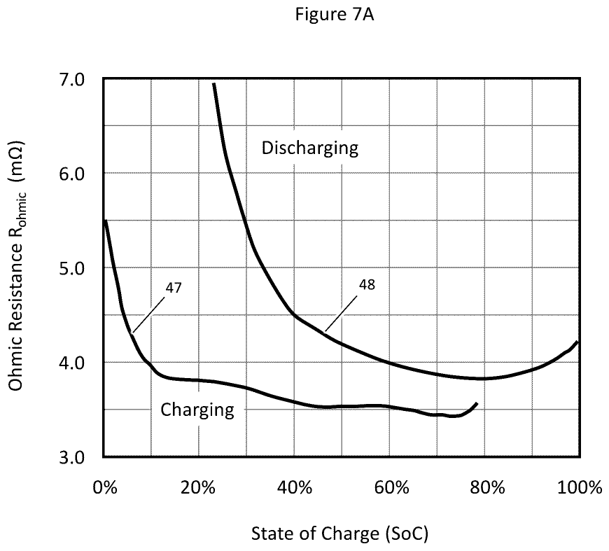

FIG. 7B. Exemplary charge storage characteristics of a battery in terms or C-rate during discharging and charging.

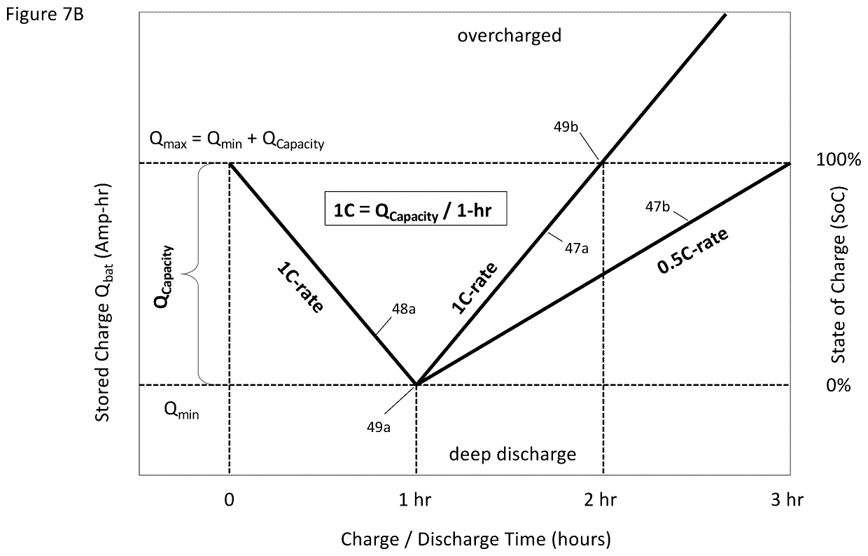

FIG. 7C. Limitations in voltage range of Li-ion battery including fire risk from overcharging and cell damage from over-discharging.

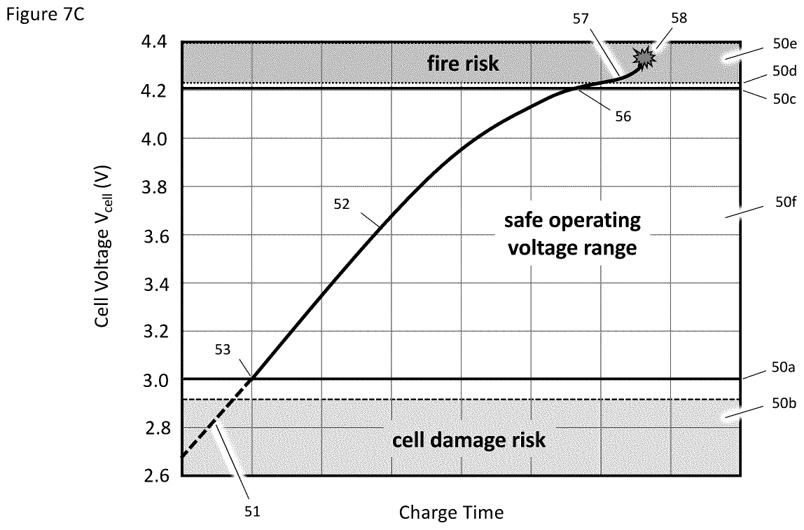

FIG. 8. Definitions of current-voltage SOA safe-operating-area for a Li-ion battery.

FIG. 9. Thermal profile of a Li-ion battery during heating and overheating.

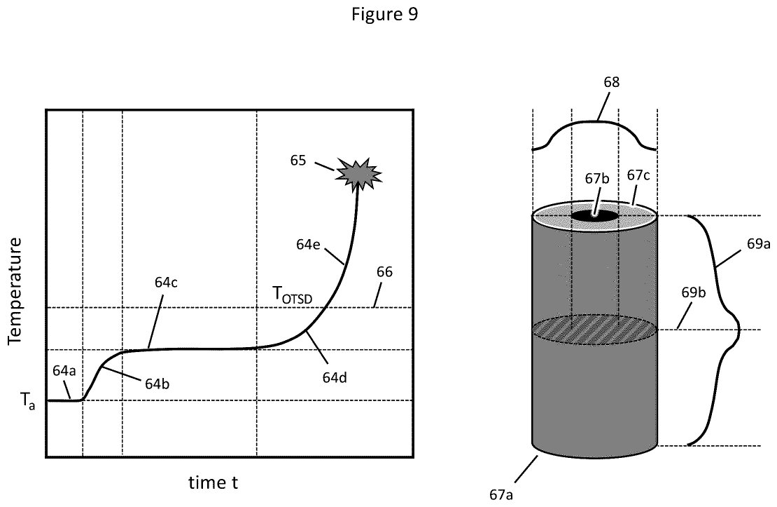

FIG. 10. Mechanistic schematic of hydrogen fuel cell electrochemistry.

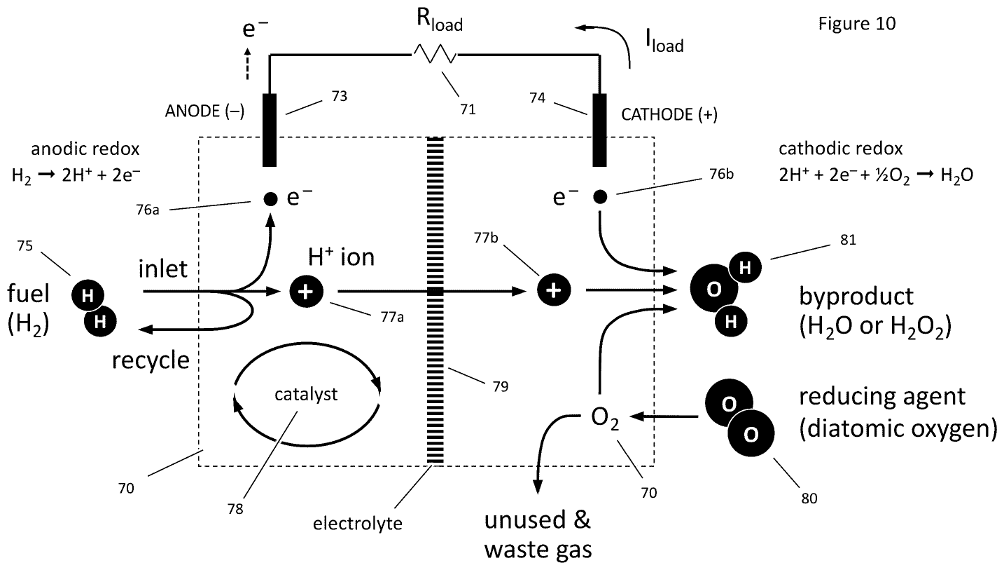

FIG. 11. Charge transport models for alkali, MCFC, PAFC, and SOFC fuel cells showing ion conduction in electrolyte.

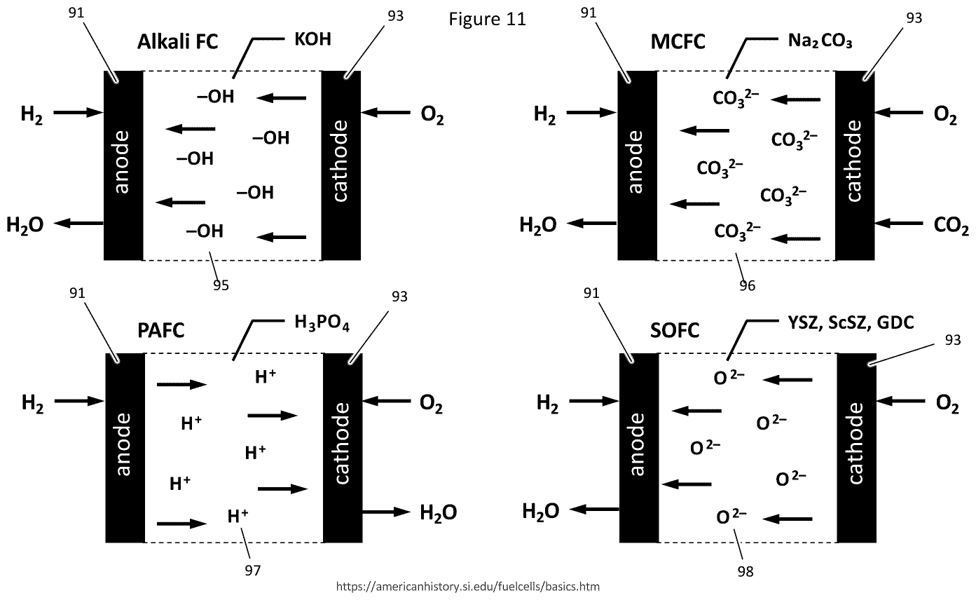

FIG. 12. Diagram of fuel cell components comprising a membrane electrode assembly (MEA).

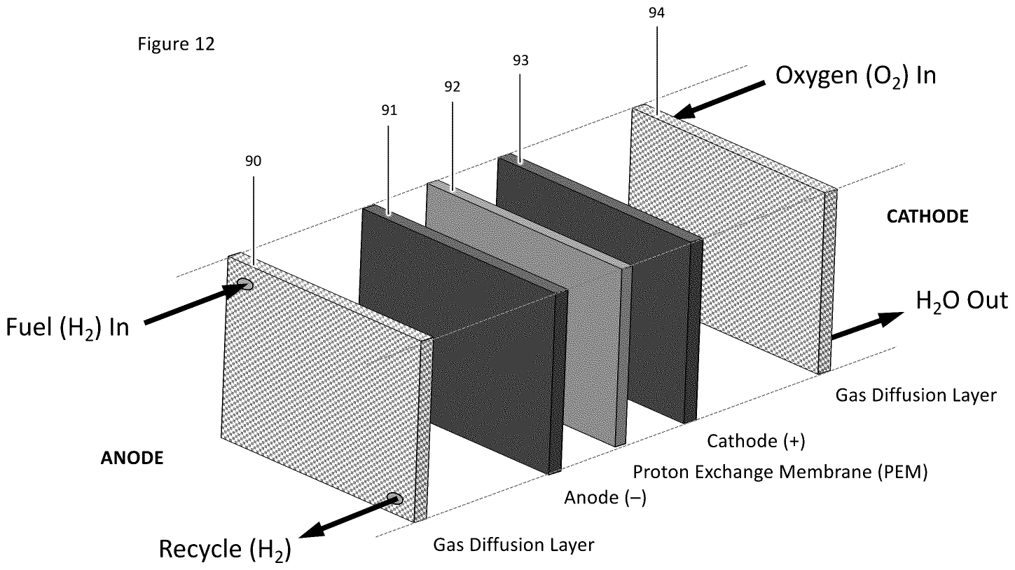

FIG. 13A. Lumped element schematic representation of a fuel cell.

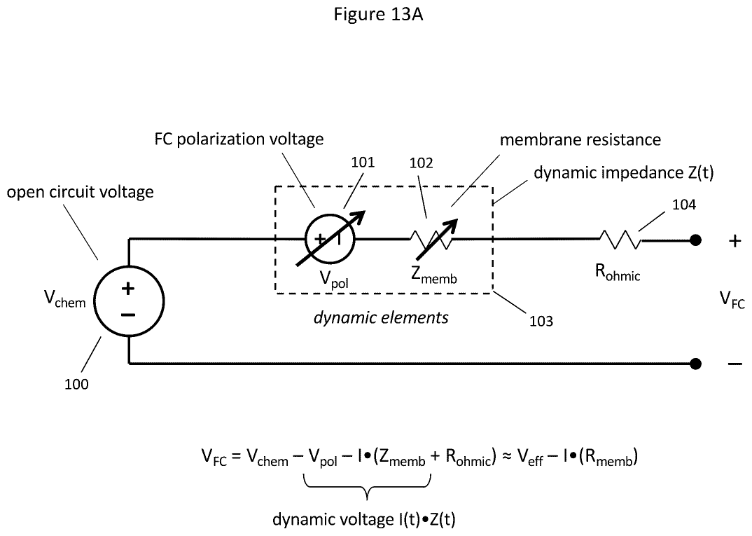

FIG. 13B. Simplified lumped element schematic representation of a fuel cell.

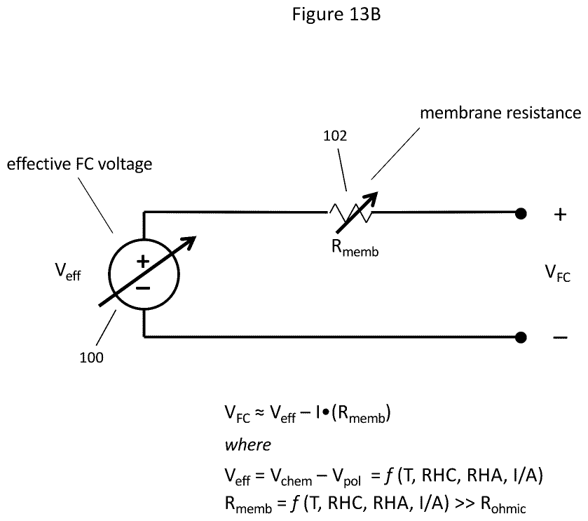

FIG. 14A. Schematic of operation of fuel cell membrane electrode assembly depicting mechanisms involving water.

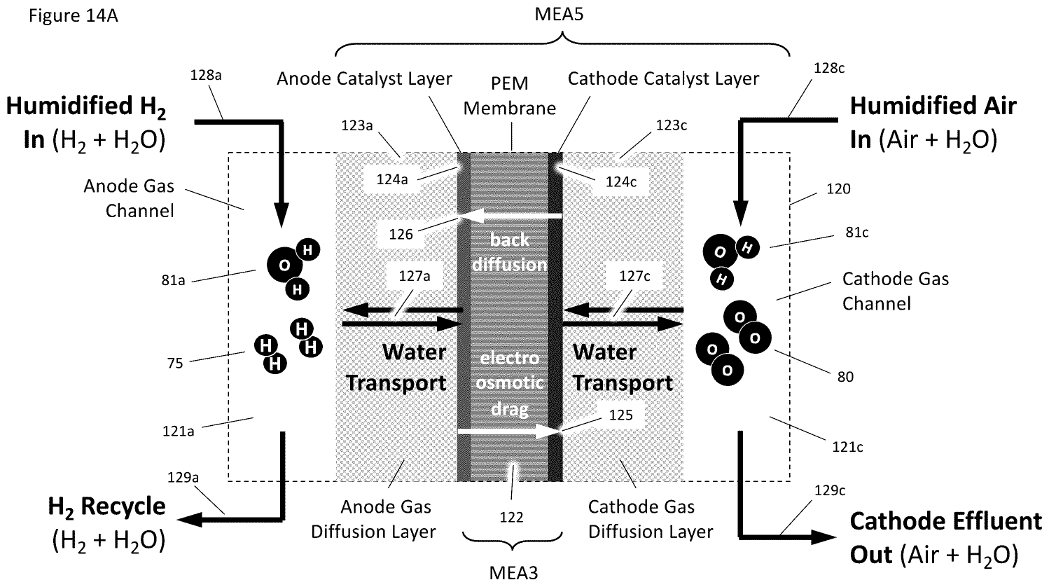

FIG. 14B. Schematic representation of function of gas diffusion layer (GDL) in a PEM fuel cell.

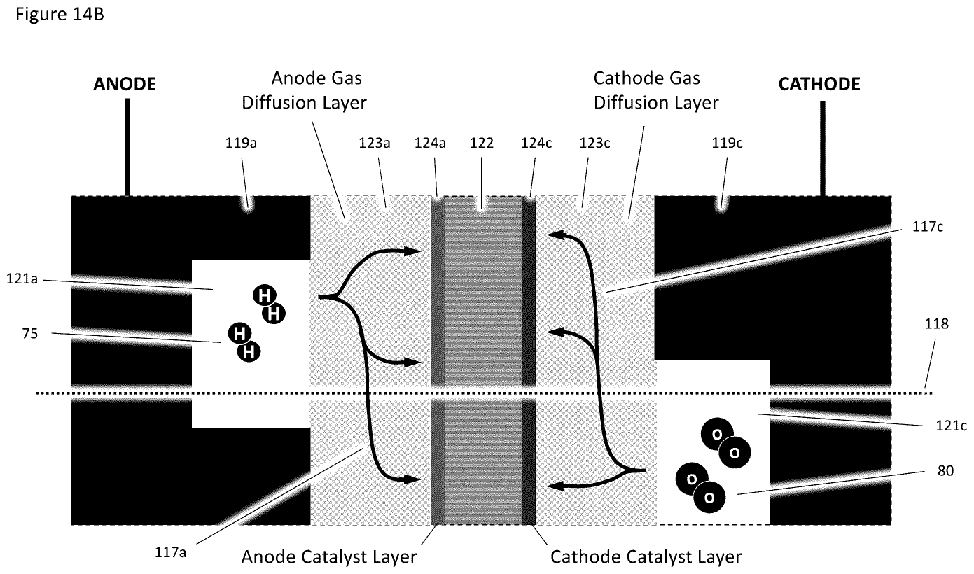

FIG. 15. Exemplary curves of conventional PEM hydrogen fuel cell voltage V_{FC} at 70° C. as a function of current density I/A for various levels of relative humidity RH.

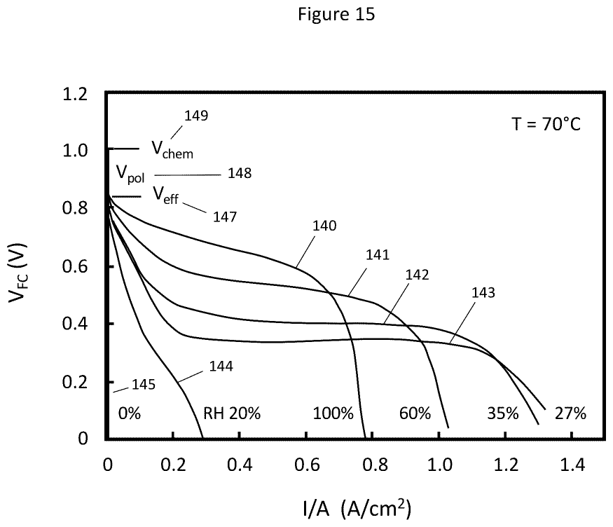

FIG. 16. Exemplary curves of conventional PEM hydrogen fuel cell voltage V_{FC} at 90° C. as a function of current density I/A for various levels of relative humidity RH.

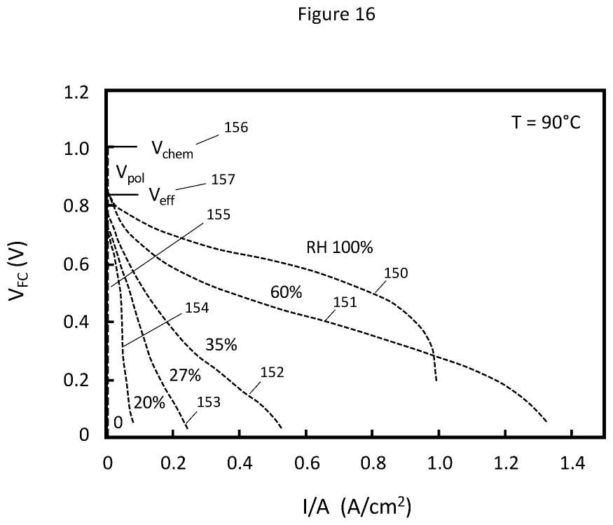

FIG. 17. Exemplary curves of conventional PEM hydrogen fuel cell voltage V_{FC} at 70° C. as a function of relative humidity RH for various levels of current density I/A.

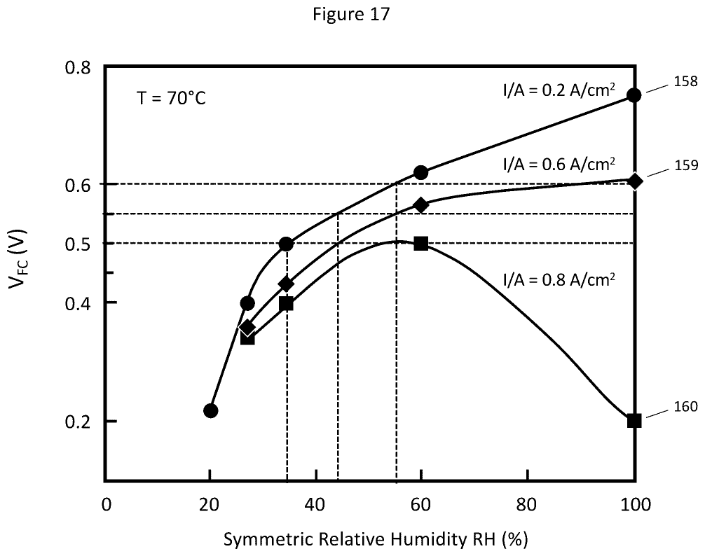

FIG. 18. Exemplary curves of conventional PEM hydrogen fuel cell specific resistance R_{FC}A at 70° C. as a function of current density I/A for various levels of relative humidity RH.

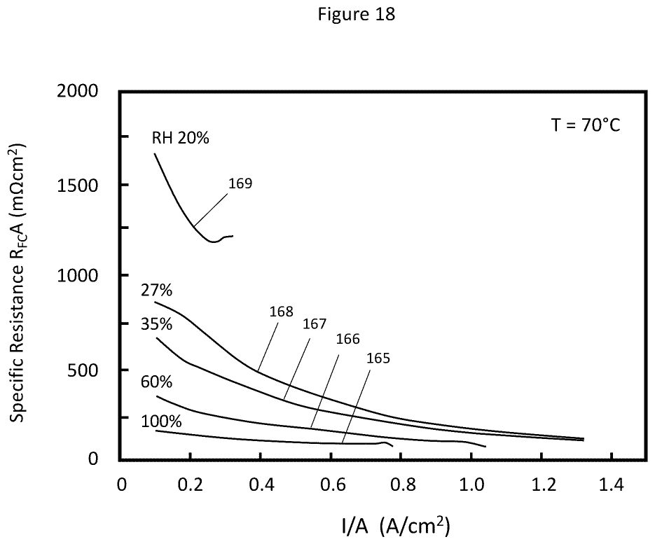

FIG. 19. Schematic of lumped element model for array of “n” series connected fuel cells including voltage, resistance, and total generated charge.

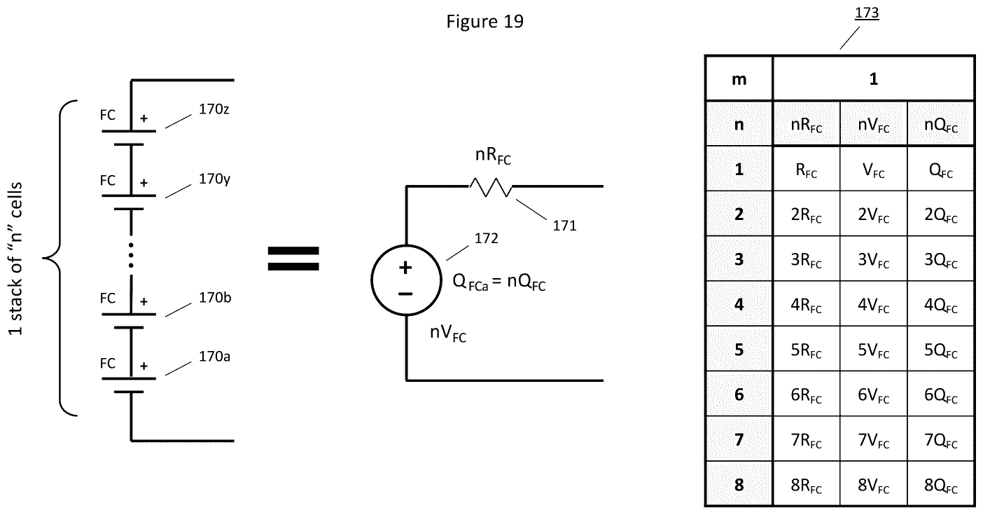

FIG. 20. Schematic of lumped element model for array of “m” parallel connected fuel cells including voltage, resistance, and total generated charge.

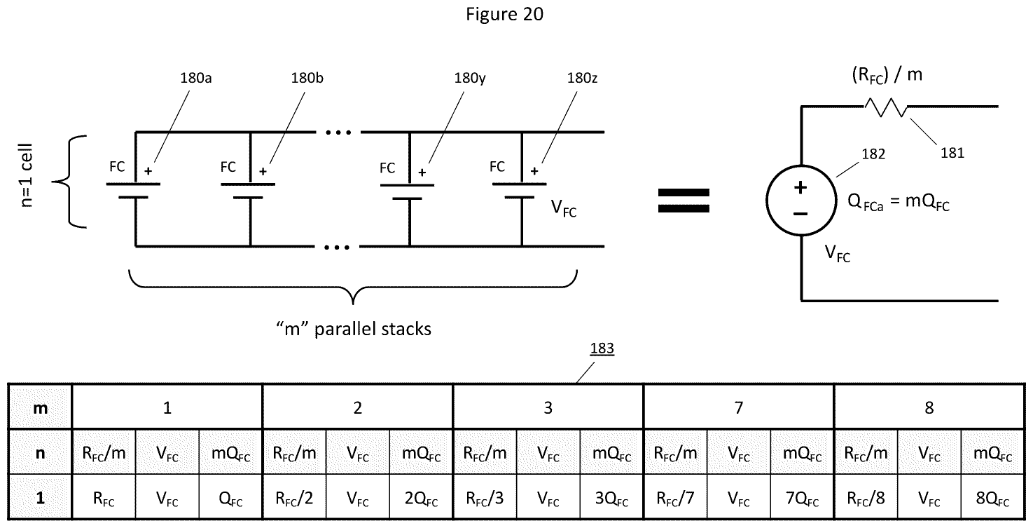

FIG. 21. Dimensions of various small form factor canisters illustrating container volume and pressure limitations.

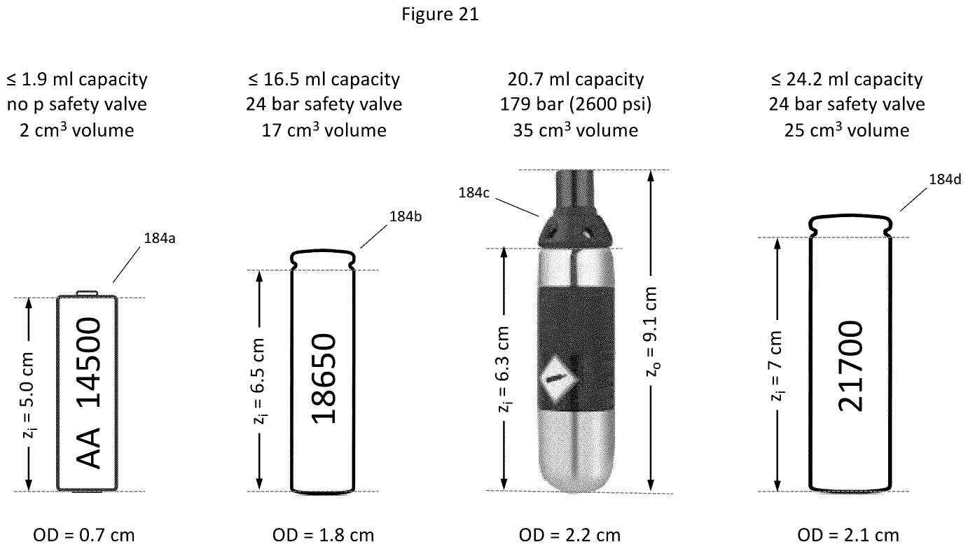

FIG. 22A. Example of high pressure hydrogen gas canister including construction, PRD pressure release device, and valve.

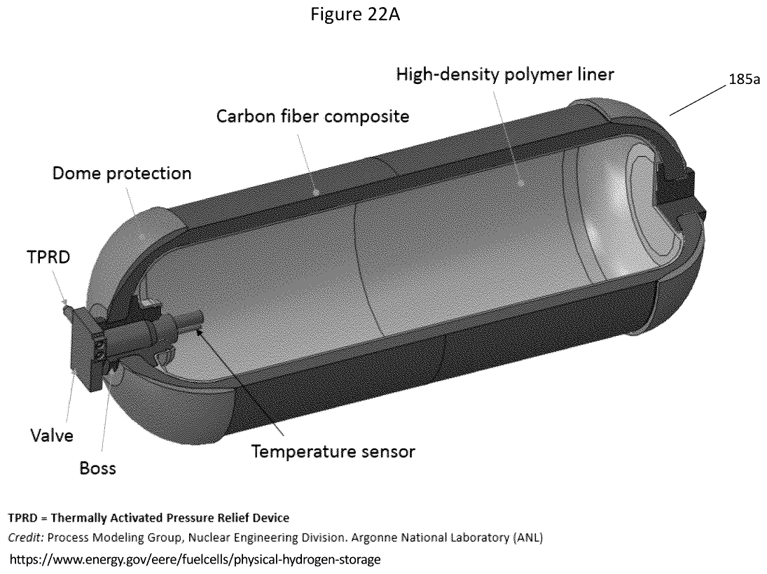

FIG. 22B. Alternate example of high pressure hydrogen gas canister including construction and related hardware.

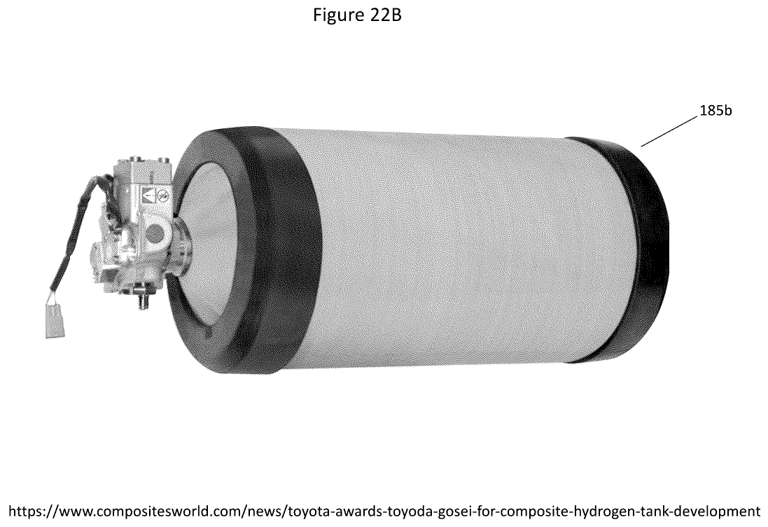

FIG. 23. Linear graph of gas canister volume showing calculated value of electric charge Q_{T} equivalency for hydrogen at various pressures measured in bars.

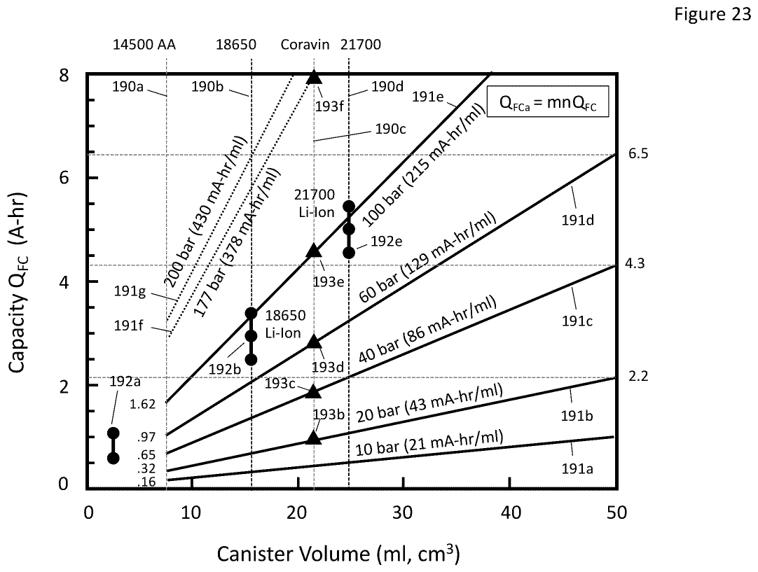

FIG. 24. Loglog graph of gas canister volume showing calculated value of stored energy in kWh and electric charge Q_{T}in Ah for hydrogen at various pressures measured in bars with gasoline as reference.

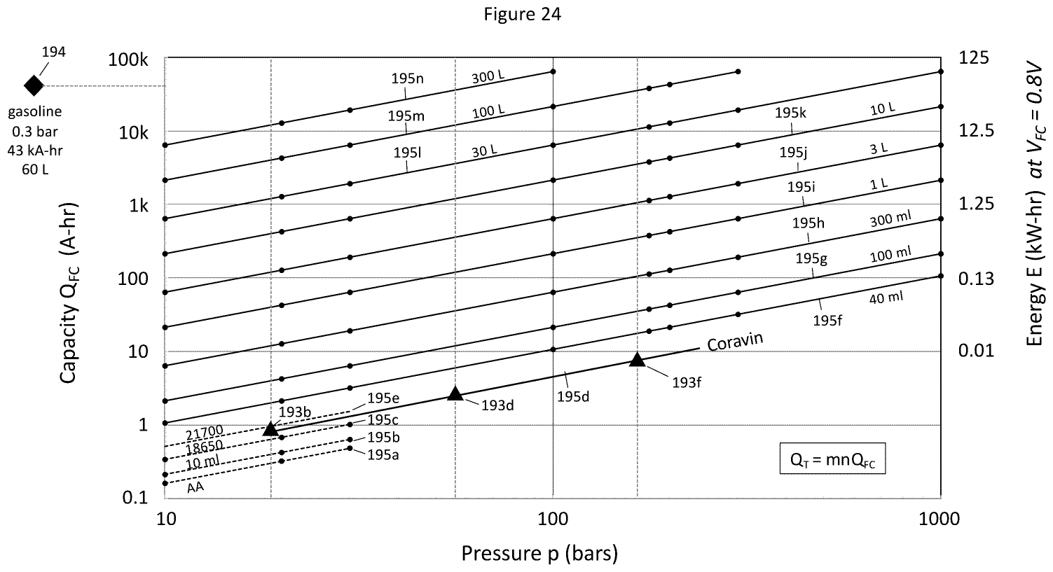

FIG. 25. Specific resistance of exemplary hydrogen fuel cells as a function of number of fuel cells contrasting parallel and series configurations.

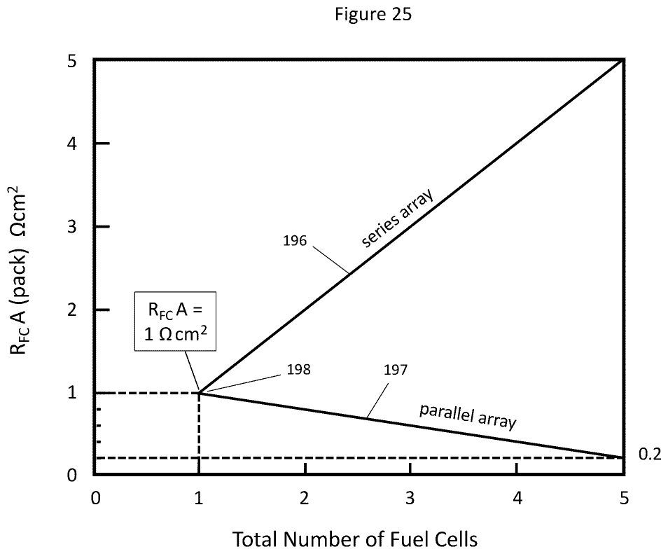

FIG. 26. Schematic of lumped element model for array of “m by n” series-parallel array of fuel cells including voltage, resistance, and total generated charge.

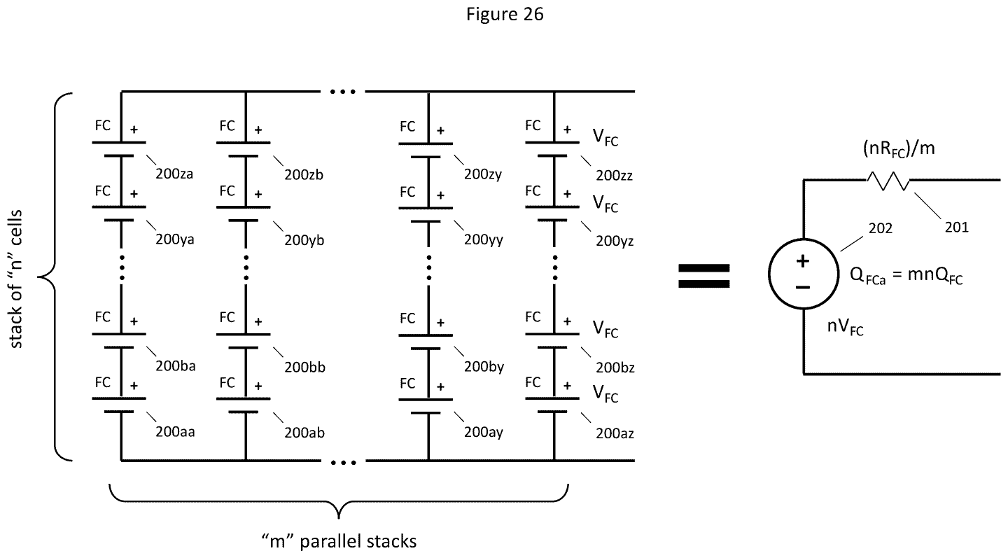

FIG. 27. Summary table of various arrays of “m by n” series-parallel fuel cell arrays parametrically describing voltage, resistance, and total generated charge.

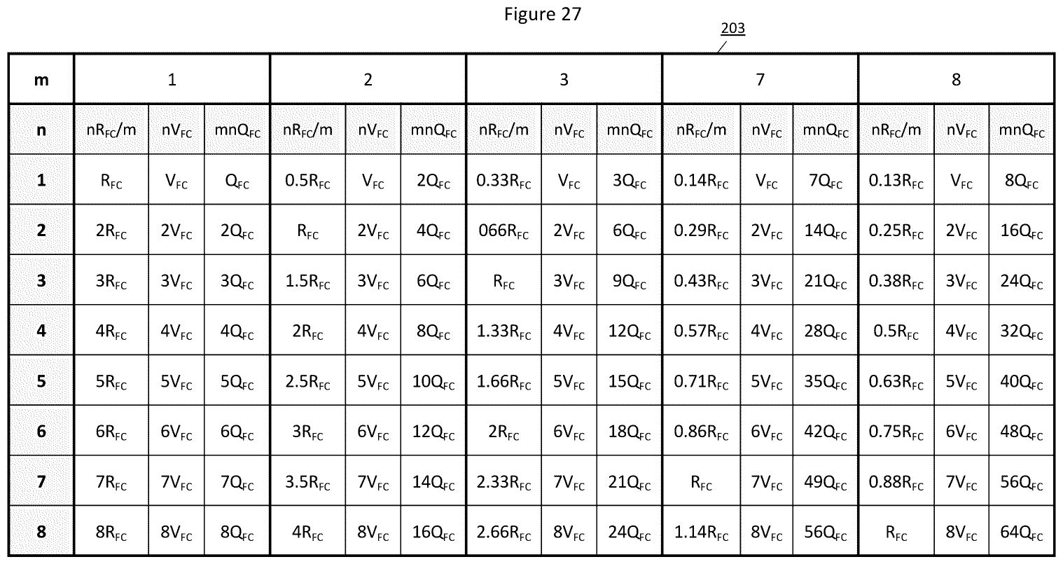

FIG. 28. Graph of specific resistance of hydrogen fuel cells as a function of number of fuel cells of number of “n” series connected cell varied parametrically for various “m” parallel combinations.

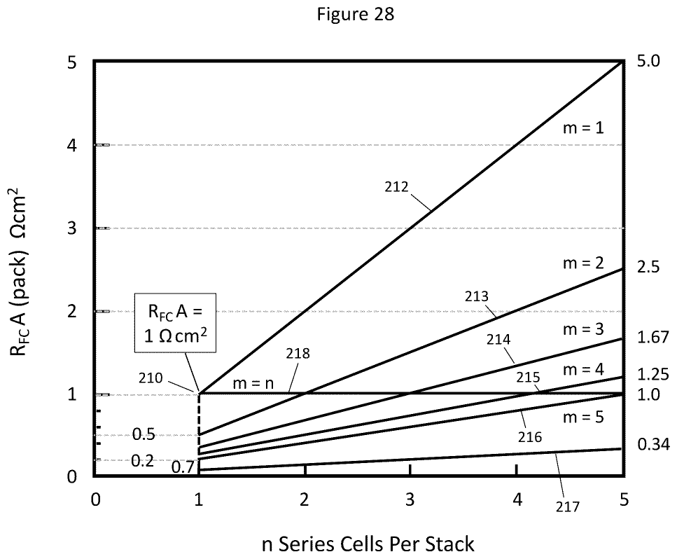

FIG. 29. Schematic of fuel cell array driving brushed and brushless motors.

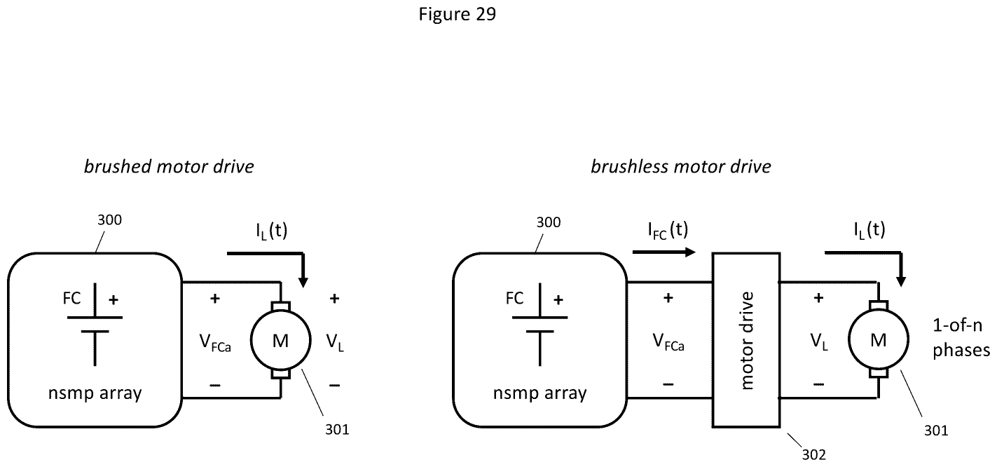

FIG. 30. Schematic of fuel cell array driving low voltage motor via motor drive module.

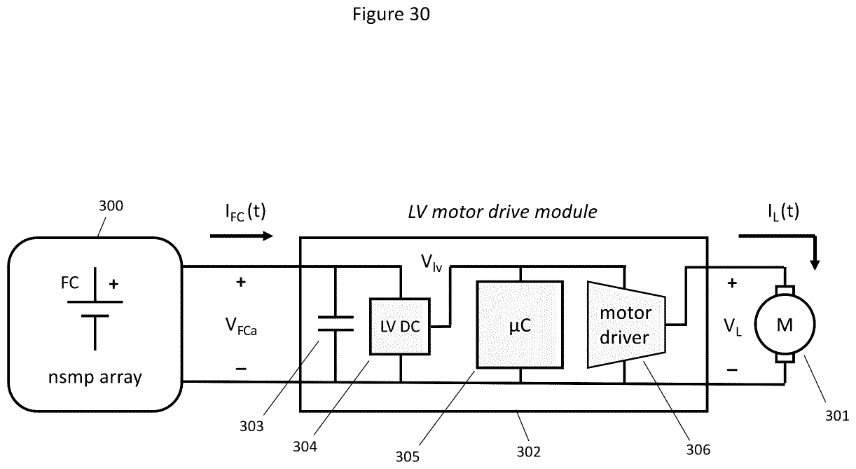

FIG. 31. Schematic of fuel cell array driving high voltage motor via motor drive module.

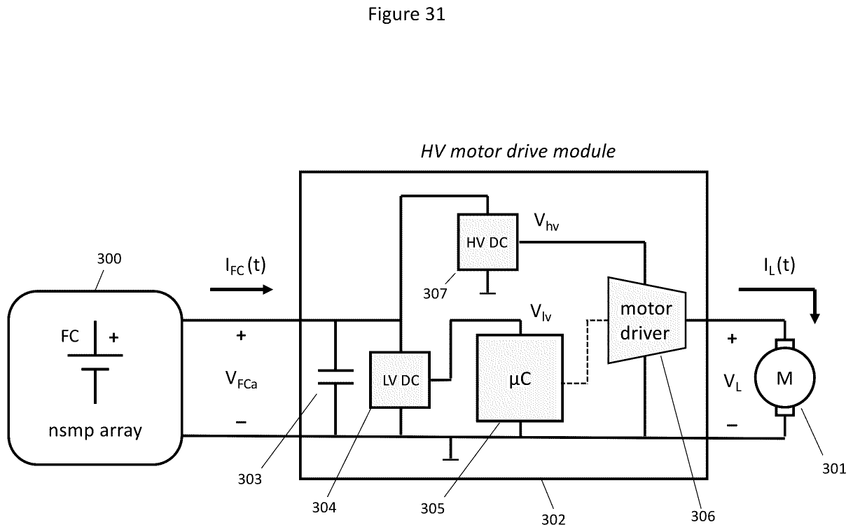

FIG. 32. Voltage and current waveforms depicting problematic motor startup for motor drive powered by high resistance fuel cell.

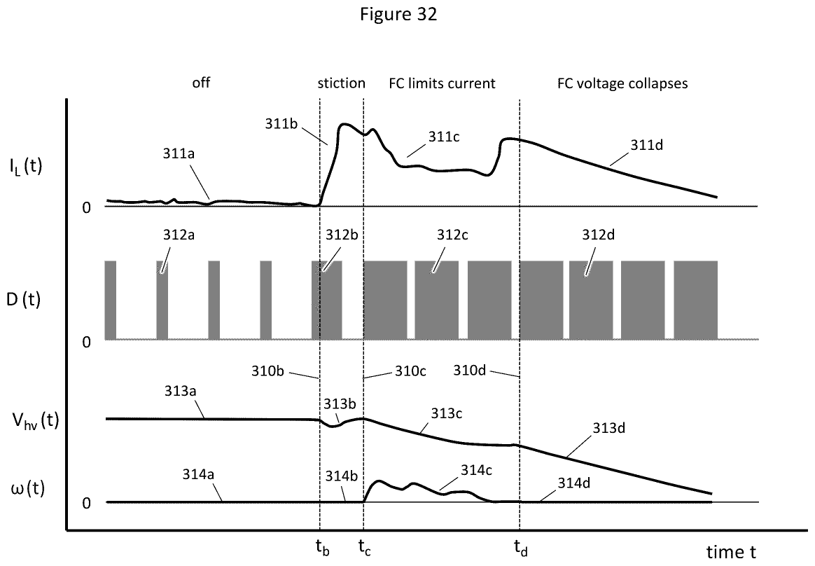

FIG. 33. Schematic of fuel cell array in radio frequency communications including an exemplary equivalent circuit of RF module.

FIG. 34. Voltage and current waveforms depicting problematic operation of RF module powered by high resistance fuel cell leading to system failure.

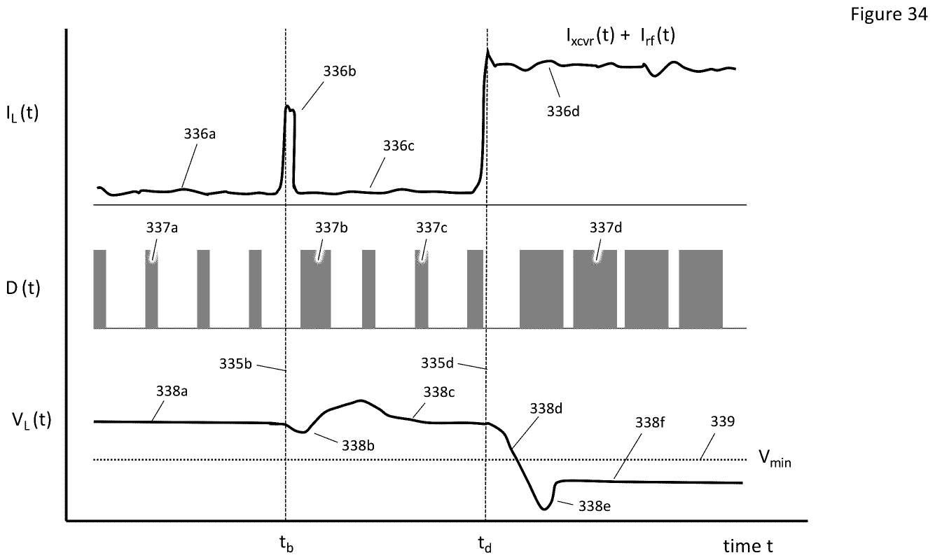

FIG. 35. Schematic of fuel cell array driving notebook computer and equivalent circuit including lithium battery pack.

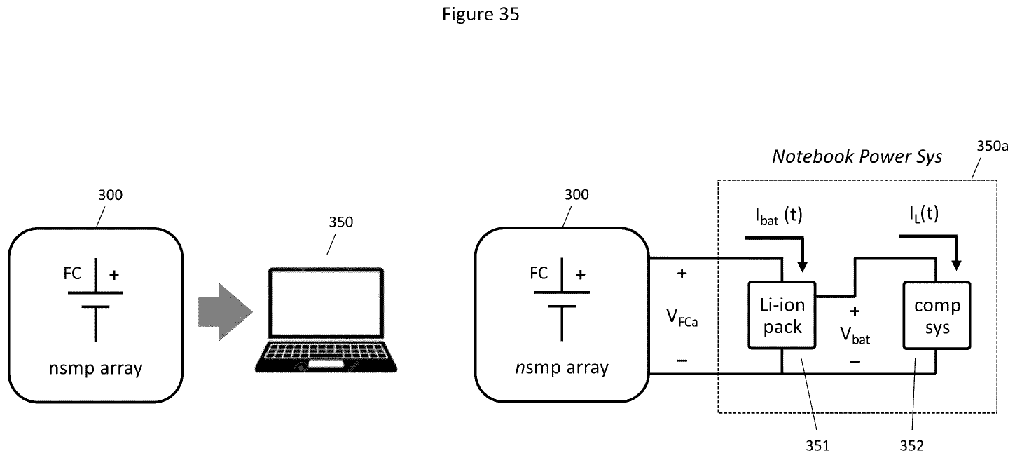

FIG. 36. Detailed schematic of fuel cell array driving lithium battery pack comprising a series parallel array of lithium ion cells including protection electronics and charger circuit.

FIG. 37. Schematic representations of single fuel cell unable to charge a lithium ion battery pack either directly or via boost converter.

FIG. 38. Schematic representations of fuel cell series arrays unable to charge a lithium ion battery pack either directly or via a synchronous Buck converter.

FIG. 39. Alternative schematic representation of a fuel cell series array unable to charge a lithium ion battery pack via a synchronous Buck converter.

FIG. 40. Schematic illustrating fuel cell powering a lithium ion array through an intervening dual mode constant-current constant-voltage charger circuit.

FIG. 41. Current and voltage waveforms depicting operation of a dual mode constant-current constant-voltage circuit charging a lithium ion array.

FIG. 42 Voltage waveforms contrasting problematic lithium ion charging using a high resistance fuel cell source versus a power adapter with unlimited current.

FIG. 43. Schematic illustrating fuel cell charging a lithium ion array through a synchronous Buck regulator and dual mode constant-current constant-voltage charger circuit.

FIG. 44. Schematic of the disclosed iFBC intelligent buffered fuel cell including representative functions including buffer energy storage, fuel cell control, energy recovery, temperature and humidity control, a FMI fuel management interface, and an iB intelligent buffer controller with isolated bus communication.

FIG. 45. Schematic of the disclosed iFBC intelligent buffered fuel cell driving a motor module.

FIG. 46. Waveforms illustrating the disclosed iFBC intelligent buffered fuel cell successfully driving a motor module (solid lines) contrasted against problematic conventional fuel cell operation and malfunction (dashed lines).

FIG. 47. Schematic of the disclosed iFBC intelligent buffered fuel cell driving a RF communication module.

FIG. 48. Waveforms illustrating the disclosed iFBC intelligent buffered fuel cell successfully driving a RF communication module (solid lines) contrasted against problematic conventional fuel cell operation and malfunction (dashed lines).

FIG. 49. Schematic of the disclosed iFBC intelligent buffered fuel cell driving a lithium ion battery pack with dual mode constant-current constant-voltage charger.

FIG. 50. Waveforms illustrating the disclosed iFBC intelligent buffered fuel cell successfully powering dual-mode constant-current constant-voltage charging of a lithium ion battery array of cells.

FIG. 51. Equivalent schematic and corresponding symbol of an integrated BFC buffered fuel cell including an array of fuel cells, a battery buffer cell, along with charging and protection circuitry.

FIG. 52A. Transient current response of buffered fuel cell including battery current buffering and fuel cell re-supply.

FIG. 52B. Transient voltage response of buffered fuel cell including battery current buffering and fuel cell re-supply.

FIG. 53A. Graph comparing exemplary fuel cell and buffered fuel cell voltages versus current and current density where the conventional FC resistance is 1200 times greater for a 4s1p fuel cell than a buffered fuel cell.

FIG. 53B. Graph comparing exemplary fuel cell and buffered fuel cell voltages versus current and current density where the conventional FC resistance is 300 times greater for a 4s4p fuel cell than a buffered fuel cell.

FIG. 53C. Graph comparing conventional fuel cell and advanced fuel cell voltages versus current and current density using 4s4p arrays.

FIG. 53D. Graph comparing conventional fuel cell, advanced fuel cell and buffered fuel cell voltages versus current and current density using 4s60p arrays.

FIG. 54 Graph comparing conventional fuel cell, advanced fuel cell and buffered fuel cell DC resistances versus current and current density using 4s60p arrays.

FIG. 55. Schematic and equivalent circuit of a BFC buffered fuel cell comprising an exemplary 4s4p square array of hydrogen fuel cells at 0.925V per cell and a 3.7V Li-ion cell as buffer.

FIG. 56. Schematic and equivalent circuit of a BFC buffered fuel cell comprising an exemplary 4s4p square array of hydrogen fuel cells at 0.8V per cell and a 3.2V Li-ion cell as buffer.

FIG. 57. Schematic and equivalent circuit of a BFC buffered fuel cell comprising an exemplary 5s1p tall array of hydrogen fuel cells at 0.8V per cell and a 4.0V Li-ion cell as buffer.

FIG. 58. Schematic and equivalent circuit of a BFC buffered fuel cell comprising an exemplary 5s5p square array of hydrogen fuel cells at 0.8V per cell and a 4.0V Li-ion cell as buffer.

FIG. 59. Schematic and equivalent circuit of a BFC buffered fuel cell comprising an exemplary 5s5p square array of hydrogen fuel cells at 0.7V per cell and a 3.5V Li-ion cell as buffer.

FIG. 60. Schematic and equivalent circuit of a BFC buffered fuel cell comprising an exemplary 6s1p tall array of hydrogen fuel cells at 0.7V per cell and a 4.2V Li-ion cell as buffer.

FIG. 61. Schematic and equivalent circuit of a BFC buffered fuel cell comprising an exemplary 6s6p square array of hydrogen fuel cells at 0.7V per cell and a 4.2V Li-ion cell as buffer.

FIG. 62. Schematic and equivalent circuit of a BFC buffered fuel cell comprising an exemplary 6s6p square array of hydrogen fuel cells at 0.6V per cell and a 3.6V Li-ion cell as buffer.

FIG. 63. Schematic and equivalent circuit of a BFC buffered fuel cell comprising an exemplary 6s1p tall array of hydrogen fuel cells at 0.7V per cell and a 4.2V Li-ion cell as buffer.

FIG. 64. Schematic and equivalent circuit of a BFC buffered fuel cell comprising an exemplary 7s7p square array of hydrogen fuel cells at 0.6V per cell and a 4.2V Li-ion cell as buffer.

FIG. 65. Schematic and equivalent circuit of a BFC buffered fuel cell comprising an exemplary 7s7p square array of hydrogen fuel cells at 0.5V per cell and a 3.5V Li-ion cell as buffer.

FIG. 66. Schematic and equivalent circuit of a BFC buffered fuel cell comprising an exemplary 8s8p square array of hydrogen fuel cells at 0.5V per cell and a 4.0V Li-ion cell as buffer.

FIG. 67. Equivalent circuits of BFC buffered fuel cells comprising exemplary 9s9p and 10s10p square arrays of hydrogen fuel cells at 0.45V with a 4.1V Li-ion buffer and 0.4V per cell with a 4.0V Li-ion buffer respectively.

FIG. 68. Graph of buffered fuel cell load current I_{L} in amperes (left-side axis) and C-rate (right-side axis) as a function of buffer voltage for various electrical loads including ohmic load current, discharge test current, and charging currents for batteries at 2.7V, 3.0V and 3.6V. The current of an unbuffered fuel cell I_{FC} powering an ohmic load is included for reference.

FIG. 69A. Graph of stack voltage nV_{FC} and single-string stack resistance nR_{FC} versus number of series cells “n” in stack varied parametrically by cell voltage V_{FC}.

FIG. 69B.—Graph of nV_{FC} stack voltage versus cell voltage V_{FC} varied parametrically by number of series cells “n” in stack.

FIG. 70. Equivalent circuits of BFC buffered fuel cells of a nsmp fuel cell array with 1s1p and 1s2p lithium ion cells as buffers.

FIG. 71. Response surface of unregulated stack voltage nV_{FC} and m=1 series stack resistance nR_{FC} as a function of cell voltage V_{FC} and number of series cells “n” in stack including black and gray shaded overvoltage and undervoltage conditions, m=1 fuel cell array resistance nR_{FC}, and for comparison 1s1p and 1s2p buffer resistances R_{buf}=R_{bat} and R_{buf}=R_{bat}/2 respectively.

FIG. 72. QXR charge transfer regulator limited buffer voltage using voltage clamping and voltage regulation.

FIG. 73. Schematic representations of the QXR charge transfer regulator functions comprising fuel cell current array current limiter, buffer current limiter and buffer voltage regulator and limiter.

FIG. 74. Response surface of QXR regulated stack voltage V_{buf} and m=1 series stack resistance nR_{FC} as a function of cell voltage V_{FC} and number of series cells “n” in stack. Black zone indicates voltage regulated charging while gray zones indicate undervoltage charging.

FIG. 75. Two QXR charge mechanisms and corresponding buffer charging modes comprising voltage regulated charging and current limited charging.

FIG. 76. QXR controlled buffer charging profiles comprising showing current limited charging, normal charging mode, and clamped voltage or regulated voltage modes. The normal charging mode may comprise constant current charging, constant voltage charging (as shown), and a sequenced combination thereof.

FIG. 77. Fuel cell current and voltage waveforms I_{FC} and V_{FC} as a function of charging time illustrating the effect of buffer charging voltage headroom ΔV_{chg} on charging curves including constant charging voltage (solid line) and accelerated clamped voltage charging (dashed lines).

FIG. 78. Response surface depicting buffer charging voltage headroom ΔV_{chg} as a function of fuel cell voltage V_{FC} and number of series connected fuel cells n in a FC stack along with equivalent m=1 fuel cell resistance nR_{FC} for a fuel cell technology of R_{FC}=1.21.

FIG. 79A. Exemplary QXR linear regulator circuit comprising current clamped linear voltage regulator.

FIG. 79B. Exemplary QXR linear regulator circuit for performing both constant-current mode and constant-voltage mode CI-CV charging of buffer cells.

FIG. 79C. Exemplary QXR linear regulator circuit for performing both constant-current mode and constant-voltage mode CI-CV charging of buffer cells using mode switching.

FIG. 80. QXR controlled buffer voltage waveforms comparing CV constant voltage charging to dual mode sequenced constant-current constant-voltage CI-CV charging.

FIG. 81A. Schematic of QXR compliant multimode PWM switching converter combining voltage regulation with input and output current feedback limited pulse modulation.

FIG. 81B. Functional representation of QXR compliant multimode PWM switching converter comprising current limited pulse modulation and voltage regulation.

FIG. 82A. Voltage and current waveforms of multimode QXR charge transfer regulator including linear mode trickle charge, linear constant-current CI-mode charging, and current-clamped PWM constant-voltage CV-mode charging.

FIG. 82B. Voltage and current waveforms of QXR charge transfer regulator including linear-mode trickle charge, and current-clamped PWM dual-mode constant-current constant voltage sequenced charging.

FIG. 83. Response surface of unregulated buffer peak charging current and series stack resistance nR_{FC} of m=1 fuel cell array as a function of cell voltage V_{FC} and number of series cells “n” in stack. Peak currents are based on CV charging of buffer at starting voltage of V_{buf}=3.6V. Note that for m=1 or A=1 cm², fuel cell current I_{FC} measured in amperes and current density I_{FC}/A=A/cm² are identical numerically and differ only by their corresponding units.

FIG. 84. Response surface of regulated peak buffer charging current and series stack resistance nR_{FC} of m=1 fuel cell array as a function of cell voltage V_{FC} and number of series cells “n” in stack where currents are limited to 0.2 A/cm². Note that for m=1 or A=1 cm², fuel cell current I_{FC} measured in amperes and current density I_{FC}/area=_{FC}/A having units of amps/cm²=A/cm² are identical numerically and differ only by their corresponding units. In an algebraic equation the term “A” means area. When used as a unit of measure A is the SI international standard symbol for ampere.

FIG. 85. Response surface of regulated peak charging C-rate and series stack resistance nR_{FC} of m=1 fuel cell array as a function of cell voltage V_{FC} and number of series cells “n” in stack. Assuming buffer capacity Q=3 Ah, no conditions shown exceed safe 2C buffer charge rate limitation.

FIG. 86. Graph of regulated peak buffer charging current in C-rate and amperes versus fuel cell voltage V_{FC} as a function of number of series cells “n” in stack for m=1 fuel cell array.

FIG. 87. Response surface of unregulated buffer peak charging current in amperes and series stack resistance nR_{FC} of m=5 fuel cell array as a function of cell voltage V_{FC} and number of series cells “n” in stack. Peak currents are based on CV charging of buffer at starting voltage of V_{buf}=3.6V.

FIG. 88. Response surface of unregulated buffer peak charging current density (measured in A/cm²) and series stack resistance nR_{FC} of m=5 fuel cell array as a function of cell voltage V_{FC} and number of series cells “n” in stack. Spotted cells indicate conditions exceeding fuel cell current densities of 0.2 A/cm².

FIG. 89. Response surface of FC limited peak buffer charging current in amperes and series stack resistance nR_{FC} of m=5 fuel cell array as a function of cell voltage V_{FC} and number of series cells “n” in stack. Peak currents are based on CV charging of buffer at starting voltage of V_{buf}=3.6V.

FIG. 90. Response surface of regulated peak charging C-rate and series stack resistance nR_{FC} of m=5 fuel cell array as a function of cell voltage V_{FC} and number of series cells “n” in stack limited to FC current densities of 0.2 A/cm². Assuming buffer capacity Q=3 Ah, no conditions shown exceed safe 2C buffer charge rate limitation.

FIG. 91. Graph of regulated peak buffer charging current in C-rate and amperes versus fuel cell voltage V_{FC} as a function of number of series cells “n” in stack for m=5 fuel cell array.

FIG. 92. Response surface of unregulated buffer peak charging current in amperes and series stack resistance nR_{FC} of m=10 fuel cell array as a function of cell voltage V_{FC} and number of series cells “n” in stack. Peak currents are based on CV charging of buffer at starting voltage of V_{buf}=3.6V.

FIG. 93. Response surface of unregulated buffer peak charging current density (measured in A/cm²) and series stack resistance nR_{FC} of m=10 fuel cell array as a function of cell voltage V_{FC} and number of series cells “n” in stack. Peak current densities are based on CV charging of buffer at starting voltage of V_{buf}=3.6V.

FIG. 94. Response surface of FC limited peak buffer charging current in amperes and series stack resistance nR_{FC} of m=10 fuel cell array as a function of cell voltage V_{FC} and number of series cells “n” in stack. Spotted cells indicate fuel cell current densities limited to 0.2 A/cm².

FIG. 95. Response surface of regulated peak charging C-rate and series stack resistance nR_{FC} of m=10 fuel cell array as a function of cell voltage V_{FC} and number of series cells “n” in stack limited to FC current densities of 0.2 A/cm². Assuming buffer capacity Q=3 Ah, no conditions shown exceed safe 2C buffer charge rate limitation.

FIG. 96. Graph of regulated peak buffer charging current in C-rate and amperes versus fuel cell voltage V_{FC} as a function of number of series cells “n” in stack for m=10 fuel cell array.

FIG. 97. Response surface of unregulated buffer peak charging current in amperes and series stack resistance nR_{FC} of m=15 fuel cell array as a function of cell voltage V_{FC} and number of series cells “n” in stack. Peak currents are based on CV charging of buffer at starting voltage of V_{buf}=3.6V.

FIG. 98. Response surface of FC limited peak buffer charging current in amperes and series stack resistance nR_{FC} of m=15 fuel cell array as a function of cell voltage V_{FC} and number of series cells “n” in stack. Spotted cells indicate fuel cell current densities limited to 0.2 A/cm².

FIG. 99. Response surface of regulated peak charging C-rate and series stack resistance nR_{FC} of m=15 fuel cell array as a function of cell voltage V_{FC} and number of series cells “n” in stack limited to FC current densities of 0.2 A/cm². Assuming buffer capacity Q=3 Ah, no conditions shown exceed safe 2C buffer charge rate limitation.

FIG. 100. Graph of regulated peak buffer charging current in C-rate and amperes versus fuel cell voltage V_{FCa}s a function of number of series cells “n” in stack for m=15 fuel cell array.

FIG. 101. Response surface of unregulated buffer peak charging current in amperes and series stack resistance nR_{FC} of m=20 fuel cell array as a function of cell voltage V_{FC} and number of series cells “n” in stack. Peak currents are based on CV charging of buffer at starting voltage of V_{buf}=3.6V.

FIG. 102. Response surface of FC limited peak buffer charging current in amperes and series stack resistance nR_{FC} of m=20 fuel cell array as a function of cell voltage V_{FC} and number of series cells “n” in stack. Peak currents are based on CV charging of buffer at starting voltage of V_{buf}=3.6V. Spotted cells indicate fuel cell current densities limited to 0.2 A/cm².

FIG. 103. Response surface of regulated peak charging C-rate and series stack resistance nR_{FC} of m=15 fuel cell array as a function of cell voltage V_{FC} and number of series cells “n” in stack limited to FC current densities of 0.2 A/cm². Assuming buffer capacity Q=3 Ah, no conditions shown exceed safe 2C buffer charge rate limitation.

FIG. 104. Graph of regulated peak buffer charging current in C-rate and amperes versus fuel cell voltage V_{FCa}s a function of number of series cells “n” in stack for m=20 fuel cell array.

FIG. 105. Response surface of unregulated buffer peak charging current in amperes and series stack resistance nR_{FC} of m=25 fuel cell array as a function of cell voltage V_{FC} and number of series cells “n” in stack. Peak currents are based on CV charging of buffer at starting voltage of V_{buf}=3.6V.

FIG. 106. Response surface of FC limited peak buffer charging current in amperes and series stack resistance nR_{FC} of m=25 fuel cell array as a function of cell voltage V_{FC} and number of series cells “n” in stack. Spotted cells indicate fuel cell current densities limited to 0.2 A/cm².

FIG. 107. Response surface of regulated peak charging C-rate and series stack resistance nR_{FC} of m=25 fuel cell array as a function of cell voltage V_{FC} and number of series cells “n” in stack limited to FC current densities of 0.2 A/cm². Assuming buffer capacity Q=3 Ah, no conditions shown exceed safe 2C buffer charge rate limitation.

FIG. 108. Graph of regulated peak buffer charging current in C-rate and amperes versus fuel cell voltage V_{FC} as a function of number of series cells “n” in stack for m=25 fuel cell array.

FIG. 109. Response surface of unregulated buffer peak charging current in amperes and series stack resistance nR_{FC} of m=30 fuel cell array as a function of cell voltage V_{FC} and number of series cells “n” in stack. Peak currents are based on CV charging of buffer at starting voltage of V_{buf}=3.6V.

FIG. 110. Response surface of FC limited peak buffer charging current in amperes and series stack resistance nR_{FC} of m=30 fuel cell array as a function of cell voltage V_{FC} and number of series cells “n” in stack. Spotted cells indicate fuel cell current densities limited to 0.2 A/cm². Squares shaded gray indicate inability to charge due inadequate headroom, i.e., undervoltage where V_{chg}≤3.6V.

FIG. 111. Response surface of regulated peak charging C-rate and series stack resistance nR_{FC} of m=30 fuel cell array as a function of cell voltage V_{FC} and number of series cells “n” in stack limited to FC current densities of 0.2 A/cm². Assuming buffer capacity Q=3 Ah, no conditions shown exceed safe 2C buffer charge rate limitation.

FIG. 112. Graph of regulated peak buffer charging current in C-rate and amperes versus fuel cell voltage V_{FC} as a function of number of series cells “n” in stack for m=30 fuel cell array.

FIG. 113. Response surface of unregulated buffer peak charging current in amperes and series stack resistance nR_{FC} of m=40 fuel cell array as a function of cell voltage V_{FC} and number of series cells “n” in stack. Peak currents are based on CV charging of buffer at starting voltage of V_{buf}=3.6V.

FIG. 114. Response surface of FC limited peak buffer charging current in amperes and series stack resistance nR_{FC} of m=40 fuel cell array as a function of cell voltage V_{FC} and number of series cells “n” in stack. Peak currents are based on CV charging of buffer at starting voltage of V_{buf}=3.6V.

FIG. 115. Response surface of buffer limited peak buffer charging current in amperes and series stack resistance nR_{FC} of m=40 fuel cell array as a function of cell voltage V_{FC} and number of series cells “n” in stack. Patterned cells indicate buffer currents limited to 2C charge rates for a buffer having a capacity Q=3 Ah.

FIG. 116. Response surface of regulated peak charging C-rate and series stack resistance nR_{FC} of m=40 fuel cell array as a function of cell voltage V_{FC} and number of series cells “n” in stack limited to safe buffer charging currents of 2C assuming a buffer capacity of Q=3 Ah.

FIG. 117. Graph of regulated peak buffer charging current in C-rate and amperes versus fuel cell voltage V_{FC} as a function of number of series cells “n” in stack for m=40 fuel cell array. Solid lines indicate currents limited by the maximum safe C-rate of 2C for charging the buffer cell while dashed lines indicate the less restrictive maximum allowable fuel cell current limitation of 0.2 A/cm².

FIG. 118. Response surface of unregulated buffer peak charging current in amperes and series stack resistance nR_{FC} of m=50 fuel cell array as a function of cell voltage V_{FC} and number of series cells “n” in stack. Peak currents are based on CV charging of buffer at starting voltage of V_{buf}=3.6V.

FIG. 119. Response surface of FC limited peak buffer charging current in amperes and series stack resistance nR_{FC} of m=50 fuel cell array as a function of cell voltage V_{FC} and number of series cells “n” in stack. Spotted cells indicate fuel cell current densities limited to 0.2 A/cm².

FIG. 120. Response surface of buffer limited peak buffer charging current in amperes and series stack resistance nR_{FC} of m=50 fuel cell array as a function of cell voltage V_{FC} and number of series cells “n” in stack. Peak currents are based on CV charging of buffer at starting voltage of V_{buf}=3.6V. Patterned cells indicate buffer currents limited to 2C charge rates for a buffer having a capacity Q=3 Ah.

FIG. 121. Response surface of regulated peak charging C-rate and series stack resistance nR_{FC} of m=50 fuel cell array as a function of cell voltage V_{FC} and number of series cells “n” in stack limited to safe buffer charging currents of 2C assuming a buffer capacity of Q=3 Ah.

FIG. 122. Graph of regulated peak buffer charging current in C-rate and amperes versus fuel cell voltage V_{FC} as a function of number of series cells “n” in stack for m=50 fuel cell array. Solid lines indicate currents limited by the maximum safe C-rate of 2C for charging the buffer cell. Dashed lines indicate the maximum allowable fuel cell current limitation of 0.2 A/cm² occurring at 10 A beyond the maximum ordinate value of the graph.

FIG. 123. Graph of buffer charge rate versus fuel cell voltage V_{FC} for n=5 series connected cells charging a buffer of 3.6V or greater varied parametrically by the number of parallel cells from m from 5-to-50 or equivalent PEM area thereof.

FIG. 124. Graph of buffer charge rate versus fuel cell voltage V_{FC} for n=6 series connected cells charging a buffer of 3.6V or greater varied parametrically by the number of parallel cells from m from 5-to-50 or equivalent PEM area thereof.

FIG. 125. Graph of buffer charge rate versus fuel cell voltage V_{FC} for n=7 series connected cells charging a buffer of 3.6V or greater varied parametrically by the number of parallel cells from m from 5-to-50 or equivalent PEM area thereof.

FIG. 126. Graph of buffer charge rate versus fuel cell voltage V_{FC} for n=8 series connected cells charging a buffer of 3.6V or greater varied parametrically by the number of parallel cells from m from 5 to 50 or equivalent PEM area thereof.

FIG. 127. Graph of buffer charge rate versus fuel cell voltage V_{FC} for n=9 series connected cells charging a buffer of 3.6V or greater varied parametrically by the number of parallel cells from m from 5-to-50 or equivalent PEM area thereof.

FIG. 128. Graph of buffer charge rate versus fuel cell voltage V_{FC} for n=10 series connected cells charging a buffer of 3.6V or greater varied parametrically by the number of parallel cells from m from 5-to-50 or equivalent PEM area thereof.

FIG. 129. Equivalent circuit of 9s50p fuel cell at V_{FC}=0.45V and ⁹V_{FC}=4.05V charging a 3 Ah Li-ion cell from 3.6V to 4.05V. Table illustrates charging currents in units of amperes and C-rate as a function of buffer voltage V_{buf} and voltage headroom ΔV_{chg} for a fuel cell area m=50.

FIG. 130A. Equivalent circuit of 8smp fuel cell at V_{FC}=0.70V and 8V_{FC}=5.6V charging a 3 Ah capacity Li-ion cell from 3.6V-to-4.2V at up to 2C rates. Table illustrates charging currents in units of amperes and C-rate as a function of buffer voltage V_{buf} and voltage headroom ΔV_{chg} for fuel cells having ratiometric areas {m=50, 40, 30, 20, 10}.

FIG. 130B. Graph of QXR charging current in amperes and in C-rate versus buffer voltage for various values of ratiometric area m varying from 10-to-50 for fuel cell voltages V_{FC}=0.7V, for 8V_{FC}=5.6V, for m=50 and for V_{FC}=0.45V. As shown, for m values below 30 charging occurs without regulation. For ratiometric areas of m≥30, charging requires regulation to prevent excessive currents.

FIG. 131A. Equivalent circuit of 8smp fuel cell at V_{FC}=0.70V and 8V_{FC}=5.6V charging two paralleled 4 Ah Li-ion cell having with total capacity Q=8 Ah. Table illustrates charging currents from V_{buf}=3.6V-to-4.2V in units of amperes and C-rate up to 2C=16 A as a function of buffer voltage V_{buf} and voltage headroom ΔV_{chg} for fuel cells having ratiometric areas {m=50, 40, 30, 20, 10}.

FIG. 131B. Graph of QXR charging current in amperes and in C-rate versus buffer voltage for various values of ratiometric area m varying ratiometrically from 10-to-50 for fuel cell voltages V_{FC}=0.7V and 8V_{FC}=5.6V. Over the range of buffer voltages from 3.6V-to-4.2V and ratiometric areas from 10-to-50, regulation is not required to prevent exceeding charging currents of 2C=16 A.

FIG. 132A. Equivalent circuit of 9smp fuel cell at V_{FC}=0.80V and 8V_{FC}=7.2V charging two paralleled 4 Ah Li-ion cell having with total capacity Q=8 Ah. Table illustrates charging currents from V_{buf}=3.6V-to-4.2V in units of amperes and C-rate up to 2C=16 A as a function of buffer voltage V_{buf} and voltage headroom ΔV_{chg} for fuel cells having ratiometric areas {m=50, 40, 30, 20, 10}.

FIG. 132B. Graph of QXR charging current in amperes and in C-rate versus buffer voltage for various values of ratiometric area m varying ratiometrically from 10-to-50 for fuel cell voltages V_{FC}=0.8V and 8V_{FC}=7.2V. Over the range of buffer voltages from 3.6V-to-4.2V and ratiometric areas from 10-to-50, regulation to prevent charging currents exceeding 2C=16 A is not required except for m≥50.

FIG. 133. Plan view and end view of prototype buffered fuel cell assembly combining a single 21700 Li-ion cell as buffer and MEA membrane electrode assembly for PEM area of 15 cm² including gas inlets, exhaust ports, and PCB printed circuit board for iBFC intelligent control circuitry.

FIG. 134. Plan view and end view of prototype buffered fuel cell assembly combining a single 21700 Li-ion cell as buffer and MEA membrane electrode assembly for PEM area of 30 cm² including gas inlets, exhaust ports, and PCB printed circuit board for iBFC intelligent control circuitry.

FIG. 135. Plan view and end view of prototype buffered fuel cell assembly combining dual 21700 Li-ion cells as buffer and MEA membrane electrode assembly for PEM area of 40 cm² including gas inlets, exhaust ports, and PCB printed circuit board for iBFC intelligent control circuitry.

FIG. 136. Plan view and end view of prototype buffered fuel cell assembly combining a single 21700 Li-ion cell as buffer and MEA membrane electrode assembly of PEM area of 50 cm² including gas inlets, exhaust ports, and PCB printed circuit board for iBFC intelligent control circuitry.

FIG. 137. Table comparing capacity of several iBFC modules.

FIG. 138A. Flow chart illustrating dynamic fuel cell operation during isolation and measurement stages.

FIG. 138B. Flow chart illustrating dynamic fuel cell operation during array reconfiguration and resumption of charging

FIG. 139. Function and voltage response surface of dynamic fuel cell array function using analog-to-digital decoder.

FIG. 140A. State table of dynamic fuel cell array function.

FIG. 140B. State diagram of dynamic cell array function.

FIG. 141A. Three configurations of dynamic cell array function and fuel cell electrical characteristics thereof where the fuel stack varies from ⁹V_{FC} to 7V_{FC}.

FIG. 141B. Three configurations of dynamic cell array function and fuel cell electrical characteristics thereof where the fuel stack varies from 6V_{FC} to ⁴V_{FC}.

FIG. 142. Graph of fuel cell stack voltage nV_{FC} versus cell voltage V_{FC} using dynamic fuel cell array function.

FIG. 143A. Combined dynamic cell array function with intrinsic QXR charging for n=9 and n=8.

FIG. 143B. Combined dynamic cell array function with intrinsic QXR charging for n=7 and n=6.

FIG. 143C. Combined dynamic cell array function with intrinsic QXR charging for n=5 and n=4.

FIG. 144. Graph of fuel cell stack voltage nV_{FC} versus cell voltage V_{FC} using dynamic cell array function with intrinsic BFC regulated charging.

FIG. 145A. Response surface of fuel cell stack voltage nV_{FC} as a function of cell voltage V_{FC} and number of series cell s “n” using dynamic cell array function.

FIG. 145B. Response surface of fuel cell stack voltage nV_{FC} as a function of cell voltage V_{FC} and number of series cell s “n” using dynamic cell array function with intrinsic BFC regulated charging.

FIG. 146. Schematic of fuel cell voltage selector using analog multiplexer.

FIG. 147. Circuit and truth table for 2-bank regulated 9-to-6 dynamic cell array function with controlled gas valve.

FIG. 148. Graph of fuel cell stack voltage nV_{FC} versus cell voltage V_{FC} using banked 9-to-6 dynamic cell array function with intrinsic BFC regulated charging.

FIG. 149. Circuit and truth table for 2-bank regulated 9-to-7 dynamic cell array function with controlled gas valve.

FIG. 150. Graph of fuel cell stack voltage nV_{FC} versus cell voltage V_{FC} using banked 9-to-7 dynamic cell array function with intrinsic BFC regulated charging.

FIG. 151. Bus communication in iBFC.

FIG. 152. Intelligent environmental control of fuel cell temperature and humidity.

FIG. 153. Effect of humidity control (humidification and desiccation) on fuel cell voltage-current characteristics.

FIG. 154. Effects of temperature on conventional fuel cell power density versus iBFC with temperature regulation.

FIG. 155. Various schematic representations of Li-ion cell balancing circuits realizing precision charging current bypass function.

FIG. 156. Waveforms representing Li-ion cell balancing using precision charging current bypass function.

FIG. 157. Function and waveforms of Li-ion multiple cell balancing using precision charging current bypass function.

FIG. 158. Schematic representation of level shifted voltage reference in series connected Li-ion cell balance function.

FIG. 159. Exemplary of cell balancing in buffered fuel cell with 4s Li-ion buffer stack using a DC coupled system voltage reference

FIG. 160. Exemplary of cell balancing in buffered fuel cell with 67s high voltage Li-ion buffer stack using a AC coupled galvanically isolated system voltage reference

FIG. 161. Energy management components of a buffered fuel cell include a dynamically reconfigurable array of fuel cells with intrinsic charge regulation of battery storage buffer, pressured gas fuel source with system-controlled pressure regulation, energy recovery through protected port to external power source, and load control access port to protect iBFC.

FIG. 162A. Example of function of iBFC energy recovery module and port comprising rectified input for galvanic isolation, protection function using a BDS battery disconnect switch, and multi-mode battery charger.

FIG. 162B Schematic illustrating three different isolated ER inputs comprising an AC source with power factor correction, an inverted DC source, and wireless charging.

FIG. 163. Graph showing SOA safe operating area of iBFC buffer charging powered through energy recovery port.

FIG. 164. Schematic representing exemplary galvanic isolation proving high-voltage protection while enabling parallel charging of stacked iBFC modules.

FIG. 165. Schematic and functional equivalent of iBFC buffer load access module including BDB bidirectionally blocking protection MOSFET preventing reverse current, enabling unidirectional conduction to a load, and with optional cell shunt function capability.

FIG. 166. Electrical characteristics of bidirectional blocking unidirectional conducting (BLB/UDC) power MOSFET.

FIG. 167A. Schematic representation of circuit of stacked buffered fuel cells illustrating pass transistor function of bidirectional blocking unidirectional conducting MOSFET supplying current to an electrical load.

FIG. 167B. Schematic representation of circuit of stacked buffered fuel cells illustrating blocking function of bidirectional blocking MOSFET preventing reverse current from a powered electrical load from improperly charging iBFC buffer cells.

FIG. 167C. Schematic representation of circuit of stacked buffered fuel cells sourcing power to a load while shunt MOSFET bypasses current and cuts off gas flow to a specific disabled cell.

FIG. 168. Exemplary schematic of iFBC energy recovery and buffered load access modules preventing direct access to fuel cell connections.

FIG. 169A. Schematic representation of circuit comprising stacked buffered fuel cells with AC coupled charging and buffer load access supplying current to an electrical load via conducting pass transistor.

FIG. 169B. Schematic representation of circuit comprising stacked buffered fuel cells with AC coupled charging and buffer load access supplying current to an electrical load while bypassing specific fuel cell modules.

FIG. 170. Exemplary schematic of iFBC with 2s array of stacked buffered fuel cells integrating fuel management, energy recovery, and buffer load access capability.

FIG. 171. Functional diagram and exemplary schematic of iFBC with 1s buffered fuel cell rated at 3.7V to 4.2V output, nominally 4V.

FIG. 172. Exemplary schematic of iFBC with 2s buffered fuel cell rated at 7.4V to 8.4V output, nominally 8V.

FIG. 173. Exemplary schematic of iFBC with 3s buffered fuel cell rated at 11.1V to 12.6V output, nominally 12V.

FIG. 174. Exemplary schematic of iFBC with 4s buffered fuel cell rated at 14.8V to 16.8V output, nominally 16V.

FIG. 175. Stacked iBFC for EV motor drive with energy recovery from regenerative braking and isolated system control.

FIG. 176. Stacked iBFC with plug-in power and isolated system control.

FIG. 177. Stacked iBFC with two path photovoltaic power via DC current storage and PV2H hydrogen electrolysis.

FIG. 178. Stacked iBFC with three path energy conversion comprising photovoltaic power via DC current storage and PV2H hydrogen electrolysis, and waste heat to turbine to generator to hydrogen electrolysis (T2G2H).

FIG. 179A. Block diagram of a BFC buffered fuel cell including fuel cell stack, QXR charge transfer regulator, and buffer cell.

FIG. 179B. Block diagram of a BFC buffered fuel cell including fuel cell stack, QXR charge transfer regulator, and buffer cell with functional descriptions therefor.

FIG. 179C. Block diagram of an iBFC intelligent buffered fuel cell combining a fuel cell stack, QXR charge transfer regulator, and buffer cell with the module's ER energy recovery and BLA buffer-load access preventing adverse impact on buffer cells from external power sources and electrical loads.

FIG. 180A. Block diagram depicting functions of a QXR charge transfer regulator with a high capacity buffer.

FIG. 180B. Block diagram depicting functions of a QXR charge transfer regulator with a low capacity buffer.

FIG. 181A. Kirchhoff's current law describing 3-branch QXR summing node for BFC without energy recovery input.

FIG. 181B. Kirchhoff's current law describing 4-branch QXR summing node for BFC with energy recovery input.

FIG. 182A. BFC voltage cascade comprising 5V fuel cell stack with 1s Li-ion buffer driving 1.8V and 2.7V loads.

FIG. 182B. BFC voltage cascade comprising 12V fuel cell stack with 1s Li-ion buffer driving 1.8V and 2.7V loads.

FIG. 182C. BFC voltage cascade comprising 12V fuel cell stack with 2s Li-ion buffer driving 1.8V, 2.7V, 3.0V and 5.0V loads.

FIG. 182D. BFC voltage cascade comprising 30V fuel cell stack with 4s Li-ion buffer driving 1.8V, 2.7V, 3.0V, 5.0V and 12.0V loads.

FIG. 183A. Current-voltage overlay of the SOA of Li-ion buffer cell contrasted to the electrical characteristics of two high-voltage fuel cell stacks of differing areas.

FIG. 183B. Current-voltage overlay of the SOA of Li-ion buffer cell contrasted to the electrical characteristics of two low-voltage fuel cell stacks of differing areas.

FIG. 184A. Schematic comparison of a switch mode PWM voltage regulator to current node PWM QXR charge transfer regulator.

FIG. 184B. Schematic a multimode QXR charge transfer regulator with trickle charge, constant-current and constant-voltage mode capability.

FIG. 184C. Waveforms of PWM QXR in constant current mode and constant voltage mode operation.

FIG. 185. Flow chart for measuring fuel cell and buffer voltages, configuring fuel cell array topology, and charging buffer cell.

FIG. 186. Schematic of dynamically reconfigurable fuel cell array topology with gas cutoffs.

FIG. 187. Algorithm to dynamically reconfigure fuel cell array topology.

FIG. 188. Exemplary buffer charging waveform with concurrent dynamic reconfiguration of fuel cell topology.

FIG. 189. Comparison of relative humidity operating ranges for various BFC buffered fuel cell designs.

FIG. 190. Block diagram of iBFC intelligent buffered fuel cell combining buffered fuel cell with environmental control functions.

FIG. 191. Comparison of relative humidity operating ranges for various BFC buffered fuel cell and iBFC intelligent buffered fuel cell designs including active humidification and desiccation.

FIG. 192. Comparison of temperature operating range of exemplary fuel cells with and without intelligent active heating and cooling.

FIG. 193. Block diagram of intelligent buffered fuel cell representing various iBFC electronic control features including dynamic fuel cell array, QXR charge transfer regulator, energy recovery module, and buffer load access module.

FIG. 194. Functional schematic of exemplary iBFC electronic control features of energy recovery module and buffer load access module.

FIG. 195. Functional schematic of dynamic fuel cell array varying both fuel cell area mA_{FC} and the number of fuel cells n connected in series.

FIG. 196. Block diagram of stacked iBFC modules with “u” active modules driving an electrical load.

FIG. 197. Block diagram of stacked iBFC modules with (u−1) active modules driving an electrical load including one iBFC bypassed.

FIG. 198. Series charging of stacked iBFC modules including DC coupled charge balancing.

FIG. 199. Galvanically-isolated parallel charging of stacked iBFC modules including AC-coupled charge balancing.

FIG. 200. Simplified block diagram of a static array buffered fuel cell.

FIG. 201. Simplified block diagram of a dynamic array buffered fuel cell with buffer load access output port protection.

FIG. 202. Simplified block diagram of a dynamic array buffered fuel cell with buffer load access output port protection and electrical power input via energy recovery modulation.

FIG. 203. Energy input and outputs in iBFC applications.

FIG. 204. Schematic of iBFC electrical elements including fuel cell stack, electrical buffer, charger, and load protection.

FIG. 205. BLA buffer load access bidirectional blocking switch implementation comprising four terminal lateral MOSFET with body bias generator.

FIG. 206. BLA buffer load access bidirectional blocking switch implementation comprising common source and common drain trench power DMOSFETs.

FIG. 207. Improved BLA buffer load access comprising a three power MOSFET implementation of bidirectional disconnect and bypass switch functions.

FIG. 208. Block diagram of iBFC intelligent buffered fuel cell modules and functions.

FIG. 209. Power loss in resistive devices as a function of input power from a 4V, 24V and 48V.

FIG. 210. Schematic of a 24V iBFC comprising a dynamic fuel cell array.

FIG. 211. Fuel cell stack voltage as a function of individual fuel cell V_{FC} comprising stacks with n=21, n=42, or n=63.

FIG. 212. iBFC operation of a dynamic fuel cell switching between n=63 and n=42 including hysteresis.

FIG. 213. Top view of exemplary 24V iBFC including three stacks of 21 PEM+fuel cells.

FIG. 214. End view of exemplary 24V iBFC comprising three stacks of 21 PEM+fuel cells.

FIG. 215. Cutline view of 6s1p buffer cells within exemplary 24V iBFC.

FIG. 216. Perspective view of 6s3p buffer cells in exemplary 24V iBFC module.

FIG. 217. Exterior view of exemplary 24V iBFC.

FIG. 218. Schematic of 4 μstack 24V iBFC module.

FIG. 219. Voltage-current transfer characteristics of a dual-mode dynamic buffered fuel cell comparing n_{FC}={36, 48}.

FIG. 220. FC stack voltage dependence on individual membrane voltages V_{FC} as function of stack height n_{FC}.

FIG. 221. Schematic comparison of two-zone and three-zone five-μstack buffered fuel cells.

FIG. 222. Voltage-current transfer characteristics of a dual-mode dynamic buffered fuel cell comparing n_{FC}={36, 60}.

FIG. 223. Voltage-current transfer characteristics of a three-mode dynamic buffered fuel cell comparing n_{FC}={36, 48, 60}.

FIG. 224. Components of a buffered fuel cell including charge transfer regulator driving a summing node.

FIG. 225. Details of a charge transfer regulator in a buffered fuel cell driving a shared summing node.

FIG. 226. Details of a charge transfer regulator in a buffered fuel cell lacking a shared summing node.

FIG. 227. I-V characteristics of constant current charger and antiparallel current source bypass circuit.

FIG. 228. Calibration of BFC lumped element model.

FIG. 229. Schematic representation of various buffered fuel cells with a constant cell voltage V_{FC}=0.7V.

FIG. 230. Stack voltages for various buffered fuel cells contrasting n_{FC}={36, 48, 60} as a function of fuel cell membrane voltage V_{FC}.

FIG. 231. Schematic representation of various buffered fuel cells with a constant output voltage V_{L}=25.2V.

### DESCRIPTION OF THE INVENTION

To address the myriad of severe deficiencies plaguing best-in-class fuel cells today, a new fuel cell and system architecture is disclosed herein. Referred to an intelligent buffered fuel cell or iFBC, the new device and methods thereof integrate an energy buffer into the fuel cell module able to internally transfer energy between the fuel cell and buffer without being affected by any external electrical loads. Moreover, the iBFC exhibits electrical properties similar to the lithium ion battery to facilitate problem free use in commonplace applications to promote and accelerate widespread user adoption without the need to reengineer important applications.

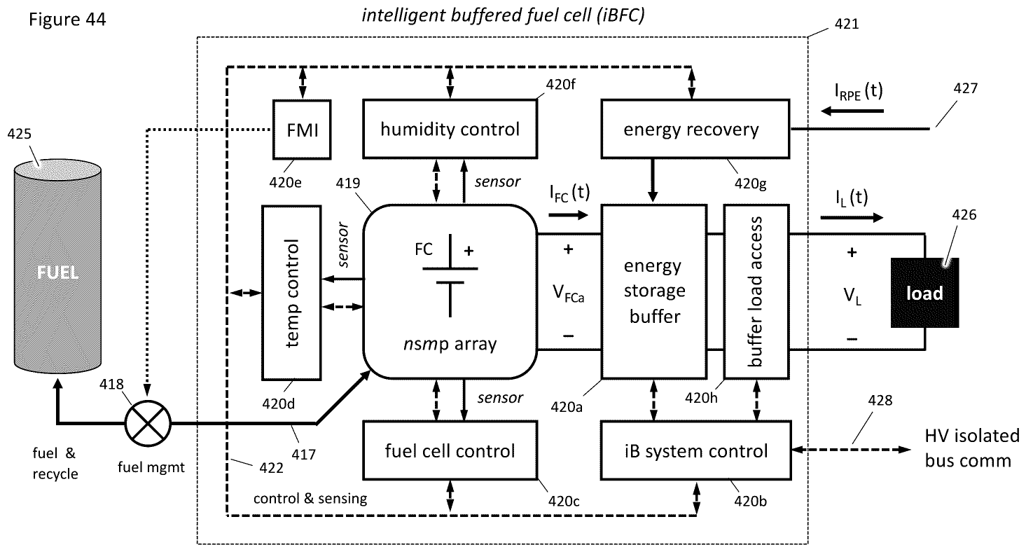

As illustrated in FIG. 44, the intelligent buffered fuel cell 421 or iBFC includes a number of key features, including without limitation the following:
Series-parallel fuel cell array 419 capable of dynamic reconfiguration of array electrical topology including number of series connected cells and the fuel cell area along with internal electrical, thermal, and humidity sensors.
Fuel cell control module 420c controlling fuel cell array topology in dynamically reconfigurable fuel cell arrays and gas microvalves.
Intelligent energy storage buffer 420a with integrated regulating charger facilitating energy storage, impedance matching, overvoltage and overcurrent protection, and buffer charge balancing functions. Energy storage buffer 420a stores electric charge and is therefore sometimes referred to through this invention as electrical storage. Unlike most components in the iBFC which comprise unidirectional flow, electrical currents within energy storage buffer 420a are bidirectional, able to source and absorb energy.
Energy recovery ER module 420g able to convert power sources such as generators, power supplies, uninterrupted power supplies, pluggable power, renewable power, regenerative power, or energy harvesting into DC power suitable for charging energy storage buffer 420a and to protect the energy storage buffer from damage. The ER module may also contain a rectifier-filter for converting AC coupled power into floating DC using galvanic isolation. Electrical energy flow into ER module 427 is denoted by the current I_{RPE} the subscript being an acronym for recovered and pluggable energy recognizing renewable and harvested energy is separate and distinct from “pluggable” grid power sources. ER module
Buffer load access (BLA) module 420h protecting energy storage buffer 420h from adverse conditions cause by external connection to load 426 including protecting against overcurrent from a shorted load, limiting over-discharge of buffer cells, and preventing reverse current from electrical loads containing their own internal power sources. As such iBFC current flow in the BLA is unidirectional flowing outward from the iBFC to load 426. Buffer load access also facilitates the dynamical ability to disconnect or shunt fuel cells from a series stack without interrupting current of disrupting iBFC operation and to conserve fuel consumption in disabled cells.
Intelligent buffer system controller 420b with high-voltage isolated external interface bus 428 and internal iBFC communication bus 422 facilitating inter-module communication within the iBFC system.
Temperature control module 420d to up-regulate (heat) or down-regulate (cool) temperature of fuel cell array 419 thereby enabling cold start capability and providing protection from fuel cell overheating.
Humidity control module 420f able to humidify fuel such as hydrogen gas delivered from fuel supply container 425 to fuel cell array 419 or to directly humidify the anode or cathode of fuel cells comprising fuel cell array 419.
Fuel management interface FMI 420e able to control external fuel management module 419 to control the flow rate and pressure of fuel supply and recycle lines 417.

Collectively, the various functional modules or blocks comprising energy storage buffer 420a, Intelligent buffer system controller 420b, fuel cell control module 420c, temperature control module 420d, fuel management interface FMI 420e, humidity control module 420f, and energy recovery module 420g comprise intelligent buffer (iB) 420. As such the intelligent buffered fuel cell iFBC 421 can be represented in a simplified form comprising a dynamic fuel cell array 419, intelligent buffer (iB) 420, and communication comprising control bus 422. The term nsmp shown in dynamic fuel cell array 419 of FIG. 44 shown previously refers to the circuit topology of the fuel cells, namely an array of “m” parallel fuel cell stacks each comprising “n” series connected fuel cells. In this descriptor, the s means series and the p means parallel. For example, a 4s2p fuel cell array comprises two parallel strings (m=2) of fuel cells each comprising four fuel cells connected in series electrically (n=4).

Note that the value of n must be the same each string, otherwise the various strings of fuel cells would exhibit different voltages, creating lossy or unpredictable electrical behavior and wasting fuel. The value of m, i.e., number of parallel cells is actually a measure of the active surface area of each fuel cell. The value of m can be any number greater than 0 representing the total area whether divided into separate discrete cells or merged into one single area. For convenience, throughout this disclosure the term m=1 means a fuel cell with an active area of 1 cm². As such, a m=2 fuel cell could mean a single fuel cell of 2 cm² or two electrically paralleled cells each 1 cm² in area. Similarly, a m=4 fuel cell could be realized by four paralleled FCs each of 1 cm² in area, two paralleled FCs each of 2 cm² in area, or one FC occupying 4 cm² in area. The area of 1 cm² is chosen as a matter of convenience because the electrical properties of fuel cells are often normalized by area, for example using the current density I/A with units of A/cm² or mA/cm² and with specific resistances being the product R_{FC}A of resistance times area with units of (cm².

As such, the choice of 1 cm² as a standard fuel cell is purely arbitrary. For example, in higher power systems requiring larger fuel cells, larger area cells may be chosen as a standard unit. If a 16 cm² area is defined to mean m=1, then a 4 cm² cell would be considered a fractional value, specifically as m=0.25. Considering that the active fuel cell area A_{FC}for m=1 is arbitrary, throughout the rest of this disclosure, the standard area for m=1 shall be construed to mean A_{FC}=1 cm² for the sake of convenance and shall not be interpreted to limit or constrain the fuel cell geometries to any size or shape. If the total area mA_{FC}of a fuel cell is changed dynamically, then the fuel cell area must be divided into at least two pieces of areas m₁ A_{FC} and m₂ A_{FC} where m₁+m₂=m.

A key element of the disclosed invention, the “buffered fuel cell” or BFC comprises fuel cell array 419 and energy storage buffer 420a. In one embodiment, the energy storage buffer comprises one or several lithium-ion batteries. As will be explained later in this disclosure, an array of fuel cells cannot be electrically connected directed to an array of lithium ion batteries and function consistently and safely. Instead, electronic charge control circuitry is integrated within energy storage buffer 420a to ensure safe energy transfer. The energy efficiency of a fixed network of fuel cells and Li-ion cells is not however, energy efficient as the fuel cells may mismatch in voltage, either too low or too high. To prevent energy transfer losses, the two chemistry cells require active regulation during energy transference. This function involves sensing voltage, and currents and when necessary reconfiguring the cell array. This dynamic function performed in real time involves the fuel cell control module 420c, essentially upgrading the inventive buffered fuel cell (BFC) into an intelligent buffered fuel cell (iBFC).

Integrated into a module, these functions in various combination comprise intelligent buffered fuel cell iBFC 421 converting fuel such as hydrogen stored in supply container 425 into electrical energy depicted as current I_{L} (t) powering an electrical load 426. In addition to converting fuel into electric power, the iBFC module as shown is also able to capture and store energy from conventional power sources. Fuel may also comprise organic compounds such as methane or glucose. The main features of the iBFC is its ability to power (drive) a diverse range of electrical loads, to maximize energy conversion efficiency from fuel (hydrogen, glucose), and to operate a wide range of environmental conditions including variations in temperature, pressure, and humidity.

The benefits of the inventive iBFC are best exemplified by considering major commercial use cases for powering motors (including electric vehicles), communication devices, and devices power by lithium ion battery packs such as notebook computers. Other battery pack loads include home energy storage and power walls.

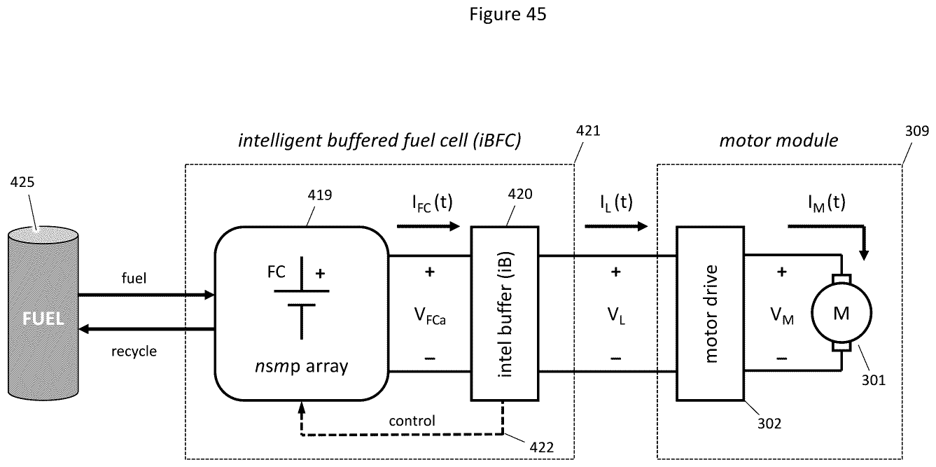

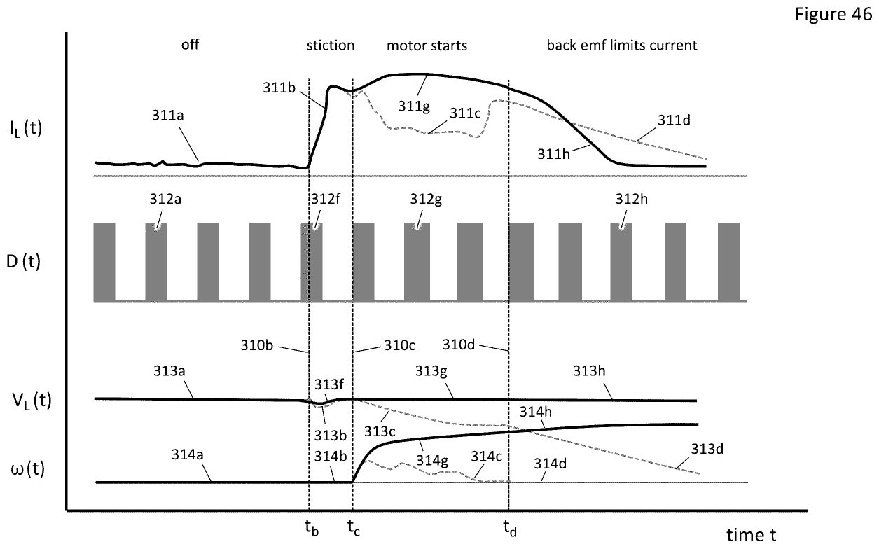

iFBC Exemplary Use Cases. Schematically FIG. 45 illustrates intelligent buffered fuel cell (iBFC) 421 comprising a fuel cell array 421, intelligent buffer controller 420, and control signal 422 delivering electrical power converted from fuel 425 to motor module 309 including motor drive 309 and motor 301. The waveforms shown in FIG. 46 contrast operation using iBFC 421 to a conventional unbuffered fuel cell implementation. As shown, in contrast to the conventional FC currents 311c and 311d causing failure to overcome stiction and start the motor 314c and 314d, and the collapse of the output voltage V_{L}(t) 313c and 313d, in the case if the buffered fuel cell, the motor starts successfully leading to a controlled increase in rotational velocity 314g and 314h, and a controlled decline in motor current 311g and 311h as back emf develops. As such PWM duty factors 312f, 312g, and 312h remain very similar to 312a during the off interval before time t_{b}. Likewise using the buffered fuel cell V_{L}(t) output from the driver remains essentially constant where 313f, 313g, and 313h remain nearly unchanged from off interval unloaded voltage 313a.

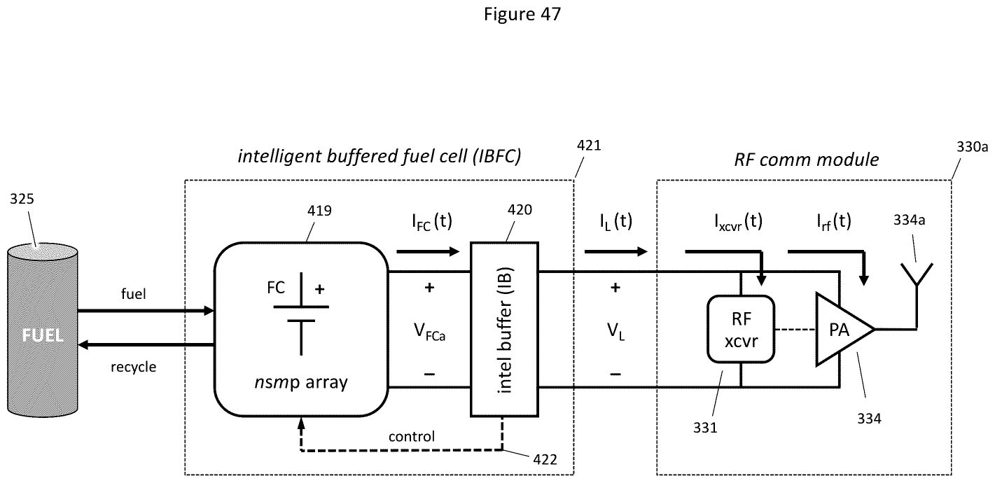

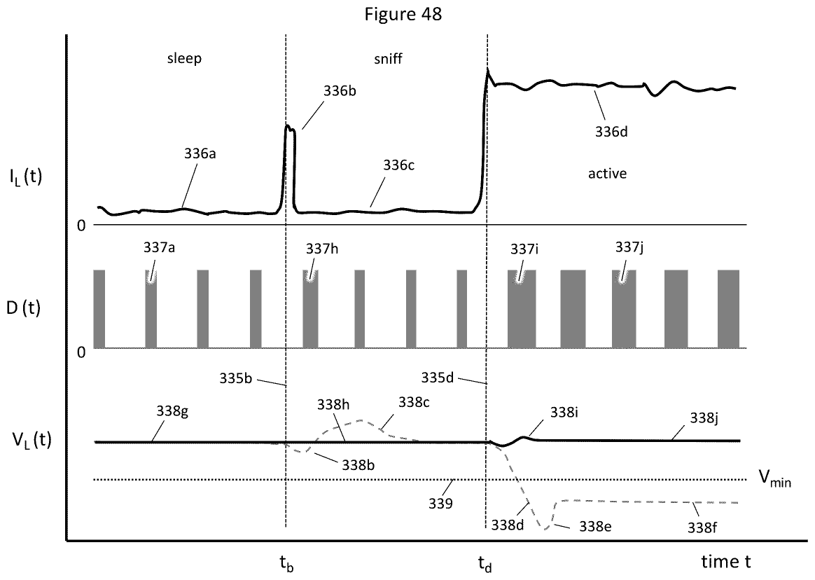

Schematically FIG. 47 illustrates the use of iBFC 421 with FC array 419, intelligent buffer controller 420 and control signal 422 powering RF communication module 330a. As depicted in the waveforms of FIG. 48, the buffered fuel cell is able to deliver a nearly constant output voltage 338g, 338h, 338i and 338j during operation totally eliminating the problematic voltage deregulation illustrated by conventional V_{L}(t) waveforms 338b, 338c, 338d, 338e, and 338f leading to system failure. Using the iBFC 421, the duty factor of internal voltage regulation within RF transceiver 331 and RF power amplifier 334 remain virtually constant 337a and 337h during sleep and sniff modes and increase only slightly 337i and 337j during active communication.

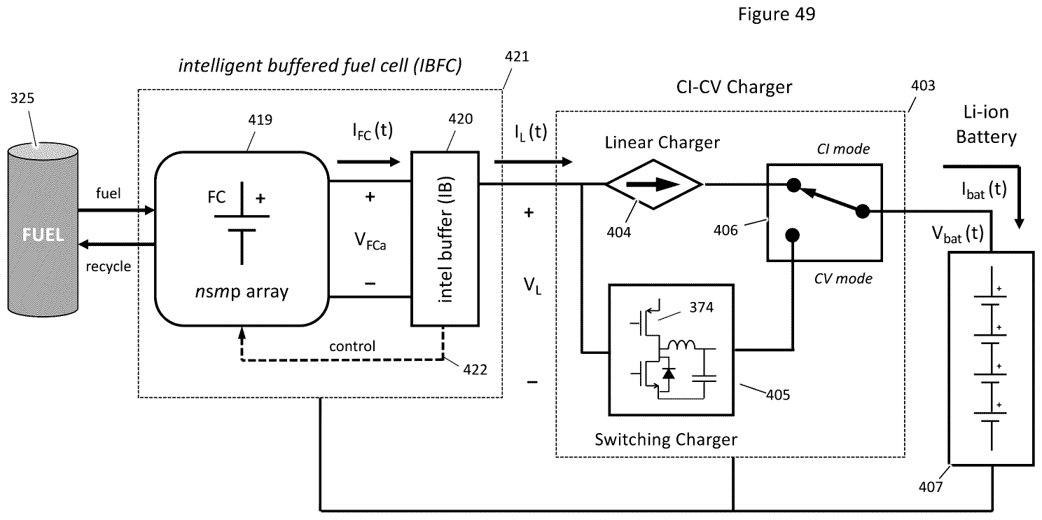

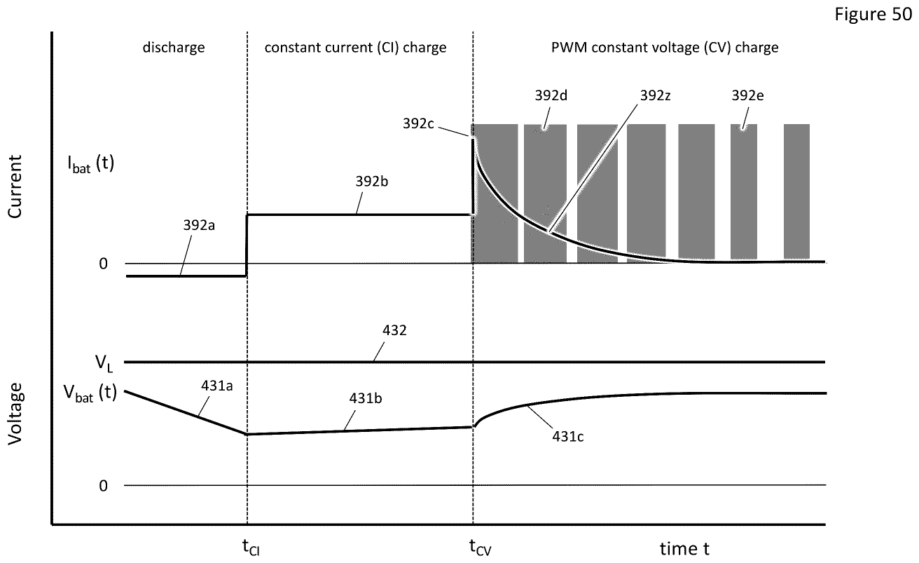

FIG. 49 illustrates the use of iBFC 421 with FC array 419, intelligent buffer controller 420 and control signal 422. As shown IBFC 421 is able to deliver power to Li-ion pack 407 including CI-CV charger 403 avoiding the aforementioned problems of an unbuffered fuel cell. In real world applications CI-CV charger 403 and Li-ion battery 407 are contained within a single product such as a notebook computer, a uninterrupted power supply (UPS) module, or a power wall. Intelligent buffered fuel cell iBFC 421 converts fuel contained in canister 325 into electric power which it supplies to the input of CI-CV charger 403 as its electrical load delivering current I_{L}(t) and a voltage V_{L}(t) The charger in turn modifies the electrical power into a form beneficial for charging battery 407 comprising time varying waveforms V_{bat} (t) and I_{bat} (t) shown in FIG. 50. The electrical load powered by Li-ion battery 407 is not shown.

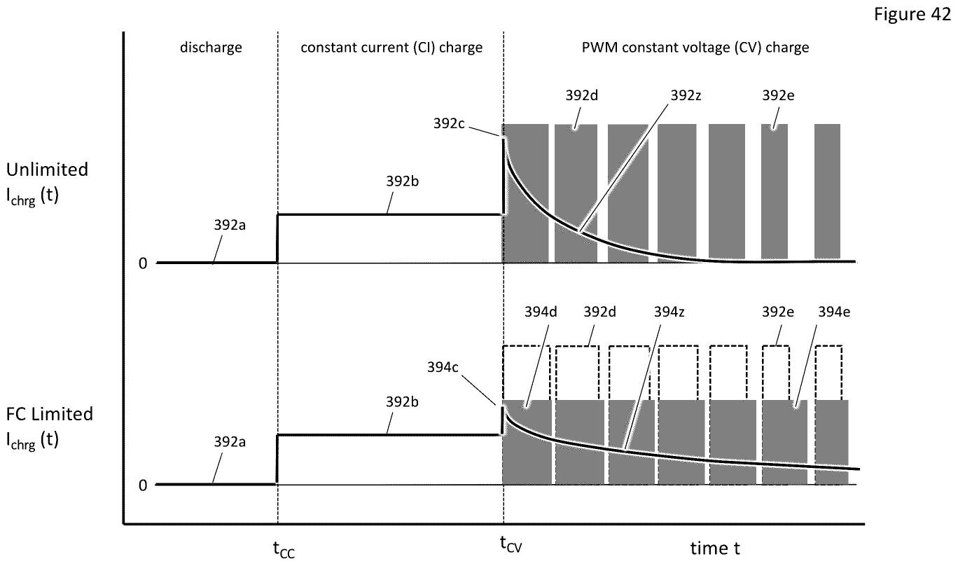

Specifically, during the discharge period when CI-CV charger 403 is not operating, battery current 392a is negative, i.e., where I_{bat} (t)<0. As such the battery voltage 431a declines. At time t_{CI} battery charging commences in the form of a constant current 392b via linear charger 404 where I_{bat}(t)>0 and the battery voltage 431b rises linearly. At time t_{CV}, the charger switches mode 406 into constant voltage pulse charging using a switching charger 405. As pulsed currents 392 commence the average battery current instantly rises 392c then declines 392z and the battery voltage 431c rises approaching its target voltage. As the voltage increases, the charger's duty factor having a value D=1−(Vₐt (t)/V_{L}(t)) declines resulting in shorter current pulses 392e. By supplying power from the intelligent buffered fuel cell iBFC 421, the fuel cell output voltage 432 remains constant throughout the entire charging cycle including pulse mode, completing overcoming the FC limited charging current problem shown previously by curve 394c in FIG. 42.

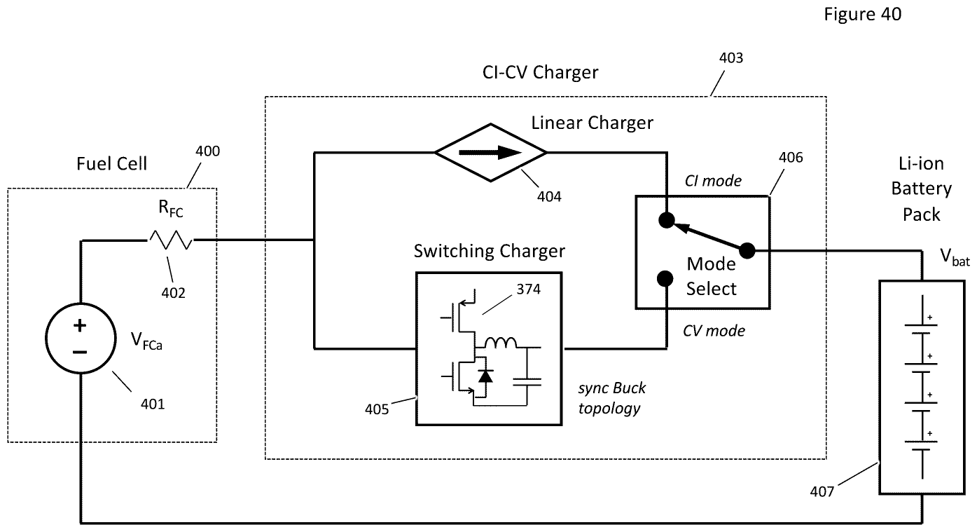

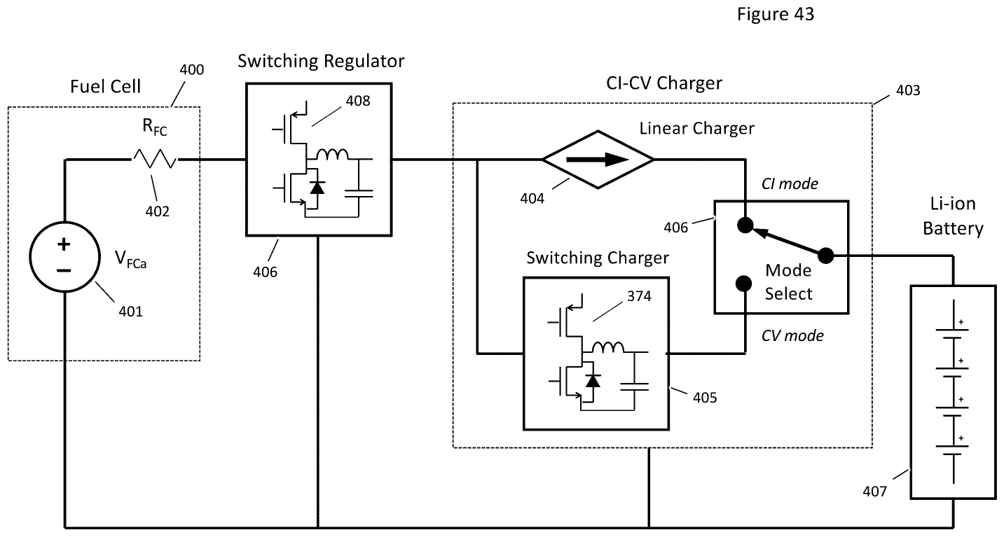

The reason charging lithium ion battery pack 407 from iBFC 421 in FIG. 49 works while the circuits shown previously in FIG. 40 and FIG. 43 does not is because an unbuffered fuel cell 400 is incapable of delivering high currents to the input of switching charger 405 or switching regulator 406 where intelligent buffer 420 is an energy reservoir containing a low-impedance charge storage element such as a lithium ion cell or array of cells.

Charging battery pack 407 from intelligent buffer 420 is essentially a battery-to-battery transfer, where battery pack 407 and charger 403 never “sees” fuel cell 419 nor even know it exists. In operation, they draw their power from intelligent buffer 420 not from fuel cell 419. In this sense, in an unbuffered system the load current I_{L}(t) is the fuel cell current I_{FC}(t), mathematically expressed as I_{L}(t)=I_{FC}(t). By contrast, in a buffered fuel cell the load current is not identical to the fuel cell because the buffer draws instantaneous current from the fuel cell totally independent from the load drawing current from the buffer, meaning generally I_{L}(t) #I_{FC} (t). More specifically whenever I_{L}(t)>I_{FC}(t) the buffer is discharging, i.e., depleting its stored energy to deliver power to the load, while when I_{FC}(t)>I_{L}(t) the fuel cell is recharging the buffer, increasing its SoC state-of-charge condition.

So unlike problematic circuits where a fuel cell is used to directly drive an electrical load, using the intelligent buffered fuel cell iBFC 421, a lithium ion battery pack can be powered and charged without concern that the input impedance of the battery or its charger circuit will overload the iFBC or cause a collapse in its output voltage. In this regard, the buffered fuel cell functions as a “stiff voltage source” powering the input of a DC/DC converter or an electrical load when a conventional fuel cell does not. A stiff voltage source is a source of electrical energy whose voltage is relatively constant over a range of currents.

The question as to whether the buffered fuel cell need be intelligent or not depends on several considerations, namely (i) does the fuel cell need to compensate for variations in relative humidity, temperature, or pressure from a changing ambient, or (ii) is protection from excessive or unusual load conditions required to prevent damage to the buffer cell, or (iii) does the buffer need to be able to absorb energy from another energy source other than the fuel cell such as pluggable power from the grid, energy harvesting from renewables such as solar arrays and wind turbines, or regenerative power from motor braking or other forms of inertial emf, e.g., gravity changes in potential energy.

If the load is benign with predictable or low current demands like a security camera, the device operates in a temperature and humidity regulated environment, and the fuel cell is the only source of power to charge the recharge buffer, then intelligence features are not required in the buffer module. If however the environmental conditions are subject to real-time changes like when driving an EV, the system has a charging port, or if the load is unpredictable like a battery UPS module, then intelligence is required. Described previously in FIG. 44, intelligence functions in iBFC 421 include environmental factors involving humidity control 420f, temperature control 420d, and FMI fuel management 420e which may include gas pressure or flow rate. Intelligence functions also include electrical functions and safety provisions including energy recovery module 420g to manage incoming power from external sources, buffer load access module 420b to protect against adverse impacts of external electrical load 426 on fuel cell array 419, fuel cell control 420c adjusting the fuel cell array topology to match the fuel cell voltage to the buffer and improve electrical efficiency, and finally intelligent buffer system control module 420b to control operations, manage control and sensing data transport across internal data busses 422, and to facilitate isolated bus communication 428 to the outside world.

Summary of iBFC Benefits: A summary of benefits of the buffered fuel cell (BFC) and the intelligent buffered fuel cell (iBFC) includes without limitation the following use cases:
Ability to directly convert fuel such as hydrogen or glucose into electric current and to concurrently absorb and store electrical energy from itself and from other electrical sources such as solar, wind, and grid power for later use.
Ability to provide an integrated means for supplying either immediate and deferred power providing synergistic benefits of both storage and local power generation for high up-time energy availability.
Ability to cleanly convert hydrogen, glucose, or other fuels into electricity as a low impedance electrical power source producing only water as a chemical byproduct.
Ability to consume and convert fuel such as hydrogen into electrical power as a low impedance electrical power source using fuel generated from a wide spectrum of energy sources including renewable resources such as wind, solar, and hydroelectric power; from nuclear power including heat generated power, electrolysis, or combinations thereof; from low-carbon-footprint energy sources such as natural gas or methane conversion; or from capturing waste gasses produced during industrial and chemical manufacturing. Alternatively the ability to convert organic compounds such as glucose or various inorganic compounds like caustic soda, i.e., NaOH, directly into energy.
Ability to improve the energy conversion efficiency of polluting sources such as coal gasification or using carbon-sequestered fossil fuels such as oil, brown, or black coal by increasing the total electrical energy output for CO₂ produced.
Ability to function as a secondary source of power generation such as uninterrupted power or for use in emergency and backup power.
Ability to function as a secondary source of power generation such as portable power or for use in electric vehicles and portable devices.
Ability to contribute to primary power generation supplying electrical power to the main grid, local grids, microgrids, and home and personal power networks.
Ability to improve the efficiency of solar power conversion combining photovoltaic direct conversion into electric power with thermal water electrolysis of panel heat into hydrogen and subsequently converted by the buffered fuel cell in electricity.
Ability to supply power and/or drive all load types including motors, communication devices, communication systems, lighting, computing devices, electromechanical and electronic systems.
Ability to charge lithium ion battery packs including notebook computers, uninterrupted power supplies (UPS), battery backup power, home wall power, and electric vehicles.
Ability to stably power all types of load impedances including resistive, inductive reactive, capacitive reactive, dynamic reactive, reflective transmission lines, and power converters.
Ability to stably supply input power to all power supply and power converter topologies including DC-to-AC inverters, AC motor drive inverters, synchronous power converters, along with all DC-to-DC converters and regulators including Buck, synchronous Buck, boost, flyback, forward, and Cuk topologies.
Ability to cooperatively cogenerate power with other renewable power sources including photovoltaic solar, thermal solar, wind power generation, hydroelectric, and ocean wave power including delivering power when renewable sources such as the sun or wind are temporarily unavailable.
Ability to cooperatively cogenerate power with turbine-based power in turbine-to-generator-to-grid T2G2G using DC-to-AC inverters and microinverters synchronized to the grid, able to deliver consistent power levels avoiding problems in destabilizing the main power grid.
Ability to directly convert hydrogen or other fuels into energy for transportation applications including electric vehicles or hybrid electric vehicles including, cars, trucks, motorbikes, scooters, busses, tractor-trailer rigs, trains, boats, ships, ferries, and more.

Compared to all reported fuel cells, the BFC buffered fuel cell and iBFC intelligent buffered cell feature a number of unique capabilities not possible with present day technology.

These advantages include:
Ability to deliver significantly higher currents to an electrical load, more than 250 times greater than conventional fuel cells.
Able to deliver electrical current from the electrochemical cell exhibiting low series impedance and minimal polarization voltage losses reducing the adverse impact of higher current demand on fuel cell terminal voltages.
Ability to rapidly supply high current spikes from load transients without significant voltage dropout of BFC voltage.
Offering a voltage source with minimal reactive components avoiding unwanted oscillations or underdamped overresponse to voltage and current load transients.
Ability to perpetually supply uninterrupted current to an electrical load so long that the BFC's fuel is replenished either through by replacing the gas supply, through continuous hydrogen co-generation, or by refilling its fuel container with an external source before the buffer discharges. The buffer thereby increases the available swap time for replacing a fuel canister without interrupting operation.
Ability to maintain a stable voltage on the BFC terminals while replacing fuel sources such as swapping cannisters or refilling a fuel tank.
Ability to maintain a tight distribution in output voltage despite changes in the fuel cell potential, thereby avoiding the safety risk to the buffer device electrical loads of overcharging batteries or burning up motors from undervoltage operation.
Ability to operate over a wider temperature range including room temperature operation.
Ability to commence operation, able to start-up at cold temperatures or during freezing temperatures.
Ability to optionally provide internal active cooling to avoid cell overheating.
Ability to operate over a wide range of relative humidity, even in hot or cold dry climates such as deserts and the artic including the ability to humidify incoming gasses.
Able to maintain consistent levels of output power despite environmental variations affecting fuel cell reaction rates and electrochemical potential.
Ability to self regulate fuel cell internal humidity and temperature.
Ability to dynamically shutdown unused or unneeded fuel cells during operation while conserving fuel by temporarily disconnecting passive fuel cells from the gas supply eliminating wasteful fuel consumption. This dynamically controlled fuel cell topology minimizes buffer charging time while maximizing overall fuel to electric conversion generating efficiency.
Ability to absorb and store electrical energy from charger power to increase energy capacity, preserve fuel reserves, or extend EV driving range.
When combined with solar panel generated hydrogen, the ability to provide 24/7 power using photovoltaic electrical recharging of the buffer in the daylight hours and using electrolysis generated hydrogen at night to recharge the buffer via fuel cell electrical generation.
Ability to manage fuel supply input facilitating control of external valves, pressure regulators, and humidifiers able to control, regulate and sequence the flow of hydrogen or fuel into the fuel cell including recycling of unused fuel.
Supports a range of buffered fuel cell module voltages, including 3.6V-to-4V and 14V-to-16V types.
Supports a variety of series-parallel fuel cell and series-parallel buffer cell topologies to maximize fuel-to-electricity power generation; electric energy storage; or to realize some balance therebetween controlling the blend of electrical generation-to-storage capacities.
Ability to control and monitor iBFC operation communicating via an internal bus and system controller IC, microcontroller, or module.
Ability to control, monitor, communicate iBFC operation externally to power plant controllers, power system controllers, engine control, peak power tracking systems, and UPS backup power controllers using any number of non-isolated or isolated system control bus protocols and their associated wired or wireless physical mediums including USB, WiFi, Bluetooth SPI, I²C, S²C, Ethernet, DOCSIS, or automotive standards such as CAN, LIN, FlexRay, Medi Oriented Systems Transport (MOST), On-Board Diagnostics (OBDII), SAE J1850, or SAE J1708.
Ability to report fault conditions or alerts to external applications and systems via said bus communication.
Ability to stack BFC assemblies into higher-voltage modules from 15V to 1000V while maintaining a balanced voltage distribution across all modules
The ability in stacked modules to AC-couple charging currents using galvanic isolation and to opto-isolate control signals eliminating high voltage shock risk.

Together, these elements enable the buffered fuel cell to store power as either electrical energy in the buffer or in the form of hydrogen (or another fuel) for subsequent conversion into electricity at a later time. The total charge deliverable from the buffered fuel cell thereby equals the charge stored in the buffer cells plus the charge stored in its fuel. In the case of a hydrogen fuel cell, the total charge convertible from a canister of hydrogen depends on the volume, pressure and temperature of the hydrogen storage system. If electrolysis of water or methane is processed to produce hydrogen in real time, then the total energy capacity is unlimited (so long as more fuel is delivered) but instead is determined by the conversion rate, i.e., how rapidly can more fuel be created.

Hydrogen fuel converted into electrical energy with in the BFC can be produced using energy such as heat from another energy source such as solar heat; geothermal heat; heat from nuclear reactions or nuclear power plants; waste heat from other chemical processes, factories, or waste treatment facilities; or heat from the clean burning of fossil fuels, i.e., the burning of gas, methane, oil, or coal combined with carbon sequester methods and technologies. Alternatively, electric power can be used to generate hydrogen by electrolysis of water powered by solar photovoltaics, wind turbines, by hydroelectric power, or by electric power generated via boiling water powering turbines and generators. Boiling water can be produced from geothermal sources, from nuclear power, or from the clean burning of fossil fuels including gas, methane, oil, and coal with carbon sequester techniques to limit CO₂ emissions. Electric power for electrolysis may be produced, delivered, and converted locally into hydrogen. Alternatively heat-generated turbine power for electrolysis may be delivered over the grid to the hydrogen production facility—a process referred to herein as T2G2G, an acronym for turbine-to-generator-to-grid describing the energy transfer sequence.

In one embodiment the fuel cell is a hydrogen fuel cell constructed of a solid electrolyte proton membrane exchange (PME) layer assembled or stacked in a membrane electrode assembly or MEA. The total area of the fuel cell MEA can be realized in one larger area or broken into an array of multiple smaller fuel cells in a nsmp series-parallel array comprising m parallel string or stacks of n-series fuel cells. To ensure consistent voltages all parallel stacks must comprise the same number of n series connected cells. Aside from the current density dependence of each fuel cell's voltage V_{FC}, there is no limitation on the number or aggregate area of parallel cells m, which may be multiples of fraction of the area defined as m=1 with the caveat that gas flow into various aspect ratio cells should be uniform to fully utilize the active PEM surface area and reduce reliance on the GDL gas diffusion layer.

In another embodiment the fuel cell comprises a PEM proton exchange membrane conducting hydrogen ions generated from the oxidation of organic molecules such as glucose, in which case the fuel is for example a suspension of sugar water, easily replenished, safe, non-toxic, and inflammable. In another class of embodiments the fuel cell comprises an AEM anion exchange membrane able to conduct negatively charged ions such as hydroxyl ions OH-generated from the reduction of KOH or glucose.

The intelligence related features in the iBFC comprise methods and apparatus for controlling the fuel cell internal environmental conditions including anode humidity, cathode humidity, cell temperature, gas pressure, gas flow rate, along with various electrical functions such as dynamic varying the fuel cell array topology, optimizing charging of the buffer cell, preventing overcharging or over-discharging of the buffer cell, protecting against overheating of the fuel cells and buffer cells, and protecting against excessive currents.

In another embodiment, the array of fuel cells can be electrically altered by switches, preferably comprising power MOSFETs configured to change the routing of electrical current through series connected cells to increase or decrease the number of cells in the string, either by shunting an active cell or diverting current to the output by excluding the cell, essentially implementing a multiplexer of two or more power switches using control circuitry described herein as fuel cell control functional block 420c.

The buffer in the buffered fuel cell refers to its means to capture and retain electric energy generated by the fuel cell for subsequent use. Electrically the buffer serves as a mechanism for energy transfer between the fuel cell as a DC electrical generator and the electrical load. It provides a number of benefits. First, it allows fuel cell energy generation to occur asynchronously with energy consumption by the load, meaning the energy production can continue unabated whether the load is consuming all or part of the current being generated or not. Secondly its allows unused electric power to be stored for later use, for instances when current consumption exceeds the electrical generation rate. Thirdly, it provides low impedance instantaneous power to a load to satisfy high current demand and current spikes resulting from load transients too fast for a fuel cell's slow electrochemistry to respond to. Fourthly, it facilitates efficient energy transfer accommodating impedance mismatches between the load and fuel cell. Fifthly, it enables the BFC to maintain consistent electrical characteristics such as resistance, voltage, and current capability despite the environmental effects of temperature and humidity on the fuel cell performance and energy conversion.

Sixthly, it allows the fuel cell to deliver power to the buffer at an optimum current density irrespective of a load's current demand. Seventhly, it allows the BFC to store electrical energy not only generated from its own fuel cell but from external electrical power sources including DC power converted from the AC mains; energy recovery from regenerative braking in EVs; electric power output from photovoltaic arrays (thereby eliminating the need for solar inverters); and other means of energy harvesting. Lastly, through water electrolysis powered by the BFC, excess electrical power can be converted into hydrogen gas for later use, while beneficially increasing unused electrical buffer capacity to accommodate incoming electrical power from time sensitive photovoltaic, wind, or generator sources.

In one embodiment the energy buffer storage device is a lithium ion battery. Alternatively, the buffer may comprise the parallel combination of lithium ion batteries, or for higher voltages a series string or series-parallel array of Li-ion batteries. Critically, the battery buffer array is connected to the fuel cell array through an intervening charge transfer regulator or QXR, the function of which is several fold, namely to (i) protect the fuel cells from excessive power draw, (ii) to protect the buffer battery from excessive charging currents, and (iii) to protect the battery from a dangerous overvoltage condition developed from overcharging the cell.

In other embodiments the fuel cell comprises an alternative chemistry such as glucose or caustic potash (KOH) instead of hydrogen, a thinner membrane, a reengineered gas diffusion layer, maintaining a higher fuel cell voltage, lower membrane impedance, and reduced polarization voltage. The combined benefits reduce the need for connecting as many fuel cells in series. Designing a fuel cell array which relies on a higher more stable fuel cell voltage, although beneficially for minimizing cost, means the electronics depends on the fuel cell performance. The fuel cell may comprise a room-temperature low-temperature, or high temperature PEM fuel cell primarily operating in the ranges 0° C.-to-50° C., 60° C.-to-80° C., and 110° C.-to-180° C. respectively.

Any significant deviation in fuel cell characteristics, for whatever reason, means the system will fail to function within target voltage and current specifications. As an embodiment of this invention, the fuel cell comprises a reconfigurable array of multiple cells where the number of series connected cells varies based on the measured voltage. If the voltage is too low to adequately charge the buffer more cells are connected in series increasing the stack voltage to charge the buffer battery. Alternatively, if the individual fuel cell voltage are high, the stack voltage will exceed the voltage needed to charge the buffer battery. In such a case, the number of energy generating fuel cells must be reduced by (i) electrically shorting out the unnecessary fuel cell, and (ii) cutting off the hydrogen fuel supplied to the inoperative cell to avoid wasting fuel.

While the disclosure describes a PEM membrane based hydrogen fuel cell and a buffer battery comprising one or more lithium ion cells, other chemistries may be used. For example, the fuel cell electrochemistry may employ a different fuel source other than hydrogen gas including alkali, molten carbonate, phosphoric acid, and solid oxide fuel cells. Similarly, the battery buffer may comprise a different electrochemistry such as lithium polymer, lead acid, and nickel-metal-hydride compounds.

Aside from turning off and bypassing individual fuel cells in a cell stack, fuel cell modules may also be bypassed by a iBFC module shunt function which (i) shunts the module diverting current around it, and (ii) cuts off fuel consumption in unused modules improving efficiency and increasing operating times.

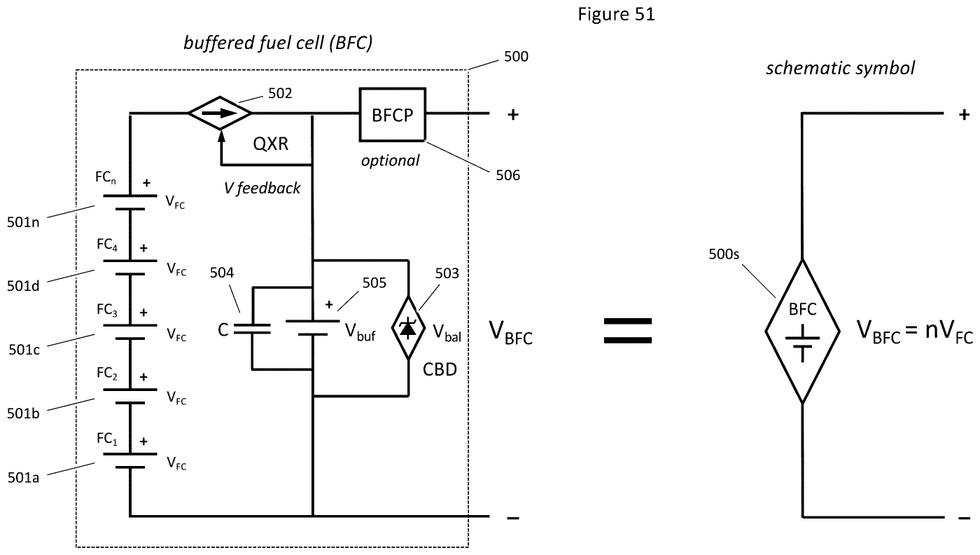

The Buffered Fuel Cell. The buffered fuel cell disclosed herein comprises a variety of elements used together to generate electric power, safely transferring charge from the fuel cell array and storing that charge on a low-impedance charge storage device such as a lithium ion battery. FIG. 51 illustrates the equivalent schematic 500 and corresponding symbol 500s of an BFC buffered fuel cell integrating an array of fuel cells, a battery buffer cell, along with charging and protection circuitry. As depicted, BFC elements include some combination of the following:
An array of series connected, parallel connected, or series-parallel connected fuel cells 501a-501n for example comprising without limitation a room temperature hydrogen fuel cell using a proton exchange membrane (PEM) as an electrolyte.
A low-impedance charge storage device 505 comprising an individual battery, a series string of two or more batteries; an array of two or more batteries in parallel, of a series-parallel combination. In one embodiment, the battery chemistry is lithium-ion.
One or more devices or circuits used to limit the battery's state of charge either by (i) cell balance device CBD 503 limiting the maximum cell voltage and balancing charge among series connected cells; (ii) a QXR charge transfer regulator 502 controlling charge transfer from the fuel cell array to the battery, or (iii) the combined use of both.
A high speed capacitor C 504 to provide protection against electrostatic discharge (ESD) static induced damage.
An optional buffered fuel cell protection BFCP 506 circuit to protect against some combination of over-current, over temperature, and cell over-discharge.

Although the charge transfer regulator QXR in some ways functions like a battery charger, it other ways it functions as a current limiter to prevent overloading of the fuel cells leading to voltage collapse. Shown previously in FIG. 43 the function of a battery charger such as CI-CV charger 403 or of switching voltage regulator 406 is to maintain a prescribed output of current or voltage assuming the input power is unlimited, meaning the input power must be a “stiff” voltage source unaffected by spikes in current demand. By contrast charge transfer regulator QXR must protect both its input and outputs from dysfunction by limiting the rate of current flowing between the fuel cell array and the battery buffer cell.

Too much current flowing between the fuel cell array and the battery can cause (i) a drop in the voltage of the fuel cell potentially overheating or dehydrating the cell and/or damaging its electrochemistry; (ii) overcharge the battery buffer causing a dangerous overvoltage condition leading to Li-ion cell damage, electrolyte leakage, fire or explosion; or (iii) overheat the battery buffer also possibly causing Li-ion cell damage, electrolyte leakage, fire or explosion. As such, the QXR is both a current limiter and a voltage regulator—limiting its input current to protect its fuel cell power source and regulating its output voltage to protect the battery buffer from overcharging.

A key function of the QXR charge transfer regulator is to match the series stack voltage nV_{FC} of a fuel cell array of n cells to the voltage of the buffer cell V_{buf} up to the maximum allowable voltage of the buffer V_{buf}(max) whereby
V_{FC} is the voltage of a single fuel cell with typical voltages of 0.4V-to-0.9V per cell,
n is the number of fuel cells of the same area connected electrically in series, where n may vary from 1 to 10 or higher,
nV_{FC} is the voltage of a series stack of n fuel cells,
R_{FC} is the resistance of s single fuel cell of area A_{FC} Or area multiplier m=1,
nR_{FC} is the total series resistance of series stack of n fuel cells where m=1 and where nR_{FC}/m is the total series resistance of series stack of n fuel cells where m #1,
V_{buf} is a buffer cell voltage specific to a particular battery electrochemistry, e.g., 2.7V-to-4.2V for a lithium ion cell or 2.3-to-2.5V for a sodium ion battery,
R_{buf} is the ohmic resistance of the buffer of a fixed battery area, and
V_{BFC} is the terminal voltage of a buffered fuel cell where V_{BFC} (V_{buf}−I_{L}R_{b}AU) at load currents I_{L} and where V_{BFC} V_{buf} at low currents.

Typically fuel cells exhibit voltages between 0.4V-to-0.9V per cell, well below the typical unloaded buffer voltage V_{buf}≈3.6V±0.6V. In order to match the fuel cell stack voltage to the buffer voltage so that nV_{FC} V_{buf} and nV_{FC}>Vₙₒₘ to facilitate charging, the fuel cell must comprise a series stack of “n” cells where 4≤n≤10. For example, for n=5 when V_{FC}=0.70V then V_{buf}=5(0.7V)=3.5V and when V_{FC}=0.75V then V_{buf}=5(0.75V)=3.75V. In a design where n=6, V_{FC}=0.60V then V_{buf}=5(0.6V)=3.6V and when V_{FC}=0.70V then V_{buf}=5(0.7V)=4.2V. For fuel cell voltages above 0.7V however a n=6 fuel cell has a voltage exceeding 4.2V. For voltage greater than the maximum buffer voltage V_{buf}(max)=4.2V of a lithium ion cell, the QXR must functions as a voltage regulator, voltage limiter or voltage clamp.

The optimum selection of the number of series-connected fuel cells depends on the construction of the fuel cell, its normal variation in voltage over operating and ambient conditions, and the electrochemistry of the buffer. As various embodiments of this invention, the number of fuel cells in a stack “n” can be chosen (i) never to exceed the maximum buffer voltage V_{buf}(max), (ii) to exceed the V_{buf}(max) under ideal ambient conditions (such as high humidity) but under nominal conditions not to exceed the buffer's V_{buf}(max) rating, or (iii) generally to exceed the maximum buffer voltage and rely on the QXR to safely limit the buffer voltage.

Although the first case eliminates any risk of overdriving the buffer it also underperforms in energy density by not fully charging the buffer thereby limiting stored electrical energy reserves. The third case, always fully charging the buffer, stores the most electrical energy in the buffer but is least efficient in its use of fuel because the QXR change transfer regulator loses power when it must restrict the buffer voltage. The middle case is a compromise between the two. All three cases apply to a fixed network of fuel cells, i.e., where the number of series cells n is a constant.

In another embodiment of this invention described as a dynamic fuel cell array, the number of fuel cells can be changed during operation based on changing ambient conditions and fuel cell voltages, for example to produce a voltage only slightly higher than V_{buf}(max). This embodiment is described later is this application.

One inventive feature of the disclosed buffered fuel cell (BFC) as disclosed is its ability to function as a self-charging low-impedance battery. In such use cases, any electrical device drawing energy from the buffered fuel cell receives its power in the same manner as if it were connected to a lithium ion battery, except that the battery recharges itself without any connection to electrical power. To the user, the BFC appears indistinguishable from a battery power source that replenishes itself and never discharges so long that fuel is available. The potential real-world BFC applications functioning as a “self-recharging battery” are endless. BFC applications include the following:
Power packs and charging stations for portable electronics such as mobile phones, tablets, notebooks.
UIS uninterrupted power supplies for computers; servers; networks including Ethernet routers, WiFi routers, cable modems, fiber headend devices, cable set top boxes; wired and wireless communication systems including cell towers, RF repeaters, fiber repeaters, and satellite dishes,
UIS uninterrupted power supplies for residential and commercial properties including appliances, WiFi networks, and security systems.
UIS uninterrupted power supplies for mission critical applications including hospitals, emergency services, forest ranger observation towers, fire stations, military deployments, ad hoc emergency communication networks, and impromptu facilities for disaster relief.
UIS uninterrupted power supplies for powering control systems for power generation and power distribution.

Another class of applications for the disclosed buffered fuel cell comprise electrical systems requiring fuel derived power generation and electrical power storage. Applications include concurrent cogeneration of hydrogen and electrical power where the electrical power is immediately available on-demand and the generated hydrogen is stored and converted later into electric power by the fuel cell. Other BFC uses include energy harvesting from unreliable sources such as wind and solar power stored electrically but supplemented by hydrogen fuel when primary power is unavailable. Still other applications involve hydrogen generated electrical power with regenerative electrical energy recovery Examples include:
Hydrogen powered electric vehicles including cars, trucks, and trains able to recover energy from traction motors during braking, aka regenerative braking, where during braking motors become generators storing electrical power in the BFC's battery buffer,
Solar cogeneration of photovoltaic electric power stored in the BFC's battery buffer, heat converted by microturbine into electric current stored electrically or converted into hydrogen through electrolysis, and later converted into electric power through the fuel cell,
Wind turbine cogeneration of electric power stored in the BFC's battery buffer and simultaneously converted into hydrogen by electrolysis and later converted back into electric power through the fuel cell,
Power wall where the BFC's battery buffer is charged either from a solar PV panel or from the mains, supplemented by a hydrogen backup, where the hydrogen can either be supplied or converted from the PV or mains using electrolysis.

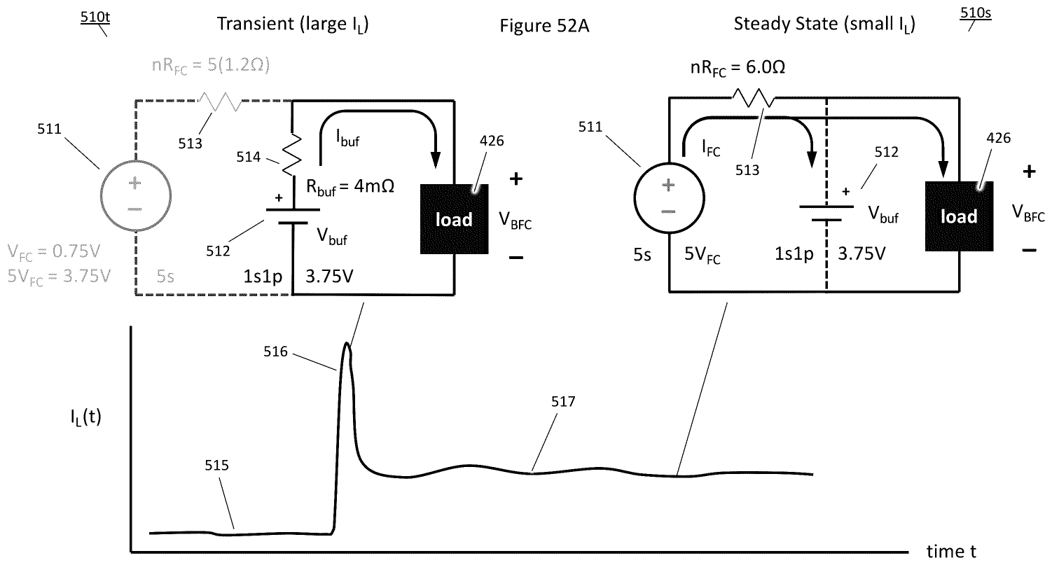

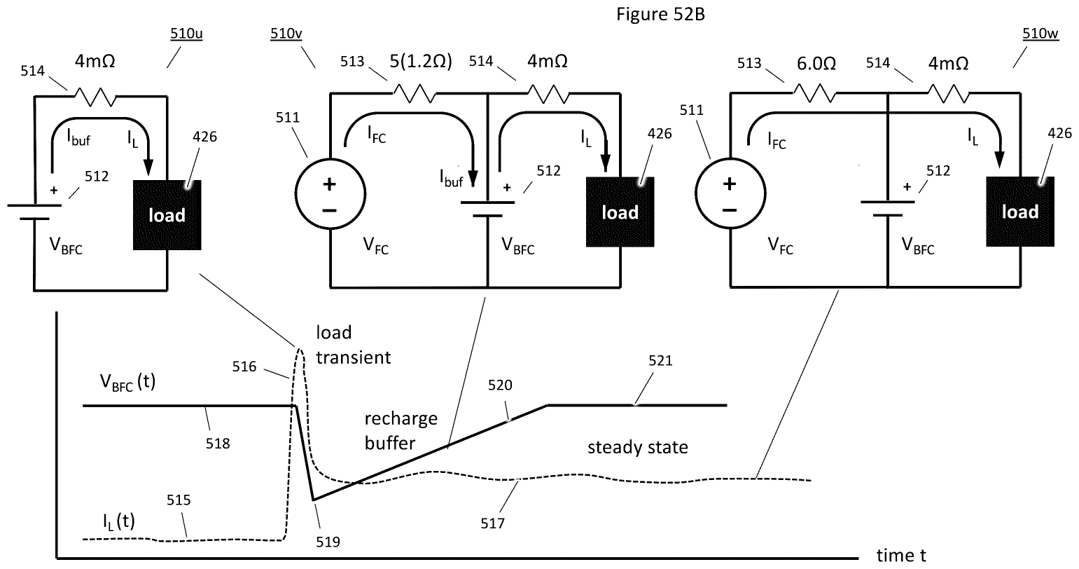

As shown in FIG. 52A, the buffered fuel cell operation involves two operational modes best represented by two different equivalent circuits—transient circuit 510t and steady state circuit 510s. In reality, the electrical network remains the same but the relative contribution of the components change. The full equivalent circuit comprises and an electrical load 426 powered by the parallel combination of an array of fuel cells 511 with equivalent resistance 513, and a buffer cell 512 comprising with an equivalent internal resistance 514. Strictly speaking, the electrical network comprises two parallel branches—one branch comprises fuel cell 511 in series with its equivalent resistance 513, the second branch comprises buffer voltage 512 and its associated resistance 514.

In operation the circuit supplies current from both sources 511 and 514 to load 426 at a voltage V_{BFC}. The actual power contribution of both sources, however, depends on the load condition not the fuel cell and buffer. More precisely, the two branches contribute to the total load current I_{L}=(I_{FC}+I_{buf}) in an amount inversely proportional to their resistances, namely I_{FC}=(V_{BFC}−V_{FC})/nR_{FC} and I_{buf}=(V_{BFC}−V_{buf})/R_{buf}. When V_{FC}≈V_{buf} then I_{buf}/I_{FC}≈(nR_{FC}/R_{buf}). Because the resistances are significantly different, i.e., nR_{FC}>>R_{buf} then their relative current contributions (V_{BFC}/nR_{FC})<<(V_{BFC}/R_{buf}) are also substantially different. Succinctly put, the buffer can supply high current, the fuel cell cannot. Conversely, the fuel cell can create electric charge, the battery cannot.

As shown in circuit 510t, during high load-current transients, fuel cell array 511 has little involvement because of the high resistance nR_{FC} of its stack of fuel cells. Instead buffer cell 512 almost exclusively delivers power to load 426 during current transient. During a load transient, the current changes rapidly from its quiescent condition 515 to a transient current spike 516, the magnitude of which is limited only by the value R_{buf} of series resistance 512. After the transient spike subsides the current diminishes to a steady state value 517. During steady state operation shown by circuit 510s, fuel cell 511 supplies a total current I_{FC} which is shared between load 426 and the recharging of buffer cell 512. Because the current charging buffer cell from fuel cell 511 necessarily flows through high value resistor 513 and because nR_{FC}R_{buf}, there is no need to include buffer resistance 512 in the charging loop to predict charging. As such, the buffer resistance has been removed from steady state circuit 510s to provide a more phenomenological representation of the network.

As shown by the I_{L}(t) waveform, load transients representing a sudden increase in current demand from a quiescent state 515 to current spike 516 are supplied by the buffer cell 512, e.g., a single lithium ion battery and not by fuel cell 511. The superior ability of buffer cell 512 to deliver instantaneous power is a direct consequence of its low internal resistance 504, low AC impedance, and voltage stiffness. In lithium ion electrochemistry, the adverse impact of polarization effects diminishing the battery's terminal voltage is negligible except at an extremely low state-of-charge, i.e., during deep discharge. Polarization losses in Li-ion cells are only weakly dependent on battery currents.

This means the battery voltage is essentially constant and the cell maintains a low ohmic resistance. Absent any protection circuitry such as a battery disconnect switch described previously, a shorted Li-ion cell can deliver a short circuit current of around 1000 A, i.e., 4V divided by an internal resistance of 4 mΩ, or a discharge C-rate of 333C far above the maximum tested discharge current of 15C. So although the battery is protected against such high currents, the unprotected short circuit capability of an electrochemical cell is a measure of its current handling capability.

In this regard, a single hydrogen fuel cell of 1 cm² has a resistance of 1.2Ω—a DC impedance 300 times more resistive than Li-ion cell resistance, but at a much lower voltage. To mimic the voltage of the Li-ion cell, a stack of five-or-more fuel cells are required. Unless the area of the fuel is increased commensurately, the five cell stack exhibits a resistance of 5 times 1.2Ω or 6Ω. A five cell stack is optimistic as its voltage will sag too low under low humidity conditions common at high altitudes, in arid climates, in winter seasons. For example, for a nominal voltage of 0.5V encountered over a range of humidity values, eight fuel cells must be connected in series to reliably produce a 3.7V-to-4.0V source, meaning the equivalent voltage stack of fuel cells has a nominal resistance of 9.6Ω, exhibiting a net resistance 2,400 times greater than a single Li-ion cell.

Ignoring polarization losses in the PEM layer, this large resistance ratio means the disclosed buffered fuel cell delivering current to a shorted load supplies 1000 A, of which only 17 0.4 A or 0.04% of the current comes from fuel cell 511. This means for all practical purposes high load currents are supplied entirely by the lithium ion cell. As depicted, afterwards in a low current steady state condition the Li-ion buffer supplies the load, Meanwhile the fuel cell gradually delivers charge into the buffer cell to recharge it at the maximum C-rate it is able.

FIG. 52B provides a more detailed description of the buffered fuel cell transient response illustrating voltage response during current buffering. fuel cell re-supply, and steady state operation as depicted by three different equivalent circuits 510u, 510v, and 510w respectively. During load current transient 516 the buffer voltage V_{BFC}(t) rapidly drops 519 from its steady state value 518 as the buffer cell 512 unloads its charge to supply the load 426 as shown in equivalent transient circuit 510u. During this rapid current spike resistance 514, the 4 mΩ resistance of the Li-ion buffer cell is the only thing limiting current other than the voltage across load 426. Because the fuel cell 511 contributes miniscule current compared to buffer cell 512, it is not shown in transient equivalent circuit 510u whereby momentarily I_{buf}≈I_{L}.

As the load transient demand 516 is satisfied and the load current I_{L}(t) diminishes to a lower value 517 the voltage across the buffer cell 512 hits a minimum value and then begins to recharge 520. This condition, shown by recovery equivalent circuit 510v comprises two half circuits. The first of these half circuits is the low current recharge loop comprising fuel cell stack 511, resistance 513 of the fuel cell stack with magnitude nR_{FC}=5(1.2Ω)=6Ω and the buffer cell 512. The second half circuit involves the load current loop comprising the buffer cell 512, the buffer resistance 514 having magnitude 4 mΩ and the load 426. As shown, the fuel cell delivers steady current to recharge the buffer while it continues to supply current to the load whereby I_{FC}=I_{buf}+I_{L}. Provided that the average current consumption of the load is sufficiently small compared to the fuel cell's ability to source current, i.e., I_{L}<I_{FC}, then a net charge flows into the buffer cell 512 and the voltage V_{BFC}(t) as shown gradually recovers increasing in voltage 520 until it fully charges the buffer cell stabilizing at its final value 521.

After the buffer becomes fully charged then I_{buf}=0 and the fuel cell voltage source 511 continues to power the load 426 directly whereby I_{FC}=I_{L} as shown in the steady state equivalent circuit 510w. In the steady state condition current is dominated by the load and the 6Ω series resistance of the fuel cell. The 4 mΩ buffer resistance can therefore be neglected and removed from the equivalent circuit. Although in this example I_{FC}>I_{L} and the battery recharges while the load is active, in a worse case scenario, the battery buffer cell 512 could become totally depleted by the load 426 causing the system to go into sleep mode where I_{L}=0, whereby the fuel cell recharges the depleted buffer cell after the system is off. The three operating stages (i) load transient, (ii) recharge, and (iii) steady state operation and their equivalent circuits illustrate the principal and operation of a self-recharging battery. While the current transient is managed entirely by the battery buffer cell, the recharge rate depends on the current sourcing capability of the stack of fuel cells, the capacity of the battery buffer cell, i.e., how many coulombs or Ah it can store, and the steady state current demand of the load. The size and current capability of the fuel cell therefore doesn't determine the transient load capability of the BFC, but the recharge time of the battery buffer once depleted.

A comparison of the voltage of a buffered fuel cell at various currents compared to conventional fuel cell is dramatically different. While the buffered fuel cell maintains nearly a constant voltage at any current, at least for some period of time, a fuel cell cannot. Instead the fuel cell voltage drops as a function of the current it delivers at a slope greater than can be explained by its internal resistance alone. This behavior can be explained is because a fuel cell exhibits significant polarization losses at higher current densities.

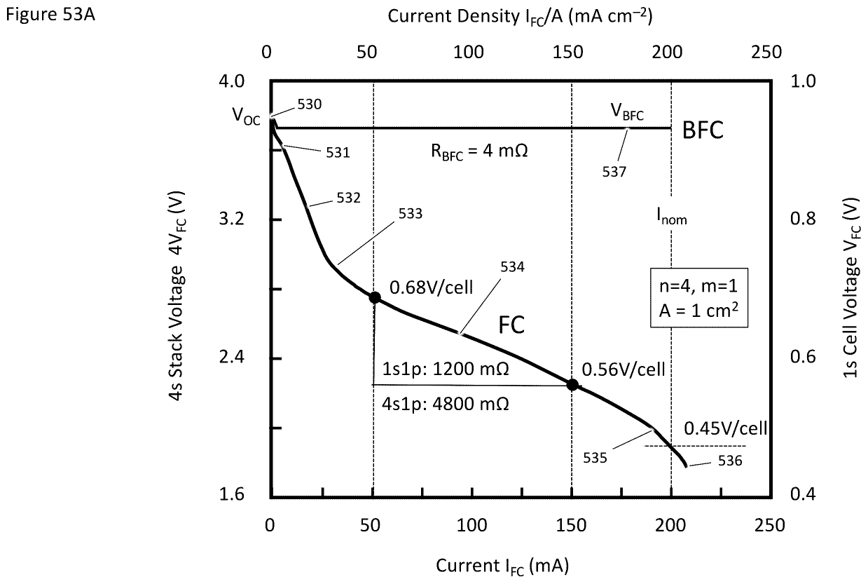

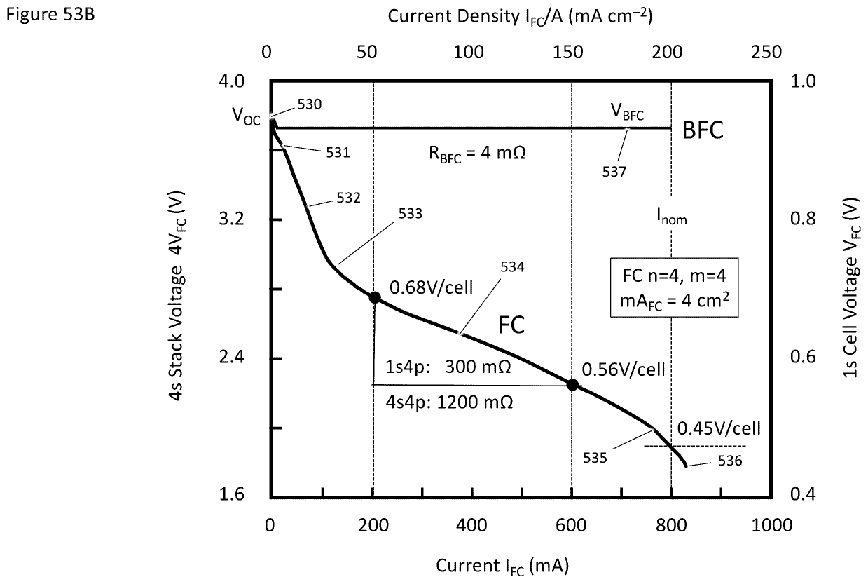

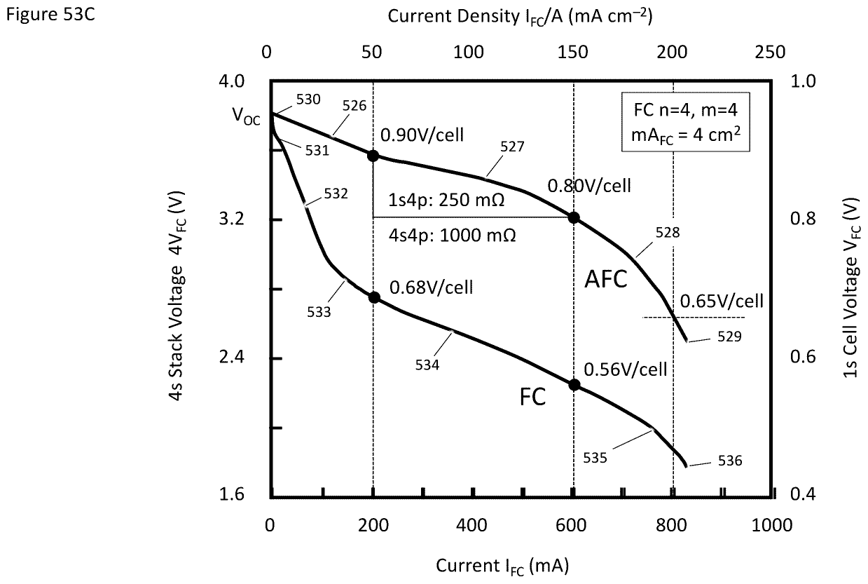

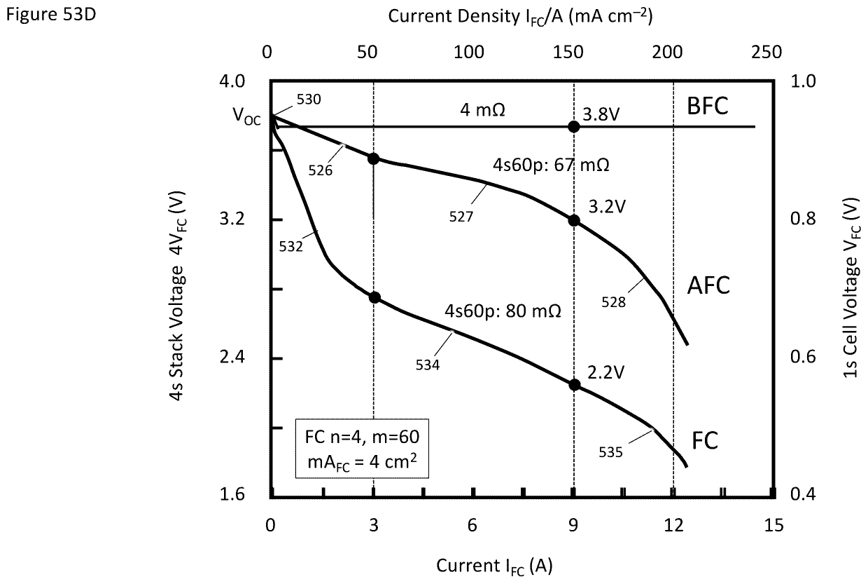

FIG. 53A illustrates the terminal voltage of a commercial PEM fuel cell with A=1 cm² as a function of current. The left side ordinate axis illustrates the voltage ⁴V_{FC} for a 4s stack of fuel cells while the right side ordinate illustrates the voltage of a single fuel cell V_{FC} used to form the stack. The lower x-axis illustrates current in milliamps and the upper x-axis is listed in current density measured in mA/cm². Because the fuel cell area is A_{FC}=1 cm², i.e., multiplicative factor m=1 then the numerical values for current I_{FC} in mA and current density I_{FC}/A in mA/cm² are identical. The graph shows two curves, the m=1 fuel cell curve comprising line segments 530-to-536 and buffered fuel cell curve 537. Although the fuel cell FC characteristic manifests a strong current dependence of voltage, the buffered fuel cell BFC exhibits a constant voltage over the entire current range. The voltage 537 of the buffered fuel cell V_{BFC} is only slightly less than that of the open circuit voltage 530 of the fuel cell V_{OC}.

Using the left side y-axis for a 4s stack, the fuel cell characteristic curve starts at an open circuit voltage 530 of V_{OC}=3.8V. The stack voltage drops immediately 531 with even small fuel cell currents. Rather than coming from the resistive drop across the PEM membrane, this rapid voltage decline continues with increasing current density occurs as the consequence of an offsetting polarization effect. The polarization effect is especially manifest in the first 25 mA (or 25 mA/cm²) of current conduction 532. Because of its small signal linearity, the drop from 3.8V to 2.9V at 25 mA can also be approximated as a polarization resistance R_{FCp}=900 mV/25 mA=36Ω, a very high resistance for a voltage source. Fortunately, above 25 mA/cm² the effective resistance improves substantially. The reduced voltage decline is illustrated by a slope change 533 between 25 mA and 50 mA (or as 25-to-50 mA/cm²) representing a transition from polarization dominated conduction to charge transport limited conduction.

Charge transport voltage losses occur because of a limited rate of gas able to cross the membrane pores. Sometimes referred to as diffusion resistance, this so called membrane resistance is not simply a function of the pore size of the PEM membrane, but also on gas transport through the gas diffusion layer. As shown, the voltage declines linearly from 0.68V per cell at 50 mA (50 mA/cm²) to 0.56V per cell at 150 mA (150 mA/cm²). This behavior can be modelled as a linear resistance of 1200 mΩ for a single n=1 fuel cell or 4800 mΩ for the 4 s stack. Above 150 mA, a change in the curvature of the current dependence 535 indicates added losses essentially functioning as added resistive loss mechanisms. At 200 mA (or 200 mA/cm²) and above, the voltage declines to 0.45V increasing the small signal resistance by 25% to 1500 mΩ over the 50 mA to 200 mA range.

That said, the losses are not purely ohmic as the I-V shape 535 is non-linear especially beyond 200 mA in region 536. The physical mechanism of loss in operating region 536 is likely water transport related, when water accumulates in the membrane inhibiting oxygen from reaching the membrane and impeding hydrogen ions able to cross the membrane into the cathode, a phenomena referred to as water logging. In the example fuel cell, the voltage becomes too low at currents greater than 200 mA to be useful. Although cells can be operated up to 600 mA (600 mA/cm²), the cell voltage drops below 0.4V requiring more series cells to be stacked to generate a useful voltage.

Five means to address the problem of fuel cell voltage droop and dropout at increased currents are disclosed herein, not including combinations thereof. These methods include the means to (i) make the fuel cell area much larger to lower its current density, (ii) improve the ion exchange membrane efficiency to reduce membrane resistance and polarization effects, (iii) implement the buffered fuel cell as described herein, (iv) compensate for environmental condition impacting fuel cell voltage stability, and/or (v) implement a dynamically adjusted fuel cell array. These methods are not mutually exclusive and may be used in various combinations.

Regarding the first solution, making a bigger fuel cell, increasing the PEM surface area reduces the fuel cell resistance but doesn't change the shape of the fuel cell's current density versus voltage curve. For example, increasing m=1 to m=4 means the active fuel cell area increases from 1 cm² to 4 cm². This solution is illustrated in the graph of FIG. 53B. As represented, the current on the lower x-axis is quadrupled from that of the m=1 cell. The resistance similarly decreases by a factor of four, from 1200 mΩ to 300 mΩ for each 1s fuel cell, and from 4800 mΩ to 1200 mΩ for the 4s stack. The characteristic shape of fuel cell voltage against current density remains unchanged.

Aside from the forgoing, other methods to improve fuel cell function involves reengineering the fuel cell PEM membrane construction and gas diffusion layers to improve gas transport, lower resistance, and reduce polarization. An exemplary I-V characteristic for the advanced fuel cell of A_{FC} is shown in FIG. 53C by the curve comprising line segments 526, 527, 528, and 529. Compared to the conventional FC fuel cell, the A_{FC} maintains a higher cell voltage over the entire current range, especially at current densities less than 200 mA/cm². As shown in the engineering prototype data the fuel cell voltage at 50 mA/cm² increases from 0.68V to 0.90 volts, a 120 mV or 32% improvement. At 150 mA/cm² current densities, the observed improvement from 9.56V to 0.80V represents a 240 mV increase for a 43% improvement.

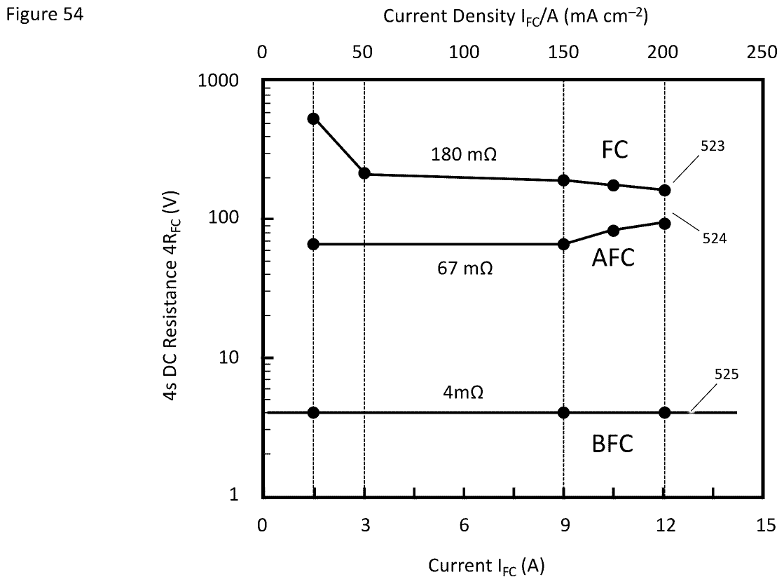

FIG. 53D provides a direct comparison of a conventional FC fuel cell, an A_{FC} advanced fuel cell, and the BFC buffered fuel cell scaled in area to m=60, a 4s60p cell capable of 10A operation. As shown at 9A load current, while the conventional fuel cell with only 2.2V is almost unusable, at 3.2V the advanced fuel cell still is able to maintain a voltage comparable to the low ed of a lithium ion battery's voltage. Although the small signal resistances, the partial derivative ∂V/∂V=67 mΩ, is shown the be only slightly better for the A_{FC} than the 80 mΩ conventional fuel cell, the real disadvantage of the conventional FC is more substantial because of the initial voltage loss in region 532. Using the large signal resistance R=(V_{OC}−V)/I_{FC}, FIG. 54 reveals the conventional fuel cell exhibits a DC equivalent resistance of 180 mΩ, nearly triple that of the A_{FC}.

The third improvement articulated above, the buffered fuel cell, outperforms both of its competitors. At 3.8V nearly independent of current, the buffered fuel cell behaves as a low impedance stiff voltage source. The fuel cell in the buffer fuel cell design may comprise either the FC or A_{FC}. The A_{FC} version is preferable however as it recharges a depleted buffer cell faster and to a higher battery voltage.

The fourth option to improve fuel cell performance, reducing the impact of environmental conditions using intelligent control functions includes humidity control, temperature regulation, protection features and more. Although intelligent environmental control disclosed herein can theoretically be used for any fuel cell technology, its application in buffered fuel cells is especially advantageous as the added functionality can better match the fuel cell's current delivery ability to the optimum buffer charging conditions. Matching fuel cell capability to the buffer requires intelligent functions during charge transfer either by controlling current delivered by the fuel cell, limiting the charging current of the buffer cell, limiting the buffer cell voltage, or redistributing charge among multiple buffer cells connected in series. These advanced functions distinguished the basic buffered fuel cell or BFC as disclosed from its more intelligent counterpart, the intelligent buffered fuel cell or iBFC.

Referring again to FIG. 44, intelligent charge management functions in an iBFC are performed by the QXR charge transfer regulator within the fuel cell array 419; by the fuel cell control module 420c using dynamically charging topologies in the fuel cell array, i.e., changing the number of series connected fuel cells; by conserving the fuel supply by cutting off hydrogen to unused cells, and by controlling temperature and humidity within the fuel cell using the humidity control module 420f and temperature control module 420d.

As such the buffered fuel cell function like a self-charging battery exhibiting the electrical characteristics of a lithium ion battery but offering the benefit of unlimited self recharging provided hydrogen fuel is available or replenished. The mechanisms used to improve the performance of the iBFC far beyond that of a conventional fuel cell are relatively insensitive to the electrical performance of the fuel cell. Referring again to FIG. 53D and FIG. 54, a comparison of the BFC voltage versus the conventional fuel cell illustrates that no matter what the resistance of the fuel cell array or technology, the BFC aggregate resistance is no higher than the battery buffer resistance and essentially constant over a range of load currents.

Buffered Fuel Cell Topologies. Buffered fuel cell (BFC) topologies refers to the topological electrical network of fuel cells in a series-parallel array of cells. The topology of an array of fuel cells determines a number of key electrical parameters of the resulting buffered fuel cell including
The minimum voltage V_{FC(min)} of the stack of n fuel cells operating over a specified range of currents and environmental conditions including humidity and temperature.
The maximum voltage V_{FC(max)} of the stack of n fuel cells operating over a specified range of currents and environmental conditions including humidity and temperature.
The terminal voltage of the BFC as a function of current and environmental conditions including humidity and temperature.
The resistance of the BFC as a function of current and environmental conditions including humidity and temperature for a parallel network of m stacks of fuel cells.
The requisite electrical specifications of the QXR charge transfer regulator necessary to optimize charging of the BFC Li-ion buffer cell.

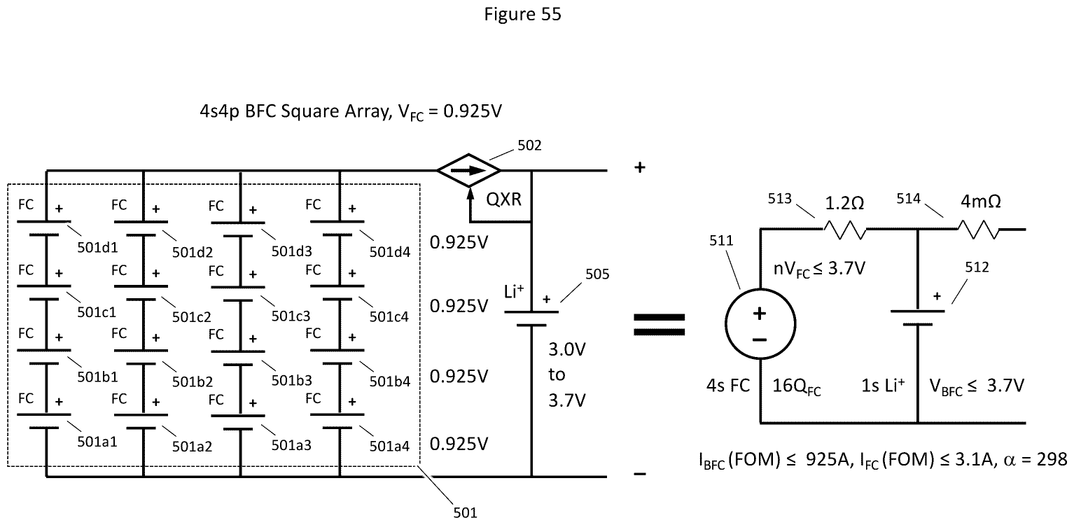

Although the precise voltages and currents of the fuel cell array depend on the specific electrochemical properties of the fuel cell and its PEM under specific environmental conditions, the array design can be optimized to reduce sensitivity to variability in fuel cell characteristics, to improve overall fuel efficiency, and to protect the buffer cell from excessive voltages and charging currents. FIG. 55 to FIG. 67 illustrate various topologies of fuel cell arrays, each array with its own unique voltage-current-resistance (VCR) characteristics.

Among these FIG. 55 illustrates the schematic and equivalent circuit of a BFC buffered fuel cell comprising an exemplary 4s4p square array of hydrogen fuel cells at 0.925V per cell and a 3.7V Li-ion cell as buffer. In a square array the number of series connected cells n in a stack equal the number of parallel stacks m. Specifically the FC array 501 contains 16 fuel cells or fuel cell elements comprising four parallel stacks—stacks 1, 2, 3, and 4. Stack 1 comprises the series string of FCs 501a1, 501b1, 501c1, and 501d1; stack 2 comprises the series string of FCs 501a2, 501b2, 501c2, and 501d2; stack 3 comprises the series string of FCs 501a3, 501b3, 501c3, and 501d3; and stack 4 comprises the series string of FCs 501a4, 501b4, 501c4, and 501d4. The array 501 feeds buffer cell 505 through QXR charge transfer regulator 502. In a square array as described where n=m, the net resistance of the fuel cell array with resistance R_{FCa}, given by

R_{FCa}=(n/m)R_{FC}=R_{FC}

is identical to the resistance of a single fuel cell R_{FC}, e.g., 1.2Ω. The equivalent circuit comprises 4s fuel cell 511, FC series resistance 513 of 1.2Ω, buffer cell 512 and buffer series resistance 514 of 4 mΩ. Given V_{FC}=0.925V is at the high end of the range, a stack of four cells is at best, able to charge buffer 512 to a maximum voltage R_{FCa}≤3.7V.

As such short circuit current figure-of-merit I_{FC} (FOM)≤3.1 A=3.7V/1.2Ω. This current is referred to as a FOM because it is hypothetical describing the scenario of an unbuffered fuel cell directly driving a shorted load. As such, the current is only relevant when compared to the same FOM for the buffered fuel cell, in this case I_{BFC} (FOM)≤925 A=3.7V/4 mΩ. The current ratio α=925 A/3.1 A=298 means the buffered fuel cell is capable outperforming the conventional fuel cell by nearly 300× in delivering energy to a load, a metric analogous to the rated horsepower of engine, a condition that never actually occurs.

The stored charge value 16Q shown for fuel cell 511 is more complicated than the charge stored in a battery. Battery charge is determined the total charge stored in the cell during the process of charging, where Q=I_{chg}·t. The charge in a fuel cell is the amount of charge contained in the fuel feeding the cell. If each cell has its own dedicated fuel supply, the total charge 16Q_{FC} is equal to 16 times the fuel in each dedicated canister Q_{can}, i.e., 16Q_{FC}=16Qcan. If however the charge in the gas canister is shared among all active fuel cells, then 16Q_{FC}=Q_{can} or Q_{FC}=Q_{can}/16.

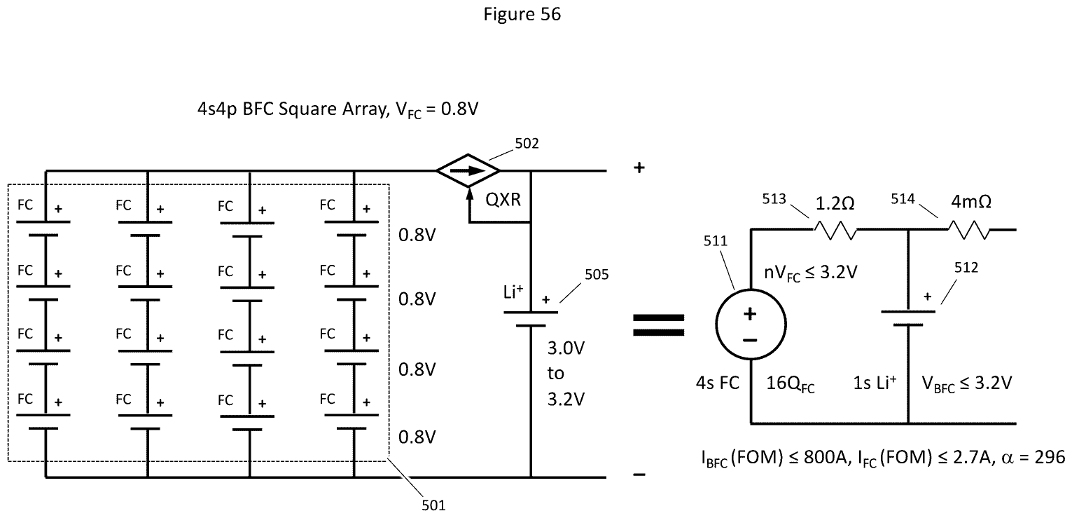

The FOM is also useful when comparing the effect of cell voltage on a fuel cell's current capability. For example, as shown in FIG. 56, the same 4×4 array operating at a lower electrochemical potential V_{FC}=0.8V results in nV_{FC}=3.2V for a figure-of-merit of I_{FC} (FOM) 2.7 A. Compared to the 0.925V condition, the current ratio β=2.7 A/3.1 A=87% meaning the lower cell voltage decreases current sourcing capability of the fuel cell array by 23%. While 3.2V is well within the normal voltage range of buffer 512 when using lithium ion chemistry, it does utilize a significant fraction of the buffer's capacity or state-of-charge.

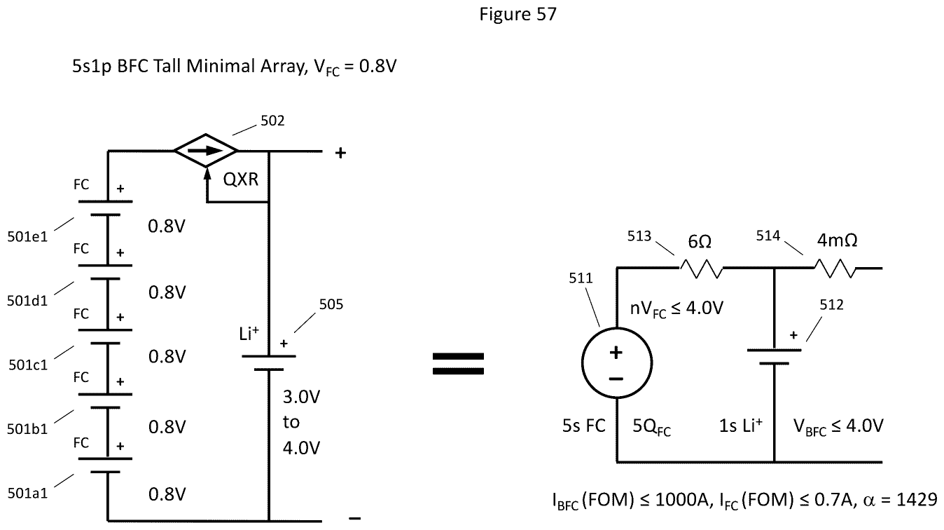

A tall array is a fuel cell array where n>>m, i.e., where the number of cells connected in series is substantially greater than the number of parallel strings. As such FIG. 57 illustrates the schematic and equivalent circuit of a BFC buffered fuel cell comprising an exemplary 5s1p tall array of hydrogen fuel cells 501a1, 501b1, 501c1, 501d1, and 501e1, each at 0.8V per cell. Fuel cell array 501 feeds buffer 505 through charge transfer register 502, charging the buffer at a voltage of 4.0V a voltage compatible with Li-ion safe operating areas. The 5s1p tall array, however increases the unit cell resistance by n whereby R_{FCa}=nR_{FC}=5(1.20)=60 but correspondingly increases the stack voltage to 4V thereby reducing the figure-of-merit of I_{FC} (FOM)≤0.7 A=4V/6Ω.

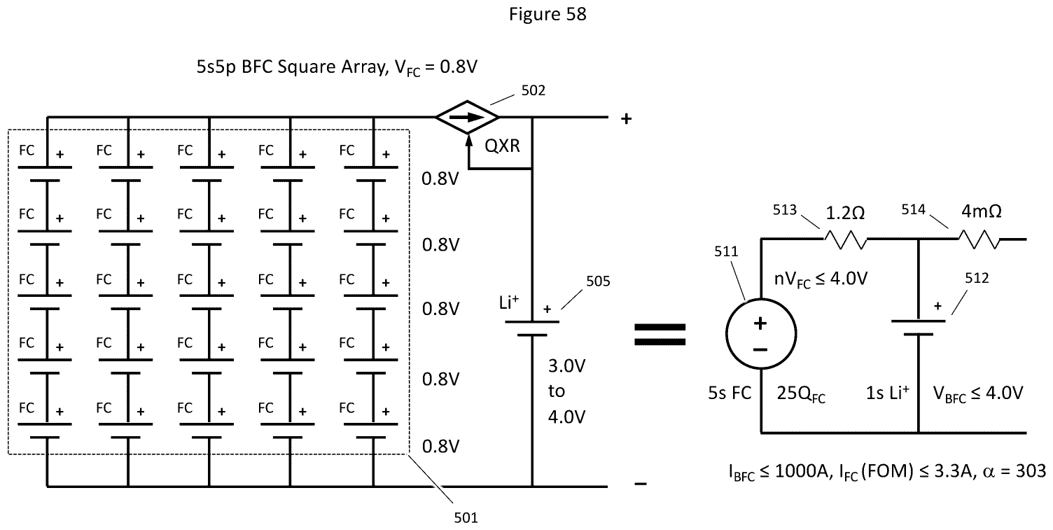

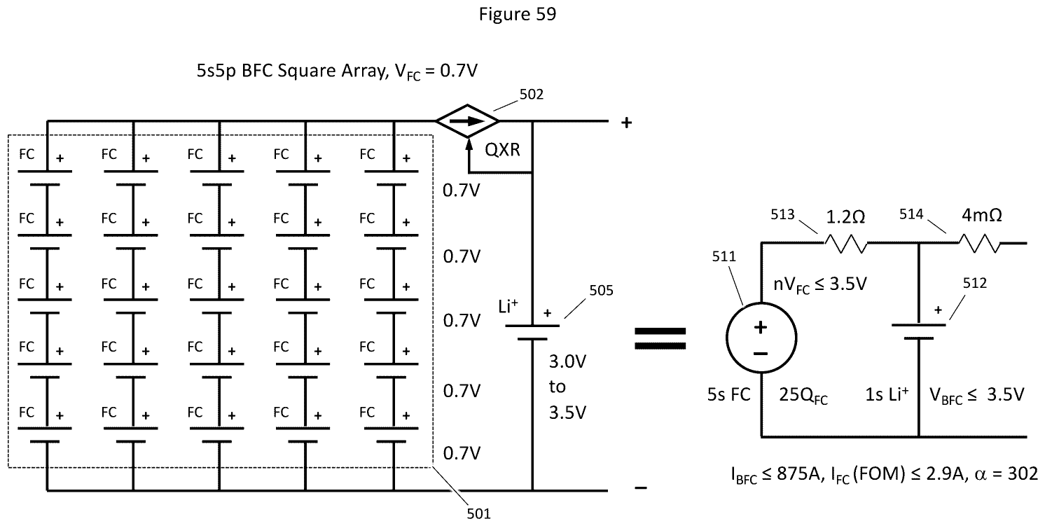

FIG. 58 illustrates a square 5s5p matrix 501. Compared to the aforementioned 5s1p tall array, the square array reduces resistance to R_{FCa}=R_{FC}=1.20 at V_{FC}=0.8V, thereby increasing the FOM current to I_{FC}(FOM)≤3.3A where ⁴V_{FC}≤4V. Likewise the I_{BFC}≤4V/4 mΩ=1000 A. The ratio of a=I_{BFC}/I_{FC}(FOM)=1000 A/3.3 A=303 means the buffer can deliver up to 303 times the current of the fuel cell during peak demand. Decreasing the cell potential to V_{FC}=0.7V, the square 5s5p matrix 501 of FIG. 59 lowers the stack voltage to nV_{FC}=3.5V respectively decreasing I_{FC}(FOM)≤2.9 A. The risk of low stack voltages, e.g., during low humidity conditions, renders the n=5 array topologies overly dependent on the fuel cell electrical characteristics.

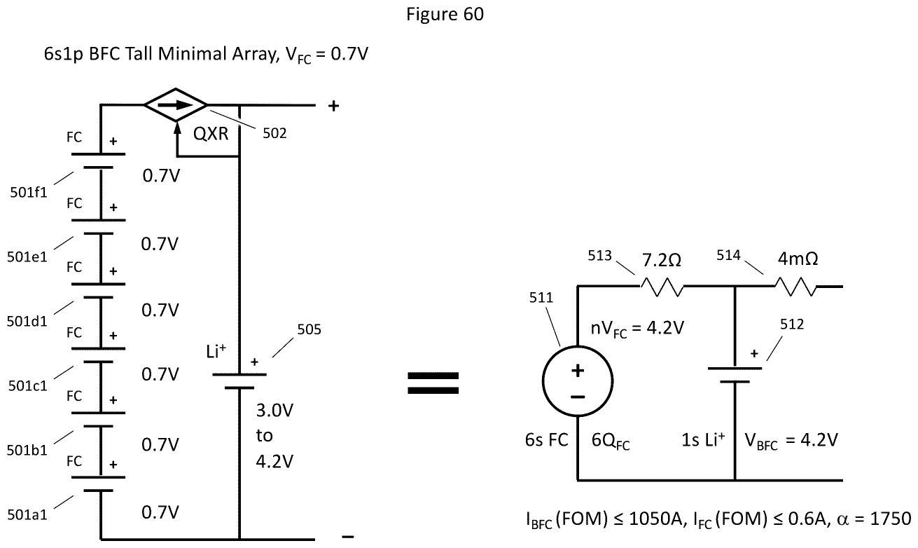

Increasing the series cell stack to n=6 means the series voltage is able to reach 4.2V, the maximum voltage of the Li-ion buffer cell, whenever V_{FC}=0.7V. As an example, FIG. 60 illustrates the schematic and equivalent circuit of a 6s1p tall array version of a BFC buffered fuel cell where the n=6 series combination of fuel cells 501a1 to 501f1 supply buffer 505 through QXR charge transfer regulator 502. As shown the equivalent circuit comprises 6s fuel cell 511 with series resistance 513 of 7.20 resulting in a low fuel cell figure-of-merit of I_{FC} (FOM) 4.2V/7.2Ω=0.5 A. Ironically despite its dreadfully poor I_{FC}(FOM), the buffered fuel cell exhibits an extremely high overall performance of I_{BFC} (FOM)≤1050 A=4.2V/4 mΩ. The combined impact of the higher voltage stack of the buffer offset by a higher series resistance of the fuel means the benefit a of buffering a=I_{BFC}/I_{FC}(FOM)=1050 A/0.6 A=303 is over three hundred times greater than the fuel cell alone. A high value of a also means the recharge time of a depleted buffer will be longer.

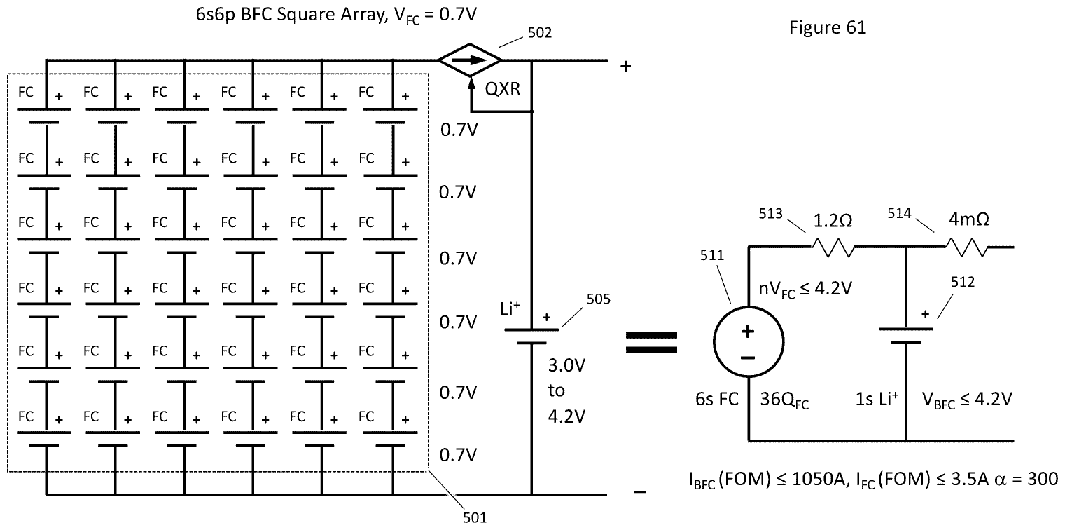

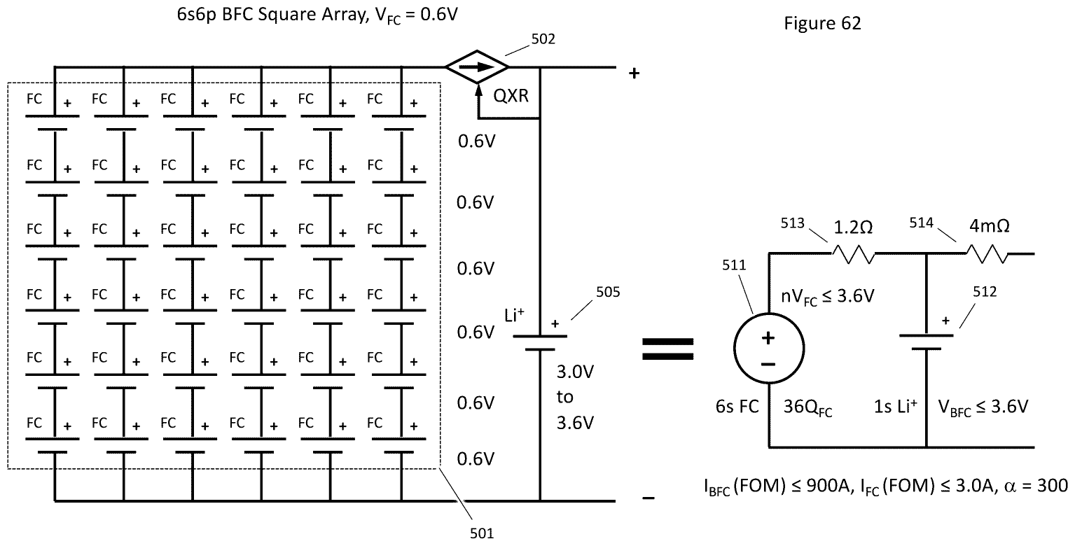

The FIG. 61 illustrates the benefit of converting a 6s tall array into a 6s6p square array. Using the square fuel cell array 501, fuel cell array resistance 513 drops from of 7.2Ω and 1.2Ω. As a results the current figure-of-merit I_{FC} (FOM) when V_{FC}=0.7V improves from 0.6 A for the 6s1p tall array to I_{FC}(FOM)≤4.2V/1.2Ω=3.5 A for the square array. The current ratio α=I_{BFC}(FOM)/I_{FC} (FOM) for the tall array topology is 1750 compared to 300 for the square array meaning the square array relies less on the buffer cell to deliver current. Unfortunately, when V_{FC}=0.6V, any 6s design like that shown in FIG. 62 only charges the buffer to 3.6V, significantly limiting the stored energy in the buffer of the BFC.

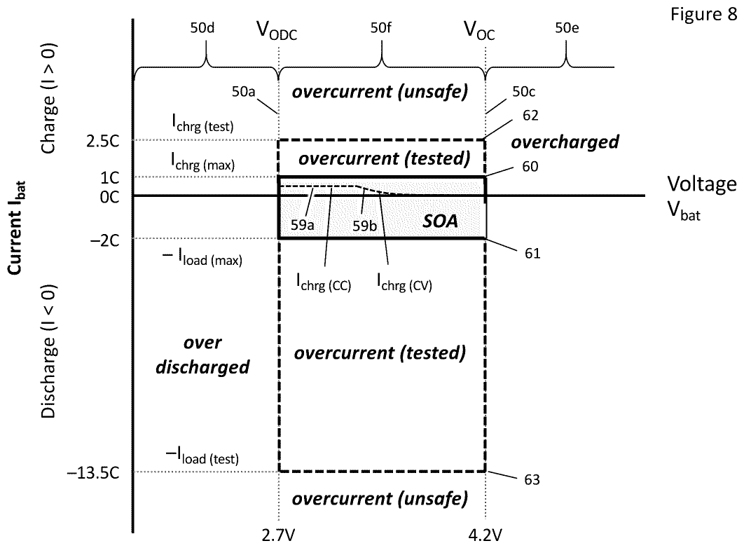

A more robust topology involves a n=7 fuel cell stack, where for cell voltages of 0.6V or higher the array has a voltage 511 of magnitude nV_{FC}≥4.2V. The advantage of this design is that the fuel cell voltages needn't be too high to produce a voltage greater than a fully charged lithium ion battery, thereby making the lithium ion battery a viable chemistry for realizing the buffer. Because the fuel cell stack is capable of exceeding the maximum safe voltage for a full-charged Li-ion cell, a protection function is required to connect the fuel cell array 501 to the buffer 505, especially preventing an voltage exceeding the V_{OC}, the overcharge voltage 50c shown in the SOA safe operating area graph shown previously in FIG. 8.

Importantly, a fuel cell array where n=7 cannot safely be connected directly to a Li-ion cell implementation of buffer 505. As shown, the protection function is performed by interposing QXR charge transfer regulator 502 between fuel cell array 501 and buffer 505. Other methods able to protect buffer 505 from overvoltage may include voltage regulators, Zener voltage clamps, shunt voltage regulators, or cell charge balancing circuits described elsewhere in this application.

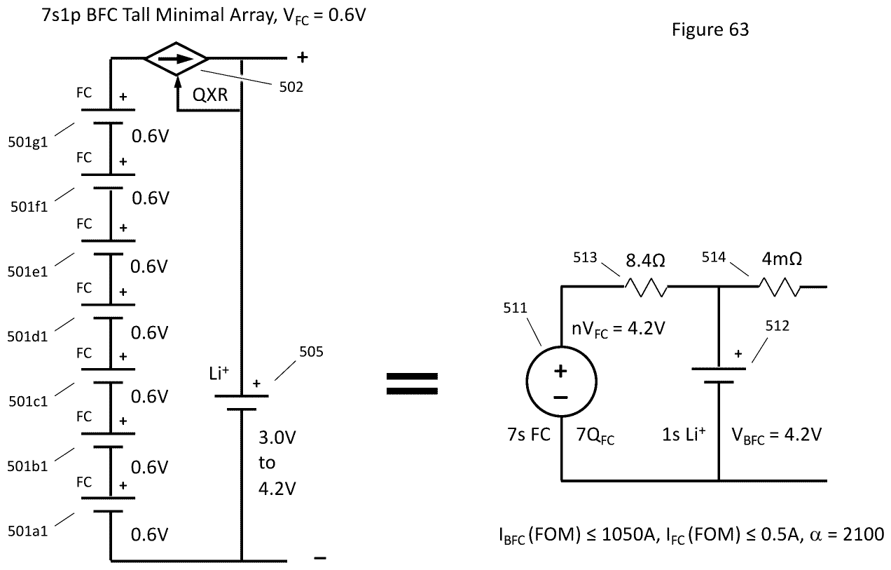

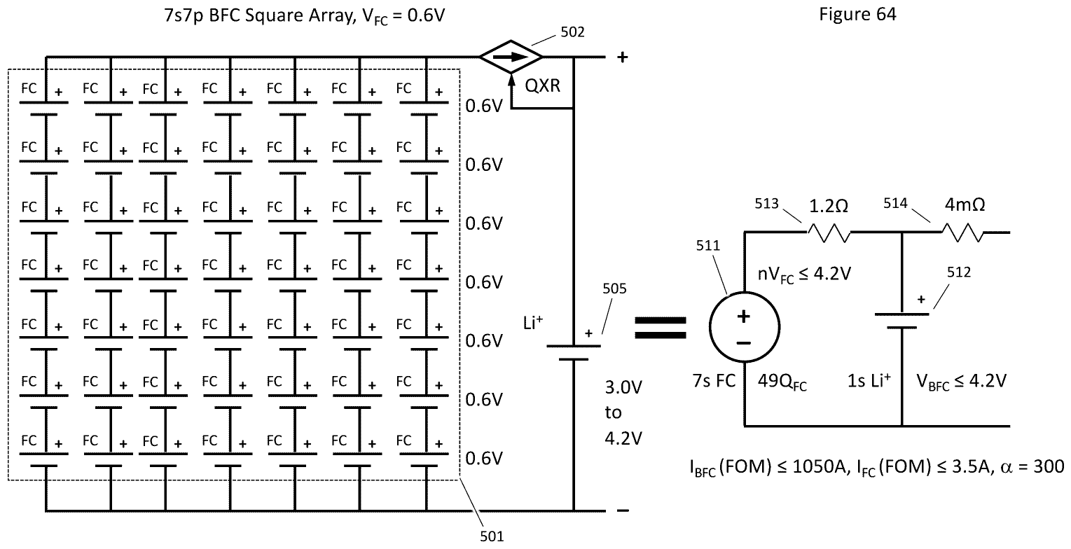

As shown in FIG. 63 and FIG. 64 for a 7s1p tall array and a 7s7p square array, the equivalent fuel cell resistances 513 are 8.40 and 1.20 corresponding to I_{FC} (FOM) values of 0.5 A and 3.5 A respectively. At a 4.2V stack voltage both designs exhibit a figure of merit of I_{BFC} (FOM)≤1050 A=4.2V/4 mΩ. The buffer's improvement α=I_{BFC}(FOM)/I_{FC}(FOM) for the tall n=7 buffered fuel cell array is 2100 while its square array counterpart is only 300.

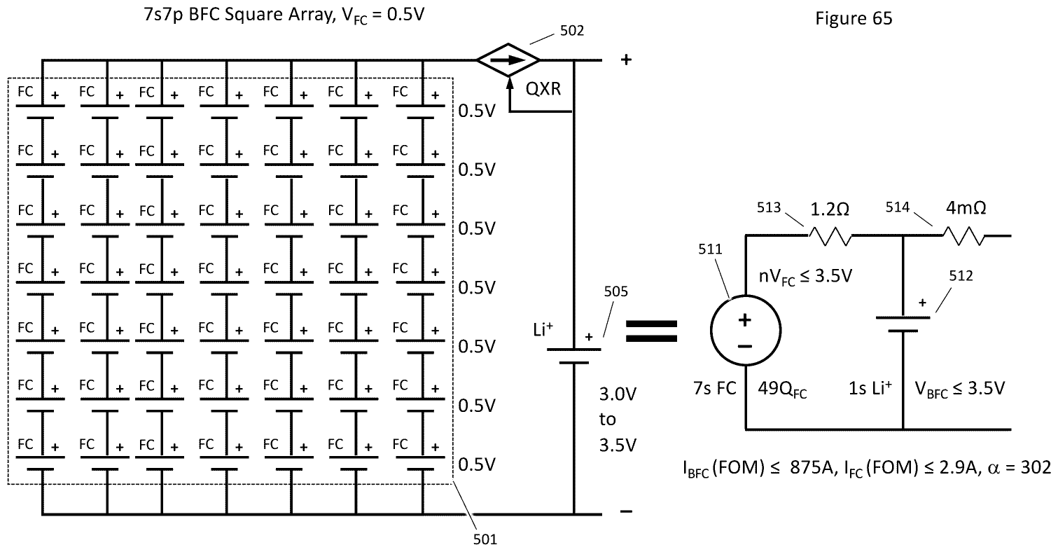

Safety functions aside, the primary benefit of increasing the number of series connected cells in a stack to n≥7 is the fuel cell's ability to source power at voltages even when the individual fuel cells suffer a low cell voltage. The primary cause of a hydrogen fuel cell exhibiting a low fuel cell voltage V_{FC} is due to operation under low humidity conditions. The lower the RH relative humidity, the lower the voltage V_{FC} of every fuel cell in the array. By creating an array of more series connected fuel cells, the stack is able to output a usable voltage at lower fuel cell voltages and therefore able to operate over a wider range of humidity values. For example, if a n=6 fuel cell stack can only maintain V_{BFC}≥3.8V down to RH=45%, while a n=7 fuel cell stack of identical fuel cell construction can deliver the same voltage down to RH=35%, thereby making the fuel cell usable over a wider range of ambient conditions. For example, at V_{FC}=0.5V shown in FIG. 65, a 7s7p fuel cell array is still useful having a stack voltage of nV_{FC}≤3.5V. Although they lose roughly half the buffer's energy storage capacity compared to charging to 4.2V, the buffered fuel cell is still able to function and deliver power.

Further increases in the value of n above seven have three effects (i) it increases the lowest cell voltage and corresponding relative humidity able to adequately charge the buffer cell, (ii) it increases the peak output voltage nV_{FC} and current I_{FC} from the fuel cell under high humidity conditions thereby further necessitating protection functions against excessive voltages and current, and (iii) properly implemented for safety, higher currents can be used to accelerate charging of a depleted buffer cell. The third item is discussed later in this application.

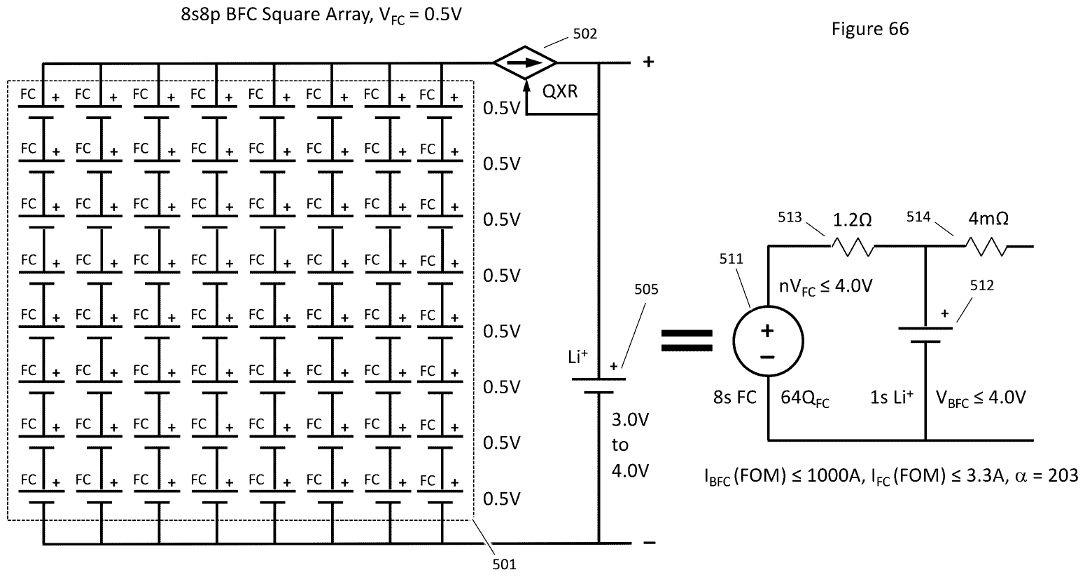

Consider operation of higher count buffered fuel cells where n≥8. FIG. 66 for example illustrates the schematic and equivalent circuit of a BFC buffered fuel cell comprising a 8s8p square array of hydrogen fuel cells operating in a low humidity ambient with 0.5V per cell charging a Li-ion cell as buffer. As described at V_{FC}=0.5V an 8s8p fuel cell array 501 can be represented by an equivalent schematic comprising a nV_{FC}=4.0V fuel cell voltage 511, a 1.2Ω fuel cell resistance 513, a buffer 512 charged to 4.0V, and a 4 mΩ buffer resistance 514. The corresponding performance metrics include fuel cell figure-of-merit I_{FC} (FOM)≤3.3 A, a buffered fuel cell figure-of-merit I_{BFC}(FOM)<1000 A, and a corresponding BFC beneficial ratio of a=I_{BFC}(FOM)/I_{FC}(FOM)=203. Importantly, for any fuel cell with V_{FC}>0.53 any 8s design will fully charge a Li-ion buffer and without regulation or protection will easily exceed cell's 4.2V limit. If we consider the low end of the BFC's usable operating range to be 3.6V, then the n=8 array can function down to V_{FC}=3.6V/8=0.45V, substantially expanding the relative humidity operating range.

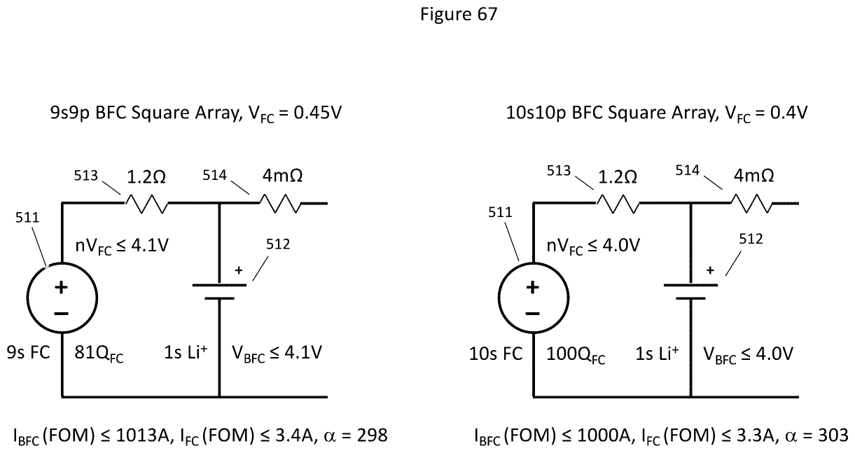

Similarly FIG. 67 equivalent circuits of BFC buffered fuel cells comprising exemplary 9s9p and 10s10p square arrays of hydrogen fuel cells able to deliver over 4.0V at cell voltages as low as 0.45V and 0.40V respectively without impacting the buffered fuel cell's ability to deliver high load currents at a BFC figure-of-merit I_{BFC}(FOM) 1000A when fully charged. To prevent buffer overcharging, the QXR must limit, regulate or clamp the buffer charging voltage to 4.2V whenever nV_{FC}>4.2V. In a n=9 array this occurs whenever V_{FC}>0.47V. In a n=10 array this occurs whenever V_{FC}>0.42V. Because of the larger number of cells, the fuel cell stack is able to operate at lower cell voltages ensuring reliable operation at lower humidity levels without sacrificing functionality. If we consider the low end of the BFC's usable operating range to be 3.6V, then a n=9 array can function down to V_{FC}=3.6V/9=0.40V while a n=10 array can function down to V_{FC}=3.6V/10=0.36V.

In conclusion, given the fact that the number of fuel cells in a string n must be the same for every parallel string, then only three topologies are possible in the buffered fuel cell, namely
Tall arrays where n>m, where by increasing the voltage to nV_{FC}, the array's resistance necessarily increases to a value higher than the resistance of a single fuel cell, i.e., whereby (n/m)R_{FC}>RFC.
Square arrays where n=m, where by increasing the voltage to nV_{FC}, the array's resistance remains equal to the resistance of a single fuel cell, i.e., whereby (n/m)R_{FC}=R_{FC}.
Wide arrays where m>n, where by increasing the voltage to nV_{FC}, the array's resistance increase is compensated by an even greater increase in fuel cell area m thereby resulting in a value higher than the resistance of a single fuel cell, i.e., (n/m)R_{FC}<R_{FC}.

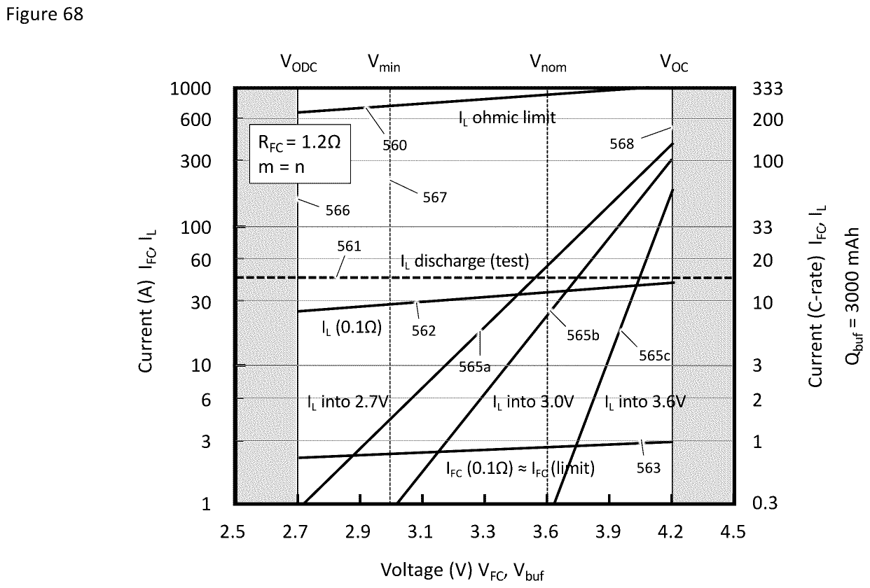

Fuel Cell Array CVR Characteristics. As demonstrated by the exemplary fuel cell arrays described previously, the current-voltage-resistance (CVR) characteristic of a fuel cell array is determined by the technology of the individual cells and the electrical network topology of the array. The current-voltage relationship of the array is displayed graphically in FIG. 68 as a graph of current of buffered fuel cell load current I_{L} in amperes (left-side axis) and C-rate (right-side axis) as a function of the buffer voltage for various electrical loads including ohmic load current limit 560, discharge test current 561, 0.1Ω ohmic load 562, and charging currents for batteries at 2.7V, 3.0V and 3.6V represented by lines 565a, 565b, and 565c respectively. The limited current of an unbuffered fuel cell I_{FC} powering ohmic loads 563 is included as a reference.

Over the operating voltage range of a lithium ion cell between 2.7V and 4.2V bounded by the V_{ODC} over-discharge voltage 566 and the V_{OC} overcharge voltage 568, the discharge current capability I_{L} of the buffered fuel cell driving a short 560 exceeds a current of 600 A, i.e., 200C for a 3 Ah buffer. This shorted load condition conducts currents well beyond the safety testing limit 561 of commercial Li-ion cells at currents of 15C. In real world applications, DC currents are far lower. Specifically, current delivered into a resistive load from a BFC is given by

$${I}_{L} \leq \frac{{v}_{b u f}}{( {R}_{b u f} + {R}_{L} )} = \frac{{v}_{b u f}}{( 4 m Ω + {V}_{b u f} )} \approx \frac{{V}_{b u f}}{{R}_{L}} ≪ \frac{{V}_{b u f}}{{R}_{b u f}}$$

for values of R_{L}>>R_{buf} and for voltages within the safe range 2.7V V_{b} f 4.2V where the buffer is realized using a single lithium ion battery. Assuming an ohmic load where R_{L}=0.1Ω then as shown by curve 562 the current range drops to 40.4 A-to-26.0 A, or in C-rate as 13.5C-to-8.7C. By contrast, the current capability of an unbuffered square fuel cell array given by

$${I}_{F C} \leq \frac{n {V}_{F C}}{( {R}_{F C} + {R}_{L} )} = \frac{n {V}_{F C}}{( 1.2 Ω + {V}_{b u f} )} \approx \frac{n {V}_{F C}}{{R}_{F C}}$$

where m=n, R_{FC}=1.2Ω, and nV_{FC}≈V_{buf}. Because R_{FC}>>R_{L}, the maximum current delivered into a 0.1Ω load 563 is essentially the same as the short circuit current capability of the fuel cell. In other words, the peak DC current delivered by the disclosed buffered fuel 560 is limited by the load resistance while the peak current of the unbuffered fuel cell driving a high current load is limited by its own internal resistance 563. The current ratio is over 300×, i.e., over two-orders-of magnitude apart.

If the BFC is used to power a load that requires some minimum voltage Vₘᵢₙ to conduct current, then the current equation for the buffered fuel cell is modified into the expression

$${I}_{L} \leq \frac{( {V}_{buf} - {V}_{min} )}{( {R}_{buf} + {R}_{L} )} = \frac{( {V}_{buf} - {V}_{min} )}{( 4 m Ω + {V}_{buf} )} \approx \frac{( {V}_{buf} - {V}_{min} )}{{R}_{L}} ≪ \frac{{V}_{buf}}{{R}_{buf}}$$

A typical example of a load requiring a minimum voltage to conduct current is the input to a battery charger or UPS circuit. Until the BFC voltage exceeds the voltage of the battery being charged no current will flow from the BFC into the battery acting as an electrical load. As shown in the graph, the curves labelled I_{L} into 2.7V, I_{L} into 3.0V, and I_{L} into 3.6V represented by lines 565a, 565b, and 565c respectively clearly illustrates the challenge of using the BFC to power a battery pack only works when V_{buf} >Vₘᵢₙ and delivers no current when the buffer and the battery pack are equal in voltage.

The term Vₘᵢₙ 567 is somewhat arbitrary as it means the lowest output voltage the buffer fuel cell is allowed to operate by the system specifier or product designer. For example, a reasonable value for Vₘᵢₙ using lithium ion cell chemistry is 3.0V. Operating at voltage below Vₘᵢₙ constitute operating in deep discharge likely causing irreparable damage to the battery and internally to its electrochemical separator. Since many electrical loads operate at 3V, a minimum value of Vₘᵢₙ=3V is useless as a voltage source cannot deliver power to a load at the same voltage without conducting through zero resistance. A more pragmatic approach is to target applications of the buffered fuel cell to a Vₙₒₘ nominal voltage such as 3.6V but still allow the BFC discharge to Vₘᵢₙ during use. Another strategy is to not allow a load to commence drawing energy from the BFC when the V_{BFC}<Vₙₒₘ but allow it to discharge below V_{BFC} provided discharge first commenced when a V_{BFC}<Vₙₒₘ.

Although the use of buffered fuel cells in applications involving superconductors allow the minimum voltage differential between the load voltage and BFC voltage to be reduced, the internal resistance of the buffer and the load will still limit the current unless they too comprise superconductors. Today superconductors are relegated to large systems requiring cryogenic cooling. In the event that room temperature superconductors become available, motors, generators, and even lithium ion batteries used in the BFC's buffer can be converted to the new materials. For example, with superconductors the load resistance becomes zero R_{L}=0 and the buffer's internal resistance R_{buf}=0 dramatically improving the load transient capability of the buffered fuel cell. Unfortunately, the internal electrical resistance of a fuel cell, i.e., its membrane or diffusion resistance, is electrochemical in nature, not ohmic and will not benefit from material advancements in superconductors.

In practice then a BFC should protect itself by cutting off connections to a load whenever V_{buf} falls below V_{ODC}, the over-discharge voltage of the buffer cell's electrochemistry. Voltage below V_{ODC}, should be automatically disconnected as should polarity reversals—cases where the load voltage has an intrinsic voltage or energy source higher in voltage than the buffer fuel cell, i.e., V_{L} >V_{BFC}. Such instances can occur during regenerative energy such as regenerative braking, from inductive spikes, system noise, or a load containing its own power source such as it own battery pack or generator. If fact, without polarity protection the electrical load comprising a battery could act as a power source charging the buffer cell with current flowing in the reverse direction, i.e., from the load into the buffered fuel cell. Reverse current flow is a buffered fuel cell is not a safe circumstance as it may cause uncontrolled and potentially dangerous overcurrent or overvoltage conditions to occur in the buffer cell. In fact except for exotic, experimental, and invariably inefficient fuel cells capable of reverse operation and electrolysis, conventional fuel cells are not designed to absorb energy, only deliver it. In order to avoid these problems, in one embodiment of the invention the buffered fuel cell comprises two electrical ports—one for outputting power to a load, and a separate port for absorbing power from a power source. Applications of two-port power operations follow later in this application.

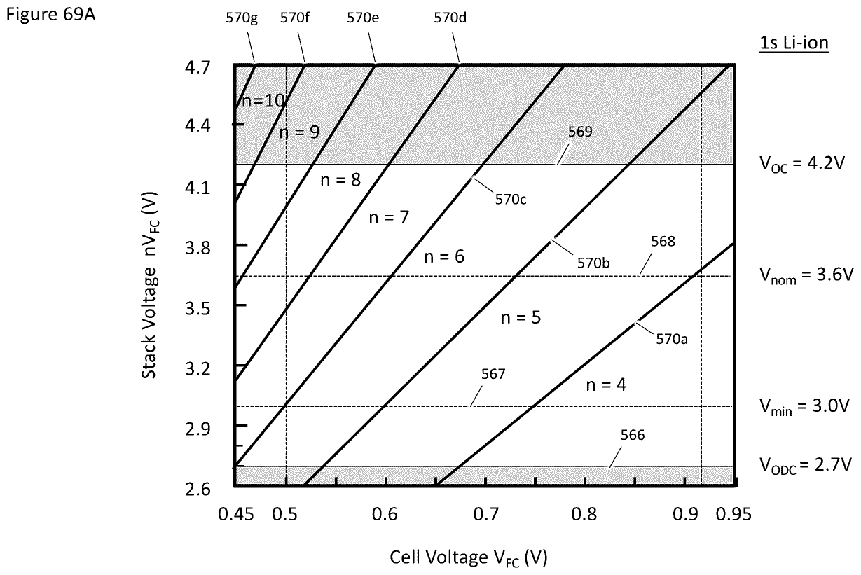

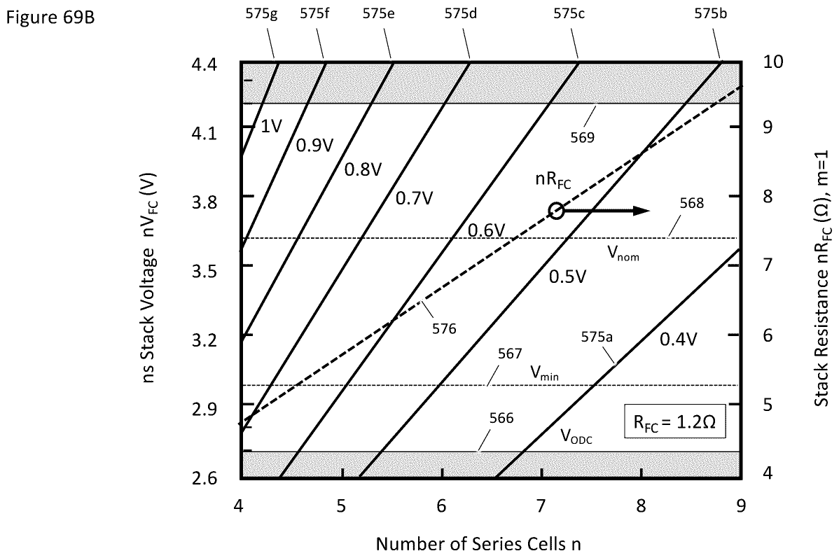

As exemplified in the previous illustrations describing various fuel cell array topologies, a key consideration in the design of buffered fuel cell as disclosed herein is the relative voltage ratio of the fuel cell stack voltage to the buffer cell voltage. Logically for any FC stack, the fuel cell array voltage must exceed the buffer cell voltage to charge it. While this concept is simple to express mathematically as nV_{FC}>V_{buf}, in practice it is not trivial to achieve because the fuel cell's electrical properties of voltage, polarization voltage, membrane resistance, and efficiency strongly depend on current density and on environmental conditions including humidity and temperature. FIG. 69A illustrates a graph of nV_{FC} stack voltage on the left-side ordinate axis versus cell voltage V_{FC} varied parametrically by number of series cells “n” in the FC stack.

As is clearly evident, over a pragmatic range of fuel voltages 0.45V≤V_{FC}≤0.95, the stack voltage nV_{FC} of n fuel cells varies from below 2.7V, a voltage below the V_{ODC} over-discharge voltage 566 safety limit for Li-ion cells to a voltage over 4.2V, a dangerous condition exceeding the V_{OC} overcharge voltage 569 safety limit for a lithium ion buffer cell. Significantly, because of the exceedingly wide variability of fuel cell stack voltages with humidity, a series combination of fuel cells cannot be directly connected to a lithium ion cell without risking safety and cell damage.

Specifically at elevated humidity levels, high fuel cell potentials can cause dangerous overvoltage and overcurrent conditions. Conversely, under low humidity conditions, low cell voltages can undercharge a lithium ion cell at a voltage below Vₙₒₘ 568 at 3.6V not only limiting energy storage but risking permanent cell damage by discharging below Vₘᵢₙ 567 at 3.0V.

The intrinsic incompatibility between a fuel cell stack and a lithium ion cell is depicted parametrically by lines 570a for a fuel cell stack with n=4, line 570b for a fuel cell stack with n=5, line 570c for a fuel cell stack with n=6, line 570d for a fuel cell stack with n=7, line 570e for a fuel cell stack with n=8, line 570f for a fuel cell stack with n=9, and line 570g for a fuel cell stack with n=10. As depicted, fuel cell stacks of n≤4 are incapable of exceeding Vₙₒₘ over the full spectrum of nominal cell voltages, i.e., where nV_{FC} Vₙₒₘ and require a minimum cell voltage of V_{FC}>3.0V/4=0.75V to exceed the target operating range's lower limit Vₘᵢₙ. Commencing discharge from an undercharged state risks over-discharging the battery buffer, a condition that can damage the lithium ion separator and cause a short circuit induced fire during the next charging cycle.

By contrast, stacked fuel cell designs with n≥6 while capable of charging the buffer above V_{ODC} instead risk overcharging the buffer cell above V_{OC} potentially causing overheating, electrolyte leakage, fire, or explosion. The risk of overcharging the buffer cell increases in proportion to the number of series connected cells in the stack—the larger the value of n, the more easily nV_{FC}≥V_{OC}. Over the specified range of fuel cell voltages from 0.45V to 0.95V, fuel cell array where n=5 shown by line 570b may cause both overcharge and over-discharge conditions to occur.

To further quantify the problematic matter of exceeding the safe operating area of a lithium ion buffer cell, FIG. 69B illustrates a graph of stack voltage nV_{FC} versus number of series cells “n” in a fuel cell stack, varied parametrically by cell voltage V_{FC} at 0.4V, 0.5V, 0.6V, 0.7V, 0.8V, 0.9V and 1.0V/cell corresponding to curves 575a, 575b, 575c, 575d, 575e, 575f, and 575g respectively. Although these specific curves are identified at discrete voltages, they represent a sampling of a analog continuum in voltage. The number of cells n, by contrast are integers with no fractional intermediates between the labelled numbers.

As shown, lower numbers of series connected fuel cells n exhibit a correspondingly lower range of stack voltages than higher cell counts. Higher V_{FC} cell voltages, typical of operation at higher humidity, not only span higher voltage ranges, they also exhibit larger slopes as described by the derivative dV/dn. Higher values dV/dn significantly affect fuel cell design where a small change in the topology of the fuel cell array can profoundly affect fuel cell performance especially over a range of RH relative humidity values. The resulting stack voltage nV_{FC} must be measured against the safe operating area bounded by the V_{ODC} over-discharge voltage 566 on the low side and the V_{OC} overcharge voltage on the high side. Within this SOA, the stack voltage is also compared against the design criteria of the Vₘᵢₙ minimum voltage 567 and the Vₙₒₘ nominal voltage 568.

Fuel cell stacks that never exceed Vₙₒₘ risk operating perpetually in an undervoltage condition shortening buffer life and suffering the inability to supply even 3V electrical loads without risking deep discharge. As shown, cell arrays operating at V_{FC}=0.4V shown by curve 575a do not even reach Vₘᵢₙ for a n=9 cell stack. To operate properly at such low voltage and low humidity conditions probably requires a cell stack of n=10 to be useful. On the other end of the spectrum, operation at high cell voltages where V_{FC}<0.7V shown by curves 575d to 575g, never risks falling below V_{ODC} but easily exceeds the V_{OC} overcharge voltage 569 for any cell stack n≥5. For example, for a n=5 design, the V_{OC} overcharge voltage 569 is exceeded whenever V_{FC}>0.84V (not shown) while for n=6 it occurs when V_{FC}=0.7V represented by curve 575d. Depending on the number of cells intermediate voltage operation shown by curves 575b and 575c can cause either undervoltage operation or overvoltage with no single value being optimum.

Clearly, in order to realize the buffered fuel cell as disclosed herein, an array of fuel cells cannot be connected directly to a lithium ion cell because of their intrinsic naturally occurring mismatch in voltages. As illustrated graphically, there is no proper number of fuel cells to match the voltage variability of a fuel cell stack to the limited safe operating area of a lithium ion battery used as the buffer in the BFC. Although theoretically another battery chemistry with a less stringent operating voltage range could be used to supplant lithium ion as a buffer cell, no comparably performing electrochemistry exists today. Even should a viable Li-ion replacement be discovered, there is no reason to presume that the new hypothetical cell would be any more compatible with or tolerant of the extreme voltage variability of the hydrogen fuel cell than existing chemistries.

Instead, an inventive electronic component, the charge transfer regulator having a acronym QXR where “Q” means charge, “X” is an abbreviation for the prefix “trans” (such as xmitter, xfer, etc.), and regulator “R” is required to connect and equilibrate the fuel cell and battery elements with the buffered fuel cell. Since the battery is constructed using Li+ion chemistry and the PEM fuel cell uses H⁺ions, the QXR can be considered as translation device for storing energy in dissimilar group-I cation chemistries. Given the described function of the QXR charge transfer regulator in preventing overcharging, it is preferable to “overdesign” the fuel stack by using too many rather than too few cells in a stack.

That said, the function of the QXR is not simply to limit voltage. This non-obvious complication occurs because the electrochemical properties of both the fuel cell and the buffer are subject to limitations in their maximum current conduction I_{FC} and I_{buf}. Which current is more limiting depends of the topology of the fuel cell array, the area of the fuel cell characterized by its m value, the number of cells in the stack n, and the cell voltage as a function of both humidity and temperature. Moreover, fuel cell current depends not only on stack voltage nVF_{C} but on its series resistance nR_{FC} which varies by the number of series connected cells n and their area equivalent m. As depicted for a m=1 design by curve 576 in FIG. 69B shown previously, the stack resistance shown on the right side ordinate axis increases linearly from 4.8Ω at m=4 to 10.8Ω for m=9. To better understand these dependences, a multivariate response surface is required to determine which factors dominate safety in transferring energy from a fuel cell stack to a buffer cell or cells.

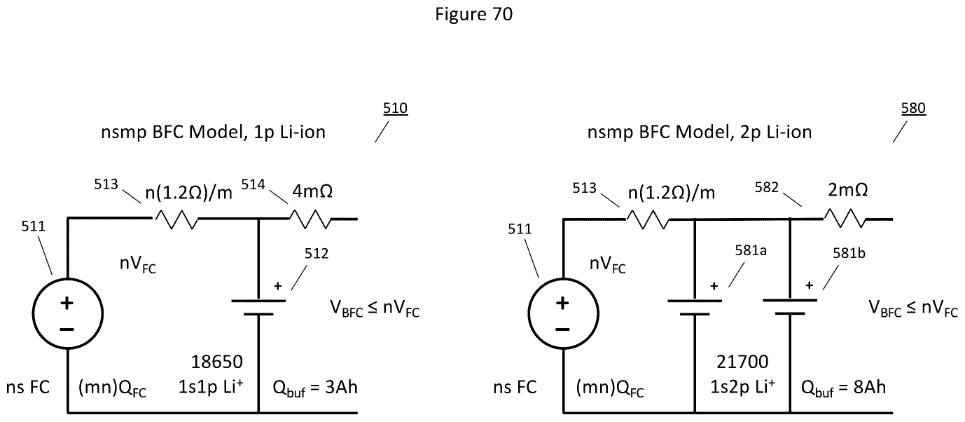

QXR Functionality. As described, the required relationships between the fuel cell stack voltage nV_{FC} and the buffer voltage V_{buf} is determined by current conduction between the two elements using an intermediary device—a QXR charge transfer regulator. To identify the requisite functions of the QXR it is insightful to consider the problems encountered when directly connecting a stack of fuel cells to a lithium ion cell absent any protective electronics. Although a myriad of combinations of fuel cell topologies and buffer battery configurations are conceivable, careful consideration of two basic networks shown in FIG. 70 is especially insightful. These two BFC circuit topologies include a nsmp fuel cell array 511 connected to a buffer comprising either a 1s1p lithium ion cell 512 in circuit 510 or two parallel connected lithium ion cells 581a and 581b arranged in a 1s2p electrical network in circuit 580. For simplifying analysis, the schematics do not include the QXR charge transfer regulator.

Each circuit also includes two resistors, lumped element resistor 513 representing equivalent series resistance of the fuel cell array 511. An exemplary resistance of 1.2Ω is shown for 1s1p fuel cell multiplied by the ratio (n/m) to determine the equivalent resistance of the stack. A second resistor 514 depicts the resistance of a single lithium ion battery as buffer 512 at 4 mΩ or of the parallel combination of two lithium batteries 581a and 581b with an equivalent resistance of 2 mΩ. Like the fuel cell array, the buffer may comprise any series-parallel array of batteries comprising “v” series configured battery cells connected into “u” string connected in parallel. Accordingly, the equivalent resistances of the buffer and fuel cells

$${R}_{F C a} = ( n / m ) {R}_{F C}$$

$${R}_{buf} = ( v / u ) {R}_{b a t}$$

where R_{bat} is the resistance of a single battery cell and R_{buf} is the equivalent resistance of the array of batteries. Unlike fuel cells which can be stacked on top of one another in the same assembly for n>1 and/or expanded in area where m>1, batteries comprise discrete components that cannot be merged into a larger enclosure. As such, increasing the number of parallel connected batteries u>1 reduces the buffer's equivalent resistance proportionally but maintains the same voltage.

Alternatively connecting more batteries in series, i.e., where v>1, the voltage of the series connected batteries increases as so too does the resistance. Because however the number of fuel cells in the fuel cell stack n must be scaled in proportion with the number of series connected batteries v, i.e., where n∝v, e.g., 6 fuel cells for every battery there is no electrical benefit to stack batteries. Instead, a more pragmatic solution is to maintain v=1 and vary only the number of parallel batteries u comprising the buffer as shown in the example of circuit 580.

Likewise, the total charge Q_{T} of the equivalent network of the BFC is the sum of the fuel cell charge Q_{FCa} and the buffer charge Q_{buf} given by

$${Q}_{T} = {Q}_{FCa} + {Q}_{buf}$$

$${Q}_{FCa} = ( mn ) {Q}_{FC}$$

$${Q}_{buf} = ( uv ) {Q}_{bat}$$

where u is the number of parallel strings of v series connected batteries in the buffer storing energy Q_{bat}, m is the number of parallel stacks of fuel cells comprising n series cells, Q_{FC} is the charge of any one fuel cell, and Q_{FCa} is the total charge contained in a fixed volume of fuel.

Technically speaking, schematic 510 is inaccurate as resistor 514 should be in series with buffer 512 and in parallel with the network branch containing fuel cell stack 511 and fuel cell stack resistance 513. Because however that the resistance of R_{buf}=4 mΩ is so small compared to the fuel cell's equivalent resistance n(1.2Ω)/m, then when fuel cell 511 either charges buffer or delivers current to a load the added resistance 514 is meaningless compared to the fuel cell's internal resistance. Relocating resistor 514 into the output loop more insightfully depicts the network as two half circuits—a charging loop comprising fuel cell 511, resistance 513, and buffer 512; and a load loop comprising buffer 512, buffer resistance 514 and an electrical load (not shown).

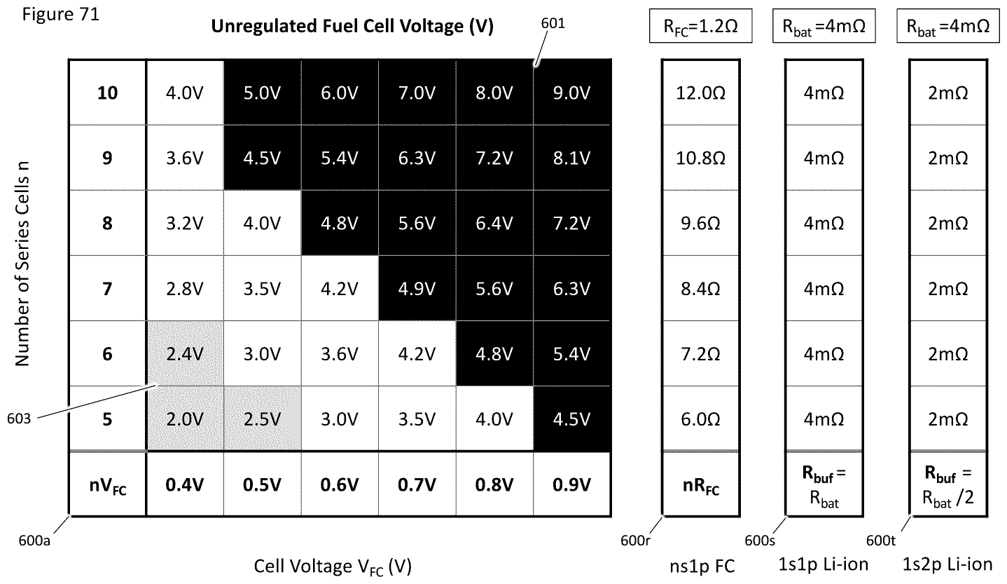

FIG. 71 illustrates the multi-variable interdependence of the fuel cell array stack voltage nV_{FC} presented as response surface 600a of two variables—cell voltage V_{FC} shown on the x-axis and number of series cells “n” in the fuel cell stack shown on the y-axis. The response surface represents three-dimensional data of the voltage occurring for each x-y pair of fuel cell voltage V_{FC} and number of series cells n. For example, for the cell where the column for V_{FC}=0.5V intersects the row for n=7, at a fuel cell stack voltage of 3.5V.

The black zone cells 601 indicate an overvoltage condition while gray zone cells 603 indicate FC array undervoltage conditions too low to charge the Li-ion buffer within the specified range. As depicted, only a narrow band of nV_{FC}combinations fall within the buffer limited voltage range 2.7V≤nV_{FC}≤4.2V. The graphic also illustrates the m=1 stack fuel cell nR_{FC}resistance 600r and for reference, the resistances of 1s1p and 1s2p lithium-ion cell buffers in columns 600s and 600t respectively, assuming R_{FC}=1.2Ω and R_{bat}=4 mΩ.

While the fuel cell resistance for a constant A_{FC}=1 cm², i.e., m=1, area scales linearly with n, the buffer resistances do not within any measurable degree depend on the fuel cell's number of stacked cells n whatsoever. This illustration highlights several important points. First, the QXR must provide voltage regulation to prevent damaging the lithium ion buffer. Secondly the area factor m must be increased proportionally with the cell stack voltage and n to counter increased fuel cell stack resistance nR_{FC}. Thirdly the buffered fuel cell is able to deliver power to an electrical load through a constant resistance. As such the deliverable power available for driving an electrical load depends on the voltage the buffer, but not on the fuel cell resistance. So even though increasing the number of fuel cells in a stack increases fuel cell resistance, the overall performance of the buffered fuel cell improves, i.e., is capable of delivery more current, not less.

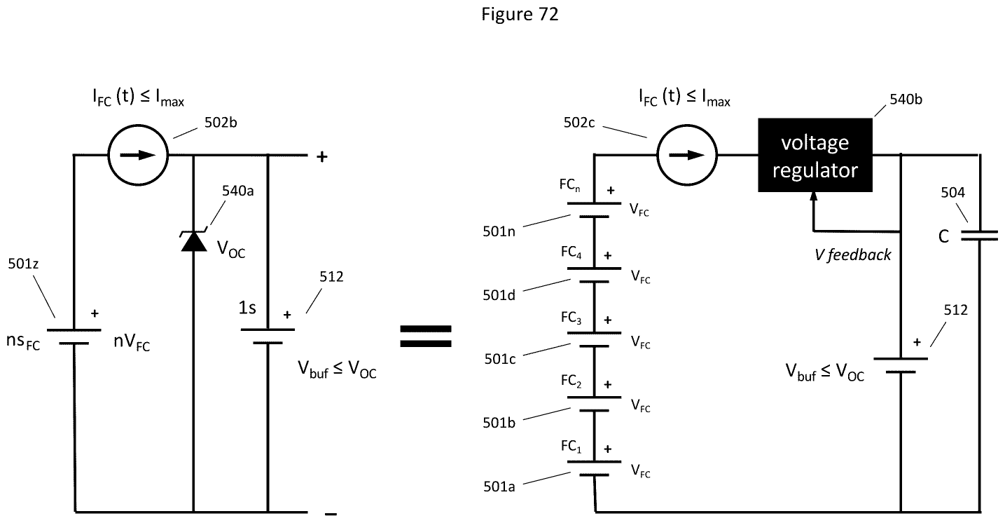

Given the wide variability of fuel cell voltages over expected humidity and temperature ranges, two important array design considerations also emerge. First, the required number of series connected fuel cells should match or exceed five, i.e., n≥5. Second, to prevent overcharging the Li-ion cell, the buffer voltage must be limited by clamping of voltage regulation as illustrated in FIG. 72. The voltage protection functional description of the QXR is shown in the left side schematic where 501z is an array of n series connected fuel cells, current limiter 502b protects current transfer from exceeding some maximum current Iₘₐₓ when transferring charge to buffer cell 512, and where idealized Zener diode equivalent 504a limits the maximum charge voltage V_{buf} to below the battery's overcharge voltage V_{OC}, i.e., where V_{buf}≤V_{OC}. Although idealized Zener diode equivalent 504a schematically is illustrated as a shunt regulator, in practice it is easier and less lossy to employ a series pass regulator such as voltage regulator 540b shown in the right side schematic in the same illustration.

In this schematic fuel cell stack 501z is depicted as a series connection of n fuel cells FC₁ to FCₙ identified as cells 501a, 501b, 501c, 501d, . . . , 501n where any number of cells (not shown) are connected between cell 501d and 501n. For ensuring stable and reliable operation voltage regulator 540b has its output filtered by capacitor 504 with value C in parallel to buffer 512. The capacitor should be low impedance at high frequencies to provide rapid response that the electrochemical impedance behavior of buffer 512. Using ideal components, the combination of current limiter 502c placed in series with voltage regulator 540b is non-sensical as it implies putting an ideal current source in series with an ideal voltage source creating an electrical paradox. Specifically, an ideal current source will deliver any voltage necessary to ensure it conducts a constant current while an ideal voltage source will deliver any current necessary to ensure it produces a fixed voltage. In practice, these two components 502c and 540b are real devices not idealized sources. As such the current source will limit the current flowing into voltage regulator regardless of its output voltage. As such, the low impedance buffer 512 will hold the output of regulator 540b at the buffer voltage V_{buf} until it charges, ultimately reaching the V_{OC} overcharge voltage. Once this voltage is met, voltage regulator 540b will clamp the maximum output voltage to V_{OC} regardless of how much current the current limiter 502c tries to source.

In this way the current limiter defines a maximum value of conducted current by does not maintain a constant current. Similarly, voltage regulator 540b cannot maintain a constant output voltage but strictly limits the maximum voltage. In this manner it functions more as a voltage limiter than a regulator. Together the two devices perform the combined function of a current limited voltage clamp, not a current source or a voltage regulator. In so doing the combined effect is to control charge transfer from fuel cell 501z to buffer 512, hence its notation as a “charge transfer regulator” or QXR and not a current or voltage regulator.

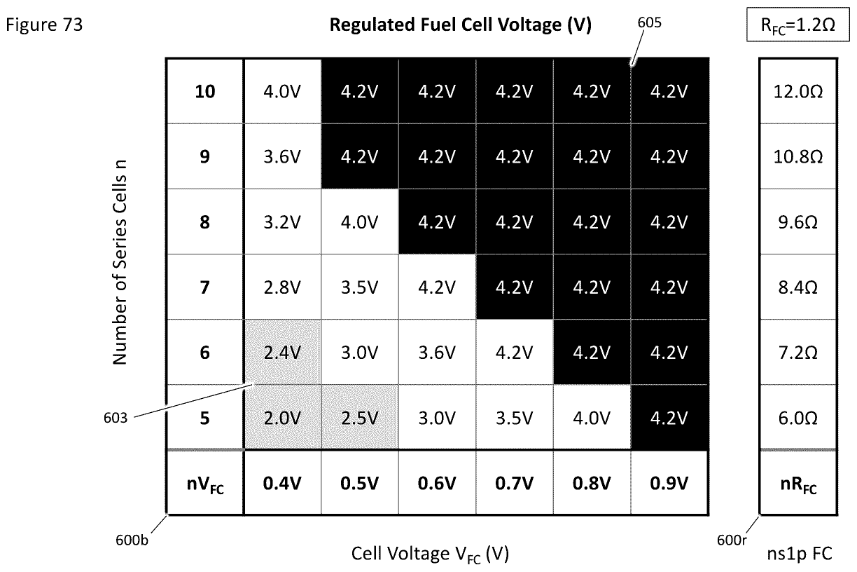

Using the QXR to limit charge transfer, the previously illustrated response surface 600a is transformed into the QXR protected response surface 600b shown in FIG. 73. In this manner the black shaded cells 605 are charge transfer limited to 4.2V as a safety feature to prevent buffer malfunction, damage, or fires. The remaining cells in the response surface remain unchanged. But as described previously. the purpose of the charge transfer regulator is not only to clamp the buffer voltage but to prevent overcurrent, limiting the maximum output current delivered by fuel cell stack 501z, and by limiting the maximum charging current flowing into buffer cell 512 during charging.

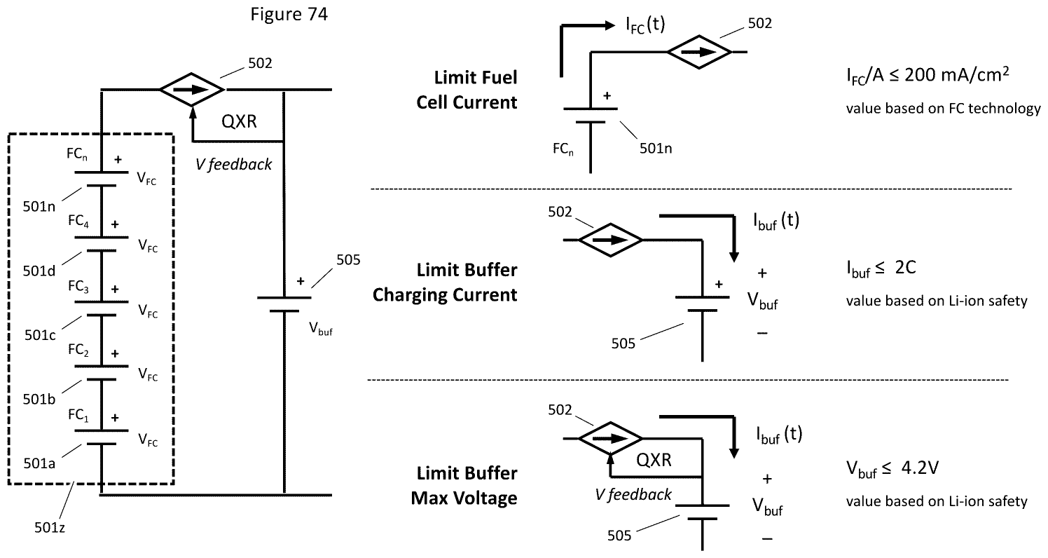

As disclosed herein, the task of preventing the buffer cell from exceeding its overcharge voltage limit V_{OC} is performed by a protective device, the QXR charge transfer regulator 502 inserted between the fuel cell array 501z and the buffer cell 505 as shown schematically in FIG. 74. The critically important voltage clamping function is depicted in the lower right schematic where QXR employs voltage feedback to monitor the state-of-charge of the buffer to prevent excessive voltage during charging. Although the maximum voltage of the buffer is shown as V_{buf}≤4.2V in reality this QXR regulated voltage should be V_{buf}≤V_{OC}, the overcharge voltage of the battery specified by the manufacturer and not necessarily the voltage depicted in the illustration.

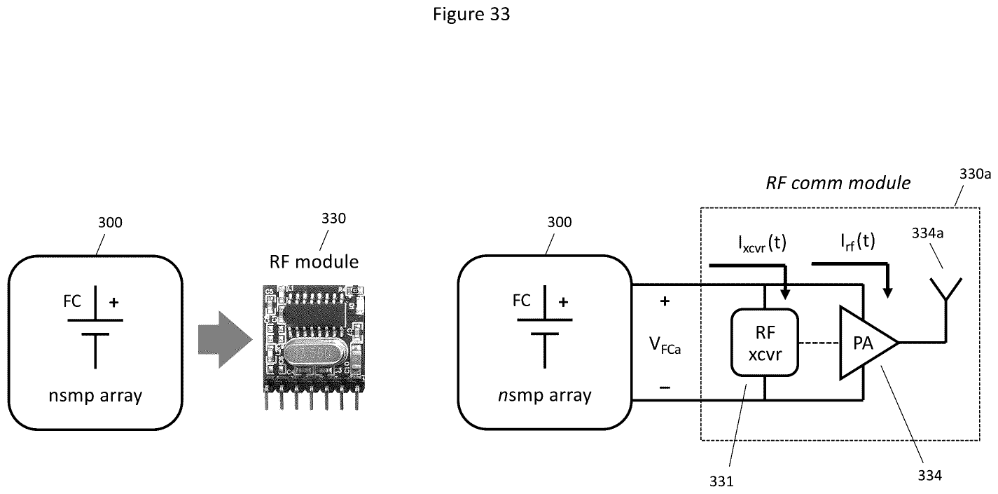

As aforementioned although the voltage protection feature is a critical function of the QXR, it is not its only key role. As such the QXR is not simply a series-pass voltage limiter. Instead, the QXR must control the current flowing from the fuel cell to the buffer. As depicted in the same figure, the current control function has two different purposes (i) to limit the maximum current delivered by the fuel cell, and (ii) to limit the maximum charging current of the buffer cell. The dual current limit criteria for the input and output of the QXR are completely different. In the upper right side schematic previously shown FIG. 74 the QXR is configured to limit a fuel cell's current to some specified maximum, in the example shown I_{FC}/A≤200 mA/cm². The need to limit the fuel cell current is not intended to prevent damage to the fuel cell PEM membrane but to prevent fuel cell voltage droop and dropout as exemplified by line segments 535 and 536 in FIG. 33A shown previously. The actual current corresponding to this current density depends on the fuel cell area or m value. Assuming m=1 is defined as the A_{FC}=1 cm² then for m=5, A_{FC}=5 cm² and I_{FC}≤1 A; for m=10, A_{FC}=10 cm² and I_{FC}≤2 A; for m=20, A_{FC}=20 cm² and I_{FC}≤4 A; for m=30, A_{FC}=30 cm² and I_{FC}≤6 A; for m=40, A_{FC}=40 cm² and I_{FC}≤8 A; and for m=50, A_{FC}=50 cm² and I_{FC}≤10 A.

In the case of current limiting of the buffer charging current shown by the middle right schematic of FIG. 74, a common safety limit for charging lithium ion chemistries is 2C. The actual maximum current depends on the capacity of the buffer cell. In the event of a 18650 form factor with 3 Ah capacity configured in a 1s1p buffer topology, a 2C current is equal to 6 A. For a 21700 Li-ion cell with 4 Ah capacity configured in a 1s1p buffer topology has a 2C current equal to 8 A, while in a 1s2p topology its 2C current equals 16 A.

The matter of whether fuel cell 501z or buffer 505 sets the allowed current conducted by QXR 502 depends on both environmental conditions and on fuel cell design. As stated previously a 3 Ah capacity 1s1p buffer topology exhibits a 2C current equal to 6 A. For a fuel cell of area m=30, the 200 mA/cm² current limit is also 6 A. In such a design, a QXR maximum current of 6 A will satisfy both the fuel cell and buffer current criteria, i.e., they are balanced. Accordingly for smaller area fuel cells where m<30, the maximum fuel cell current density limits the recharging rate of the buffer to a value below 6 A. For larger area fuel cells where m>30, the 2C buffer rate of 6 A limits the recharging rate of the buffer, not the fuel cell current capability.

Similarly, for a 21700 Li-ion cell with 4 Ah capacity configured in a 1s1p buffer topology has a 2C current equal to 8 A, while in a 1s2p topology its 2C current equals 16 A. In the case of a single 4 Ah cell, the fuel cell current limit and buffer cell limit occur at m=40. For smaller fuel cells, the fuel cell limits the maximum buffer charging current while for larger fuel cells the Li-ion 2C limit sets the maximum charging rate. For a dual cell buffer where 2C charging occurs at 16 A, the buffer charge rate in not limiting for any reasonable sized fuel cells.

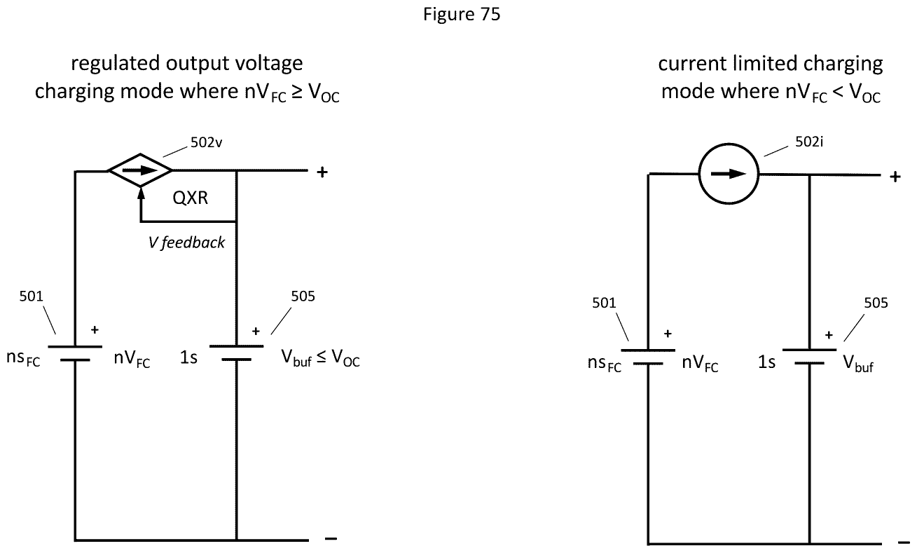

In summary, the QXR charge transfer regulator is a critically important component necessary to ensure safety and reliable operation when transferring charge from a stack of fuel cells into a battery buffer. As depicted in FIG. 75, the QXR comprises a feedback-controlled pass element interposed between a fuel cell stack 501 and a charge storage buffer 50. The QXR may operate in voltage mode whenever nV_{FC}>V_{OC} as depicted in the left side schematic as QXR 502v or may function as a current limiter as depicted in the right side schematic as QXR 502i. In the voltage clamping mode QXR 502v strictly limits the buffer voltage to prevent a dangerous overvoltage condition above the overcharge limit of the battery. In the current limiting mode QXR 502i prevents charging currents from exceeding a specified current density in the fuel cell and from exceeding a safe C-rate in the buffer cell.

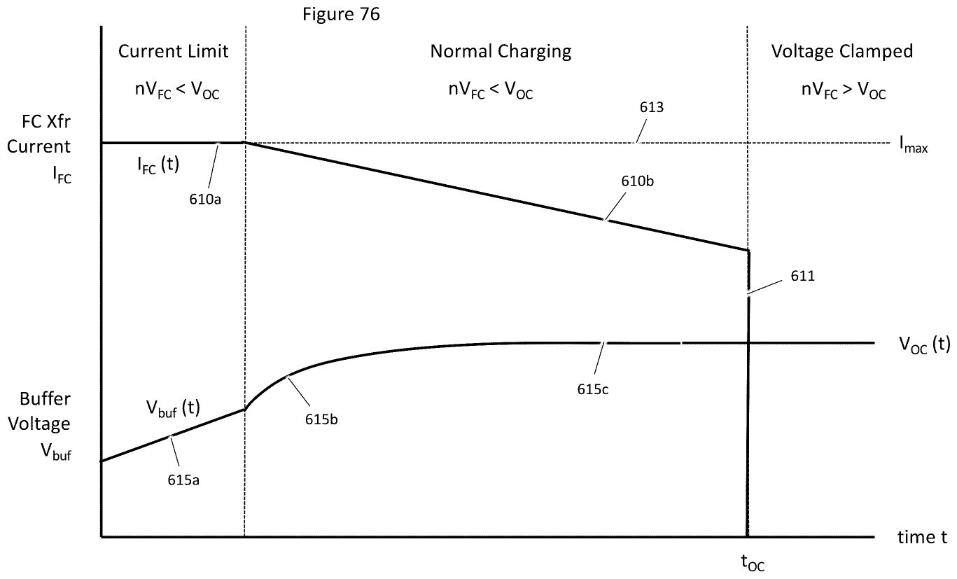

Unlike a battery charger, the QXR limits the current, limits the voltage, or directly connects the fuel cell and buffer without interfering with either current or voltage. These functional modes of the QXR are exemplified in the waveforms of FIG. 76. For example, in the current limiting mode the fuel cell current I_{FC}(t) is limited to the maximum safe current 610a. During current limiting, the V_{buf}(t) buffer voltage 615a rises linearly. The current limit may be pre-determined by design or be dynamically adjusted by autonomous sensing circuitry. Either way the current must be limited to I_{chg}(max) as specified by either to the maximum fuel cell current to avoid voltage droop or by the maximum safe charging current of the Li-ion battery buffer.

Once the voltage differential between the fuel cell voltage V_{FC} and the buffer voltage V_{buf} diminishes below the Iₘₐₓ current limit threshold 613, then charge transfer transitions into a resistive connection between the fuel cell stack and the buffer, labelled as “normal charging”. During this mode, the current declines 610b as the voltage rises first rapidly 615b then asymptotically 615c until nV_{FC}=V_{OC} when charging current 611 drops to zero in which case the buffer voltage stabilizes 615c just slightly below V_{OC}. The combination of these three specifications is unlike any voltage regulator or battery charger available. The charge transfer regulator is therefore a unique and non-obvious requirement of the disclosed buffered fuel cell. Connecting a fuel cell to a unprotected lithium ion battery can cause failures, fires, and explosions. Connecting a fuel cell stack directly to a lithium ion charger IC will overpower the fuel cell's power sourcing ability collapsing the voltage and interrupting charging, recovering and trying again and again.

Headroom Limited Charging Rate. Operating in the normal charging range below the QXR current limit and voltage clamp levels, the QXR performs a secondary function of charging the buffer cell. Charging may involve current mode, voltage mode, or sequential charging. Switch mode PWM charging is not preferred as it can result in excessive fuel cell current conduction. Current limited switch mode operation, described later in this application, may be used.

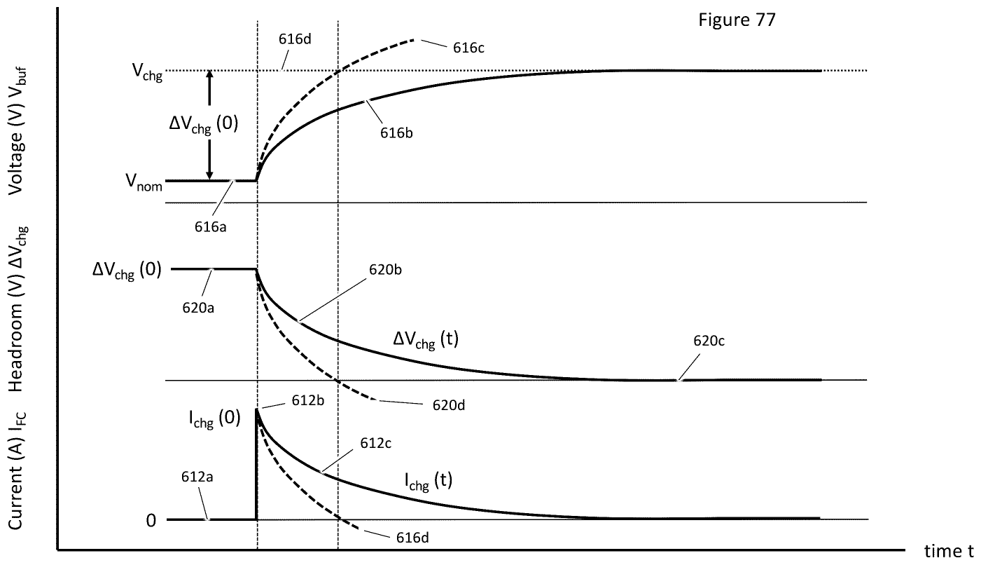

In voltage mode, the maximum charging rate is limited by the charging headroom ΔV_{chg}defined as ΔV_{chg} (t)=V_{chg}−V_{buf}(t) the difference ΔV_{chg} 620a between V_{chg} 616d and the buffer voltage at Vₙₒₘ 616a. As shown by the solid lines in FIG. 77, when charging first commences at some nominal buffer voltage 616a V_{buf}=Vₙₒₘ, the headroom 620a is given by ΔV_{chg} (0)=V_{chg}−Vₙₒₘ. As charging ensues the headroom ΔV_{chg} (t) declines 620b as the buffer voltage 616b approaches the charger voltage 616d. In a corresponding manner the charging current jumps from its quiescent level 612a to its peak value 612b at I_{chg}(0) then declines asymptotically 612c as shown by curve I_{chg}(t). The charging rate can be accelerated by applying a higher charge voltage 616c and clipping the voltage at 616d before it exceeds the V_{OC} overcharge safety limit. As shown with increased headroom ΔV_{chg} approaches zero 620d is a shorter time and terminates charging 616d faster.

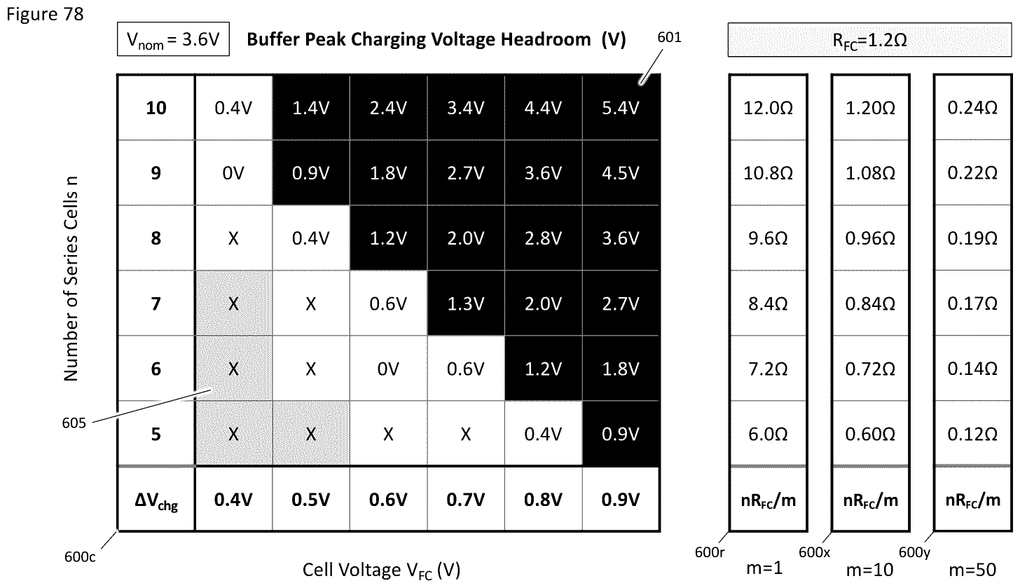

In order to perform accelerated charging, the by ΔV_{chg} headroom must be larger than 1V and ideally greater than 2V as shown in the response surface 600c of FIG. 78. This condition occurs primarily when V_{FC}≥0.7V or n≥8 or both as identified by the black cells 601. The table also includes the cell stack resistance for various combinations of series cells n and parallel cells m as shown in columnar tables 600r for m=1, 600x for m=10, and 600y for m=50. The scaled resistances comprise a value (n/m)R_{FC} where the single cell 11p value equals 1.20. As shown increasing the number of series cells increases the fuel cell voltage and charger headroom but also increases the series resistance of the fuel cell. Increasing the fuel cell area mA_{FC} however decreases the resistance. The net resistance is therefore the single cell resistance R_{FC} time the geometric multiplier (n/m) whereby the array resistance equals (n/m)R_{FC}. Although the number of series cells n and parallel cells m may be fixed, in accordance with this invention they also may be varies dynamically during operation.

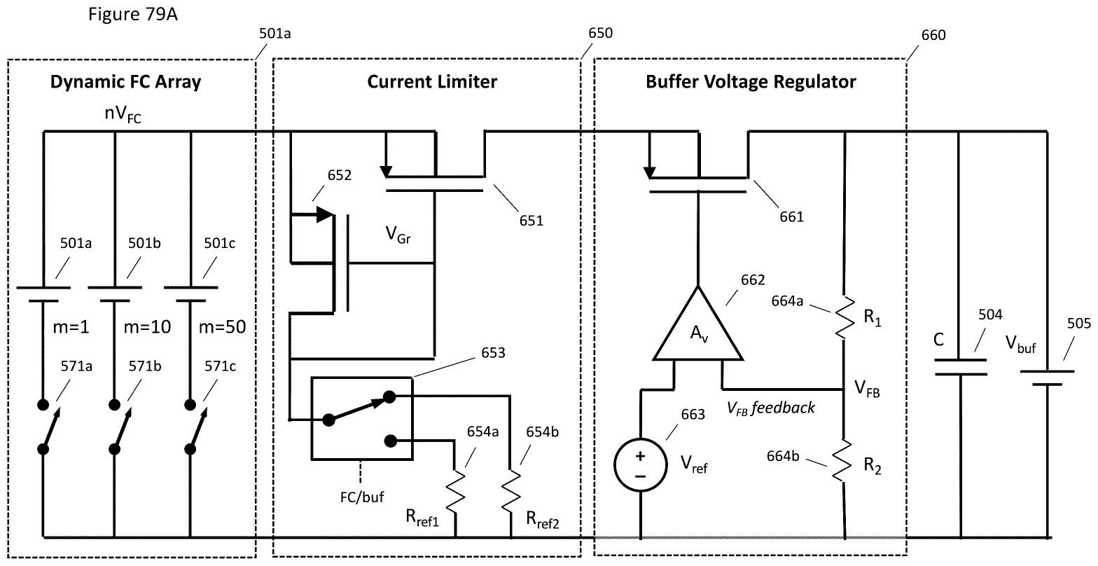

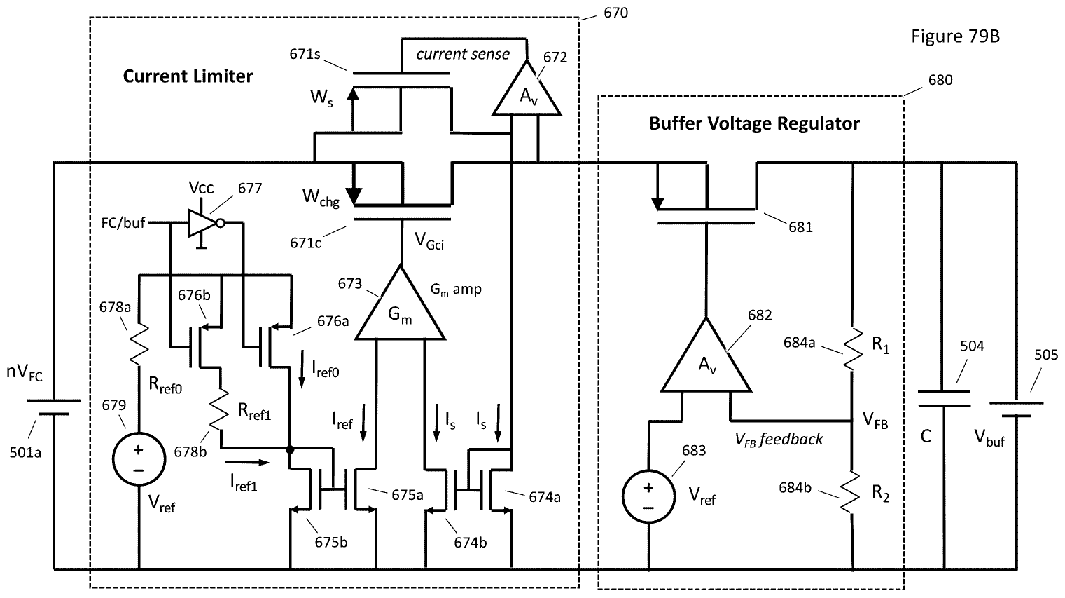

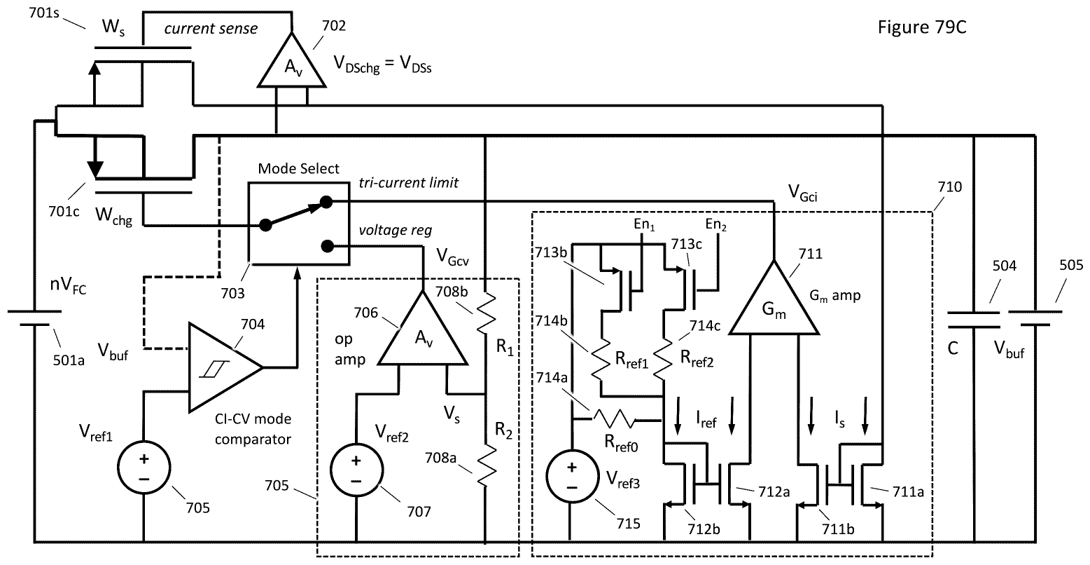

The ability to dynamically change the fuel cell topology is depicted schematically in FIG. 79A where the fuel cell array 501a may be varied by controlling which switches 571a, 571b and 571c are conducting and which ones are open. Regardless of the switch combination the net fuel cell voltage nV_{FC} is given by the number n of fuel cells connected in series and the voltage of an individual fuel cell V_{FC}. The fuel cell voltage therefore does not depend in the area scaling factor m. The current capability of the fuel cell and equivalent resistance depends not only on the series number of cells but on the equivalent area mA_{FC} of the fuel cell.

As illustrated switch 501a enables conduction in m=1 cell 501a where the total resistance is given by n(1.2Ω). Switch 501b enables conduction in m=10 cell 501b where the total resistance is given by n(0.12Ω). Switch 501c enables conduction in m=50 cell 501c where the total resistance is given by n(0.024Ω). In this manner the fuel cell can produce the required voltage without generating more current capability than is needed, thereby reducing heating and preserving fuel.

Circuits integrating the QXR current transfer regulator include the schematic of FIG. 79A combining a two limit current limiter 650 with a linear series-pass voltage regulator 660. The input FC/buf signal can be used to dynamically change the current limiting 653 to best match the fuel cell array topology. The current limit can be set by adjusting the gate width of MOSFETs 651 and 652, the reference resistors 654a and 654b having resistances R_{ref1} and R_{ref2}respectively, or both. The FC/buf signal determines which limit is applicable based on sensing data. Alternatively, a fixed level current can be determined and set by resistor at the time of manufacturing of a specific fuel cell design. The buffer voltage regulator stage 660 includes a pass transistor 661 operating in linear mode whose gate potential is controlled by voltage differential input amplifier 662.

The inputs to the differential amplifier include a reference voltage 663 of magnitude V_{ref}and a feedback signal V_{FB}, the tap point of a voltage divider comprising resistors 664a and 664b heaving resistances R₁ and R₂. The feedback voltage V_{FB} is a fraction of the regulator's output-buffer voltage V_{buf}. The magnitude of the feedback signal V_{FB}=V_{buf} [R₂/(R₁+R₂)] is chosen relative to the reference voltage to prevent the output from exceeding a pre-defined voltage of V_{OC}, typically between 4.1V and 4.2V depending on cell chemistry. The resistor values 664a and 664b and/or the voltage reference 663 value V_{ref} can be trimmed during manufacturing to improve current accuracy. The regulated voltage output is filtered by capacitor 504.

FIG. 79B illustrates an improved version of the dual setting current limiter circuit using a precision voltage and ratioed current mirrors. Although the circuit appears complex, the main function can be understood by considering the two main MOSFETs—charging transistor 671c and sense transistor 671s. In a precision implementation, the two MOSFETs 671c and 671s are identical in construction except in their gate width. Specifically the gate width of the charging transistor 671c W_{chg} is significantly larger than sense MOSFET 671s with gate width Wₛ<<W_{chg}. Differential amplifier 672 compares the drain-to-source voltages of the two transistors and biases the gate of sense transistor 671s to a voltage forcing the V_{DS} of both the sense and charging MOSFETs to be equal.

If the V_{DS} values are equal, the current is divided in the gate width ratio (Wₛ/W_{chg}) of the sense and charging transistors 671s and 671c in proportion to their resistances. In this manner the current Iₛ is a precise measure of the buffer charging current I_{chg}. The current Iₛ is then mirrored by threshold connected N-channel MOSFET 674a into matching MOSFET 674b. The drain current of MOSFET 674b in then input into Gm transconductance amplifier 673. Aa a term-of-art in analog integrated circuitry, a “threshold connected” MOSFET is any field effect transistor with its gate connected to its drain making it a two-terminal device operating in its saturation region that converts drain current into a voltage V_{DS}=V_{GS}≈Vₜₒ. The term Vₜₒ is the threshold voltage of an enhancement mode MOSFET.

The second input to transconductance amplifier 673 is the reference current I_{ref}mirrored from threshold connected N-channel MOSFET 675b into current sink MOSFET 675a. The value of the reference current I_{ref} is mirrored as a reference input to Gₘ transconductance amplifier 673. The value I_{ref} may be either I_{ref0} or I_{ref1} depending in the state of the “FC/buf” digital enable signal and inverter 677 corresponding to the current limit specifications of the fuel cell or the buffer, whichever one is more restrictive at the time. The selection between I_{ref0} and I_{ref1} is achieved using the combination of inverter 676 and transistors 676a and 676b together functioning as a SPDT single-pole double-throw analog switch.

In the analog switch whenever the logical input “FC/buf” is in a high state, i.e., a Boolean “1” state, then the gate of P-channel MOSFET 676b is biased to the supply voltage Vcc whereby V_{GS}>0, P-channel MOSFET 678b is off, and I_{ref}1=0. Inverted by logical inverter 677, a high logic input simultaneously produces a grounded gate voltage on P-channel MOSFET 676a whereby V_{GS}<0. The negative gate bias turns on P-channel MOSFET 676a completing the circuit and delivering reference current I_{ref0} into threshold connected N-channel MOSFET 675b of current mirror 675a, and ultimately into the input of Gₘ transconductance amplifier 673. The Gₘ transconductance amplifier 673 amplifies the differential input between the sense current IS and the reference current I_{ref0} driving the gate bias on charging MOSFET 671c accordingly. If the sense current Iₛ does not match the reference current, the gate bias on charging MOSFET 671c is adjusted to increase or decrease the charging current until the two currents match.

The reference I_{ref} current is trimmed to precisely correspond to the required current limit for the fuel cell. The reference current I_{ref0} is determined by the sub-circuit comprising reference voltage 679, threshold-connected N-channel MOSFET 675b, and trim resistor 678a where the reference current is given by the relation I_{ref0} (V_{ref}−Vₜₒ)/R_{ref0}. To produce a second current limit level, the digital state of FC/buf input is biased to a low state turning on P-channel MOSFET 676b and turning off 676a. The resulting reference current is then determined by the sub-circuit comprising reference voltage 679, threshold-connected N-channel MOSFET 675b, and the series sum of trim resistors 678a and 678b. The resulting reference current is then modified to be I_{ref1}≈(V_{ref}−Vₜₒ)/(R_{ref0}+R_{ref1}).

In this manner the selection of resistors 678a and 678b enables the current limit to switch between two limits, setting either the current required to prevent excessive charging currents in buffer 505 or to prevent overcurrent and voltage droop in fuel cell stack 501. The circuit is dynamic, whereby the current limit can change during operation should the fuel cell voltage changes with varying humidity.

By monitoring the voltage of the fuel cell stack, the digital signal FC/buf can be toggled between buffer current limiting and fuel cell current limiting values. Specifically in the case of high humidity, the fuel cell stack voltage nV_{FC} is elevated resulting in an increased buffer charging currents, i.e., where V_{FC}/R_{FC}>I_{chg} (max) corresponding to a 2C charge rate. In such a case the current limit is set to the buffer input mode and the charging current is adjusted to protect the battery buffer. In the case of low-to-moderate humidity, the voltage per cell is low whereby more fuel cells are required in order to produce the required charging voltage in which case the current limit setting is determined by the fuel cell current density limit, not buffer charging. In this way the two state current limiter 670 is able to dynamically protect the fuel cell over a spectrum of operating conditions.

Aside from current protection, the QXR circuit also includes a buffer voltage regulator 680 follower to the two-state current limiter 670. The function of the buffer voltage regulator is to prevent the output of the QXR from overcharging the buffer voltage V_{buf}>V_{OC}. In the implementation shown a linear regulator circuit is adapted comprising P-channel pass transistor 681 which controls charging current so the voltage on capacitor 504 and buffer 505 never exceed the safety limit. The linear circuit employs a differential amplifier comparing the voltage of a trimmed V_{ref} precision voltage reference such as a bandgap reference to the V_{FB} tap point of a voltage divider comprising resistors 684a and 684b used to monitor the battery voltage. As the V_{FB} voltage rises during charging, the differential signal (V_{FB}−V_{ref}) diminishes reducing the gate drive on P-channel pass transistor 681 and lower the charging current to prevent overcharging. When V_{FB}=V_{ref} the charging current becomes zero and the buffer voltage remains at or near the safe operating condition V_{buf}=(V_{OC}−δV) allowing for some voltage guard band δV.

Although the disclosed QXR charge transfer regulator performs the required functions it suffers several design deficiencies. Firstly, it requires two large area P-channel power MOSFETs, specifically current limiter MOSFET 671c and voltage regulator MOSFET 681 making the cost of the integrated circuit or components nearly double that of a single transistor implementation. Secondly, both P-channel MOSFETs requires some minimum voltage referred to as “headroom” to operate. This minimum voltage is proportional to the transistor's on-state resistance. Unfortunately, a P-channel MOSFET has a area normalized specific on-resistance R_{DS}A more than double that of an N-channel. With two power MOSFETs in series the required chip area is four times greater than a single P-channel device implementation and 8 times the area of a single N-channel version. Aside from a larger die area and higher cost, the other disadvantage is the voltage regulator follower 680 offers only constant voltage charging mode. Some battery charging algorithms start with a constant current Cl charging mode before commencing CV constant voltage mode charging. The constant current charging mode is beneficial in maximizing the buffer's charging cycle life. The required current level in this Cl constant current charging mode does not match the 2C safety limit required for Li-ion charging protection or the 200 mA/cm² current restriction for fuel cell operation.

An improved multifunction QXR charge transfer regulator integrating the three defined QXR features with a dual-mode CI-CV charger is shown in FIG. 79C. The circuit features a single high-current pass-transistor comprising P-channel power MOSFET 701c of gate width W_{chg} for charging and P-channel sense MOSFET 701s of gate width Wₛ. Differential input voltage mode amplifier 702 driving the gate of current sense MOSFET 701s ensure that the drain-to-source voltage of both devices match, i.e., V_{DSchg}=V_{DSs}. When these two voltages match, the current flowing in the sense resistor becomes a precise multiple of the charging current whereby Iₛ=(Wₛ/W_{chg})I_{chrg}.

As shown the QXR circuit operates in two modes, constant current and constant voltage. The transition from current mode into voltage mode occurs when the voltage exceeds a specified buffer cell voltage where the resulting charging current is limited because of the limited voltage headroom (nV_{FC}−V_{buf}) of the QXR is small. This transition can be detected by monitoring voltage using CI-CV mode comparator 704 comparing V_{buf} to voltage reference 705 set to a voltage V_{ref1}. During charging whenever V_{buf}<V_{ref1}, the CI-CV comparator 704 digital output switches state toggling mode select switch 703 to voltage regulation mode. In voltage regulation mode, the gate drive for P-channel power MOSFET 701c is provided from the output of a voltage mode differential amplifier 706 amplifying the differential voltage between sense voltage Vₛ and a second voltage reference 707 having a voltage V_{ref2}. The sense voltage VS represents a fractional ratio of the output voltage V_{buf} charging buffer 505 and capacitor 504 using a resistor voltage divider comprising resistors 708a and 708b. The resistor ratio scales the voltage to precisely match the reference voltage 707 when the buffer is charged to its final value V_{buf}=(V_{OC}−δV) allowing for some voltage guard band 6V. The sense voltage is given by V_{S} =V_{buf} (R₂/(R₁+R₂)). When Vₛ<V_{ref2} the difference is amplified and biases the P-channel power MOSFET 701s at a gate potential V_{Gcv} charging the buffer at the maximum possible rate possible for the available headroom. Once Vₛ→V_{ref2} then the gate drive diminishes and I_{chg} →0 terminating charging.

Unless the QXR is operating in CV mode, the mode switch 703 defaults to current mode. In the circuit as disclosed, the current limiter is capable of specifying three different current levels (i) the maximum charging current not to exceed a specified current density in the fuel cell stack e.g., I_{chg}≤200 mA/cm², (ii) the maximum charging current not to exceed the safe charging current for the buffer, for example a 2C charge rate, and (iii) a specified constant current charge rate for CI mode charging whenever condition (i) and (ii) do not arise. The analog circuitry involved in regulating relies on current sense feedback Is from the sense P-channel MOSFET 701s. The current is reflected into a ground referenced sink current by the current mirror comprising threshold-connected N-channel MOSFET 711a reflected by N-channel MOSFET mirror 711b. The IS current is fed into a Gₘ transconductance amplifier 711 whose output is used to bias the P-channel power MOSFET 701c controlling charge transfer and charging currents for the QXR.

The second input to Gₘ transconductance amplifier 711, a reference current I_{ref} is used to set the maximum allowed current during charging in the CI mode. As a tri-current limiter, the reference current is derived from a shared V_{ref3} voltage reference 715 which is converted into one of three reference currents I_{ref0}, I_{ref1}, or I_{ref2} supplied to a current mirror comprising threshold connected N-channel MOSFET 712b and mirror device 712a. The adjustable reference current can be generated from the precision voltage source divided by a programmable resistance, or from a single resistor reflected into current mirrors of different width rations to scale the current up or down. In the variable resistor method shown schematically, three reference resistors 714a, 714b, and 714c are selected in different combinations by digital control signals En₁ and En₂ controlling multiplexer switches 713b and 713c. When both switches are off the magnitude of the generated reference current is defined by only resistor 714a having resistance R_{ref0}. The resulting reference current I_{ref}=I_{ref0} is given by the equation I_{ref0}=(V_{ref3}−Vₜₒ)/R_{ref0}. When enable En₁ is turned on, the reference current increases to I_{ref}=I_{ref0}+I_{ref1}. In essence turning on switch 713b puts resistor 714b in parallel with 714a, thereby lower the resistance and increasing the current. Although it is commonly known that parallel resistors add in reciprocal relation where 1/R=1/R₁+1/R₂+1/R₃ . . . , in practice it is common to use the shorthand notation R=R₁∥R₂∥ R₃. Accordingly, the equation for the reference current I_{ref} when enable En₁ is turned on is I_{ref}=(V_{ref3}−Vₜₒ)/(R_{ref0}|R_{ref1}) and when En₂ is turned on is I_{ref}=(V_{ref3}−Vₜₒ)/(R_{ref0}∥R_{ref2}) where R_{ref2} is the resistor 714c. Because a two input digital gate has four combinations, an even higher reference current can be achieved turning both En₁ and En₂ inputs whereby all three resistors are in parallel and I_{ref}=(Vref₃−Vₜₒ)/(R_{ref0}∥R_{ref1}∥R_{ref2}). The selectable reference current becomes the second differential input into Gₘ transconductance amplifier 711 allowing the current limit to be programmable.

Although the schematic represents a digitally controlled analog circuit, the circuit can be adapted for using a D/A converter to program the current limit and may employ digital logical logic or. microcontroller to determine the position of the mode switch and the current limiter enable signals En₁ and En₂. For example, a microcontroller can concurrently monitor the buffer voltage and the charging current and determine which current limit level is appropriate or when it is best to switch to QXR voltage mode operation. The decisions can also be based on measuring environmental factors such as relative humidity and temperature.

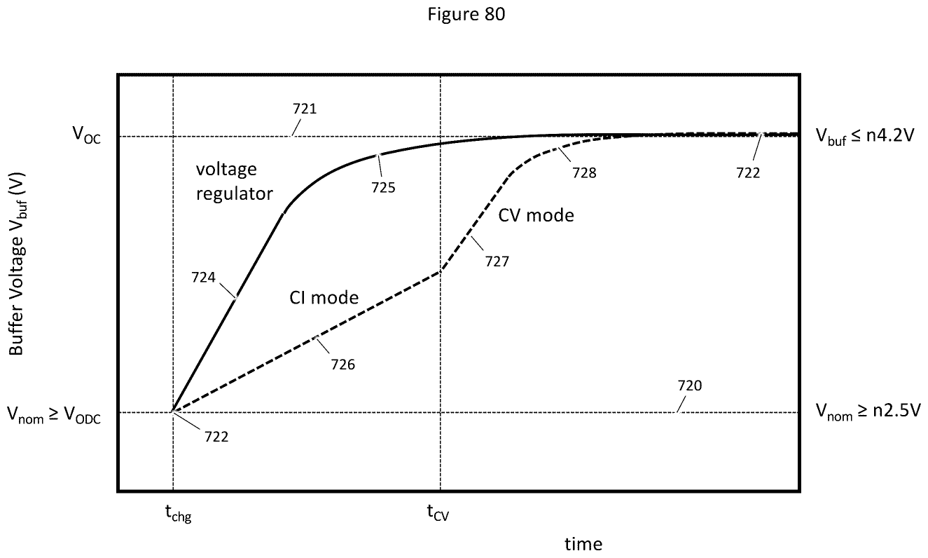

FIG. 80 contrasts the charging waveforms of the QXR with dual mode charger against a QXR with only constant voltage mode charging. The figure assumes the normal charging cycle when current limiting of the fuel cell or the battery C-rate are not required. As shown by line 720, starting at some nominal buffer voltage Vₙₒₘ above the over-discharge voltage V_{ODC} constant voltage charging commences 722 with a rapid rise in voltage and a corresponding state-of-charge 724 then slows asymptotically 725 as the final voltage V_{OC} is approached. Although the current is not excessive studies suggest that starting with a controlled current allows the electrochemical cell to maintain an equilibrium state and avoid unwanted chemical byproducts which can poison the cell and shortens is charging cycles and use life. By contrast, in Cl constant current mode a constant current results in a slower purely linear voltage ramp 726 until some pre-specified condition is met at time t_{CV} when the QXR switches into voltage mode causing a rapid rise in voltage 727, followed by a faster asymptotic charging cycle 728 culminating with a fully charge buffer 722 when charging ceases.

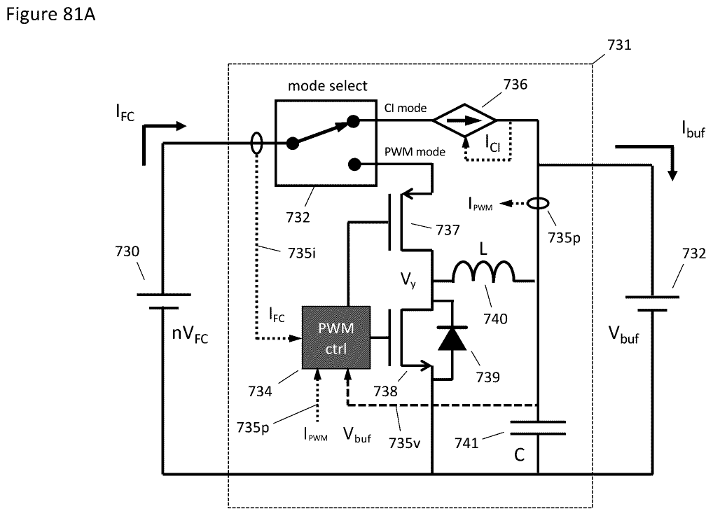

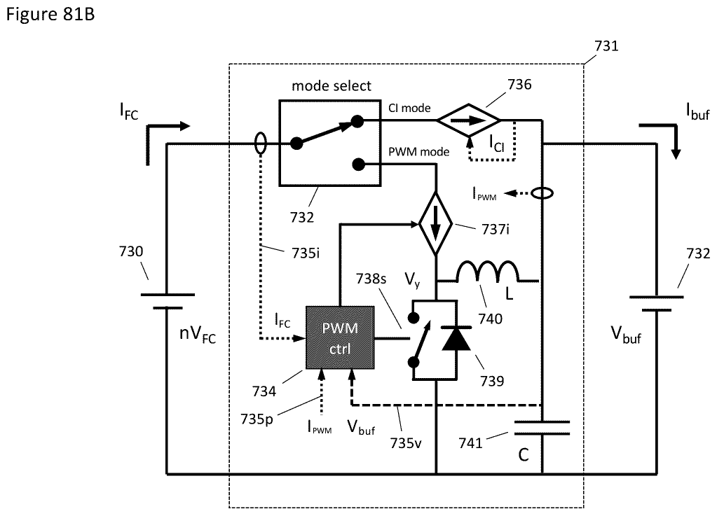

Another embodiment of the QXR charge transfer regulator comprises a multi-mode circuit combining linear circuitry with a novel implementation of PWM regulation involving current-limited pulse width modulation, also referred to herein as current clamped pulse width modulation. The disclosed current clamped modulation method exemplified by the schematics in FIG. 81A and FIG. 81B are antithetical to the the normal philosophy of switch mode power conversion. The pulsed mode QXR disclosed herein is neither a conventional linear regulator nor a switch mode regulator.

To clarify, conventional design philosophy in power electronics teaches that by pulsing switches on-and-off a DC/DC converter can achieve higher efficiencies and lower power loss than using linear regulation. Specifically linear regulation methods employ a current-control element called a pass transistor to regulate of limit the current flow between the current regulator's input and output. Linear control can be used for current regulation or voltage regulation. In a linear voltage regulator, for example, pass transistor current is controlled by voltage sensing and feedback to produce a desired regulated output voltage. In a linear current regulator, pass transistor current is controlled by current sensing and feedback to produce a desired regulated output current. In either voltage or current regulation, the pass transistor carries a continuous current I_{L} while supporting a voltage differential AV=(Vᵢₙ−Vₒᵤₜ) between its input and output. By Kirchhoff's voltage law, a regulator supporting a voltage differential ΔV and simultaneously carrying a load current I_{L} necessarily dissipates power Pₗₒₛₛ=I_{L}ΔV, meaning the larger the voltage differential ΔV, the greater the power loss. As such, linear regulators therefore only work well at low current or over small voltage differentials.

In contrast, a switching regulator has two operating modes, on, i.e., conducting, where a transistor carries current operating as a low resistance switch, and an off state when no current flows into the converter. Power loss is minimal in both states. Importantly in a switching regulator power loss does not depend on the input-to-output voltage differential like it does in linear regulator. In its operation, input power is not transferred directly to an electrical load but into an inductor which behaves like a lossless current source to provide power to the load. During its off-state of duration t_{off} the input switch in a switching converter is off meaning I_{sw}=0 and no power is lost in the input switch. During its on-state of duration tₒₙ the converter's input switch conducts current I_{sw} equal to the current in an inductor, sustaining a voltage V_{sw}=I_{sw}R_{DS} and dissipating instantaneous power Pₗₒₛₛ=I_{sw}²R_{DS}. The power loss in the switch thereby depends only on the inductor's current, the resistance of the switch, and the fraction of the time the switch is on known as its duty factor D where D=(tₒₙ/(tₒₙ+t_{off}). The average power loss in the switch is therefore Pₗₒₛₛ=D(I_{sw}²R_{DS}), an amount which can be reduced by using a larger lower resistance power MOSFET as the switch.

A switching converter, however assumes its input is a stiff voltage source. A stiff voltage source is a power supply that does not substantially change with the current it delivers. As described previously, a fuel cell is not a stiff voltage source. As discussed previously, the effective voltage of a fuel cell varies significantly with current varying from 0.9V to as low as 0.15V. Therefore, a conventional switching regulator cannot be reliably powered by a fuel cell because the fuel cell voltage drops as current demand increases.

As an alternative, we disclose herein a PWM pulse width modulated QXR charge transfer regulator comprising a switching converter with current limited pulses. The current pulses are controlled both in duration and in the magnitude of current to avoid voltage sag in the fuel cell and overcharging of the buffer. Shown in FIG. 81A, a dual-mode QXR charge transfer regulator 731 charging buffer 732 from fuel cell stack 730 comprises a linear current regulator 736 and a pulse width modulated (PWM) converter comprising PWM controller 734, power MOSFET 737, rectifier 739, optional synchronous rectifier power MOSFET 738, and low-pass filter capacitor 741. A mode select switch 732 determines where charge transfer occurs through linear current regulator 736 or through the PWM regulator.

To prevent overcurrent during charge transfer from the fuel cell to the buffer in PWM mode, the pulsed power MOSFET 737 must operate in linear mode as a current source, not as a switch. In pulsed linear mode, the MOSFET intentionally sustains more voltage than a conducting switch would in a conventional switching regulator. In this sense the disclosed current-limited switching regulator may be considered as a pulsed linear regulator, not a linear regulator and not a PWM regulator.

In order to perform the requisite functions of a QXR charge transfer regulator, PWM controller 734 requires three input. Voltage feedback 735v is used to monitor the output voltage across capacitor 741 to prevent causing an overvoltage condition on buffer cell 732. Input current monitor 735i monitors the fuel cell current to ensure its maximum current specification in not exceeded. PWM current sense 735p measures current I_{P}WM to ensure the average charging current I_{buf} does not exceed the specified limit of buffer 732. If the area mA_{FC}of fuel cell 730 is small, the fuel cell current will be the limiting factor whereby I_{FC}feedback 735i is sufficient to regulate the pulse current and PWM current feedback 735p can be eliminated. Conversely if the fuel cell is large in area, then the fuel cell current I_{FC} feedback 735i is unnecessary and the pulse current limit is determined by PWM current feedback 735p. If the fuel cell is intermediate, then both feedback signals are required where the more restrictive current is used to set the maximum current.

FIG. 81B illustrates the functional equivalent circuit of the current limited pulse width modulated QXR charge transfer regulator where power MOSFET 737 is replaced by a pulsed current regulator 737i and optional synchronous rectifier MOSFET 738 is replaced by switch 738s. Unlike the converter power MOSFET 737 which must be current limiting, the synchronous rectifier MOSFET 738 can operate in switch mode because it does not determine the current flowing in inductor 740 or affect the current I_{FC} drawn from fuel cell stack 730, it simply reduces power losses in rectifier 739.

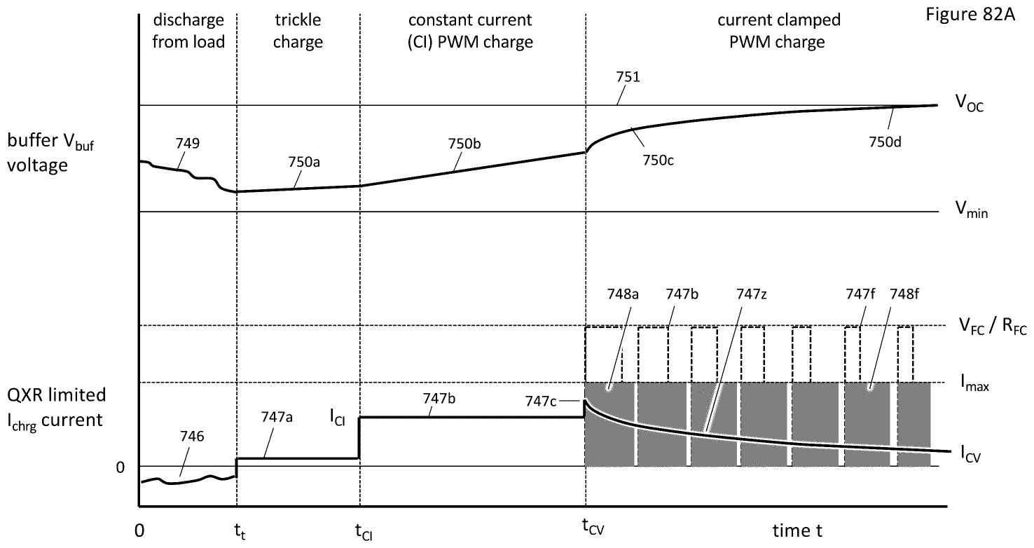

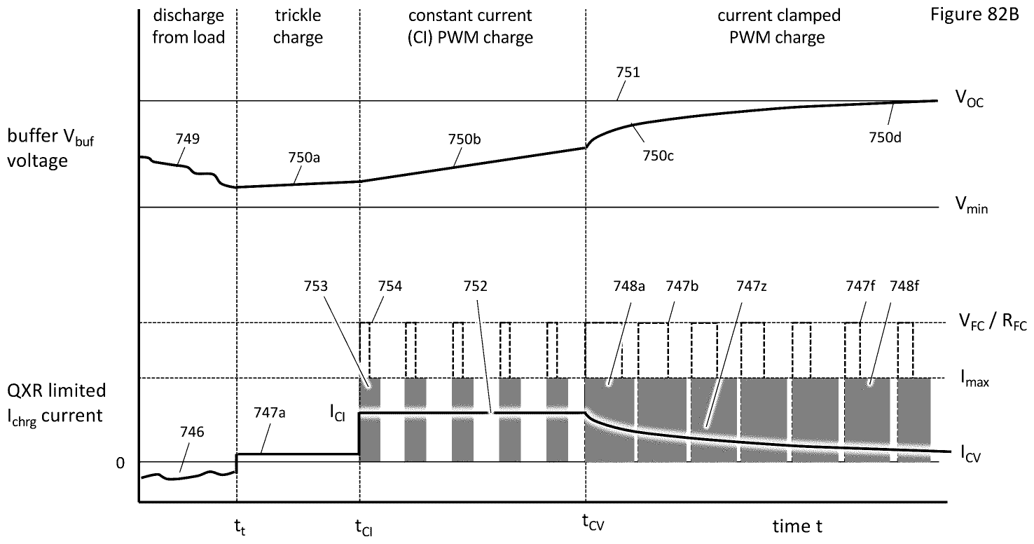

FIG. 82A illustrates the voltage and current waveforms of the disclosed multi-mode PWM QXR in various time intervals. During the interval 0 to time tₜ, the buffer cell 732 is discharged by an unspecified electrical load with current 746 causing a decline 749 in buffer voltage V_{buf}(t). So long that V_{buf}(t)>Vₘᵢₙ the fuel cell operates normally. At time tₜ the QXR operates as a low voltage linear current source of magnitude 747a called trickle charging mode or pre-charge mode causing a slow but gradual increase 750a in buffer voltage V_{buf}(t). If the buffer voltage exceeds a specified value, trickle charge can be eliminated. Trickle charging can be performed using a separate current source similar to 736 connecting the QXR input and output through a 1P3P three-position mode select switch 732 or alternatively implemented using two different current multiplier ratios of current feedback signal I_{CI} in linear current regulator 736. The trickle charging rate is typically 10% of the constant current charging rate, e.g., a C-rate of 0.1C.

At time t_{CI} the QXR commences constant current charging 747b at a current I_{CI} resulting in a linear increase in battery voltage 750b. The charging current may be as high as 1C so long that the buffer cell doesn't overheat. Depending however on the fuel cell area mA_{FC} and environmental conditions such a temperature and relative humidity, the fuel cell may be unable to deliver such a fast charge rate, in which cause pulse currents will be determined by the feedback signal 735i.

At time t_{CV} the QXR switches into a constant-voltage PWM mode charging. Unlike the CI constant current mode with its linear charging profile, CV mode charging exhibits an asymptotic charging profile starting rapidly 750c at first then slowing down 750d as the voltage approaches the maximum charge voltage shown by V_{OC} limit 751. During this mode the instantaneous QXR current I_{PWM} charging buffer cell 732 comprises pulses of varying duration 748a, 748f limited in magnitude to a value Iₘₐₓin accordance with the described current feedback signals. The resulting averaged current profile ICV comprises an exponential decay 747z commencing at a starting value 747c which may manifest some small discontinuity above or below the constant current 747b charging value I_{CI} at the moment of mode-switching at time t_{CV}. Note that without current limiting, i.e., in switch mode operation, the idealized current pulses 747b, 747f are significantly higher in magnitude and shorter in duration that current limited pulse operation. As shown in switch mode operation the idealized current pulses 747b, 747f have a value set by the fuel cell voltage V_{FC} and the switch resistance R_{DS}, not by current limit Iₘₐₓ.

While FIG. 82A illustrates pulse mode operation only in the constant voltage charging phase and linear charging in the constant phase, the current clamped PWM QXR circuit can also be adapted to perform pulsed mode operation during the constant current charging phase between time t_{CI} and t_{CV} as depicted in FIG. 82B. Using current feedback rather than voltage feedback, a constant average current 752 of magnitude I_{CI} can be emulated by a pulse string until a target voltage is reached at time t_{CV}. As in the CV mode, the pulses 753 are limited in magnitude to a value Iₘₐₓwell below their switch mode equivalent 754 so as to not exceed the maximum current limit of either the fuel cell input or buffer cell output of the QXR. Because the QXR charge transfer regulator is operating in pulse mode throughout both the CI and CV intervals, not current discontinuity occurs at time t_{CV}.

In conclusion, as multiple embodiments of this invention, either linear mode, pulse modulation, or multi-mode methods can be used to implement charge transfer regulator operating in constant-current or constant-voltage mode buffer charging, provided that feedback control is used to limit the pulse current magnitude Iₘₐₓ below the maximum specified fuel cell current and the maximum buffer charging current, whichever is lower. In all cases, the voltage V_{buf}(t) of the buffer cell can never exceed its overcharge safety limit V_{OC}.

BFC Charging Performance. Aside from providing safety features and improving the ability to deliver orders-of-magnitude higher currents at a lower impedance than state-of-the-art present day conventional fuel cells, another key feature of the buffered fuel cell is ability to function as a self-charging battery. This feature means the BFC can recharge itself after being depleted from powering an electrical load or conversely can augment steady state current flowing to a load while maintaining or at least minimizing the charge drain on its buffer cell.

For simplicity's sake, the charging of a discharged buffer cell from electricity generated by the fuel cell can be measured in terms of current in amperes, as current in terms of C-rate, or measured in time as the inverse of the charging C-rate. For example a 2C charge rate means the fuel cell can charge an unloaded buffered fuel cell from its nominal value to full charge in 30 minutes. The buffer charging current depends on a number of number of variables, namely
The starting voltage of the discharge buffer cell, i.e., Vₙₒₘ.
The number of series connected fuel cells n in a stack.
The fuel cell voltage V_{FC} as a function of electrochemistry, PEM and FEA manufacturing, temperature, and humidity.
The headroom ΔV_{chg}defined by the charging supply voltage V_{chg} and the buffer cell's state of charge where the charging voltage V_{chg} supplied by the fuel cell during charging may exceed the overcharge safety limit, i.e., where V_{chg} >V_{OC} at least until the buffer voltage reaches the overcharge voltage when the QXR clamps the voltage.
The QXR “regulated” current determined by the more restrictive of either the maximum fuel cell current density or the maximum charging C-rate of the buffer cell, typically at I_{buf}=2C.
The capacity and topology of the buffer cell or cells.

These factors are described in detail in three dimensional response surfaces describing various BFC designs. The following response surfaces cover a range for fuel cells having an area of 1 cm² or m=1 to 50 cm² or m=50. Consistently throughout the response surfaces the value reported in each row-column intersection of the graph represents the fuel cell array current in units of either amperes or C-rate where the x-axis represents discrete steps in fuel cell voltage V_{FCa}nd the y-axis describes the number of series connected cells n in a FC stack.

In the response surface peak currents are based on CV charging of buffer at starting voltage of V_{buf}=3.6V. In depicted in the graphs, cells shown in black indicate charging conditions requiring voltage clamping at V_{OC}; cells shaded gray indicate inability to charge due inadequate headroom, i.e., undervoltage where V_{chg} 3.6V; spotted cells indicate conditions exceeding fuel cell current densities of 0.2 A/cm²; and patterned cells indicate buffer currents limited to 2C charge rates for a buffer having a capacity Q=3 Ah. The corresponding stack resistance equal to (n/m)R_{FC} is included on the right side of the response surface graph as a reference for each value of n assuming R_{FC}=1.20 for a single fuel cell.

The response surfaces to follow include various parameters including
Unregulated peak current in units amperes A.
Unregulated peak current density in units of A/cm².
Fuel cell limited peak current in units of amperes A.
Buffer limited peak current in units of amperes A.
Regulated peak buffer current in units of C-rate.

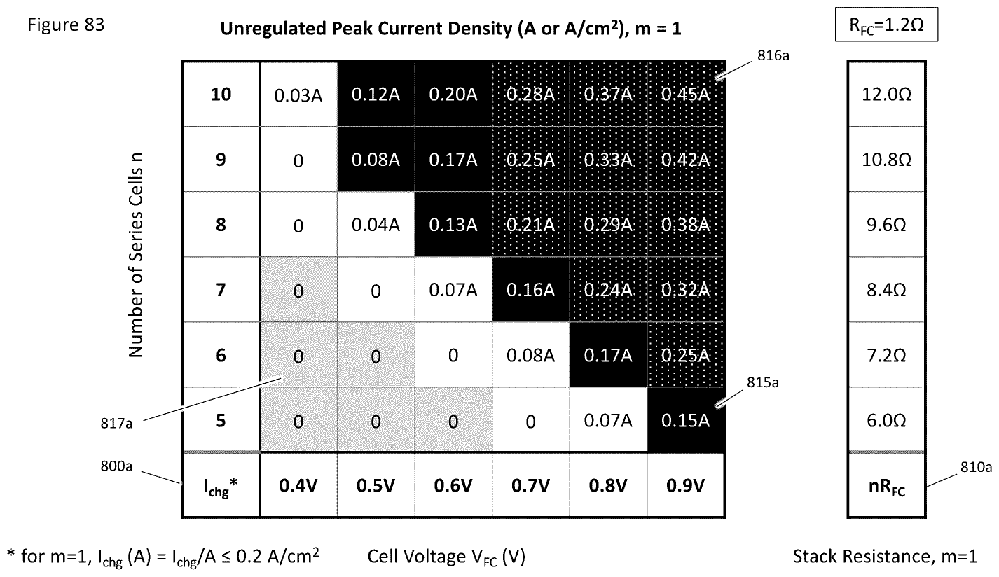

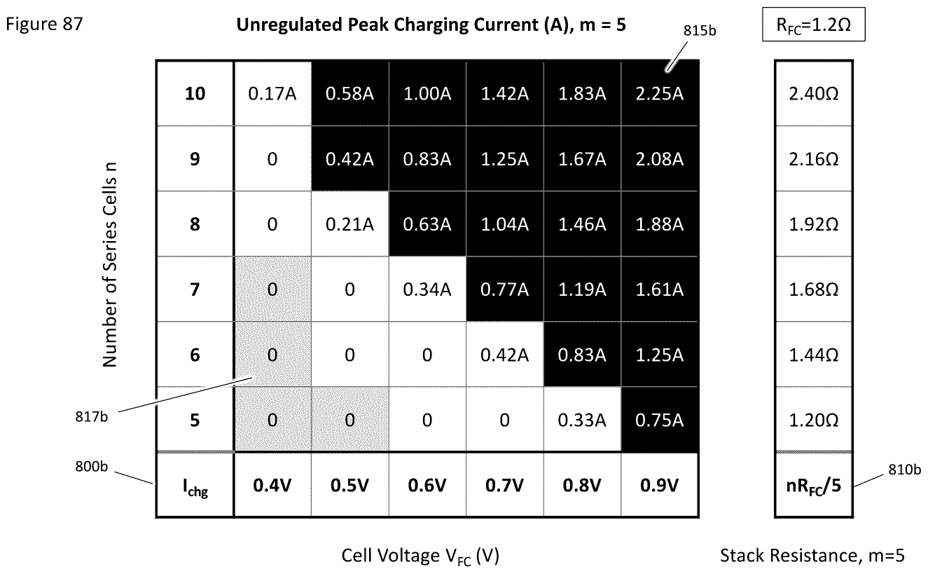

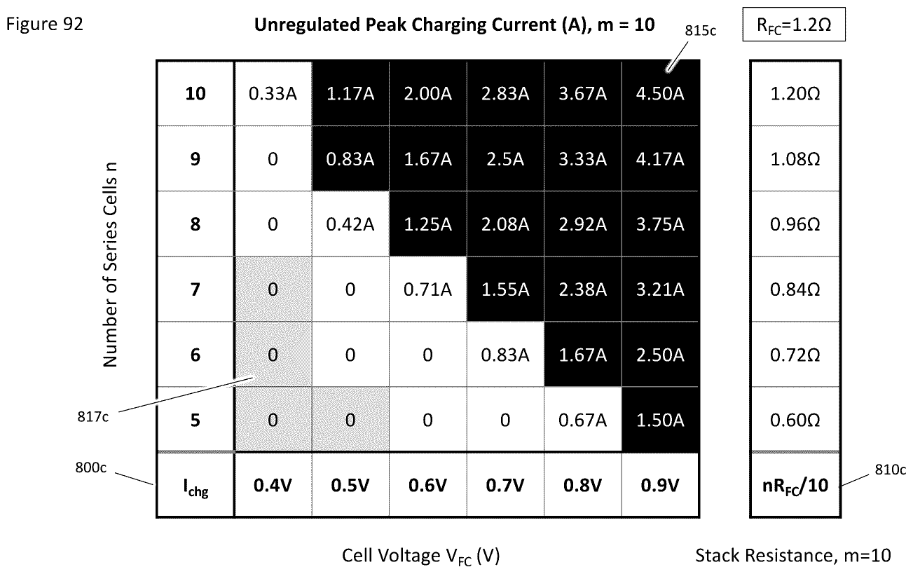

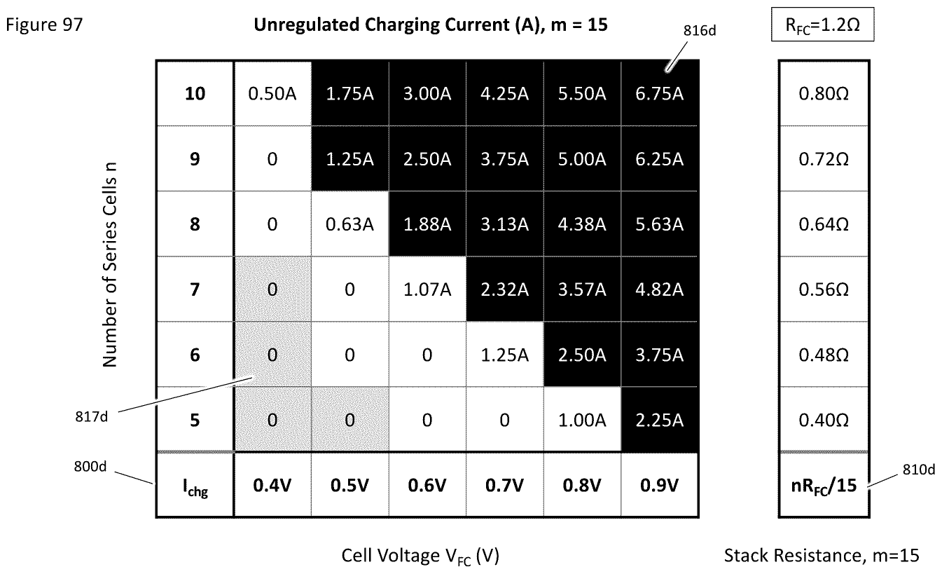

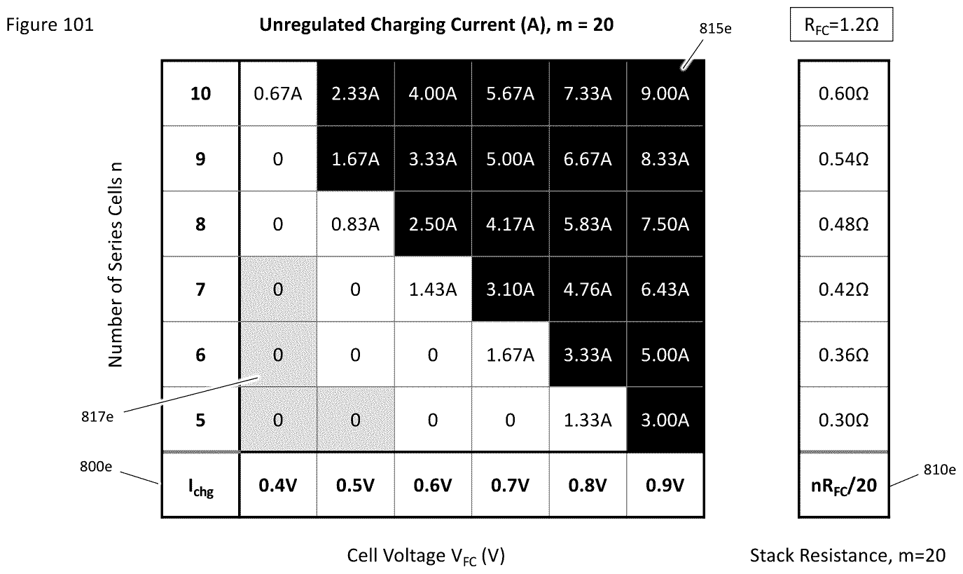

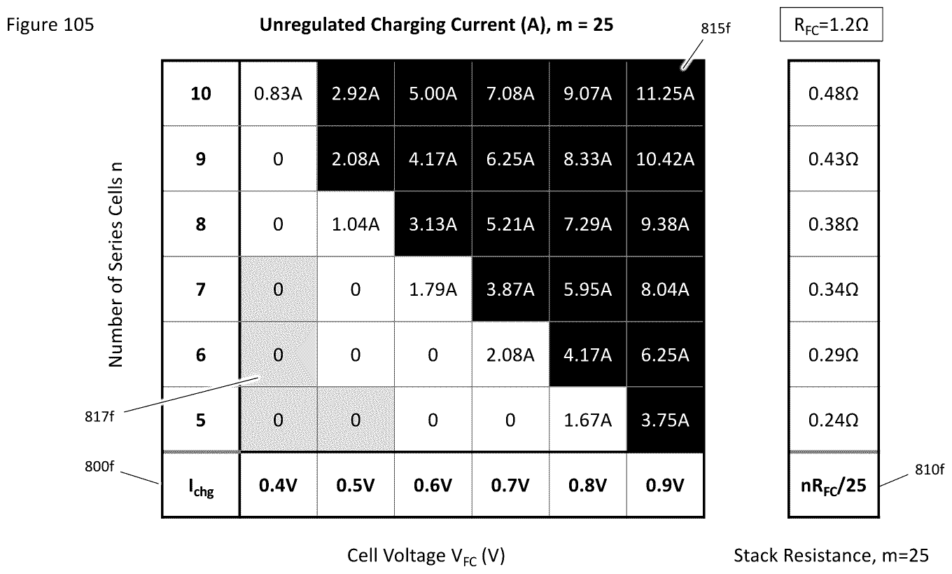

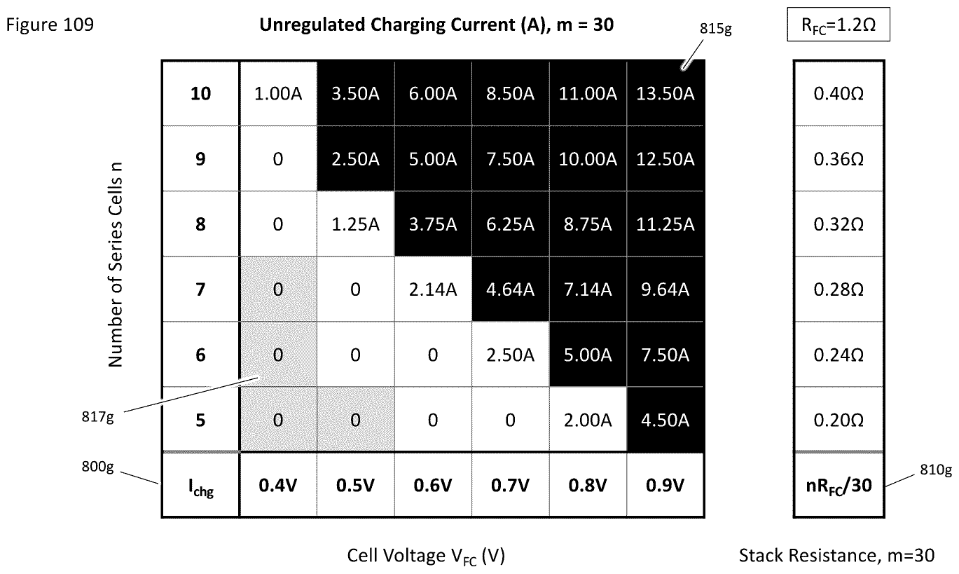

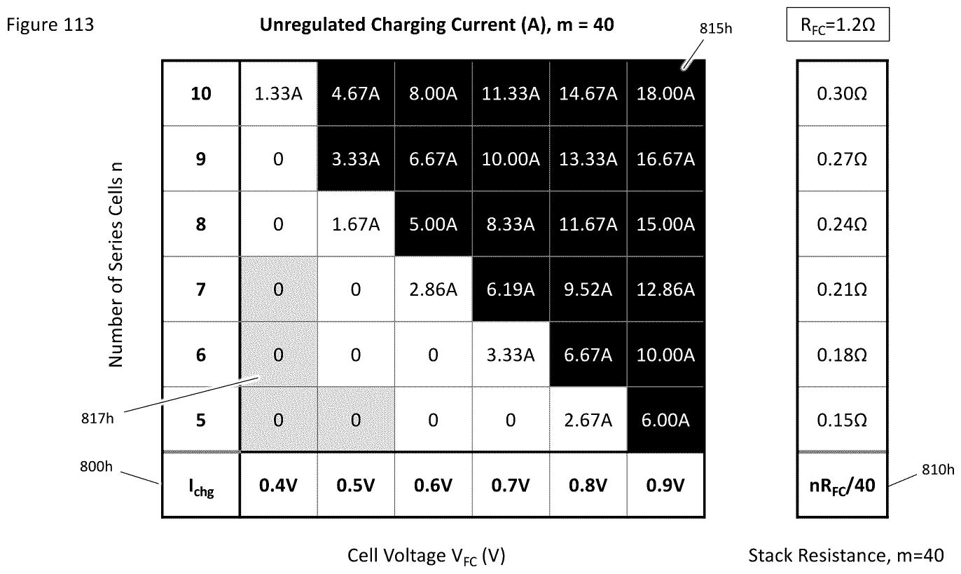

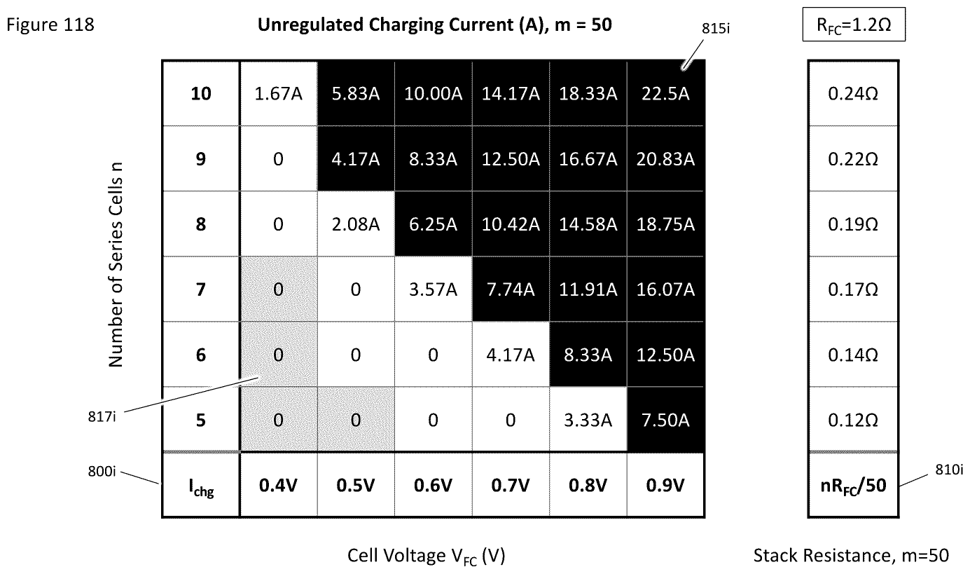

Not every fuel cell topology includes all the above graphs. The term peak means the highest current under a given set of conditions. Regulated current refers to the current limiting function of the QXR charge transfer regulator. C-rate is referenced to a standard 18650 cell with 3000 mAh capacity. All tables are referenced to room temperature at 1 atmosphere pressure, i.e., 1 bar. The following slides are arranged by group for different fuel cell arrays. They include the following:
m=1 fuel cell array shown in FIG. 83 to FIG. 86;
m=5 fuel cell array shown in FIG. 87 to FIG. 91;
m=10 fuel cell array shown in FIG. 92 to FIG. 96;
m=15 fuel cell array shown in FIG. 97 to FIG. 100;
m=20 fuel cell array shown in FIG. 101 to FIG. 104;
m=25 fuel cell array shown in FIG. 105 to FIG. 108;
m=30 fuel cell array shown in FIG. 109 to FIG. 112;
m=40 fuel cell array shown in FIG. 113 to FIG. 117; and
m=50 fuel cell array shown in FIG. 118 to FIG. 122.

Although a useful comparative figure-of-merit for a buffered fuel cell delivering power to a dead short is the equation nV_{FC}/nR_{FC}, the equation does not describe the internal operation of the BFC. Instead, a fuel cell stack must charge the buffer cell at a voltage sufficient to actually store a meaningful quantity of charge and electrical energy in the cell. If we assume the charging must deliver a voltage Vₙₒₘ, then the peak charging current is defined by the headroom between the fuel cell stack voltage and the nominal charging voltage divided by the series resistance of the fuel cell stack nR_{FC}. The applicable charging equation becomes

$${I}_{FC} \leq ( {nV}_{FC} - {V}_{nom} ) / {nR}_{FC}$$

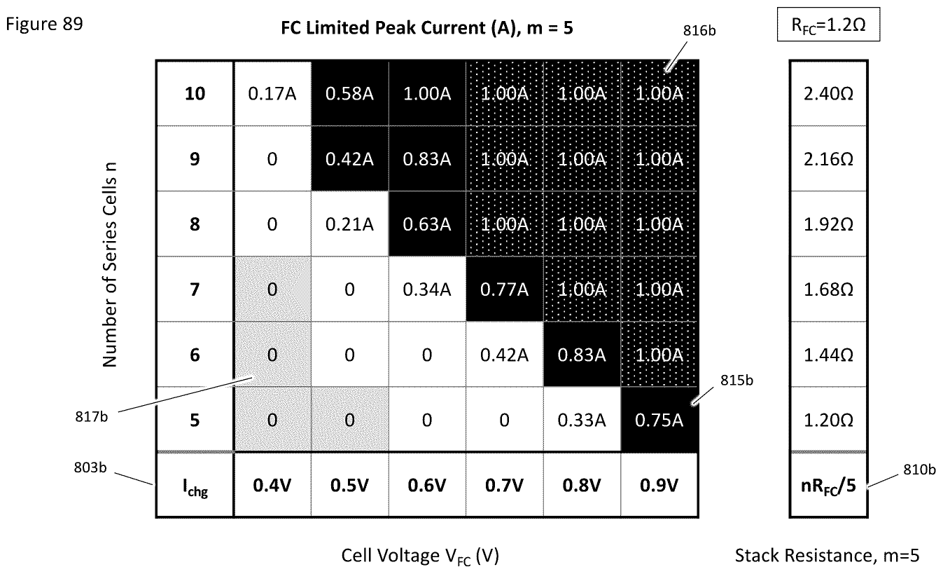

1 where Vₙₒₘ=3.6V. For example, a 5s5p square fuel cells has a resistance (n/m)R_{FC}=(5/5)1.2Ω=1.2Ω, then the peak current when commencing charging is I_{FC}=(5V_{FC}−3.6V)/1.2Ω. If V_{FC} is 0.9V, then nV_{FC}=4.5V and the headroom (4.5V−3.6V)=0.9V. The corresponding charging current is then 0.9V/1.20=0.75 A. This calculation can be confirmed by referring to cell (V_{FC}, n)=(0.9V, 5) in response surface 803b of FIG. 89 to follow. The first set of graphs describe m=1 fuel cell arrays. FIG. 83 illustrates the response surface 800a depicting unregulated QXR currents for arrays ranging from n=5 to n=10 and cell voltages ranging from V_{FC}=0.4V to V_{FC}=0.9V. Fuel cell currents I_{FC}(t) are calculated using a nominal charging voltage of Vₙₒₘ=3.6V and the resistances shown in table 810a ranging from 6.0Ω to 12.0Ω corresponding to values of n ranging from 5≤n≤10. As noted, numerous cells are unable to source meaningful amounts of current and are recorded as 0 in the table because the fuel cell stack voltage does not exceed Vₙₒₘ. This doesn't mean that the fuel cell can't re-charge a deeply discharged cell but that the stored energy from charging will be minimal. Gray cells 817a do not produce a sufficiently adequate voltage to charge a Li-ion cell as a buffer. Black cells 815a and spotted cells 816a represent condition where the fuel cell array exceeds buffer V_{OC} and requires voltage clamping.

Spotted cells 816a also represent cell that exceed the maximum allowed fuel cell current density of 200 mA/cm² or 0.2 A/cm². Note that when m=1, the fuel cell area A_{FC}=1 cm² whereby the value of current in units of amperes A and current density in units of A/cm² are identical numerically. This convenience is true only for m=1 response surfaces. In all other response surfaces the current and current density graphs are split into two separate graphs. An adjunct to response surface 800a is a table 810a listing the fuel cell stack resistance nR_{FC} against the number of cells n in the stack as arranged by row. The resistance of an individual cell is assumed constant at R_{FC}=1.2Ω.

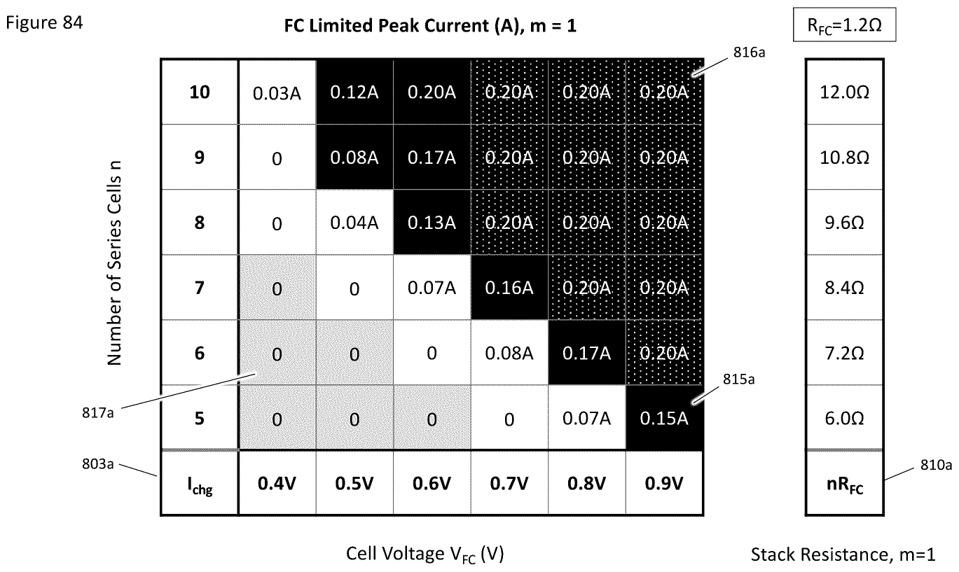

The response surface 803a of FIG. 84 describes peak currents are limited to 0.2 A/cm² by the fuel cell. Black cells 815a and spotted cells 816a highlight conditions where the fuel cell array exceeds buffer V_{OC} and requires voltage clamping. Spotted cells 816a also represent cells that exceeded the maximum allowed fuel cell current density and were limited by the QXR to 200 mA/cm² or in absolute current to 0.2 A. Some cells such as (V_{FC}, n)=(0.6V, 10) operate at 0.2 A naturally without the need for current limiting. As such these cells are not highlighted by spots.

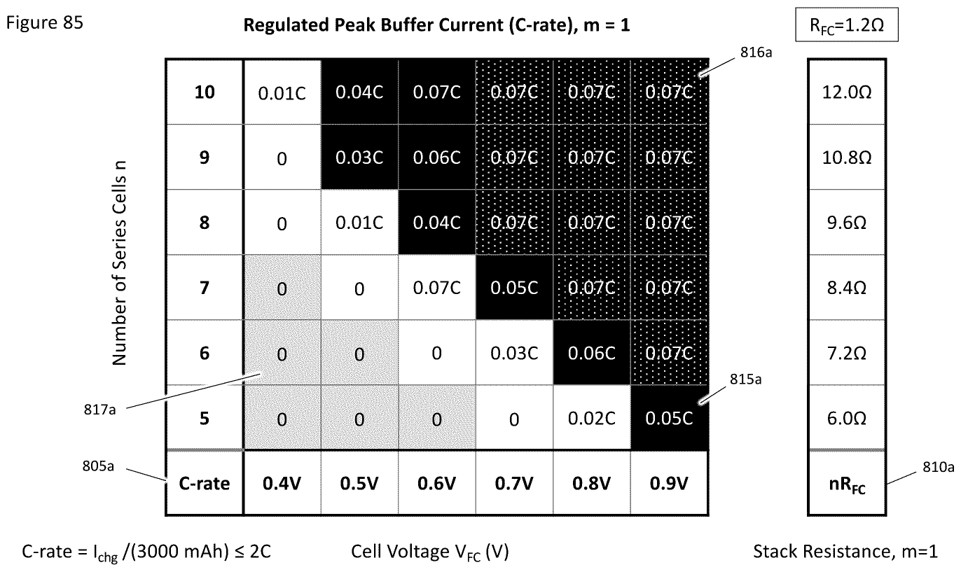

FIG. 85 illustrates response surface 805a depicting the peak buffer charging current described in units of C rate defined by C-rate=I_{chg}/(3000 mAh)≤2C. Because the highest currents shown are limited by the maximum fuel cell density in spotted cells 816a, these current are far below the 2C limitation for charging a 3 Ah buffer cell. In other words, for a m=1 fuel cell, the fuel cell's ability to source current limits the recharge rate of the buffer, not the battery.

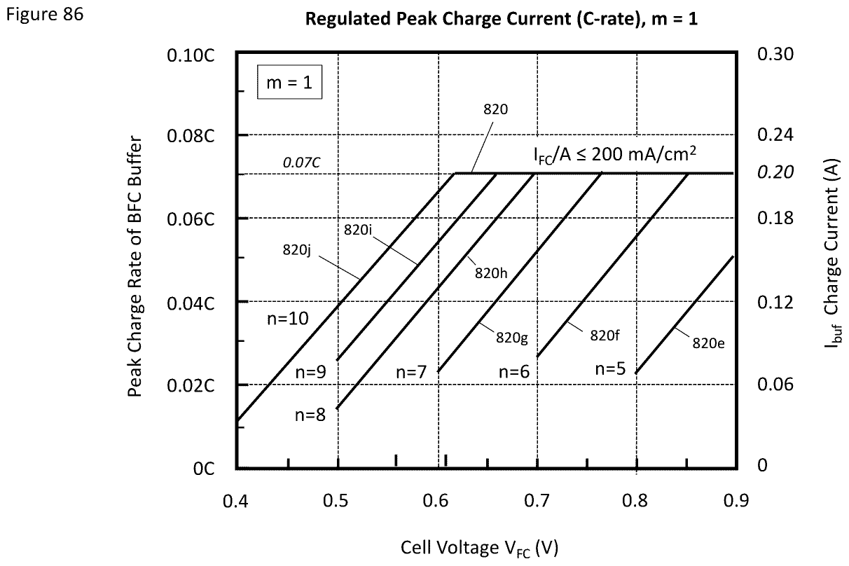

The graph of FIG. 86 illustrates the peak self recharging rate of a 1 cm² unloaded buffered fuel cell in both amperes and C-rate as a function cell voltage varied parametrically by the number of series cells in the stack. Each curve represents a specific value of n, where curves 820e, 820f, 820g, 820h, 820i, and 820j correspond cells stacks of n=5, 6, 7, 8, 9, and 10 respectively. All curves merge to a maximum value shown by horizontal line 820 corresponding to a maximum fuel cell current density of 200 mA/cm². The resulting peak current—a mere 0.2 A or 0.07C is not very useful. As expected, in the m=1 array no conditions exceed safe 2C buffer charge rate limitations. To recapitulate, fuel cell areas of 1 cm² or m=1 while too small to be useful for many applications are valuable because the values of current in amperes and current density in A/cm², are numerically identical differing only by their corresponding units. As such m=1 data is useful when analyzing scaling of cells to higher currents and larger areas.

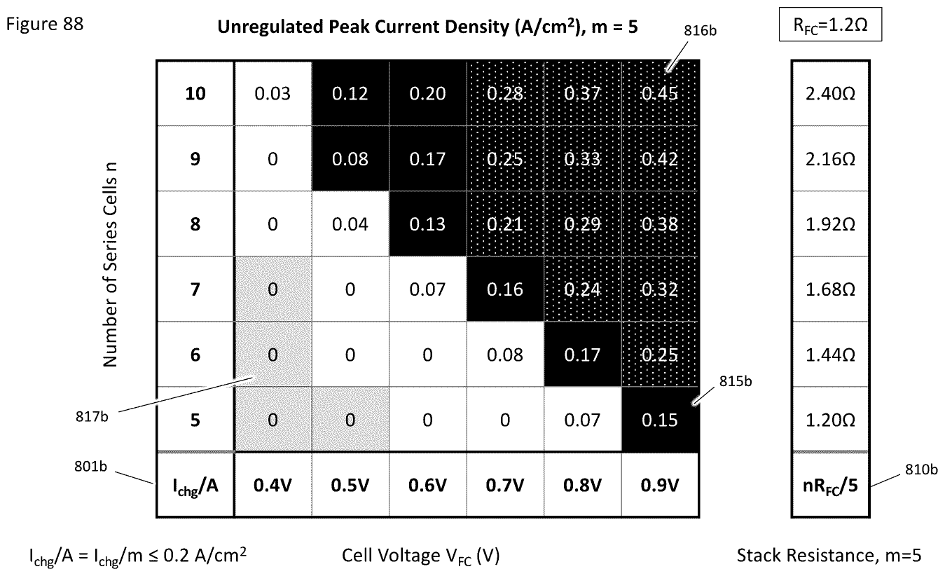

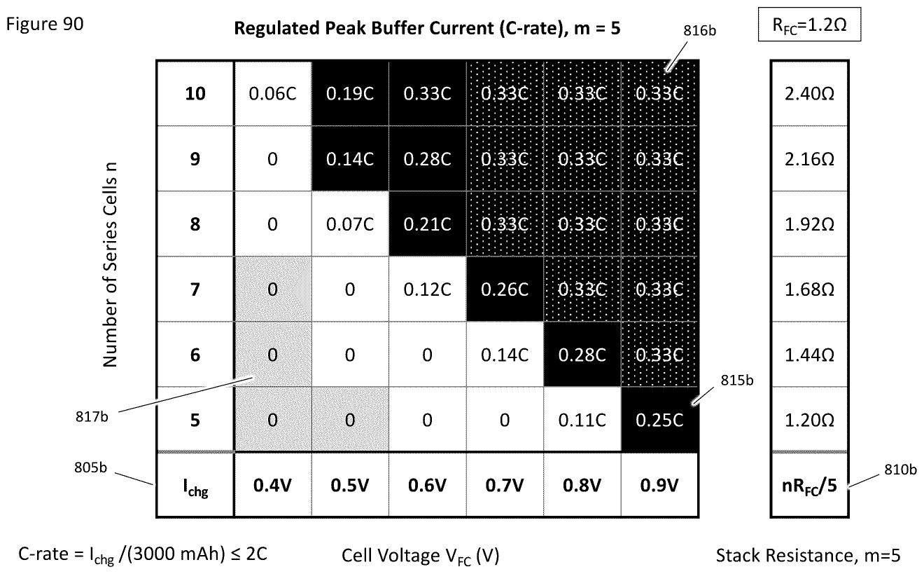

The second set of graphs describe m=5 fuel cell arrays, i.e., fuel cells where A_{FC}=5 cm². Accordingly FIG. 87 illustrates the response surface 80b depicting unregulated QXR currents for arrays ranging from n=5 to n=10 and cell voltages ranging from V_{FC}=0.4V to V_{FC}=0.9V. Fuel cell currents are calculated using a nominal charging voltage of Vₙₒₘ=3.6V with resistances shown in table 810b spanning 1.20-to-2.40 corresponding to values of n ranging from 5 ≤n≤10. Gray cells 817b do not produce a sufficiently adequate voltage to charge a Li-ion cell as a buffer. Black cells 815b represent conditions where the fuel cell array exceeds buffer V_{OC} and requires voltage clamping. Unregulated peak currents reach 2.25 A. FIG. 88 illustrates the response surface 801b of unregulated peak charging current densities. Spotted cells 816b identify conditions exceeding 0.2 A/cm². Shown in response surface 803b of FIG. 89, QXR regulation to 0.2 A/cm² limits peak charging currents to 1A as highlighted by the spotted cells 816b. Converting the currents to C-rate, response surface 805b in FIG. 90 shows the charging current is only 0.33 C, well below the 2C limit.

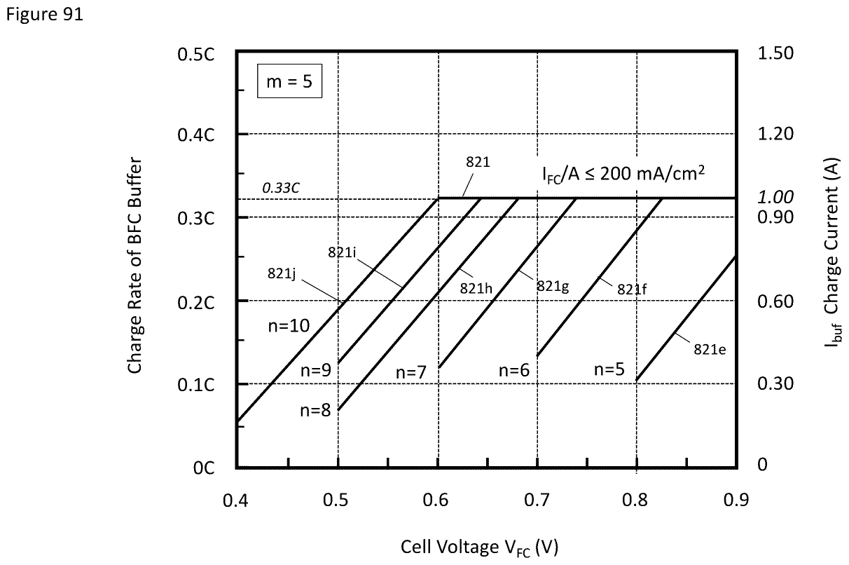

The graph of FIG. 91 illustrates the peak self recharging rate of a 5 cm² unloaded buffered fuel cell in both amperes and C-rate as a function cell voltage varied parametrically by the number of series cells in the stack. Each curve represents a specific value of n, where curves 821e, 821f, 821g, 821h, 821i, and 821j correspond cells stacks of n=5, 6, 7, 8, 9, and 10 respectively. All curves merge to a maximum value shown by horizontal line 821 for a maximum fuel cell current density of 200 mA/cm² corresponding to 1 A or 0.33C.

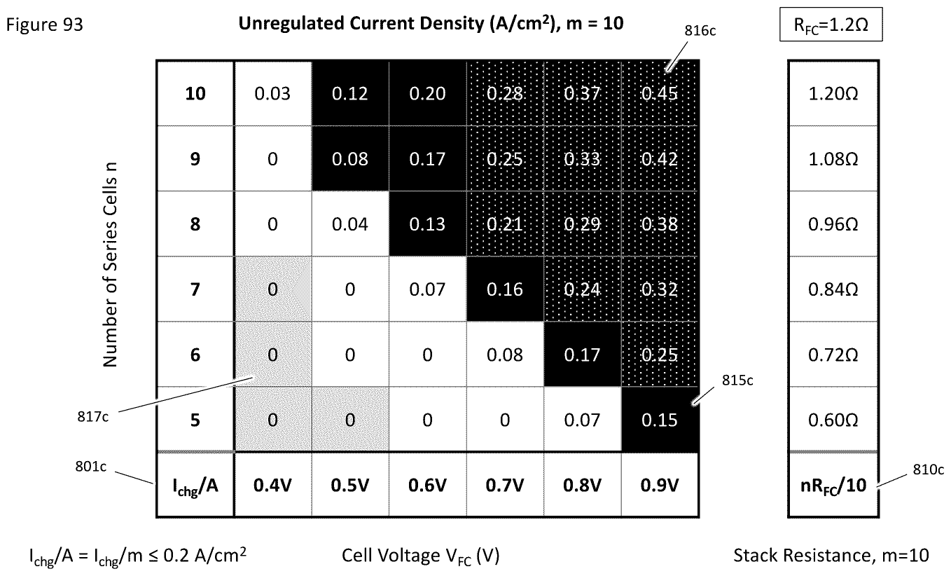

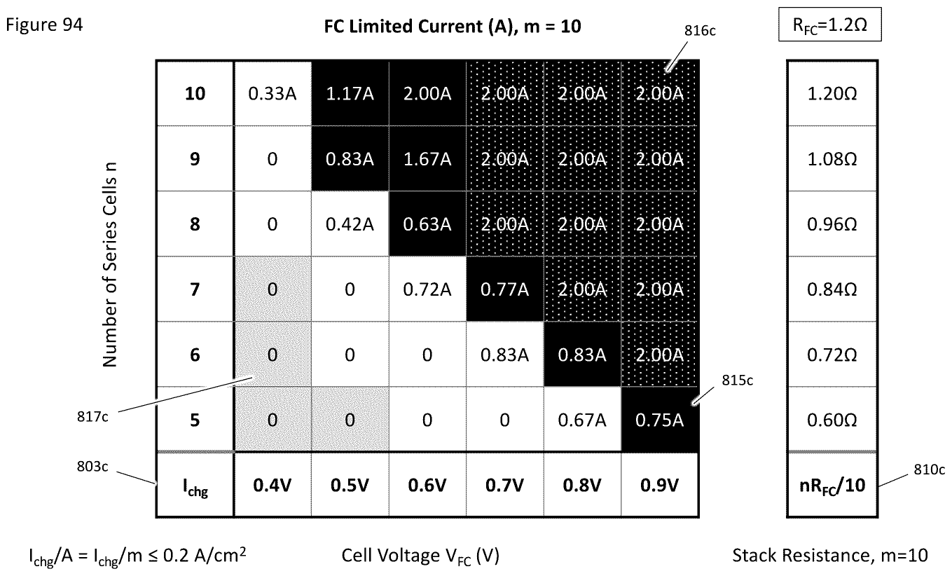

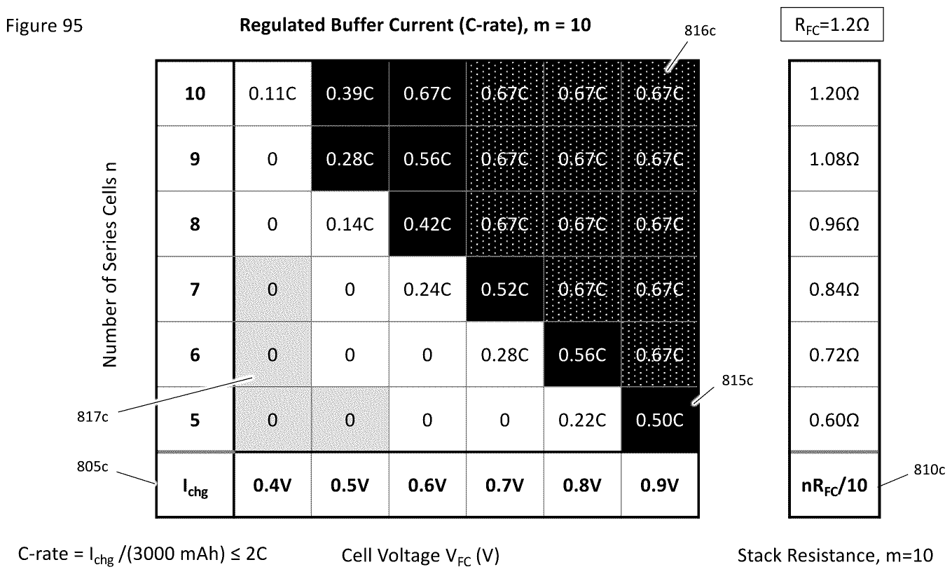

The third set of graphs describe m=10 fuel cell arrays, i.e., where A_{FC}=10 cm². Accordingly FIG. 92 illustrates the response surface 800c depicting unregulated QXR currents for arrays ranging from n=5 to n=10 and cell voltages ranging from V_{FC}=0.4V to V_{FC}=0.9V. Fuel cell currents are calculated using a nominal charging voltage of Vₙₒₘ=3.6V with resistances shown in table 810c spanning 0.60 to 1.20 corresponding to values of n ranging from 5≤n≤10. Gray cells 817c do not produce a sufficiently adequate voltage to charge a Li-ion cell as a buffer. Black cells 815c represent conditions where the fuel cell array exceeds buffer V_{OC} and requires voltage clamping. Unregulated peak currents reach 4.5 A. FIG. 93 illustrates the response surface 801c of unregulated peak charging current densities. Spotted cells 816c identify conditions exceeding 0.2 A/cm². Shown in response surface 803c of FIG. 94, QXR regulation to 0.2 A/cm² limits peak charging currents to 2 A as highlighted by the spotted cells 816c. Converting the currents to C-rate, response surface 805c in FIG. 95 shows the charging current is 0.67 C, well below the 2C limit.

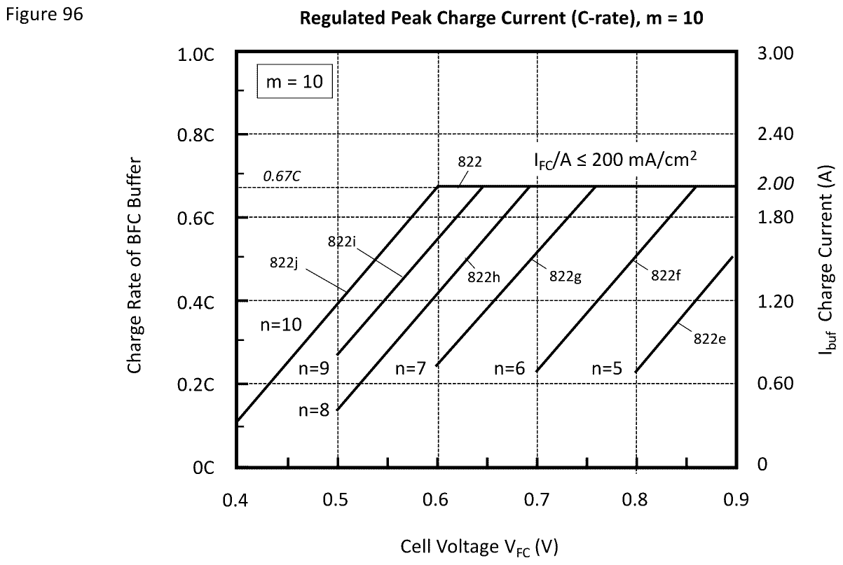

The graph of FIG. 96 illustrates the peak self recharging rate of a 10 cm² unloaded buffered fuel cell in both amperes and C-rate as a function cell voltage varied parametrically by the number of series cells in the stack. Each curve represents a specific value of n, where curves 822e, 822f, 822g, 822h, 822i, and 822j correspond cells stacks of n=5, 6, 7, 8, 9, and 10 respectively. All curves merge to a maximum value shown by horizontal line 822 for a maximum fuel cell current density of 200 mA/cm² corresponding to 2 A or 0.67C.

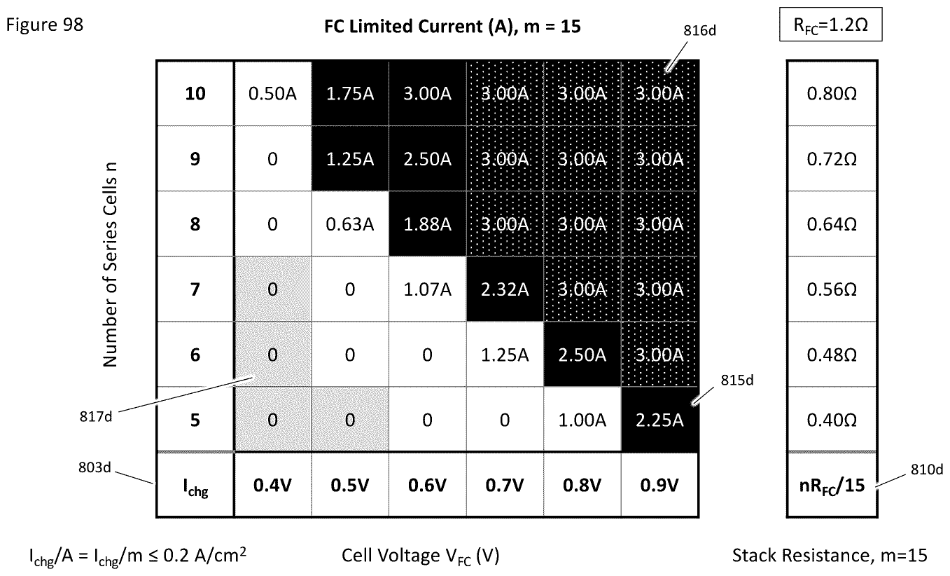

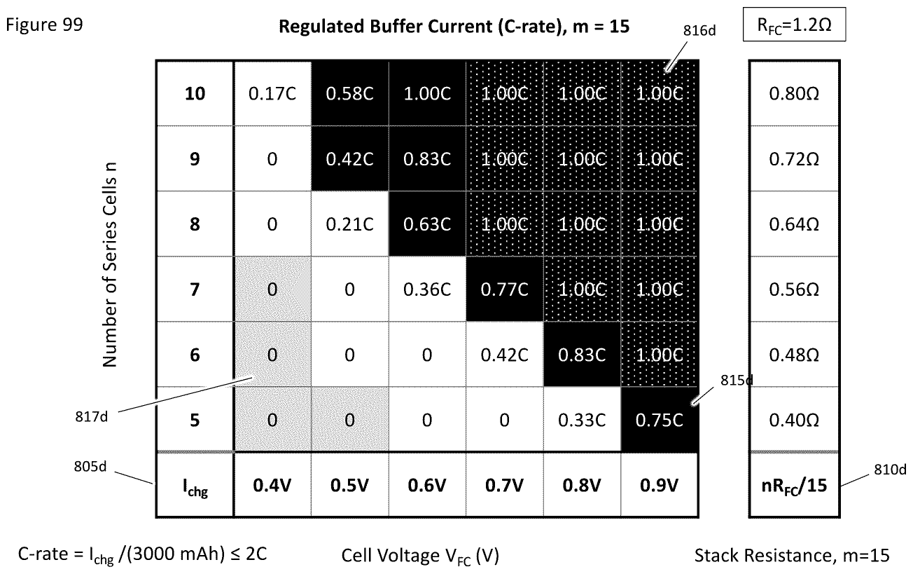

The fourth set of graphs describe m=15 fuel cell arrays, i.e., where A_{FC}=15 cm². Accordingly FIG. 97 illustrates the response surface 800d depicting unregulated QXR currents for arrays ranging from n=5 to n=10 and cell voltages ranging from V_{FC}=0.4V to V_{FC}=0.9V. Fuel cell currents are calculated using a nominal charging voltage of Vₙₒₘ=3.6V with resistances shown in table 810d spanning 0.4Ω to 0.8Ω corresponding to values of n ranging from 5≤n≤10. Gray cells 817d do not produce a sufficiently adequate voltage to charge a Li-ion cell as a buffer. Black cells 815d represent conditions where the fuel cell array exceeds buffer V_{OC} and requires voltage clamping. Unregulated peak currents reach 6.75 A. Shown in response surface 803d of FIG. 98, QXR regulation to 0.2 A/cm² limits peak charging currents to 3 A as highlighted by the spotted cells 816d. Converting the currents to C-rate, response surface 805d in FIG. 99 shows the charging current is 1C, below the 2C limit.

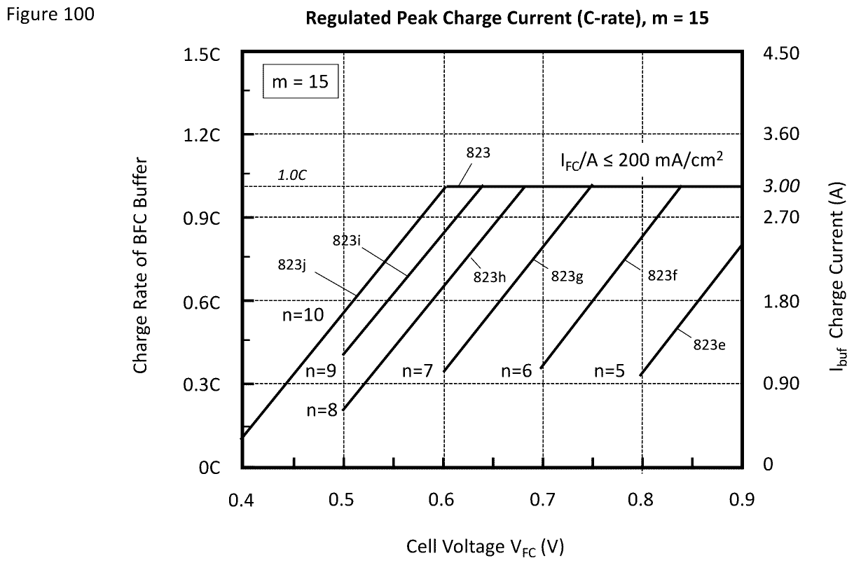

The graph of FIG. 100 illustrates the peak self recharging rate of a 15 cm² unloaded buffered fuel cell in both amperes and C-rate as a function cell voltage varied parametrically by the number of series cells in the stack. Each curve represents a specific value of n, where curves 823e, 823f, 823g, 823h, 823i, and 823j correspond cells stacks of n=5, 6, 7, 8, 9, and 10 respectively. All curves merge to a maximum value shown by horizontal line 823 for a maximum fuel cell current density of 200 mA/cm² corresponding to 3 A or 1.0C.

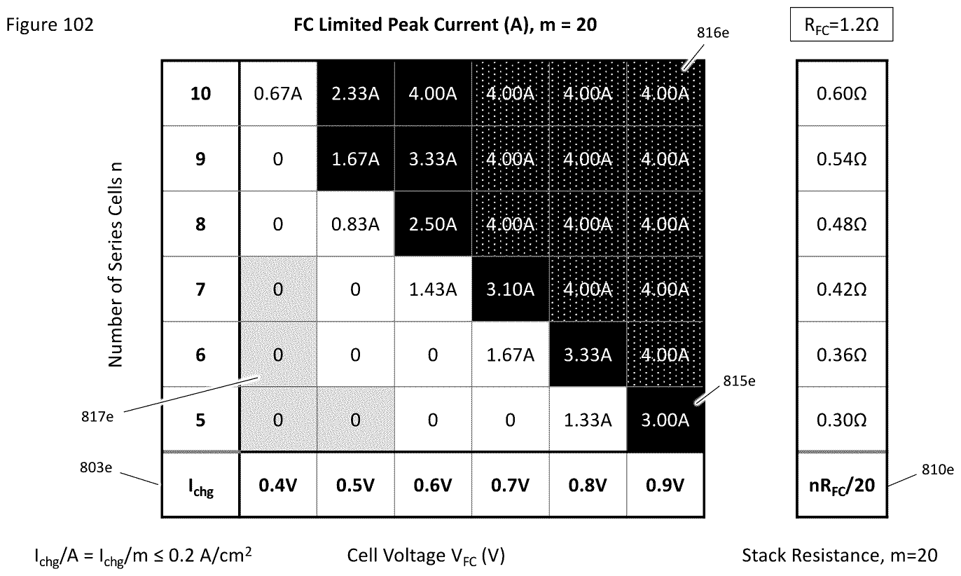

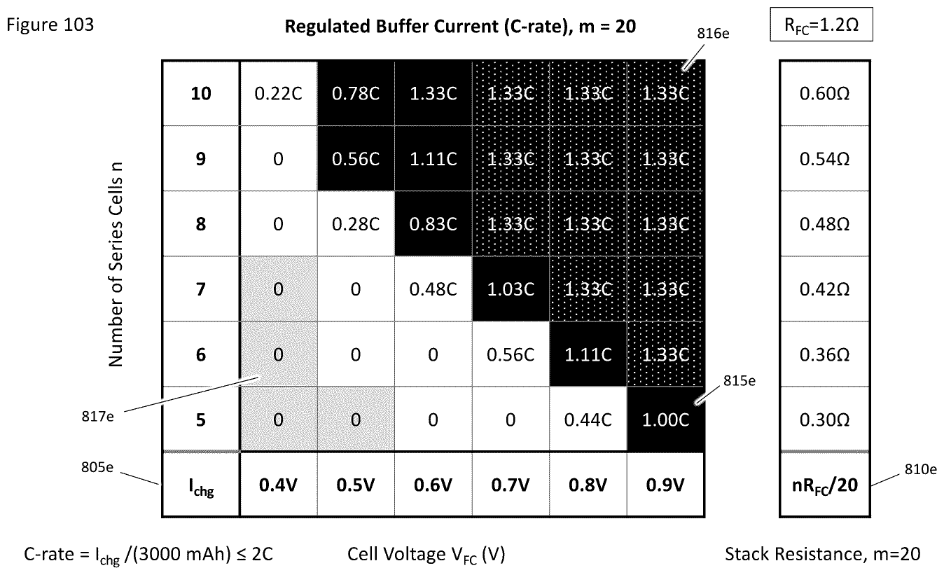

The fifth set of graphs describe m=20 fuel cell arrays, i.e., where A_{FC}=20 cm². Accordingly FIG. 101 illustrates the response surface 800e depicting unregulated QXR currents for arrays ranging from n=5 to n=10 and cell voltages ranging from V_{FC}=0.4V to V_{FC}=0.9V. Fuel cell currents are calculated using a nominal charging voltage of Vₙₒₘ=3.6V with resistances shown in table 810e spanning 0.3Ω to 0.6Ω corresponding to values of n ranging from 5 ≤n≤10. Fuel cell currents are calculated using a nominal charging voltage of Vₙₒₘ=3.6V with resistances shown in table 810c spanning 0.4Ω to 0.8Ω corresponding to values of n ranging from 5 ≤n≤10. Gray cells 817e do not produce a sufficiently adequate voltage to charge a Li-ion cell as a buffer. Black cells 815e represent conditions where the fuel cell array exceeds buffer V_{OC} and requires voltage clamping. Unregulated peak currents reach 9.0 A. Shown in response surface 803e of FIG. 102, QXR regulation to 0.2 A/cm² limits peak charging currents to 4 A as highlighted by the spotted cells 816e. Converting the currents to C-rate, response surface 805e in FIG. 103 shows the charging current is 1.33C, below the 2C limit.

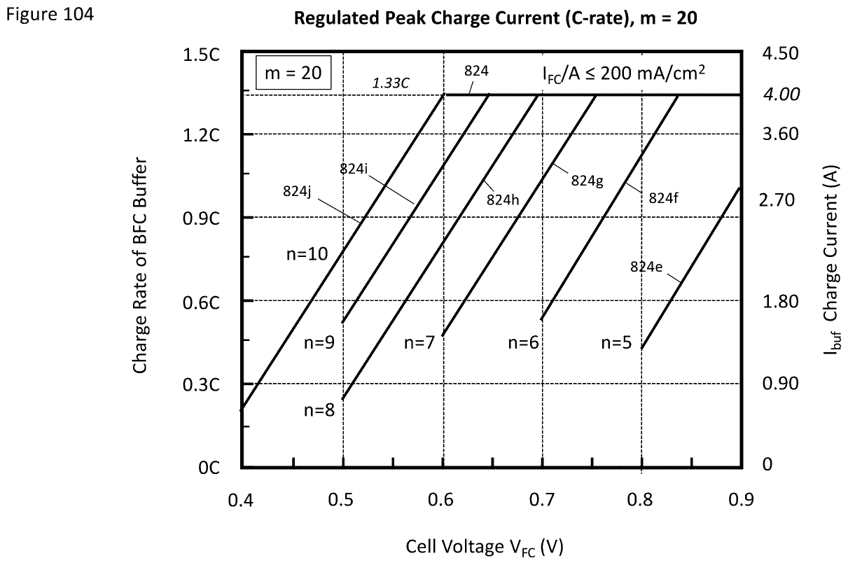

The graph of FIG. 104 illustrates the peak self recharging rate of a 20 cm² unloaded buffered fuel cell in both amperes and C-rate as a function cell voltage varied parametrically by the number of series cells in the stack. Each curve represents a specific value of n, where curves 824e, 824f, 824g, 824h, 824i, and 824j correspond cells stacks of n=5, 6, 7, 8, 9, and 10 respectively. All curves merge to a maximum value shown by horizontal line 823 for a maximum fuel cell current density of 200 mA/cm² corresponding to 4 A or 1.33C.

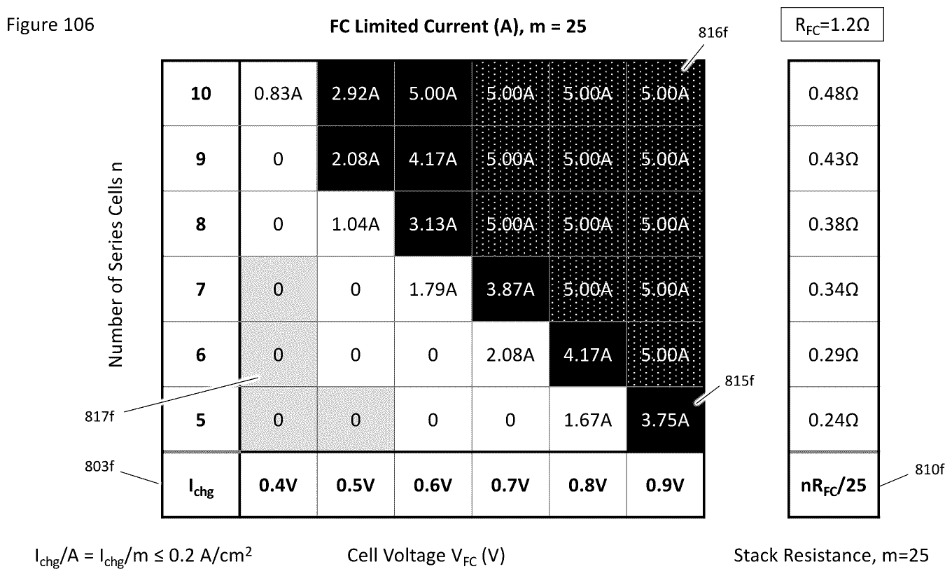

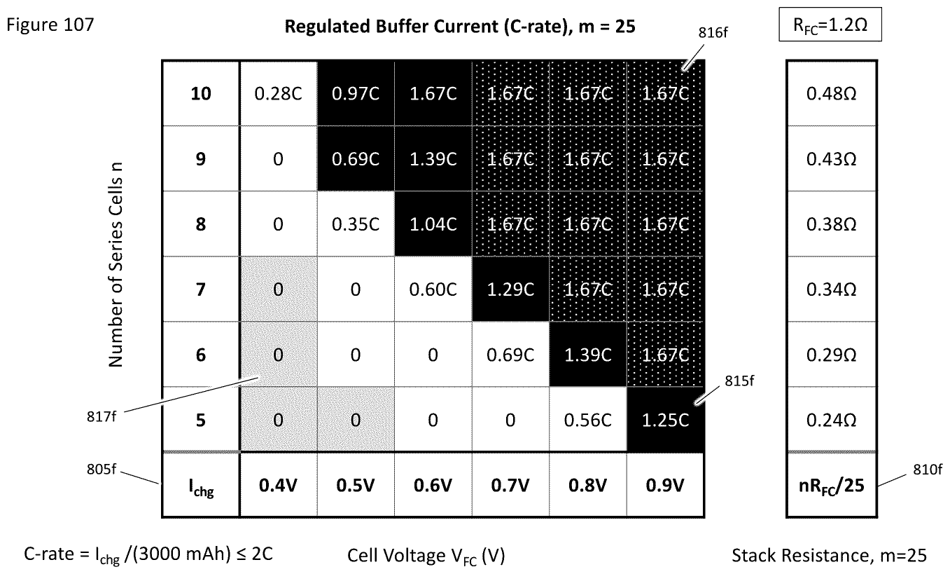

The sixth set of graphs describe m=25 fuel cell arrays, i.e., where A_{FC}=25 cm². Accordingly FIG. 105 illustrates the response surface 800f depicting unregulated QXR currents for arrays ranging from n=5 to n=10 and cell voltages ranging from V_{FC}=0.4V to V_{FC}=0.9V. Fuel cell currents are calculated using a nominal charging voltage of Vₙₒₘ=3.6V with resistances shown in table 810f spanning 0.240 to 0.480 corresponding to values of n ranging from 5 ≤n≤10. Gray cells 817f do not produce a sufficiently adequate voltage to charge a Li-ion cell as a buffer. Black cells 815f represent conditions where the fuel cell array exceeds buffer V_{OC} and requires voltage clamping. Unregulated peak currents reach 11.25 A. Shown in response surface 803f of FIG. 106, QXR regulation to 0.2 A/cm² limits peak charging currents to 5 A as highlighted by the spotted cells 816f. Converting the currents to C-rate, response surface 805f in FIG. 107 shows the charging current is 1.67C, 16.5% below the 2C limit.

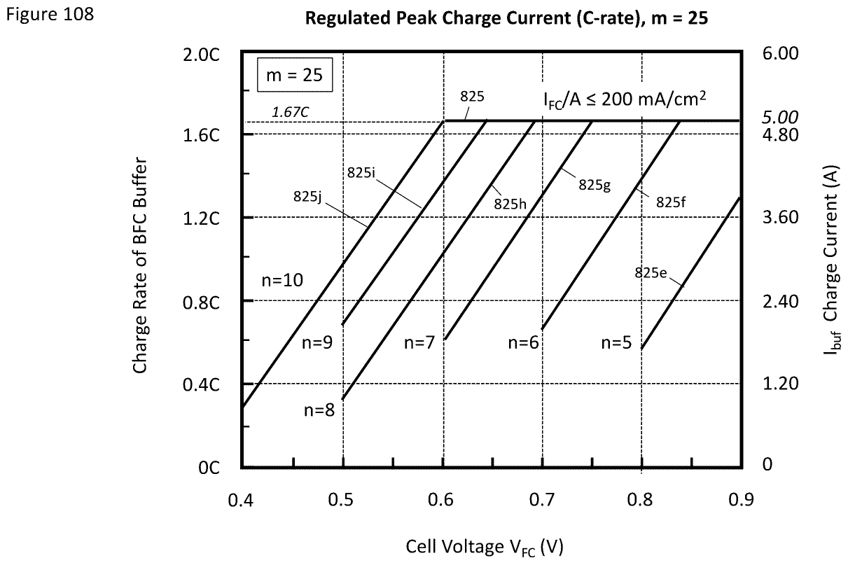

The graph of FIG. 108 illustrates the peak self recharging rate of a 25 cm² unloaded buffered fuel cell in both amperes and C-rate as a function cell voltage varied parametrically by the number of series cells in the stack. Each curve represents a specific value of n, where curves 825e, 825f, 825g, 825h, 825i, and 825j correspond cells stacks of n=5, 6, 7, 8, 9, and 10 respectively. All curves merge to a maximum value shown by horizontal line 825 for a maximum fuel cell current density of 200 mA/cm² corresponding to 5 A or 1.67C.

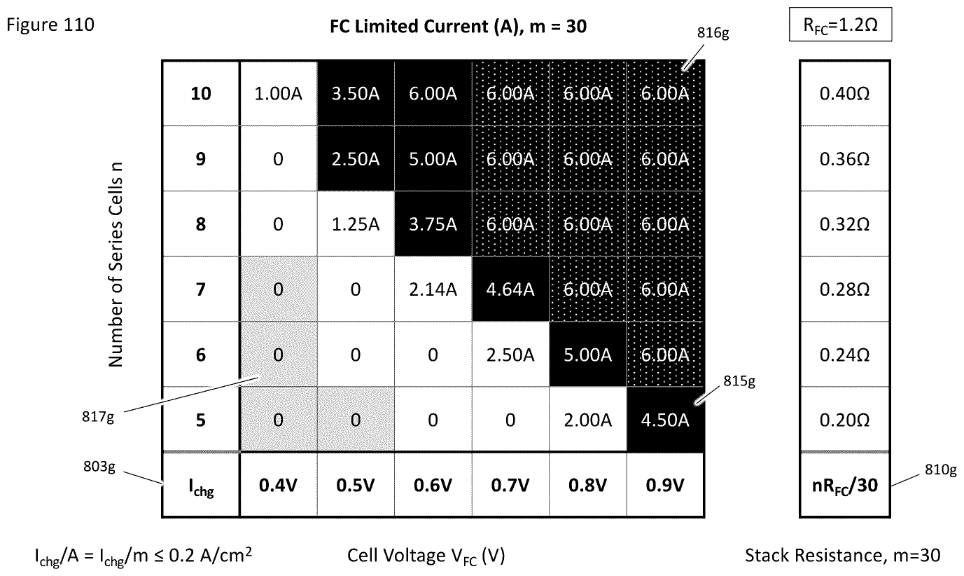

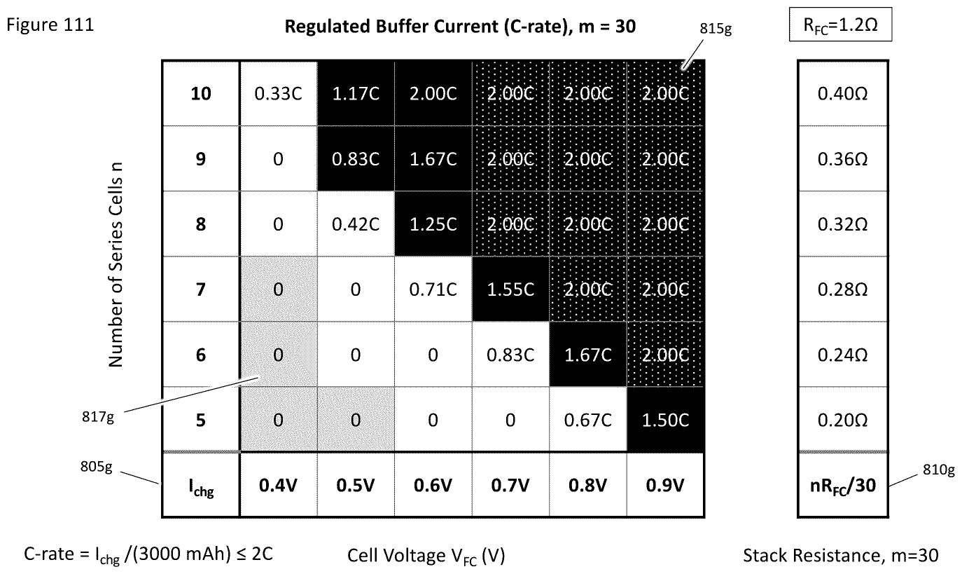

The seventh set of graphs describe m=30 fuel cell arrays, i.e., where A_{FC}=30 cm². Accordingly FIG. 109 illustrates the response surface 800g depicting unregulated QXR currents for arrays ranging from n=5 to n=10 and cell voltages ranging from V_{FC}=0.4V to V_{FC}=0.9V. Fuel cell currents are calculated using a nominal charging voltage of Vₙₒₘ=3.6V with resistances shown in table 810g spanning 0.2Ω to 0.4Ω corresponding to values of n ranging from 5≤n≤10. Gray cells 817g do not produce a sufficiently adequate voltage to charge a Li-ion cell as a buffer. Black cells 815g represent conditions where the fuel cell array exceeds buffer V_{OC} and requires voltage clamping. Unregulated peak currents reach 13.5 A. Shown in response surface 803g of FIG. 110, QXR regulation to 0.2 A/cm² limits peak charging currents to 6 A as highlighted by the spotted cells 816g. Converting the currents to C-rate, response surface 805g in FIG. 111 shows the charging current is 2C, the maximum current for the 2C limit.

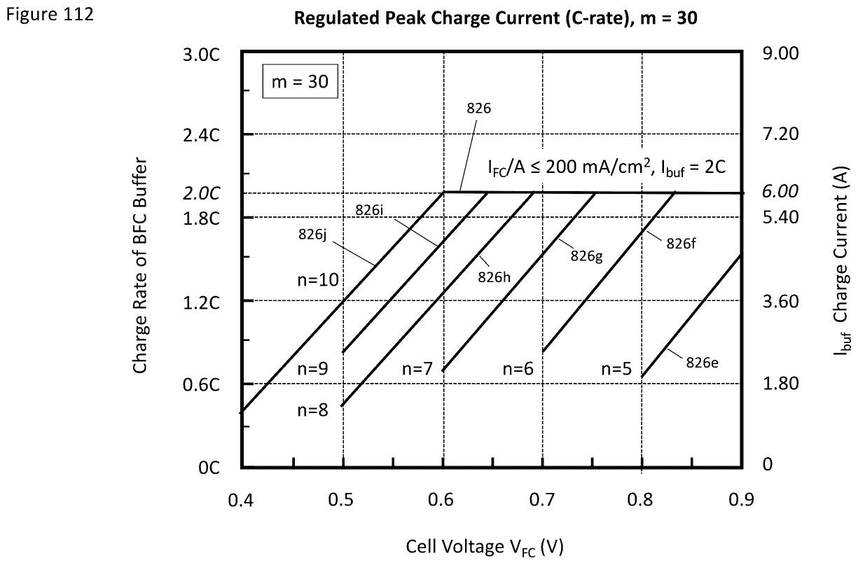

The graph of FIG. 112 illustrates the peak self recharging rate of a 30 cm² unloaded buffered fuel cell in both amperes and C-rate as a function cell voltage varied parametrically by the number of series cells in the stack. Each curve represents a specific value of n, where curves 826e, 826f, 826g, 826h, 826i, and 826j correspond cells stacks of n=5, 6, 7, 8, 9, and 10 respectively. All curves merge to a maximum value shown by horizontal line 826 for a maximum fuel cell current density of 200 mA/cm² corresponding to 6 A or 2C.

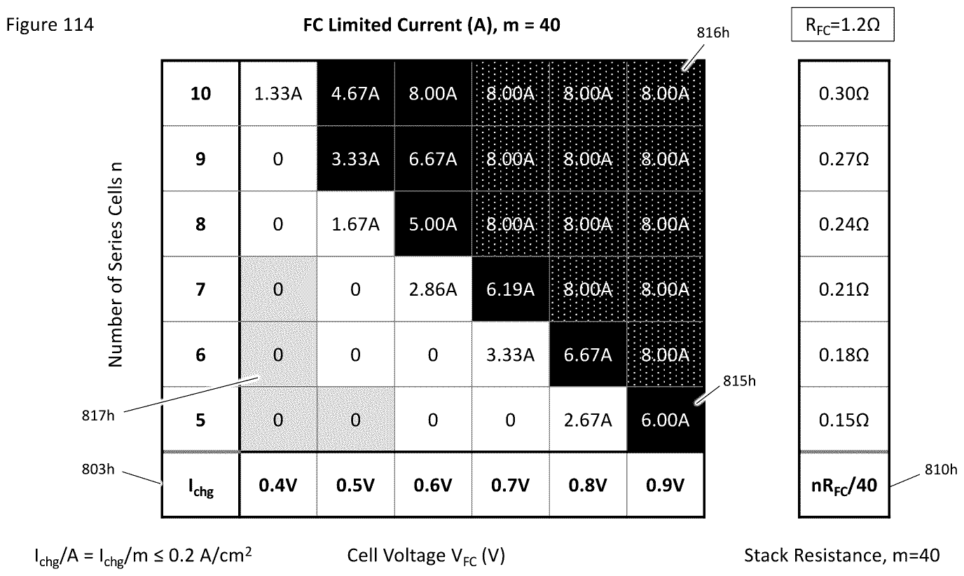

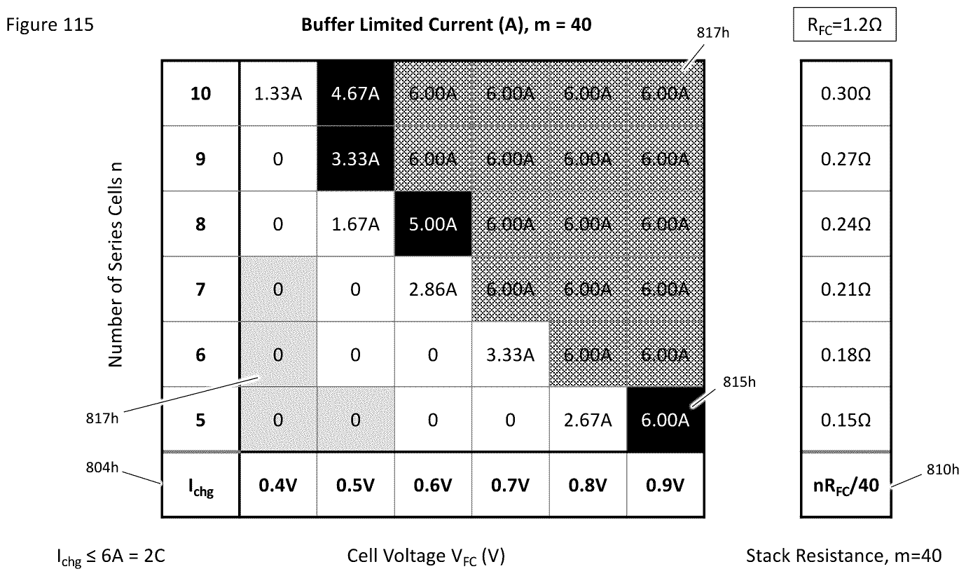

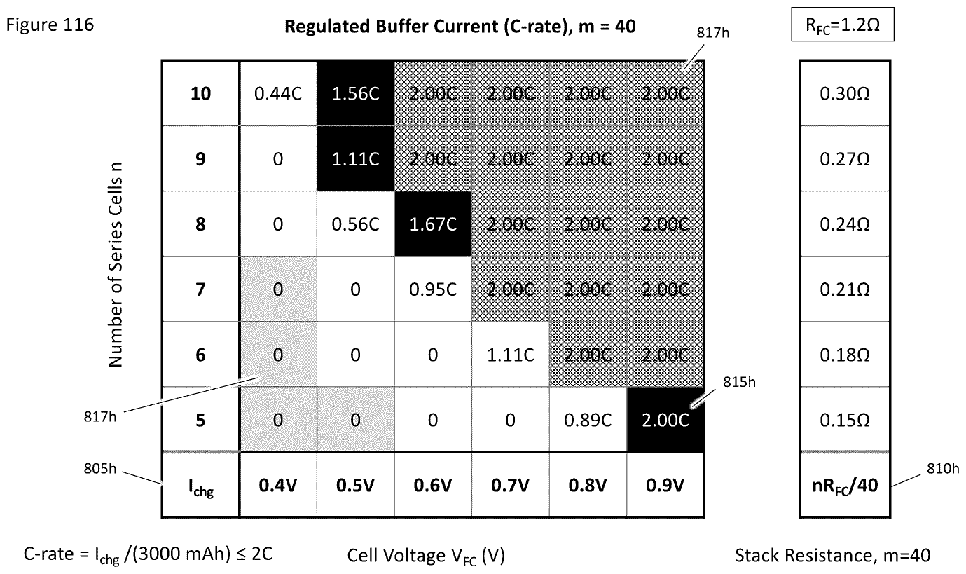

The eighth set of graphs describe m=40 fuel cell arrays, i.e., where A_{FC}=40 cm². Accordingly FIG. 113 illustrates the response surface 800h depicting unregulated QXR currents for arrays ranging from n=5 to n=10 and cell voltages ranging from V_{FC}=0.4V to V_{FC}=0.9V. Fuel cell currents are calculated using a nominal charging voltage of Vₙₒₘ=3.6V with resistances shown in table 810h spanning 0.15Ω to 0.3Ω corresponding to values of n ranging from 5≤n≤10. Gray cells 817h do not produce a sufficiently adequate voltage to charge a Li-ion cell as a buffer. Black cells 815h represent conditions where the fuel cell array exceeds buffer V_{OC} and requires voltage clamping. Unregulated peak currents reach 18 A. Shown in response surface 803h of FIG. 114, QXR regulation to 0.2 A/cm² limits peak charging currents to 8 A as highlighted by the spotted cells 816h. The maximum charging for a 3 Ah buffer however is 6 A, as depicted by shaded area 817h in the buffer current limited response surface 804h of FIG. 115. Converting the currents to C-rate, the regulated buffer current response surface 804h in FIG. 116 shows the charging current limited conditions 817h regulated to a 2C charging rate.

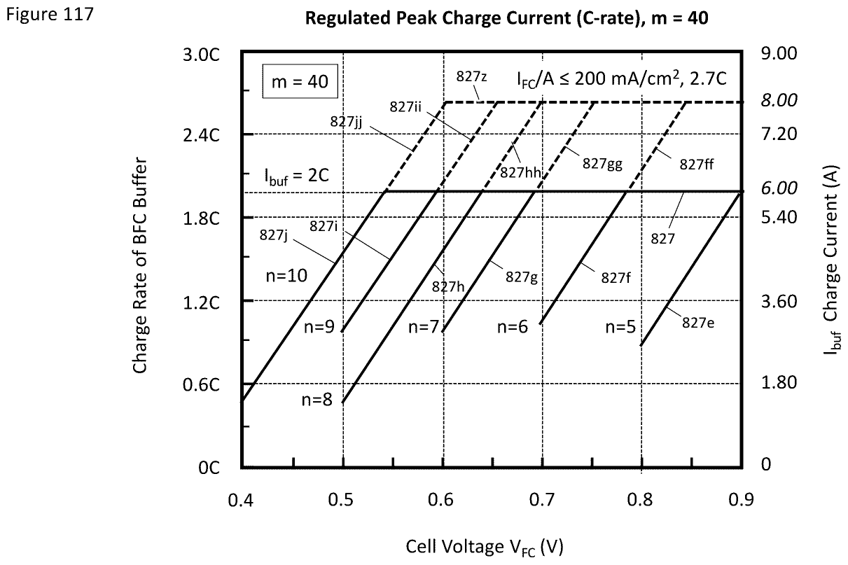

The graph of FIG. 117 illustrates the peak self recharging rate of a 40 cm^{Z} unloaded buffered fuel cell in both amperes and C-rate as a function cell voltage varied parametrically by the number of series cells in the stack. Each curve represents a specific value of n, where curves 827e, 827f, 827g, 827h, 827i, and 827j correspond cells stacks of n=5, 6, 7, 8, 9, and 10 respectively. All curves merge to a maximum value shown by horizontal line 827 for a maximum buffer charge current corresponding to 6A or 2C.

As shown, at 8 A or 2.7C the fuel cell charge limit 827z is significantly higher than the buffer charge limit 827. Without the buffer limitations 827e extends to 827ee, 827f extends to 827ff, 827g extends to 827gg, 827h extends to 827hh, 827i extends to 827ii, and 827j extends to 827ii. The extra fuel cell performance can be utilized by doubling the buffer cell from 1s1p Li-ion into a 1s2p thereby moving the buffer cell charging limit to 4C or 12A.

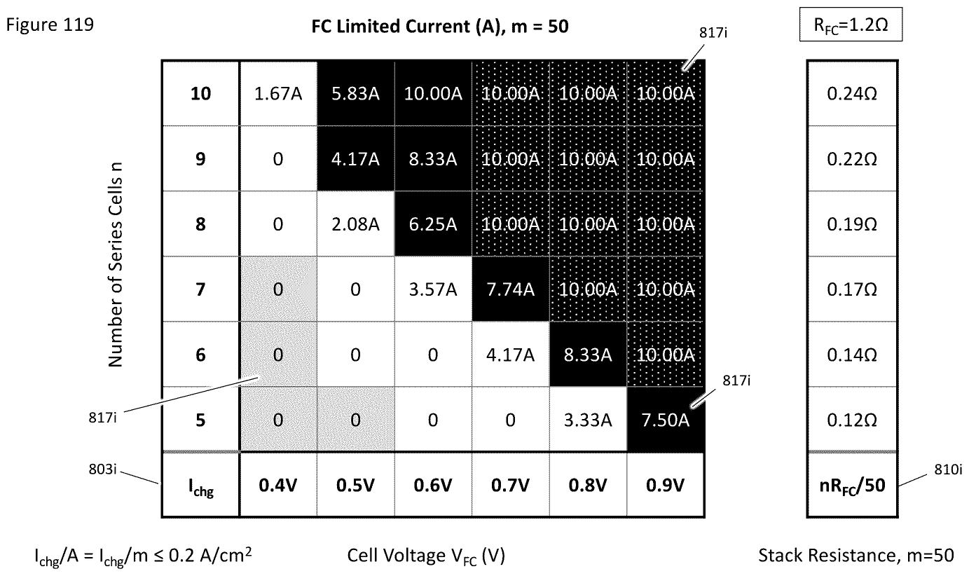

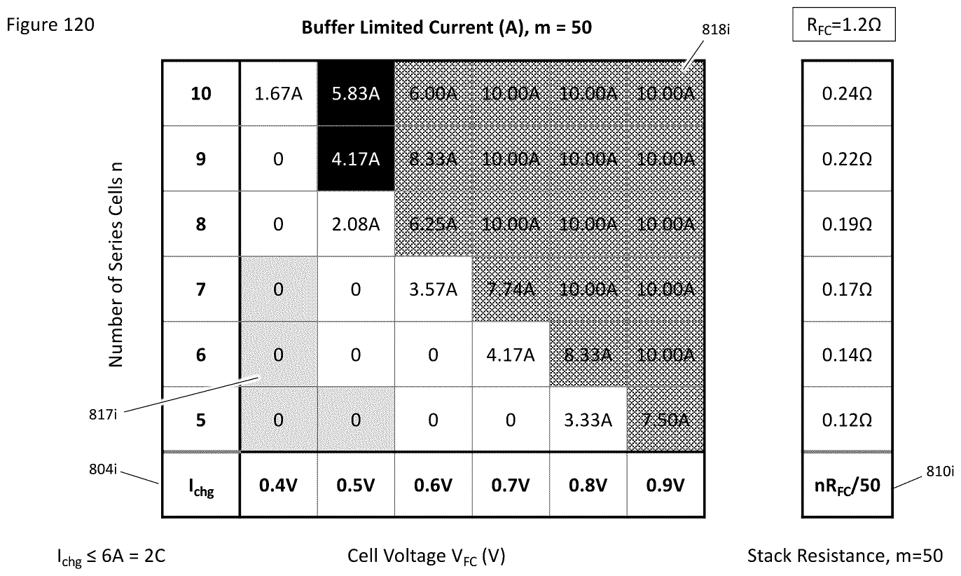

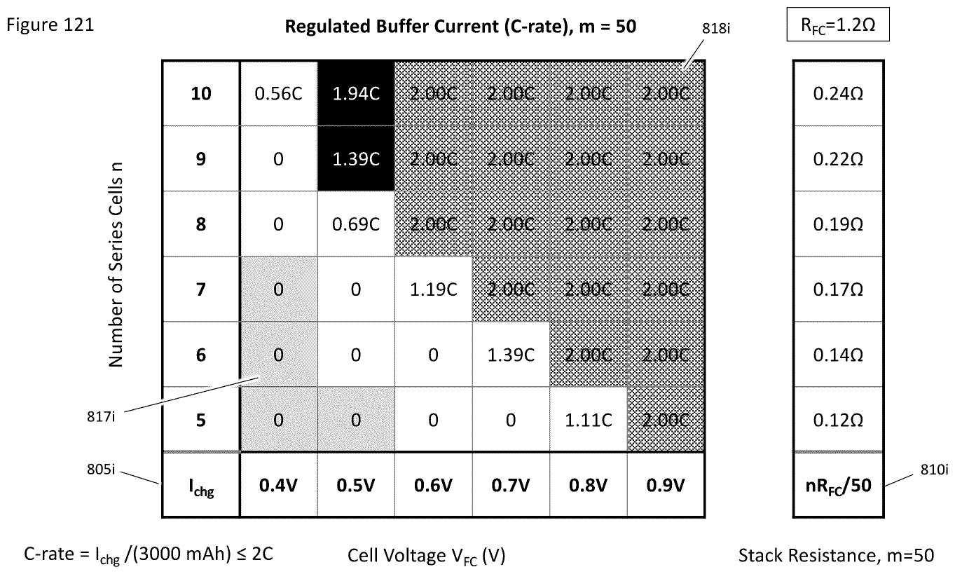

The ninth set of graphs describe m=50 fuel cell arrays, i.e., where A_{FC}=50 cm². Accordingly FIG. 118 illustrates the response surface 800i depicting unregulated QXR currents for arrays ranging from n=5 to n=10 and cell voltages ranging from V_{FC}=0.4V to V_{FC}=0.9V. Fuel cell currents are calculated using a nominal charging voltage of Vₙₒₘ=3.6V with resistances shown in table 810i spanning 0.12Ω to 0.24Ω corresponding to values of n ranging from 5≤n≤10. Gray cells 817i do not produce a sufficiently adequate voltage to charge a Li-ion cell as a buffer. Black cells 815i represent conditions where the fuel cell array exceeds buffer V_{OC} and requires voltage clamping. Unregulated peak currents reach 22.5 A. Shown in response surface 803i of FIG. 119, QXR regulation to 0.2 A/cm² limits peak charging currents to 10A as highlighted by the spotted cells 816i. The maximum charging for a 3 Ah buffer however is 6 A, as depicted by shaded area 817i in the buffer current limited response surface 804i of FIG. 120. Converting the currents to C-rate, the regulated buffer current response surface 805i in FIG. 121 shows the charging current limited conditions 818i regulated to a 2C charging rate.

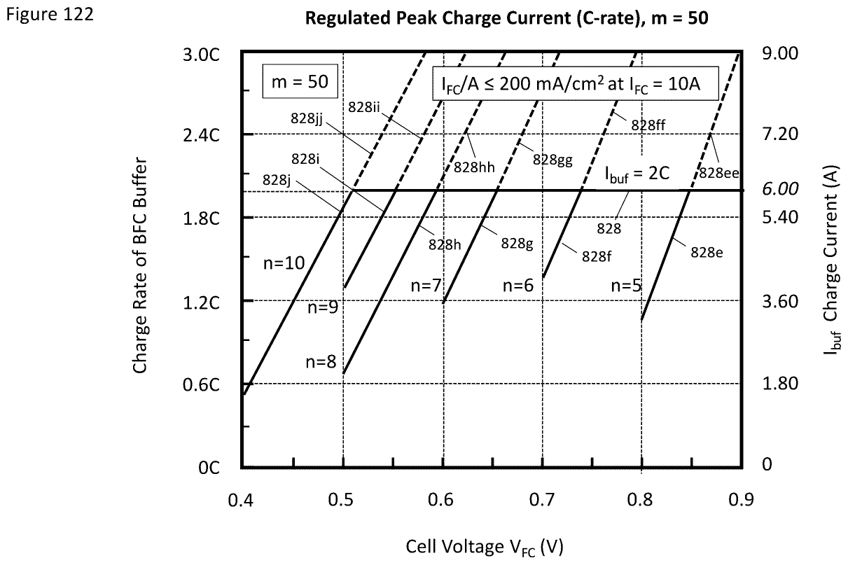

The graph of FIG. 122 illustrates the peak self recharging rate of a 50 cm² unloaded buffered fuel cell in both amperes and C-rate as a function cell voltage varied parametrically by the number of series cells in the stack. Each curve represents a specific value of n, where curves 828e, 828f, 828g, 828h, 828i, and 828j correspond cells stacks of n=5, 6, 7, 8, 9, and 10 respectively. All curves merge to a maximum value shown by horizontal line 828 for a maximum buffer charge current corresponding to 6A or 2C.

As shown, at 10A or 3.3C the fuel cell charge limit (not shown) is significantly higher than the buffer charge limit 828. Without the buffer limitations 828e extends to 8278ee, 828f extends to 828ff, 828g extends to 828gg, 828h extends to 828hh, 828i extends to 828ii, and 828j extends to 828ii. The extra fuel cell performance can be utilized by doubling the buffer cell from 1s1p Li-ion into a 1s2p thereby moving the buffer cell charging limit to 4C or 12A.

Scaling Fuel Cells. Paralleling fuel cells either by increasing the number of discrete fuel cells or scaling the total area of a single fuel cell is measured by the multiplier m whereby the total area of a fuel cell array is given by

A_{FCa}=mA_{FC}

and where for conveniences sake A_{FC}=1 cm². A larger m value increases the buffer's charging C-rate but does not change the charging voltage range. The charging voltage limit is defined by the equation

$${I}_{chg} = \frac{{nV}_{FC} - {V}_{buf}}{( \frac{n}{m} ) {R}_{FC}}$$

where I_{chg} 2C for Q=3 Ah, V_{buf}=3.6V, R_{FC}=1.2Ω, 5≤n≤10, 5<m<50, and 0.4V V_{FC}≥0.9V. In this equation whenever nV_{FC} approaches the battery voltage V_{buf} then the numerator (nV_{FC}−V_{buf})→0, charging current drops to zero, and charging slows eventually ceasing. As such no buffer cell can charge above the voltage of the fuel cell stack charging it.

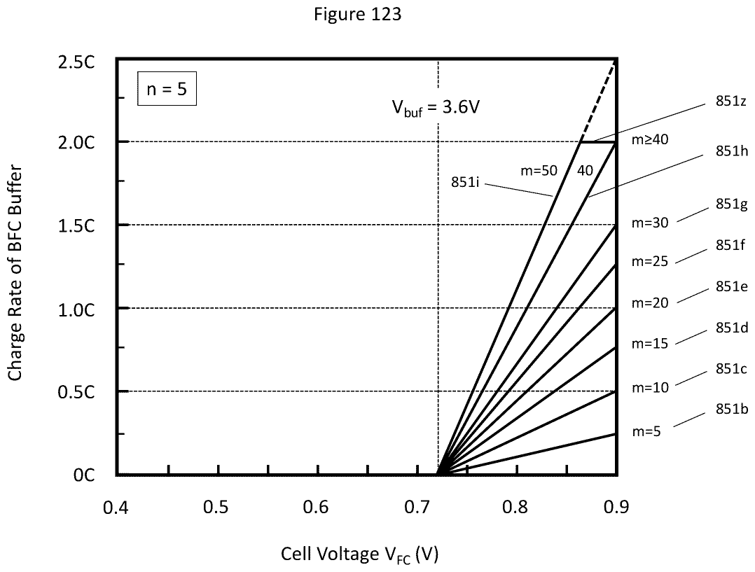

This BFC charge current equation is graphed for n=5 in FIG. 123 comprising curves 851b, 851c, 851d, 851e, 851f, 851g, 851h, and 851i corresponding to m=5, 10, 15, 20, 25, 30, 35, 40, and 50 respectively. As shown the charging rate drops to zero when V_{FC}=(V_{buf}/n)=(3.6V/5)=0.72V per cell. For a 5s50p array, the fuel cell resistance is

R_{FCa}=(n/m)R_{FC}=(5/5Ω)(1.2Ω)=0.12Ω

Rearranging the charge current equation, the charging current reaches the 2C or 6 A limit shown by horizontal line segment 851z at the voltage V_{FC} given by

$${V}_{FC} = \frac{{V}_{buf} + {I}_{chg} [ ( \frac{n}{m} ) {R}_{FC} ]}{n} = \frac{3.6 V + 6 A [ 0 \text{.12} Ω ]}{5} = 0.86 V per cell$$

beyond which the charging current is limited to 2C or 6 A by the QXR charge transfer regulator as shown graphically.

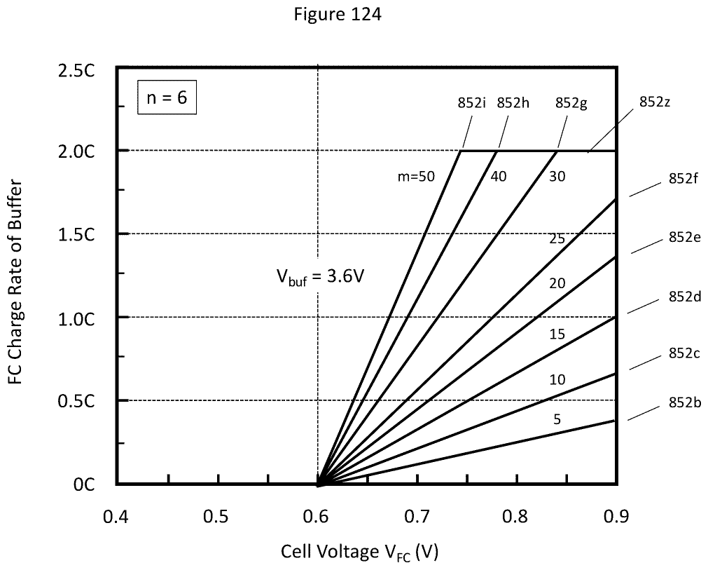

This BFC charge current equation is graphed for n=6 in FIG. 124 comprising curves 852b, 852c, 852d, 852e, 852f, 852g, 852h, and 852i corresponding to m=5, 10, 15, 20, 25, 30, 35, 40, and 50 respectively and where R_{FCa}=0.14Ω. The charging current reaches zero for fuel cell voltage below V_{FC}≤0.6V and the m=50 current becomes limited to 2C at V_{FC}≥0.74V as shown by line segment 852z.

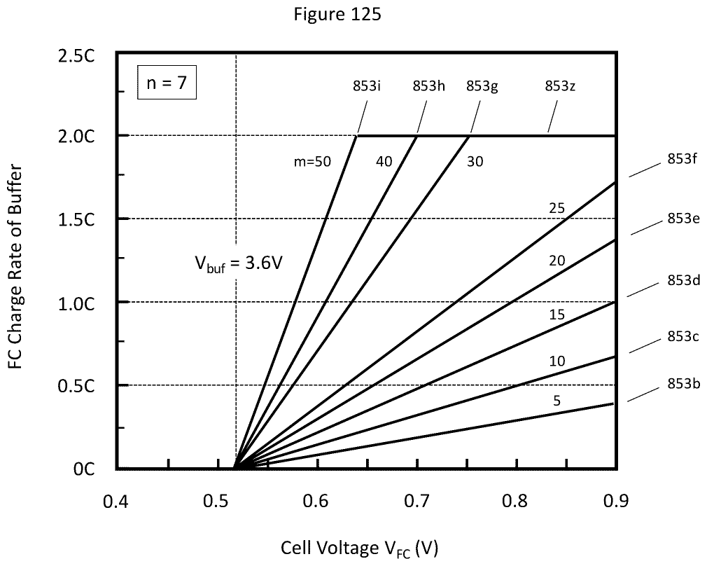

The BFC charge current equation is graphed for n=7 in FIG. 125 comprising curves 853b, 853c, 853d, 853e, 853f, 853g, 853h, and 853i corresponding to m=5, 10, 15, 20, 25, 30, 35, 40, and 50 respectively and where R_{FCa}=0.170, the charging current reaches zero for fuel cell voltage below V_{FC}≤0.51V and the m=50 current becomes limited to 2C at V_{FC}≥0.66V as shown by line segment 853z.

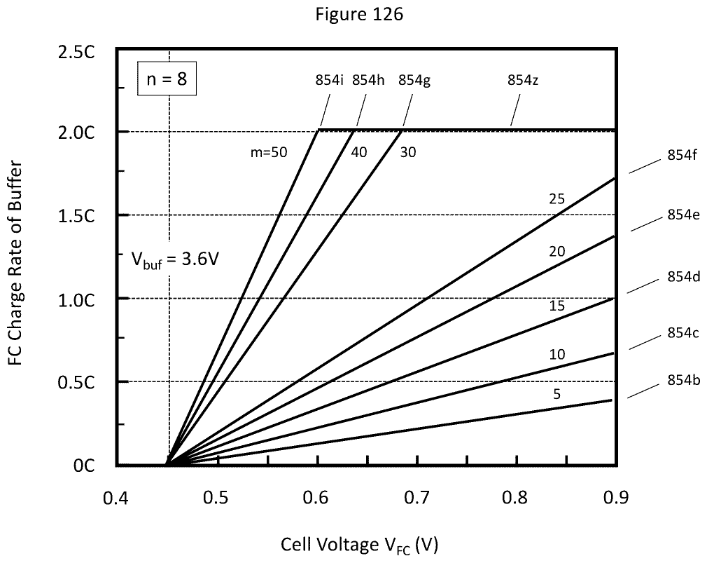

The BFC charge current equation is graphed for n=8 in FIG. 126 comprising curves 854b, 854c, 854d, 854e, 854f, 854g, 854h, and 854i corresponding to m=5, 10, 15, 20, 25, 30, 35, 40, and 50 respectively and where R_{FCa}=0.19Ω, the charging current reaches zero for fuel cell voltage below V_{FC}≤0.45V and the m=50 current becomes limited to 2C at V_{FC}≥0.59V as depicted by horizontal line segment 854z.

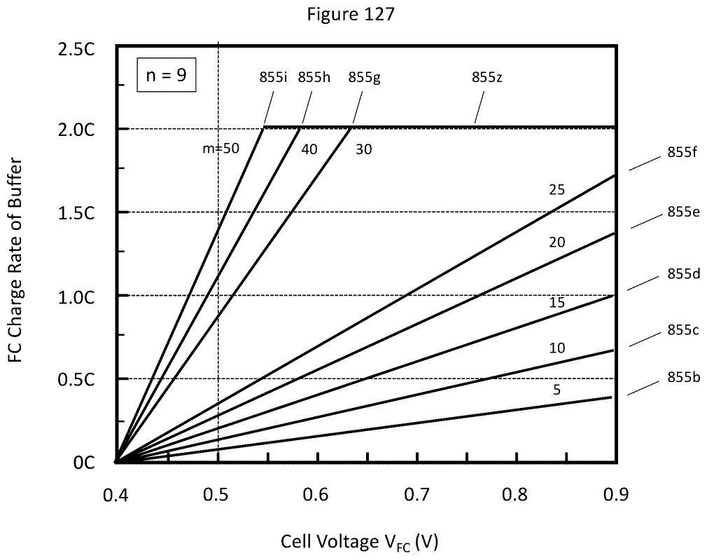

The BFC charge current equation is graphed for n=9 in FIG. 127 comprising curves 855b, 855c, 855d, 855e, 855f, 855g, 855h, and 855i corresponding to m=5, 10, 15, 20, 25, 30, 35, 40, and 50 respectively and where R_{FCa}=0.24Ω, the charging current reaches zero for fuel cell voltage below V_{FC}≤0.36V (not shown) and the m=50 current becomes limited to 2C at V_{FC}≥0.50V as shown by line segment 855z.

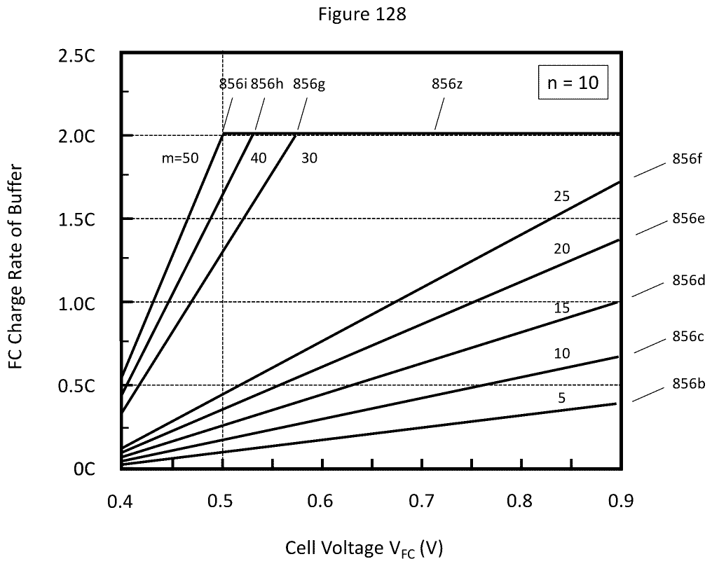

The BFC charge current equation is graphed for n=10 in FIG. 128 comprising curves 856b, 856c, 856d, 856e, 856f, 856g, 856h, and 856i corresponding to m=5, 10, 15, 20, 25, 30, 35, 40, and 50 respectively and where the charging current reaches zero for fuel cell voltage below V_{FC}≤0.36V (not shown) and the m=50 current becomes limited to 2C at V_{FC}≥0.50V as shown by line 855z.

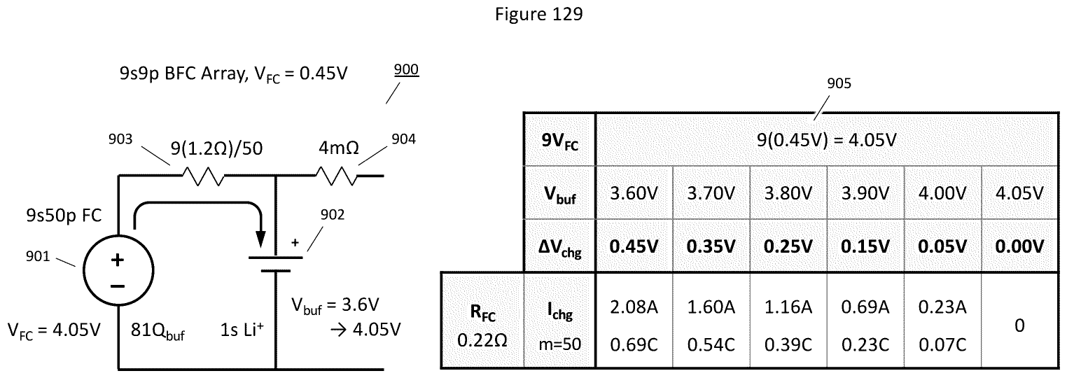

Although the prior graphs show the peak current when charging commences, i.e., when V_{buf}=3.6V and the fuel cell exhibits a voltage nV_{FC}, they do not reveal the current as the buffer charges. Schematic 900 in FIG. 129 illustrates the charging currents for a 9s50p fuel cell 901 charging a single 18650 Li-ion buffer cell in a low humidity condition where V_{FC}=0.45 and nV_{FC}=9(0.45V)=4.05V. For this topology, fuel cell resistor 903 is given by (n/m)R_{FC}=(9/50)1.2Ω=0.22Ω. Table 905 illustrates as V_{buf} charges from 3.6V to 4.05V, the fuel cell current diminishes from 2.08 A or 0.69C down to 0 in proportion to the ΔV_{chg}(t)=9V_{FC}−V_{buf}(t). The current drops to zero at 4.05V because the fuel cell stack voltage is unable to charge the buffer fully to 4.2V.

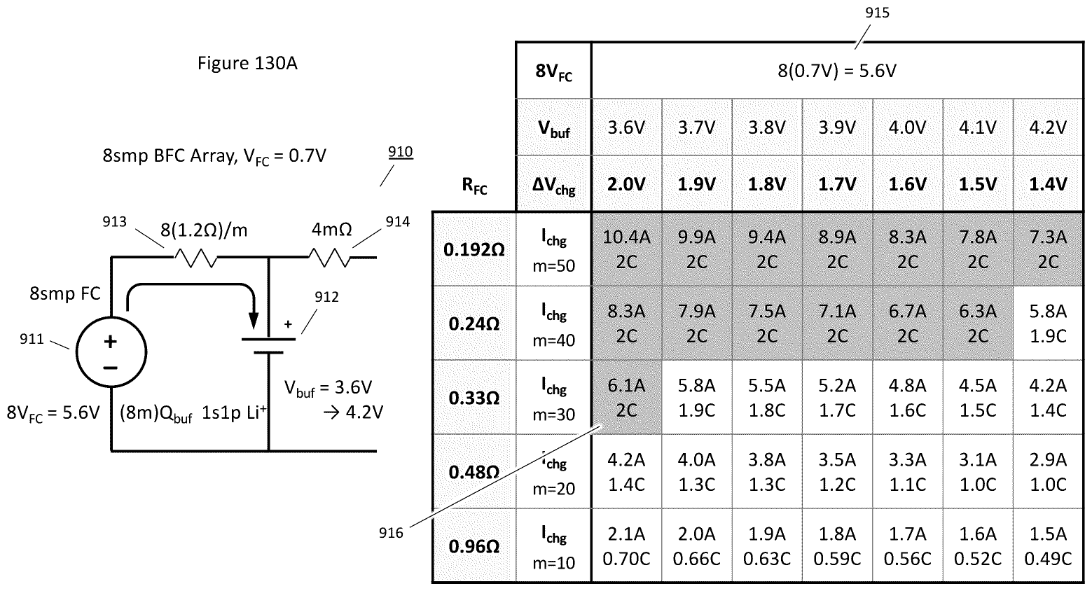

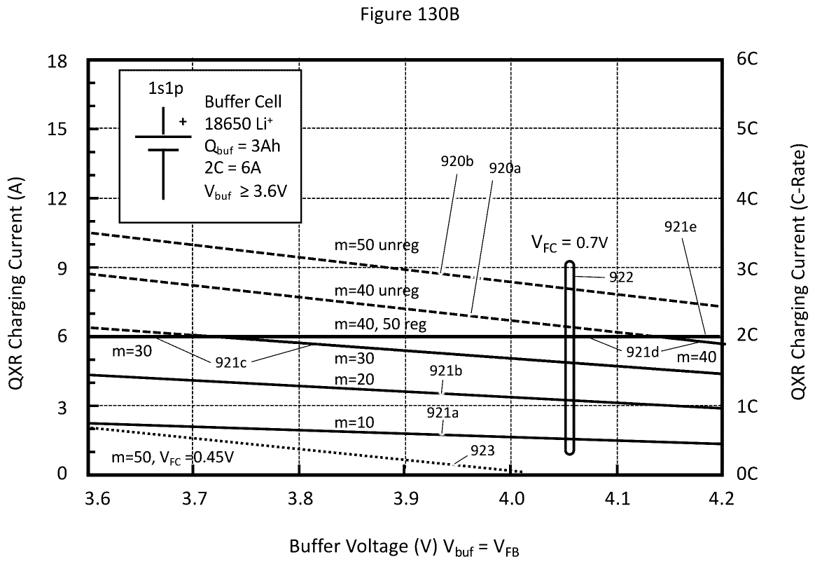

At higher fuel cell voltages, e.g., with higher humidity, the aggregate voltage of a fuel cell stack exceeds 4.2V, the buffer charges fully to 4.2V. For example, table 915 describes charging of a 8smp FC array for varying fuel cell areas m illustrated by schematic 910 in FIG. 130A. Assuming V_{FC}=0.7V the fuel cell stack voltage is nV_{FC}=8(0.7V)=5.6V. The charging headroom given by ΔV_{chg}(t)=8V_{FC}−V_{buf}(t) where V_{buf}(0)=3.6V therefore varies 2.0V to 1.4V until V_{buf} charges to 4.2V after which charging is terminated. The charging current I_{buf} depends on the headroom ΔV_{chg}(t) and the fuel cell resistance 913 given parametrically in terms of m by the relation (8/m)1.2Ω. Table 915 illustrates the fuel cell 911 is able to deliver 2C charging current at m=40. Currents over 2C are clamped to 6A as depicted by shaded cells 916. At m=50 the fuel cell is capable of delivering between 10.4 A and 7.3 A which must be limited to 2C or 6 A by the QXR charge transfer regulator. Alternatively, a 1s2p Li-ion pair of cells can be used as the buffer.

FIG. 130B graphically illustrates the buffer charging current in units of amperes A on the left ordinate axis and in C-rate units on the right y-axis as a function the buffer voltage V_{buf}(t) during charging from Vₙₒₘ=3.6V to V_{OC}=4.2V. Aside from curve 923 for low humidity operation with V_{FC}=0.45V as a reference, all curves shown occur at higher humidity levels with a corresponding fuel cell voltage 922 of V_{FC}=0.7V. As shown m=10 and m=20 curves 921a and 921b do not require QXR current limiting over the full range. The m=30 charge curve 921c becomes current clamped to 6A or 2C only at the beginning of charging when V_{buf} 3.75V. The m=40 charging curve 921d is current clamped to 2C at all buffer voltages except when V_{buf} >3.15V near the end of charging. The m=50 charging curve 921e is clamped to 2C over the full range of charging conditions. As a reference, the unclamped current for curve 920a where m=40 and 920b where m=50 illustrates charging currents without the QXR function exceed 6 A and possibly may reach 10.5 A, too high in current for the buffer.

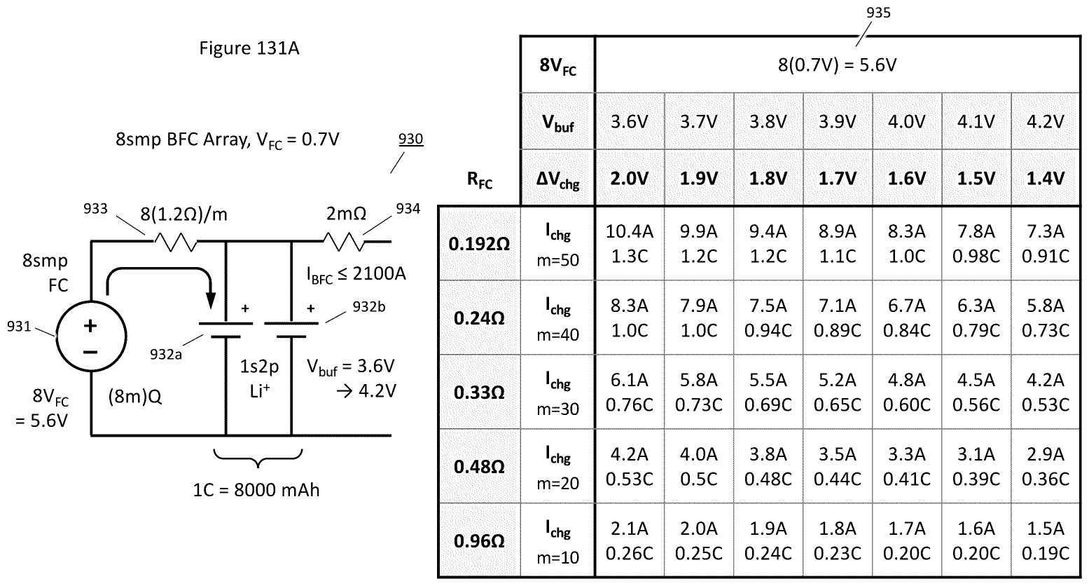

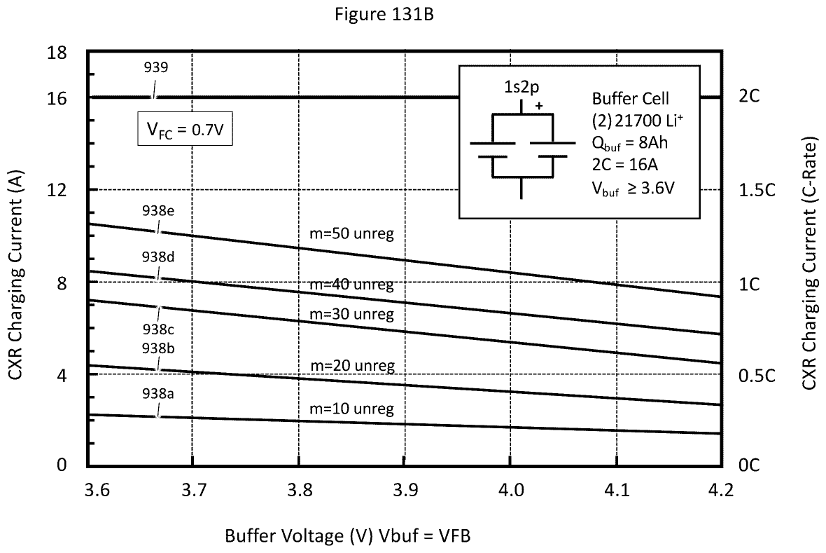

In one embodiment of this invention high current capability of a BFC using a wide fuel cell such as m>40 beneficially increases charge transfer capability by employing a 1s2p Li-ion dual cell buffer using a 21700 cell. Shown in schematic 950 of FIG. 131A, buffer construction comprises two cells 932a and 932b powered by a 8 smp fuel cell array 931 where the area factor m is varies parametrically by design. This dual buffer design offers a number of performance improvements over its single cell counterpart. These advantages include (i) the ability to use a larger fuel cell 931 able to recharge the two buffer cells at higher currents more quickly, (ii) decreased fuel cell resistance 933, (iii) ability to operate to lower levels of relative humidity, (iv) increased buffer charge storage capacity of paralleled cells 932a and 932b where 1C=8000 mAh, and (v) reduced buffer resistance 934.

Comparing dual-cell buffer schematic 930 to single cell buffer 910, the 2C buffer capacity improves from 6 Ah to 16 Ah, a 170% increase in energy storage. Buffer resistance decreases by half from 4 mΩ to 2 mΩ. The BFC current figure-of-merit doubles from 4.2V/4mΩ =1050 A to the high current 4.2V/2mΩ=2100 A. Table 935 illustrates that at V_{FC}=0.7V charging times for m=50 increase the charging times of the higher capacity buffer increase inversely with the C-rate dropping from 2C to between 1.3C and 1.0C. These slower charging rates are illustrated graphically in FIG. 131B by contrasting the 2C maximum charge rate at 16 A shown by line 939 against the unregulated charge rates for fuel cells with m=10, 20, 30, 40, and 50 corresponding to curves 938a, 938b, 938c, 938d, and 938e respectively.

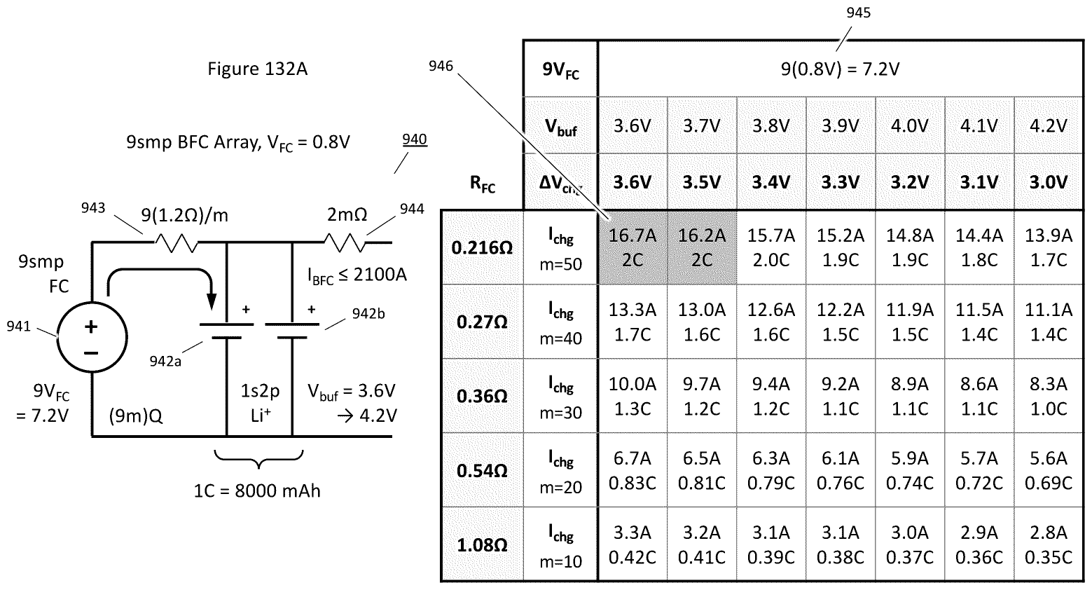

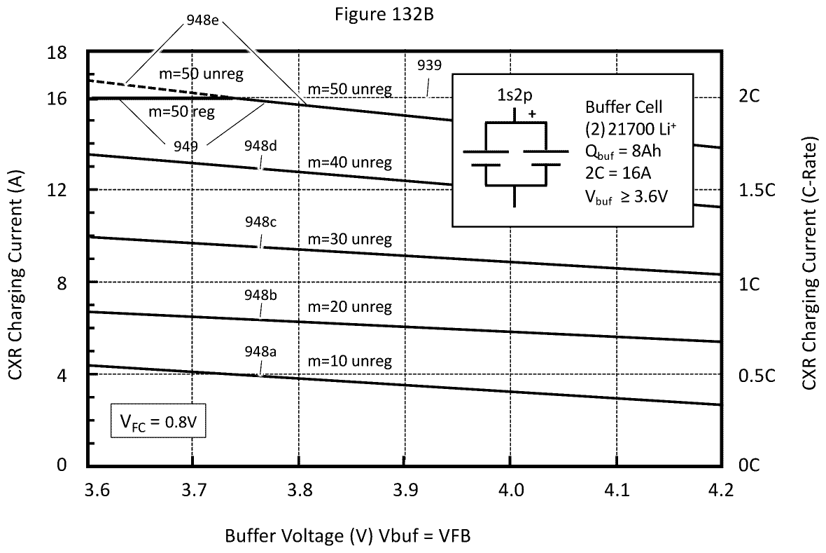

The increased charging time required by a dual cell buffer can be compensated for by increasing the fuel cell stack voltage while maintaining a large area m=50 fuel cell. For example, schematic 940 in FIG. 132A is identical to the aforementioned schematic 930 except that the number of n series fuel cells increased from 8-to-9 and the fuel cell voltage increased from V_{FC}=0.7V to V_{FC}=0.8V. As illustrated by cells 946 in table 945, these two changes result in an increase in unregulated fuel cell current over 16 A. Clamped at a 2C charging rate, the 9s50p fuel cell operating at V_{FC}=0.8V can charge a dual 21700 cell Li-ion buffer with Q_{FC}=8 Ah in the same time that a 8s50p operating at V_{FC}=0.7V is able to charge a Q_{FC}=3 Ah single 86250 cell Li-ion buffer. The charging current improvement offered by the n=9 design is illustrated in the graph of FIG. 132B where compared to the 2C maximum buffer charging rate 939 at 16 A, the charging currents delivered from a 9s stack of fuel cells comprising unregulated curves 948a, 948b, 948c, 948d, and 948e having area factor m=10, 20, 30, 40, and 50 are significantly higher than the 8s design. In fact, the 948e curve exceeds the 2C limit 939 for buffer voltages below 3.74V when first commencing charging. The regulated current curve 949 is therefore included as a substitute for unregulated curve 948e.

Increasing the number of series connected fuel cells in a stack, thereby increases a fuel cell's current sourcing capability and reduces buffer recharging times despite increasing the fuel cell's series resistance. The table below compares four wide array fuel cells operating at V_{FC}=0.7V where n is varied from 7-to-10, the individual fuel cell resistance is R_{FC}=1.20 and the minimum buffer voltage when commencing charging is Vₙₒₘ=³0.6V. As shown increasing the number of series connected cells increases the fuel cell current capability and reduces charging times despite increasing the fuel cell stack resistance. The beneficial impact of increasing the number series connected fuel cells diminishes with increasing n and headroom ΔV_{chg}=[(n/m)R_{FC}−Vₙₒₘ] increases. At V_{FC}=0.7V two other observations can be made. First, all stack voltages exceed 4.2V requiring the QXR charge transfer regulator to perform voltage clamping at or slightly below V_{DC} of the buffer. Second, a m=50 design categorically exceeds the maximum charge rate of a 3 Ah lithium ion cell and must be limited to 2C by the QXR. In this sense, a A_{FC}=50 cm² fuel cell is too large for optimum charging of a single cell buffer. The asterisk * and shaded cells identify conditions where the QXR is required to perform some form of regulation, either current limiting, voltage clamping, or both.

| Topology | Series cells | Stack voltage | Stack resistance | FC current | C-rate | C-rate |
|---|---|---|---|---|---|---|
| nsmp | n | nV_{FC} | (n/m)R_{FC} | I_{FC} into 3.6 V | Q = 3 Ah | Q = 8 Ah |
| 7 s 50 p | 7 | 4.9 V* | 0.168 Ω | 7.7 A | 2 C (2.5)* | 1.0 C |
| 8 s 50 p | 8 | 5.6 V* | 0.192 Ω | 10.4 A | 2 C (3.5)* | 1.3 C |
| 9 s 50 p | 9 | 6.3 V* | 0.216 Ω | 12.5 A | 2 C (4.2)* | 1.6 C |
| 10 s 50 p | 10 | 7.0 V* | 0.240 Ω | 14.2 A | 2 C (4.7)* | 1.9 C |

The same analysis, recreated for operation when V_{FC}=0.5V is described in the following table. As shown by the asterisks *, at 0.5V per cell a 7s or 8s deign cannot fully charge the buffer to 4.2V. While such a design does not need voltage regulation it also cannot achieve a high state-of-charge for the buffer. Moreover at 0.5V per cell, the fuel cell is incapable of sufficiently high current to approach the 2C maximum charging rates, especially for a dual-cell buffer design.

| Topology | Series cells | Stack voltage | Stack resistance | FC current | C-rate | C-rate |
|---|---|---|---|---|---|---|
| nsmp | n | nV_{FC} | (n/m)R_{FC} | I_{FC} into 3.6 V | Q = 3 Ah | Q = 8 Ah |
| 7 s 50 p | 7 | 3.5 V | 0.168 Ω | — | 0 | 0 |
| 8 s 50 p | 8 | 4.0 V | 0.192 Ω | 2.1 A | 0.7 C | 0.3 C |
| 9 s 50 p | 9 | 4.5 V* | 0.216 Ω | 4.2 A | 1.4 C | 0.5 C |
| 10 s 50 p | 10 | 5.0 V* | 0.240 Ω | 5.8 A | 1.6 C | 0.7 C |

In conclusion, no one fuel cell topology can cover the full spectrum of power levels and environmental conditions. In general, too low of a stack voltage is worse than too great a voltage meaning the number of series connected cells is better overdesigned for excessive voltage and current which can be regulated than under designed sacrificing stored energy. The QXR charge transfer regulator is therefore a non-obvious but critical component in implementing a buffered fuel cell and self-charging battery.

In another embodiment of this invention, the number of fuel cells connected to the buffer is dynamically adjusted to optimally supply the buffer with the right current for rapid recharging and minimizing fuel waste producing excess voltage in high humidity conditions. This dynamic buffered fuel cell is described later in this disclosure.

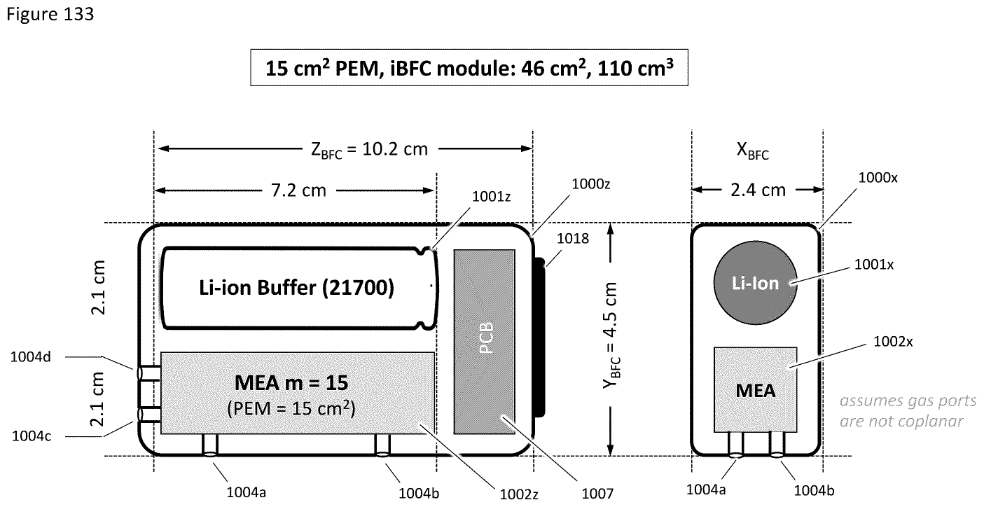

Exemplary BFC Modules. Given the forgoing design consideration including (i) the fuel cell size; a printed circuit board to mount the QXR circuit and other devices; and a lithium ion cell or cells as a buffer, several examples of BFC modules are shown in FIG. 133 to FIG. 137 as examples illustrating the compact size, high energy density, and convenient form factors for the disclosed buffered fuel cell. The modules shown do not include the hydrogen or fuel tank.

Elements of the buffered fuel cell module exemplified in FIG. 133 includes the enclosure 1000 with 1000z shown in the z-direction and 1000x in the x-direction, external electrical connections 1008, gas ports 1004a-to-1004d, MEA membrane electrode module 1002 with 1002z shown in the z-direction and 1002x in the x-direction including the PEM assembly, buffer cell 1001 shown as 1001z in the z-direction and 1001x in the x-direction comprising a cylindrical lithium ion cell in a 21700 can, and a PCB printed circuit board 1007 containing π electronics such as the QXR charge transfer regulator. In case the where the buffer fuel cell module includes intelligent control circuitry and other components, i.e., iBFC, the circuitry can also be mounted onto PCB 1007. The hydrogen fuel canister is not shown as it is external and not part of the BFC module. Other ports may be included in the MEA module to perform fluidic heat exchange (not shown) as required. Although electrical connector 1008 is represented symbolically as a battery like electrode on the ends of the BFC module, the connection may alternatively comprise a locking plug-socket arrangement.

Although a wide range of materials may be used, the MEA housing 1000 likely requires a metal enclosure to prevent hydrogen leakage. Although the hydrogen canister requires high pressure, for example 179 bar or greater, the MEA housing need not support the high same high pressure as the fuel container 425 because fuel management unit FMI 418 may include a pressure regulator able to maintain a differential pressure between the fuel canister and the MEA module and to. Shown schematically in iBFC block diagram of FIG. 44, FMI 418 may also compensate for pressure changes at different altitudes.

It should also be understood that the physical shape and construction of the BFC shown previously in FIG. 133 is exemplary and not intended to be limiting. Using the dimensional data from this design a MEA module 1002 shown in the z direction as 1002z comprises an active area of 15 cm² or m=15 configured in a rectangular shape of 7.2 cm by 2.1 cm to maximize uniform gas distribution throughout the cell.

Series stacked PEM layers are contained within a common housing to maintain a low profile, but may be segmented into different housings with separate gas flow control and valves. In one embodiment, some PEM fuel cells are contained within a separate gas housing than the other cells where the isolated PEM layers can be electrically disabled and simultaneously cut off from the fuel source by a mechanical or micromachined valve.

In the exemplary construction as shown, the m=15 PEM module dimensions are Z_{BFC}=10.2 cm long, Y_{BFC}=4.6 cm wide, and X_{BFC}=2.4 cm deep comprising a surface area of 46 cm² with a volume of 110 cm³ inclusive of the 21700 lithium ion battery as its buffer 1001z. An alternative design may employ a lower capacity 18650 Li-ion cell.

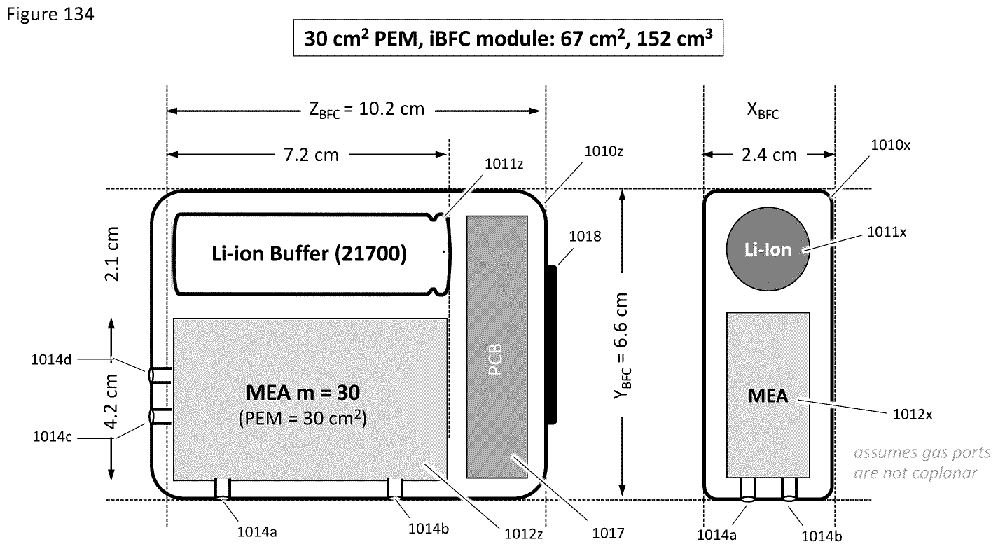

An alternative embodiment comprising a m=30 PEM having an active surface area of 30 cm² is illustrated in FIG. 134 inclusive of PCB and a 21700 canister Li-ion cell. Elements of this buffered fuel cell module includes enclosure 1010 shown in the z-direction as 1010z and in the x-direction as 1010x, external electrical connections 1018, gas ports 1014a-to-1014d, MEA membrane electrode module 1012 shown in the z-direction as 1012z and in the x-direction as 1012x including PEM assembly, buffer cell 1011 comprising a cylindrical lithium ion cell in a 21700 can shown in the z-direction as 1011z and in the x-direction as 1011x, and a PCB printed circuit board 1017 containing electronics such as the QXR charge transfer regulator.

The PEM active area of MEA 1012 shown in the z-direction as 1012z is configured in a rectangular aspect ratio of 7.2 cm by 4.2 cm to match the length of the 21700 Li-ion cell.. The m=15 PEM module dimensions are Z_{BFC}=10.2 cm long, Y_{BFC}=6.6 cm wide, and X_{BFC}=2.4 cm deep comprising a surface area of 67 cm² with a volume of 152 cm³ excluding any hydrogen fuel container volume. Gas ports are schematic representations—actual hardware may vary in construction and materials.

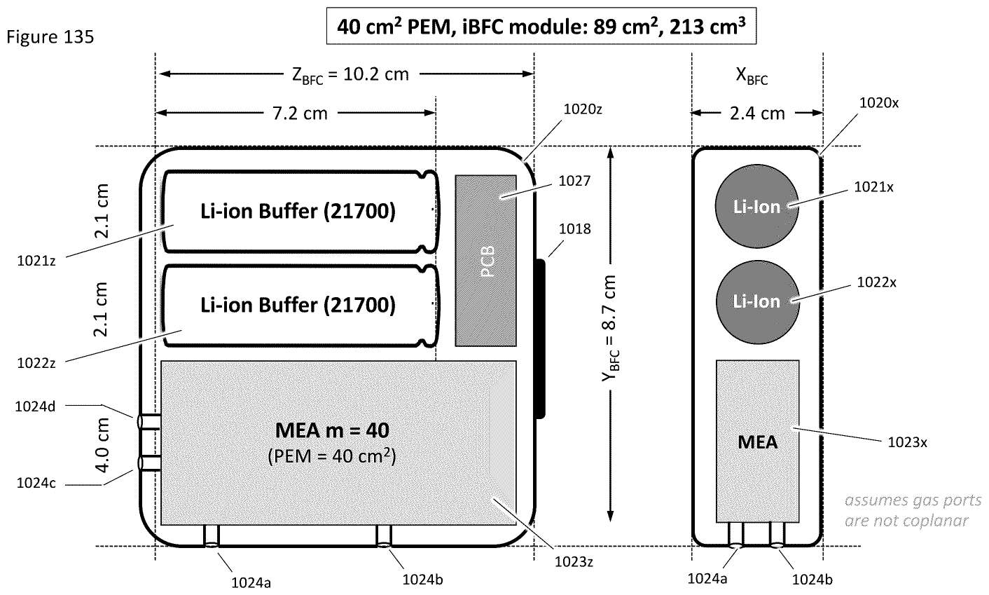

A dual buffer version of BFC is shown in FIG. 135 comprising enclosure 1020z, one m=40 MEA module 1023z with an active PEM surface area of 40 cm², PCB 1027 for control electronics, and two 21700 cylindrical can Li-ion cells as buffers 1021 and 1022 depicted in the z-direction as 1021z and 1022z and in the x-direction as 1021x and 1022x. The m=40 PEM module 1023 shown in the z-direction as 1023z and in the x-direction as 1023x has dimensions Z_{BFC}=10.2 cm long, Y_{BFC}=8.7 cm wide, and X_{BFC}=2.4 cm deep comprising a surface area of 89 cm² with a volume of 213 cm³ excluding any hydrogen fuel container volume. The PEM module 1023 active area is configured in a rectangular aspect ratio of 10 cm by 4 cm with a length matching that of the buffer cells 1021 and 1022 and the PCB. With a m=40 MEA this design has 33% lower impedance than the previously described design but contains 2.7× greater electrical buffer charge storage capacity, specifically (8 Ah)/3 Ah)=267% of aforementioned design. Although the larger lower impedance PEM module produces 33% higher charging currents than the m=30 design, the larger capacity still requires longer times to recharge.

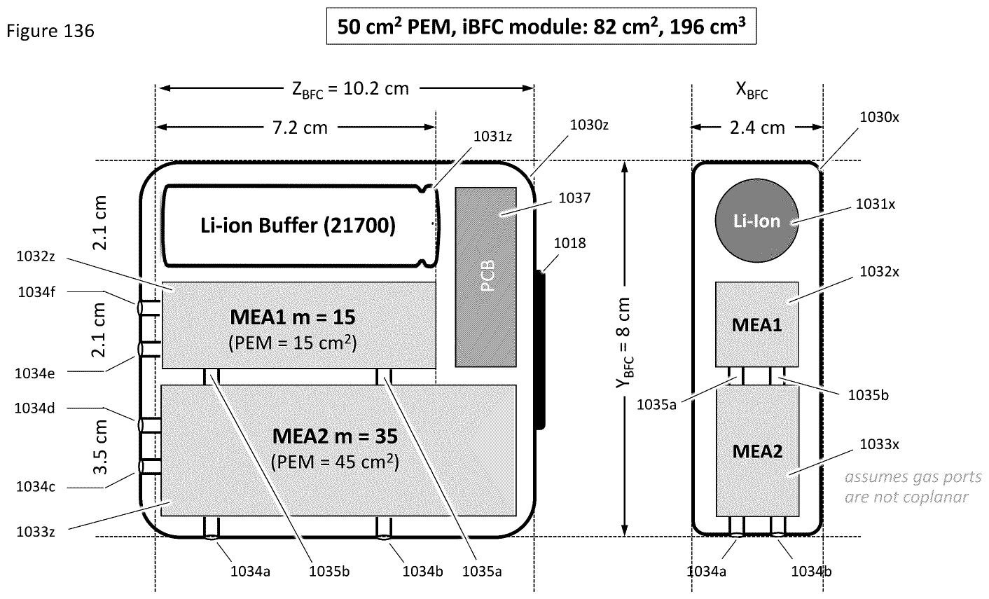

Another embodiment representing a fast recharge version of the BFC shown in FIG. 136 comprises only a single 21700 cylindrical Li-ion cell as buffer 1031z with a large m=50 PEM membrane having an active surface area of 50 cm². To avoid an excessively long and unnecessarily large area PCB, the fuel cell is separated into two PEM units. One unit MEA 1032 shown as 1032z and 1032x in the z- and x-directions has an area of 15 cm² with dimensions of 7.2 cm by 2.1 cm. The other MEA 1033 shown as 1033z and 1033x in the z- and x-directions has an active area of 35 cm² with dimensions of 10 cm by 3.5 cm. The dimensions are selected where the length of the 21700 Li-ion buffer cell 1031 and the narrow dimension of PCB 1037 match that of the longer PEM module 1033. Overall, the enclosure 1030 dimensions of this m=50 buffered fuel cell design are Z_{BFC}=10.2 cm long, Y_{BFC}=8.0 cm wide, and X_{BFC}=2.4 cm deep comprising a surface area of 82 cm² with a volume of 196 cm³ excluding any hydrogen fuel container volume, an area and volume slightly smaller than the dual buffer design. Because the m=50 BFC module has an active PEM area 3.33× that of the m=15 design, is recharge time is one-third that of its smaller BFC counterpart. In a split MEA design, gas plumbing is more complex requiring external ports and intra-module gas connections. As an example, module 1030z includes external gas ports 1034a to 1034d connected to MEA 1033z, external gas ports 1034e and 1034f connected to MEA 1032z, and gas ports 1035a and 1035b interconnecting MEA 1033z to MEA 1032z.

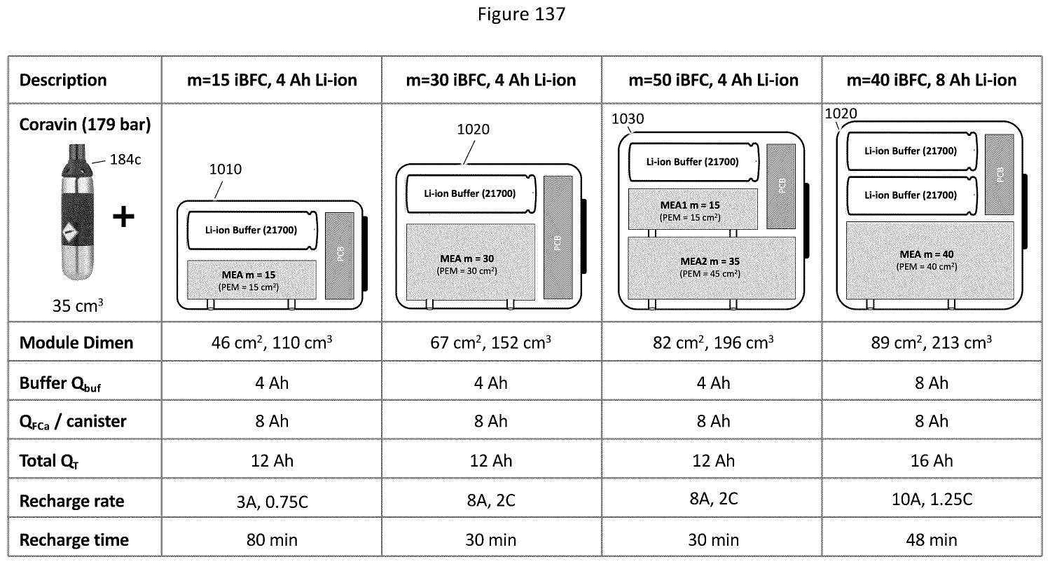

FIG. 137 summarizes the four described buffered fuel cells describing the modules dimension by area and volume, the total charge Q_{buf} contained as electric charge in the Li-ion buffer cell or array of cells, the equivalent electronic charge Q_{FCa} at 179 bar contained in a Coravin style canister having a volume 35 cm², and the total charge Q_{T}=Q_{buf}+Q_{FCa}. The table also lists the recharge rate with current measured in mA and C-rate, and the recharge time required to fully replenish the buffer to full capacity. As shown, the four module designs 1010, 1020, 1030, and 1040 represent volumes ranging from 110 cm³ to 213 cm³ in increments of 1×, 1.46×, 1.78×, and 1.93× respectively not counting the volume of a gas canister such as 184c. Including 8 Ah of fuel cell charge contained in a Coravin like gas capsule 184c, the four designs are capable of storing and delivering a total charge of 12 Ah, 12 Ah, 12 Ah, and 16 Ah respectively, and amount 2.5 times the capacity of a notebook computer. Accordingly, the single buffer cell designs deliver 67% of the total energy from the fuel cell and only 33% from the stored electrical energy while the dual buffer cell design comprises half coulombic energy and half hydrogen without replenishing fuel.

To compare energy density of BFCs, the volume of the gas container must be included in the calculation where the m=15 BFC has occupies a total volume of 110 cm³+35 cm³=145 cm³; the m=30 BFC has a combined volume of 187 cm³; the m=50 design has a total volume of 231 cm³; and the dual buffer cell BFC occupies a volume of 248 cm³. Using these total volumes, the corresponding volumetric charge density for the m=15 buffered fuel cell is Q_{T}/vol=(12000 mAh/145 cm³)=83 mA/cm³. Similarly for m=30 at 187 cm³, charge density is 64 mA/cm³ and for m=50 at 231 cm³, 52 mA/cm³. For the dual buffer design Q_{T}/vol=(16000 mAh/213 cm³)=75 mA/cm³.

Comparing the change contained in the 20.7 ml Coravin canister 184c similar in volume to the 21700 Li-ion cylindrical cell, the battery cell contains 4 Ah while hydrogen gas at 179 bars contains 8 Ah. Essentially using Li-ion chemistry, two 21700 cans hold the same energy as a single gas capsule of slightly smaller dimensions and volumes. But unlike the lithium ion electrochemistry needing time to recharge, an additional 8 Ah of charge can instantly add charge to the fuel cell.

Dynamic Fuel Cell Topology. One embodiment of the intelligent buffered fuel cell or iBFC 421 shown previously in FIG. 44, fuel control module 420c is able to dynamically reroute the electrical connections within fuel cell array 419. In a dynamic fuel cell array, the topology electrically interconnecting the fuel cells into a grid like array may be changed. Topological changes may include
Disconnecting a fuel cell from the array using a transistor to create an open circuit.
Rerouting current using transistors to emulate a single-pole double-throw switch or SPDT.
Shorting out a fuel cell by a transistor so that current is bypassed around a fuel cell removing its voltage contribution and shunting its insertion resistance by a lower resistance transistor.
Disconnecting unused or shunted fuel cells from the gas supply thereby conserving fuel.

In such implementations, the decision to reconfigure an array may be based on detecting voltage, measuring currents, or by analyzing environmental conditions such as temperature, humidity, or responding to communication over an external bus to a system controller. Reconfiguring the array of cells is performed by transistors which may include bipolar transistors or MOSFETs possibly also involving diode conduction. Among these MOSFETs make the best switches as they exhibit linear characteristics with no voltage offsets.

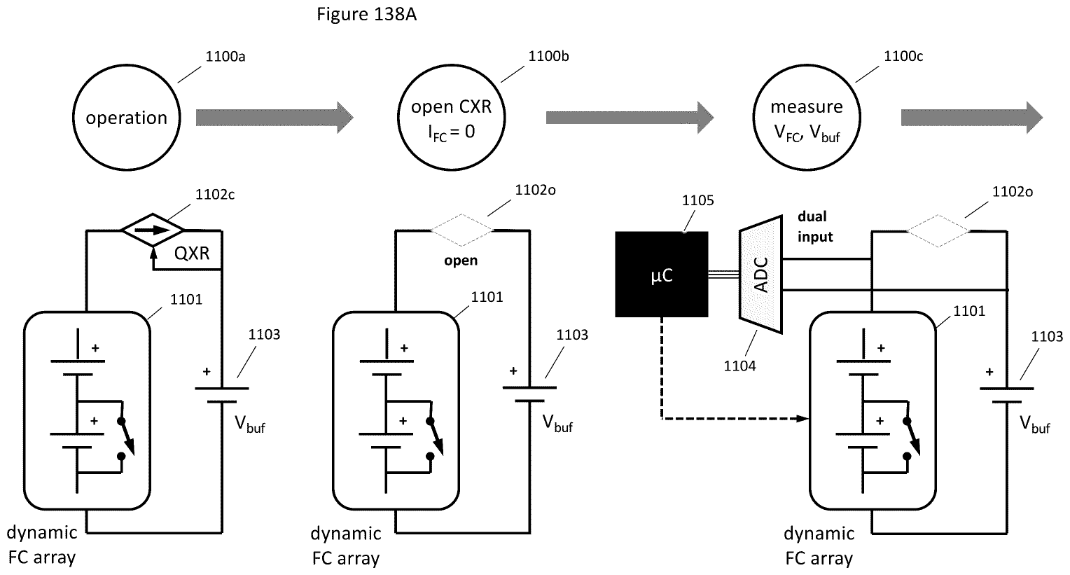

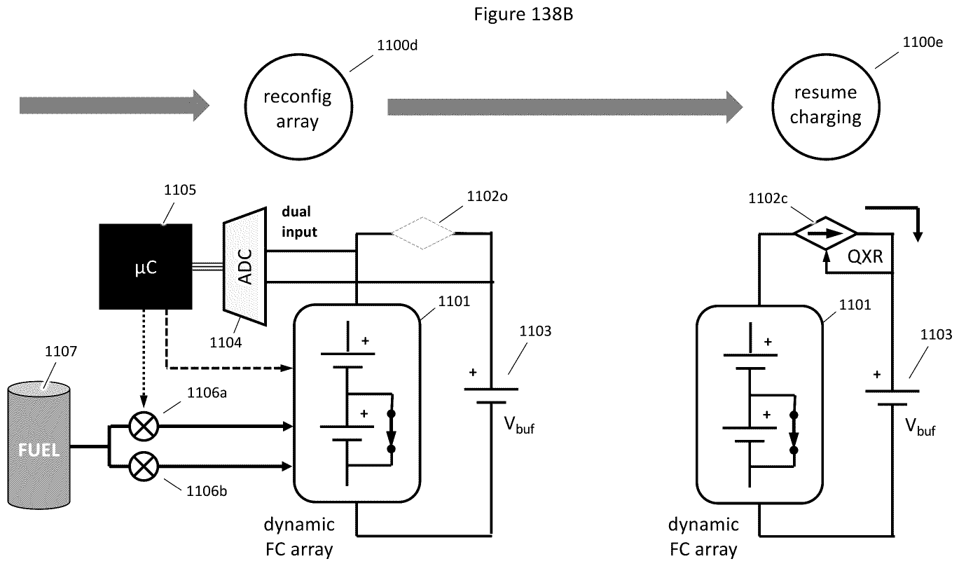

In one embodiment, a microcontroller is used to decide what configuration of fuel cells to select based on the respective voltages of the fuel cell array and of the voltage of the buffer cell. To determine both independently with the greatest precision, the two components must be momentarily disconnected from one another to facilitate voltage, charge, or current measurements. For example, FIG. 138A illustrates a flow chart for measuring the state of a fuel cell array by momentarily discontinuing operation. During operation mode 1100a, dynamic fuel cell array 1101 transfers charge to buffer 1103 through QXR charge transfer regulator 1102c. Because the low impedance and current demands of buffer 1103 electrically loads fuel cell array 1101, the only proper means by which its true electrical state can be ascertained is by momentarily disconnecting the two components.

The first step, isolating electrical component 1100b is performed using digital control of the QXR charge transfer regulator 1102c by making it an open circuit, i.e., functioning like a switch so that I_{FC}=0. Once the QXR charge transfer regulator is biased into an open state 1102o measurements on the fuel cell 1101, the buffer 1103, or both can be performed as shown in step 1100c. For example, using a multiplexed or dual input ADC analog-to-digital converter 1104 the voltage V_{FC}Of fuel cell 1001 and on buffer V_{buf} 1103 can be independently and concurrently measured, converted into a digital code. The code is then passed to a microprocessor, microcontroller, or logic integrated circuit 1105 to algorithmically determine the optimum configuration of the fuel cell array 1101.

Continuing the flow chart in FIG. 138B, in step 1100d the microcontroller then reconfigures the fuel cell array by turning on and off various transistors within the dynamic fuel cell array 1101 and gas 1106a and 1106b microvalves to eliminate fuel waste in dormant cells. Thereafter, in step 1100e the QXR is reactivated 1102c resuming normal charging, albeit using a newly configured fuel cell array. The term dynamic refers to the fuel cell controllers ability to reconfigure itself at anytime and repeatedly during operation. Although the flow chart shows the process of disconnecting the fuel cell from the buffer cell to accommodate independent measurement of each, in practice they may remain connected and a single voltage be used to determine the best array topology.

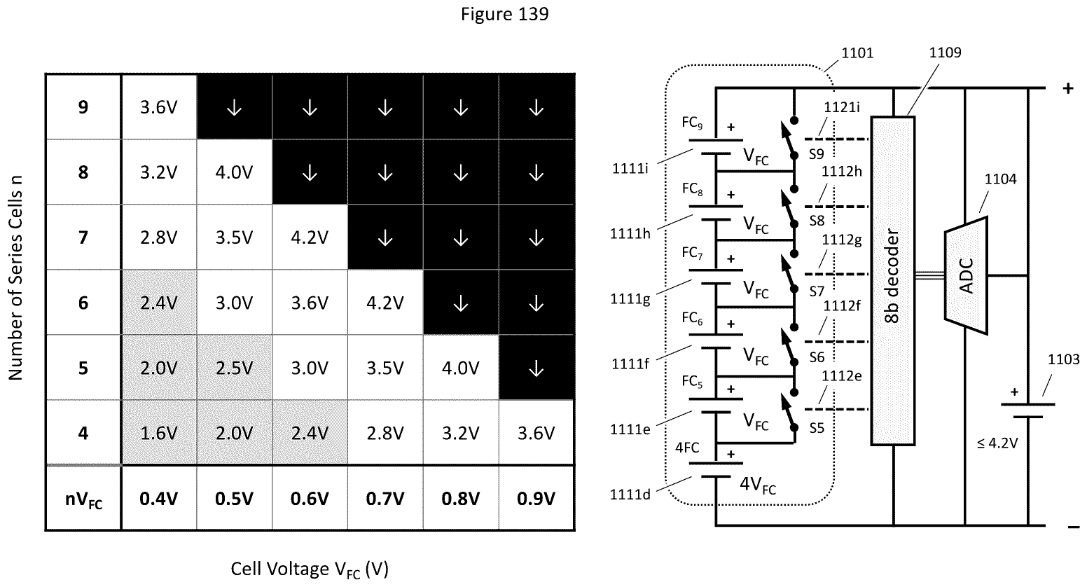

FIG. 139 for example illustrates on embodiment of the circuit function and voltage response surface of dynamic fuel cell array function 1101. As shown, the digital output of analog-to-digital converter 1104 measuring the voltage V_{buf} of buffer cell 1103 is processed by a digital decoder 1109 into separate gate control signals 1112e through 1112i controlling an array of switches S5 through S9 to shunt various combinations of fuel cells FC₅ through FC₉. Specifically, output 1112e controls switch S5 shunting FC₅ fuel cell 1111e; output 1112f controls switch S6 shunting FC₆ fuel cell 1111f; output 1112g controls switch S7 shunting FC₇ fuel cell 1111g; output 1112h controls switch S8 shunting FC₈ fuel cell 1111h; and output 1112i controls switch S9 shunting FC₉ fuel cell 1111i. The first four fuel cells is the stack 111d are always in the circuit to maintain an absolute minimum voltage needed for operation.

Dynamic operation is shown in the response surface for 4-to-9 series cells operating for a voltage range of 0.4V per cell up to 0.9V. Although numerous algorithms are possible, one algorithm involves reducing the series number of cells by one cell whenever the fuel cell voltage exceed 4.2V. The cell is removed by shorting it out by one of the shunt switches, indicated in the response surface as a downward pointing arrow. For example, in the cell (V_{FC}, n)=(0.9V, 5) =4.5V>4.2V the voltage is 4.5V so the matrix reconfigures by shunting one cell, thereby dropping the voltage from 4.5V to 3.6V. Since the cells are identical and approximately equal in voltage which specific cell is shorted out doesn't matter.

Similarly, if n=8 cells are active and the fuel cell voltage jumps from 0.5V to 0.7V due to a sudden change in humidity or temperature, then the (V_{FC}, n)=(0.7V, 8)=5.6V>4.2V results in a 5.6V stack voltage. In such a case, dropping only one cell out of the FC stack reduces the fuel cell voltage by 0.7V to (V_{FC}, n)=(0.7V, 7)=4.9V>4.2V which at 4.9V is still too high to charge the buffer without regulation. Dropping two cells out of the array reduces the voltage to (V_{FC}, n)=(0.7V, 6)=4.2V which is within the safe range for the buffer charging without QXR charge transfer regulation.

Operation this example of dynamic array control is to allow the maximum safe voltage to impressed on the fuel cell array until the buffer voltage approaches the V_{OC} safety limit. Rather than relying on the regulator function within the QXR charge transfer regulator to clamp the voltage and waste power from fuel cells that are not needed, the number of series connected fuel cells can be reduced to minimize the charging headroom once the target voltage is reached.

In another embodiment of a dynamic fuel cell, the logical algorithm is a sequential state machine, deciding which shunt transistors to turn on and off based on a given state then ascending from a lower voltage to a higher, or conversely starting at a higher voltage then descending to a lower voltage state by shunting more fuel cells.

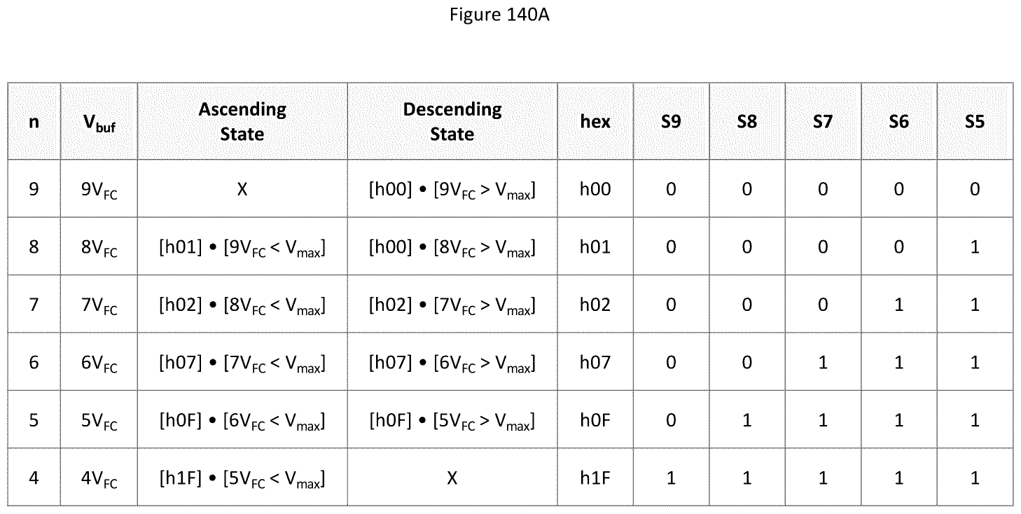

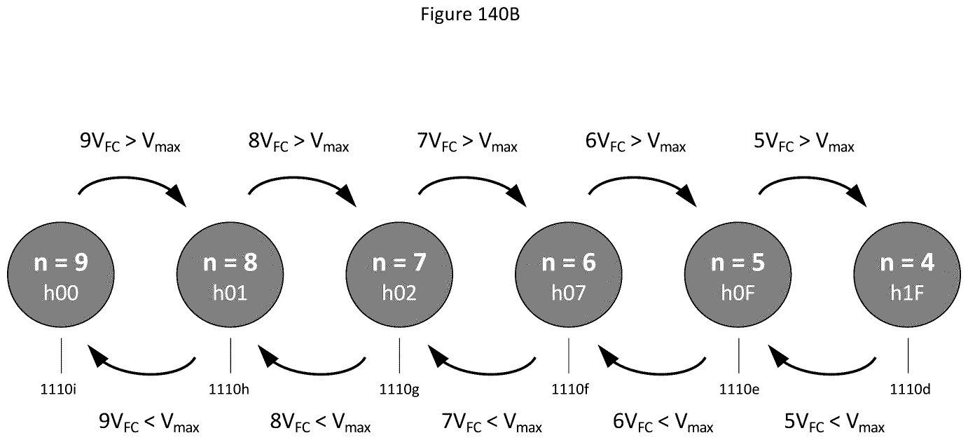

In the state table shown in FIG. 140A, the highest voltage state ⁹V_{FC} occurs when the stack voltage is too low and all cells are needed to maximize charging. The resulting hexadecimal code h00 means all shunt switches are biased off, i.e., open, so that all cells are working to convert fuel into electrical energy. The lowest voltage state ⁴V_{FC} occurs when the stack voltage is too high and all cells are needed to limit charging and reduce losses in the voltage regulator by shunting out fuel cells FC₅ through FC₉ but leaving the lowest four fuel cells FC₁ to FC₄(not shown) still operating. The hexadecimal code h1F has a corresponding binary code [0001111] where the binary “1” means the shunt transistors are turned on and the corresponding fuel cells are shorted out.

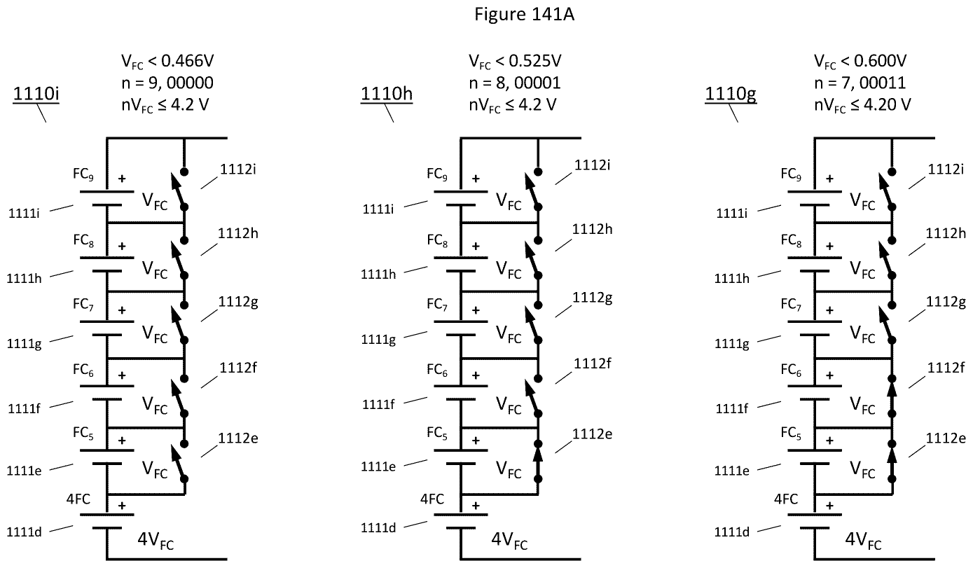

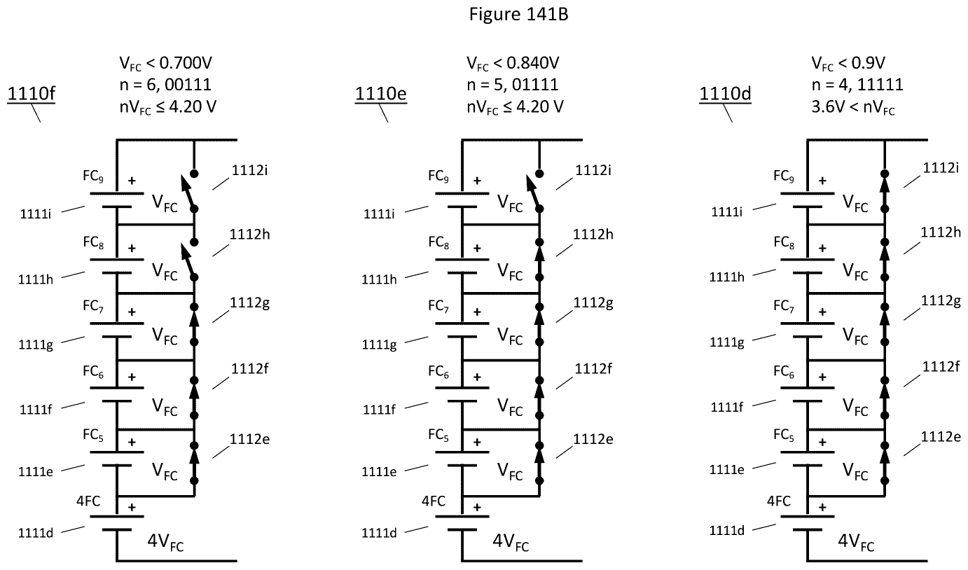

The transitions can be represented in a state diagram as shown in FIG. 140B listing the conditions to increase or decrease the number of active fuel cells in accordance with six different states 1110i through 1110d as depicted by the six equivalent circuits in FIG. 141A and FIG. 141B. For example, in state of 1110i of FIG. 141A shunt switches 1112e through 1112i are all open and the stack voltage is ⁹V_{FC}. In state 1110h, one shunt switch is closed and the rest remain open so the stack voltage is 8V_{FC}. Schematically this condition is represented by shunt switch 1112e being closed but this choice is arbitrary. In state 1110g, two shunt switches are closed and three remain open so the stack voltage is 7V_{FC}. Schematically this condition is represented by shunt switches 1112e and 1112f being closed but this choice is arbitrary.

Continuing with state of 1110f of FIG. 141B shunt switches 1112e through 1112g are closed while switches 1112h and 1112i remain open and the stack voltage is 6V_{FC}. In state 1110e, every shunt switch except 1112i are closed so the stack voltage is 5V_{FC}. In state 1110d, every shunt switch is closed so the stack voltage reverts to ⁴V_{FC} the voltage supplied by only the four series connected un-shunted cells 1111d.

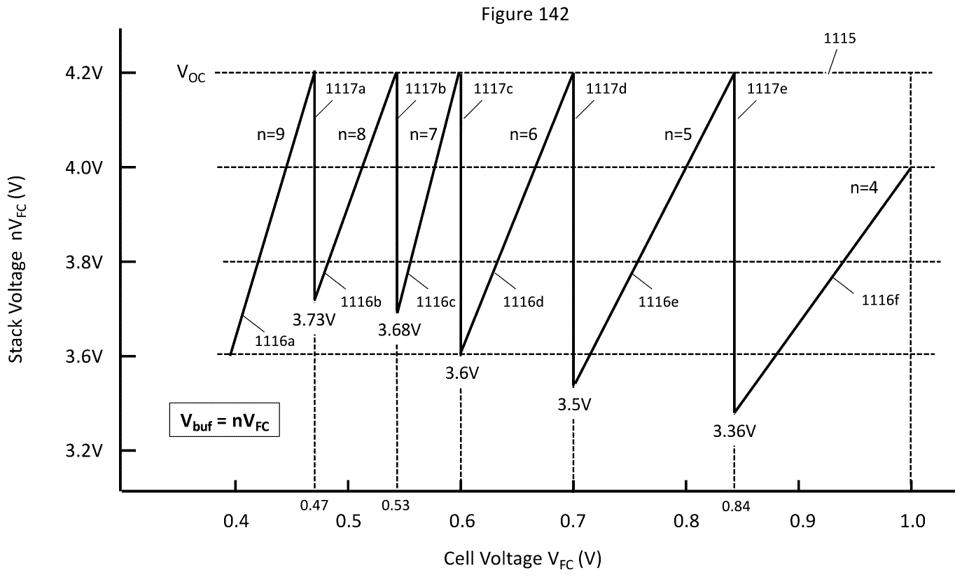

In general, state changes occur sequentially and progressively so that states are not skipped especially since charging and discharging of the high capacity buffer cell is a slow process. The resulting stack voltage nV_{FC} of the dynamic array changing as a function of fuel cell voltage V_{FC} is illustrated by the sawtooth shaped voltage pattern shown in FIG. 142. As shown each time the cell voltages become too high the stack voltage hits the upper V_{OC} limit 1115 and one cell is removed.

For example, between cell voltages of 0.4V and 0.47V a n=9 fuel cell stack exhibits a rising voltage 1116a until it reaches V_{OC}, then one cell is shunted to n=8 instantly dropping the voltage by transition 1117a back to 3.73V. Voltage during charging then increases 1116b until the stack hits V_{OC} at a cell voltage of V_{FC}=0.53V at which point another fuel cell is shunted so n=7 dropping the voltage 1117b back to 3.68V. The pattern continues with charging 1116c up to V_{OC} when V_{FC}=0.6V, thereafter reducing the active cells to n=6 dropping the voltage 1117c down to 3.6V. Ramp 1116d then ensues until V_{FC}=0.7V when the stack is reduced to n=5 and the voltage drops 1117d down to 3.5V. Ramping 1116e occurs until V_{FC}=0.84V/cell where the number of cell is reduced to n=4 and the stack voltage drops 1117e to 3.36V. For fuel cells above 0.84V the cell count is fixed to n=4 illustrated by ramp 1116f.

The process shown is agnostic to whether the fuel cell voltage V_{FC} is rising or falling due to environmental conditions. This algorithm never exceeds line 1115 representing the value V_{OC} so it does not rely on the voltage regulation function within the QXR charge transfer regulator unless a switch malfunction occurs. Because however the voltage never exceeds the safety limit the charging rate is slowed by a lower average value of headroom. Headroom is the voltage difference between the fuel cell stack voltage nV_{FC} and the buffer voltage V_{buf}(t) during charging, i.e., (nV_{FC}−V_{buf}(t)). Greater headroom charges faster but loses more energy to waste heat in the QXR.

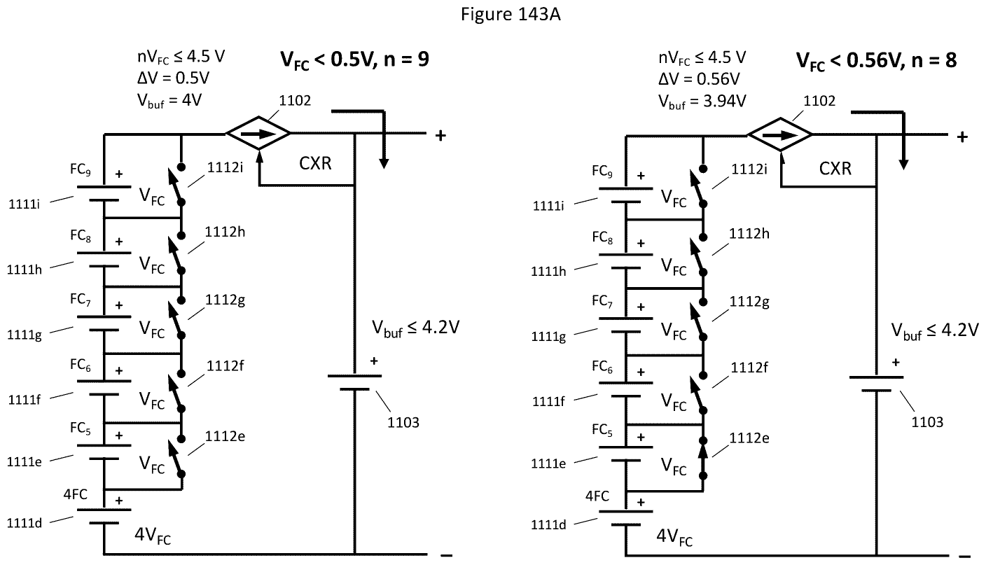

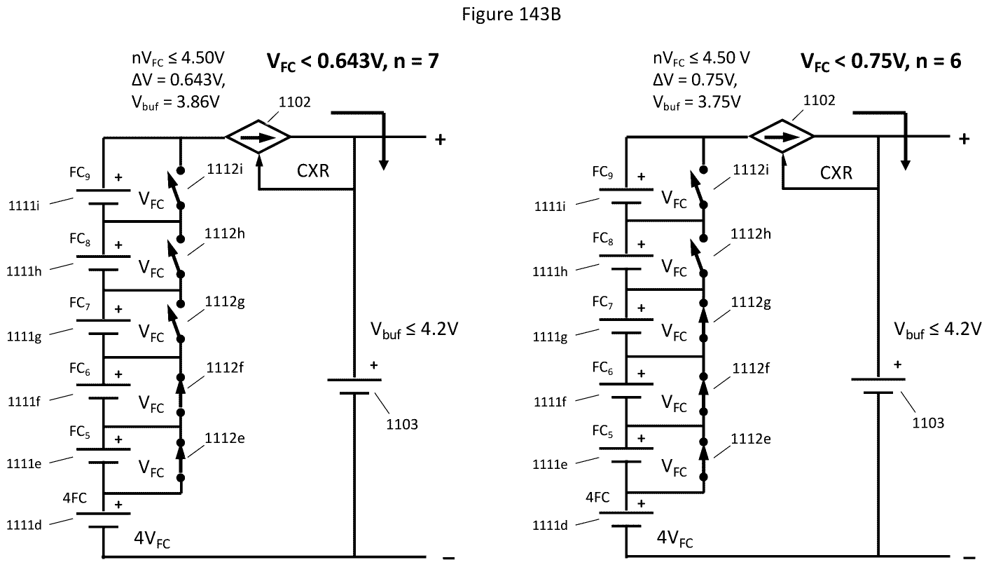

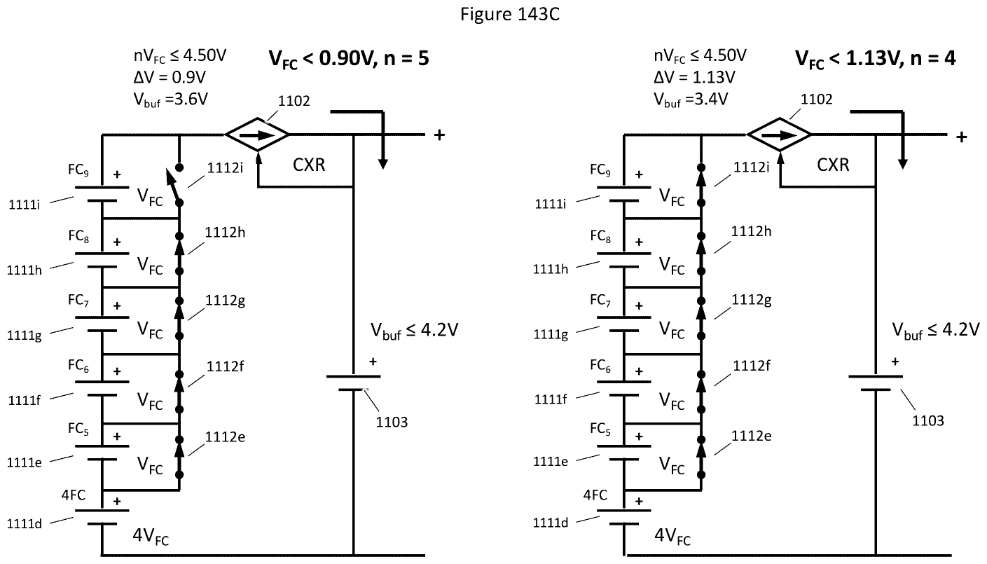

An alternative embodiment is to intentional bias connect the fuel cells to a higher voltage than V_{OC} and to rely on the voltage regulator function within the QXR charge transfer regulator to protect against the overvoltage condition. This type of dynamic fuel cell topology ensures the maximum charging at all times. For example, as shown in FIG. 143A intrinsic QXR charging employs a n=9 fuel cell stack when V_{FC}<0.5V and ⁹V_{FC}≥4.5V then dynamically switches to n=8 when ⁹V_{FC}<4.5V. During this interval the QXR regulator function supports the extra voltage headroom of (⁹V_{FC}−V_{OC})=(4.5V−4.2V)=0.3V, losing only 0.3V out of 4.5V or only 7% to regulator losses. FIG. 143B illustrates intrinsic QXR charging when n=7 for voltages V_{FC}≤0.643V and n=6 for voltages V_{FC}≤0.750V. FIG. 143C illustrates intrinsic QXR charging when n=5 for voltages V_{FC}≤0.9V and n=4 for voltages above 0.9V, as defined by the inequality where 0.9V<V_{FC}≤1.13V.

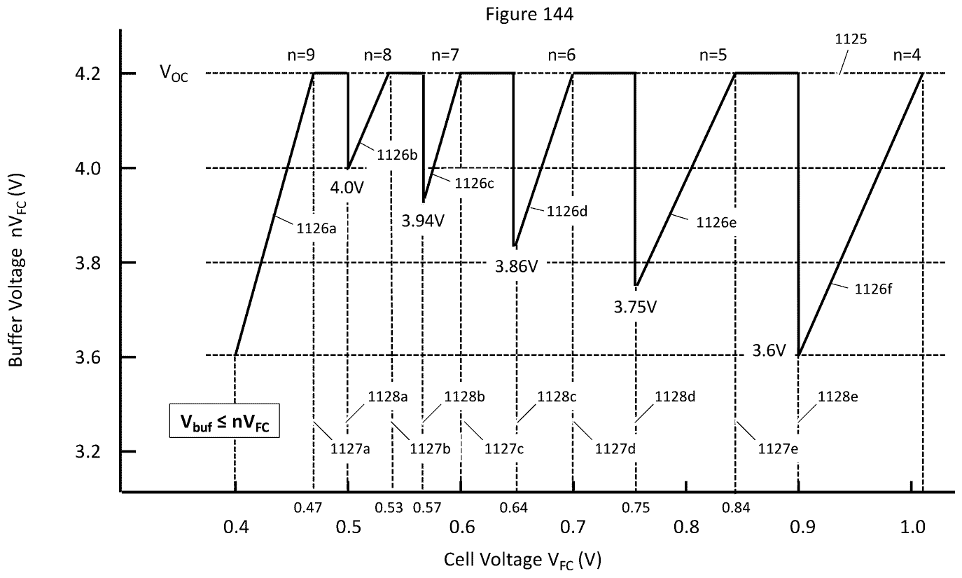

In this manner the dynamic fuel cell topology maintains an array stack voltage between 4.2V and 4.5V while the QXR regulator prevents the Li-ion buffer voltage V_{buf}(t) from ever exceeding V_{OC}=4.2V. This improved charging efficiency is illustrated in a graph of fuel cell stack voltage nV_{FC} versus cell voltage V_{FC} shown in FIG. 144 where the maximum buffer voltage is clipped to 4.2V but the average charging voltage is approximately 4.0V. Although the voltage transfer function is state based, i.e., path and time independent, it is easier to interpret the transitions as a ramp up or down in the fuel cell voltages where each band of voltages contains a linear function of fixed slope marked by discrete transitions in the number of active fuel cells in the array.

For example, in the n=9 band spanning the range 0.4V≤V_{FC}≤0.47V the fuel cell stack exhibits a linear voltage dependence 1126a between 3.6V as the lower boundary and V_{OC}=4.2V as the upper boundary. In the n=9 voltage clamped region between transitions 1127a and 1128a the stack voltage remains constant at 4.2V as defined by the QXR charge transfer regulator. At the transition 1128a, when the unloaded stack voltage equals nV_{FC}=9(0.5V)=4.5V the number of active cell is reduced by one cell to n=8 and the stack voltage drops to 4.0V.

Similarly in the n=8 band spanning the range 0.5V<V_{FC}≤0.53V the fuel cell stack exhibits a linear voltage dependence 1126b between 4.0V as the lower boundary and V_{OC}=4.2V as the upper boundary. In the n=8 voltage clamped region between transitions 1127b and 1128b the stack voltage remains constant at 4.2V as defined by the QXR charge transfer regulator. At the transition 1128b, when the unloaded stack voltage equals nV_{FC}=8(0.57V) 4.5V the number of active cell is reduced by one cell to n=7 and the stack voltage drops to 3.94V.

Within the n=7 band spanning the range 0.57V<V_{FC}≤0.60V the fuel cell stack exhibits a linear voltage dependence 1126c between 3.94V as the lower boundary and V_{OC}=4.2V as the upper boundary. In the n=7 voltage clamped region between transitions 1127c and 1128c the stack voltage remains constant at 4.2V as defined by the QXR charge transfer regulator. At the transition 1128c, when the unloaded stack voltage equals nV_{FC}=7(0.64V)≈4.5V the number of active cell is reduced by one cell to n=6 and the stack voltage drops to 3.86V. Within the n=6 band spanning the range 0.64V<V_{FC}≤0.70V the fuel cell stack exhibits a linear voltage dependence 1126d between 3.86V as the lower boundary and V_{OC}=4.2V as the upper boundary. In the n=6 voltage clamped region between transitions 1127d and 1128d the stack voltage remains constant at 4.2V as defined by the QXR charge transfer regulator. At the transition 1128d, when the unloaded stack voltage equals nV_{FC}=6(0.75V)=4.5V the number of active cell is reduced by one cell to n=5 and the stack voltage drops to 3.75V. Within the n=5 band spanning the range 0.75V<V_{FC}≤0.84V the fuel cell stack exhibits a linear voltage dependence 1126e between 3.75V as the lower boundary and V_{OC}=4.2V as the upper boundary. In the n=5 voltage clamped region between transitions 1127e and 1128e the stack voltage remains constant at 4.2V as defined by the QXR charge transfer regulator. At the transition 1128e, when the unloaded stack voltage equals nV_{FC}=5(0.9V)=4.5V the number of active cell is reduced by one cell to n=4 and the stack voltage drops to 3.6V. Above V_{FC}=0.9V the fuel cell stack exhibits a linear voltage dependence 1126f.

The addition of the voltage clamped regions at V_{FC}=0.47V, 0.53V, 0.6V, 0.7V, and 0.84V shifts the average voltage of the transfer function up from that of the implementation shown previously in FIG. 142 where the stack voltage instantly drops by one cell whenever nV_{FC}=V_{OC} shown by line 1115.

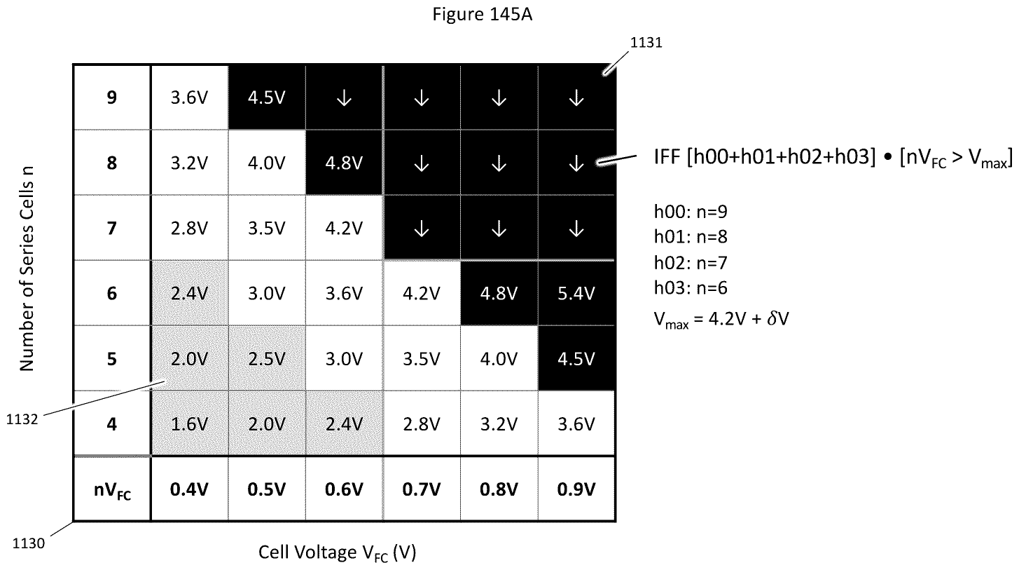

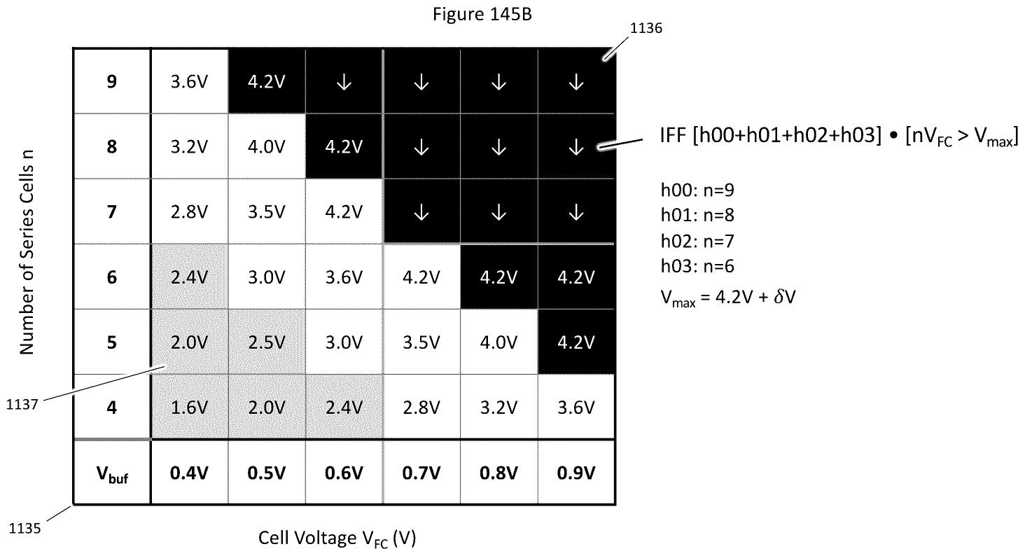

The resulting response surface achieved by shifting the average voltage higher and relying on voltage regulation shown in FIG. 145A maintains a fuel cell voltage nV_{FC} ranging from 4.5V to 5.4V whenever the fuel cells are capable of fully charging the buffer to 4.2V. The logical condition to decrease the stack of n cells as illustrated by downward pointing arrows occurs if-and-only-if the cell voltage stack exceeds Vₘₐₓ=V_{OC}+δV where δV=V_{FC} is the voltage change whenever the number of cells changes by Δn=1. In Boolean form the shift down is given by the logical statement IFF{[h00+h01+h02+h03]·[nV_{FC}>Vₘₐₓ]} is true. In Boolean expressions the term IFF means if-and-only-if, the plus symbol + means “inclusive OR”, i.e., “either/OR” in common language meaning at least one argument is true; and the · multiply symbol means a logical AND, a condition where both arguments must be true. This method means a single value of Vₘₐₓ such as 5V can be chosen for all conditions rather than determining the transition voltage for every change in V_{FC}. Although Vₘₐₓ>V_{OC}, the precise value of Vₘₐₓ for the fuel cell is not critical as the QXR never allows the buffer voltage V_{buf} to exceed the overcharge voltage or operate outside of its SOA. As such the relation Vₘₐₓ>V_{OC} >V_{buf} allows the peak voltage of the fuel stack to routinely operate above the overcharge voltage without risking damage to the buffer cell.

FIG. 145B illustrates the same response surface except it includes the action of the QXR charge transfer regulator clamping the output voltage V_{buf} to QXR to 4.2V. In essence the response surface of the aforementioned FIG. 145A describes the input voltage of the QXR supplied by the changing topology of the dynamic fuel cell array while FIG. 145B describes the voltage clamped output of the QXR used to charge the buffer cell. Because the QXR categorically protects the buffer from an overvoltage condition, the Boolean logic can be modified to allow specific combinations without changing the analog circuitry, meaning the function of the dynamic fuel cell array is digitally programmable, not relegated to only analog circuit implementations. For example, should the Boolean condition be changed to exclude the state h03, i.e., where the dynamic state change follows the condition IFF {[h00+h01+h02]·[nV_{FC}>Vₘₐₓ]} then the cell (V_{FC}, n)=(0.6V, 9) would be allowed to rise to 5.4V rather than transitioning to n=8 falling back to 4.8V. Since the cell is clamped to 4.2V by the QXR then as long as the QXR can tolerate the higher input voltage the voltage response surface is essentially the same electrically, that the buffer is limited to 4.2V. The maximum voltage of the stack is limited not by the buffer or fuel cell but by the integrated circuit process used to fabricate the switch matrix controlling the fuel cell array. Commonly available processes include 5V CMOS which work reliably up to 5.5V; 12V CMOS processes that work reliably to 13.2V; and 30V BCD bipolar-CMOS-DMOS processes that reliably operate up to 30V.

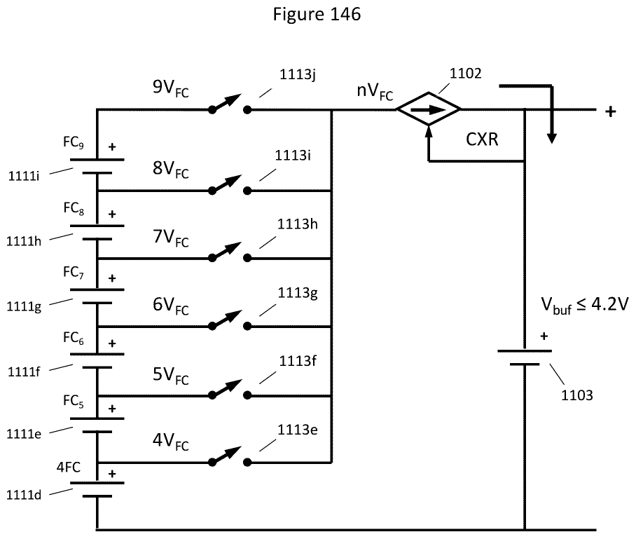

Although the prior circuit examples illustrates shunt switches shorting out bypassed fuel cells, a single-pole multi-throw analog switch aka analog multiplexer can also be used to select the number of cells included in the stack. As shown in FIG. 146, an analog multiplexer comprising six switches 1113e to 1113j is used to select which series connected fuel cells are connected to QXR 1102. In analog multiplexer operation only one switch is turned on at a time. If only switch 1113e is turned on nV_{FC}=⁴V_{FC}. If instead switch 1111g is turned on the output nV_{FC}=6V_{FC}. If the topmost switch 1113j is turned on then nV_{FC}=⁹V_{FC}. The voltage selector needn't be linear. Different combinations of 1, 2 or 3 fuel cells are possible.

BFC Fuel Control. As an adjunct to dynamic fuel cell topologies, another embodiment of this invention is the means to prevent fuel from being consumed by bypassed fuel cells. In dynamic BFC arrays, disabled cells are bypassed or electrically shorted. Although a bypassed fuel cell does not contribute to the series stack voltage or the fuel's cells series resistance it remains electrochemically active converting hydrogen into electric current. Having electrically shorted terminals, the current the disabled cell generates is conducted within the MOSFET short used to perform the bypass.

As a result, all the electric current the fuel cell produces is turned to heat in the shunt device housed within the fuel cell itself. Specifically, a 1.2Ω fuel cell producing 0.7V shorted by a 0.2Ω MOSFET results in a 0.50 A current loop dissipating 300 mW in the cell and another 50 mW power loss in the shunt transistor. While this heat is not excessive, the fuel used to produce it is altogether wasted.

In order to conserve fuel and not waste it supplying bypassed fuel cells, the same fuel cell control module used to dynamically reconfigure can be used to disconnect the fuel supply from shunted cells. As first illustrated previously in FIG. 138B, using a valve to cutoff the hydrogen supply prevents PEM layer electrochemical reactions, conserving fuel for use elsewhere or at a later time. Although theoretically each PEM layer could include its own microvalve and independent fuel management, the cost and complexity is neither practical nor necessary. Rather than dynamically reconfiguring a fuel cell array one cell at a time, a more pragmatic solution is to employ “banking,” i.e., reconfiguring the cell topology in groups of cells called banks.

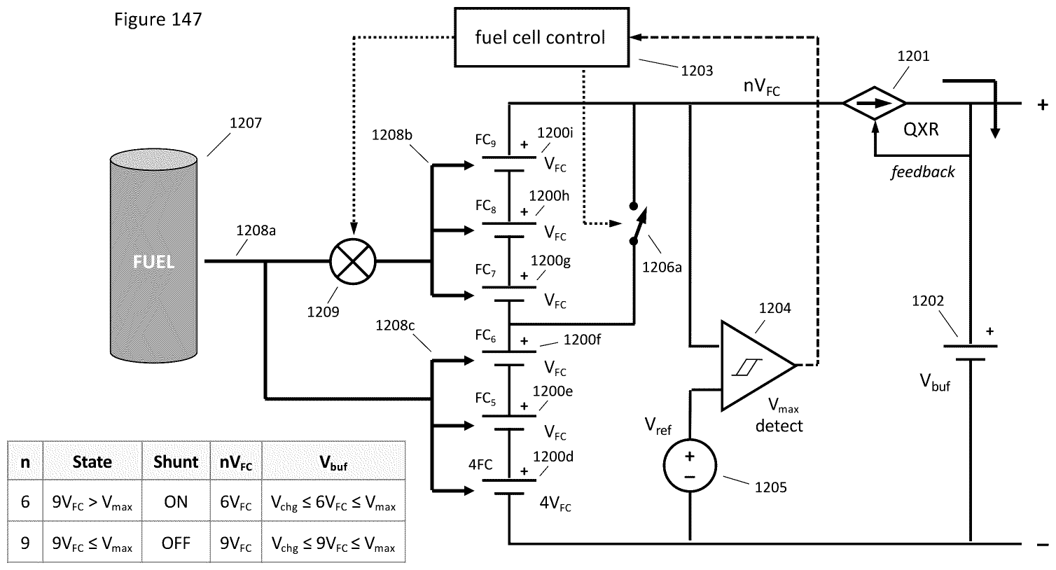

For example, in FIG. 147 is a schematic of a dynamic fuel cell array and its corresponding truth table. As shown the array comprises a series stack of nine fuel cells broken into two banks—one bank comprising six fuel cells 1200d, 1200e, and 1200f respectively labelled as 4FC, FC₅ and FC₆; the other bank comprising three fuel cells 1200g, 1200h, and 1200i labelled as FC₇, FCs, and FC₉. Although these cells may be shorted individually each using a dedicated MOSFET as a shunt, in the banked array, a single MOSFET switch 1206a functions as a shunt to the series connection of FC₇, FC₈, and FC₉. The shunt MOSFET switch 1206a responds to digital, i.e., on/off, commands from the fuel cell control module 1203 reacting to the Vₘₐₓ detect comparator 1204.

The Vₘₐₓ comparator 1204 compares the fuel cell voltage nV_{FC} or some scaled “proxy” voltage thereof to voltage reference 1205. The measured proxy voltage for example can for example comprise a sense voltage Vₛ derived from a resistive voltage divider adjusted to any fraction of the fuel cell voltage. Using this scaling principal, whenever Vₛ>V_{ref} then nV_{FC}>Vₘₐₓ and bypass switch 1206a is activated—dynamic fuel cell array operation referred to herein as “bypass mode”. In the example shown, during bypass mode when 9V_{FC}>Vₘₐₓ, the fuel cell control module turns on shunt 1206a, reducing n=9 to n=6. Accordingly, the input voltage to QXR 1201 is reduced by 33% limiting the maximum charging voltage of buffer 1202 to 6V_{FC}. Although the Vₘₐₓ comparator can operate perpetually, in one embodiment the QXR is momentarily biased into an open state so that measurements can be performed without electrical loading. Even when the QXR is temporarily disabled the electrical load of the buffered fuel cell is unaware of the measurement as buffer cell 1202 continues to provide uninterrupted electrical power to the BFC's output terminals. In this manner the fuel cell array can be dynamically reconfigured to divert current or bypass cells without the electrical load being aware of changes internal to the fuel cell itself or the charging rate therefrom.

Concurrently gas valve 1209 cuts fuel supplied from tank 1207 from the bank of bypassed fuel cells 1200g, 1200h, and 1200i to preserve fuel and prevent unnecessary waste heat. As shown, the schematic illustrates the fuel valve affects all electrically bypassed cells. In practice, not every bypassed fuel cell necessarily requires fuel valve control. As shown, gas supply 1208a is divided into two gas supply paths—gas supply 1206b which includes valve 1209 and has supply 1208b which does not include a gas valve.

Added pressure regulators (not shown) may be included to prevent changes in pressure as gas flows are toggled on and off. Moreover, not every fuel cell capable of electrical bypassing necessarily needs to be included in the bypass bank. Instead, some cells may be included in the bypass bank and other cells may include their own dedicated bypass transistors, with or without fuel valve control of hydrogen flow. The only combination not realizable in normal operation is cutting the fuel supply to a non-bypassed series connected fuel cell as it interrupts current conduction and leads to an open circuit interrupting current in the entire string or stack.

That said, in another embodiment of the dynamic fuel cell, interrupting the gas supply in a series connected fuel cell my be used as a redundant method for interrupting charging in a buffered fuel cell. For example, should the QXR current regulator device fail risking buffer overcharging, a control signal or fault detection signal sent to the fuel cell control module can automatically interrupt gas flow to one or more fuel cells, thereby safely terminating charging. The disclosed method of chemically interrupting the function of an electrical circuit by limiting fuel to a series connected fuel cell represents the first reported use of a chemically controlled electrical gate. This method may be considered a chemical failsafe protection feature but may also be considered a type of chemo-electrical logic.

While the lithium ion buffer voltage V_{buf} cannot exceed V_{OC}, the voltage Vₘₐₓ used to charge the buffer can, and preferably should to speed charging. As implemented the voltage Vₘₐₓ is programmable based on the input to the Vₘₐₓ detect comparator, as set by the value of V_{ref} or a multiple thereof. Made in accordance with system requirements and specifications, the value of Vₘₐₓ is essentially arbitrary primarily because the QXR strictly limits the buffer voltage V_{buf} to a value no greater than V_{OC}. Representing the electromotive force empowering charging, the driving voltage for charging Vₘₐₓ=(V_{OC}+δV) where δV is the overdrive potential above the buffer's overcharge voltage limit V_{OC}.

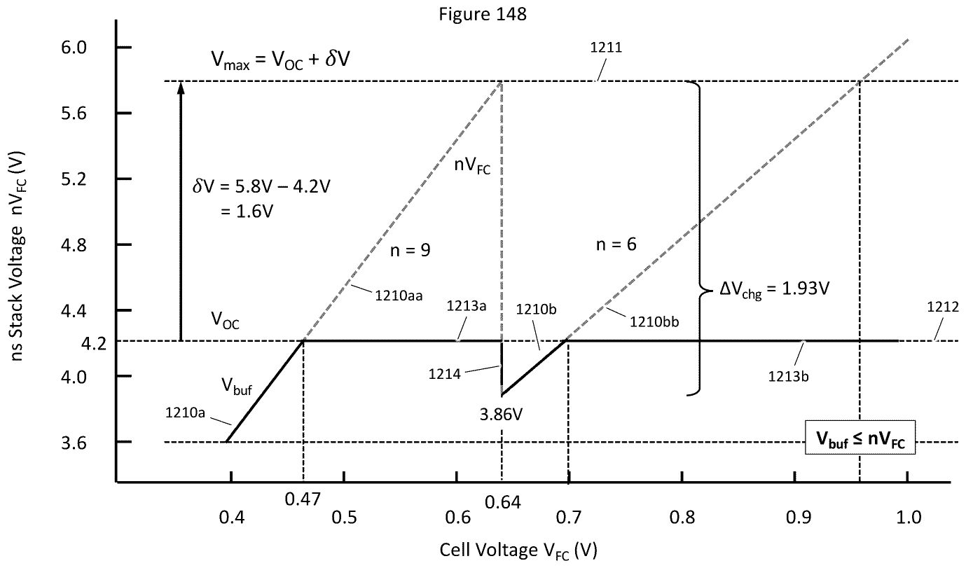

FIG. 148 graphically illustrates the transfer function of a banked dynamic fuel cell where the y-axis is a measure of the fuel cell stack voltage nV_{FC} and the x-axis is the voltage V_{FC} of an individual fuel cell in the stack. The transfer function is not linear because the value of n is dynamically changing. The graph demarcates two key voltages defining dynamic fuel cell operation, namely the safety defined V_{OC} buffer overvoltage limit 1212 and the more arbitrary value Vₘₐₓ as the overdrive voltage δV of the fuel cell where Vₘₐₓ=(V_{OC}+δV).

The transfer function contains two regions—one where V_{FC}≥0.64V and a second region where V_{FC}≥0.64V. In one embodiment, the dynamic fuel design as disclosed comprises a bank of six stacked fuel cells for n=6 operation below V_{FC}≥0.64V and a second bank of three stacked fuel cells with a separate gas port for n=9 operation at V_{FC}≥0.64V. The resulting two-state banked dynamic fuel cell array combined with QXR voltage clamping is able to maintain a very high average cell voltage and state-of-charge for a Li-ion buffer cell in a BFC operating over the full spectrum of fuel cell conditions spanning the range 0.4V V_{FC}≥0.95V. Whenever the buffer cell exceeds is overvoltage limit V_{OC} the QXR clamps its output voltage to ensure V_{buf} V_{OC}=4.2V.

When operating at low cell voltages in the n=9 mode, the fuel cell voltage and buffer voltage rise proportionately 1210a according to the relation ⁹V_{FC}=V_{buf}. Once the condition V_{FC} 0.47V occurs, the maximum buffer voltage is clamped 1212 to V_{OC}=4.2V. Above V_{FC}=0.47V the two V_{buf} and nV_{FC} curves 1210aa and 1213a diverge where the V_{buf} buffer voltage 1213 remains clamped to a V_{OC} overvoltage limit 1212 while the ⁹V_{FC} fuel cell stack voltage tracks the V_{FC} fuel cell voltage proportionately 1210aa with a slope of 9. In this operational region the unclamped stack voltage nV_{FC} comprises the input voltage to QXR charge transfer regulator while the buffer voltage V_{buf} comprises the output voltage of QXR 1201.

Because of the electrochemical storage capacity and high electrical capacitance of buffer cell 1202, the V_{buf} voltage changes slowly compared to the environmentally sensitive fuel cell voltage whereby ⁹V_{FC}>V_{buf}. As such the transfer function is a state based, not time based and does not constitute a waveform. Instead, it illustrates if the buffer is at one voltage and the fuel cell is at another, the transfer function describes the operation of the QXR in that state. Specifically, at or just above V_{FC}=0.64 when ⁹V_{FC}=4.5V, the number of series-connected fuel cells is reduced from n=9 to n=6 and the voltage drops to 6V_{FC}=3.86V. Upon transition 1214, the voltage of the fuel cell and the buffer equilibrate 1210b to V_{buf}=6V_{FC} discounting any time delays in charging the buffer cell to equilibrium. In this operating region V_{FC}≥0.7V, fuel cell stack voltage follows the relation 1210bb according to nV_{FC}=6V_{FC} while the buffer voltage is limited to V_{OC} 1212 as depicted by line 1213b.

In a buffered fuel cell, the rate that the fuel cell stack charges the battery buffer is given by the relation I_{chg}=I_{FC}=ΔV_{chg}(t)/R_{FC} where ΔV_{chg}(t)=nV_{FC}−V_{buf}(t) is referred to as charger headroom. The peak charging rate therefore depends on the fuel cell stack voltage and the buffer voltage as charging commenced. In dynamic fuel cell array operation exemplified by the transfer function shown previously in FIG. 142, the fuel cell stack is limited to nV_{FC}<V_{OC}=4.2V, the starting buffer voltage is Vₙₒₘ=3.6V, and the headroom is ΔV_{chg}=V_{OC}−Vₙₒₘ=4.2V−3.6V=0.6V.

By contrast, in the banked dynamic fuel cell design described here, the fuel cell stack voltage is greater than V_{OC}=4.2V and may be as high Vₘₐₓ where by example Vₘₐₓ=5.8V. In such as case the headroom is ΔV_{chg}=Vₘₐₓ−Vₙₒₘ=5.8V−3.6V=2.2V. Since I_{chg}=ΔV_{chg}/R_{FC}, a headroom of 2.2V in this embodiment produces a peak charging current 3.7× that of the 0.6V headroom of the V_{OC} limited design. The values of Vₘₐₓ is a design parameter where Vₘₐₓ=V_{OC}+δV where δV is referred to as the overdrive capability of the dynamic fuel cell. Given δV=1.6V, the maximum stack voltage Vₘₐₓ=4.2V+1.6V=5.8V. During the transition when response 1210aa hits Vₘₐₓ, the fuel stack voltage drops commensurate with the reduction in active cells from nV_{FC}=9(0.644V)=5.8V to nV_{FC}=6(0.644V)=3.86V representing a dynamic change of 1.93V.

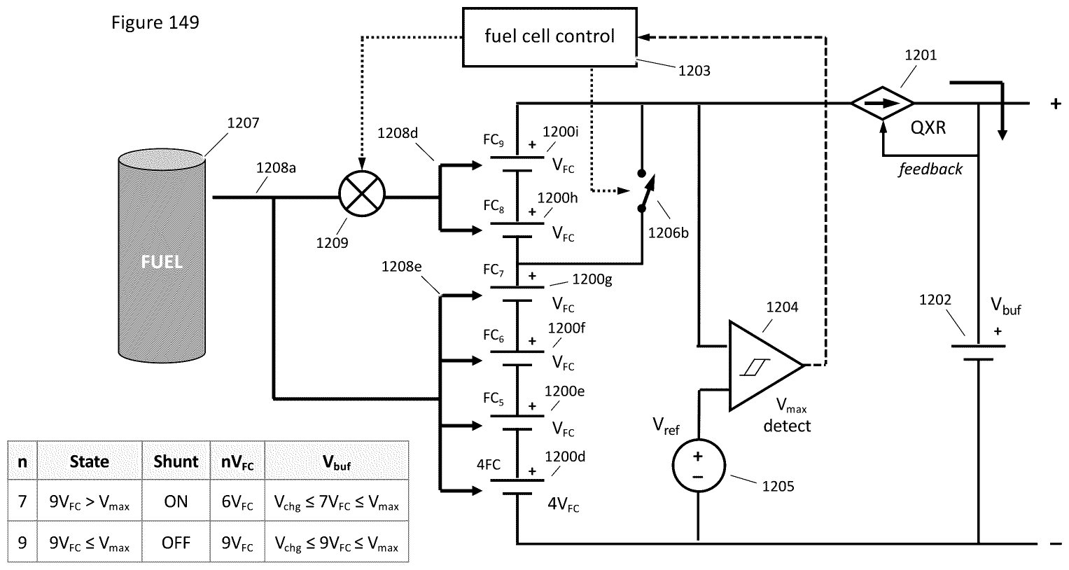

In the alternative embodiment shown in FIG. 149, the fuel cells are divided into two banks, where only the topmost fuel cells 1200h and 1200i labelled FC₈ and FC₉ are banked for bypass and gas cutoff. In this case, the fuel cell array operates in only two states—a 7s array or a 9s array. In this case bypass MOSFET switch 1206b shunts the banked cells 1200h and 1200i. Fuel supply 1208d to the shunted cells is gated by gas valve 1209 where the gas supply 1208e to the remaining cells are not.

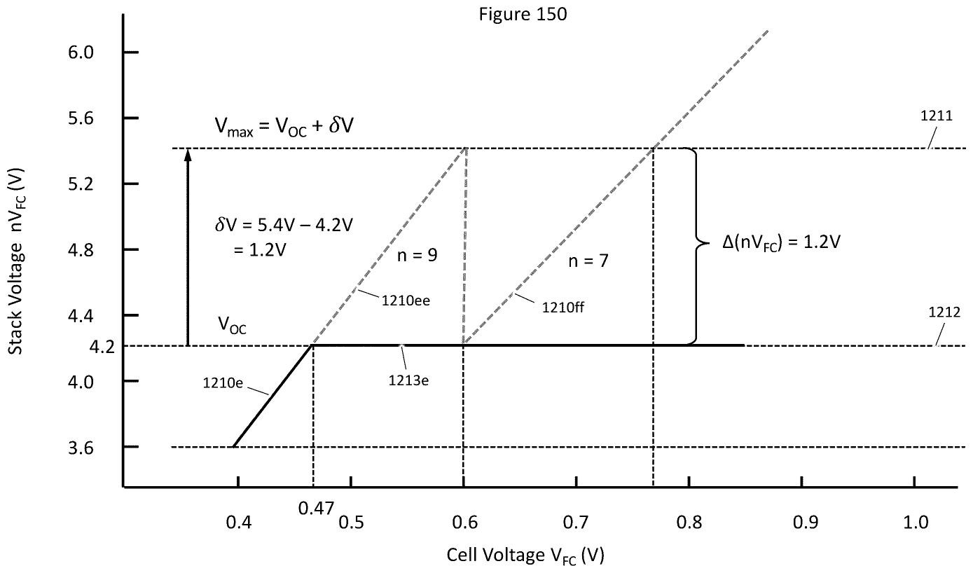

Beneficially, this method increases the average fuel cell voltage driving the charging process. Unlike the previous three banked cell design shown in FIG. 150, the minimum voltage at transition occurs at a voltage at or above 4.2V meaning the circuit operates above V_{OC} 1212 during all charging cycles whenever the fuel cells can reach a higher voltage. As such, the maximum buffer voltage follows the curve 1210e capped at to a constant voltage 1213e by the QXR for any voltage V_{FC}≤0.47V. The n=9 fuel cell voltage 1210ee increases till at nV_{FC}=Vₘₐₓ=5.4V the cell array dynamically shifts from n=9 to n=7 dropping the voltage by 1.2V back down to precisely V_{OC}=4.2V.

Above V_{FC}≥0.6Vm the QXR regulates the buffer voltage at V_{OC} as the n=7 fuel cell voltage 1210ff continues to increase even above Vₘₐₓ 1211. At V_{FC}=0.9V the unregulated fuel cell stack voltage is nV_{FC}=7(0.9V)=6.3V, a voltage not too high to easily regulate. Alternatively above V_{FC}≤0.77V one additional fuel cell cand be shorted dropping the stack voltage by 0.9V. Notice through the majority of the operating range this design employs the same 1.2V differential both for the overdrive and the charger headroom.

Summary of Dynamic Fuel Cell Array Operation. The net benefit of disclosed dynamic array topology apparatus and its operation is the ability for the fuel cells array to perform faster charging over a wider range of cell voltages and environmental conditions. As disclosed, when per-cell voltages are high during conditions of warm (but not overly hot) temperatures and high humidity, fewer cells in the array participate in charging the buffer cell. Conversely in dry or cold conditions (but still above freezing) when lower cell voltages are manifested, the number of series-connected cells in the stack are dynamically increased to ensure the fuel cell is able to self-charge its buffer cell to at least 3.6V and ideally to 4.2V.

The topological change as disclosed is achieved either by diverting, i.e., shunting, current around unnecessary cell using low resistance switches generally comprising MOSFETs or power MOSFETs, or to disconnect the fuel cell altogether from the array using a method that requires at least two switches—one to disconnect the fuel cell from the array, another to complete the conduction path between the remaining functioning cells and the buffer stage absorbing the generated energy.

In one set of embodiments the fuel cell array topology is dynamically configured to reduce the series connected cells in the stack whenever the voltage output of the array exceeds the buffer's V_{OC} overcharge voltage, e.g., 4.2V for many lithium ion chemistries. Maintaining a voltage at or slightly below V_{OC} minimizes the role of the QXR charge transfer regulator in protecting the buffer from charging to an overvoltage condition and reduces the power dissipation in the QXR regulator.

An alternative method maintains the total number of connected cells in dynamic fuel cell array to a voltage above the V_{OC} limit, overdriving the buffer cell with a higher voltage to accelerate charging through a higher charging “headroom” and charging currents, but relies on the QXR charge transfer regulator to protect the buffer cell by limiting the buffer cell maximum voltage for safety while simultaneously supporting a higher QXR input voltage. By delivering current while maintaining a large voltage headroom between the fuel cell array and the buffer cell, the QXR dissipates power equal to the charging current times the differential voltage of the headroom. The excess power is wasted as heat, meaning the energy conversion efficiency of the buffered fuel cell is reduced for the benefit of accelerated charging and reduced recharging times.

In every instance, the QXR must strictly prevent the Li-ion buffer cell from being overcharged, the only difference being how high the fuel cell voltage is allowed to reach before reconfiguring the cell array to reduce its net voltage driving the charging process. Detecting the fuel cell voltage to reconfigure the fuel cell array may be performed by checking the voltage potential or one or both sides of the QXR charge transfer regulator while conducting current or alternatively by temporarily disabling the QXR like opening a switch to allow independent measurement of the unloaded fuel cell potential and the buffer cell voltage.

iBFC Environmental Regulation. Because the electrochemistry of a fuel cell depends heavily on ambient and internal environmental conditions of humidity, temperature, and to a lesser extent on the pressure and gas flow rates in the anode and cathode chambers, controlling these variables is important in ensuring reliable operation of the buffered fuel cell in delivering a specified charging current to the buffer cell. The purpose of such environmental regulation of the fuel cell is either to minimize these fluctuations altogether or alternatively to prevent extreme conditions by limiting the range of tolerance to environmental variability.

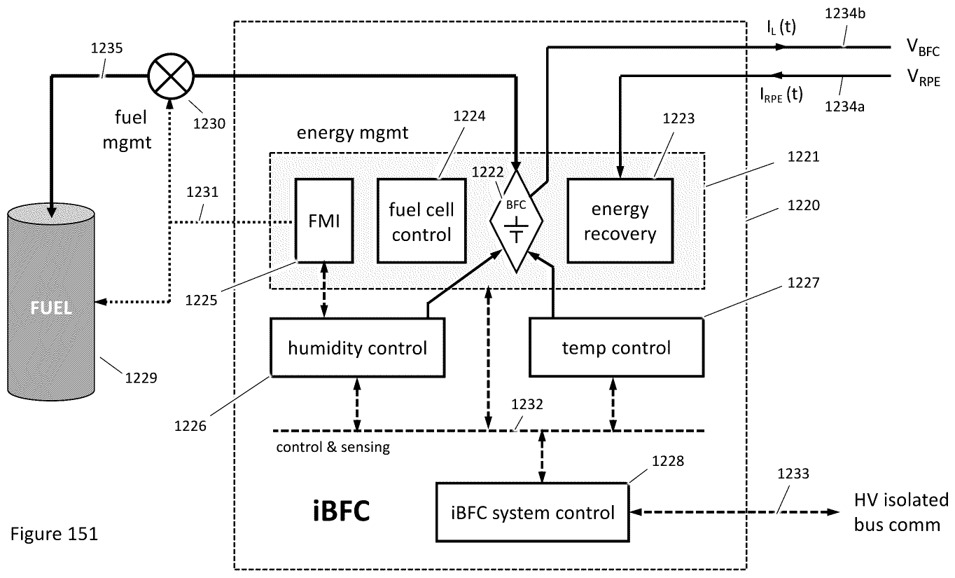

FIG. 151 illustrates a block diagram of environmental control modules in the iBFC intelligent buffered fuel cell design and their relationship to elements of iBFC energy management. The basic energy storage components of the intelligent buffered fuel cell includes a fixed array or dynamic array implementation of buffered fuel cell 1222 and fuel cell control including monitoring and managing voltages, currents, headroom, overdrive, disconnect and other QXR charge transfer regulator functionality including gas microvalves for bypassed cells. Fuel management interface 1225 includes control signals 1231 to gas flow control including gas pressure, flow rate, gas cutoff and optionally gas humidity and gas temperature. Control may be implemented by one ore more discrete components 1230, gas tubing 1235, and gas canisters 1229.

Another element of the intelligent buffered fuel cell is energy recovery module 1223 able to absorb and process electrical energy sources, provide protection functions, and to convert incoming power sources into a form to be stored by the electrical buffer within BFC 1222. One key feature of energy recovery module 1223 is its ability to separate incoming electrical power 1234a to the intelligent buffered fuel cell module 1220 from output delivered power 1234b. Collectively, the combination of BFC 1222, energy recovery module 1223, fuel cell control 1224, and FMI fuel management interface 1225 collectively comprise energy management module 1221.

Specifically environmental control modules in the iBFC include the following components:
Fuel cell humidity control module 1226 controlling water vapor levels in both anode and cathode chambers and in incoming fuel, e.g., hydrogen and oxygen gasses, or organic compounds such as glucose.
Fuel cell temperature control module 1227 controlling temperature the ion exchange membrane within the MEA membrane electrode assembly and/or controlling the temperature of incoming gasses such as hydrogen and oxygen or organic fuel such as glucose.
Fuel management module 1225 including the pressure, flow rate, temperature, and humidity of hydrogen and oxygen into the fuel cell, and the conditions of the fuel reservoirs, or in the case of glucose solution controlling the pressure, flow rate, and optionally controlling viscosity by adjusting solute-solvent relative concentrations.

These modules communicate through an internal control and sensing bus 1232 managed by iBFC intelligent buffer system controller 1228. The system controller also may communicate with external systems through an external bus 1233 capable of high-voltage isolation through galvanic or optocoupled data transfer. The advantage of the external communication is the sensors located within a system, for example in a server farm, home, factory, or distributed throughout a vehicle may be used in deciding the degree of active environmental intervention needed on the iBFC.

Note that the FMI fuel management interface module 1225 does not control gas flow within the fuel cell and MEA chambers of BFC fuel cell array 1222, that role is performed by the FCC fuel cell control module 1224 because of its requisite close interaction with the BFC fuel cell array 1222, e.g., knowing which array cells are in bypass mode and which ones are active. Operating in conjunction with BFC array 1222, FCC module 1224, and energy recovery module 1223, the FMI fuel management interface module 1225 controls the fuel supply external to the iBFC itself, either through the fuel reservoir 1229 or the gas delivery from the canister to the fuel cell involving tubing 1235, valves 1230, mass flow controllers, and pressure regulators.

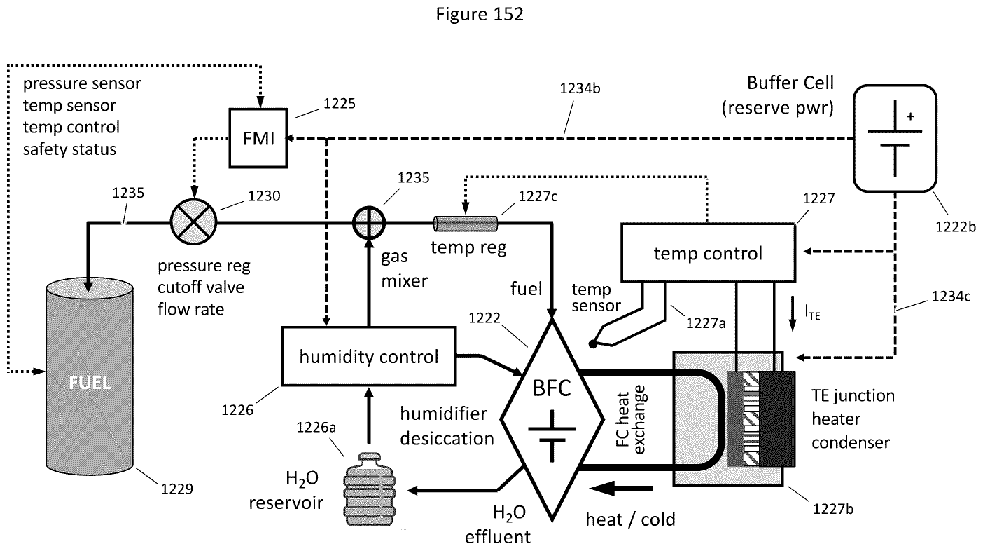

A more detailed functional block diagram of iBFC environmental control of the BFC buffered fuel cell core is illustrated in FIG. 152. Specifically, the FMI fuel management unit 1225 controls the gas flow by controlling gas pressure, flow rate, and gas cutoff through tubing 1235 and valves 1230. Gas pressure control is necessary to maintain a large pressure differential between the high pressure contained within the fuel canister and the pressure within the fuel cell MEA assembly and chamber. For example, the ideal pressure within the fuel cell may be 1.5 to 2 bars while as explained previously a much higher pressure of 179 bars or more is beneficial in the gas reservoir as it increases the stored charge to be converted later into electricity. FMI 1225 is thereby able to independently control the fuel cell chambers internal gas pressure while concurrently monitoring the temperature and pressure in the gas canister and as necessary sending commands to a smart canister 1229 to vent gas or cooling the container to maintain system safety.

Another function of the FMI is to monitor and as needed control the gas flow rate in the fuel cell. Flow rates must be sufficient to deliver the charge necessary to maintain a specified level of current. The required flow at one atmosphere pressure (1 bar) and at room temperature (25° C.) to prevent reaction rate limited current generation is determined by the gas stoichiometry constant or GSC, a species specific constant normalized for a single 1 A fuel cell. Values of GSC are minimally 7.95 mL/min for H₂, 3.98 mL/min for pure oxygen, and 18.99 mL/min for room air. The total required flow rate for a fuel fuel cell assembly comprising a m-by-n array of cells, each conducting current I_{FC} is given by the equation:

FR=(mn)I_{FC}(GSC)(SR)

where FR is flow rate is measured in mL/cm²; n is the number of series cells in a stack; m is the number of parallel stacks, and I_{FC} is the fuel cell current for a defined area and current rating. Through the use of programmable MFC mass flow controllers external from the fuel cell module or attached to the fuel supply, the FMI is able to control the anode and cathodes air flows, dynamically adjusting the SR stoichiometry ratio factor at a prescribed multiple, e.g., numerically between 2 to 4, the minimum GSC flow rate times the number of cells (mn) being supplied. In the illustration only the H₂ reservoir, valve, and anode supply line are illustrated. It will be understood that the same configuration applies to the anode oxygen or air supply line. In a glucose fuel cell the anode supply line regulates the flow rate of the reducing agent.

Lastly, FMI 1225 manages cutoff valves, able to disconnect the fuel supply reservoir from the fuel cell module in the event of low-energy demand, a fully-charged buffer, sleep mode operation, or from a safety fault. Valve control 1230 can also be used to sequence fuel from multiple canisters allowing a canister to be fully depleted and replaced below drawing fuel from a backup container.

Humidity control is another key element of the iBFC disclosed herein. The humidity control module 1226 controls the humidity inside the PEM membrane and MEA enclosure 1222 by performing desiccation or by controlling water drainage from the cell chamber to prevent water drowning and PE overload. Removed water, i.e., H₂O effluent, may be released into the environment or preserved in a H₂O reservoir 1226a for subsequent use in humidification as needed. The humidifier function involves heating water to increase its vapor pressure then mixing the water vapor into the gas supply lines through a gas mixer 1235. Although the humidifier function is shown for the hydrogen supply line to the anode, the same method is applicable for the oxygen or air supply to the cathode. Humidification can also be performed by heating water loaded salts or carbon nanotubes releasing surface bound water as vapor.

Another environmental function of the iBFC is temperature control. The temperature control module 1227 includes one or more sensors 1227a monitoring the internal fuel cell condition. In the schematic temperature sensor 1227a is represented as a thermocouple but is normally realized as a solid-state sensor or PN diode. The temperature of the fuel cell can be adjusted through an air or fluid heat exchanger 1227b. The source of cold or heat for the heat exchanger may be a thermoelectric junction, a heater, or a condenser. The condenser may employ heating or cooling using energy supplied by a vehicle or HVAC system. The heater function is especially important to ensure reliable fuel cell startup when operating in cold climates where the ambient temperature Ta≤0° C. and water crystals may impair or prevent fuel cell conduction. Another form of temperature regulation can be performed on the gas lines 1227c using a heater or a heat exchanger to raise or lower the temperature of the gas supply either the hydrogen line to the anode as illustrated, and/or on the oxygen line to the cathode chamber.

One key benefit of buffered fuel cell 1222 is the battery buffer portion of the BFC is capable of supplying electrical power 1234b to the humidity and fuel units or to the temperature control unit and heat exchanger 1234c. For example in buffered fuel cell 1120 reserve electrical power can be extracted from the buffer cells 1222b within the buffered fuel cell 1222 even if the fuel cell portion is inactive from low humidity or frozen water in the fuel cell membrane.

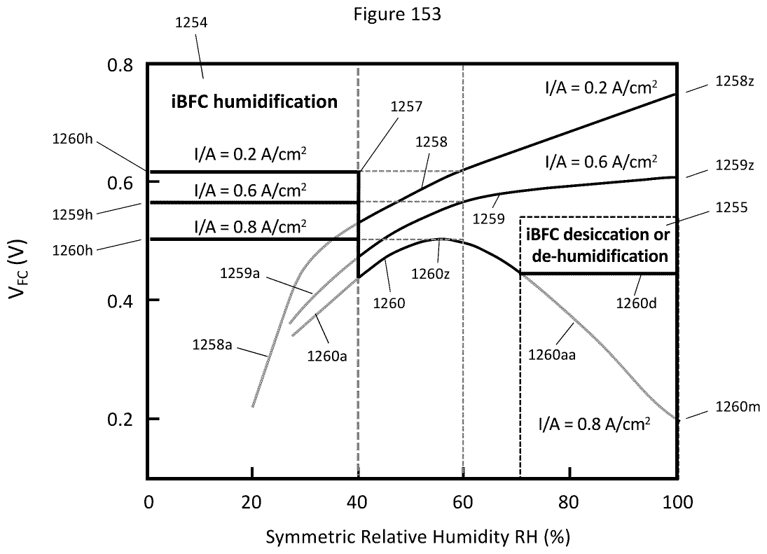

Exemplary benefits of humidity control are depicted in the graph of fuel cell voltage V_{FC} as a function of RH relative humidity shown in FIG. 153. V_{FC}vs RH exemplary curves shown include curve 1258 at a moderate current density I_{FC}/A=0.2 A/cm², curve 1259 at a medium-high current density I_{FC}/A=0.6 A/cm², and curve 1260 at a high current density I_{FC}/A=0.8 A/cm². In general, the fuel cell voltage is higher at moderate current densities, reduced at medium-high current densities, and lowest at high current densities.

In one example, fuel cell voltages at 0.2 A/cm² reach a peak value 1258z around 0.7V at RH=100% and lacking the disclosed humidification exhibit a precipitous decline 1258a below 0.3V in dry conditions where RH 40%. With active humidification 1254 activated at RH=40%, V_{FC} voltages immediately recovers, rising 1257 from a low of 0.5V to a stable voltage over 0.6V, approximately the same as RH=60%.

Similarly, fuel cell voltages at 0.6 A/cm² reach a peak value 1259z around 0.6V at RH=100% and lacking the disclosed humidification exhibit a substantial decline 1259a below 0.3V in dry conditions where RH 40%. With the active humidification 1254 disclosed herein activated at RH=40%, the fuel cell voltage recovers, rising 1257 from a low of 0.47V to a stable voltage over 0.57V, approximately the same as RH=60%. The reason the 0.6 A/cm² has a lower slope in low humidity operation 1259a than does the 0.2 A/cm² curve 1258a is because the higher current generates more water partially offsetting membrane dehydration.

The high current characteristic of fuel cell voltage, e.g., curve 1260 at 0.8 A/cm² differs from lower current density operation for two reasons. At low humidity below 40%, the membrane dehydrates faster because of excess heating causing lower cell voltages 1260. Active humidification commencing at 40% as described herein immediately increases the cell voltages from a low of 0.4V to a moderate voltage of 0.5V.

The zenith of the voltage curve 1260z occurs not at RH=100% but a medium level of humidity around RH=55% and then declines 1260aa with increasing humidity to an unusable 0.2V as a minimum 1260m at 100% humidity. The reason for this differing behavior at high humidity is water logging—where the membrane become so saturated from self-generated water that gas transport is impeded or totally blocked inhibiting the fuel cell reaction. In this case, the intelligent buffered fuel cell may utilize active or passive desiccation 1255 to remove water from the gas. This task can be performed by rerouting the gas over a solid desiccant to absorb excess water especially above RH≥70%, or by cooling the gas flow in the cathode to remove excess water vapor. The desiccation function of the iBFC is required only in fuel cell designs operating at high current densities such as 0.8 A/cm² and then only when high humidity is detected by the QXR charge transfer regulator, by current monitor, by the fuel cell control module, or by the buffer module measuring relative humidity in the gas flow.

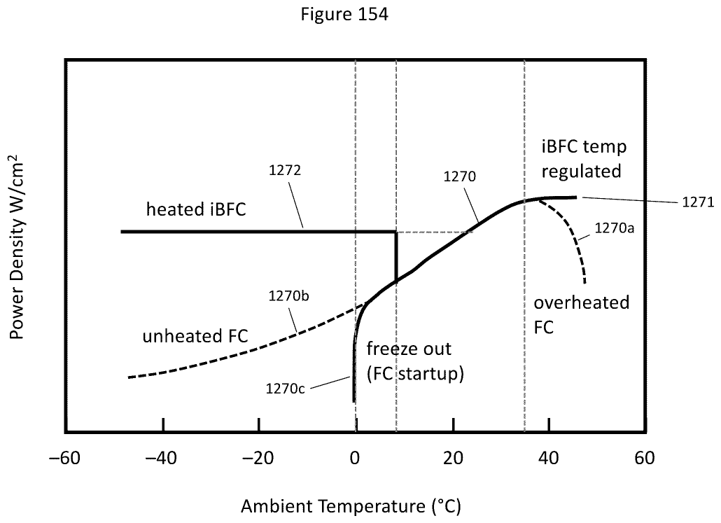

FIG. 154 illustrates exemplary functions of the temperature control module. As depicted in the graph of power density measured in W/cm², the power generating ability of a fuel cell is a function of temperature 1270 with higher temperatures performing better than cold temperature operation. The temperature relationship is complicated by the fact that colder air also carries less moisture, so it is difficult to isolate temperature dependence of a fuel cell from the effects of relative humidity. Humidity aside, increased temperature improves the kinetics of the fuel cell reaction, delivering increased kinetic energy to charge conduction, statistically accelerating reaction rates, and improving gas transport diffusivity. A lower temperatures, reduced reaction kinetics an unheated fuel cell degrades conversion efficiency and increases membrane resistance both affecting the cell's power density capability 1270b.

At fuel cell start up below 0° C. however fuel cell freeze out can impede conduction 1270c by blocking ion exchange membrane pores with ice crystals. In such a case, even a moderate degree of heating can thaw the ice opening pores and stimulating fuel cell production. Once operation commences, the exothermic nature of the hydrogen redox reaction will maintain the fuel cell's operation above freezing. Using only a heat transient to jump start the cell, once operation commences the power output curve will follow the unheated FC curve 1270b.

To maintain improved cell efficiency and sustain a higher level of power output at cold temperatures, one embodiment of this invention involves steady state temperature regulation. With temperature regulation, the fuel cell performance can be maintained a higher efficiency 1272 despite operating at low temperatures. Ion exchange membrane PEM and AEM based fuel cells also can degrade in performance 1270a at extremely high temperatures. High temperature mechanisms depend on humidity. In deserts and low humidity uses high temperatures degrade performance by drying out the fuel cell and reducing the minimal level of water to maintain steady state operation. In wet climates high temperatures can cause water logging, i.e., excessive water retention interrupting gas transport. By actively or passively cooling the fuel cell in accordance with this invention electrical performance can be maintained at higher level 1271c especially if humidity is controlled at the same time. Cooling in extremely hot environments can also prevent cell degradation and inhibit corrosion, especially in acidic PEM based fuel cells.

Methods of temperature regulation made in accordance with this invention can be achieved by attaching a heating, cooling, or heating-cooling element directly to the fuel cell enclosure controlled via 1227. Alternatively, a heat exchanger can pass fluid or forced air through the bipolar or tripolar plate to a heat exchanger 1227b or convective surface. In a electric vehicle the reserve power in the buffered can be used to power the vehicle's HVAC system to regulate the fuel cell's temperature in a enclosed atmospheric chamber. In another embodiment the oxygen is heated to carry heat into the cell. Although hydrogen can also be heated heating oxygen is safer. The schematic representation showing the fuel being heated is only intended to denote any gas or reactant supplied to the fuel cell can be heated or cooled. It is not intended to imply only hydrogen or fuel can temperature regulated. In general, the disclosed intelligent buffered fuel cell coordinates heating and cooling functions via temperature control module 1227 which may also include external data bus communication to a power generation system of a vehicle.

Buffer Cell Voltage Balancing. As described, the basic iBFC architecture comprises a stack of n fuel cells in parallel with one or more paralleled buffer cells. Although the buffer can be configured to comprise series connected batteries, e.g., a 200s array of batteries, then the n=8 fuel cell stack with a 4V output will not match the 800V battery voltage. As a result, the number of fuel cells in the stack must be 32 to match the 4s connected battery at 16V. There is no electrical benefit to stack so many buffers in the same pack. Instead, it is more convenient to design a fixed-topology buffered fuel cell comprising a specific number of lithium ion batteries combined with its own internal fuel cell array for self recharging well matched to the proper voltage range. In this manner the fuel cells function the same as lithium ion batteries but will the ability to recharge themselves when depleted. Predefined buffer combinations include 1s 4V pack (nominally operating at 3.75V), 2s 8V pack, 4s 16V pack, 6s 24V pack, 12s 48V pack and possibly 24s 96V pack.

To achieve higher power operation these predefined BFC packs can be stacked in series or wired in parallel to increase the total power output. Because of its low internal buffer resistance and stiff voltage source capability the BFC output voltage can then be scaled up or down using a DC/DC switching regulator comprising a step-down Buck converter topology, a step-up boost converter topology, a flyback or forward converter which may be step-up or step-down, or alternatively a Buck-boost or Cùk converter if the conversion ratio varies. As explained previously, the reason the buffered fuel cell can drive a switching regulator while an unbuffered fuel cell cannot is because switch mode regulator use low resistance power MOSFETs as switches, not a linear current source, and therefore repeatedly draw high spikes of current which a fuel cell cannot handle. With its 4 mΩ and lower impedance, the buffer of a the BFC can easily supply large spike currents without suffering load dependent voltage sag.

Although the modularity of the disclosed buffered fuel cell and intelligent buffered fuel cell render assembly of modules into high power systems straightforward stacking lithium ion cells into series stacks within a BFC or stacking BFC in series in totem pole configuration, i.e., head-to-toe or anode-upon-cathode has one problematic issue to resolve—cell balancing.

Specifically, whenever electrochemical cells of high-energy density chemistries such as Li-lon are stacked, slight differences in manufacturing, chemical composition, or aging can cause cells to charge to different voltages disproportionately. For example, if a 16V stack has three cells charged to 3.9V each, the remain cell is charged to 4.3V a full 100 mV above V_{OC}=4.2V. As detailed previously operating outside the SOA of a Li-ion battery can lead to overheating, electrolyte leakage, combustion, and possibly explosion. To prevent this problem the iBFC must perform cell balancing within series connected buffer cells within a pack or potentially from pack-to-pack when stacking modules.

Accordingly, another advantage of the disclosed intelligent buffered fuel cell is its ability to perform voltage balancing among buffer cells. Cell balancing is the ability to ensure a series string of buffer cells contain cells evenly distributing the voltage where no one cell carries an unfair burden in charge or energy storage. While cell balancing is not a concern in fuel cells or low energy density battery types like alkaline, NiCd, or NiMH cells, in lithium ion chemistries cell imbalances can cause one or more cells in a series connected string to reach their overvoltage limit before others.

Once any cell in a string hits this maximum voltage limit, in order to prevent its overcharging and possible damage or fire, the entire string must immediately cease charging even though many or most cells in the string remain below full charge—stopping in a low charge state. The net effect is the buffer capacity is reduced by the voltage imbalance where the highest voltage cell causes all other cells to stop charging at a lower voltage.

Although multicell battery packs use complex circuitry for determining pack charge state and cell cycle life analysis the methods, circuitry, and software, the method are complex and expensive, primarily motivated by the need to predict battery life. This methods include counting coulombs absorbed by each cell, continuously monitoring the voltage of every cell in the pack, recording cell charging history from its initial charge state through all of its charging and discharging cycles, and tracking all the voltage changes throughout a pack's use life. Moreover, charging of lithium ion battery packs involve multi-step sequenced switching chargers and wireless chargers for fast charging in compliance with USB3 Universal Serial Bus 3 standards. Charging from a high-power stiff voltage source as defined by USB3 is however completely different than using a high-impedance fuel cell stack with highly variable voltages. In such cases the stack voltage may fall below 3.6V or exceed 4.2V.

To prevent an overcharged cell from prematurely terminating charging, the disclosed buffered fuel cell includes provisions for modularized cell charge balancing. In this method, a series connected string of Li-ion buffer cells can be balanced with one another even if they are not assembled in the same unit or manufactured at the same time. The distributed modular approach to cell balancing offers benefits previously impossible to implement.

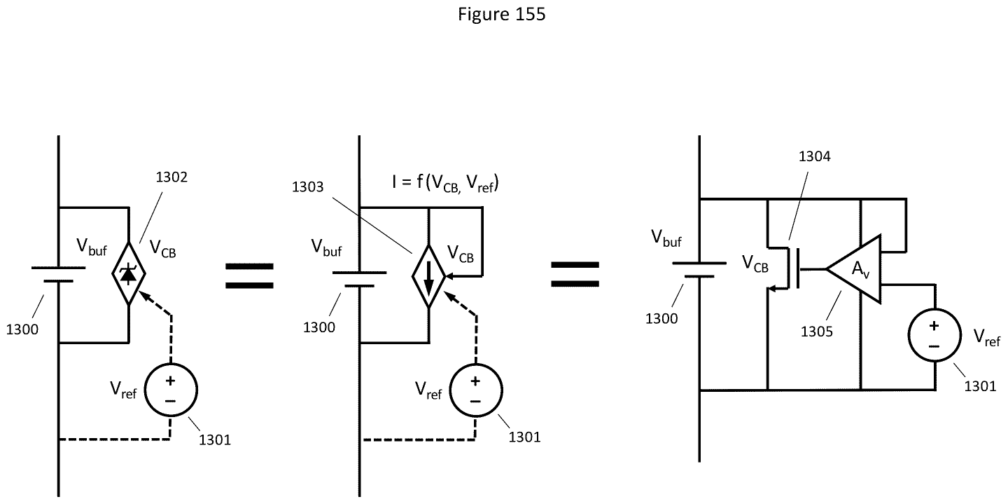

The mechanism of charge balancing is a current limited shunt regulator comprising a device placed in parallel with the Li-ion buffer cell that diverts charge around a cell so that (i) it never categorically never exceeds V_{OC}, and (ii) so its voltage precisely matches other cells in stacked set of iBFC modules. Circuit implementations are represented schematically in FIG. 155 illustrating in the equivalent function circuit shown on the left-side circuit where CB charge balancing device 1302 behaves like a Zener diode whose equivalent clamping voltage is a function of the difference between the buffer cell 1300 voltage V_{buf} and a reference 1301 voltage V.

The center figure illustrates the operational control principle of CB charge balancing device 1302. As a buffer cell voltage approaches its target charging voltage, the voltage gain of a circuit diverting the current around the buffer cell increases, thereby driving a bypass current element 1303 as a dependent current source to redirect current around buffer cell 1300 thereby reducing the current and slowing charging of cell 1300. If the same process occurs in other cells connected in series with this one, the fast charging cells slow down as they approach the target voltage while the lagging cells continue rapid charging in pace. One such implementation of this diverter shunting function is illustrated in the rightmost circuit schematic comprising a voltage reference 1301, a voltage mode differential amplifier 1305, and a power MOSFET shunt device 1304 across the buffer cell.

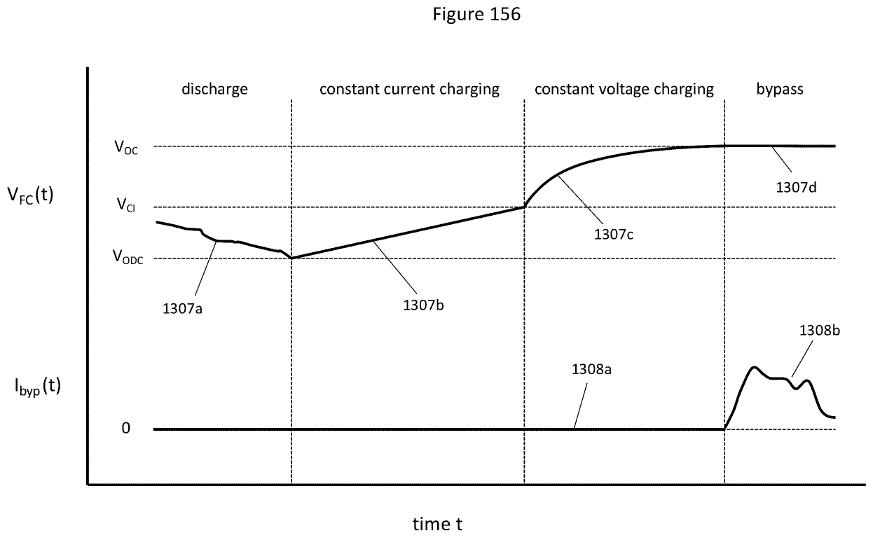

The waveforms of FIG. 156 illustrate during a normal discharge and CI-CV charge cycle including voltage discharging 1307a, the voltage during constant-current charging 1307b, and the voltage during constant-voltage charging 1307c. During these three intervals the bypass current 1308a remains at zero, i.e., where I_{byp}(t)=0. Only in the asymptotic charging interval 1307d as the buffer charges and V_{buf} →V_{OC} does the bypass circuit begin to divert current 1308b around the cell, i.e., where I_{byp}(t)>0.

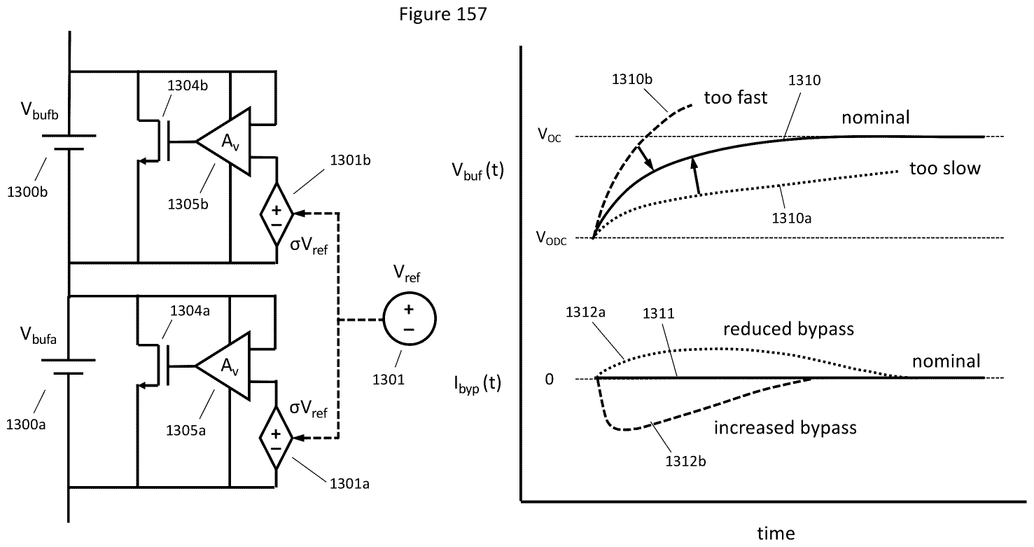

The differential effect on charge balancing of two series-connected buffer cells is described in the schematic of FIG. 157 and corresponding charging waveforms of V_{buf}(t). For simplicities sake, the associated QXR charge transfer regulator and parallel fuel cell stack are omitted from the electrical network. Schematically, the circuit depicts two series-connected buffer cells 1300a and 1300b and two charge-balancing circuits comprising bypass MOSFETs 1304a and 1304b, differential amplifiers 1305a and 1305b and dependent voltage sources 1301a and 1301b having a voltage σV_{ref} controlled by a common V_{ref} voltage reference 1301 where a is a scalar multiplier. In operation, anytime the voltage V_{bufa} on cell 1300a differs from 1300b, the differential signal is amplified by amplifier 1305a increasing the gate bias on bypass MOSFET 1304a to either increase bypass current until the voltage adjusts and the difference eliminated.

In the waveforms shown cells that are charging at the normal rate 1310 are not bypassed 1311. Cells that are charging too slowly 1301a get extra charge by reduced bypassing 1312a stealing charge from other cells in the string charging faster than they are. Cells that charge too quickly 1310b divert their current by bypassing current 1312b around the fast charging cell diverting the charge to other cells in the string. The challenge of implementing a distributed bypass circuit that matches from unit to unit or one buffer cell to another is not the shunt regulator bypass function itself but how to relay the identically same voltage reference over a wide range of voltages without causing dangerous voltage mismatches leading to overcharged cells.

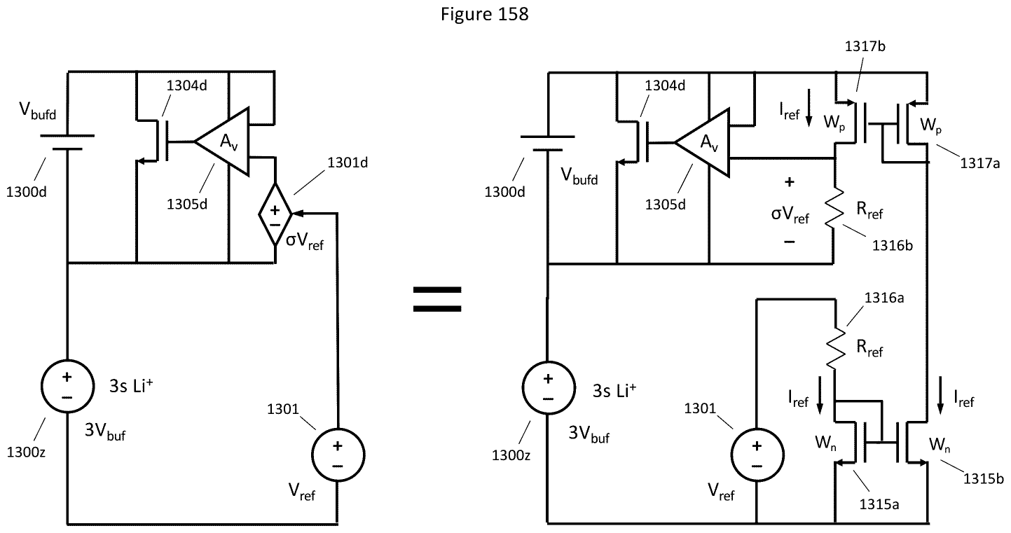

In one embodiment shown in FIG. 158 voltage reference distribution utilizes a level shifted dependent voltage source whose value mirrors a common reference voltage V_{ref} not necessarily biased to the same DC potential. As shown, buffer cell 1300d sits atop a 3s stack of lithium ion batteries 1300z with its anode biased at ³V_{FC} and its cathode at ³V_{FC}. Comprising a scalar multiple a of a ground-referenced voltage reference 1301, level-shifted reference voltage σV_{ref} provides one input to differential amplifier 1305d while the second input comprises the buffer voltage V_{bufd}. The output of differential amplifier 1305d drives the gate of N-channel shunt power MOSFET 1304d dynamically controlling the bypass current I_{byp} (t). Level shifted voltage reference 1301d, differential amplifier 1305d, and the source of N-channel shunt power MOSFET 1304d all are referenced to the anode of buffer cell 1300d. Since this voltage ³V_{buf}changes along with the charge state and voltage of series buffer cells 1300z, the voltage is referred to as “floating”. The term level shift refers to shifting a small signal voltage biased at one DC potential to another without disturbing or scaling the magnitude of the voltage with the DC offset. In this case the level shifted voltage is floating, i.e., not a fixed potential above ground. For example, a precision 1.1003 V reference remains the same value whether its biased at ground, aka zero volts DC offset, or atop a DC offset of 3V_{buf} approximately 10.8V-to-12V.

To create a precision voltage reference 1301 requires using an amplifier or gain element to produce a voltage which is adjusted while concurrently measuring the voltage, a process referred to as trimming. Some voltage references such as silicon bandgap circuit rely on material properties such as the 1.1 eV energy bandgap of semiconducting silicon to produce the voltage. Ideally a precision reference voltage have a precise constant value independent which remains constant despite variations in temperature and in fluctuations in the circuit's supply voltage. As such, the original reference voltage is represented schematically as an independent voltage source symbol comprising a circular shape.

Any voltage sources created from the original independent voltage source in order to match its potential and mimic its variations, are represented as a dependent voltage source identifiable schematically by its rhomboid shape symbol. Although the voltage of the independent voltage source master reference and its dependent voltage sources should not vary over voltage or temperature, what is important in cell voltage balancing is the variations track one another with change so the ratio of the voltage remains fixed ideally one-to-one. In practice, the dependent voltage source may exhibit a voltage of σV_{ref} at manufacturing then trimmed to improve matching where σ→1.

To level shift the precision voltage, the reference must be converted into a current then back into the same voltage using matched components, e.g., matched resistors or matched transistors such as bipolar transistors or MOSFETs. Matching, the ability to maintain nearly identical electrical characteristics over temperature requires the use of devices sorted during manufacturing to have identical electrical characteristics or by monolithically integrating identical geometry devices into a single silicon integrated circuit.

In this manner, the ground-based reference voltage V_{ref} is converted into a current reference I_{ref} by a series-connected precision or trimmed resistor 1316a having a value R_{ref} and one-or-more matched transistors forming a current mirror. In the exemplary schematic, the ground referenced current mirror comprises threshold connected N-channel MOSFET 1315a connected to the gate of mirror MOSFET 1315b. The current I_{ref} is then given by I_{ref}=(V_{ref}−Vₜₒ)/R_{ref}. The current in the grounded mirror MOSFET is then connected to a second P-channel current mirror referenced to the cathode of buffer cell 1300d.

Since the transistors, e.g., a MOSFET operating in its saturated region, maintain I_{ref} as a constant current independent of voltage then the value of current in the level translated current mirror identically matches the current in the ground-referenced mirror independent of any DC offset. The threshold connected P-channel MOSFET 1317a then provides gate bias to identically constructed mirror P-channel MOSFET 1317b conducting current through resistor 1316b. The second mirror which floats atop the DC offset voltage is then converted back into the reference voltage using a second identical value resistor R_{ref} to create the level-shifted dependent voltage source having a value σV_{ref}. In this manner the reference is level-shifted to a higher voltage using the principle of matched components, the absolute value of which doesn't matter.

More specifically in the exemplary circuit, a precision voltage source V_{ref} establishes a current through a set resistor R_{ref}to cause reference current I_{ref} to flow in a current mirror which is mirrored to a voltage biased at a DC offset of ⁴V_{buf}, four times the voltage of the ground referenced cell. The mirror in turn drives the same current precisely matched through an identically matched resistor R_{ref} producing the same floating voltage σV_{ref} as the ground based source circuit V_{ref} within the accuracy of ensuring precision through a. The parameter a can be any number but σ=1 is common as it means a mirror does not change the magnitude of current it reflects.

This voltage σV_{ref} is then subtracted from the buffer voltage V_{buf} sitting atop cells at voltage ³V_{buf} to produce a differential signal (V_{buf}−σV_{ref}) fed as an input into the differential amplifier or op amp. The gain of the operational amplifier increases the gate drive to the power MOSFET bypass if the mismatch to the voltage reference is greater and decreases if it is more precisely matched. As such every cell drives the buffer cell charge to the same value so that the charge held by each of a string of series connected buffer Li-ion cells remain evenly distributed balanced as the array charges. This is one method in which the iBFC is able to balance charge across strings of cells.

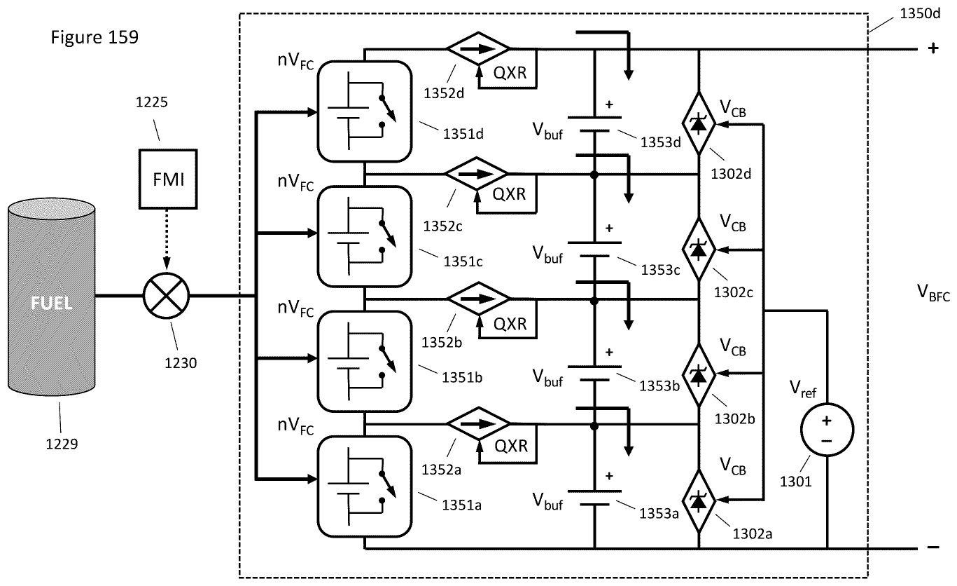

For example, an application of this method shown in FIG. 159 illustrates a 16V iBFC module comprising four series-connected buffer cells 1351a through 1351d, each powered by a dedicated fuel cell stack 1351a through 1351d, and connected via their own dedicated QXR charge transfer regulators 1352a through 1352d. Each buffer is in parallel with a dedicated charge balancing device 1302a through 1302d sharing a common grounded voltage reference 1301. In this manner a single common reference voltage 1301 forces all four cells to maintain a balanced charge among themselves during charging even though they all are floating atop different DC bias potentials 0V (ground), V_{buf}, ²V_{buf}, ³V_{buf}. In addition to the stacked fuel cells energy management system, the iBFC also includes a FMI fuel management interface 1225 controlling fuel supply 1229 through gas valve 1230.

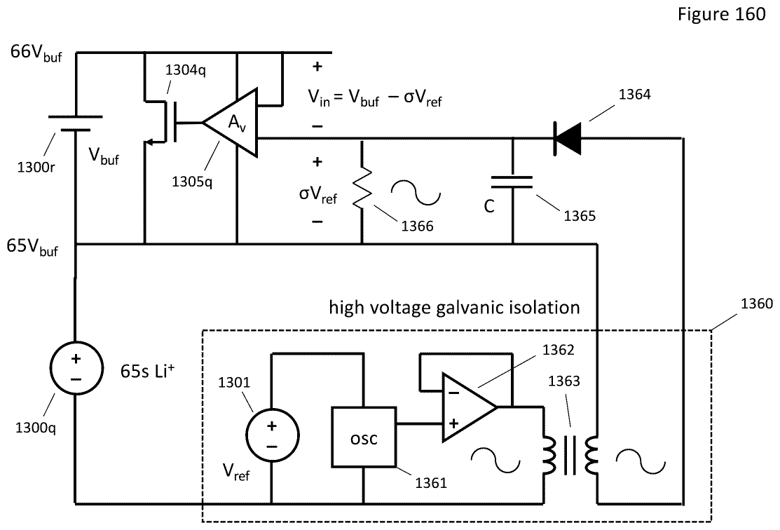

This described DC coupled reference method while useful up to 100V or more, is not applicable for operation at higher potentials such as 400V to 800V because of accuracy issues and also because of high voltage safety concerns. In such cases the galvanically isolated circuit of FIG. 160 is beneficial. Operation involves sinusoidal oscillator 1361 creating a sinusoidal waveform with a voltage proportional to reference voltage 1301 at V_{ref}. The current of the sinusoid is boosted by voltage follower 1362 then transferred via transformer 1363 to a secondary winding where it is rectified 1364 and filtered 13465 to produce an identical voltage across resistor 1366 except biased at a different DC offset bias voltage. The floating reference voltage σV_{ref} is then input into differential amplifier 1305q to drive shunt N-channel power MOSFET 1304q to control the charge in cell 1300r. In this manner, a low voltage reference can be transferred to multiple iBFC modules without concern of their DC voltage.

Buffer Charging via R_{PE} port. Conventional fuel cells can generate power but they cannot absorb power. Although professorial publications promulgate the promise of reversible fuel cells, thermodynamics, Gibbs free energy, and entropy argues such devices are not possible. The optimum design for performing electrolysis is not the same as galvanic electrochemistry. While the electrolysis of water into hydrogen and water may be generally considered the electrochemical inverse of the fuel cell galvanic process converting hydrogen and oxygen into water and electricity, the reactions are in fact not symmetric. Governed by the second law of thermodynamics, the round trip electrolytic-galvanic process necessarily results in a net loss of energy. As such a fuel cell is not a preferred candidate for absorbing electrical energy, and is preferred in generating from primary energy generated hydrogen, not acting as a battery.

By contrast, the buffered fuel cell is not only able to convert fuel into electrical energy but is able to absorb electrical energy and store it chemically. Although the BFC charges its buffer cells from the electric power generated from its fuel cells, it can also absorb power from any electrical source of energy including renewable and green sources. Distinct from the procedures of transferring energy from the fuel cell array into a buffer such as Li-ion or Na-ion electrochemical cells via the QXR charge transfer regulator described previously in this disclosure, charging the buffer cells with current from an external source is completely different challenge than charging it from fuel cells. While the QXR charge transfer register controls the rate of delivery from the fuel cell array with known electrical properties, external charging can be from any source, requiring protection from overcurrent, voltage spikes, noise, electrical resonances of the source, DC voltage offsets, power factor issues, and other unknowns. Since the QXR charge transfer regulator interposes the fuel cell array and the buffer cells it cannot control buffer charging from an external power source such as a generator, regenerative braking energy from an EV, or the highly unpredictable power from renewables involving PV solar arrays and wind turbines.

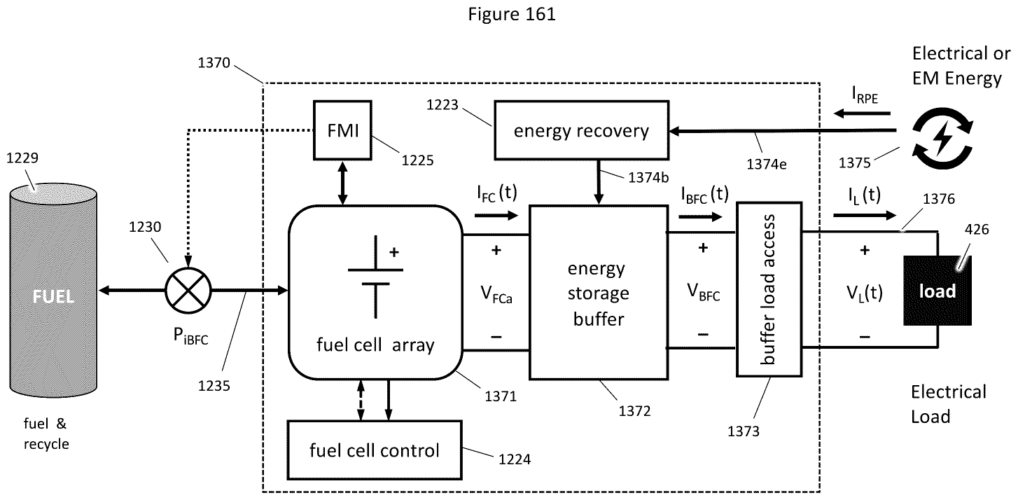

The current input for charging the iBFC with an electric source referred to herein as the ER energy recovery module is shown in FIG. 161. The specific internal features of the ER module depend on the intended sources of energy used to power it. In one set of embodiments made in accordance with this invention, the energy recovery input port is separate and distinct from the output of the iBFC used to power electrical loads. The input current I_{RPE} into the energy recovery port includes two broad classes, recovered energy from energy harvesting; and generated electric power referred to herein as pluggable power.

The subscript RPE therefore refers to energy from recovery and pluggable energy sources, not from the iBFC's internal fuel cell array. The term energy recovery refers to secondary power collected from energy sources that would have otherwise been lost or wasted. Non-commercial and residential wind and solar represent examples of recovered energy. Regenerative braking represents braking refers to the power stored in inertial systems that is recovered when the speed of the moving object or vehicle is actively reduced through braking. In such cases, the motor that previously consuming power to produce traction or locomotion suddenly becomes a generator during breaking. Electrically, the back emf (electromotive force) of any traction or locomotive motor during drive becomes the source or stored power during breaking. The regenerative braking mechanism can occur in either rotary motors used in electric vehicles or in linear motors used in high speed trains. Although this phenomena occurs is all motors, unless the motor moves at high speed and frequently starts and stops, the energy harvested from regenerative braking isn't cost justified. Local storage such as UPS units and power walls charged from a roof top solar PV array are still considered recovered energy even if they are supplemented by power from the AC mains. Recovered power essentially comprises power where the user or system designer has the ability to specify the voltage range and frequency of the power source including DC and AC microgrids in the home or office.

Pluggable power refers to any power generated and delivered into a power grid, including AC and DC distribution of power across cities and states. The primary power source for the grid varies but generally involves coal, natural gas, nuclear, or hydroelectric power plants supplemented by wind farms and solar farm power generation. Although residentially generated PV arrays can be inverted and “sold” to the power utility, personally generated power represents less than 1% of the grid power. In fact, because solar and wind energy vary with weather and time-of-day, they cannot be used as the major power source for a power grid, and may even cause a grid to become destabilized forcing a utility to increase the burning of fossil fuels just to increase the content of fixed frequency power present in the transmission network. Although DC grids can remedy some of these problems, they too cannot rely on privately owned power being sold to the utility and connected into the grid. In some states and countries, the utility prohibits attaching a power generation source onto their power grid, or in the very least they won't pay for any net beneficial power they receive from their subscribers.

Broadly speaking, pluggable power represents a power source specified and regulated by a government or utility, while recovered energy is everything else. Users have no choice in the specifications of pluggable power but have complete flexibility in their choice of recovered power. The specification of electrical power used as a secondary power source to charge the buffers in a buffered fuel cell depends strongly on the power source, not the buffered fuel cell's design. So even though it is theoretically possible for the output the buffered fuel cell to also function as an electrical input for charging the buffer cells from another power source of than the fuel cells, it is expensive, impractical, complex, and potentially dangerous. Specifically, if an electrical load and an electrical power source both share the same electrical connection on a buffered fuel cell there is no means by which the BFC can protect the electrical load from receiving power directly from power source which might contain voltage transients, current spikes, electrical noise, phase shifts, and other uncontrollable effects which can damage or destroy the electrical load, the buffered fuel cell, or both.

Moreover, the protection functions required on the power output of a buffered fuel cell necessarily control the flow of power out of the BFC but prohibit upstreaming of unknown power sources send power into the BFC, i.e., they should block reverse conduction currents. The electrical charging port for a buffered fuel cell has the opposite requirements—it should allow certain forms of power to be transferred into the BFC but block current from flowing out of the input potentially damaging a power source like a PV panel with power incompatible with source's voltage or current specifications. In the intelligent buffered fuel cell disclosed herein, this complex function is the job of an energy recovery module.

Not only must the energy recovery module input to the iBFC prevent unwanted energy flow between a power source and the buffer storage, it must ensure compatibility between the two during energy transfer. Specifically, actual energy transfer from a power source may involve a wired connection of electric DC or AC current, or may involve transfer via a magnetic field such as transformer-coupled galvanic isolation or possibly wireless magnetic charging. Although wireless chargers used in cell phones represent an example of wireless magnetic energy transfer, the vast majority of applications using magnetic coupling are performed in components that constrain the magnetic field to an iron core. These devices include transformers and coupled inductors, the primary different being a transformer delivers power from a primary winding to its secondary contemporaneously, i.e., directly, while a coupled inductor first stores the energy then releases it later transferring to the load out of phase with the power first “magnetizing” the iron, a process known as indirect energy transfer. While coupled inductors are used primarily in switching power supplies, aka DC/DC converters, transformers are used at low frequency in AC power distribution and in some topologies of DC/DC converters. Either the key benefit of magnetic power transfer compared to a wired electrical connection is safety. In the event of a system failure transformers and coupled inductors become an open circuit disconnecting the primary and secondary coils thereby preventing electrical shock of fire.

Another isolated power transfer mechanism is to use radio frequency (RF) electromagnetic energy to carry power, a term sometimes called RF power or RF charging. First promoted by Nicholas Tesla RF charging while technically feasible, is illegal in most countries because it violates FCC frequency band and communication regulations defining licensable portions of the electromagnetic spectrum and forbidding high-power radio transmission for the delivery of power. As one embodiment of the buffered fuel cell, the energy recovery unit can be adapted to accept any of these forms of energy input using an electrical port separate from the BFC's power output to electrical loads.

The construction of a BFC with separate power input and output ports is represented functionally in the block diagram shown previously in FIG. 161. As depicted, intelligent buffered fuel cell iBFC 1370 constitutes a fuel cell array 1371 comprising a fixed or dynamic topology of nsmp cells connected to a energy storage buffer 1372 comprising an array of one or more electrochemical cell such as a lithium ion battery. As shown, fuel cell array 1371 supplies power to buffer 1372 at a voltage V_{FCa} and at a current I_{FC}(t) through a QXR charge transfer regulator (not shown) contained within fuel cell array.

The number of fuel cells in the array and their electrical series-parallel electrical topology may be fixed or dynamically reconfigured in response to commands by fuel cell control module 1224 or sensory data of the fuel cell condition obtained by the QXR. Although the example depicts a single voltage output V_{FCa} corresponding to a 1s buffer cell where for example V_{FCa}≤4.2V, it is understood in accordance with other embodiments of the invention described previously, a number of buffer cells could be connected in series in which case multiple connections between the fuel cell array and the buffer array are present.

Fuel cell array 1371 also communicates or provides sensor data to the FMI fuel management interface 1225 used to control fuel supply 1235 from source 1228 including regulation of flow and pressure P_{iBFC} by valve-regulator 1230. Although the fuel cell may comprise a PEM membrane and consume hydrogen as its fuel source, the architecture of the iBFC as disclosed is agnostic to the type of fuel cell or the fuel.

The electrical portion of iBFC 1370 comprises the buffer cell array in energy storage buffer 1372 and its interactions with electrical load 426 and electrical or EM energy source 1375. In the embodiment shown, the iBFC segregates the power delivery and electrical output circuitry from the electrical input and energy recovery circuits. In particular, energy is delivered to electrical load 426 through an intervening functional block BLA buffer load access 1373 where energy storage buffer 1372 supplies time varying current I_{BFC}(t) at a voltage V_{BFC} to the input of BLA buffer load access 1373 which in turn supplies power 1376 to electrical load 426 in the form of a time varying current I_{L}(t) and at a voltage V_{L}(t).

Although the currents I_{BFC}(t) and I_{L}(t) along with the load voltage V_{L}(t) can change rapidly with load conditions such as motor startup, capacitive in-rush current, and load fault conditions, the buffer cell's voltage V_{BFC}changes slowly in accordance with the state-of-charge of its Li-ion cells. BLA buffer load access 1373 thereby protects the buffer cells in energy storage buffer 1372 from damage from external conditions, either a malfunction of load 426 or reverse current from a power source, e.g., a battery pack at higher voltage than V_{BFC}.

In this embodiment electrical energy flow I_{RPE} into iBFC 1370 from a power source 1375 occurs through entirely different electrical port 1374a than the path 1376 flowing out of the iBFC to load 426. Instead the power flow through charging electrical port 1374a flows into energy recovery block 1223 where the power is converted into a form useable by energy storage buffer 1372 and delivered as a DC charging current 1374 irrespective as whether the actual power source 1375 is AC, DC or magnetic.

Moreover, the disclosed separation of energy flow into an input channel 1374a via the energy recovery module 1223 and an output channel 1375b delivering energy to a load via a buffer load access module 1373, allows the two power input and output functions to be more specialized and therefore better at performing their required tasks. Specifically, energy recovery module 1223 protects the buffered fuel cell from damage absorbing energy while the buffer load access module 1373 protects against potential damage caused by an electrical load or an improper connection. Another benefit of the dual port design is that external charging and powering of a load can occur in sequence or simultaneously. A further benefit is by routing power from an electrical power source 1375 through iBFC 1370, load is protected from damage from a direct connection from the energy source.

In concurrent charging and load drive, whenever the electrical input exceeds the load power the net unused power can be used to charge the buffer eliminating the need to consume fuel to generate power in the fuel cell. When the electrical input and output power match, the iBFC functions as a passthrough device with no net change in the buffer or fuel cell. During a net energy shortfall where the incoming electrical energy is less than the load current demand, the shortfall can be supplied by the buffer cells and concurrently replenished by fuel cell 1371 electrical generation.

The combination of fuel cell control 1224, buffer energy storage 1372, FMI fuel management interface energy 1225, input to the energy recovery module 1223, and energy delivered to an electrical load 426 via buffer load access module 1373 provides the iBFC 1370 a wide range of flexibility in controlling energy generation, storage and use in any electrical system. It also facilitates a modular system design able to support various voltages, power level, and topologies in a plug-and-go manner, making design, manufacturing, and maintenance more convenient and lower cost.

Aside from managing net electrical energy flow in and out of the buffered fuel cell, the ER energy recovery module and the BLA buffer load access module are important protective elements of the iBFC's overall energy management system. Other iBFC energy management elements include a dynamically reconfigurable array of fuel cells with intrinsic charge regulation of battery storage buffer, pressured gas fuel or organic fuel source management with system-controlled pressure and flow rate regulation, and fuel cell control optimizing operational topologies to maximize reliability and optimize efficiency.

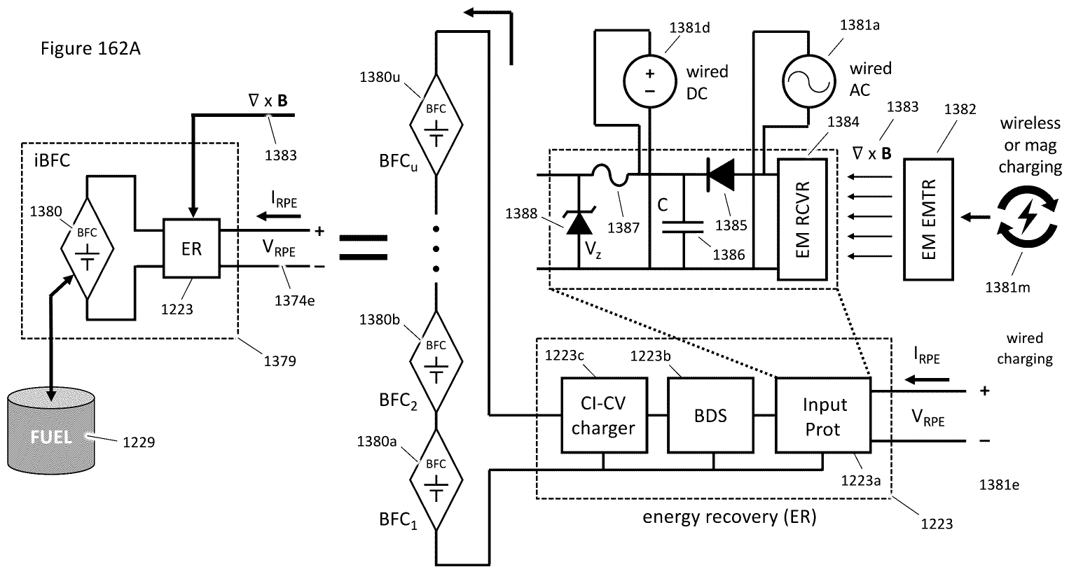

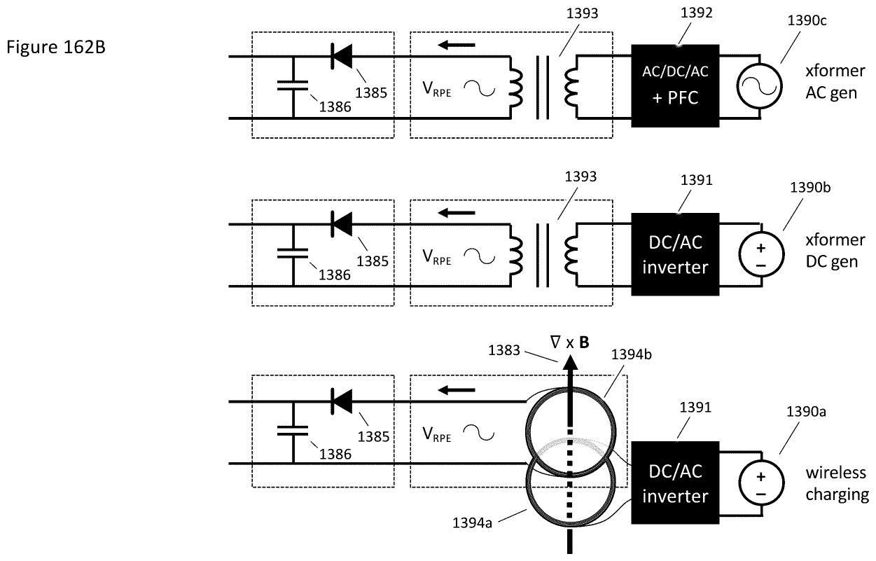

Energy Recovery. FIG. 162A describes the two major charging mechanisms of the intelligent buffered fuel cell 1379, self re-charging of the buffer in BFC 1380 via fuel 1229, and electrical charging of the buffer through ER energy recovery module 1223. Energy recovery thereby refers to electrical power input into the disclosed buffered fuel cell from an external source, not generated from the internal fuel cell. External power directly input as electric charge into the buffer of the BFC may involve power delivery via electrical power 1374e or wireless charging 1383 via time-varying magnetic field ∇×B. Construction of BFC 1380 comprises a string of individual buffered fuel cells 1360a to 1360u where u is the number of BFCs connected in series. Energy recovery module 1223 comprises three elements, namely input protection 1223a, relevant functional elements of a BDS battery disconnect switch 1223b, and a multimode or CI-CV charger 1223c. Energy sources may be wireless 1381 using magnetic or electromagnetic ∇×B coupling 1383 comprising a coupled pair of EM transmitter or emitter coupled to a EM receiver 1384. It may also include wired power sources 1381e using electrical conduction by wire. Exemplary power sources may comprise wired AC 1381a at any voltage or frequency or DC power 1381d. These three energy inputs may include (i) wireless or magnetically coupled energy similar to wireless chargers, (ii) wired AC input from an alternating current from a generator, alternator or any turbine-powered single or multiphase sinusoidal source or (iii) wired DC inputs from a UPS, battery, photovoltaic, array, or rectified mains power.

As shown, the input protection module 1223a provides a variety of failsafe functions including isolation as needed, rectification of AC power into DC by diode 1385 or a diode bridge (not shown), and filtered of noise and ripple from oscillatory power sources by capacitor 1386. Note that although a single half-wave rectifier is illustrated as a means to convert single-phase AC into DC, a full-wave rectifier or a diode bridge may be used. Likewise, by tripling the number of rectifiers, single-phase rectification can be adapted for three-phase power. Rectifiers may comprise a P-N junction, P-I-N diode, or Schottky diode constructed from silicon or from a wide bandgap material such as silicon carbide, gallium nitride, semiconducting diamond, or other compound semiconductors.

Lastly any diode rectifier can be replaced by a power MOSFET functioning as a synchronous rectifier including lateral or vertical power MOSFETs, planar DMOS or trench DMOS power MOSFETs or high voltage super-junction MOSFETs. Including the filtering function of capacitor 1386 or more complex filters involving active and passive components (not shown) including resistors, inductors, capacitors, transformers, and coupled inductors, the functions of exemplary input protection circuit 1223a is not only protection but power conditioning, i.e., making power more usable, which may include limiting voltage transients, minimizing current spikes, and performing power factor correction.

One failsafe safety feature embodied in input protection circuit 1223a is voltage clamped fuse protection. Unlike conventional fuse protection which protects only against excessive currents, failsafe capability of a voltage-clamped fuse protection also prevents against overvoltage or reverse polarity conduction. The circuit comprises fuse 1387 and Zener diode 1388. In the positive polarity, any voltage exceeding Zener diode 13888 voltage Vz causes the current flowing in fuse 1387 to rise in proportion to increased input voltage regardless if it comes from the AC, DC or magnetic sources 1381d, 1381a, or 1381m respectively. In the unlikely event that incoming power source reverses polarity, Zener diode 1388 becomes forward biased nearly immediately blowing fuse 1387. As described the fuse-clamp combination of a series-pass fuse and a Zener diode is beneficial in preventing overcurrent from any source or to prevent damage from excessive voltage.

For higher voltage systems, isolation is critically important for safety. This is best performed using magnetic coupling, a term referred to as galvanic isolation. In accordance with Faraday's law of induction, a time varying magnetic B field induces current in a conductor in proportion to the vector calculus “curl” of the magnetic field, ∇×B. As shown in FIG. 162B, various means exist to provide galvanic isolation. They include AC power 1290c isolated by transformer 1393, then rectified and filtered by diode 1385 and capacitor 1386 to produce filtered DC voltage. Interposed betwixt AC power source 1390c and transformer 1393 is power supply PFC module 1392 which converts low frequency AC such as 60 Hz to DC, then using a boost or flyback converter performs PFC power factor correction followed by a inverter to recreate AC at a frequency orders of magnitude higher than the input power.

The outputted power is then supplied to transformer 1393 to provide high voltage galvanic isolation and to reduce the voltage to the BFC operating voltage range. The transformer winding ratio m_{w} determines the voltage reduction. For example, a 120 V peak-to-peak AC input with a RMS voltage of 168V can be reduced to 5.6V matched to a 1s Li-ion buffer using a winding ratio of 30. The same AC input can be reduced to 21V well suited for a 4s Li-ion buffer using a winding ratio 20. Because the AC frequency of output from power supply PFC module 1392 is much higher than its low frequency input the size and weight of transformer can be substantially reduced.

To reduce the voltage of a high voltage DC source 1390b and provide galvanic isolation, a high performance DC/AC inverter 1391 can be used to drive transformer 1393 using a forward converter topology. Alternatively at lower power levels, a coupled inductor may be utilized as part of flyback converter topology. Strictly speaking when rectifier-filter function comprising diode 1385 ad capacitor 1386 are included the system end-to-end comprises a DC/DC converter.

The third example of galvanic isolation is wireless charging which is essentially a large area air gapped transformer comprising magnetic field 1383 coupling conductor emitter coil 1394a to receiver coil 1394b. The power supplied to emitter coil 1394a is provided by DC/AC inverter 1391 powered from DC source 1390a.

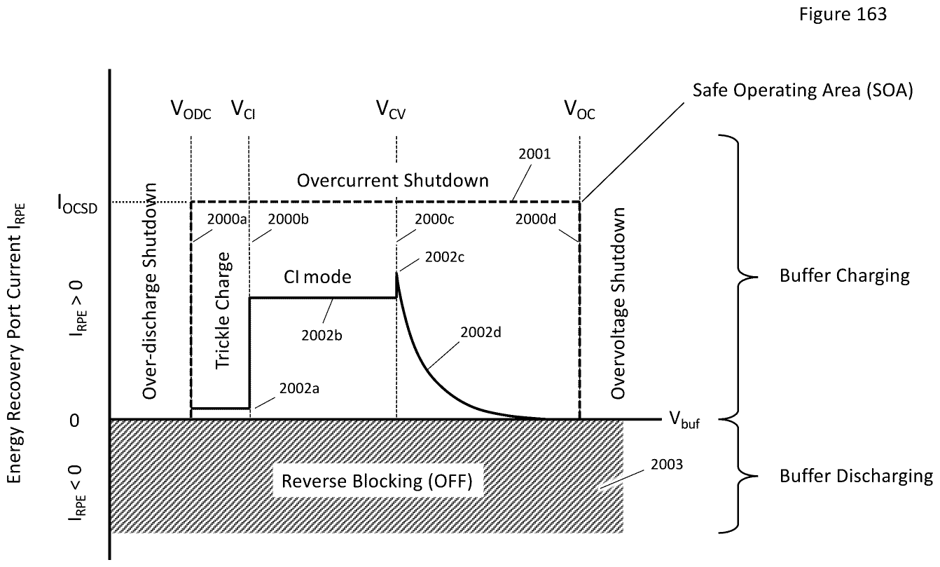

BDS Functionality: The second function of the energy recovery module 1223 is an abridged version of a BDS battery disconnect switch function. The BDS battery disconnect switch 1223b protecting the energy recovery port function protects against overcharging, overtemperature, and overcurrent conditions but does not include protection against over-discharging as discharging occurs only through buffer load access port 1373 and not the energy recovery input module 1223. The boundaries of the safe operating area (SOA) defined by the abridged BDS are shown in FIG. 163 comprising an overvoltage shutdown limit V_{OC} 2000d and overcurrent shutdown 2001. The over-discharge limit V_{ODC} 2000a while it can be included inn the ER function is actually monitored by the QXR, so the ER function is not required.

Finally, the multiphase CI-CV dual phase charger must operate at voltages consistent with the series stack of iBFC modules it charges generally not exceeding 100V. Its charging profile includes trickle charging 2002a above the over-discharge voltage V_{ODC} limit 2000a but below the V_{CI} constant current charging threshold voltage 2000b. Above CI but below the V_{CV} constant-voltage charging transition threshold 2000c, the current is maintained at a constant level 2002b resulting in a linear increase in cell voltage. Above V_{CV} but below the overvoltage shutdown limit 2000d buffer charging converts into constant voltage mode causing a small current spike 2002c due to voltage mismatches, followed by an exponential decay in current 2002d as the buffer voltage approaches a fully charged condition.

Note that the safe operating area for charging a buffer cell defined by V_{ODC} 2000a as the lowest voltage, V_{OC} 2000d as the highest voltage and overcurrent shutdown limit 2001 is applicable only for positive voltages I_{buf} >0 for charging. Negative voltages causing buffer discharging are blocked by the reverse blocking characteristic 2003 are not possible through energy recovery module 1223, but only through the buffer load access module 1373.

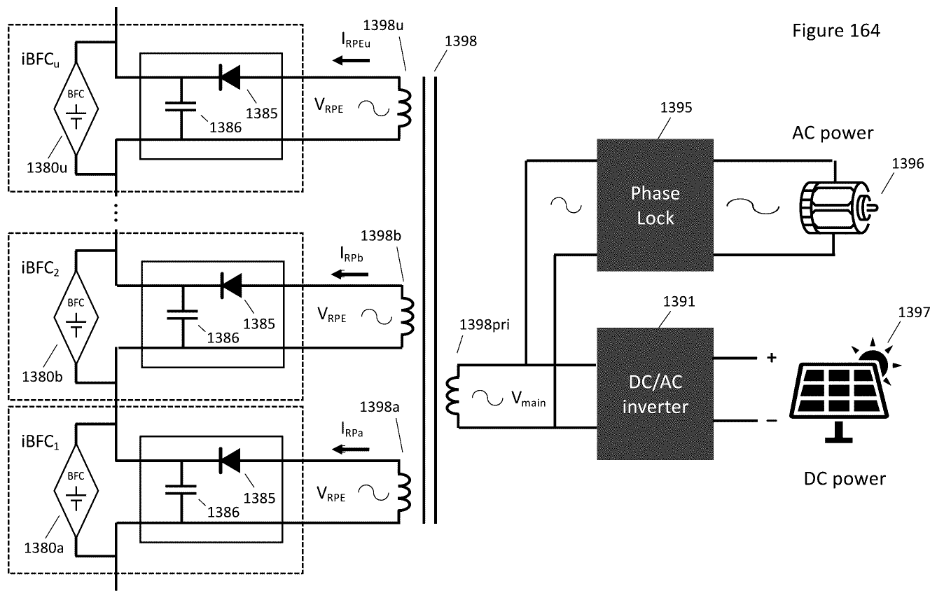

An example of galvanic isolated power transfer to charge multiple BFCs is illustrated in FIG. 164 where a string of “u” intelligent buffered fuel cell modules 1380a, 1380b, . . . , 1380u labelled iBFC₁, iBFC₂, . . . , iBFCᵤ are connected electrically in series in a head-to-toe totem-pole configuration, i.e., anode-to-cathode. The number of iBFCs connected in series can range from one to hundreds depending on voltage. Because the various iBFC modules are biased at different DC levels, potentially spanning hundreds-of-volts apart, a DC based charge input cannot be used. Instead, the charging input can be delivered using a multiple winding transformer to galvanically isolate each charging input.

For example, AC power delivered into the primary winding 1398pri of multiple winding transformer 1398 is magnetically coupled to multiple secondaries 1398a, 1398b, . . . , 1398u. The voltages of each secondary winding VRPE are identical as they all have the same winding ratio m_{w} relative to the primary winding. Given (#turns)ₚᵣᵢ is the number of turns on the primary coil and (#turns)_{sec} is the number of turns on a secondary coil, then for m_{w}=(#turns)_{sec}/(#turns)ₚᵣᵢ, the voltage on each secondary coil V_{RPE} is given by the relation V_{RPE}=m_{w}Vₘₐᵢₙ where Vₘₐᵢₙ in is the voltage of the AC mains which may include DC power sources 1397 inverted into high frequency AC power combined with AC generator power 1396 synchronized to operate in phase 1395 with another other AC sources. Although 50-60 Hz line frequencies may be used, inverter 1391 and phase lock circuits 1396 can also be used to scale to higher frequencies, for example from 1 kHz to over 1 MHz in order to shrink the size and weight of transformer 1398.

Since each secondary winding is unrelated to the others, the various stacked modules can all charge simultaneously, i.e., in parallel, even though topologically the buffer are connected electrically in series. The seconding winding AC voltage is then rectified 1385 and filtered 1386 then supplied to each corresponding iBFC module. The output voltages V_{RPE} and currents I_{RPE} is then fed into each modules protection circuitry module 1223 described previously in FIG. 162A including voltage-clamped fuse failsafe protection in input protection circuit 1223a, battery disconnect switch protection 1223b, and multi-mode CI-CV charger 1223c. Since the winding ratio m_{w} reduces the high voltage input Vₘₐᵢₙ to a low voltage V_{RPE}, all the circuitry in energy recovery module 1223 can operate at low voltages and use only low voltage components. In this manner, no high voltages are connected to any one iBFC module even if though the iBFCs are connected in long series strings to create 400V to 800V DC supplies. In this manner the iBFC can be stacked or paralleled the same way lithium ion batteries are used today.

Buffer Load Access. Another key feature of the iBFC is its ability to control energy flow between the buffer of a buffered fuel cell and an electrical load, the “load” through an interface circuit referred to herein as a BFA buffer load access. Since the relative voltage of the buffer and the load cannot be known, the BFA must be able to block against unauthorized current flow bidirectionally, i.e., in either polarity—whether a load has a lower voltage than the iBFC or vise versa. To control current flow in both polarities, the semiconductor device or its equivalent circuit must be able to block current bidirectionally whether its drain terminal is more positive than its source or conversely if its source voltage is greater than its drain. Schematically, bidirectional blocking is represented by two back-to-back diodes.

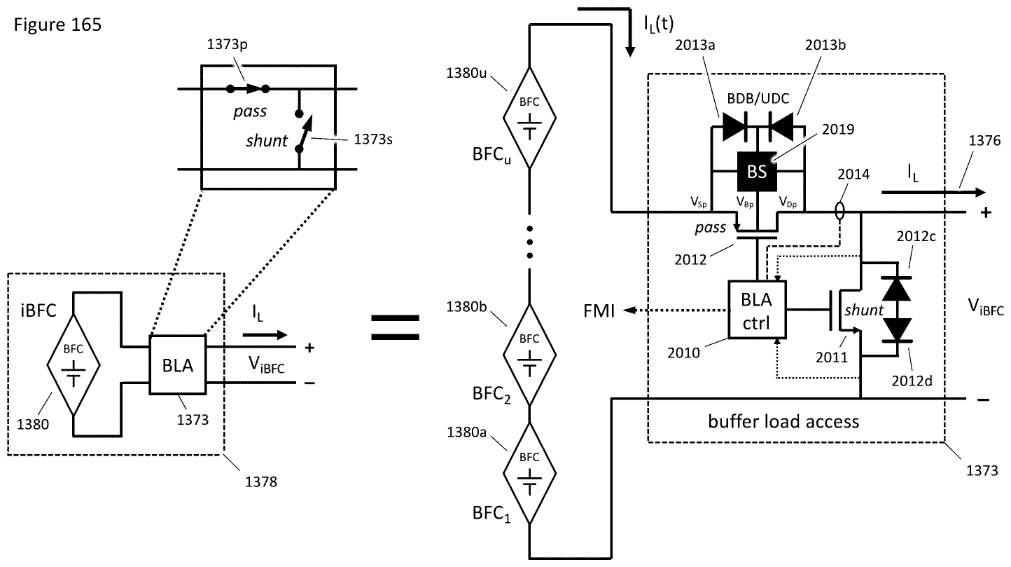

In the exemplary circuit shown in FIG. 165, BLA buffer load access is able to limit, interrupt, or bypass current supplied to an energy absorbing load and, if necessary, disconnect the load from the system. The functional description 1378 is represented by a BLA 1373 protected iBFC intelligent buffered fuel cell 1380 where the main functional element of the BLA is the combination of a disconnect switch labelled as “pass” switch 1373p and a bypass switch labelled as “shunt” switch 1373s. Together they control the current flow I_{L} out of or conducted around BFC 1380. In the pass mode when pass switch 1373p is closed and shunt switch 1373s is open, the buffered fuel cell controls the output terminal port voltage V_{iBFC}. In the shunt mode, when pass switch 1373p is open and shunt switch 1373s is closed, the buffered fuel cell is disconnected from the output and load and current may flow around the iBFC. Shunt mode is needed when stacking fuel cells in series to make higher voltages. The BLA switch array can also be biased into a disconnect mode where pass switch 1373p and shunt switch 1373s are both open where no current flow out of or through the iBFC.

Aside from switching, other functions of the BLA module 1373 include the option to sense and, if necessary, limit the outgoing current from the iBFC through a device referred pass transistor 2012, nomenclature referring to its ability to control the energy transferred, i.e., “passed” between the two circuit components. A secondary function of the pass transistor in BLA is to prevent reverse current, the condition whenever a load has a higher voltage than the iBFC denoting a load with its own internal battery power. If BLA control circuit 2010 either (i) detects that output voltage V_{BFC} is higher than the voltage uV_{BFC} indicating the presence of a power source in the connected load, or (ii) detects current 2014 flowing in the wrong direction, into the port rather than out of the port to the load, pass MOSFET 2012 acting as pass switch 1373p is biased into an off state disconnecting the iBFC string from the source. In this way charging from an external electrical source can only be performed by current flowing into the energy recovery module 1223 described previously and not by forcing reverse current through the buffer output.

Elements of the BLA buffered load access circuitry 1373 include an series-connected pass MOSFET 2012 controlled by the buffer load access BLA controller 2010 providing BDB bidirectional blocking when the device is an off state and only providing UDC unidirectional conduction from the BFC string to the load when the device is on and conducting. As such, the V_{BFC}terminals can source current I_{L} to a load but cannot receive current or recycle it. By contrast, only electrical current I_{RPE} flowing into the iBFC module through the V_{RPE} energy recovery input port can facilitate externally powered charging of the buffer cell string.

The bidirectional blocking characteristics P-channel MOSFET 2012 are indicated schematically by two back-to-back PN semiconductor diodes 2013a and 2013b. Actual implementation can be achieved either by connecting two antiparallel MOSFETs with source-to-body shorts in series in a common-source or common-drain configuration, or by using a single P-channel MOSFET with a body snatcher BS 2019, a circuit that connects the MOSFET's body terminal to either the source or the drain in a manner to ensure the PN diode bridging the source and drain terminals is always antiparallel, i.e., reverse biased.

For example, to block current in an off state P-channel MOSFET when the source potential is more positive in potential than its drain, i.e., V_{Sp}>V_{Dp}, the body snatcher circuit shorts the MOSFET's body to its source terminal V_{Bp}=V_{Sp} whereby the N-type body is biased to a more positive voltage than the P-type drain reversing biasing the body diode antiparallel to the direction of conduction. Conversely if in some reverse blocking mode V_{Dp}>V_{Sp} then the body snatcher connects the body terminal to the MOSFET's drain V_{Bp}=V_{Dp} whereby the N-type body is biased to a more positive voltage than the P-type source, and the body-to-source diode is reverse biased and unable to conduct current. In this way the gate-bias controlled channel current is the only means conduction.

The electrical properties of a P-channel implementation of the bidirectionally-blocking unidirectionally conducting BDB/UDC pass transistor are illustrated previously in FIG. 165. As illustrated the transistor facilitates bidirectional blocking in both quadrant I 2020a and quadrant III 2020b in the off state with equivalent circuits 2022a and 2022b respectively; unidirectional ohmic “switch-mode” conduction in the on-state of quadrant III 2021 represented by equivalent linear resistor 2023 comprising channel resistance R_{ch}; and as applicable saturated current conduction 2021b in quadrant III at higher current densities shown as transistor 2024. Current saturation at the a magnitude (−Iₛₐₜ) can limit the power delivered to a damaged or shorted load. If however the voltage V_{DS} across the output iBFC parallel with pass transistor 2021 exceeds V_{OC}, MOSFET 2012 is biased off by BLA control 2010, discontinuing conduction so that I_{L}=0.

Another unidirectional mode, rectifier mode 2021c represented by PN diode 2025 occurs in instances when the body snatcher circuit connects the N-type body terminal of the MOSFET 2012 is connected to its more negative potential terminal, be it source or drain. Applications vary, but the rectifier mode may be used in advance of commencing on-state conduction in ohmic mode 2023 to prevent a floating output node potential during BBM break-before-make. BBM occurs when turning P-channel pass MOSFET 2012 off and turning N-channel shunt MOSFET 2011 on, or vice versa to prevent crowbarring the buffer. During BBM the bidirectional blocking feature of diodes 2012c and 2012d means the output is floating until one of the two MOSFETs either 2011 and 2012 turn on. Using rectifier mode prevents the floating node issue. Together the function BLA buffer load access 1373, the maximum load current I_{L} output from the V_{iBFC} port is protected against excessive current and against reverse charging. The role of the shunt MOSFET is discussed in the next section.

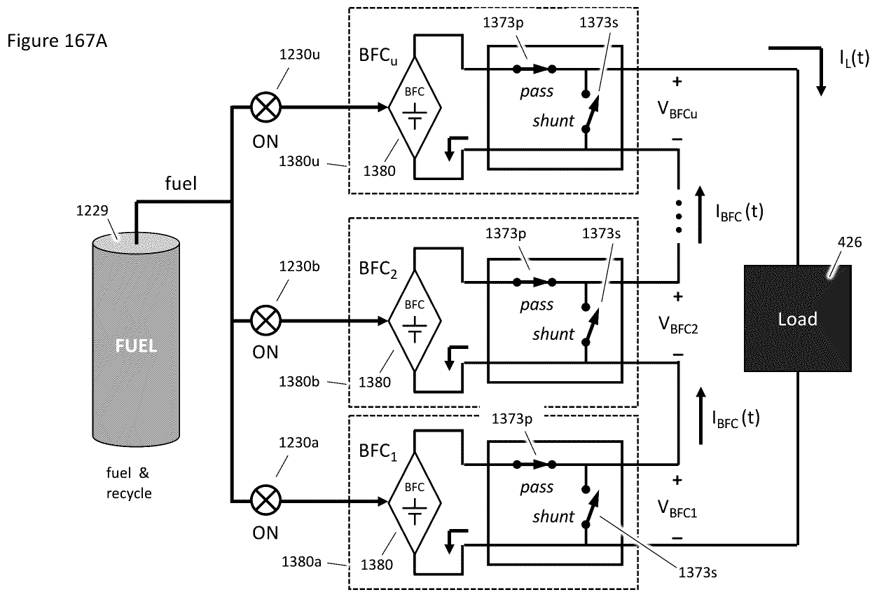

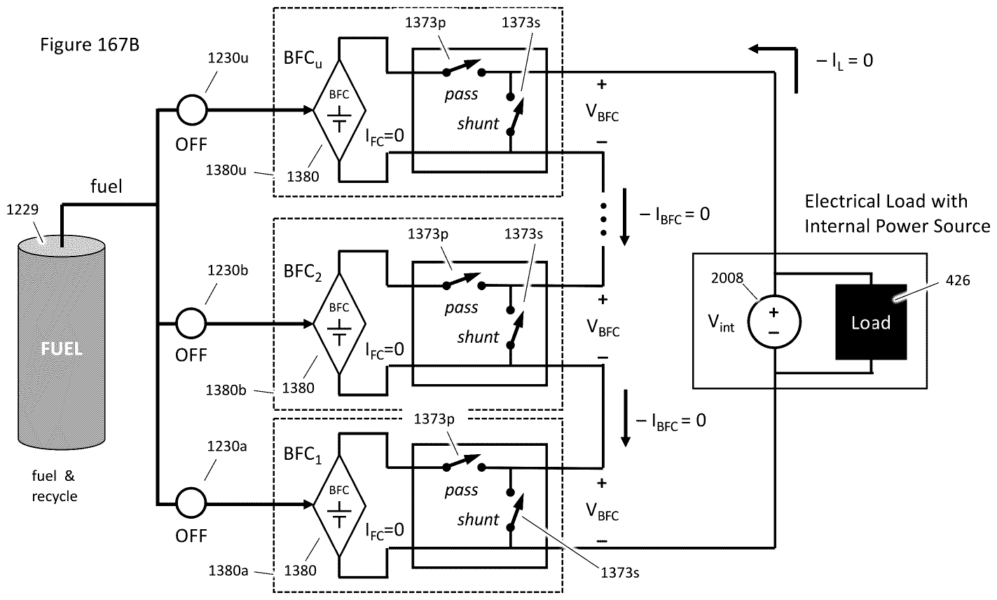

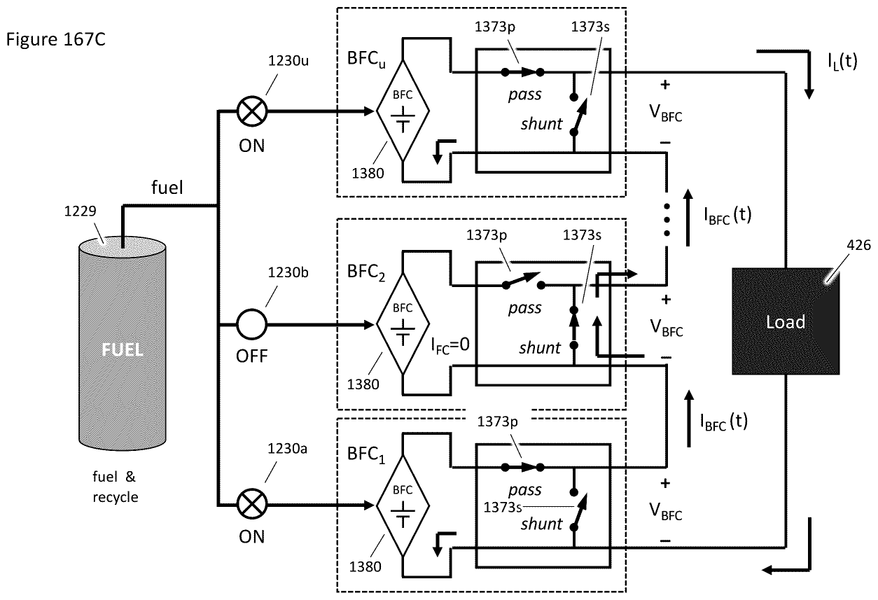

iBFC Stacking and Bypassing. Given the forgoing, every iBFC module has the capability to integrate BLA buffer load access in accordance with the system's requisite functionality. For example, FIG. 167A illustrates a stack of “u” buffered fuel cells numbered BFC₁, BFC₂, . . . , BFCᵤ realizing series conduction through all “u “cells 1230a, 1230b, . . . , 1230u to jointly power load 426 at a voltage uVBFC and a current I_{L}(t). As shown, when delivering power to a load under normal operating conditions, all pass transistor switches 1373p and microvalves 1230a through 1230u in the fuel cell array are operationally active delivering fuel 1229 to every fuel cell 1380. With all shunt switches 1373 open, the current loop includes current I_{BFC} flowing out of power generating BFC 1380 and through pass transistor 1373p in BFC₁ exiting the cathode (+terminal) and flowing into the anode of BFC₂. The current I_{BFC} then flows through power generating BFC 1380 and pass transistor switch 1373p exiting the cathode of BFC₂ and into the cell above it. The same flow pattern repeats through all superior cells until finally flowing into the anode of BFCu, through power generating BFC 1380 and corresponding pass transistor 1373p. The current emanating from cathode of the top most BFCᵤ then flows as I_{L}(t) through load 426 and back to the anode of BFC₁. By Kirchhoff's current I_{BFC}=I_{L}(t) and by Kirchhoff's voltage law V_{BFC1}+V_{BFC2}+ . . . +V_{BFCu}=uV_{BFC}=V_{L}. The power delivered to the load in therefore equal to PL=I_{L}V_{L}=I_{L}(uV_{BFC}).

In the event of an off condition, sleep mode, or an improper function the pass switch transistors 1373p open to interrupt the load current. Although ideally opening only one switch would achieve the same purpose, in reality the voltage block capability of each pass transistor is insufficient to block the voltage of the entire string of cells, but only enough to block its own generated voltage plus some guard band, e.g., using a MOSFET with a 10V avalanche voltage rated at V_{DS}≤5.5V to block a 4.2V fuel cell.

For example, as shown in FIG. 167B where a powered load 426 with its own internal power source 2008 at voltage Vᵢₙₜ attempts to charge the string of iBFCs, 1380a through 1380u, BLA circuitry detects the fault condition shutting off all pass transistors 1373a and interrupting external current to the powered load entirely whereby (−I_{L})=0. Within the buffered fuel cells however, energy transfer between the fuel cells and the buffer cells continues unabated unless gas flow valves 1230a through 1230u are opened to cut off the fuel 1229 consumption. In this manner the conversion of fuel into electric power charging the buffer can operate independently from power delivered to a load, at least until the entire fuel cell module is depleted of all charge and all fuel.

In the case where not every cell needs to be present in the stack of iBFC modules, one BFC can be bypassed without impacting the operation of others. For example, in FIG. 167C, the intelligent buffered fuel cell is commended by a system controller to disable BFC₂ while maintaining operation in the remaining cells in the stack. In this scenario, except for BFC₂ the pass transistors 1373p in every cell of the array remain active and conducting. Cell BFC₂ however charges mode whereby its pass transistor is biased off disconnecting it from the array while the shunt transistor 1373s in BFC₂ is biased into a conducting state completely bypassing its corresponding buffered fuel cell. Current flows in the same loop through load 426 and all the BFCs except for the bypassed BFC₂ module. To preserve fuel the bypassed fuel cell has its gas supply interrupted by valve 1230b while the other cells continue to consume fuel and generate power. The voltage powering load 426 becomes V_{L}=(u−1)V_{BF}C and the total delivered power is then P_{L}=I_{L}V_{L}=(u−1)I_{L}V_{BFC}.

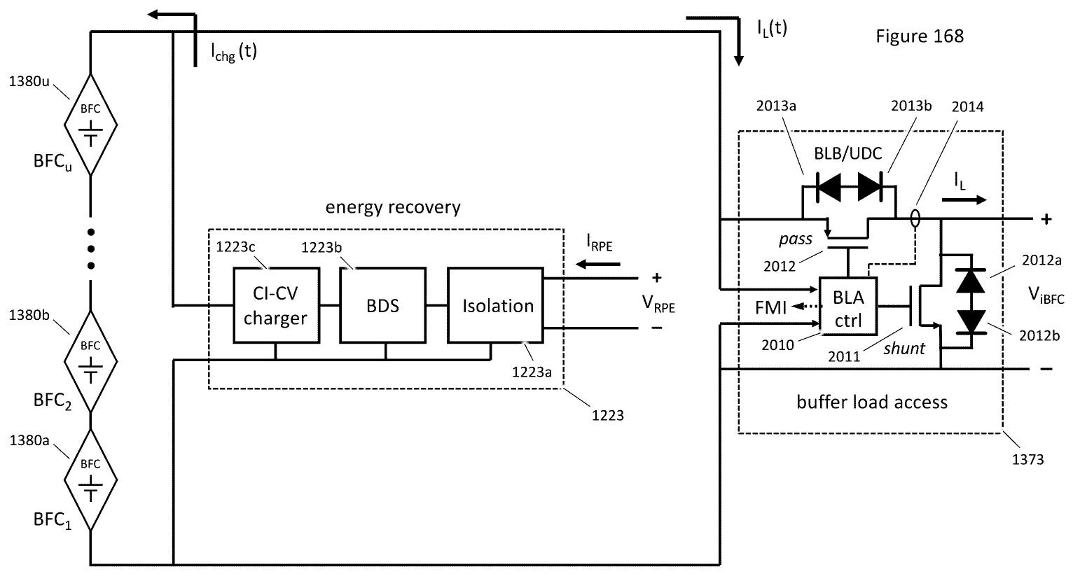

Fully Protected iBFC. Combining the described embodiments protects the iBFC from both input and output conditions. As illustrated in FIG. 168, a key principal in managing the safety of a buffered fuel with intelligence functions starts with the premise that the electrical charging input port is separate and distinct from the output port powering an electrical load. In one embodiment, energy flow into and out of buffered fuel cell 1380 involves energy recovery module 1223 for charging and buffer load access module 1373 for power delivery.

By partitioning iBFC functional responsibilities for absorbing and delivering power into different modules and different electrical paths, both activities can be more optimally performed. The dual path architecture also facilitates concurrent charging and power delivery, and the ability to control the charging rate to allocate more power for load transients. It also allows the iBFC to schedule charging off peak load periods. Safety provisions during use and/or charging, involve meeting at least three criteria:
Criterion 1: Charge transfer between the fuel cell stack and the Li-ion buffer must not damage or impair functionality of either the fuel cell or buffer cell.
Criterion 2: Connection of the iBFC to an electrical load must not damage or impair functionality of either the fuel cell or buffer cell.
Criterion 3: Connection of the iBFC to a power source must not damage or impair functionality of either the fuel cell or buffer cell.

One important feature is the ability to disconnect the buffer cell from the outside world. In two-terminal lithium ion battery packs protection during both charging and discharging from an electrical power source is performed by a battery disconnect switch or BDS. The battery BDS while preventing overcurrent, overcharge, over discharge, and over-temperature of a battery pack has no context of what power is flowing into the pack and what is flowing out.

As a single port device, it can only measure the net difference. This limited ability for battery pack to control charge transfer is problematic in the buffered fuel cell as the battery buffer cells can be charged from power generated from the fuel cell and from an external power source, all while delivering power to an electrical load. Without regulation the net charging current in the buffer cell is given by

$${I}_{buf} = {mI}_{FC} + {I}_{chg} - {I}_{L} ( t )$$

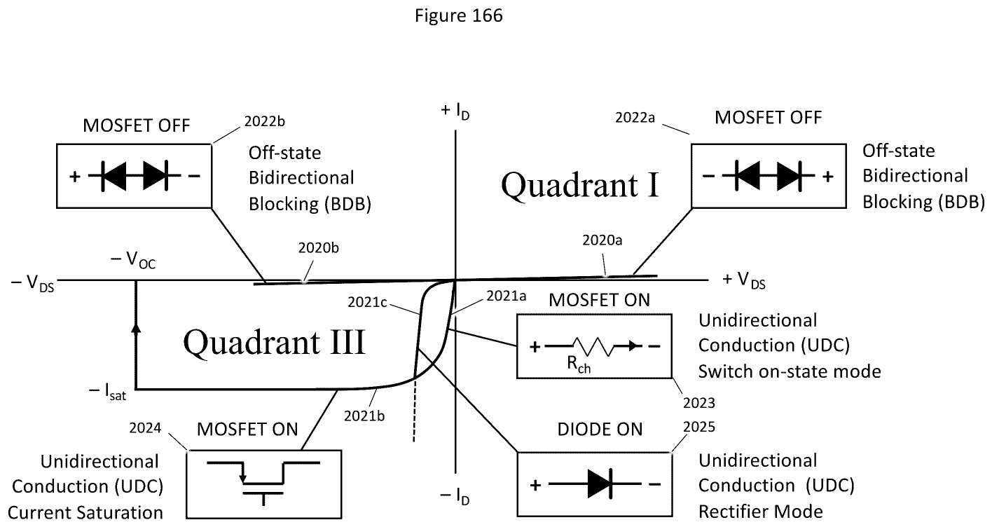

Undetected, a fault condition in any one of these power paths can cause BFC performance degradation, system malfunction, or safety risks. In order to be able to detect malfunctions and fault conditions the constituent currents flowing into and out of the buffer must be monitored and protected by various features. These include:
The QXR charge transfer regulator controlling the power flowing from the fixed or dynamic fuel cell stack into the buffer. The QXR is embedded within the BFC elements 1380 and is not explicitly shown previously in FIG. 168. The QXR prevents overvoltage of the BFC cause by buffer charging currents mI_{FC} generated by the fuel cell but cannot prevent overcharging resulting from electrical input to the energy recovery module of which the QXR has no control.
The energy recovery module 1223 responsible for conditioning incoming power from wireless magnetic charging, from transformer coupled AC, or from direct DC sources. The battery disconnect function 1223b within the energy recovery module 1223 is not the same as the BDS function used in lithium ion battery packs. As depicted previously in FIG. 163 the BDS function in the ER module is only responsible for unidirectional current flow into the BFCs and for bidirectional blocking against fault conditions but not for controlling current flow out of the BFC. In contrast bidirectional current flow requires entirely different control circuitry.
The BLA buffer load access module 1373 containing a bidirectionally blocking pass MOSFET 2012 able to connect or disconnect the BFCs from an electrical load, limit the current flow in the event of a minor overcurrent condition, or to function as a safety disconnect in the event of a shorted load. As represented in the transfer function shown previously in FIG. 166, the limited battery disconnect function realized in load access module 1373 is only able to control current out of the BFC but does not allow reverse current flow from the load back into the BFC.
Unlike a lithium ion battery BDS, the bidirectional switch function within BLA buffer load access module 1373 is capable of shunting its paralleled BFC with shunt MOSFET 2011, thereby completely eliminating the BFC or a string of BFCs from the load circuit. Obviously, the bypass shunt function is not part of any lithium ion pack BDS because it serves no purpose in conventional batteries.

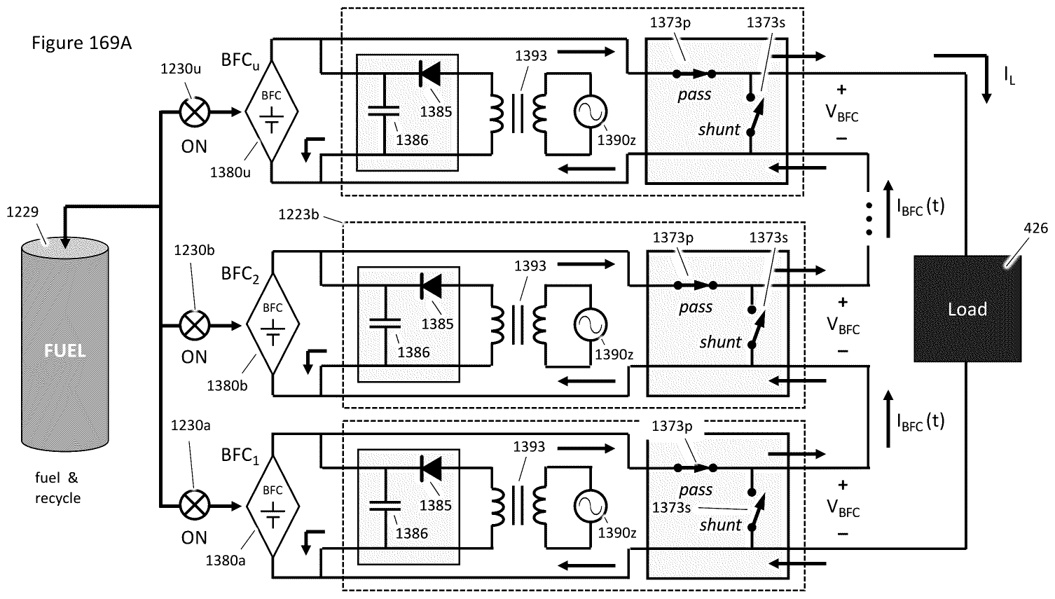

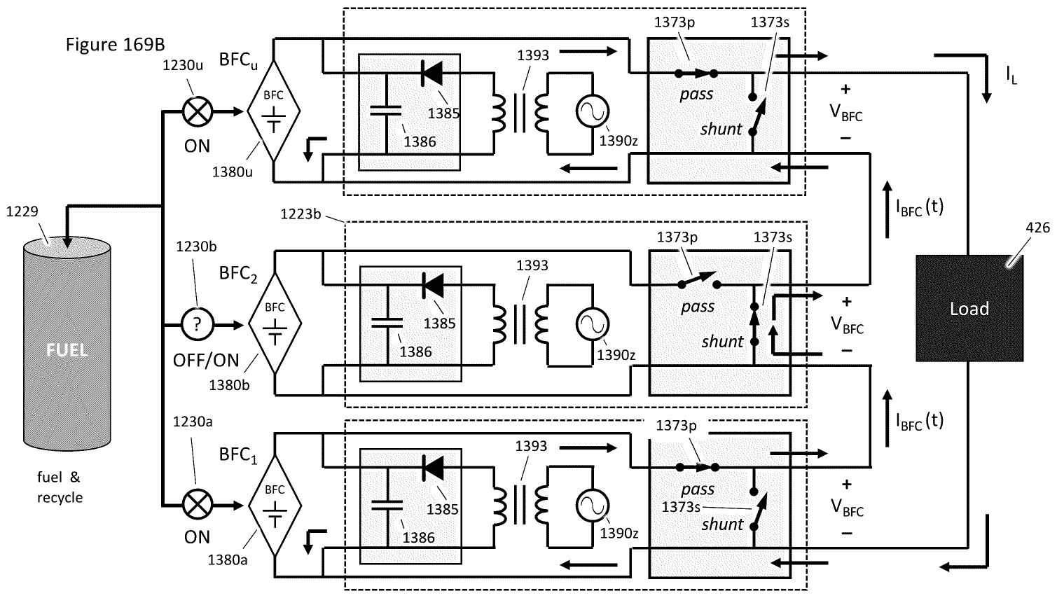

As disclosed previously, just as a string of fuel cells can be included or bypassed into a charging circuit or a load circuit, so too can entire iBFC intelligent buffered fuel cell modules. For example, in FIG. 169A every iBFC cell 1380a, 1380b, . . . , 1380u in the system ratably contributes to supplying power to load 425. As such all pass transistors 1373p are biased into a conducting on state while all bypass transistors 1373s remain off and open circuited. As shown all gas valves 1230a, 1230b, . . . , 1230u are open and delivering fuel from fuel supply 1229 to iBFCs 1380a, 138b, . . . , 1380u. Concurrently, galvanically isolated energy from AC source 1390z transfers energy through transformers 1393 into energy recovery modules (shown in abbreviated form) including rectifier 1385, filter 1386, and previously described safety functions (not shown) into the individual BFCs.

By contrast, FIG. 169B illustrates the case where all cells remain operational but cell BFC₂ which is disconnected from the load by opening pass switch 1373p and closing shunt switch 1373s. The bypassed cell may still receive fuel 1229 to charge the cell or optionally be cut off from the gas supply depending on the status of gas valve 1230b. Similarly electrical power to BFC2 through ER module 1223b may be enabled or cut off.

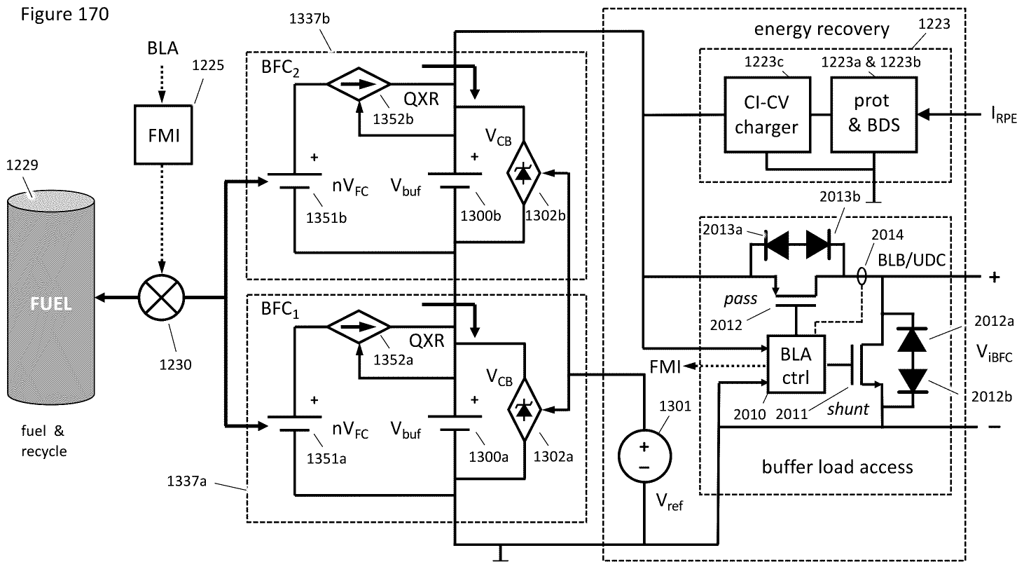

Low-Voltage Multi-Buffer iBFCs. Although complete iBFC can be connected in series to produce high voltage systems, such implementations are unnecessarily complex for low voltage operation. At voltages below 100V, intelligent buffered fuel cells have no need for AC coupled communication within the iBFC especially regarding cell balancing. Instead, cell balancing can employ a shared reference as shown in FIG. 170 comprising two series connected iBFC modules 1337a and 1337b with fuel supply 1229 and gas valve 1230 controlled by FMI fuel management interface 1225. Each buffered fuel cell is identical comprising fuel cell stacks 1351a and 1351b, QXR charge transfer regulators 1352a and 1352b, buffer cells 1300a and 1300b, and charge balancing devices 1302a and 1302b controlled from a common voltage reference Vref. 1301. For completeness, energy recover and buffer load access modules are included. Already previously described in detail, their functional operation will not be repeated here.

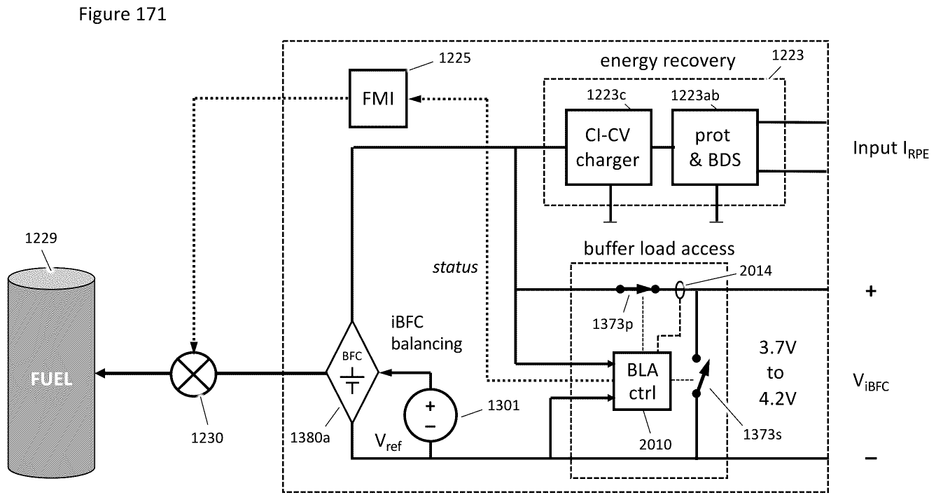

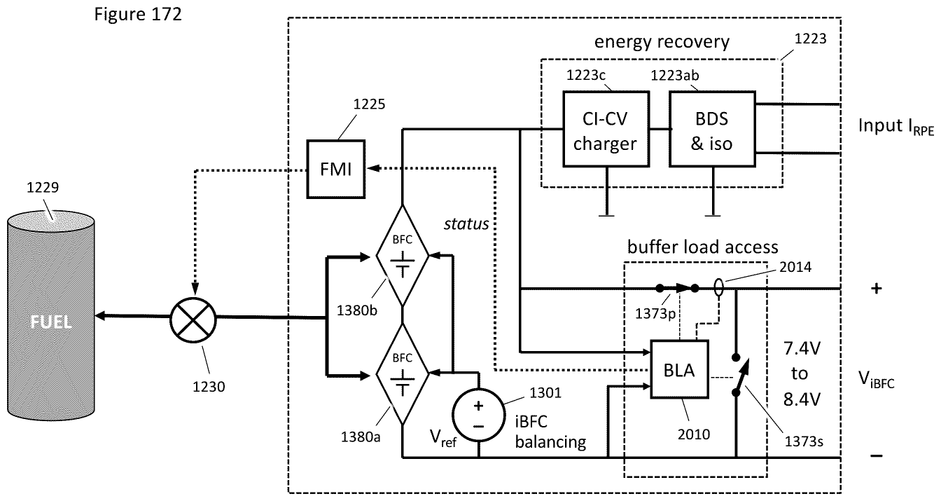

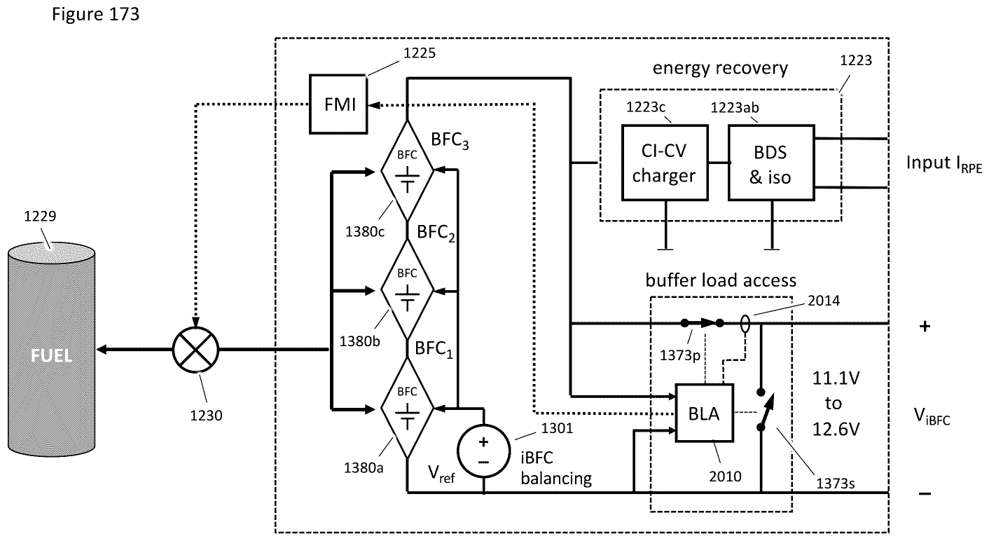

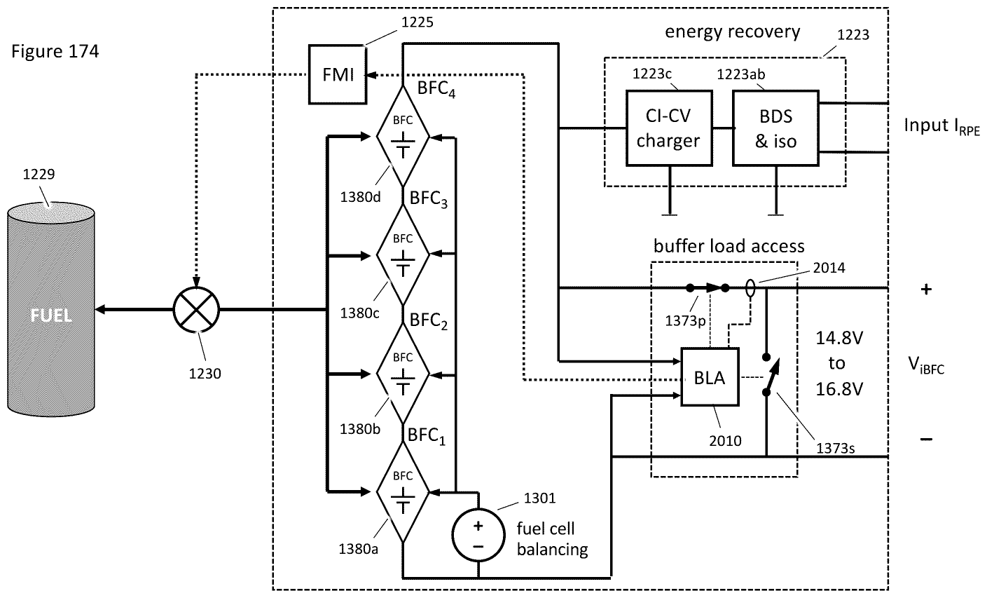

Examples of practical fuel cell implementations include a solitary iBFC modules shown in FIG. 171, a dual buffer connected iBFC module shown in FIG. 172, three series connected iBFC modules shown in FIG. 173, or four series connected iBFC modules shown in FIG. 174. The key point here is that a single voltage reference 1301 can be DC coupled using level shifting for charge balancing of one, two, three, or four buffered fuel cells with no need for isolation. Beyond a 4s array of buffer cells, a stackable architecture of iFBC modules is advantageous, more flexible, and safer.

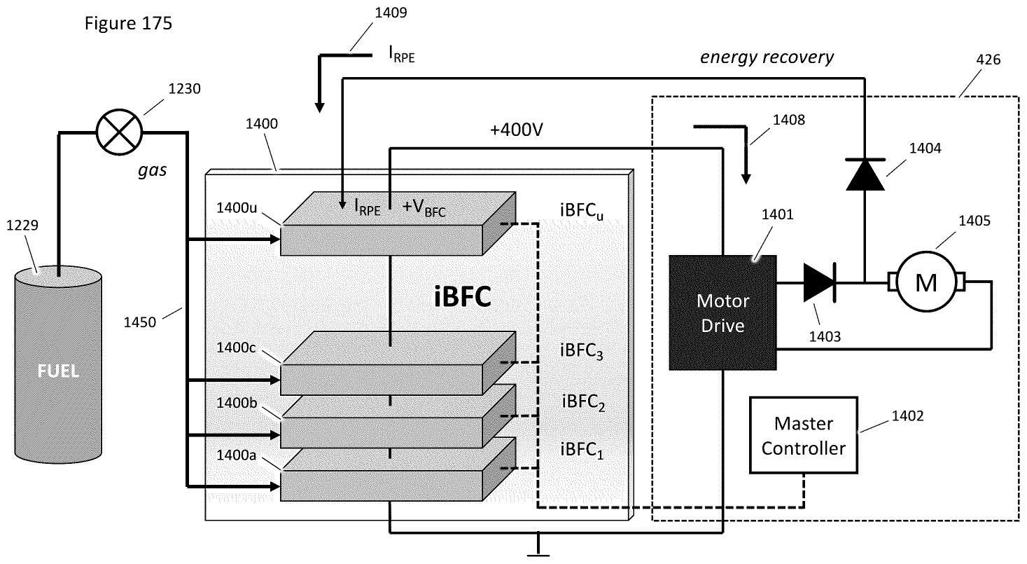

Stackable iBFC Architectures. Stacking of iBFC creates the opportunity to create higher voltage system oriented solutions to real world buffered fuel cells as disclosed herein. Applications include the 400V motor drive EV circuit of FIG. 175 comprising iBFC module 1400 comprising series connected iBFCs 1400a, 1400b, 1400c, . . . , 1400u producing a +V_{BFC}=400V powering motor drive 1401 which powers DC or AC motor 1405 through isolation diode 1403. In operation the buffered fuel cell sources current 1408 into the drive circuit which is used to produce the driving waveforms for motor 1405 which may be a brushless DC permanent magnetic motor. During braking motor 1405 becomes a generator supply current 1409 through rectifier diode 1404 into the I_{RPE} recovery input. In this way the buffered fuel cell can absorb energy from regenerative braking applications similar to an EV vehicle. Fuel cell cars cannot perform the energy recovery function as the fuel cell cannot be charged electrically. Motor drive and energy recovery can be managed by master controller 1402.

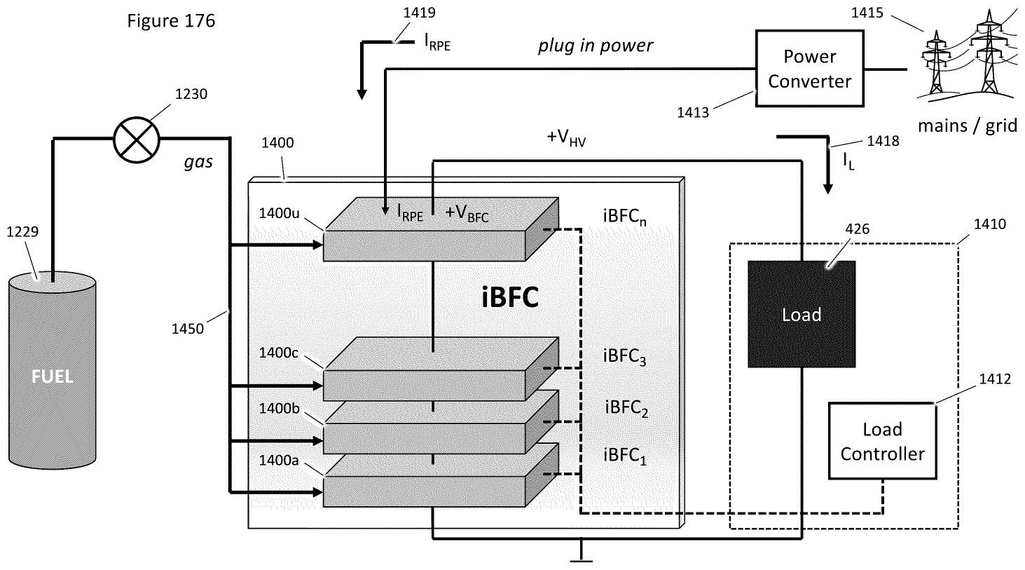

Another application, the AC mains plug-in powered iBFC of FIG. 176, powers load 426 from buffered fuel cell 1400 charged either by hydrogen fuel 1229 or from current 1419 derived from the AC mains power grid 1415 converted by power converter 1413 and fed into the I_{RPE}input. The I_{RPE} input is separate from the buffered fuel cell output+V_{BFC} providing current 1418 to load 426. Examples include a power wall, UPS for a home, hospital, office, or critical infrastructure.

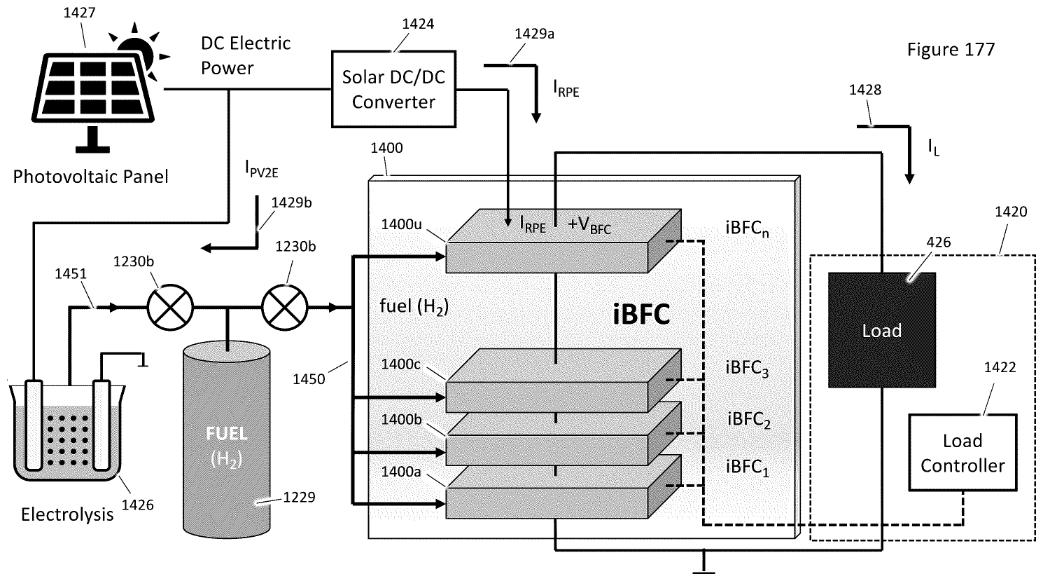

Another valuable application of the buffered fuel cell is the PV photovoltaic system of FIG. 177 comprising PV 1427 generated into electricity 1429a using solar converter 1424, and stored electrically in buffered fuel cell 1400 as input into the I_{RPE} energy recovery port. In cogeneration, a portion of electric current 1429b not stored in the iBFC is converted into hydrogen by electrolysis 1426, delivered as gas 1451 regulated by pressure regulator 1230b to prevent back-streaming, then stored in canister 1229. The gas is then released as needed by valve 1230b and supplied to buffered fuel cells 1400a through 1400u. Generated power, whether from PV electrical energy or PV green hydrogen is then supplied to load 426 in coordination with controller 1422. Load 1420 may be a residence or a commercial property.

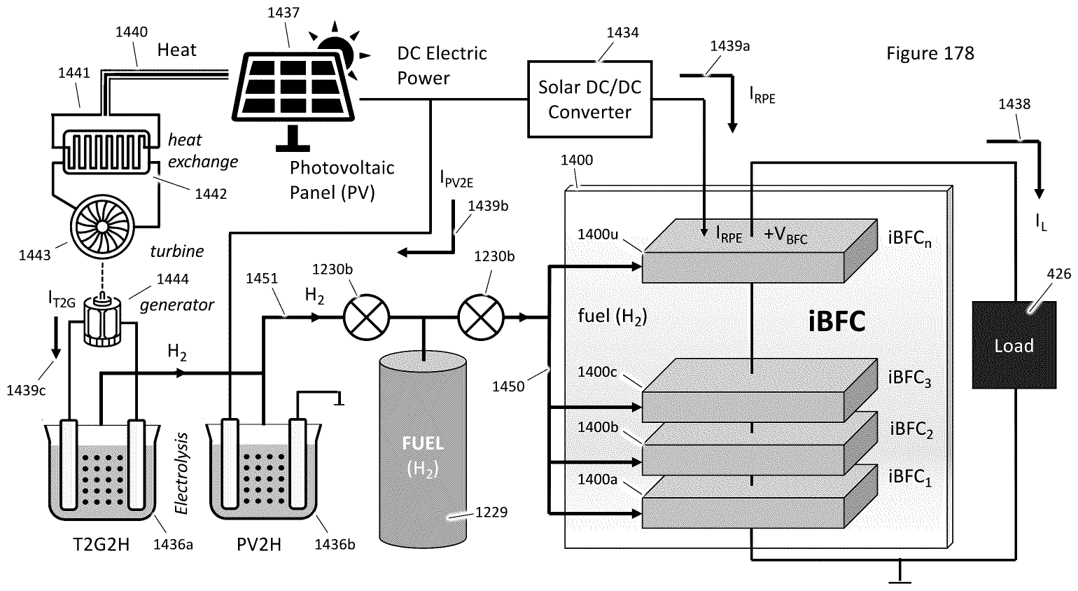

A ultra high-efficiency green power generation system shown in FIG. 178 illustrates a three channel solar cogeneration system based on the buffered fuel cell module 1400. As shown, multiple sources of energy are harvested and stored either as electrical energy in the iBFC 1400 delivered as electrical current 1439a into the iBFC's I_{RPE} port, or by hydrogen stored in canister 1229 and delivered into fuel cells 1400a through 1400u through regulator-valve 1230b. For channel cogeneration includes
PV generated electric current 1439a processed by solar converter 1434, a DC/DC regulator, and fed directly into the IRPE input of buffered fuel cell 1400.
PV generated electric current 1439b comprising electric current I_{PV2H} used to power PV2H electrolysis 1436b where the electrolysis generated hydrogen 1451 is supplied to canister 1229 through valve 1230b. The acronym PV2H means photovoltaic to hydrogen.
Solar thermal electric current generation and hydrogen electrolysis where the heat 1440 from PV panel 1437 is converted into steam by heat exchanger 1442 turning a turbine 1443. The turbine turns generator 1444 producing I_{T}2G electric current 1439c which is converted into hydrogen by T2G2H electrolysis 1436a and where the electrolysis generated hydrogen 1451 is supplied to canister 1229 through valve 1230b. The acronym T2G means turbine to generator and the acronym T2G2H means turbine-to-generator-to-hydrogen.

In this manner, an extremely high generation efficiency from solar to electricity can be realized for residential, commercial, and primary power applications.

Main Features of Buffered Fuel Cells. An overview of the inventive concepts embodied in this disclosure are summarized here. This section is not intended to limit or narrow the scope of the methods and apparatus discussed throughout the disclosure, but simply to enumerate some key features and how they overcome intrinsic limitations of present day fuel technology.

Fuel Cell Power Converters. In power electronics, the generation of electrical energy in its raw form is almost certainly unsuitable for direct use by an electrical load without some intermediary device or circuit referred to as a power converter. The role of power conversion is to correct for intrinsic incompatibilities between a power source and its electrical loads. These incompatibilities may include significant differences in voltage, current, impedance, transient response, frequency, phase, power factor, line noise, and harmonic distortion.

Examples of power converters include isolated step-down AC-to-DC universal input converters used to safely power smartphones and notebook computers from the 110V and 220V AC mains; step-down DC-to-DC converters needed to reduce 16V battery packs into precisely-regulated sub-1V high-current power supplies for microprocessors; step-up DC-to-AC power inverters used in UPS uninterrupted power supplies to convert battery storage into 110V AC for emergency power backup; step-up high-voltage isolated flyback converters used in power factor correction to maintain current and voltage phase in AC powered reactive loads; step-up DC-to-DC converters used to convert battery power walls into 400V DC power for electric vehicle charging; step-up DC-to-AC solar inverters and microinverters used to converted power from photovoltaics into 220V AC to feed the AC mains and thereby reducing residential electric bills; and constant-voltage DC multiphase motor drivers able to convert DC into multiple phase-locked current outputs each driving separate windings in a multiphase permanent magnet motor. Another class of power converter, battery chargers involve a AC-to-DC or DC-to-DC converter whose output currents are designed to match the requisite charging profile of specific battery chemistries such as lithium ion, sodium-ion, zinc-air, lead-acid, or metal hydride cells.

All these power converters share one thing in common. Although they produce a myriad of output voltage and current waveforms, they all require a stiff voltage source as their input. A stiff voltage is a power input whose voltage does not substantially drop when delivering higher currents, meaning the voltage is relatively constant over a specified range of load currents.

Fuel cells by contrast are not at all stiff voltage sources. Fuel cell voltages can vary by 5×, i.e., 500% with only a doubling of current. By contrast, AC power from home outlets can deliver 20 A and drop less than 0.1% in voltage. A lithium ion battery pack can deliver 100 A surge to a motor or microprocessor and vary by less than 1%. To make a conventional fuel cell emulate a stiff voltage source the cell must be severely overdesigned in capacity. For example, a conventional power hungry desktop personal computer consumes 150 W of average power, but its peak power demand can exceed 1,200 W to 2,300 W depending on it processing power. Accordingly, its peak-to-average power ratio is between 8× and 15×. Including guard banding, a fuel cell must therefore be designed to conduct ten-to-twenty times its average current in order to avoid voltage sag. Such an extreme overdesign renders fuel cell technology too bulky, heavy, cumbersome, and far too expensive for most commercial and computing applications.

Unfortunately making a fuel cell small means it can't function as a stiff voltage source. As such conventional power converters are not properly suited to transfer power from a practically sized fuel cell to a real-world electrical load. In this context the term “real world load” refers to an electrical load where its current cannot be controlled or limited by the system or product designer. For example, a large motor requires a high inrush current to overcome stiction, otherwise the motor will never start turning, a condition known as a frozen rotor. So unless sufficient current is delivered at startup the motor will fail. It is therefore problematic that in compact fuel cells, the voltage of a fuel cell drops precipitously whenever too much current is drawn from it.

Unfortunately, inserting a power converter between the fuel cell and the load generally doesn't help. For example, in normal power converter operation whenever load current increases the regulator must immediately draw more power from its input. If the power source is a stiff voltage, the converter adjusts its operating conditions by modulating it power transistor's pulse width “on time” to deliver the right current and voltage at the right time. If however, the power source is a fuel cell, a rapid demand increase in load current causes the fuel cell voltage to immediately drop.

Unable to deliver the required current to achieve the target load voltage, the switching power supply increases the pulse on-time, i.e., its duty factor to 100% further increasing power demand on the fuel cell. This response essentially cause the power converter to act as a dead short crowbarring the cell. As the input voltage declines, the power MOSFETs in the converter starving for gate drive voltage no longer operate as switches. Instead the current saturates and the transistors start to burn power as heat. As the cell voltage collapses, the converter cannot deliver the target voltage, and the system completely fails generally damaging either the fuel cell, the converter, the load, or some combination thereof.

As mentioned previously, this fuel cell power instability problem cannot be solved simply by a introducing a DC-to-DC power converter or a intermediary battery pack, because these components too require a stiff voltage source to operate. Like any load, a battery charger or a power converter will malfunction if its input voltage collapses as current demand increases. Unfortunately, a charger or converter cannot guarantee when a sudden spike in high current or power to an electrical load will occur whether it's a motor, electronic system, battery pack, or another power converter.

Instead, what is needed is a fuel-cell specific power converter, an innovative “FC-to-DC” converter, which never demands more current than the fuel cell can supply. Unlike a normal power converter or battery charger, the FC-to-DC converter functions as a power converter with a current limited input, not at all the function of conventional DC-to-DC converters or battery chargers. In a limited number of applications such as incandescent bulb lamp drivers and small electronics modules with minimal input capacitance, the only current spike occurs during startup. This problem can be solved by limiting both the output current as well as the input of the FC-to-DC converter to minimize inrush current. Unfortunately, in most applications current limiting alone doesn't solve the fundamental problem because the current limited FC-to-DC converter doesn't hold enough charge in its output capacitor to supply more than a brief load transient without losing regulation of its power output.

Instead, a more universal solution, a buffered fuel cell, is disclosed herein combining the inventive concept of the current-limited FC-to-DC converter with an electrochemical cell such as a lithium-ion or sodium-ion electrochemical cell in order to store, i.e., buffer, energy untangling the demands of an electrical load from the limited power capability of a fuel cell. By adapting the FC-to-DC converter into a QXR charge transfer regulator, an energy storage buffer aka electrical buffer is able to draw power from the fuel cell without demanding excessive currents. By storing charge electrically in an electrochemical cell, the buffered fuel cell is able to immediately satisfy the unpredictable demands of its electrical loads without involving or impacting the energy generating tasks of the fuel cell.

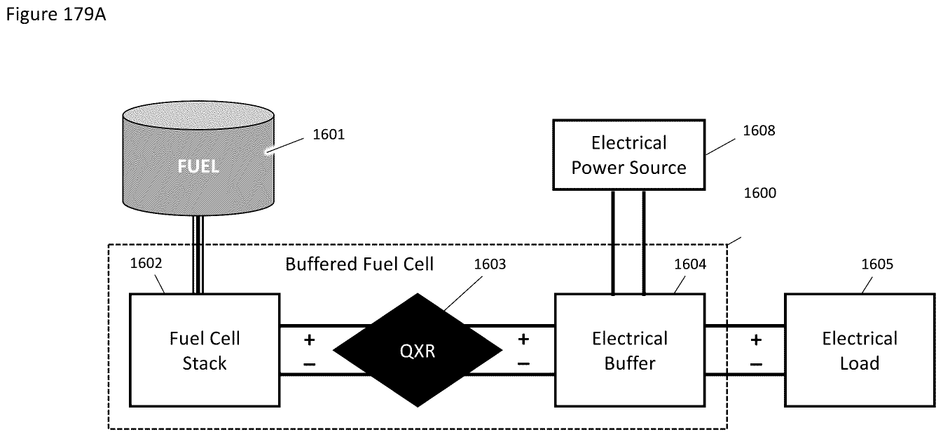

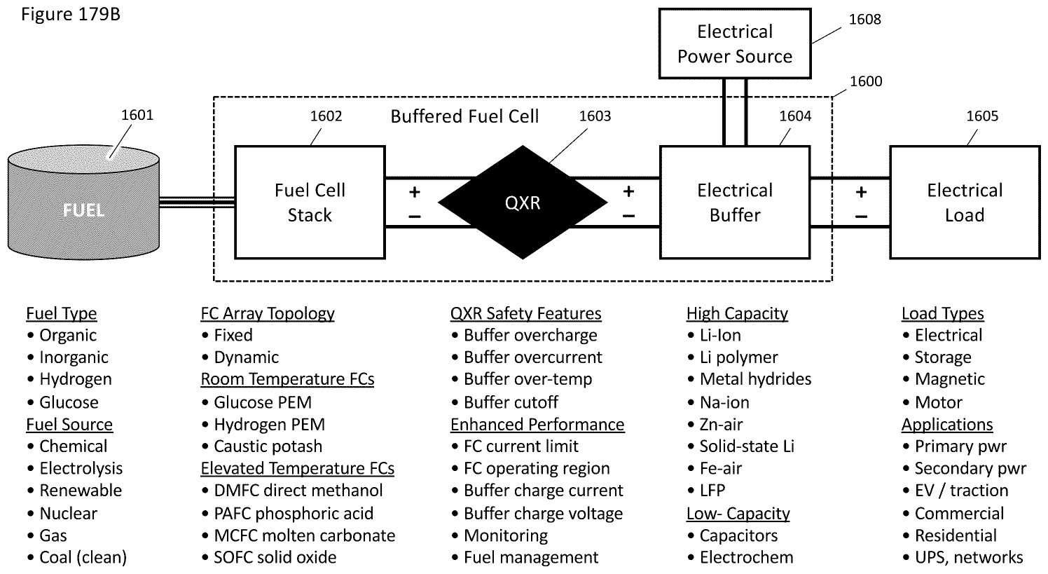

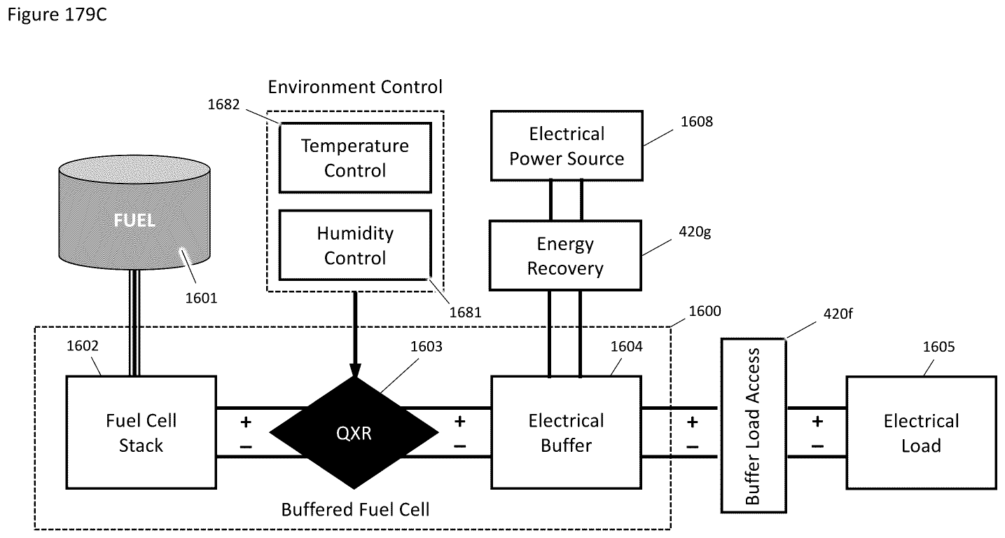

FIG. 179A depicts key elements of a buffered fuel cell 1600 as disclosed herein comprising a fuel cell stack 1602 with series connected or series-parallel connected fuel cells and electrical buffer 1604, the two elements electrically connected by an interposing charge transfer regulator QXR 1603. As shown, buffered fuel cell 1600 is supplied by an energy input comprising fuel 1601 and optionally by external electrical power source 1608, either or both of which may store charge and energy in buffer 1604. Protection against electrical overcharging of electrical buffer 1604 or from excessive currents from electrical load 1604 is not shown.

The buffered fuel cell 1600 as disclosed manages energy flow between a fuel cell stack 1602 and charge storage in electrical buffer 1604 using its inventive charge transfer regulator QXR 1603.

The charge transfer regulator QXR 1603 represents a fuel cell specific energy converter able to capture electric power generated in a fuel cell such as a hydrogen PEM fuel cell and instantaneously convert into a energy form suitable for storage as electric charge in an electrochemical buffer cell.

As enumerated in FIG. 179B, the general functions of QXR 1603 previously illustrated in FIG. 179A include an extensive list of performance enhancing features including fuel cell current limiting, adjusting charge transfer conditions to best match a fuel cell's optimum operating region at a given humidity and temperature, controlling buffer charging current and voltage, monitoring and reporting on the BFC status, and conserving fuel, i.e., fuel management. Safety functions of the QXR include protection against buffer over-voltage, buffer over-current, and buffer over-temperature. The QXR 1603 can also be used as a cutoff switch to disconnect the fuel cell stack 1602 from electrical buffer 1604 for monitoring and measurement activities, for sleep mode, or as a safety switch against leaks or malfunction. When QXR 1603 is cutoff the gas supply or glucose supply to fuel cells can also be cutoff.

Although these functions as described are generic, they must be adjusted to match the fuel cell and the electrical buffer. As such the buffered fuel cell represents an integrated modular solution adaptable for any technology used to construct fuel cell stack 1602 and any electrochemistry used to manufacture electrical buffer 1604. For example, fuel cell stack 1602 may comprise a fixed array of cells or a dynamically reconfigurable topology.

The cells themselves may comprise either permeable or semipermeable membranes including ion-exchange, microfiltration, and ultrafiltration membranes; porous materials using fabrics, glass fibers, and polymers; and more recently PEM proton exchange membranes. They may include room temperature fuel cells including glucose, hydrogen, and caustic potash (potassium hydroxide) electrochemistry, or elevated temperature operation cells including DMFC direct methanol, PAFC phosphoric acid, MCFC molten carbonate, and SOFC solid oxide compositions. Fuels 1601 include organic, inorganic, glucose, and hydrogen fuels. Fuel sources may include chemical, electrolysis, or hydrogen generated from nuclear power, natural gas and methane, or carbon-sequestered coal. In an emerging post hydrocarbon economy, hydrogen is projected to become widely available either by direct dispensing as fuel or through gas canisters sold at convenience stores and gas stations the same way propane is distributed today.

Electrical buffers may be constructed as high capacity electrochemical cells, i.e., batteries, low capacity buffers including or capacitors, supercapacitors, and organic compounds. High capacity chemistries include lithium ion, lithium polymer, sodium ion, metal-hydrides like NiMH, zinc air, solid state lithium, iron air, and LFP lithium iron phosphate. Lead acid cells are generally considered too heavy and caustic for most applications.

Aside from customizing QXR 1603 settings to match specific chemistry specific voltages and currents, the operation of buffered fuel cell 1600 as described is functionally independent of the fuel cell and buffer technologies it integrates. As such BFC 1608 is able to generate and store power with the capability to drive the full range of load types including electrical, magnetic, motor, and energy storage devices. The disclosed buffered fuel cell along with intelligent buffered fuel cell counterpart has applications in primary power generation, secondary power generation, electrical vehicle and traction applications, along with commercial, residential, networks, and UPS uses.

FIG. 179C provides a block diagram of an iBFC intelligent buffered fuel cell combining a fuel cell stack, QXR charge transfer regulator, and buffer cell with intelligent power modules for ER energy recovery 420g and BLA buffer-load access 420f. The electrical functions of the ER and BLA modules control energy flow into and out of the buffer from external power sources and electrical loads, providing protection and regulatory functions. The iBFC also include environmental control

General BFC Operation. In operation, buffered fuel cell 1600 primarily delivers electrical power-upon-demand to load 1605 directly from buffer 1604 and minimally from fuel cell stack 1602. In this manner the source of incoming power, be it fuel 1601 or electrical power source 1608 does not need to directly power load 1605 but instead generates and transfers power via, i.e., through buffer 1604. Buffer 1604 in accordance with its namesake, thereby functions as an electrical buffer, minimizing the impact of current spikes and load transients of its performance.

The reason electrical buffer 1604 and not fuel cell stack 1602 delivers surges in power demand to electrical load 1605 is because the electrical properties of fuel cell stack 1602 and electrical buffer 1605 differ greatly. Most significantly, fuel cell stack 1602 has an electrical resistance measured in the ohms, e.g., 100 for a stack of eight cells with a nominal voltage of 4V, while the same voltage electrical buffer has a resistance measured in milliohms, e.g., 4mΩ representing orders-of-magnitude higher resistance. The other reason high-current demand and transients in electrical load 1605 is supplied almost exclusively from electrical buffer 1604 and not from fuel cell stack 1602 is that the fuel cell cannot operate as a stiff voltage source, i.e., a constant voltage independent of current. As such, fuel cell stack 1602 is prevented from supplying high currents to a load by the intervention of current limiting performed by QXR 1603. Metaphorically speaking, even if fuel cell stack 1602 tried to compete with electrical buffer 1604 in supplying high currents to electrical load 160, the current limiting feature of charge transfer regulator QXR 1603 won't allow it.

In other words, in buffered fuel cell BFC 1600 operation, electrical buffer 1604 almost exclusively supplies the energy for current spikes and transients, and for periods of high power demand from electrical load 1605. When high load current demands subside, fuel cell stack 1602 is able to comfortably replenish lost charge in electrical buffer 1604 at a rate that doesn't overstress the fuel cell or cause voltage sag. In this sense the buffered fuel cell behaves like a self-recharging battery and not a fuel cell.

While electrical buffer 1605 almost exclusively handles peak power load conditions and supplies power during current transients, electrical buffer 1605 contains limited charge and will invariably become depleted over time unless the lost buffer charge is replenished. This means the average power output generated in fuel cell stack 1602 must exceed the average power consumption rate of electrical load 1605_{L} or P_{FC}≥P_{L}. More specifically, once fuel cell stack 1602 fully recharges the buffer of its lost charge, BFC 1600 enters steady state operation. In steady state operation, buffer 1605 is fully charged and the net buffer current is zero or I_{buf}=0, where any charge removed from buffer cell stack 1602 is contemporaneously replaced.

Another property of steady state BFC operation is the load current I is a small fraction of its peak demand, exhibiting minimal voltage drops across resistive parasitics and QXR 1603 within BFC 1600. At low currents, voltage V_{FC} Can be considered as approximately equal to both the buffer and load voltages whereby V_{FC}≅V_{buf}=V_{L}. This means in order to supply the necessary average power to electrical load 1605 to prevent discharging of electrical buffer 1604, the fuel cell must be sized to meet the criteria I_{FC}(ave) I_{L}[(ave).

Given that a fuel cell with unit area A_{FC}, for example 1 cm², is able to produce a nominal current I_{FC} of 200 mA, then the current density in the cell can be calculated by ratio [I_{FC}/A_{FC}] or in the example cited as 0.2 A/cm². The bracketed notation [I_{FC}/A_{FC}] means current density is a BFC design parameter which affects other characteristics. For example, a fuel cell operating at 70% relative humidity might exhibit a nominal voltage of 0.53V at 0.2 A/cm² but only 0.33V at 16 0.7 mA/cm². To calculate the minimum size fuel cell to deliver a specified load current, the total area mA_{FC} required is given by the inequality

m_{AFC}≥I_{L}/[I_{FC}/A_{FC}]

where A_{FC} is the unit size area of the fuel cell, typically 1 cm², and “m” is the scaling factor or area multiplier. It should be noted that although running a fuel cell at a higher current density [I_{FC}/A_{FC}] requires a smaller fuel cell, its lower voltage means more cells must be stacked atop one another to produce a usable voltage such as 4V. A greater number of series cells however increases fuel cell resistance, lowers energy conversion efficiency, and increases fuel consumption. Moreover, operating at higher current densities makes the fuel cell more sensitive to low humidity and low temperature operation.

Buffered Fuel Cell Embodiments: As depicted in FIG. 179B, in one embodiment of this invention, a buffered fuel cell BFC 1600 comprises a fuel cell stack 1602, a charge transfer regulator QXR 1603, and an electrical buffer 1604 whereby; fuel cell stack 1602 converts fuel into electrical power using two or more coupled electrochemical processes typically involving oxidation and reduction reactions; electrical buffer 1604 comprising a battery, capacitor, or electrochemical storage device concurrently stores the generated electric current as electric charge; charge transfer regulator QXR 1603 controls charge transfer and regulates the buffer-charging process.

As such QXR 1603 operation guarantees (i) the buffer voltage remains within a specified range regardless of operating fuel cell voltages, (ii) the maximum fuel cell current does not exceed a specified current or current density; and (iii) the buffer charging current does not exceed some specified current or C-rate; where any current delivered to electrical load 1605 in excess of the current limit setting of QXR 1603 is supplied from electrical buffer 1604, not from fuel cell 1602; and fuel cell stack 1602 generated current in excess of current delivered to electrical load 1605 is used to charge electrical buffer 1604 up to its maximum voltage, above which charging is terminated to avoid overcharging the buffer cells. In this manner, the buffered fuel cell essentially isolates the electrochemical fuel cell from the electrical load acting as an intermediary to protect the fuel cell from excessive current demands by an electrical load which the fuel cell cannot realistically supply even for very large area fuel cells.

In another embodiment, electrical buffer 1604 in buffered fuel cell BFC 1600 is capable of being charged from multiple energy sources comprising both fuel cell stack 1602 and external electrical power source 1608. Unlike a uninterrupted power supply or EV battery which requires a stable power source like the AC mains for charging, electrical power source 1608 may be intermittent comprising unstable power sources including renewable power from solar arrays, wind turbines, or from energy recovery such as regenerative braking. During operation, BFC 1600 is capable of concurrent charging of electrical buffer 1604 from both external electrical power source 1608 and fuel cell stack 1602 without overcharging the electrical buffer. Although QXR 1603 prevents overcharging of electrical buffer 1604 from fuel cell stack 1602, the basic buffered fuel cell BFC 1600 does not include protective provisions to prevent buffer cell overcharging from electrical power source 1608 or over-discharging caused by electrical load 1605. As an upgrade to BFC 1600, these intelligent protective embodiments referred to herein as an intelligent buffered fuel cell or iBFC are disclosed later in this summary.

Benefits of the buffered fuel cell are discussed in greater details in text related to FIG. 52A through FIG. 54 with specific fuel cell array topologies described in FIG. 55 though FIG. 69B.

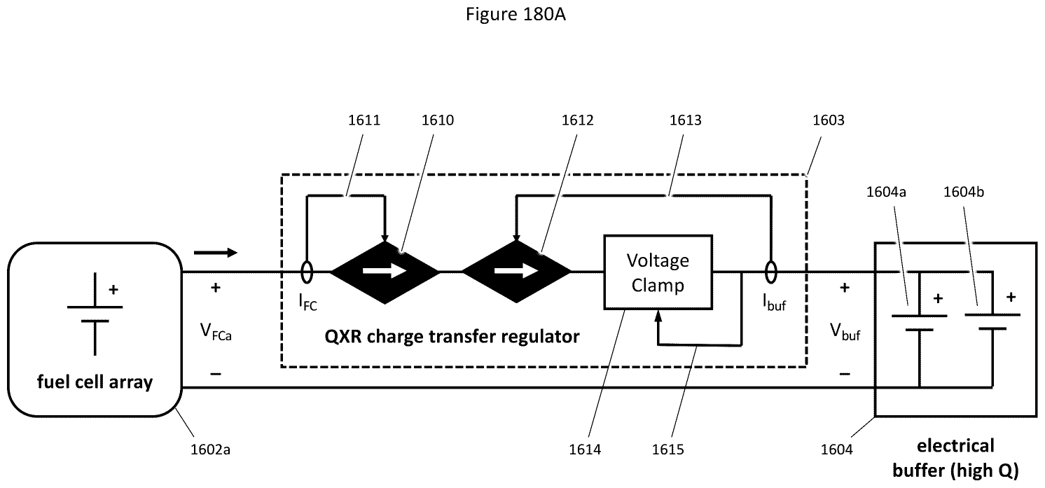

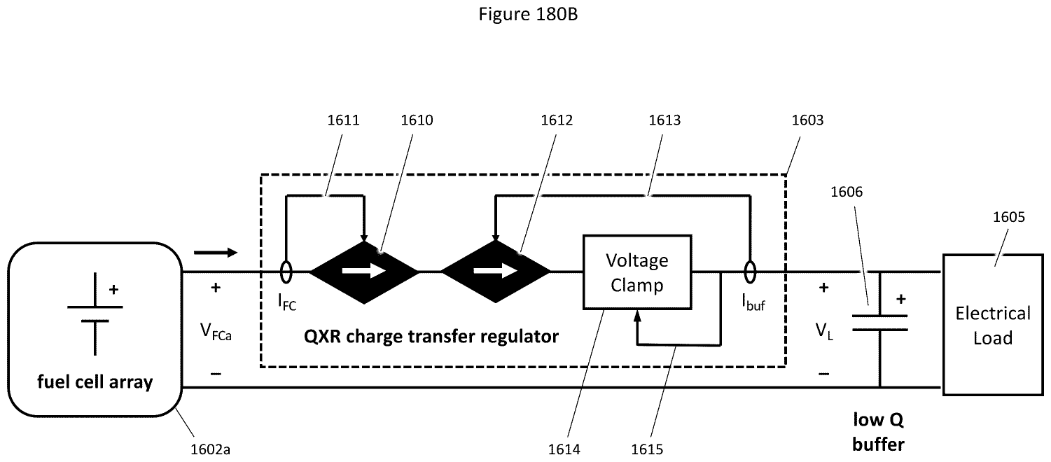

QXR Functionality: Exemplary details of charge transfer regulator QXR 1603 depicted in FIG. 180A include two current limiters 1610 and 1612 connected in series with voltage clamp 1614. Together the two current limiter functions determine the maximum charge transfer rate between the fuel cell array 1602 generating electric current and the electrical buffer absorbing it.

Although the schematic representation illustrates two discrete current limiter elements with one controlling the maximum fuel cell output and the other controlling the maximum buffer current charging input, the two functions may be merged into a single current limiter with two different settings selected for whichever condition is more limiting. When the load current is low and the buffer is nearly fully charged current limiting may be deactivated whereby only voltages and intrinsic resistances determine conduction.

With regard to limiting the fuel cell generated current, current sensor 1611 detects the current I_{FC} flowing out of fuel cell array 1602a and delivers the measurement to current limiter 1610 which compares it to a design specification I_{FC}(max). The comparison may be accomplished as an analog circuit with a differential amplifier, as mixed signal circuitry using a comparator to turn the function on and off, or digitally using discrete or software programmable logic to analyze a digital representation of the measured current. Regardless of its implementation as analog circuitry, conditional logic, or a programmable truth table, if I_{FC} I_{FC}(max) then current limiter 1610 acts like a resistive pass element and does not restrict the current flowing from fuel cell array 1602a to electrical buffer 1604. In the event that I_{FC}>I_{FC} (max) then feedback signal 1610 is used in closed loop current regulation thereby limiting the fuel cell current to I_{FC}(max).

The magnitude of the fuel cell current limit depends on the fuel cell area given by the relation I_{FC}(max) mA_{FC}[I_{FC}/A_{FC}]. The current density parameter [I_{FC}/A_{FC}] is a technology-specific design parameter for current density, generally chosen to maximize power efficiency, to avoid voltage sag, and/or to minimize fuel cell variations due to humidity and temperature changes. For hydrogen proton exchange membrane fuel cells, for example, the recommended design range in current density [I_{FC}/A_{FC}] may range from [0.2 A/cm²] to [0.7 A/cm²].

In series with dependent current source 1610 is a second dependent current source 1612. As depicted, current sensor 1613 detects the current I_{buf} flowing into buffer 1604 and delivers an analog, digital, or numerical representation of the measured current to current limiter 1612. The current limiter function then compares the measurement against a design specification I_{buf}(max). If I_{buf} I_{buf}(max) then current limiter 1612 acts like a resistive pass element and does not restrict the current flowing from fuel cell array function in closed loop current regulation thereby limiting the buffer current to I_{buf}(max). If however I_{buf} >I_{buf}(max) the current is limited to the value I_{buf}(max).

The value of the maximum charging current I_{buf}(max) flowing into buffer 1604 depends of the electrochemistry of the buffer cells and the number of parallel cells in the buffer. In the case of a lithium ion chemistry, a maximum charge current of 2C is an industry standard. As such, a 1s1p buffer cell (not shown) has a current limit of I_{buf}(max)=2C comprising I_{buf} (max)=6 A for a Q_{buf}=3 Ah 18650 cell and I_{buf} (max)=8 A for a Q_{buf}=4 Ah 21700 cell. Accordingly for the exemplary 1s2p buffer cell shown in FIG. 180A comprising Li-ion cells 1604a and 1604b has a current limit of I_{buf}(max)=2(2C)=4C. As such, I_{buf} (max)=12 A for a Q_{buf}=3 Ah 18650 cell and I_{buf} (max)=16 A for a Q_{buf}=4 Ah 21700 cell.

Although in electrical engineering, the series connection of two ideal current sources is non-sensical, the series connection of two dependent current sources, namely current limiters 1600 and 1612, is perfectly logical as whichever current limiter conducts less current sets the maximum current flow between fuel cell array 1602a and electrical buffer 1604. Given the strong dependence of voltage and current of a hydrogen PEM fuel cell on the environmental conditions of humidity and temperature, it is difficult to ascertain a priori whether BFC current is limited by the fuel cell or the buffer. While compact fuel cells are likely limited by the fuel cell's maximum current density parameter [I_{FC}/A_{FC}] and large fuel cells very likely exceed the maximum 2C charging rate for a Li-ion cell, in a balanced BFC design either criteria might be limiting. Symbolically putting two current limiters in series means whichever current is lower, i.e., more restrictive, sets the maximum charge transfer rate. In other words, one device limits the current and the other one just functions like a resistor.

In reality, a single linear control pass transistor can limit the current to either criteria using analog or mixed signal circuit designs such as those illustrated in FIG. 79A, FIG. 79B, and FIG. 79C. The net function behaves as a tri-state current limiter, whereby the QXR current is limited by the fuel cell criteria I_{FC}(max) mA_{FC}[I_{FC}/A_{FC}], limited by the charging criteria I_{buf}>I_{buf}(max), or neither. A fourth state where (I_{FC}(max)=I_{buf})>(I_{FC}(max)=I_{buf}(max)) while unlikely is mathematically degenerative (redundant) as it concurrent satisfies both current limiting criteria.

Regardless of current limiting QXR 1603 performs another even more critical safety function as a voltage clamp. As shown using voltage feedback signal 1615 to monitor the voltage present across electrical buffer 1604, voltage clamp 1614 strictly limits the voltage V_{buf} to never exceed the buffers over-charge safety limit V_{OC}. For example depending on its electrochemistry, anode and cathode composition, V_{OC} for a lithium ion battery may be 4.1V, 4.15V, or 4.2V. In an abundance of caution, the V_{OC} threshold for voltage clamp 1614 may be set to a voltage lower then the battery's safe maximum voltage.

Together, the functions of input current limiter 1610, output current limiter 1612, and voltage clamp 1614 enable the QXR 1603 charge transfer regulator to limits its input current, output current, and output voltage, thereby providing the maximum safe and reliable charge transfer from fuel cell array 1602a to electrical buffer 1604. Since all three functions set a maximum value of current and voltage, none of the three functions are truly voltage regulators, but instead can be considered only as current limiters and voltage clamps.

QXR operation is discussed in greater detail in text referring to FIG. 70 through FIG. 82B with and by for fuel cells of varying m area factors in FIG. 84 through FIG. 122. Scaling fuel cell size is considered in greater detail in the section discussing FIG. 123 through FIG. 132.

In some applications like lamp drivers and hot plugging of circuit boards, limiting the load inrush current may not cause a malfunction so long that the excess charge required at startup is not too excessive. In such cases, high capacity buffer cell 1604 can be replaced by a lower capacity buffer 1606 as shown in FIG. 180B, one able to satisfy the minimal inrush current demands or electrical load 1605 without causing a system malfunction. Low Q buffers may include AA-sized rechargeable batteries, rechargeable button batteries, and supercapacitors. Advantages of low Q buffers is their small size, low weight, and reduced sensitivity to charging conditions.

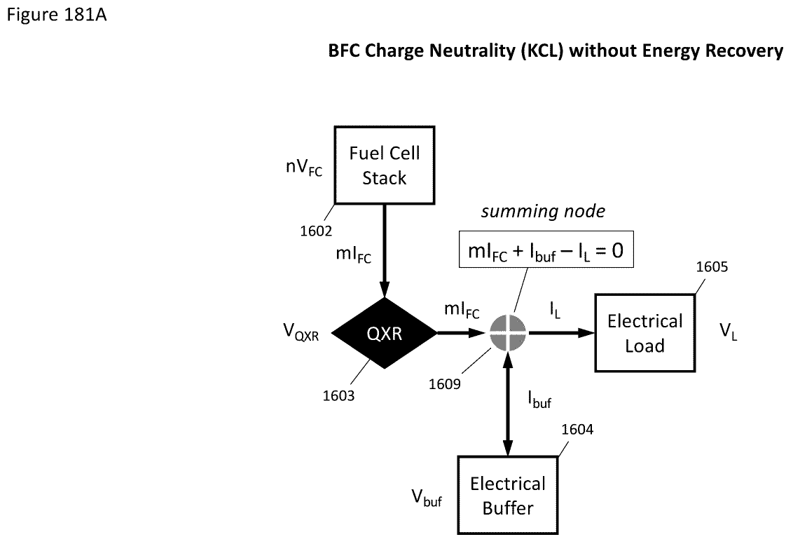

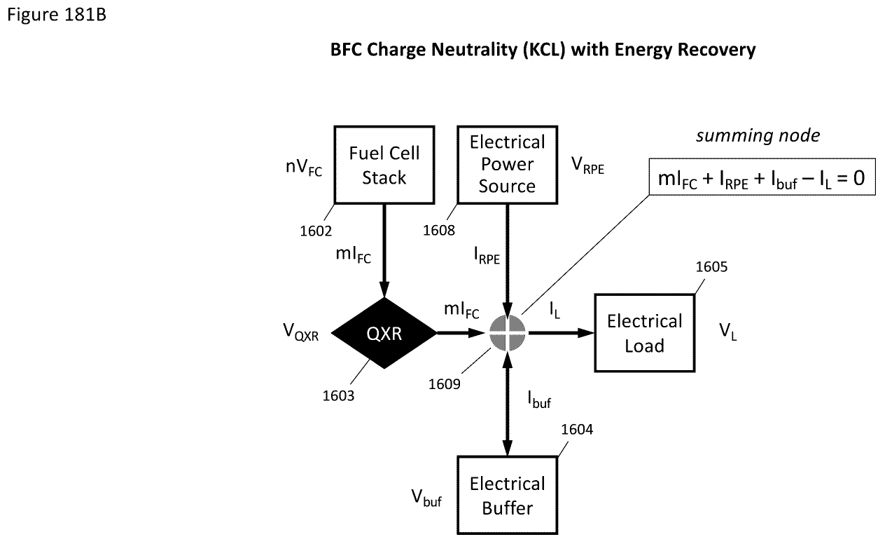

As shown in FIG. 181A, the function of QXR 1603 is to convert a highly-variable voltage nV_{FC} of fuel cell stack 1602 into a voltage range ΔV_{buf} compatible with the electrochemistry of buffer cell 1604. Whenever nV_{FC} #V_{buf} enabling conduction in QXR 1603 means the voltage V_{QXR} across charge transfer regulator QXR 1603 must according to KVL Kirchhoff's voltage law equal the difference between the fuel cell and buffer voltages until the buffer charges, namely V_{QXR}=nV_{FC}−V_{buf}. Because load 1605 is connected directly across electrical buffer 1604, then necessarily V_{L}=V_{buf} meaning two components compete for power generated by fuel cell stack 1602.

As shown, the electrical conjunction of the QXR, buffer and load is referred to as summing node 1609. As an electrical node, the summing node must exhibit charge neutrality at all time meaning the sum of all currents into the node must equal the currents leaving the node. In operation, charge neutrality is maintained in accordance with Kirchhoff's current law (KCL) governing all modes of operation by ensuring the net current in summing node 1609 is zero following the relation mI_{FC}+I_{buf}−I_{L}=0. For example, when I_{L}=0, the fuel cell generated current mI_{FC} charges the buffer exclusively, whereby mI_{FC}=−I_{buf}. Similarly in steady state operation when the buffer is fully charges and I_{buf}=0, all the fuel cell generated current mI_{FC} is delivered exclusively to the load whereby mI_{FC}=I_{L}.

As one embodiment of this invention, by controlling the charge transfer QXR 1603 ensures the aggregate current demand from buffer 1604 and load 1605 are unable to significantly impact the buffer cell stack voltage nV_{FC}. The combination of KCL and KVL also ensures that the buffered fuel cell satisfies energy conservation, i.e., where energy and power in equal energy and power output. Given the definitions P_{FC}=I_{FC}V_{FC}, P_{QXR}=I_{QXR}V_{QXR}, P_{buf}=I_{buf} V_{buf}, and P_{L}=I_{L}V_{L}, then rearranging terms confirms the conservation principle P_{FC}=P_{QXR}+P_{buf}+P_{L}.

Power loss in QXR 1603 however, is temporary only during buffer charging and does not significantly impact overall BFC energy efficiency. Specifically because V_{QXR}=V_{FC}−V_{buf}, then during charging as V_{buf} →V_{FC} and I_{buf}→0 then P_{QXR}→0. In another embodiment of QXR operation, if a load is dormant and the buffer is fully charged for example in sleep mode, the QXR may be turned off whereby I_{FC}=0. In such a condition, i.e., when cutoff, the gas flow into fuel cell stack 1602 may also be suspended using an electric valve, reducing fuel consumption and gas leakage.

It should be noted that although the charge neutrality equation for summing node 1608 equals zero, because electrical buffer 1605 is an energy storage device, it can both absorb energy as a load to fuel cell 1602 where I_{buf}<0, and source power to electrical load 1605 whereby I_{buf}>0. Moreover because of their direct connection, the electrical network depicting operation of a basic charge transfer regulator means QXR 1603 does not and cannot control charge transfer between electrical buffer 1605 and electrical load 1605.

While this direct connection is not a concern during normal operation, it can be problematic in detecting and interrupting various fault conditions including disconnecting a shorted load to prevent overcurrent in electrical buffer 1604, or in detecting or preventing reverse current flow where load 1605 sources power into electrical buffer 1604 risking both overcurrent and overvoltage failures in the buffer cell. Protection of electrical buffer 1604 from dyfunction in electrical load 1605 is considered an intelligent function as numerous factors must be considered in fault detection and response. Such functions are covered in the subsequent description of the iBFC.

Another intelligent buffered fuel cell function, energy recovery represents an inventive feature where in addition to power generation in fuel cell stack 1603, an external electrical power source 1608 may be used to charge electrical buffer 1604. Shown in the modified KCL network of FIG. 181B, the extra source of energy referred to as energy recovery and pluggable power with voltage V_{RPE} contributes an added current I_{RPE} to the summing node. Because or voltage matching and safety considerations this topic too is discussed as an intelligent feature of the iBFC and will not be further elaborated here.

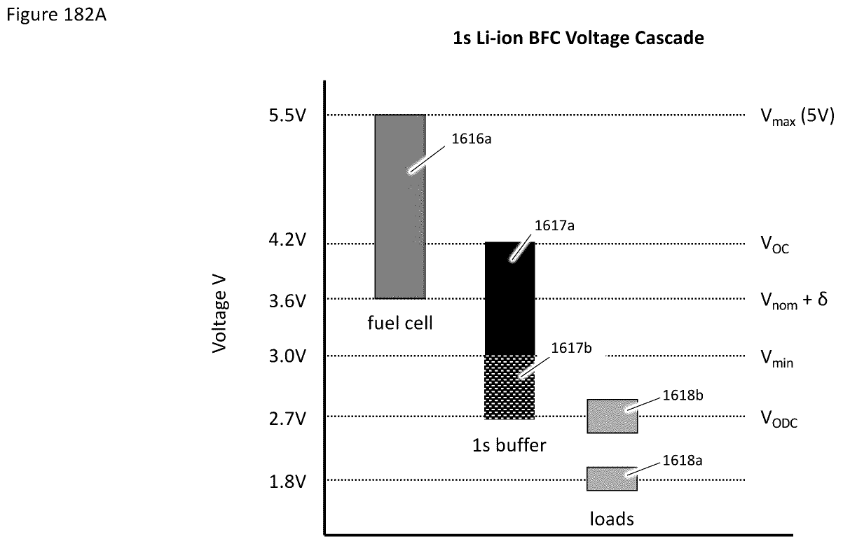

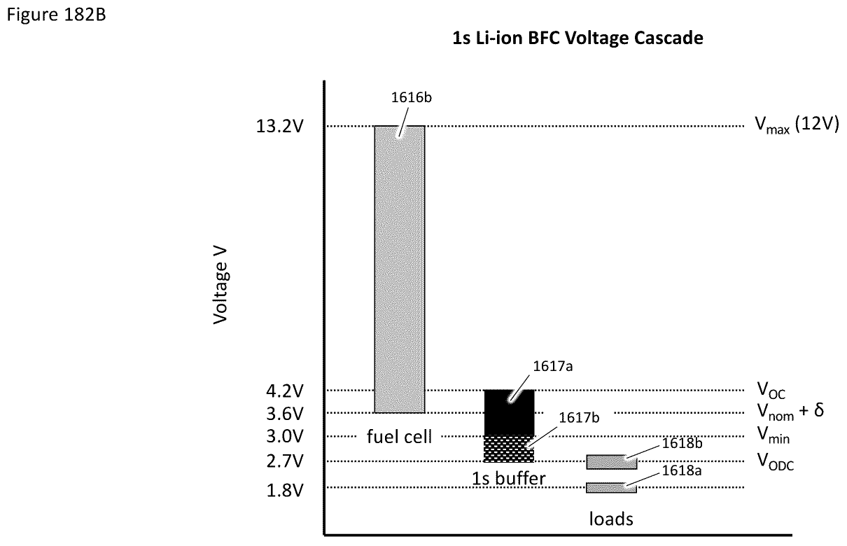

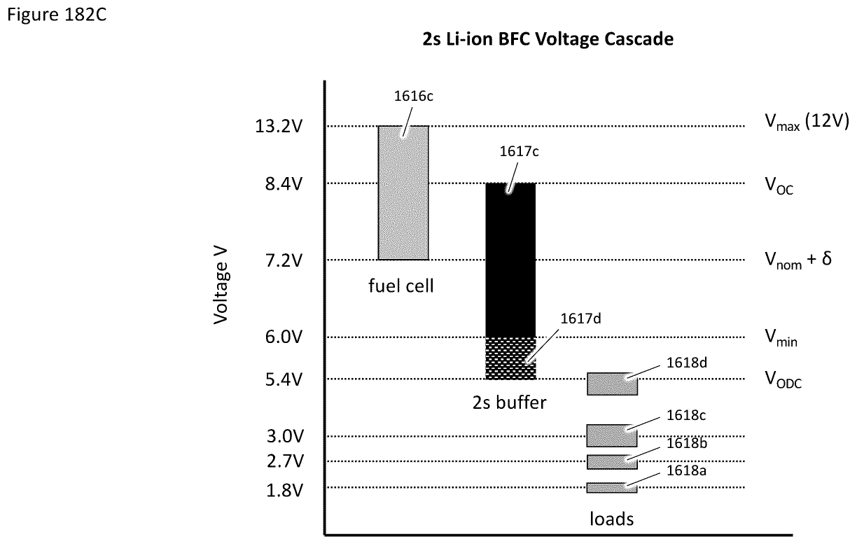

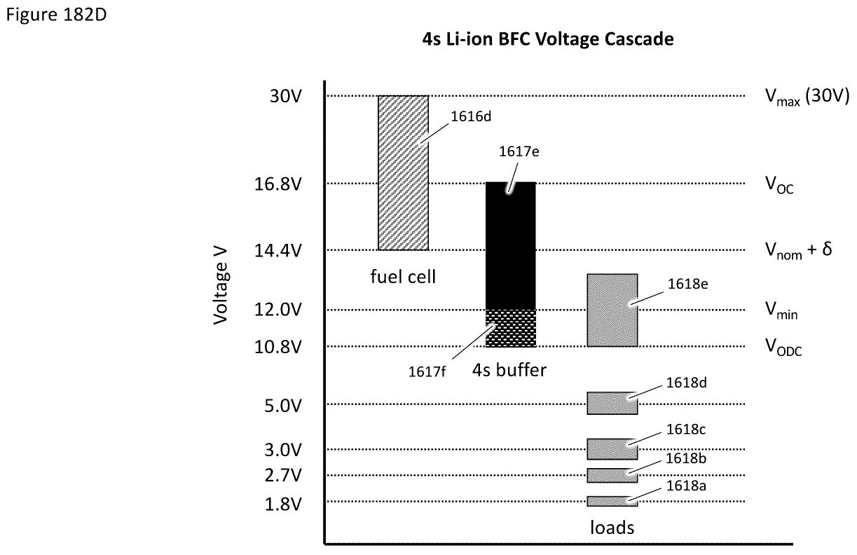

The function of the charge transfer regulator in buffered fuel cell operation is illustrated in by the BFC voltage cascade shown in FIG. 182A for a 1s Li-ion buffer. The voltage cascade illustrates the usable voltage range of the fuel cell, the buffer, and the electrical loads the buffer can drive. Using a 1s Li-ion cell as the BFC buffer, the buffer is limited in usable voltage range 1617a from Vₘᵢₙ to V_{OC} of 3.0V to 4.2V. Although the buffer cell can discharge down to V_{ODC} of 2.7V, the energy contained in the buffer at voltages 1617b below Vₘᵢₙ means it is not useable to drive electrical loads until the buffer is replenished by the fuel cell generated power.

Provided the 1s buffer maintains a voltage in the range between Vₘᵢₙ and Vₙₒₘ, the BFC can deliver power to electrical loads at 1.8V±5% and 2.7V±5% shown by bands 1618a and 168b. The buffer voltage is marginally usable to power a 3.0V load. In order to charge the buffer in the voltage range 1617a, the fuel cell must output a voltage no lower than the nominal voltage Vₙₒₘ. The maximum voltage of the fuel cell Vₘₐₓ is determined by the semiconductor process technology used to fabricate the QXR charge transfer regulator. Using a 5V CMOS or a 5V BCD power IC process for wafer fabrication, the maximum operating voltage is 5.5V.

The actual distribution of fuel cell voltages within the usable range 1616a depend on environmental conditions of humidity and temperature. To fully charge the buffer to V_{OC} means the number of fuel cells must be sufficient to exceed 4.2V in low humidity conditions but not to exceed 5.5V under high humidity thereby avoiding damage to semiconductor devices used to fabricate the QXR. For example, if a fuel cell technology exhibits 0.85V at relative humidity levels of RH=100% then at Vₘₐₓ≤5.6 the number of series fuel cells is limited to n≤6. For a minimum voltage of 3.6V, the fuel cell can only operate under low humidity down to 0.6V/cell thereby limiting the humidity range of the BFC.

To remedy this limitation a 12V BCD process can be used expanding the maximum voltage to 13.2V as shown in FIG. 182B so that a fuel cell stack up to n≤15 is possible. For example, for n=10, the minimum fuel cell voltage at low humidity is improved to 0.36V greatly expanding the usable humidity range.

The usable range of load voltages can be expanded by employing a 2s Li-ion buffer as shown in the voltage cascade FIG. 182C where the Vₘₐₓ for the 2-cell buffer is 8.4V and ranges 1617c down to a Vₘₐₓ of 6.0V. In deep discharge 1317d the buffer can work down to a V_{ODC} of 5.4V. As such the 2s Li-ion BFC is able to drive loads at 1.8V, 2.7V, 3.0V, and 5V corresponding to ranges 1618a, 1618b 1618c, and 1618d respectively. To charge the 2s buffer above Vₙₒₘ≥7.2V fuel cell range 1616c can be supported by a 12V BCD process where n≤15. Assuming the maximum number of cells, the minimum fuel voltage is 0.48V/cell. If the process is extended to 15V BCD technology with a 18V abs max, the number of cells can be extended to 21 lowering the minimum cell voltage under low humidity to 0.34V/cell.

A 4s Li-ion BFC voltage cascade is shown in FIG. 182D where range 1617e spans voltages Vₘᵢₙ=12V to V_{OC}=16.8V with deep discharge 1617f down to V_{ODC}=10.8V able to easily drive loads 5V and lower but limited in its ability to drive loads 12V±10% shown by band 1618e but improved by limiting the 12V tolerance to 5%. Charging a 4s Li-ion buffer from a fuel cell stack spanning voltages 1615d from Vₙₒₘ=14.4V to Vₘₐₓ=30V can include cell counts up to n≤35 and down to Vₘᵢₙ/n=12V/35=0.34V at low humidity levels.

The role of the DC summing node is discussed in greater detail regarding external electrical charging and energy recovery in text accompanying FIG. 161 through FIG. 164 and for protecting the buffer from electrical loads in sections discussing FIG. 165 through FIG. 168.

Basic QXR Embodiments. In one embodiment of this invention, a QXR charge transfer regulator comprises a multi-function current-limited voltage-clamp controlling the current flow between input in output whereby (i) input current is limited to a specific current, (ii) or output current is limited to a specific current, or (iii) a voltage clamped output set not to exceed a specific output voltage, whereby QXR current is dominated by the most limiting of the three criteria. If none of the three limits are reached the QXR functions like a resistor. In another embodiment the QXR input comprises an energy source such as a fuel cell which may include a hydrogen PEM fuel cell. In yet another embodiment and output is connected to an electrical buffer able to store electric charge which may comprise a capacitor, a battery, or other charge storage element.

In various embodiments the charge storage buffer may comprise a single-cell lithium ion battery limited to under 4.2V, two lithium-ion cells connected in series limited to a maximum voltage of 8.4V, or four lithium-ion cells connected in series limited to a maximum voltage of 16.8V. In another set of embodiments the input is connected to a stack of fuel cells where the input current is limited to pre-defined current density ranging from 100 mA/cm² to 1000 mA/cm². In another set of embodiments the output is limited by the maximum charging current of a lithium ion cell such as 2C for a 1s1p buffer array, 4C for a 1s2p array, or multiples thereof.

In another set of embodiments the range in fuel cell output voltages exceeds, at least in part, the voltage range of the buffer cell and where the voltage of the buffer cell exceeds the required voltage of the load the buffer powers. In another set of embodiments the voltage rating of the process used to manufacture the QXR exceeds the maximum voltage of the fuel cell including a 5V process rated at 5.5V for a QXR charging a 1s Li-ion cell, a 12V process rated at 13.2V for a QXR charging a 1s or 2s Li-ion cell array, a 15V process rated at 18V for a QXR charging a 2s Li-ion cell array, or a 30V process used to facilitate QXR charging of a 4s Li-ion cell array. In another set of embodiments, the BFC buffer may be charged by either the fuel cell, an external electrical power source, or concurrently by both without exceeding the maximum safe buffer voltage.

In another set of embodiments an electrical load draws most of its power from the BFC buffer without substantially increasing the current demand on the fuel cell stack. In a related embodiment, fuel cell generated power recharges the charge depleted in the buffer whenever the load demand is low. In yet another embodiment, the QXR can disconnect the fuel cell stack from the buffer to disable buffer recharging during a fault condition, sleep mode, or while executing measurements.

Note that at any one instant only one of the three QXR functional criteria namely, a current limited input, a current limited output, and a voltage clamped output can determine the conduction. In some circumstances, none of these functions determine the QXR current. In general, however for any given fuel cell and buffer design at least two of the criteria are required over the BFC's spectrum of operating conditions—either output voltage clamping following input current limiting, output current limiting following output current limiting, or some scenario in which all three participate.

QXR Managed Buffer Charging. Although basic QXR functionality provides the three limiting functions as described, in another embodiment the QXR should control current flow into the buffer for optimum charging of the buffer cells in accordance with its specific electrochemistry. Given the tremendous variability of fuel cell characteristics not only by their design and construction but in response to varying atmospheric conditions of temperature, pressure, and relative humidity, the best charging conditions for the buffer cell are quite complex. These charging conditions are best managed by the QXR charge transfer regulator since it is controlling the buffer currents anyway.

In general buffer charging executed by the QXR comprises at least two and possibly three operating stages as identified in FIG. 182A. In a deeply discharged cell, very low charging current called trickle charging 2240 is employed to bring the cell within its normal operating range, i.e., to charge to a voltage above Vₘᵢₙ. Above Vₘᵢₙ buffer charging commences constant current charging 2241 at currents roughly 10× that of trickle charging. Because constant current CI mode charging risks overcharging a cell beyond V_{OC}, before the cell reaches its fully charged state the QXR transitions to constant voltage or CV charging 2242. In any event the maximum charging rate of the buffer is limited to some maximum charge rate, e.g., I_{buf}=2C as shown by limit 2254.

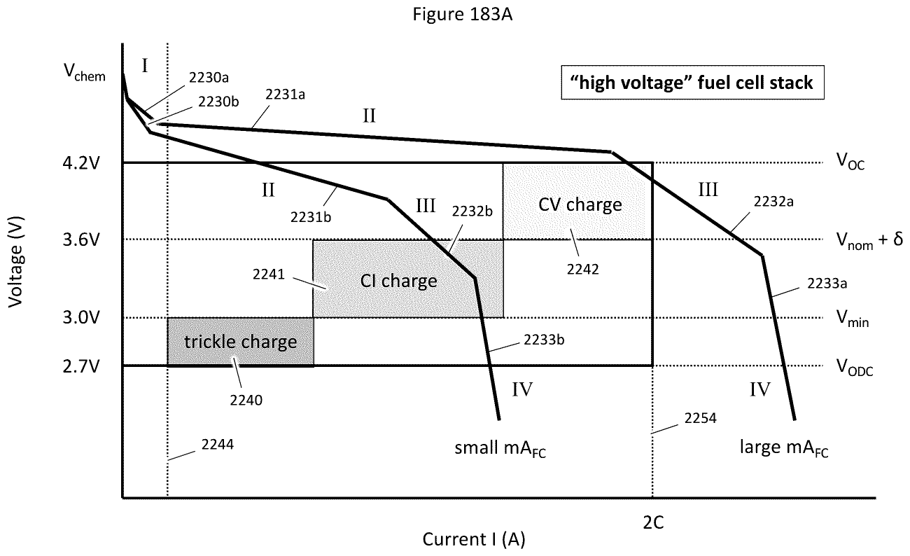

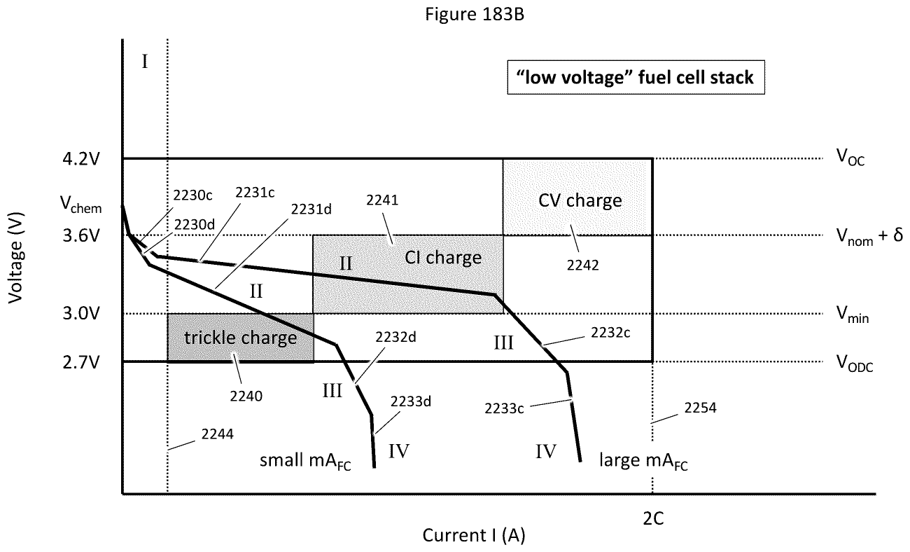

Aside from the staged charging, the other complexity in QXR operation is whether the fuel cell under a given set of environmental conditions such as temperature and humidity is capable of delivering the requisite currents and voltages for optimum charging. Since bother buffer charging and fuel cell voltage are a function of current, the only reasonable means to envision this complex relationship is to overlay the fuel cell characteristic atop the buffer charging profile. As such the previously mentioned FIG. 183A illustrates the V-I electrical characteristics of two different fuel cells overlayed atop the SOA safe operating area of a lithium ion buffer.

The voltage-current characteristics of a fuel cell involves four regions. As shown, region I comprising curves 230a and 2230b is characterized by a rapid drop in fuel cell stack voltage nV_{FC}of one-to-two hundred millivolts dropping below the unloaded electrochemical potential V_{chem}within the first 50 mA/cm² of current demand demarcated by line 2244. Because of its unstable voltage and low currents, region I is considered unusable as a viable fuel cell operating condition.

In region II, the plateau region of curves 2231a and 2231b the fuel cell maintains a relatively constant voltage over a wide range of currents at least until it reaches a high current density of over 0.4 A/cm². For this reason, region II is considered a prudent choice for reliable fuel cell operation. Above that, in region III the fuel cell voltage declines linearly as shown by curves 223a and 2232b until in region IV the voltage collapses as shown by curves 2233a and 2233b.

The two curves shown comprise a simplified piecewise linear representation of two different size fuel cells, a small area mA_{FC} fuel cell where the scaling factor m is small identified by line segments 2230b, 2231b, 2232b, and 2233b; and a large area mA_{FC} fuel cell shown by line segments 2230a, 2231a, 2232a, and 2233a where the scaling factor m is much greater than the former case. Note that the large area fuel cell exceed the charging current and voltage requirements of the buffer cell at all current densities. In contrast the small fuel cell is only able to charge the buffer at a very slow rate, roughly half that of the large cell. Both curves shown in this figure are considered high voltage meaning the fuel cell stack voltage at low currents nV_{FC}exceeds the maximum buffer voltage Vₘₐₓ. Such a condition is only possible if the number of series cells is sufficiently great to compensate for low cell voltages under dry ambient conditions.

By contrast FIG. 183B illustrates the same V−1 graph overlay for low-voltage fuel cells, i.e., where nV_{FC}<Vₙₒₘ meaning either the number of cells or the humidity or both are too low to produce a robust voltage for charging the buffer cells. In this case, the large-m cell curves represented by line segments 2230c, 2231c, 2232c, and 2233c never exceed Vₙₒₘ and barely exceed Vₘᵢₙ across the full range of currents. As such currents are limited to half the buffer's 2C limit. The small-m cell curves are even more limited relegated to CI charging below 0.5C.

In charging the buffer cell, QXR 1603 must be able to detect and adjust the charging algorithms accordingly. Fortunately, these charging algorithms can be selected by subdividing the operating voltage range of V_{ODC} to V_{OC} into three bands. In the case where V_{ODC} V_{buf} Vₘᵢₙ, the QXR is limited to only trickle charging. In the case where Vₘᵢₙ V_{buf} Vₙₒₘ, the QXR is switches to constant current CI charging mode. Only when Vₙₒₘ V_{buf} V_{OC} can the QXR transition into constant voltage CV charging mode.

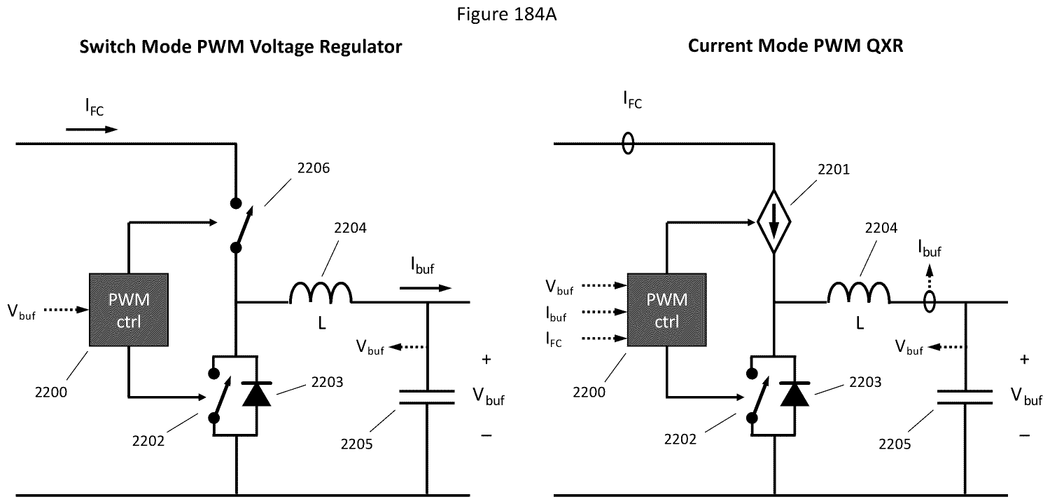

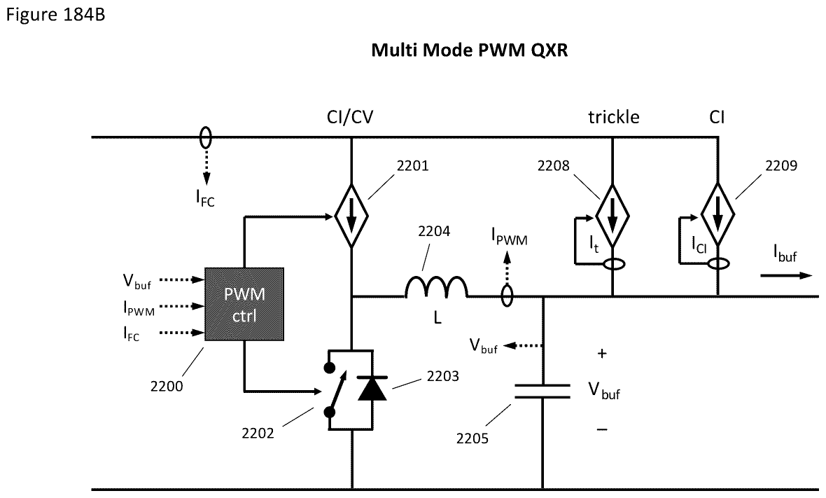

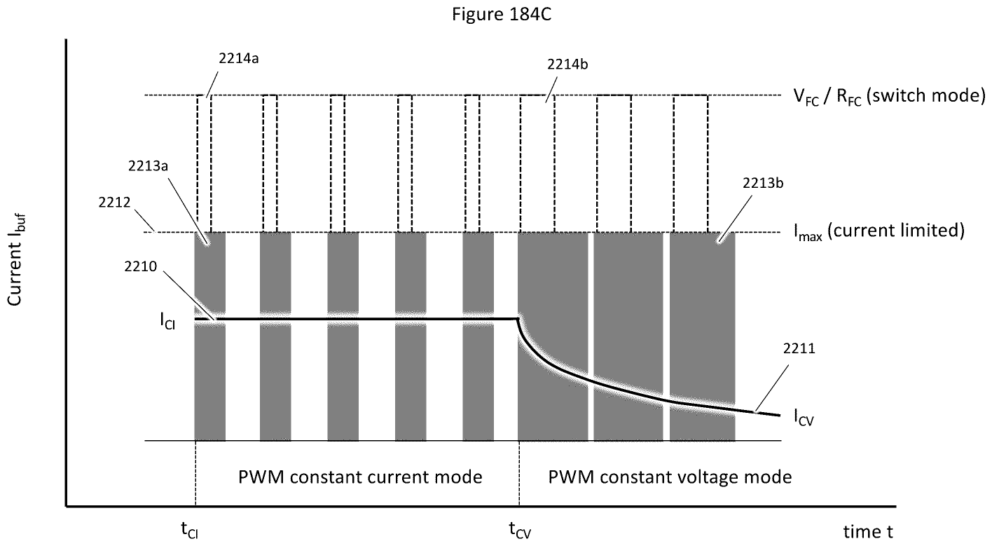

In their simplest form these charging modes may be implemented using linear circuits as described previously in FIG. 79A through FIG. 79C but may also be used in current-limited pulse mode charging, but not using switch mode operation. The distinction between switch mode charging and current limited pulse mode charging is exemplified in FIG. 184A. In switch mode PWM regulator shown on the left, PWM controller 2200 alternatively toggles switches 2206 and 2202 on and off to couple energy from the fuel cell input onto low pass filter comprising inductor 2204 and capacitor 2205 using only the output voltage V_{buf} as feedback to control the pulse width and energy transfer. Although low side switch 2202 acting as a synchronous rectifier to shunt recirculating diode 2203 doesn't impact the fuel cell current I_{FC} feeding the converter, high side switch 2206 does. The only mechanism limiting the converter's inrush current is inductor 2204. Eventually however the converter will invariably draw more current than the fuel cell can supply without voltage sag. By contrast the current limited PWM QXR circuit on the right acts as a current limited pulse width modulation converter comprising current limiter 2201 switched on and off, but not functioning as a switch. To ensure the current does not exceed the maximum specified input and output current as well as preventing an excessive output voltage V_{buf} across capacitor 2205 and any paralleled buffer cells, three forms of feedback are used by PWM modulator circuit 2201 namely I_{FC} as an input parameter, and V_{buf}and I_{buf}as output control parameters.

As shown, the PWM QXR charge transfer regulator can be merged with linear current limiters to implement a multimode QXR with advanced charging features shown in FIG. 184B. Specifically linear current source 2208 uses feedback of trickle current Iₜ to control charging deep discharge, linear current source 2209 uses feedback of constant current I_{CI} to control charging in linear mode constant current CI mode; and PWM pulsed current source 2201 controls PWM current limited pulses during constant voltage CV mode and optionally during pulse CI mode.

FIG. 184C illustrates exemplary waveforms of the disclosed current-limited PWM QXR during buffer charging. In operation, buffer current I_{buf} comprises a sequence of current limited pulses 2213a and 2213b of varying pulse width resulting in an average charging current curves 2210 and 2211. During charging, i.e., so long that V_{buf}≤V_{OC}, the PWM pulsed QXR currents 2213a and 2213b as shown are limited 2212 in magnitude to a current Iₘₐₓ in accordance with QXR operation. In accordance with the description of QXR current limiting, the maximum current Iₘₐₓ of the pulses is given by Iₘₐₓ≤mI_{FC}(max) whenever the fuel cell current limiting the maximum charge transfer rate, and to a current Iₘₐₓ≤I_{buf} (max) whenever the buffer cell maximum C-rate determines the peak charging currents.

Contrasting current limited pulse charging to switch-mode charging, the current-limited pulses 2213a and 2213b of magnitude Iₘₐₓ are lower in current and longer in duration than the PWM charging waveforms 2214a and 2214b limited in magnitude only by the fuel cell voltage V_{FC} and internal fuel cell resistance R_{FC}. Switching mode currents are however subject to voltage sag and dropout (not shown) while current limited PWM charging of the disclosed pulsed QXR method is not. Note that current limited PWM charging may by used for both CI-mode constant current and CV-mode constant voltage pulsed charging. As illustrated, during the interval between t_{CI} and t_{CV}, pulsed QXR charging of the buffer operates in constant current or CV mode where the duty factor D given by D=(tₒₙ/(tₒₙ+t_{off})) is adjusted in accordance with buffer current sensing and feedback to produce a constant average buffer current I_{CI} given by I_{CI}=D (Iₘₐₓ). After time t_{CV}, feedback control is changed to sense and feedback buffer voltage to the PWM controller where D=V_{buf}/V_{OC} and I_{CV} is given by I_{CV}=DIₘₐₓ. In both CI-mode- and CV-mode pulsed charging, the charging times using the current limited QXR are slower than conventional switch-mode charging, but do not suffer fuel cell voltage sag, dropout, and collapse.

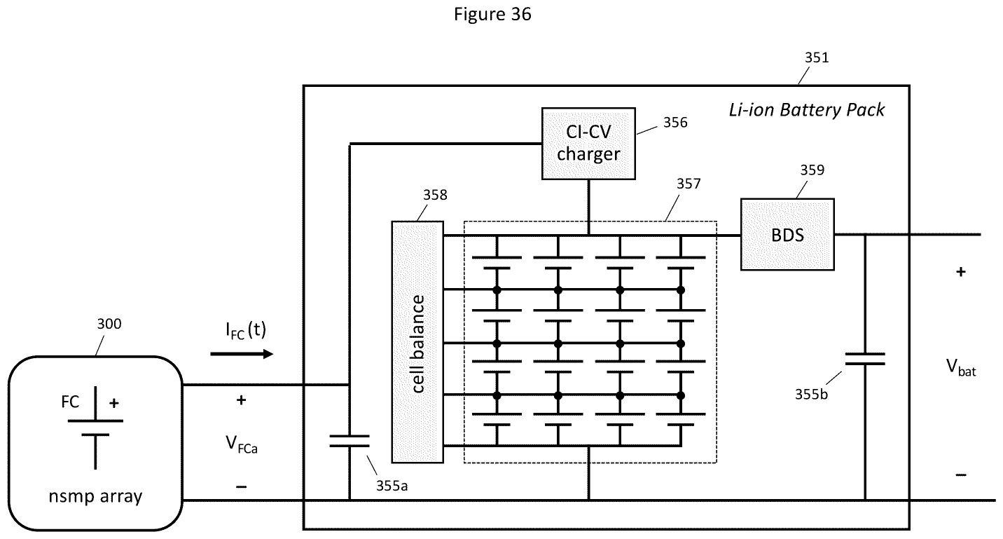

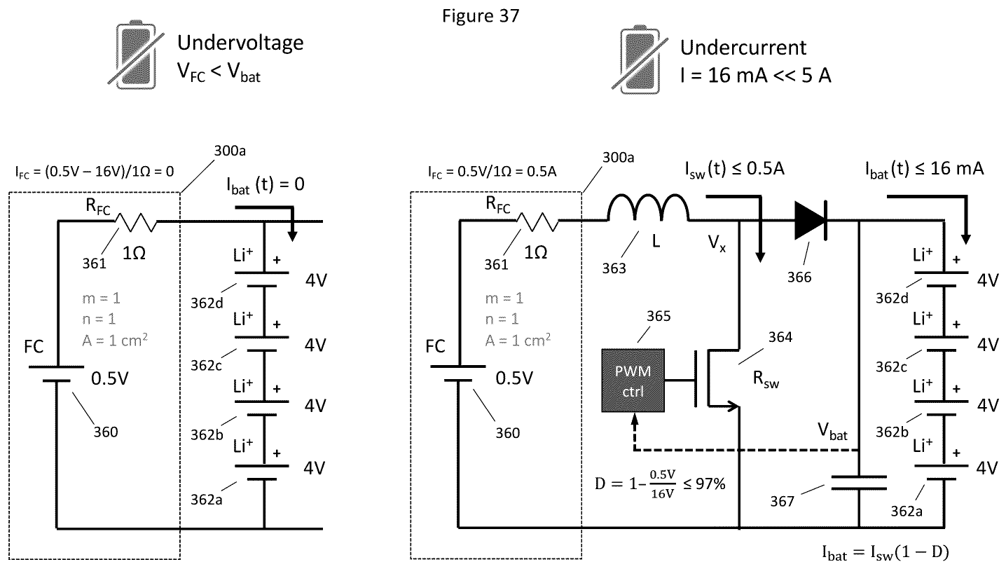

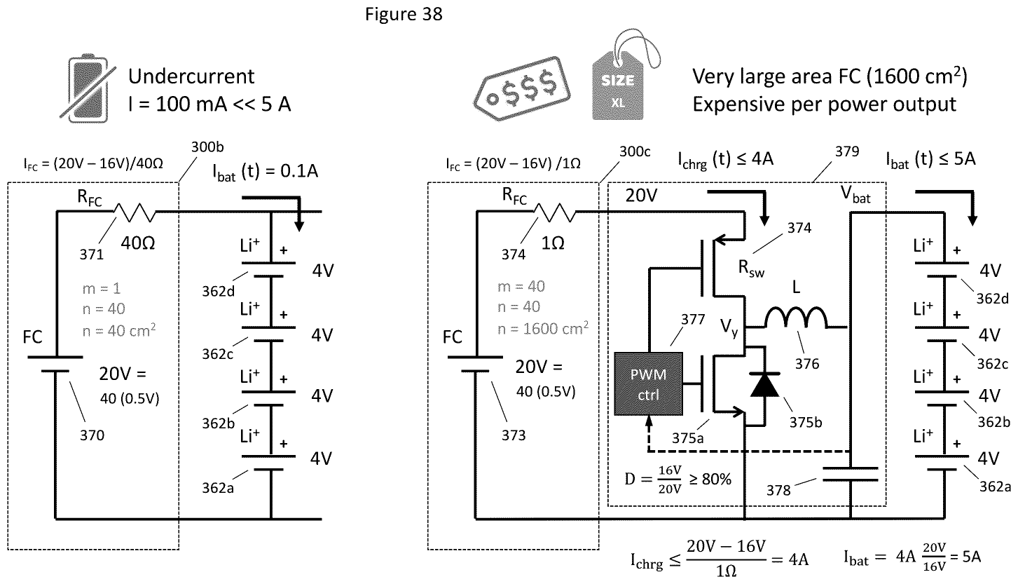

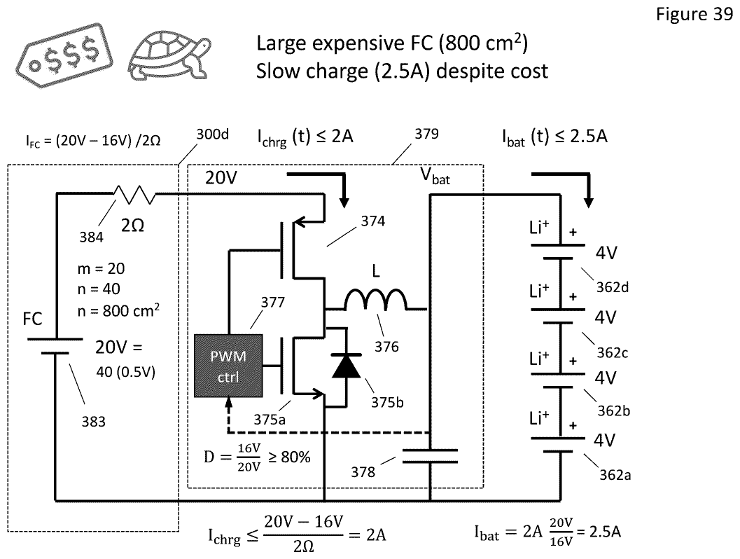

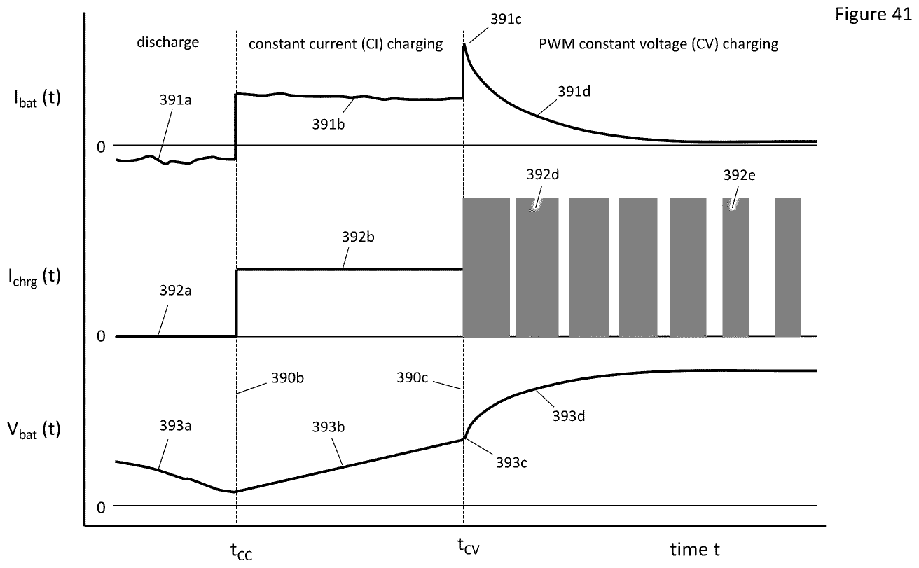

Additional details regarding the role of the QXR in charging the buffer using multimode methods are discussed throughout the specification but especially in text related to FIG. 71 through FIG. 86, FIG. 138A through FIG. 146, and in text for FIG. 161 through FIG. 164. The topic of buffer cell balancing is considered in text related to FIG. 155 to FIG. 160. and in FIG. 170 through FIG. 174. Using the iBFC to power an external battery pack during charging is considered separately in a section discussing FIG. 36 through FIG. 43.

QXR Buffer Charging Embodiments. In one embodiment of this invention, the QXR charge transfer regulator controls the charging of the electrical buffer using multi-mode charging comprising a sequence of trickle charging, constant current CI-mode charging, and constant voltage CV-mode charging depending in the state-of-charge of the buffer. For deeply-discharged buffer cells where V_{buf}≤Vₘᵢₙ for example below 3V, trickle charging is performed at 10% of the current of the value of constant current charging. For buffer voltages greater than Vₘᵢₙ but below (Vₙₒₘ+δ) constant charging current is employed comprising either a linear regulated current of Iₘₐₓ or PWM pulses each current limited to a magnitude Iₘₐₓ. For buffer voltages in the range from (Vₙₒₘ+δ) to V_{OC} constant voltage charging either using a linear voltage-mode charger or a current-limited PWM charger where the current is limited to Iₘₐₓ. The value of voltage δ is a design parameter used to adjust the transition from CI mode to CV mode which may not be precisely the same voltage as Vₙₒₘ.

Irrespective of performing charging in trickle, CI, or CV charging modes or whether using linear or PWM charging control, the maximum current conducted by the QXR is limited to a buffer charging current Iₘₐₓ where Iₘₐₓ is determined by either the maximum allowable current of the fuel cell I_{FC}(max) or the maximum allowable buffer charge rate I_{buf}(max), whichever is lower. This limitation distinguishes QXR charging over conventional battery charging which assumes a stiff voltage source as the charger input.

In one embodiment, the magnitude of the maximum charging current is limited by the fuel cell to a value Iₘₐₓ≤mA_{FC}[I_{FC}/A] where [I_{FC}/A] is a fuel cell specific design parameter ranging from 100 mA/cm² to 1000 mA/cm². In another embodiment magnitude of the maximum charging current is limited by the buffer to a charge rate of 2C which may by example comprise 6 A to 8 A for various 1s1p Li-ion buffers and 12 A to 16 A for various 1s2p Li-ion buffers.

Intelligent Charging QXR Features. Aside from realizing fixed charging methods implemented using analog integrated circuits, an intelligent upgrade to QXR charging can be implemented using programmable logic or microprocessors executing algorithms programmed as firmware or software. Algorithmic control of the dynamic fuel cell array is achieved by a fuel cell control module which may comprise dedicated charger-specific intelligence or be executed as a software module with a system microcontroller.

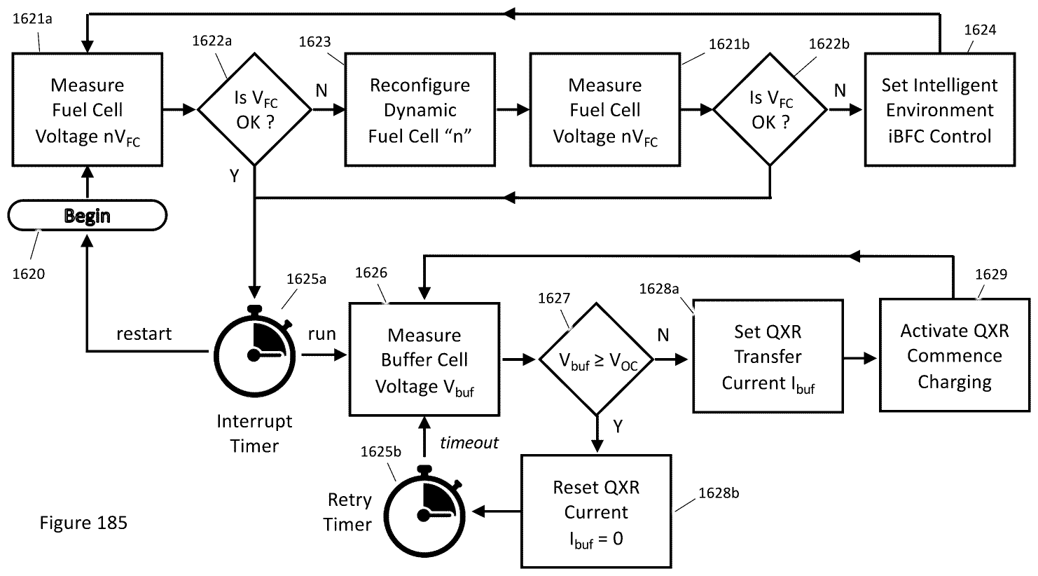

One charging algorithm for QXR buffer charging is illustrated in the flow chart of FIG. 185 commencing with step 1620 where the fuel cell voltage or fuel cell stack voltage nV_{FC} is first measured 1621a ideally while QXR is off. In step 1622a the voltage is compared against some target criteria to determine if the BFC can function properly as is or must it be adjusted. If the fuel cell is not ready for operation in step 1623 the number of series cells in the fuel cell can be adjusted higher or lower and in 1621b the stack voltage nV_{FC} remeasured. In step 1622b the BFC is again examined for readiness. If the fuel cell voltage is still not acceptable in step 1624 intelligent environmental iBFC control is activated to control the temperature, humidity, and/or gas pressure and flow rate. The fuel cell is then remeasured 1621a and the cycle repeated until the fuel cell is operating within its nominal parameters.

Once activated a non-maskable interrupt timer 1625a is set. Thereafter the fuel cell goes into its run mode starting by measuring 1626 the buffer cell voltage V_{buf} and confirming it is not fully charged. If it is full charged the QXR is turned off 1628b so that I_{buf}=0 and a retry timer 1625b is set. When the retry time reaches its timeout, the process is repeated starting with measuring 1626 the buffer voltage then again checking 1627 if the buffer is fully charged. If it is no longer full charged then in step 1628a the QXR charging current is set in accordance with the current limited multimode charging method described previously and charging commences 1629. During charging the QXR constantly monitors the buffer cell voltage and current to ensure safe charging. Eventually interrupt timer 1625a times out and the entire sequence is restarted 1620.

One key feature of intelligent buffer charging is the ability for the smart fuel cell controller to dynamically adapt the charging process in accordance with voltages and currents of the iBFC before enabling charge transfer and commencing charging. In one embodiment, the smart charging process starts by disabling QXR current conduction to allow a sequence of independent measurements and evaluations of the fuel cell and the buffer to be performed without interference of inter-buffer currents affecting the accuracy of the measurement process. The measurements are performed and the charging method selected before the QXR is activated and charging commences.

The cutoff capability of the QXR clearly distinguishes iBFC charging over any prior-art battery chargers as it facilitates precise measurements of both the input and output of the QXR regulator not possible in a conventional fuel cell. In conventional fuel cell applications, the fuel cell directly powers its load whereby any attempt to cutoff the fuel cell from the electrical load will interfere with the load's operation. In iBFC operation however, the buffer is able to continuing powering the load even when the QXR is opened and the fuel cell stack is isolated. Since the buffer is generally a low impedance high charge capacity storage, i.e., high Q, device such as a lithium ion battery the load is unable to significantly change the buffer voltage during the short time required to perform electrical measurements.

Once the measurements are completed the algorithm can be selected. iBFC charging algorithm may include various corrective actions to reconfigure the fuel cell array, activate or disable environmental controls, confirm the buffer is not fully charged, and determine which charging mode is to be applied based on its voltage. Another feature of an intelligent charging is algorithm including safety timers to ensure the software doesn't get stuck in a loop or malfunction resulting incomplete charging or an overvoltage condition. Microcontroller hosted intelligent control of QXR charging algorithms also enable the charger to store adjustable voltage and currents selected by the iBFC user or system designer.

In one embodiment, the programmable charging algorithms are performed on fixed topology fuel cell arrays, e.g., 10s50p. The problem with a prefixed fuel cell arrays however is the total voltage is limited to be nV_{FC} n is an unchangeable number. Unfortunately, the intrinsic fuel cell voltage V_{FC} unavoidably varies with environmental conditions such as humidity, temperature, and atmospheric pressure. Unless energy consuming environmental regulation features like forced cooling and humidification are invoked, there is no way to match the voltage of the fuel cell stack to the buffer for all operating conditions. This design deficiency can be overcome using a dynamically reconfigurable fuel cell array, one where the topology of the fuel cell can be changed during operation to adjust the voltage range of the fuel cell stack to compensate for environmentally induced changes in V_{FC} cell voltages.

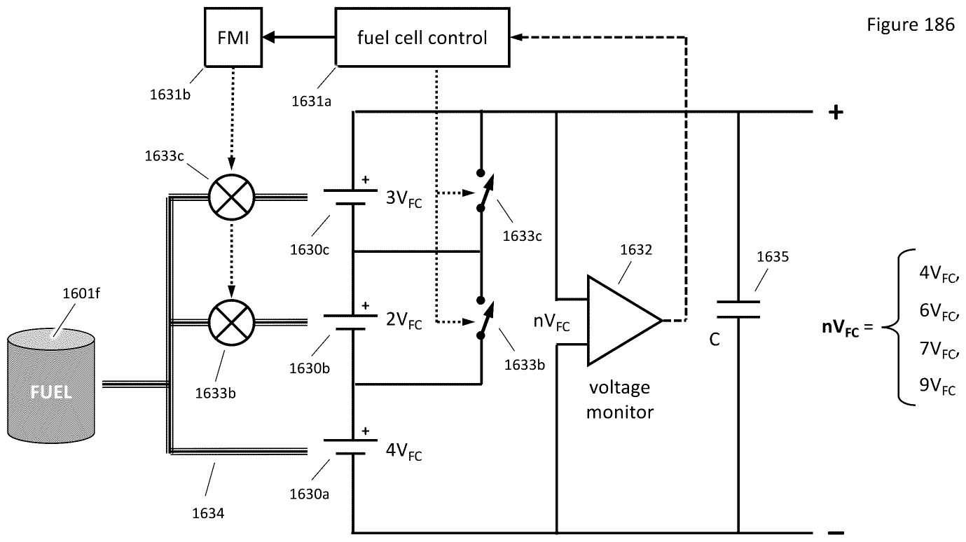

Dynamic Fuel Cell Features. The dynamic fuel cell shown in FIG. 186 comprises a stack of fuel cells 1630a, 1630b and 1630c connected in series to produce a programmable output voltage nV_{FC} across filter capacitor 1635 where the value of n can be adjusted digitally to various values, for example in the combinations ⁴V_{FC}, 6V_{FC}, 7V_{FC}, and ⁹V_{FC}. Selection of the best voltage is performed by voltage monitor 1632 and fuel cell control 1631a. Voltage monitor 1631 can be a single comparator used to determine if the fuel cell stack voltage is in a certain range or not, or may comprise an A/D converter able to report the cell voltage in digital format to logic in fuel cell control module 1631a which in turn controls the switches 1633b and 1633c used to shunt fuel cells 1630b and 1630c respectively as needed. Note that the number of fuel cells in each sub-stack differ. For example, fuel cell 1630a comprises four cells and has a corresponding voltage ⁴V_{FC}, fuel cell 1630b comprises two fuel cells and has a voltage ²V_{FC} while fuel cell 1630c comprises 3 fuel cells and has a voltage 3VFC.

By turning on and off various combinations of the shunt switches 1633b and 1633c bypassing or including fuel cells into the circuit multiple programmable voltages can be achieved using one fuel cell array. For example, if both shunt switches are off the total array voltage is ⁹V_{FC}, if both switches are on shunting fuel cells 1630b and 1630c the fuel cell stack voltage drops to ⁴V_{FC}. If only shunt 1633b is activated then fuel cell 1630b is removed from the stack and the fuel cell voltage becomes nV_{FC}=⁴V_{FC}+³V_{FC}=7V_{FC}. As one embodiment of this invention this dynamic fuel cell array topology is able adjust the fuel cell voltage to best match the required buffer voltage charging requirements.

As another embodiment of the dynamic fuel cell array, fuel 1601f is supplied directly 1634 to fuel cell 1630a but through valves 1633b and 1633c to corresponding fuel cells 1630b and 1630c. Fuel management interface FMI 1631b under fuel cell control 1631a turns off the gas supply whenever a fuel cell is bypassed thereby eliminating current and wasteful power dissipation in the shunt transistor and preserving fuel. For example, when shunt transistor 1633b in on and conducting bypassing fuel cell 1630b, then gas valve 1631b is closed thereby cutting of the fuel supply to the shunted cell.

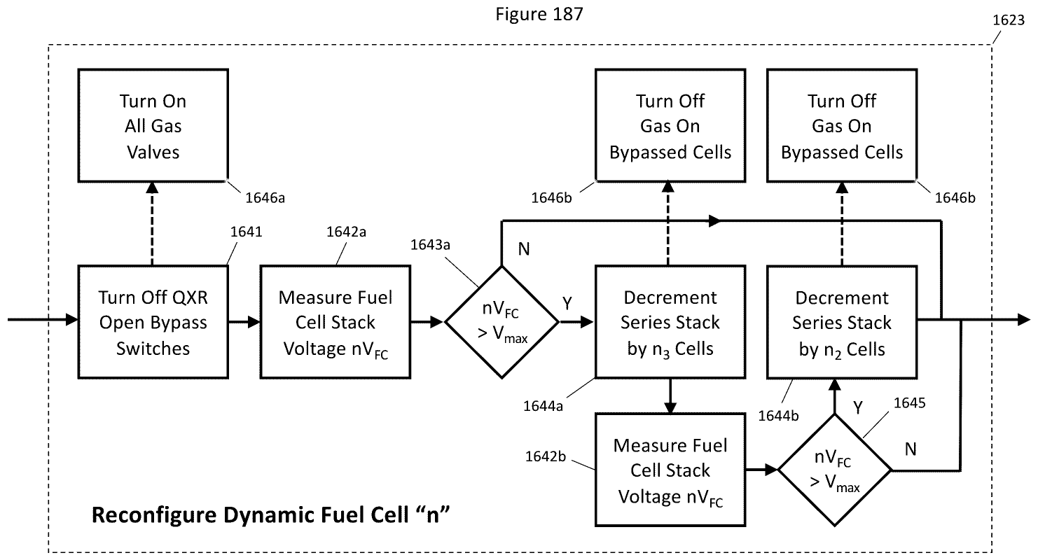

One exemplary algorithm for managing a dynamic fuel cell array is shown in FIG. 187 corresponding to the “Reconfigure Dynamic Fuel Cell Array” step 1623 described previously in the buffer charging flow chart. As shown the process by turning off the QXR regulator and opening all the bypass switches in step 1641 while turning all gas valves on in step 1646a. In step 1642a the fuel cell stack voltage nV_{FC}is measured and compared 1643a to a voltage Vₘₐₓ generally set by the fabrication process used to manufacture the QXR.

If nV_{FC} is not greater than Vₘₐₓ nothing can be done to further increase the voltage since the algorithm starts with the maximum number of active fuel cells. If the stack voltage is too high, i.e., if nV_{FC}>Vₘₐₓ, then in step 1644a the number of active cells is reduced and their associated gas supply turned off 1646b. In step 1642b the fuel cell stack voltage is remeasured and compared again in step 1645. If the stack voltage is no longer too high the dynamic array is properly configured. If not, additional cells are bypassed in 1644b and their gas supply also turned off 1646b. Since every cell that can be bypassed has been shunted the fuel cell array is at its minimum voltage and nothing more can be done to adjust the array topology. After reducing the dynamic fuel cell array to its lowest number of series connected cells, any voltage differential between the fuel cell stack and the buffer (nV_{FC}−V_{buf}) is supported by the QXR charge transfer regulator even after the buffer full charge and V_{buf}=V_{OC}.

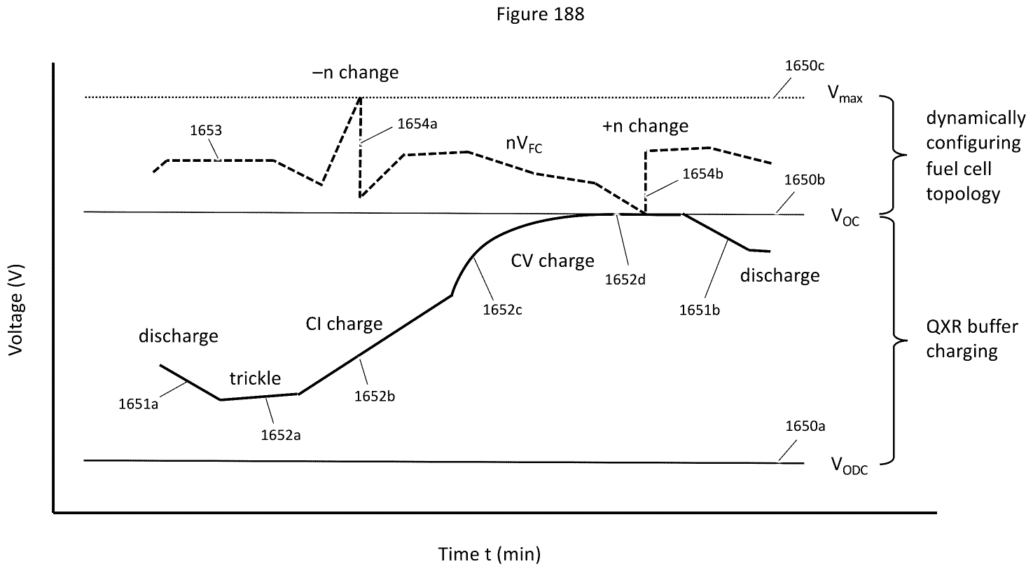

Combining the QXR regulatory function with the dynamic fuel cell array minimizes the mismatch between the fuel cell voltage and the buffer. As shown in FIG. 188, a cell discharging 1651a but remaining above the V_{ODC} limit 1650a automatically self-recharges in the iBFC. The QXR charging comprises a sequence of trickle charging 1652a, CI-mode charging 1652b, CV-mode charging 1552c. At the end of charging 1652d the buffer voltage asymptotically approaches 1650b its maximum safe voltage V_{OC} at which time charging is terminated until the buffer is again discharged 1651b.

Operating independently of QXR charging, the dynamically reconfigurable fuel cell array adjusts its series cell stack to operate within the boundaries between a lower limit, for example V_{OC} 1650b and Vₘₐₓ 1650c. In the hypothetical exemplary response curve, the fuel cell voltage is stable varying slightly until eventually rising with humidity or temperature where it ultimately hits its upper limit Vₘₐₓ 1650c. Immediately thereafter the dynamic array is autonomously reconfigured whereby the number of cells in the stack are decremented in turn lowering the stack voltage 1654a. The action occurs independently from the QXR's contemporaneous charging operations. In the example shown possibly due to lower humidity or a change temperature, the fuel cell stack voltage declines until it hits its lower threshold V_{OC} 1650b whereby the number of cells are immediately incremented increasing 1654b the stack voltage accordingly. Although the maximum voltage for buffer charging V_{OC} is depicted as the lower limit of the fuel cell stack voltage, the choice is arbitrary. The minimum fuel cell stack voltage threshold could for example be set to a voltage above the overcharge voltage, i.e., nV_{FC}>V_{OC} because the QXR supports the differential anyway protecting the buffer from overcharge damage.

Intelligent QXR Charging Embodiments. In one embodiment an intelligent QXR charger has the ability to disconnect the QXR input connected to a fuel cell stack from the QXR output connected to an electrical buffer in order to perform voltage measurements, then use the measured data to determine the best charging conditions and algorithms. In another embodiment, the algorithm determines the optimum number of fuel cells n in the series stack to produce a total voltage nV_{FC} falling within a targeted band of voltages. The stack voltage is thereby dynamically adjusted by reconfiguring the fuel cell's topology either increasing or decreasing the number of cells in the series circuit using semiconductor switches such as MOSFETs.

In one embodiment the number of series connected fuel cells in the stack is selected using a digitally controlled analog multiplexer to select which cells are included in the string. In yet another embodiment, disabled cell are shunted by paralleled switches such as MOSFETs to divert current around the cell and concurrently to disable gas flow to the cell.

In another embodiment operating band of voltages for the fuel cell stack should exceed the maximum buffer voltage V_{OC} so as to be capable of fully charge the buffer. In yet another embodiment, the stack voltage nV_{FC} shall remain below some maximum voltage Vₘₐₓ to prevent damage to the QXR transistors. Voltages of common integrated circuit processes used to fabricate the QXR and dynamic fuel cell switches include absolute maximum voltage values. of 5.5V, 13.2V, 18V and 30V. In another embodiment the fuel cell stack maintains the optimum voltage range for fully charging the buffer cell, the buffer cell is able to recharge itself, and the QXR supports the minimum voltage differential to maintain maximum operating efficiency.

iBFC Environmental Control Mechanisms. The electrical properties of a buffered fuel depend heavily on the environmental conditions of relative humidity RH and fuel cell temperatures T_{FC} and in maintaining minimal gas pressure P for steady gas flow rates FR whereby nV_{FC}=f(RH, T, P, FR). While high levels of relative humidity and elevated temperatures increase fuel cell voltages, dry cool conditions can cause a precipitous drop in fuel cell voltages especially for fuel cells operating at elevated current densities [I_{FC}/A]. Although active environmental controls can be used to minimize environmental effects, they consumer power and reduce efficiency and therefore should be used only in extreme cases.

The best means for extending the operating range of a fuel cell stack is to employ the previously disclosed dynamically reconfigurable fuel cell array. Made in accordance with this invention, any decrease in the fuel cell voltage V_{FC} is dynamically compensated by increasing the value of n, the number of series connected cells in the stack. Using voltage monitoring and a logic programmable switch array, the number of series connected cells n is adjusted to maintain the minimum criteria of nV_{FC}>V_{OC} thereby ensuring the fuel cell always generates sufficient voltage to fully charge a Li-ion buffer to its maximum potential V_{OC}. Given the monotonic relationship between RH and the cell voltage V_{FC}, the number of required fuel cells n needed to maintain nV_{FC}≥4.2V depends directly on RH and temperature.

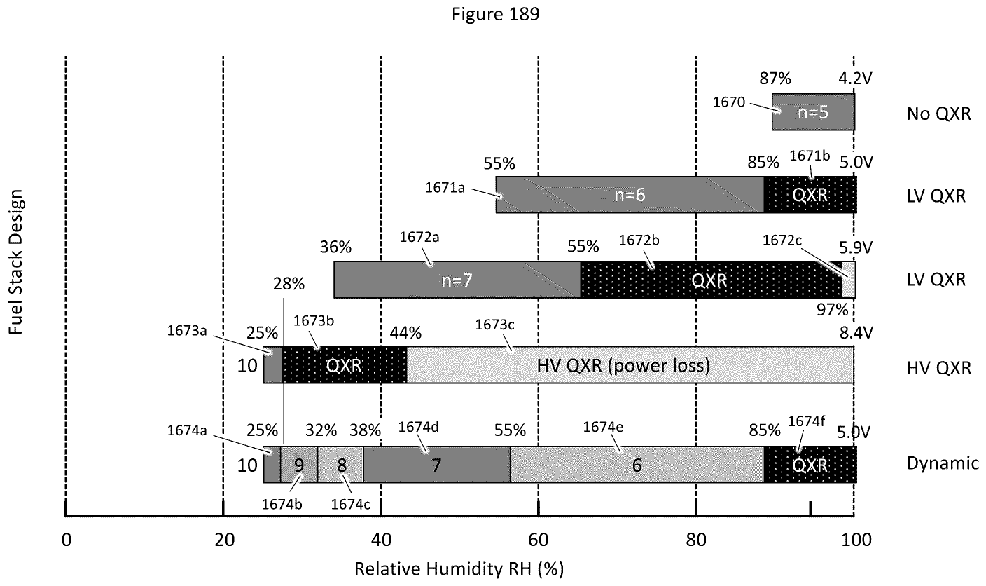

FIG. 189 illustrates a graph showing the usable range of relative humidity for various fuel cell designs operating at constant temperature. Maximum voltage calculations assume V_{FC}=0.84V at RH=100%. For the Li-ion electrochemistry, the minimal buffer voltage for charging referred to as Vₙₒₘ is assumed to be 3.6V, a voltage at which the cell retains a meaningful degree of stored energy.

Without the QXR to regulate the maximum charging voltage, an n=6 design exhibits a peak voltage nV_{FC}=6(0.84V)=5.0V>Voca value that exceeds the Li-ion overcharge voltage limit. Decreasing the number of cell to n=5 has two detrimental consequences. Firstly, the peak fuel cell stack voltage is limited to nV_{FC}=5(0.84V)=4.2V V_{OC}, meaning the usable buffer voltage range is limited to 3.6V≤V_{buf}≤4.2V and where the average voltage of 3.9V is too low to fully charge the buffer. Secondly at Vₙₒₘ=3.6V the fuel cell voltage V_{FC}=0.72 meaning the cell requires a minimum of RH>87%.

By increasing the number of cells to n=6 the usable range 1671a of the fuel cell stack expands, with a lower boundary of RH>55%. For this design, however the fuel cell voltage exceeds 4.2V at RH≥85%. In such cases, the voltage clamping function of QXR is necessary to operate up to 100% across the band 1671b. The maximum voltage at RH=100% as calculated previously is nV_{FC}≤5V.

Increasing the number of cell to n=7 further expands the usable range down to RH 36% where nV_{FC}≤4.2V from 36% to 55% in band 1672a without the need for QXR voltage clamping, and from 55% to 99% humidity in the band 1672b using a QXR regulator operating up to an abs max voltage of 5.5V. Unfortunately, in band 1672c operation at humidity levels from 97% to 100% results in a voltage up to 5.9V. This voltage is too high for standard 5V CMOS wafer processes.

Switching to a 12V process capable of a 13.2V abs max operation means that the number of cells can be further increased to n=10 leading to a maximum voltage at 100% humidity of 8.4V, well within 12V CMOS or BCD process limits. Importantly the usable humidity range expands to 25% to 100% comprising band 1673a needing no QXR clamping up to RH 28%, band 1673b requiring 5V QXR clamping up to RH≤44%, and band 1673c requiring 12V QXR clamping from 44% RH 100%. The problem in using a high voltage QXR is low efficiency, excess power dissipation, and wasted fuel. At RH=100% when nV_{FC}=8.4V using linear charging of buffers in the 3.6V-to-4.2V range means the QXR charger efficiency η_{FC} exhibits a worst case efficiency of η_{FC}=3.6V/8.4V=43% wasting 57% of the charging current. It is also expensive requiring larger more-resistive devices using a 12V CMOS process. Moreover, sustaining the voltage differential AV=(8.4V −3.6V)=4.8V while delivering I_{buf}=2C=8 A dissipates a power of 38 W, too high for most applications.

To overcome this problem the QXR charger can use the current limited charger disclosed previously to reduce the average current by D using pulse modulation. Because the pulsed charger is current limited, it does not exhibit the same efficiency improvement as a switching charger which as explained previously is incompatible with fuel cell power conversion. During conduction the instantaneous power dissipation is P_{PWM}(on)=I_{buf}ΔV and during the off interval the current is zero. The average power loss is then reduced by P_{QXR}(ave)=DI_{buf}ΔV. If the duty factor is reduced to 30%, the average power loss goes from 38 W to 11 W but the charging takes three times longer.

A more viable alternative and inventive embodiment of the iBFC is to employ dynamically reconfigurable fuel cell array where the number of cells integrated into the fuel cell stack varies from n=10 when the humidity is between 25% and 28% shown by band 1674a and the fuel cell voltage is under 0.42V whereby nV_{FC}≤4.2V. In band 1674b where humidity varies from 28% to 32% and V_{FC}≤0.5V, the dynamic array control reduces n=9 whereby the stack voltage is nV_{FC}=9(0.5V)≤4.5V. In band 1674c where humidity varies from 32% to 38% and V_{FC} ≤0.52V, the dynamic array control reduces n=8 whereby the stack voltage is nV_{FC}=8(0.52V) 4.2V. In band 1674d where humidity varies from 38% to 55% and V_{FC}≤0.6V, the dynamic array control reduces n=7 whereby the stack voltage is nV_{FC}=7(0.6V) 4.2V. In band 1674e where humidity varies from 55% to 85% and V_{FC}≤0.7V, the dynamic array control reduces n=6 whereby the stack voltage is nV_{FC}=7(0.7V) 4.2V. Finally in band 1674f with humidity ranging from 85% to 100%, the number of cells as shown is not reduced but remains at n=6 where for V_{FC}≤0.84V then nV_{FC}=6(0.84V) 5.0V and the QXR supports the voltage difference between 5V and 4.2V, with an efficiency of 84%. If the number of cell is further reduced to n=5 then the fuel cell stack voltage drops to nV_{FC}=5(0.84) 4.2V and the average efficiency improves to over 13 95%.

Benefits of the dynamic fuel cell design compared to a fixed design is it improves the usable humidity range by 5.8× from a 87%-to-100% without a QXR charger to 25%-to-100% with the dynamic fuel cell array, it significantly reduces power losses in the QXR, it eliminates the need for using a high voltage process to realize the QXR charge transfer regulator, and it preserves fuel. Although the graph depicts the effects of design on the use range of relative humidity at a constant temperature, the dynamic fuel cell array relies on voltage detection, not temperature of RH measurements. In other words, the circuit corrects for varying ambient conditions on the fuel cell voltage irrespective of what caused the variation.

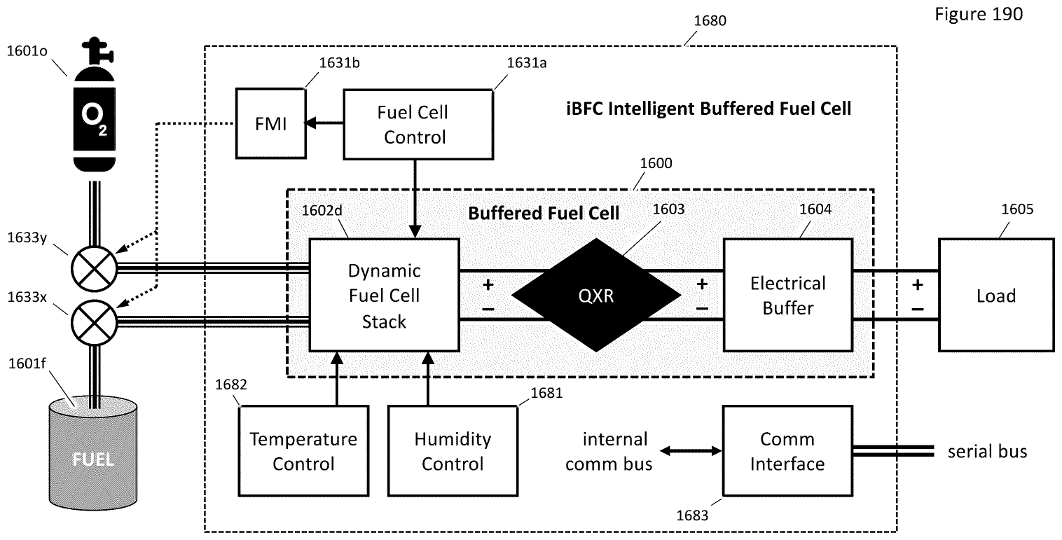

Expanding the use temperature and humidity range beyond the benefits offered by QXR voltage clamp and dynamic fuel cell embodiments involves intelligent active environmental controls. As depicted in FIG. 190 an intelligent buffered fuel cell 1680 comprises the previously described buffered fuel cell 1600 includes dynamic fuel cell stack 1602d, QXR charge transfer regulator 1603, electrical buffer 1604, along with fuel cell control 1631a and FMI fuel management interface 1631b controlling fuel supply 1601f via regulator-valve 1633x and controlling oxygen or reducing agent 1601o via regulator-valve 1633y. Environmental controls of iBFC 1680 include humidity control 1681 and temperature control 1682 along with communication interface 1683 managing internal and external communication busses.

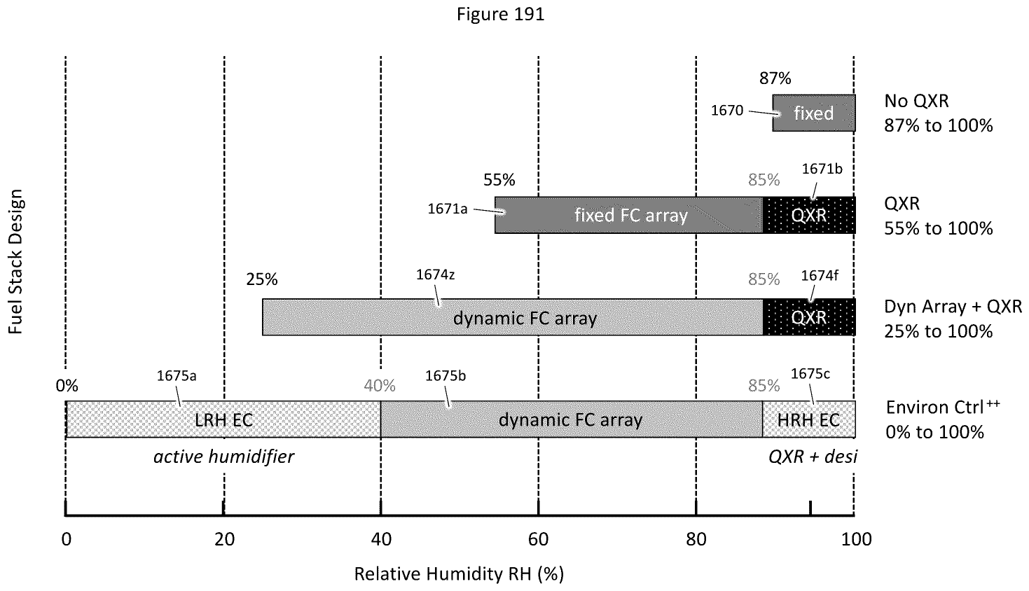

By adding active humidification in dry climates and active desiccation in humid climates the RH use range is further expanded. As shown in FIG. 191, contrasting several designs the use humidity range 1670 of a fixed fuel cell stack with no QXR is 87%-to-100%, the humidity range 1670 of a fixed fuel cell stack with a QXR including unclamped 1671a and clamped 1671b operation is 55%-to-100%. A dynamic fuel cell array with QXR extend the range from 25%-to-100% including unclamped operation 1674z and QXR clamped operation 1674f. Combining the dynamic fuel cell array with LRH EC low relative humidity environmental-control expends the range 1675a of relative humidity down to 0% but also reduces the reliance on dynamic fuel cell operating range 1675b for RH values below 40%. Above 85% humidity the HRH EC high relative humidity environmental control regime 1675c augments QXR clamping with desiccation reducing water logging and cell rusting. The net impact of the environmental control augmenting the disclosed dynamic fuel cell array and QXR charge transfer regulator is the iBFC is able to operate over the full all climate humidity range from 0% to 100%.

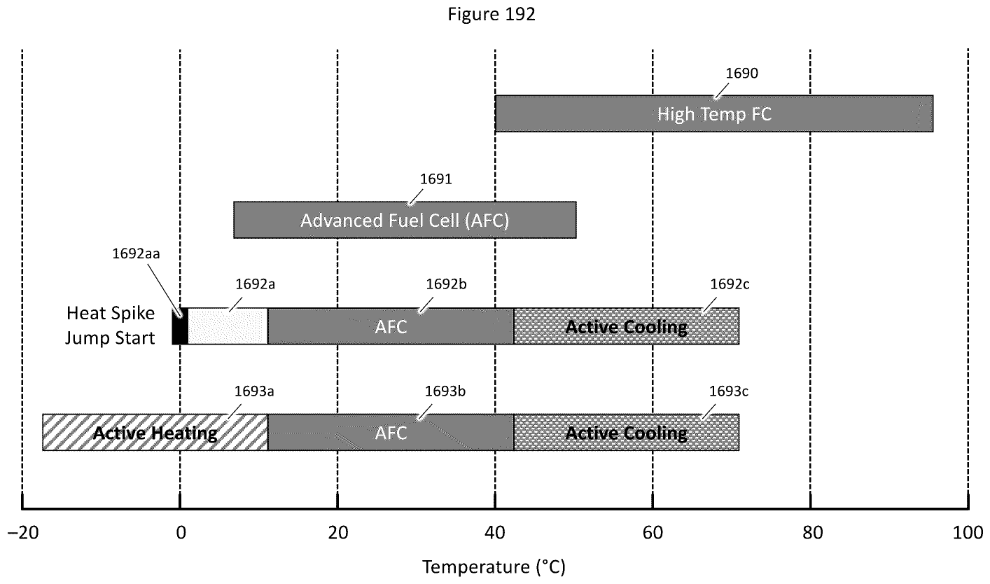

FIG. 192 illustrates the benefit of active temperature regulation on the operation of room temperature fuel cells. Although a high temperature fuel cell 1690 may operate up to 95° C. they don't function well below 40° C. Conversely a room temperature fuel cell such as an advanced PEM membrane hydrogen fuel cell 1691 works well in the zone from 8° C. to 45° C., they don't perform well at high temperatures and fail altogether under freezing conditions.

Active temperature control is shown in two versions advanced fuel cell 1692b and 1692c both benefit from active cooling 1692c and 1693c allowing them to work up to 70° C. and improving fuel cell performance down to 42° C. where uncooled room temp fuel cells struggle. For cold operation 1692a does not include regular heating once operation because the fuel cell reaction is exothermic. The real issue is to jump start the cell's operation by heat spike 1692aa to melt any frozen water blocking the PEM membrane pores. The pulse heat method while useful for starting a fuel cell at 0° C. doe not extend operation into subfreezing conditions. For that purpose a steady state heating 1693a can be performed extending fuel cell operation down to −18° C. and improving performance below 10° C. Bother heating an cooling can be achieved by forcing air or a liquid coolant like ammonium glycol through the heat tubes within the bipolar and tripolar plates.

The details of environmental control in an iBFC are considered in greater detail in sections relating to select illustrations including FIG. 44, and FIG. 151 through FIG. 154.

iBFC Environmental Control Embodiments. In one embodiment of this invention a dynamically reconfigurable fuel cell array comprises a varying number of series-connected fuel cells adjusted by increasing or decreasing the number of cells in order to maintain a fuel cell stack voltage in a defined band of voltages to offset variations in fuel cell voltage resulting from changes in temperature and/or humidity. In another embodiment the number of fuel cells in the stack vary from 4 to 10 in order to maintain a stack voltage over 4.2V despite changes in ambient conditions. In a third embodiment the voltage of the fuel cell stack never exceeds 5.5V to be compatible with commercially available 5V integrated circuit processes used to fabricate the QXR especially

In another embodiment the voltage of the fuel cell stack never exceeds 5.5V to be compatible with commercially available 5V integrated circuit processes used to fabricate the QXR charging 1s Li-ion buffers. In another embodiment the voltage of the fuel cell stack never exceeds 13.2V to be compatible with commercially available 12V integrated circuit processes used to fabricate the QXR charging 1s or 2s Li-ion buffers. In another embodiment the voltage of the fuel cell stack never exceeds 18V to be compatible with commercially available 15V integrated circuit processes used to fabricate the QXR charging 2s or 3s Li-ion buffers. In another embodiment the voltage of the fuel cell stack never exceeds 39V to be compatible with commercially available BCD power IC integrated circuit processes used to fabricate the QXR charging 4s Li-ion buffers.

In another embodiment the iBFC includes active humidification of the gas supply, oxygen supply or fuel cell chamber to extend the usable humidity range in dry ambient conditions. In another embodiment the iBFC includes active desiccation of the gas supply, oxygen supply or fuel cell chamber to prevent water logging of the cell in high humidity conditions. In another embodiment the iBFC includes active cooling to prevent excessive fuel cell temperature in hot climates. In another embodiment the iBFC includes active heating to increase fuel cell temperature in freezing conditions. In another embodiment the iBFC include pulsed heating to unfreeze water trapped in the PEM membrane pores at 0° C.

iBFC Energy Management Features. Aside from fuel cell and environmental controls, other intelligent features of the iBFC energy management. Energy management as defined herein is the control of electrical energy flowing in and out of the iBFC comprising features and functions not available in any conventional fuel cell or even applicable. For example, conventional fuel cells generate power but cannot absorb or store it, therefore managing energy flow into a ordinary fuel cell is non-sensical. In contrast, the heart of the iBFC is the buffered fuel cell which can absorb and store electrical power as well as generate its own. Its unique versatility means the buffered fuel cell has a far greater range of applications than a conventional fuel cell. Such flexibility also creates the opportunity for unexpected problems to emerge in managing power flow, preventing system level malfunctions, and surviving component faults.

To understand energy management, we must first consider the rules of control theory. Modern control theory is a field of applied mathematics used to model, predict, and control the behavior of dynamic systems involving the flow, storage, and use of energy. In the control theory of electrical power systems, components include power generation and electrical loads. Power generation comprise energy conversion devices such as generators which convert kinetic movement into electric current, fuel cells and batteries which convert chemical energy into electricity, and photovoltaic systems which convert the energy of electromagnetic energy in the visible spectrum directly into electricity using semiconductor devices. Conversely an electric load comprises an energy conversion device able to transform electricity into motion (motors), thermal energy (heat), light (optical emission), and electromagnetic radiation (radio and microwaves).

The three fundamental principles of control theory are observability, controllability, and stability. Lacking any one of these three features renders any power electronic system at risk for failure. Accordingly in reliable power systems, a power source is connected to its electrical load through intervening control circuitry to control power flow during normal operation and to interrupt current when a fault condition arises. The function of the power control circuitry facilities observability by detecting currents and voltage, controllability by determining current flow in the load using transistors such as power MOSFETs, and stability by preventing unwanted or uncontrolled oscillations, phase shifts, or noise.

As such direct load connections between a power source like a fuel cell are ill advised not only because of control and safety issues, but because an electrical load's operation can adversely impact the energy source powering it. The intelligent buffered fuel cell manages the unidirectional current flow of energy into an electrical load through inventive circuitry referred to herein as a buffer load access module or BLA module.

Another major consideration in power electronic control theory is the management of multiple power sources. Control of interacting power source is even more complex than load control because energy can flow bidirectionally, in some cases turning a generator into a motor or discharging a battery into a voltage source operating at a lower voltage. In a buffered fuel cell there are three sources of power, namely (i) the fuel cell generating electricity, (ii) the buffer storing and releasing electricity, and (iii) any external source of electrical power including a power supply, solar panel, wind turbine, or magnetic charger.

While energy flow between the fuel cell and the buffer is managed by the QXR charge transfer regulator, the intelligent buffered fuel cell controls unidirectional current flow of external power sources through inventive circuitry referred to herein as an energy recovery module or ER module. With separate inputs matched to each external power source, the function of the power control circuitry in the ER module facilities observability by detecting currents and voltage for each input; controllability by conditioning the incoming power including rectification, filtering, disconnection and failsafe protection; and stability by preventing oscillations, phase shifts, and noise.

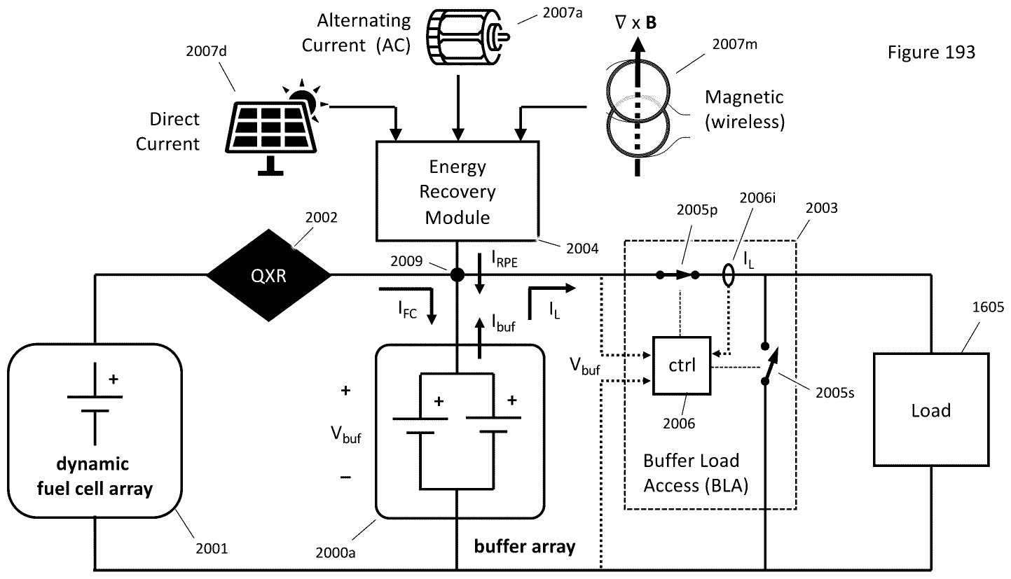

Together these two unique functions, ER energy recovery module 2004, and BLA buffer load access module 2003 are represented in the iBFC block diagram of FIG. 193 connecting the outside world to components within the iBFC. Because both the fuel cell and buffer comprise DC power sources, any power input to ER module 2004 is converted into DC and delivered as a DC current IRPE into DC summing node 2009.

As shown DC summing node 2009 describes the intersection of two conduits of electrical power sources, namely QXR 2002 and energy recovery module 2004, one conduit to an electrical load, namely buffer load access module BLA 2003 and the cathode of buffer array 2000a which may comprise any series-parallel combination of batteries or supercapacitors. Under KCL, the currents into and out of DC summing node 2009 add to zero, whereby

$${I}_{FC} + {I}_{RPE} + {I}_{buf} - {I}_{L} = 0$$

By using DC as the common power bus for the iBFC, problematic issues in power control such as stability, noise, oscillations, and phase effects are eliminated. All currents flowing into or out of DC summing node 2009 represent unipolar conduction except for I_{buf} which may positive during discharge or negative during charging. Providing a protective shell around the buffer none of the three power components QXR 2002, ER module 2004, or load 1605 connected to buffer array 2000a are actually the source or sink of iBFC power, but instead comprise a conduit between the buffer and its power sources and loads.

Only the buffer array 2002a is bipolar in operation, where current I_{buf} made be positive or negative. In this text I_{buf} >0 when the buffer acts as a power source and I_{buf}<0 when the buffer absorbs current during charging. All the other components are unidirectional in conduction but in their off state block current bidirectionally. The term BDB/UDC switch refers to a power MOSFET uniquely capable of both bidirectional blocking and unidirectional conduction. Standard power MOSFETs by comparison are only unidirectionally blocking and bidirectionally conducting.

In particular, QXR 2002 unidirectionally carries power from dynamic fuel cell 2001 but prevents reverse current back into the fuel cell meaning I_{FC}<0. Similarly, ER energy recover module 2004 unidirectionally carries power from various energy sources including DC power 2007d, AC power 2007a, and magnetically coupled power 2007m. For example, DC power sources 2007d include as solar panels and battery backup UPS; AC power sources 2007a include generators, alternators, wind turbines, and the AC mains; and magnetically-coupled power sources 2007m comprise magnetic or electromagnetic power transfer such as wireless chargers or RF power transmissions. In every case energy recover module 2004 prevents reverse energy flow from the buffer back into energy module 2004, meaning I_{RPE} >0.

Conversely BLA load access module 2003 allows current conduction in a unipolar direction outward from DC summing node 2009 to load 1605 but prevents back-streaming. In other words, reverse current flowing from load 1605 into the iBFC output is blocked by BLA 2003. In the event back-streaming power is detected by its I_{L} sensor 2006i, BLA controller 2006 opens pass transistor switch 2005p disconnecting load 1605 from the iBFC. Since only load 1605 is capable of discharging buffer array 2000a, BLA module 2003 performs a second extremely important task in preventing over-discharge of the buffer. To facilitate this task BLA controller 2006 monitors the voltage V_{buf} across buffer array 2002a. As long as V_{buf} >w V_{ODC} where w is the number of series connected buffers and V_{ODC} is the over-discharge lower voltage limit of a buffer cell, then pass transistor switch 2005p remains closed and the iBFC is able to power load 1605. If, however, the load discharges the battery and no electric charge or hydrogen fuel is available to replenish it, then when V_{buf}≤w V_{ODC} pass transistor load access switch 2000p is opened and the load is disconnected. In such cases shunt pass transistor 2005s may be activated to allow current to flow around the disabled cell, or remain open completely, cutting off the iBFC from a load circuitry and interrupting load current possibly as a part of a failsafe or sleep mode function.

Compared to any existing or even hypothesized fuel cell, the features of the disclosed iBFC are completely unique bidirectionally controlling energy flow in magnitude and direction among multiple components. By contrast a fuel cell is simplistic if not mundane exhibiting purely unipolar conduction from a single power source, the fuel cell, to a single electrical load. Mechanistically the intelligent buffered fuel cell also manifests various modes. The disclosed processes include various processes whereby (i) the dynamic fuel cell within the iBFC generates electrical power from fuel unidirectionally charging the iBFC's electrical buffer, and in so doing storing the generated energy as electrical charge, (ii) the iBFC agnostically accepts incoming electrical energy from multiple power sources including AC, DC, and magnetic power supplies, and after performing power conditioning on the external energy source, unidirectionally charging the iBFC's electrical buffer, storing the incoming energy as electrical charge, (iii) the iBFC delivers stored charge from its electrical buffer to an electrical load, or (iv) the iBFC is bypassed, allowing current to pass through its BLA module but disconnecting the entire module and its power sources from the load circuit. The fourth condition is particularly valuable when stacking iBFC fuel cells.

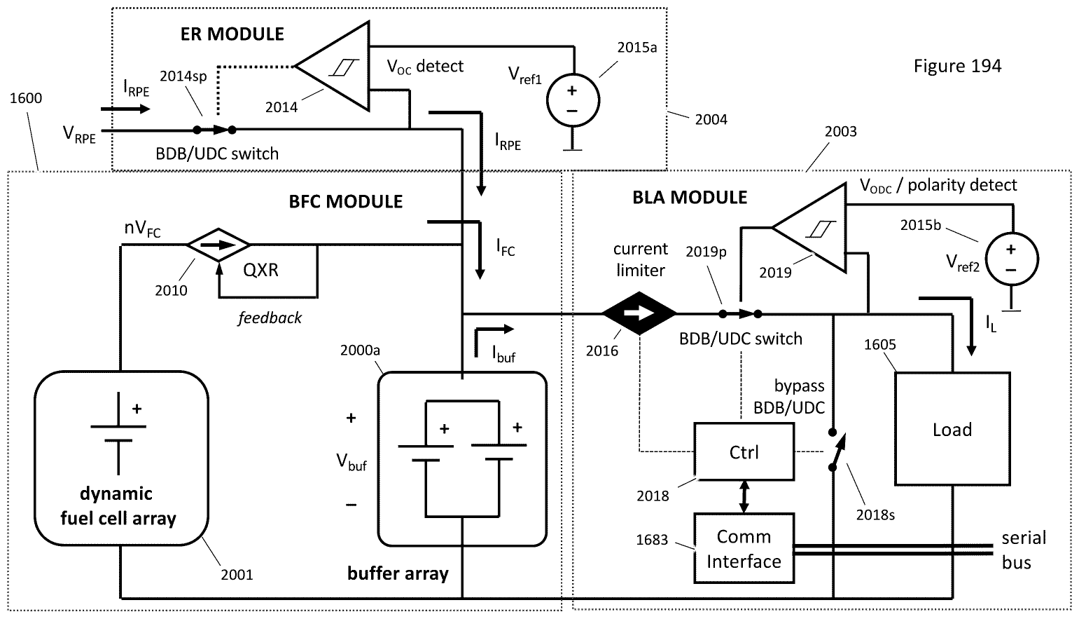

Greater detail into the operation of ER module 194 and BLA module 2003 are illustrated in FIG. 194 and their topological relationship to BFA buffered fuel cell 1600. As illustrated the core of the iBFC, BFC module 1600 comprises dynamic fuel cell 2001, QXR charge controlled regulator 2010 and buffer array 2000a.

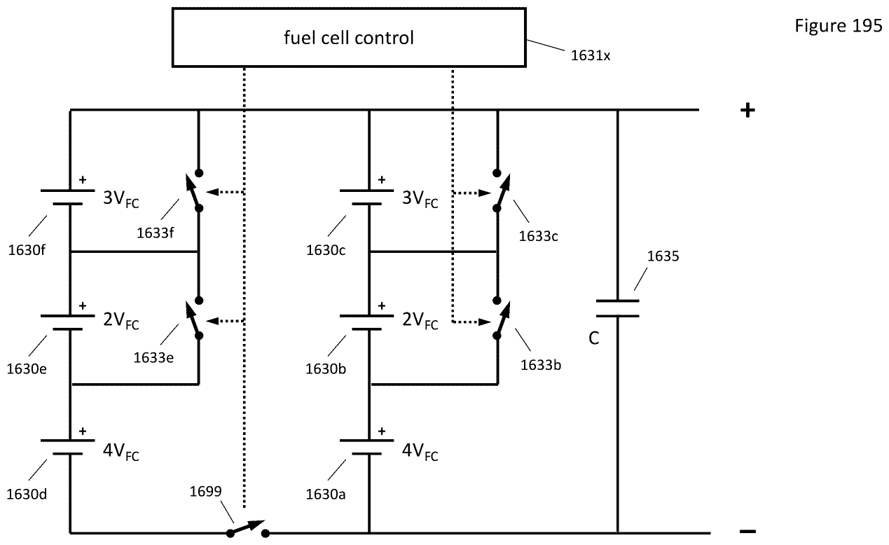

Dynamic fuel cell 2001 is further exemplified in the schematic of FIG. 195 where the series stack of fuel cells 1630a, 1630b, and 1630c is paralleled by a second string of fuel cells 1630d, 1630e, and 1630f as controlled by MOSFET switch 1699. When switch 1699 is on and conducting the two fuel cell strings are in parallel, increasing the current handling capability and reducing the net fuel cell resistance. The two fuel cell stacks must however have the same voltage. For example, if switch 1633b shunts fuel cell 1630b then concurrently 1633e shunts fuel cell 1630e to maintaining matching voltages on each string. In this manner the dynamic fuel cell feature embodied by this invention not only controls the fuel cell stack voltage but the fuel cell resistance and current capability, allowing fuel to be persevered when excess power is not required.

ER module 2004 comprises bidirectional-blocking unidirectional-conducting BDB/UDC conducting switch 2014p comprising a MOSFET pass transistor and controlled by overcharge detect comparator 2014 as referenced against precision voltage reference 2015a with trimmed voltage V_{ref1}. The purpose of ER module 2004 circuitry is to ensure that electrical energy imported into the iBFC does not overcharge the Li-ion buffer array 2000a.

BLA module 2003 comprises a bidirectional-blocking unidirectional-conducting BDB/UDC conducting switch 2019p comprising a MOSFET pass transistor and controlled by comparator 2019 referenced against precision voltage reference 2015b with trimmed voltage V_{ref2} and used to detect over-discharge conditions and reverse polarity loads, i.e., loads attempting to source power into the iBFC's output terminals. The BLA also includes controller 2018 able to current limit 2016 the load current I_{L} and in cooperation instructions received by communication interface 1683 over a serial bus to open switch 2019p and close switch 2018s thereby performing a bypass function to remove the iBFC from the load circuit.

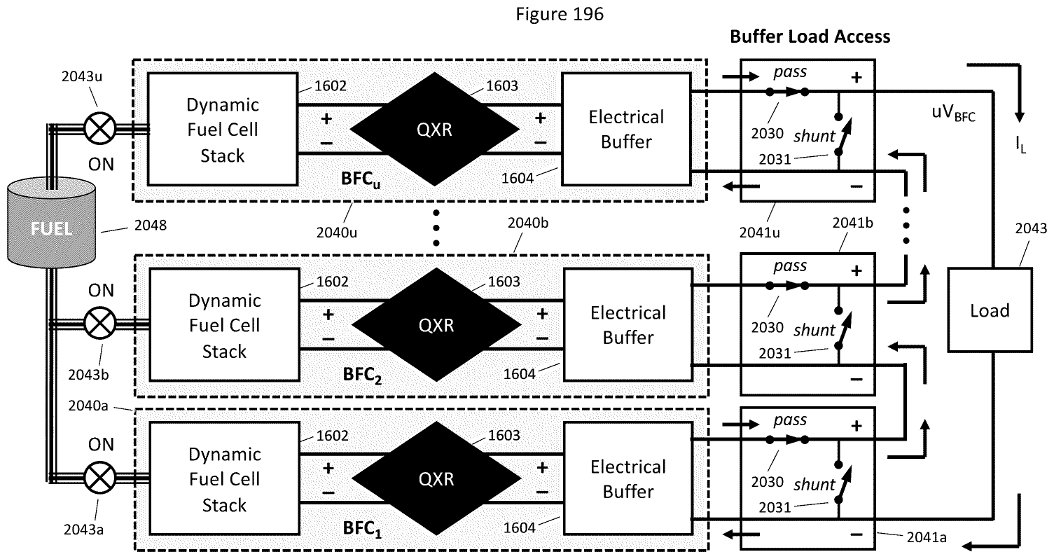

The utility of the bypass function is exemplified in the use of stacked iBFC modules shown in FIG. 196 comprising a high voltage stack of “u” series connected intelligent buffered fuel cells comprising buffered fuel cells 2040a, 2040b, . . . , 2040u each with their own corresponding BLA modules 2041a, 2041b, . . . , 2041u and gas controller microvalve 2043a, 2043b, . . . , 2043u distributing as from a shared canister 2048. Each BFC includes its own dedicated dynamic fuel stack 1602, a dedicated QXR 1603, and a dedicated electrical buffer 1604. Each iBFC has an electrical output of V_{BFC} comprising the sum of multiple fuel cells contained in dynamic fuel cell stack 1602. Each corresponding buffer load access module contains its own pass transistor 2030 for disconnect functionality and its own shunt transistor for bypass functions.

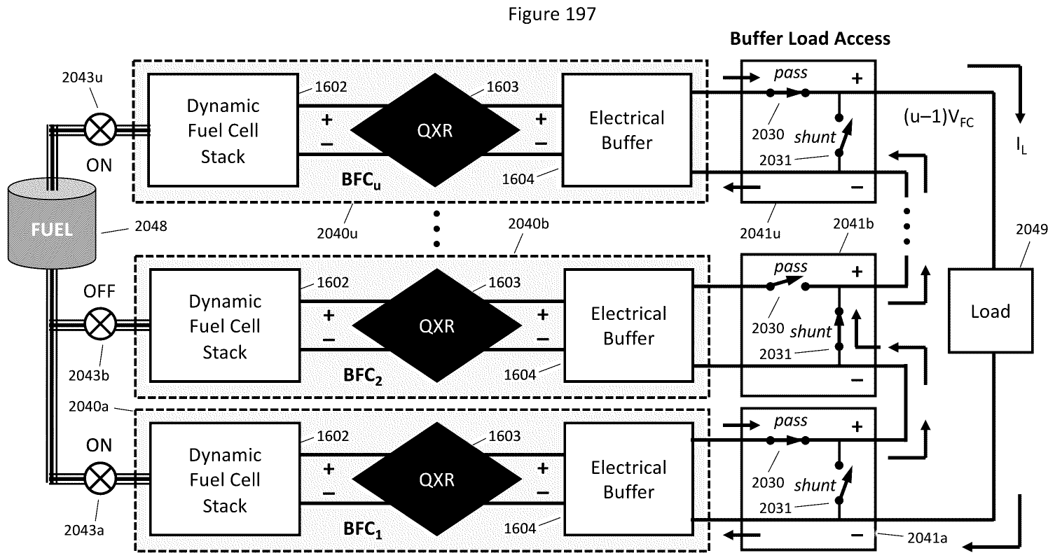

The electrical load 2049 connects across the cathode, i.e., “+” terminal, of topmost iBFC module comprising BFCu 2040u and BLA 20141u and to the anode or “−terminal” of the bottommost iBFC comprising BFCa 2040a and BLA 20141a. In aggregate the stacked modules deliver a series voltage uV_{BFC}to load 2043 at a current I_{L}. The total voltage is limited only by how many iBFC modules or μstacks are stacked, i.e., “u”, and the nominal voltage V_{BFC} of each module. For example, a 400V stack might comprise u=100 1s Li-ion iBFCs each nomically at V_{BFC}=4V, or u=24 4s Li-ion iBFCs each nomically at V_{BFC}=16V. FIG. 197 illustrates when the stack of iBFCs has too high a voltage one or more iBFC modules can be bypassed. In this example BLA 2041b is changed into bypass mode where the other cells remain active. In bypass mode pass switch 2030 in BLA 2041b is opened while shunt switch 2031 is activated. As such the load current loop flows around BFC₂ 2040b and the overall stack voltage is reduced by one V_{BFC} from the maximum voltage uV_{BFC} to a lower voltage (u−1)V_{BFC}. Applications include power saving, adjusting for ambient conditions, sleep mode, etc. To preserve fuel, the gas flow is cutoff from the bypassed cell 2040b by opening microvalve 2043b.

Another function embedded within iBFC is a secondary protection feature for cell balancing. Cell balancing ensures series connected Li-ion cells each share the same voltage and thereby carry the same charge. Although cell balancing can be used on individual BFCs or Li-ion cells within a stacked BFC like the 2s Li-ion pack shown previously in FIG. 172 and the 4s Li-ion pack shown in FIG. 174, the same principle is equally applicable for stacking entire iBFCs.

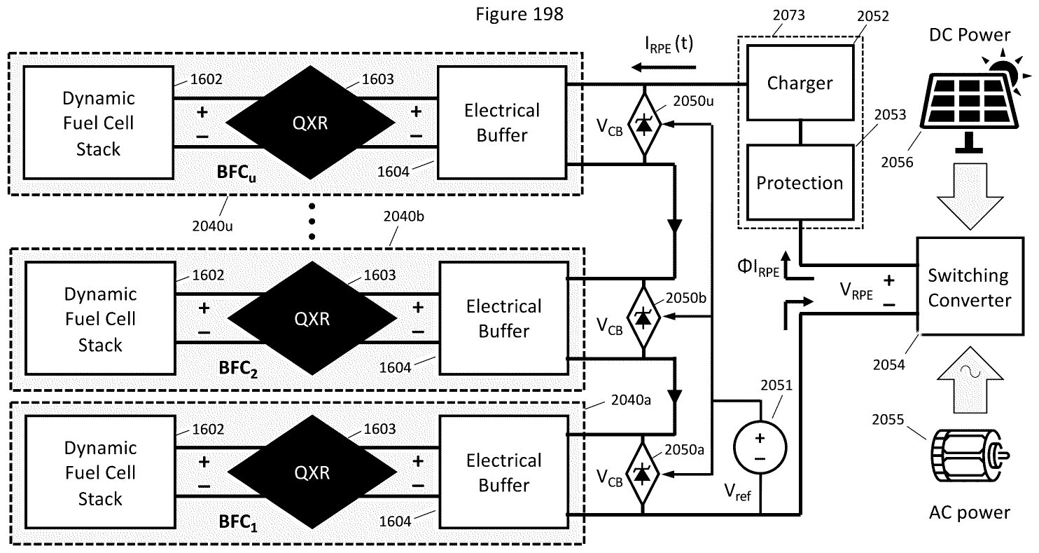

FIG. 198 illustrates an iBFC being electrically charged by an external electrical power source such as AC power 2055 or a DC source such as a solar panel 2056. In either case the switching power supply, which is not part of the buffered fuel cell, converts the incoming power into DC at a delivering power into ER module 2073 which after power condition and protection 2093 is converted into by charger 2052 into charging waveforms I_{RPE}(t) which differ from the raw input current (DI_{RPE}. The charging current passes the entire string of cells straight into the summing node and bypassing the BLA module altogether. As shown each CBC charge balancing circuit sits across its corresponding electrical buffer with CBC 2050a in parallel with electrical buffer 1604 in BFC₁ module 2040a, CBC 2050b in parallel with electrical buffer 1604 in BFC₁ module 2040b, and CBC 2050u in parallel with electrical buffer 1604 in BFC₁ module 2040u. The function of the CBC charge balancing circuit ensures all the iBFCs charge to the same voltage V_{CB} meaning the cells are charge balanced. In voltages under 100V, the charge balance circuits share a DC coupled precision voltage reference 2051 having trimmed voltage V_{ref}.

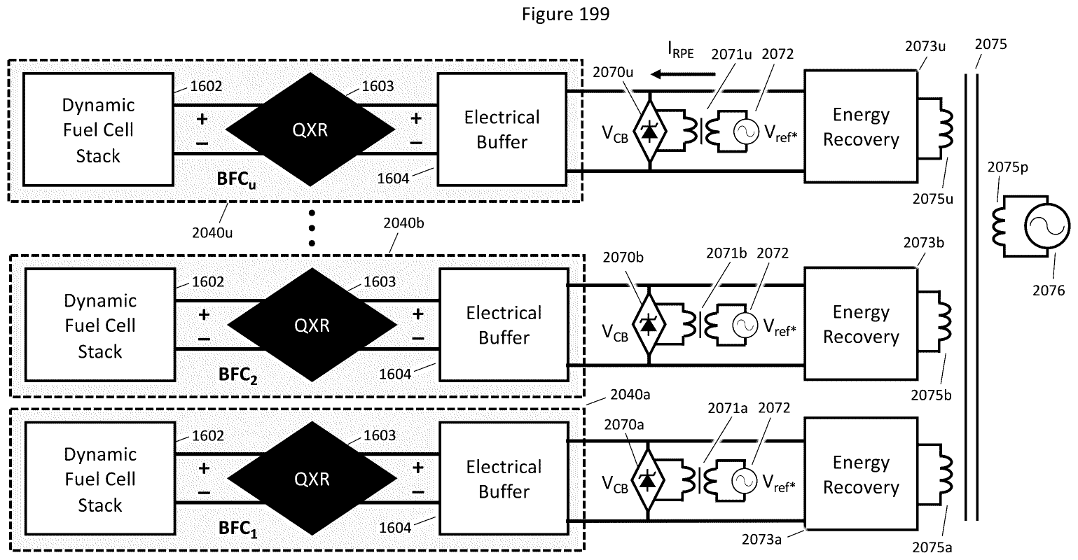

In a high voltage stack, e.g., at 400V, the charging is performed using at low-voltage using galvanically isolated floating power supplies as shown in FIG. 199. In such a case a high voltage AC power source 2076 is coupled to multiple identical windings 2073a, 2073b, and 2073u, then rectified and power conditioned in corresponding energy recovery modules 2073a, 2073b, and 2073u powering the current summing node for their respective electrical buffer in BFC modules 2040a 2040b and 2040u. The power transfer is performed using a multiple winding transformer or coupled inductor 2075 including a primary winding 2075p and secondary windings 2075a, 2075b, and 2075u. In a similar manner a shared voltage reference V_{ref} is converted into an AC voltage reference 2070 having an average value V_{ref}* then transferred to separate galvanically isolated secondaries 2071a, 2071b, and 2071u to uniformly bias floating CBC charge balance circuits 2070a, 2070b, and 2070u. The reference may comprise a common transformer or more likely because of the low voltage and power level small pulse transformers, one in each iBFC module. Ther need for isolation of the reference voltage distribution is for safety against electric shock from the high DC offset of the upper modules in stack.

The disclosed iBFC invention comprises three dedicated channels of energy flow within the iBFC. Specifically, the output port of the iBFC can only deliver power to a load but cannot accept it. The energy recovery and pluggable power port of the iBFC can only accept incoming power but cannot output power to devices connected to its inputs. The fuel cell can only generate power but cannot absorb or store power. In this way the fuel input, electrical inputs, and electrical outputs comprise dedicated ports in the iBFC that cannot be swapped or interchanged. In this sense, a secondary function of energy recovery module and BLA module is to protect the buffer from external electrical influences.

In another embodiment also the BLA buffer load access module includes a controller which manages the function of a pass switch in series between the load and the buffer array and shunt switch in parallel to the output port of the iBFC. In normal operation, the pass transistor is enabled and shunt transistor is off. The pass transistor is enabled whenever an iBFC is part of the active circuit and disabled whenever the device is cutoff from the system. When an iBFC module is cutoff, the pass transistor is opened but the shunt transistor is activated allowing current to flow around the module as if it didn't exist. In the case of a fault condition such as a short or over-temperature failure, both shunt and pass switches are opened.

The subject of stacking buffered fuel cells is considered in greater detail in the sections on charging and buffer load access shown in FIG. 155 through FIG. 174 and in the section discussing FIG. 175 through FIG. 178.

iBFC Energy Management Embodiments. An iBFC intelligent buffered fuel cell comprises a buffered fuel cell including a static or dynamic fuel cell array, a electrical buffer, and an intervening QXR charge transfer regulator that controls the transfer of energy between the fuel cell and buffer by preventing overcharging of the buffer and as needed limiting the current flow, and where the iBFC includes energy management functions comprising at least one of the following:
(i) an energy recovery circuit module able to safely transfer external electrical energy into the iBFC's electrical buffer in a manner preventing overcharging of the buffer, limiting the current to prevent damage, and providing protection against input fault conditions including excessive voltage, excessive current, and/or electrical noise,
(ii) an energy recovery circuit module able to accept DC, AC, or magnetically coupled power and convert it into a DC current to charge the electrical buffer, where buffer charging is controlled by a multimode charger able perform linear mode and/or pulse-mode methods during constant current CI-mode charging, and/or constant voltage CV-mode charging,
(iii) a BLA buffer load access circuit module able to control current flow magnitude and polarity between the iBFC buffer and an external load where current is either limited by regulation or by disconnection, and where reverse current flow from the load into the iBFC is prevented,
(iv) a BLA buffer load access circuit module able to disconnect the load from the iBFC in the event that the electrical buffer becomes over-discharged.
(v) a BLA buffer load access circuit module able to able to disable a iBFC module and bypass load current around the disabled module.

In another embodiment a DC summing node electrically connects an electrical buffer to two or more power components comprising a fuel cell stack via a QXR charge transfer regulator, an external power source via an energy recovery module, and an electrical load via a buffer-load access module whereby either
(i) fuel cell current in an on-state QXR flows unidirectionally from the fuel cell into the DC summing node and into any discharged electrical buffer, but is blocked bidirectionally in the QXR off state, or
(ii) current from the ER energy recovery module flows unidirectionally from an external power source into the DC summing node and any discharged electrical buffer, but is blocked bidirectionally by the ER module in its off state, or
(iii) current flow unidirectionally from the DC summing node and electrical buffer to an electrical load through an on-state BLA buffer load access module, but its blocked bidirectionally in the BLA off state.
(iv) current flows around any disabled iBFC through a shunt transistor.

In another embodiment a series of iBFC are stacked in series with their output ports from the individual BLA buffer access modules connected in totem pole fashion, anode to cathode to anode, operating in one of three modes whereby
(i) an iBFC is active with load current flowing through and where the load is partly powered by its electrical buffer,
(ii) an iBFC in bypass mode is disabled and disconnected from a load, whereby load current flows around the iBFC module conducted through a bypass shunt device, or
(iii) an iBFC is turned off disconnected from the load with no bypass current conduction path.

In another embodiment, a stack of iBFCs are charged in series from the ER energy recovery module through a single DC circuit connected directly to the DC summing node of every module in the charging loop. In another embodiment, a stack of iBFCs are charged from the ER energy recovery module _{in parallel} through multiple AC coupled galvanically isolated power sources or via a single multiple winding transformer or coupled inductor.

In another embodiment a series of stacked iBFCs balance charge across all the iBFCs in the stack using a CBC charge balancing circuit where the CBC shares a common voltage reference and where either the reference voltage is DC coupled or AC coupled and galvanically isolated.

IEM Applications. The applications of the foregoing inventions are nearly unlimited including primary power generation for fixed infrastructure such the power grid; for locally generated power for residences, offices, factories and hospitals; and in mobile power solutions for vehicular power in transportation including electric powered cars, trucks, trains, airplanes, and drones. Other mobile applications include portable generators, remote location power, and ad hoc emergency power networks.

Embodiments made in accordance with this invention include the individual elements of a fuel cell or electrolysis system, the processes used to fabricate the elements, the inventive benefits of combining these elements into a energy conversion device such as a fuel cell or electrolysis system, and the augmentation of an energy conversion device to store electrical charge as part of the energy conversion process. Examples of buffer augmented energy conversion devices made in accordance with this application include for example, intelligent buffered fuel cells and buffered electrolysis systems.

Applications of the IEMs made in accordance with this invention include:
Fuel cells that convert a fuel source into electricity by the transport of positive charges such as hydrogen across an IEM membrane, and storing the generated electric charge in an electrical buffer comprising an array of super capacitors or electrochemical cells such as lithium ion or sodium ion batteries. IEMs that conduct positive ions across the membrane are referred to as proton exchange membranes having the acronym PEM or alternatively as cation exchange membranes.
Fuel cells that convert a fuel source into electricity by the transport of negative charge ionized molecules such as hydroxyl across an IEM membrane, and storing the generated electric charge in an electrical buffer comprising an array of super capacitors or electrochemical cells such as lithium ion or sodium ion batteries. IEMs that conduct negative ions across the membrane are referred to as anion exchange membranes having the acronym AEMs.
Electrolysis using electricity to converts a reactant such as water, methane, or glucose into a fuel source such as hydrogen by the transport of positive charges such as hydrogen across an IEM membrane, where the electrolytic process is powered by a source of electrical power such as grid power, solar PV generated power, or from electric charge stored in an electrical buffer comprising an array of super capacitors or electrochemical cells such as lithium ion or sodium ion batteries. IEMs that conduct positive ions across the membrane are referred to as proton exchange membranes having the acronym PEM or alternatively as cation exchange membranes.
Electrolysis using electricity to converts a reactant such as alkaline solutions or potassium hydroxide into a fuel source such as hydrogen by the transport of negative charges such as hydroxyl ions across an IEM membrane, where the electrolytic process is powered by a source of electrical power such as grid power, solar PV generated power, or from electric charge stored in an electrical buffer comprising an array of super capacitors or electrochemical cells such as lithium ion or sodium ion batteries. IEMs that conduct negative ions across the membrane are referred to as anion exchange membranes having the acronym AEMs.
Electrodialysis, the process of electrochemical separation of ions in aqueous solutions using IEMs driven by the application of an electrical potential. Dialysis methods relying on IEM separation include Donnan dialysis, reverse electrodialysis, and electro-electrodialysis. Dialysis may used PEM proton exchange membranes or AEM anion exchange membranes (AEM) depending on the compounds being separated.

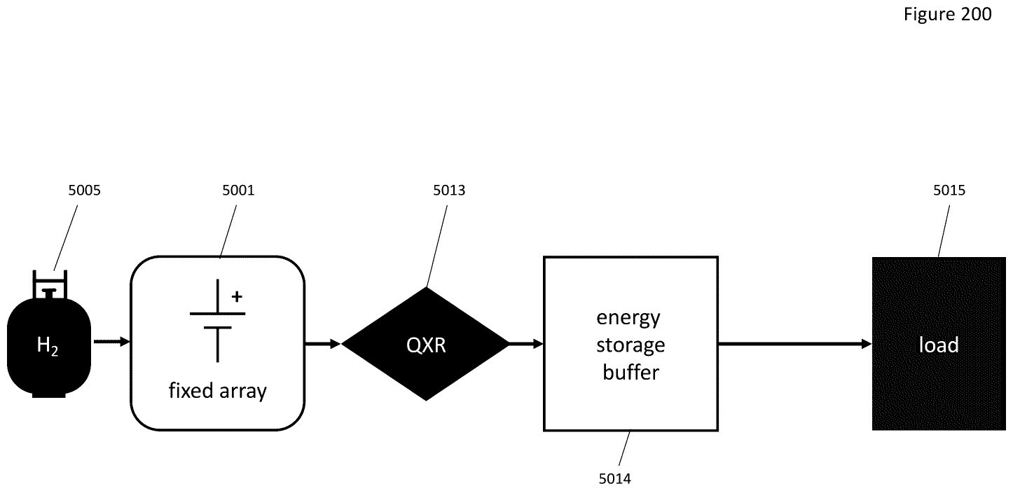

Buffered Fuel Cell. In contrast to a conventional fuel cell, inventive benefits of the buffered fuel cell made in according with this invention is its ability to decouple, i.e. isolate the electrical performance of a fuel cell from electrical loads it powers. Instead the load draws its power from the buffer, and the fuel cell supplies power to charge and refresh the buffer. The load does not however directly draw power from the fuel cell. Represented in a simplified schematic shown in FIG. 200 this buffered fuel cell function comprises a fixed array of fuel cells 5001 for converting hydrogen fuel 5005 into electricity which is transferred through charge transfer regulator 5013 to energy storage buffer 5014. Electrical load 5015 in turn draws its power from energy storage buffer 5014. In this manner energy is passed through the buffer, allowing the charging current and charging rate of the buffer to be lower than the load current and slower than the buffer's discharge rate.

So long that the buffer doesn't become fully depleted during a high-current load condition, then on-average the buffer will recover during intervals where the load current is lower allowing replacement of the lost charge. In this sense the buffered fuel cell comprises two half circuits with different impedances—the high impedance loop formed by the fuel cell array 5001, QXR charge transfer regulator 5013, and energy storage buffer 5014; and a second low impedance loop formed between energy storage buffer 5014 and electrical load 5015.

To prevent damage to the fuel cell and energy buffer cells, certain protective functions are required. QXR charge transfer regulator 5013 performs necessary functions of (i) preventing excessive current draw from fixed fuel cell array 5001, (ii) preventing excessive charging currents into energy storage buffer 5014, and (iii) and preventing overcharging of the buffer resulting in an overvoltage condition on the buffer cells. The functions of QXR charge transfer regulator 5013 can be realized using discrete components, by combining current limiters with a voltage regulator, by employing current limited voltage regulators, or by adapting a battery charger.

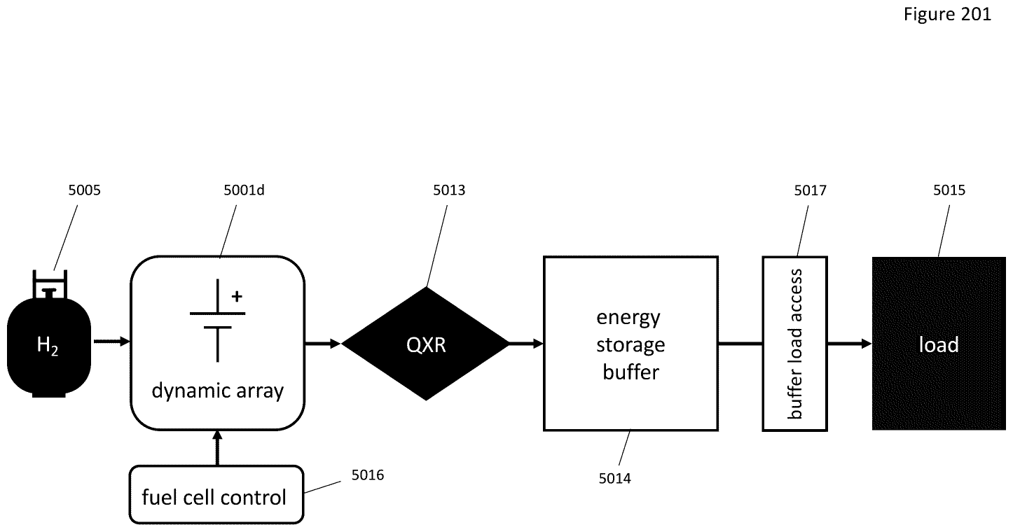

Charge transfer regulator 5013 does not however protect energy storage buffer 5014 from load 5015 including conducting excessive load currents, from shorted loads, from reverse conduction, or from over-discharging the buffer. These functions are instead realized in the BLA buffer load access 5017 block interposed between energy storage buffer 5014 and load 5015 as shown in FIG. 201.

An advanced feature of a buffered fuel cell is to replace a fixed topology of fuel cell array 5001 with an electrically reconfigurable dynamic array 5001d. In a dynamic fuel cell array, the number of fuel cells connected in series or in parallel can be altered during operation under control of the FCC fuel cell control 5016 function. In general, FCC fuel cell control 5016 senses the condition of the fuel cell to adjust it's the number of series connected cells n and the number of parallel connected cells m, thereby controlling the array's ‘nsmp’ topology in real time.

Electrically the number of series connected cells n determines the voltage of the fuel cell stack nV_{FC} where the voltage of a single fuel cell V_{FC} is a function of humidity, temperature, and current density. For example if the voltage of the fuel cell stack in a dry climate drops too low to adequately charge a lithium ion battery, i.e. with a voltage nV_{FC}≤3.5V then additional cells can be connected in series to increase the stack voltage, e.g. by increasing from n=8 cells to n=10 cells.

Conversely, if the voltage of the fuel cell in a humid environment exceeds the maximum safe buffer overcharge voltage V_{OC} 4.2V to a voltage higher than the ability of QXR charge transfer regulator 5013 to prevent overcharging the buffer cells, then the number of series connected fuel cells can be dynamically be reduced to a shorter stack, e.g. reducing the stack from n=8 to n=6. The FCC fuel cell control 5026 unit can perform this function simply by monitoring the fuel cell stack voltage either with a circuit comprising discrete comparators and ratioed voltage references, or using an A/D converter. Operation of the FCC fuel cell control 5016 unit is described in greater detail herein.

In a similar manner the number of fuel cells “m” connected in parallel can be adjusted to regulate the current output of the fuel cell stack. For example if the load 5015 is rapidly discharging energy buffer 5014 at a rate where the fuel cell cannot replenish, e.g. during operation in dry cold conditions then the current output capability can be increased by increasing the total width of operating fuel cells. If a fuel cell contains two stacks one with width m₁ and the other with m₂ then in the case of insufficient current both fuel cells can be dynamically activated charging the array topology from nsm₁p to ns(m₁+m₂)p and increasing the current from m₁I_{FC} to (m₁+m₂) I_{FC} where the fuel cell current per unit area I_{FC}=[I_{FC}/A]·A_{FC} where [I_{FC}/A] is a design parameter for the fuel cells such as 200 mA/cm² and A_{FC} is the area of a unit-cell fuel cell, e.g. 1 cm². The sensory and decision making operations of FCC fuel cell control 1016 mean the buffered fuel cell is performing intelligent functions, and is therefore referred to as an intelligent buffered fuel cell or iBFC. The intelligence functions may be realized using dedicated electronic circuitry or reconfigurable logic including programmable logic array, microcontrollers, general processor units, or microprocessor based systems. The control algorithms may be stored as autonomous firmware without. dedicated operating system, or using software executed atop an operating system and kernel.

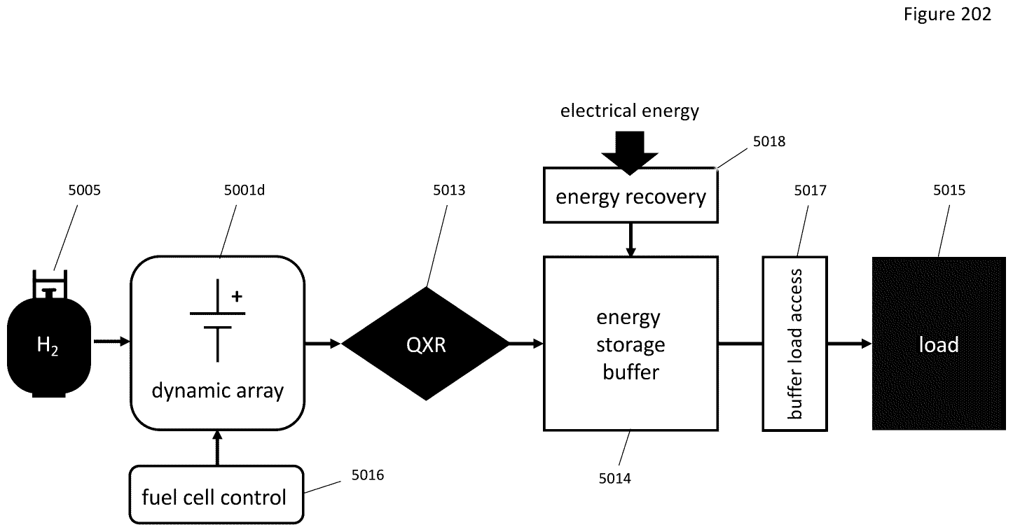

FIG. 202 illustrates another intelligent function of the iBFC, specifically energy recovery 5018. The function of energy recovery 5018 is to enable direct electrical charging of energy storage buffer 5014. The charging function requires intelligence as the total current delivered to energy storage buffer 5014 from external power sources via energy recovery 5018 plus the current delivered from dynamic fuel cell array 5001d must not exceed the acceptable charging rate, i.e. the acceptable C-rate, for energy storage buffer 5014.

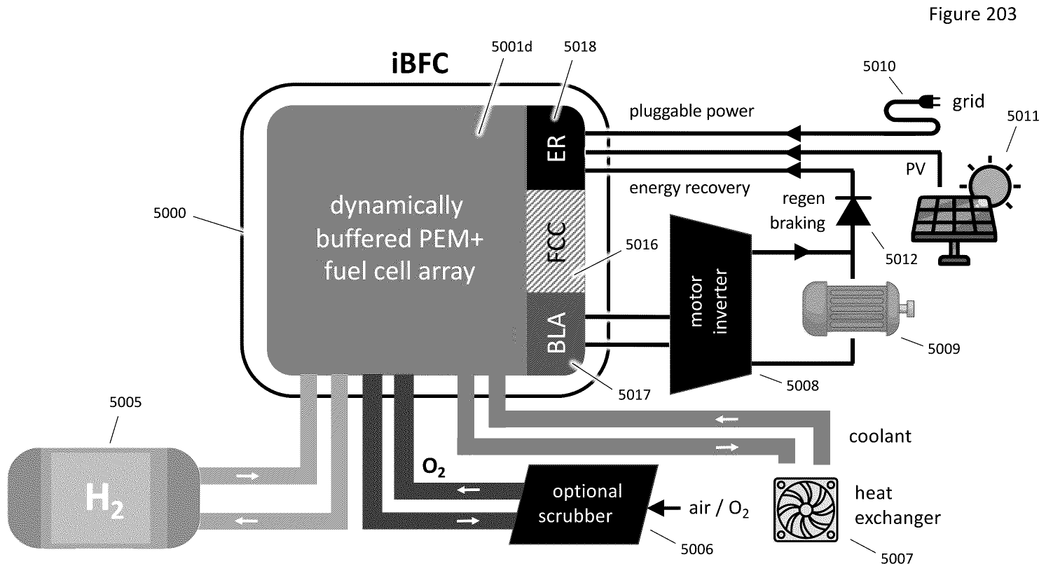

Moreover, energy recovery 5018 module conditions various forms of incoming power to make them compatible with the noise free DC power requirements to properly charge the buffer cells. As shown in iBFC block diagram of FIG. 203, external electrical power sources may comprise pluggable power from grid 5010, photovoltaic power from PV 5011, or energy recovery such as transient current from regenerative breaking of motor 5009 whenever motor inverter 5008 slows a motor or vehicle thereby converting the drive-train motor into a generator.

Aside from the electrical connections to iBFC 5000 as shown, the system also includes hydrogen fuel source 5005, cathode air supply with optional scrubber to remove poison gasses and contaminants 5006, and a cooling system including fan or heat exchanger 5007.

Various embodiment of an intelligent buffered fuel cell made in accordance with this invention, the iBFC offers functionality and performance advantage neither a conventional fuel cell can. Referring to the following comparative table, a conventional fuel cell can generate electricity offering unlimited driving range without the need for charging, has a low weight and has no thermal runaway self heating safety risks while the Li-ion battery is precisely opposite. Conversely a lithium battery is able to store electric charge when a fuel cell cannot, is able to be refreshed from a charger station without the need for fuel, is able to recover waste electrical energy from the environment like from regenerative braking while a fuel cell cannot.

Even more significantly a Li-ion battery pack is capable of delivery high on-demand power at high currents, albeit for limited durations, and represents a low-impedance “stiff” voltage source with milliohm series resistances. By contract the fuel cell cannot deliver high currents without experiencing significant voltage drops, i.e. droop, sag, and dropouts. Lithium ion battery packs can and often do exhibit overheating representing a fire hazard and safety risk.

In contrast, the iBFC offers the best features of both the lithium ion battery and a fuel cell able to deliver high currents into a low impedance load such as motor or a high current DC/DC converter or DC/AC inverter without issue. Moreover, as an omnipower device the iBFC can convert fuel into electricity and store the generated charge or accept electrical power from external electrical power sources including renewable sources such as PV solar or wind; store power from the grid; and capture regenerative energy from motor braking.

Because the buffer in the iBFC uses a small fraction of the cells in a battery powered EV or power wall, the iBFC weighs a small fraction of Li-ion batter packs of comparable energy capacities, and greatly reduces the risk of thermal runaway and battery pack fires. One key feature is the buffered fuel cell's ability to utilize power from multiple inputs—either from fuel such as hydrogen or methanol, electrical energy from the power grid or a backup generator, renewable energy from solar photovoltaic panels or from wind, and energy recovery from regenerative braking, i.e. using a slowing motor to function as a generator recovering its inertial kinetic energy back into electricity. As such iBFC can be considered as an omnipower energy conversion device able to generate electricity for fuel and able to store electrical energy from the grid, from generators, from renewables such as wind, solar, hydroelectric, and geothermal.

| | Li-ion | Fuel | |
|---|---|---|---|
| Feature | Battery | Cell | iBFC |
| Generates electricity | − | + | + |
| Stores electric charge | + | − | + |
| Requires charging | − | + | + |
| Fuel resupply increases kWh | − | + | + |
| Pluggable, charge station refresh | + | − | + |
| Energy recovery (regen braking) | + | − | + |
| Unlimited driving range (refueling) | − | + | + |
| High current | + | − | + |
| Stiff voltage source during transients | + | − | + |
| Able to drive high-I DC/DC converter | + | − | + |
| Able to drive high-P DC/AC inverter | + | − | + |
| Low resistance, low impedance | + | − | + |
| Lightweight | − | + | + |
| No thermal runaway | − | + | + |
| Omnipower input capable | − | − | + |

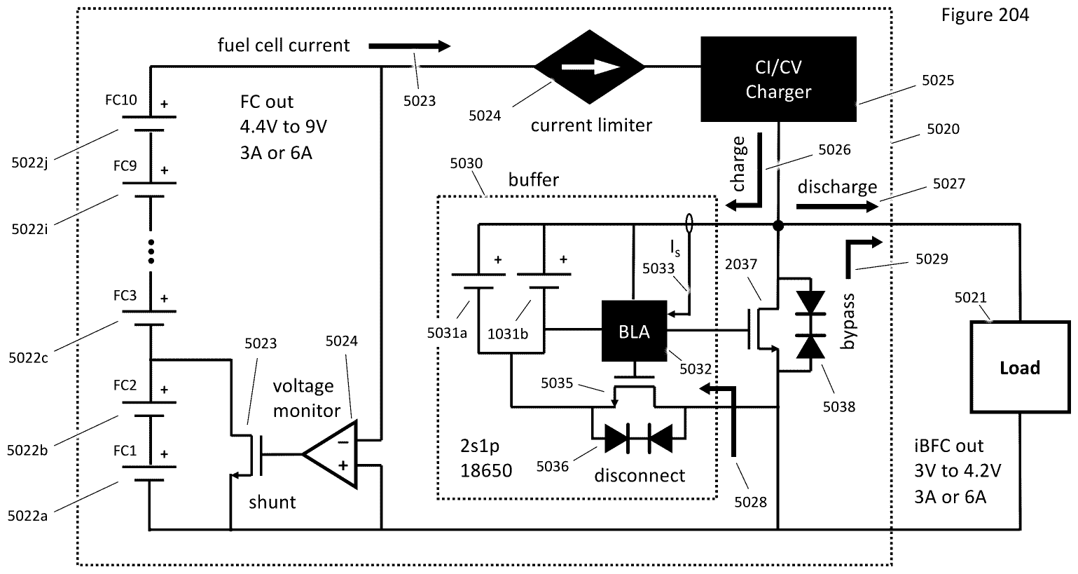

One exemplary schematic of an intelligent buffered fuel cell is shown in FIG. 204. As shown, the iBFC 5020 contains a dynamic array of up to ten fuel cells FC1 to FC10 identified as 5022a through 5022j respectively with a simple FCC fuel cell control comprising voltage monitor and shunt MOSFET 5023 in parallel with fuel cells 5022a and 5022b. As such the dynamic fuel cell as represented can comprise either a 8-cell or a 10-cell array depending in the voltage monitor. The fuel cell current 5023 is then output to CI/CV dual-mode linear or switching charger 5025 through current limiter 5024. Whether the fuel-cell current limiter function is needed depends on the area mA_{FC} of the fuel cell and the buffer and load capacity it is designed to drive.

Buffer 5030 contained within iBFC 1025 comprises electrochemical cells 5031a and 5031b, buffer load access BLA controller 5032, and disconnect switch 5035 including bidirectionally blocking diodes 5036. BLA controller 5032 has two electrical inputs—a voltage input measuring the potential of electrochemical cells 5031a and 5031b, and a current monitor depicted symbolically by a current sensor signal 5033.

In operation, electrochemical cells 5031a and 5031b within buffer 5030 are discharged by load 5021 through a loop comprising currents 5027 and 5028. Concurrently fuel cell current 5023 provides charging current 5026 via CI/CV charger 5025 to replenish charge lost during operation. Any voltage or current outside the cell's safe operating area either exceeding the maximum safe current Iₘₐₓ, exceeding the maximum cell voltage V_{OC}, or discharging below the minimum allowable cell voltage V_{ODC} results in the automatic disconnection of the cell. In stacked module applications whenever a cell is disconnected from load 5021, bypass MOSFET 5037 is activated to provide a shunt current path 5029 allowing the stacked modules to continue operation despite disconnecting buffer 5030 from the external circuit.

Like disconnect MOSFET 5035, bypass MOSFET 5037 in its off state is bidirectionally blocking 5038 represented symbolically by back-to-back diodes. The need for bidirectional blocking in the off state is to prevent both normal polarity conduction and to prevent anomalous reverse current conduction, i.e. prohibit electrical load 5021 from acting as a charger to electrochemical cells 5031a and 5031b in buffer 5030.

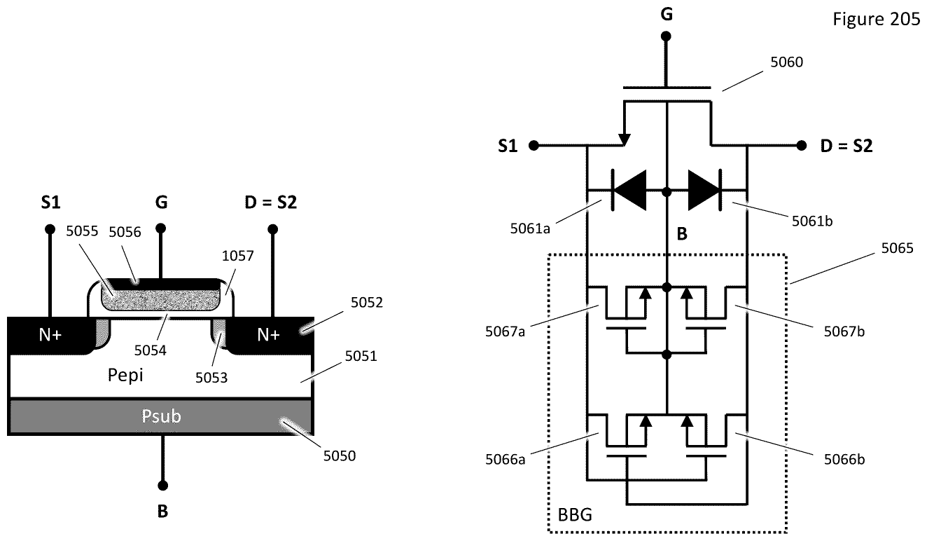

One realization of a bidirectionally blocking MOSFET 5060 is shown in FIG. 205, using a four-terminal lateral 5V sidewall spacer MOSFET along with circuitry called body bias generator BBG 5065. The MOSFET comprises source and drain N+ regions 5052 formed in P-type epitaxy 5051 grown atop a P-type substrate 5050. To prevent hot carrier damage and increase device breakdown, N− doped lightly doped drain or LDD regions 5053 are fabricated using a self-aligned process, specifically being self-aligned to gate electrode 5056. In the device shown the length of the LDD is not dependent on mask alignment but is instead determined by sidewall spacer 5057 which blocks ion implantation of arsenic used to form N+ regions 5052. To improve switching performance gate 5055 is coated with silicide 5056 formed atop gate dielectric 5054.

The function of body bias generator BGG 5065 is to dynamically bias the body potential on terminal B of MOSFET 5060 to prevent diode conduction of source-to-body diode 5061a and drain-to-body diode 5061b. Note that the nomenclature “drain” is arbitrary in a bidirectional switch as the polarities may reverse based on operating conditions. As such the terminals are more appropriately referred to S1 and S2. BBG 5065 includes two cross-coupled BBG MOSFETs 5066a and 5066b connecting S1 and S2 to the B body terminal. The gate of BBG MOSFET 5066b is tied to source S1 while the gate of BBG MOSFET 5066a is tied to source S2.

In operation, when the potential of source S1 is more positive than that of S2, i.e. V_{S1}>V_{S2}, then N-channel BBG MOSFET 5066b is biased into an on-state while BBG MOSFET 5066a remains off thereby shorting the body B of power MOSFET 5060 to S2 shorting out intrinsic diode 5061b and reverse biasing diode 5061a. Conversely, when the potential of source S2 is more positive than that of S1, i.e. V_{S2}>V_{S1}, then N-channel BBG MOSFET 5066a is biased into an on-state while BBG MOSFET 5066b remains off thereby shorting the body B of power MOSFET 5060 to S1 shorting out intrinsic diode 1061a and reverse biasing diode 5061b. In the manner only which ever body diode 5061a and 5062 are reversed bias remain in the circuit.

Auxiliary MOSFETs 5067a and 5067b having their gate, source, and body terminals hardwired to the B terminal of power MOSFET 5060 do not switch but function as lower forward dop diodes referred to herein a pseudo-Schottky diodes to prevent the body potential from floating at low bias potentials. Specifically whenever source S1 is more positive than that of S2, i.e. V_{S1} >V_{S2}, but at a voltage below the threshold N-channel BBG MOSFET 5066b, the transistor remains off and the potential at the B terminal floats to an intermediate value when V_{B} >V_{S2}. By forward biasing the body voltage, the source-to-body barrier potential is reduced thereby lowering the threshold connected MOSFET and reducing its turn on voltage limiting the range in which the body voltage can float and preventing leakage current. In other words auxiliary MOSFETs 5067a and 5067b function analogous to Schottky diodes conducting at a lower voltage than enhancement mode MOSFETs 5066a and 5066b.

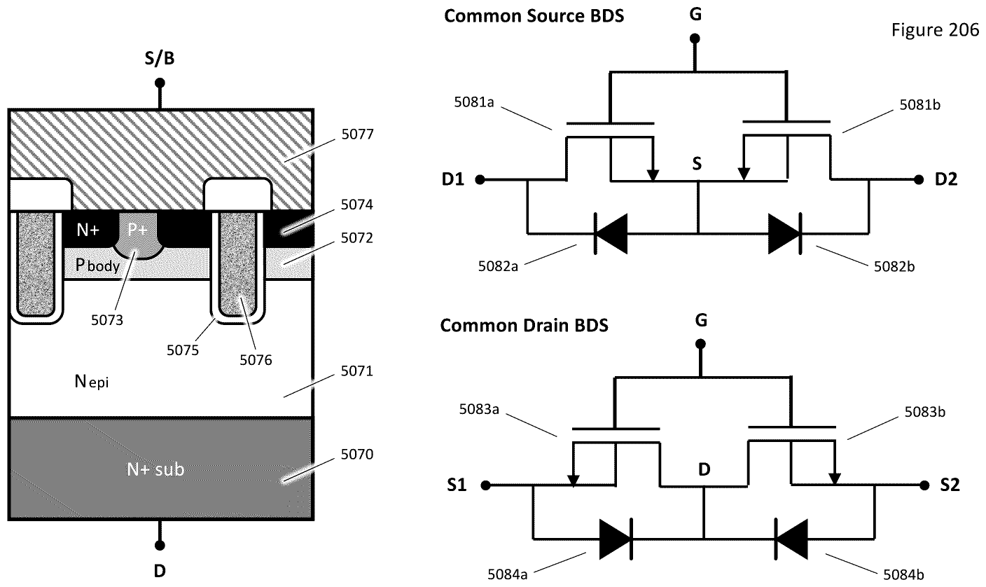

In an alternative implementation shown in FIG. 206, two trench power DMOSFETs are connected back-to-back either in a common-drain or in a common-source BDS bidirectional switch configuration. The trench power DMOSFET is a low resistance vertical device comprising a topside shorted source-body metal 5077 comprising a S/B terminal and a backside drain D terminal (metal not shown). The DMOSFET device is formed in a N-type epitaxial layer 5071 grown atop an N+heavily doped substrate 5070. A moderately doped p-type body P_{body} 5072 forms the channel of the device which contains N+source 5074. Contact to P_{body} region 5072 is made via a P+deep body region 5073 forming a butting contact with N+source regions 5074 in contact with metal 5077. P+deep body region 5073 is deeper than N+source regions 5074 but may or may not be deeper than P_{body} region 5072.

The gate electrodes 5076 are embedded in a vertically etched trench lined with a gate oxide 5075. The gate oxide may or may not be uniform along the trench at the bottom of the trench or along its sidewall between the trench bottom and the P_{body}-to-Nₑₚᵢ junction. The device is referred to a DMOSFET because of its double diffused structure, i.e. first diffusing the body P_{body} 5072 into the epitaxial Nₑₚᵢ layer 5071, then implanting and diffusing the source N+ 5074 within P_{body} 5072. Because of concentration gradient between body P_{body} 5072 and epitaxial Nₑₚᵢ layer 5071, most depletion spreading in the off-state extends into the lightly doped Nₑₚᵢ layer and not into the more highly doped body region P_{body} 5072. In this manner the device can achieve submicron channel lengths with no short channel effects. Breakdown voltages can range from 15V to hundreds-of-volts with most devices rated at 30V and 60V. Bothe P-channel and N-channel devices are available.

Using two identical trench DMOSFET devices, a bidirectionally blocking bidirectionally conducting switch with low on-state resistance and superior blocking characteristics can be realized. In one configuration two trench DMOSFET devices 5081a and 5081b are connected in a common source arrangement where the body-to-drain antiparallel diodes 5082a and 5082b are biased in opposing directions to prevent diode conduction between drain terminals D1 and D2. As such BDS conduction occurs only via the MOS channel under gate control regardless of the connection polarity.

In another configuration two trench DMOSFET devices 5083a and 5083b are connected in a common drain arrangement. Similarly, in the common drain connection the body-to-drain antiparallel diodes 5084a and 5084b face opposing directions thereby preventing diode conduction between drain terminals D1 and D2.

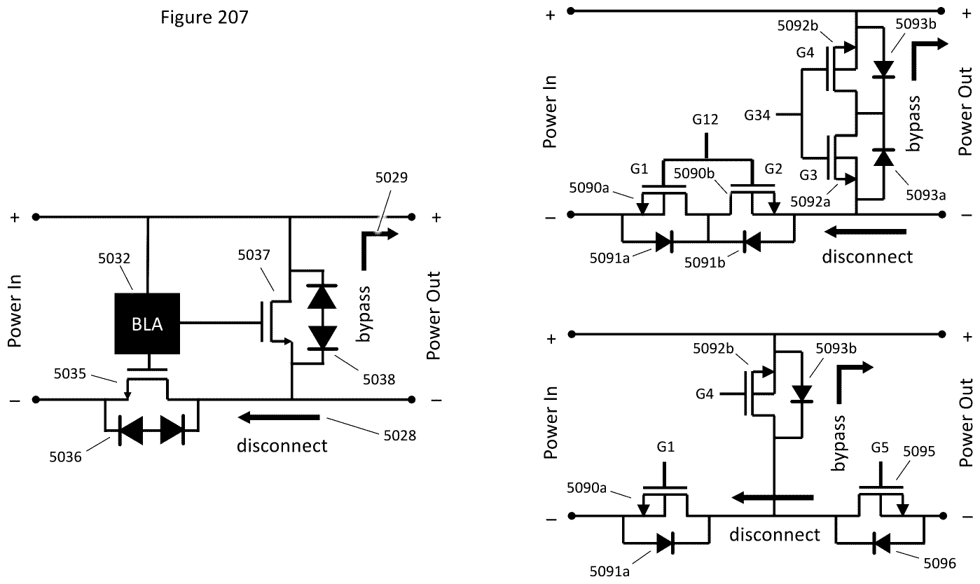

In realizing the BLA 5032 buffer load access functions of bidirectional disconnect 5028 and bypass 5029, both MOSFETs 5035 and 5037 shown in FIG. 207 must block bidirectionally 5036 and 5038 in their off state. Implementing the two BDS switches using discrete power devices requires four DMOSFETs—DMOSFETs 5090a and 5090b with integral anti-parallel diodes 5036 and 5038 to form the disconnect switch pair and DMOSFETs 5092a and 5092b with integral anti-parallel diodes 5093a and 5093b to form the bypass switch.

Because negative terminal is shared, one of the devices can be eliminated simply altering the logic gate truth table. In this compact circuit DMOSFETs 5090b and 5092a are eliminated and replace by DMOSFET 5095. Because the intrinsic antiparallel diode 5096 in DMOSFET 5095 is diametrically opposed to diodes 5091a in the disconnect switch and 5092b in the bypass switch, bidirectional blocking is not compromised.

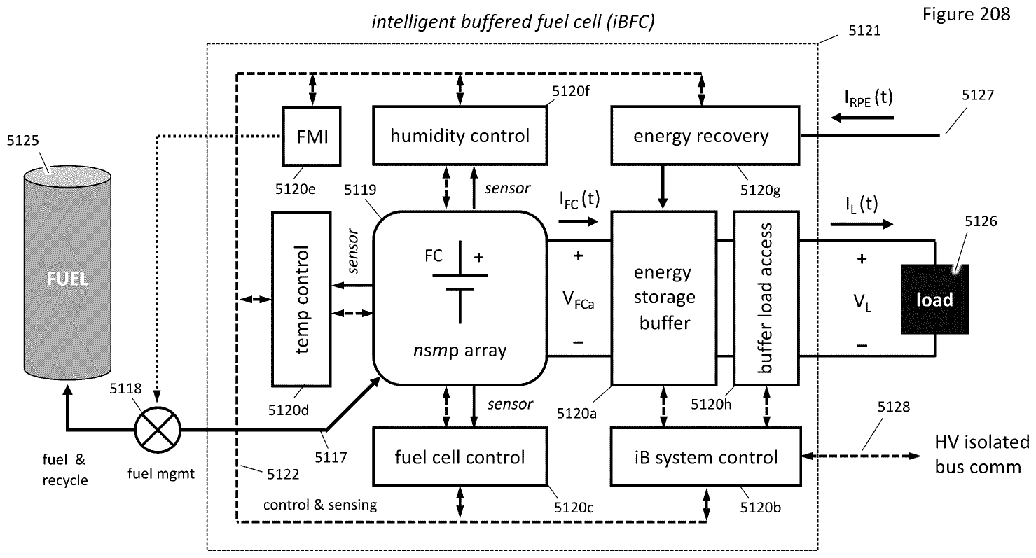

The described functions are part of the buffered load access module 5120h in the iBFC intelligent buffered fuel cell 5121 shown in FIG. 208. In addition other iBFC functions made in accordance with this invention include the following:
Series-parallel fuel cell array 5119 capable of dynamic reconfiguration of array electrical topology including number of series connected cells and the fuel cell area along with internal electrical, thermal, and humidity sensors.
Fuel cell control module 5120c controlling fuel cell array topology in dynamically reconfigurable fuel cell arrays and gas microvalves.
Intelligent energy storage buffer 5120a with integrated regulating charger facilitating energy storage, impedance matching, overvoltage and overcurrent protection, and buffer charge balancing functions. Energy storage buffer 5120a stores electric charge and is therefore sometimes referred to through this invention as electrical storage. Unlike most components in the iBFC which comprise unidirectional flow, electrical currents within energy storage buffer 5120a are bidirectional, able to source and absorb energy.
Energy recovery ER module 5120g able to convert power sources such as generators, power supplies, uninterrupted power supplies, pluggable power, renewable power, regenerative power, or energy harvesting into DC power suitable for charging energy storage buffer 5120a and to protect the energy storage buffer from damage. The ER module may also contain a rectifier-filter for converting AC coupled power into floating DC using galvanic isolation. Electrical energy flow into ER module 5127 is denoted by the current I_{RPE} the subscript being an acronym for recovered and pluggable energy recognizing renewable and harvested energy is separate and distinct from “pluggable” grid power sources.
Buffer load access (BLA) module 5120h protecting energy storage buffer 5120h from adverse conditions cause by external connection to load 5126 including protecting against overcurrent from a shorted load, limiting over-discharge of buffer cells, and preventing reverse current from electrical loads containing their own internal power sources. As such iBFC current flow in the BLA is unidirectional flowing outward from the iBFC to load 5126. Buffer load access also facilitates the dynamical ability to disconnect or shunt fuel cells from a series stack without interrupting current of disrupting iBFC operation and to conserve fuel consumption in disabled cells.
Intelligent buffer system controller 5120b with high-voltage isolated external interface bus 5128 and internal iBFC communication bus 5122 facilitating inter-module communication within the iBFC system.
Temperature control module 5120d to up-regulate (heat) or down-regulate (cool) temperature of fuel cell array 5119 thereby enabling cold start capability and providing protection from fuel cell overheating.
Humidity control module 5120f able to humidify fuel such as hydrogen gas delivered from fuel supply container 5125 to fuel cell array 5119 or to directly humidify the anode or cathode of fuel cells comprising fuel cell array 5119.
Fuel management interface FMI 5120e able to control external fuel management module 5118 to control the flow rate and pressure of fuel supply and recycle lines 5117.

Collectively, the various functional modules or blocks comprising energy storage buffer 5120a, intelligent buffer system controller 5120b, fuel cell control module 5120c, temperature control module 5120d, fuel management interface FMI 5120e, humidity control module 5120f, and energy recovery module 5120g comprise intelligent buffer (iB) 5120. As such the intelligent buffered fuel cell iBFC 5121 can be represented in a simplified form comprising a dynamic fuel cell array 5119, intelligent buffer (iB) 5120, and communication comprising control bus 5122.

Power Dissipation. Although the concept of the intelligent buffered fuel cell is adaptable to wide range of electrical applications, it is more efficient to deliver power at higher voltages than at lower potentials. The principle that power delivery is more efficient at higher voltages is universally applicable to all electrical energy sources including the power grid, batteries in BEV battery electric vehicles, and even for the buffered fuel cell as disclosed herein.

The value of operating at higher voltages can be best understood by using simple electrical network analysis. By representing a real power source using a lumped element model as an ideal voltage source having voltage Vₛ in series with a lumped element resistor having resistance Rₛ power transfer and power losses can be analyzed. Assuming a lossless power source, i.e. where η=100%, power generated by the idealized voltage source is given by the network branch constraint Pₛ=ηIₛVₛ=IₛVₛ. Similarly power P_{L} delivered to the electric load is given by P_{L}=I_{L}V_{L}. Power loss in the resistor is likewise given by P_{R}=I_{R}V_{R}.

If we consider a single-loop circuit containing the three identified components, namely a power source, load, and resistor, then in accordance with KVL Kirchhoff's voltage law the loop voltage must sum to zero, i.e. V_{L}+V_{R}−V_{S}=0. By convention the source voltage V_{S} has minus sign to denote it is a power source rather than an electrical load. Rearranging the equation for the output voltage gives the result V_{L}=V_{S}−V_{R}. With lonely one loop, the current in every element in identical meaning I=I_{L}=I_{S}=I_{R}. Given the general equal P=IV, the KVL voltage equation can be rewritten in terms of power as IV_{L}=IV_{S}−IV_{R} or simply P_{L}=P_{S}−P_{R} where power is lost in the resistance in transit to the load. Although many sources of resistance may arise in a power electrical circuit, in most cases the power losses occur in power semiconductor device such as the aforementioned power MOSFETs used in power supplies, disconnect switches, and in power multiplexers.

Aside from causing unwanted energy losses and lower energy efficiency, power dissipation in the power devices causes unwanted heating. The power MOSFET must survive the elevated temperature from its own self heating or in may burn up. Unfortunately, in the vast majority of power applications, there is never a good source of heat sinking to remove waste heat, especially in surface mounted power MOSFETs which can only remove heat convectively via copper cladding of the PCB printed circuit board, typically deposited to thickness of 70 μm corresponding a copper weight of 610 g/m², commonly referred to as a 2-ounce copper PCB.

In low-frequency power switching applications, the power MOSFET is modelled as a constant resistance carrying an average current I=Iₐᵥₑ=IₚₑₐₖD where D is the duty cycle representing the conduction on-time divided by the total clock period. To determine the temperature rise, parameters include the dissipated power in watts; the resistance in ohms; the maximum allowable junction temperature Tⱼ(max) in ° C.; the ambient temperature Tₐ in ° C., and the ability of the PCB copper to dissipate heat measured by the thermal resistance R_{θ} in ° C./W.

Since power loss in the series resistance P_{R} is given by the relation P_{R}=IV_{R} by using Ohm's law V_{R}=IR we can modify the power loss equation into P_{R}=I(IR)=I²R. This relation reveals the important consideration that power loss depend on the square of the current, meaning delivering power from a source to an electrical load at a high current dissipates more power losses and creates more heat than using a lower current and a higher voltage. This factor is the reason the power grid uses a high voltage transmission network, and only drops the voltage locally for residential power.

As described previously since the power delivered by a power source is given by the relation Pₛ=ηIₛVₛ=IVₛ where η=100%, then I=Pₛ/Vₛ. Substituting this current into the resistive power loss equation results in the power transfer function describing power loss P_{R} as a function of source power input power Pₛ and series resistance R_{S}, as given by

$${P}_{R} = {I}^{2} {R}_{S} = {( \frac{{P}_{s}}{{V}_{s}} )}^{2} {R}_{s}$$

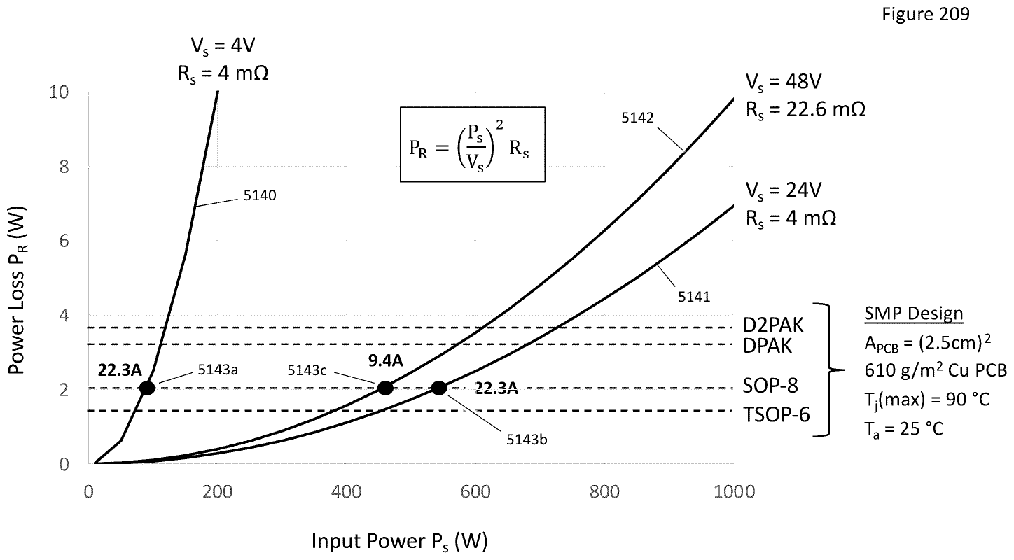

This relation is plotted in FIG. 209 showing the power dissipation as a function of power input for three different output voltages. As shown, curve 5140 describes the losses in a 4 mΩ power MOSFET delivering power from a 4V source. At 22.3 A shown by point 5143a the power device dissipates 2 W of heat while the source delivers an input power of Pₛ=IVₛ=(22.3 A)(4V)=89.2 W. By contrast curve 5141 describes the losses in a 4 mΩ power MOSFET delivering power from a 24V source. At 22.3 A shown by point 5143b the power device dissipates 2 W of heat while the source delivers an input power of Pₛ=IVₛ=(22.3 A)(24V)=535.2 W, roughly half a kilowatt. Comparing the 24V and 4V solutions, the higher voltage system delivers 533 W of power to the load over six times the power of a 4V solution supplying only 87 W. To deliver the same power as a 24V power source, the current in a 4V supply must significantly higher with commensurately higher power losses. Extending the concept to a 48V supply produces a counterintuitive result. As shown by curve 5143c, a 48V source delivers less power to a load than the 24V supply of curve 5141. As shown by point 5143c, thermal losses of 2 W occurs at 9.4 A. Ideally doubling the voltage should halve the current, maintain the same input power, and improve output power by lower conduction losses I the power MOSFET resistance. Unfortunately the 4-mΩ 30V trench DMOSFET used in a 24V system is not applicable for use in 48V systems. Instead a 60V device must be used. The higher blocking voltage requires use of a thicker-more resistive epitaxial layer. In voltage scaling of power MOSFETs the resistance increase by the breakdown voltage ratio raised to the power of 2.5V. Algebraically voltage scaling can be expressed as [R_{DS}A]₂=(V_{B2}/V_{B1})^{2.5} [R_{DS1} A]₁≈5.3 [R_{DS1} A]₁. So even though the current is halved and the power loss reduced by ¼^{th}, the resistance increased by 5.3× resulting in a net loss in performance. So limiting the thermal dissipation in a PCB mounted power MOSFET lacking heat sinking is a key design consideration in designing the maximum conducted current in a system. The maximum power dissipation is given by the temperature rise ΔT=Tⱼ(max)−Ta and the convective thermal resistance Re according to the equation

$$P \leq \frac{{T}_{j} ( max ) - {T}_{a}}{{R}_{ϑ}} = \frac{Δ T}{{R}_{θ}}$$

The specific value of thermal resistance depends on the PCB and the semiconductor package design. A sample of various surface mount packages used by power MOSFET is described in the table below. The power levels shown in the table are illustrated on the graph for a A_{PCB}=(2.5 22 cm)² with 610 g/m² copper cladding. By contrast the junction to case impedance is only 1° C./W.

| Package | R_{θ} | Tⱼ(max) | Ta | ΔT | P(max) (W) |
|---|---|---|---|---|---|
| D2PAK | 18.0° C./W | 90° C. | 25° C. | 65° C. | 3.6 W |
| DPAK | 22.2° C./W | | | | 2.9 W |
| SOT-223 | 27.2° C./W | | | | 2.4 W |
| SOP-8 | 33.0° C./W | | | | 2.0 W |
| TSOP-6 | 47.3° C./W | | | | 1.4 W |
| TSSOP-8 | 60.9° C./W | | | | 1.1 W |

https://electronics.stackexchange.com/questions/103166/how-does-power-dissipation-for-surface-mount-components-work

As explained in the prior paragraph, 24V is an especially beneficial voltage for delivering significant power levels. Applications include residential, commercial, transportation, and mobility energy. By delivering power at 24V, currents are reduced six-fold from that of 4V lithium ion battery based systems when delivering the same rated power at a higher voltage. Moreover, at 24V a 4 mΩ power MOSFET can conduct up to 22 A without exceeding the 2 W package power limit, thereby delivering up to 530 W to a load.

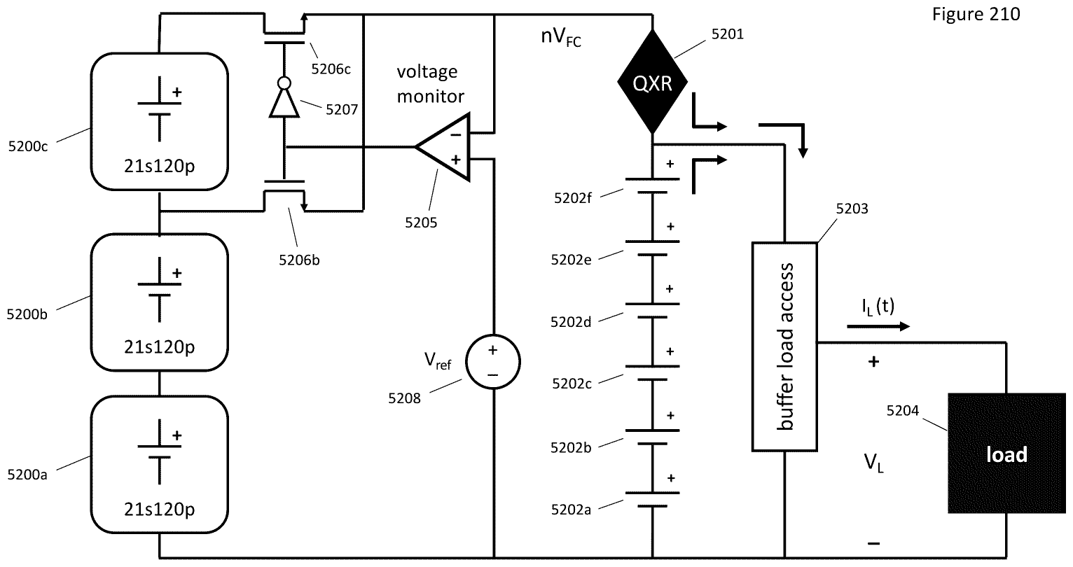

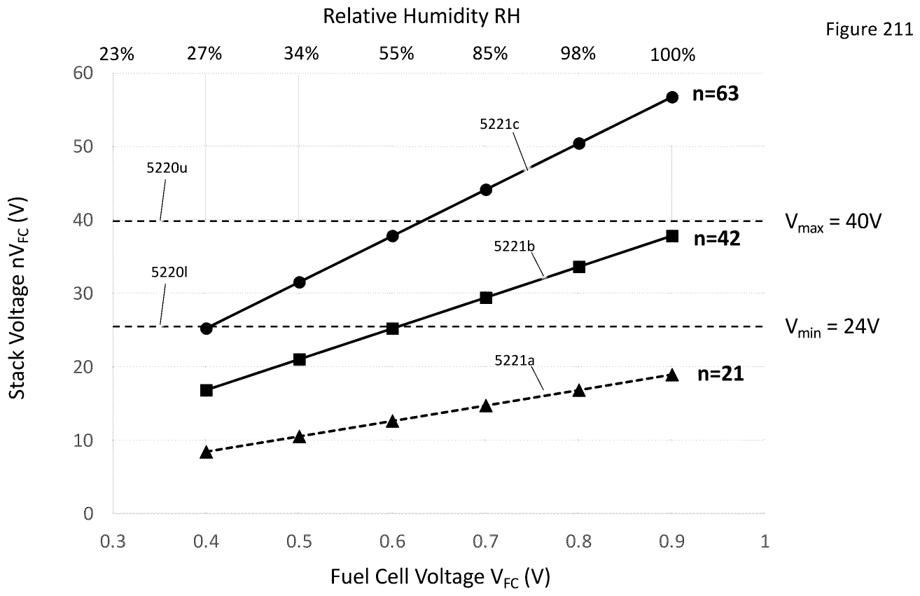

An exemplary circuit, FIG. 210 illustrates a stack of three series connected fuel-cell modules 5200a, 5200b, and 5200c, each comprising a fixed topology of 21s120p. Electrical characteristics of the n=21 module ranges in voltage from 8.4V≤nV_{FC}≤19V shown by curve 5221a in FIG. 211 corresponding to single fuel cells voltages of 0.4V≤V_{FC}≤0.9V. At a current density of 200 mA/cm² the fuel cell stack is able to deliver up to 24 A. The modules are dynamically reconfigurable using a power multiplexer comprising MOSFETs 5206b and 5206c drive out of phase by inverter 5207 and voltage monitor 5205 compared to V_{ref} reference voltage 5208.

Fuel cell stacks 5200a and 5200b are hardwired in series to produce a fixed cell configuration comprising n=42 as shown by curve 5221b. In operation whenever voltage monitor 5205 detects the fuel stack voltage nV_{FC} falls below V_{ref} reference voltage 5208, pass transistor 5206b is turned off and pass transistor 5206c is turned on increasing the fuel cell stack by 21 cells so that n=63. By increasing the stack to n=63, the voltage transfer function transitions from n=42 curve 5221b to n=63 curve 5221c.

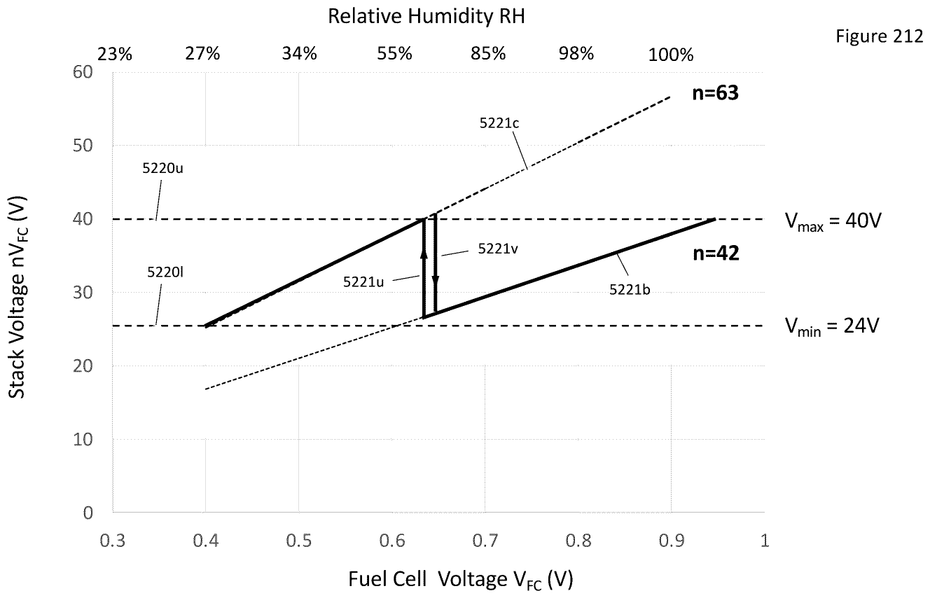

As shown in FIG. 212, by dynamically reconfiguring the array and switching the value of reference voltage of 5208, the output voltage nV_{FC} of the dynamic fuel cell stack can be maintained in a predefine range, in this example between Vₘₐₓ=40V shown by line 5220u and Vₘᵢₙ≈25V shown by line 52201. As such the unregulated output voltage of the buffered fuel cell is constrained between 25V≤nV_{FC}≤40V. Reference voltage 5208 includes hysteresis where negative transition 5221v from curve 5221c to curve 5221b differs from positive transition 5221u from curve 5221b to curve 5221c. Referring again to the schematic in FIG. 436, QXR charge transfer regulator 5201 charges a string of six lithium ion cells 5202a to 5202f. The series battery array is connected to load 5204 through a protection circuit referred to as BLA buffer load access 5203. Each cell is contained in battery holder 5258 with contacts applying pressure to eliminate contact resistance without the need to solder wires to the battery terminals which risks battery damage.

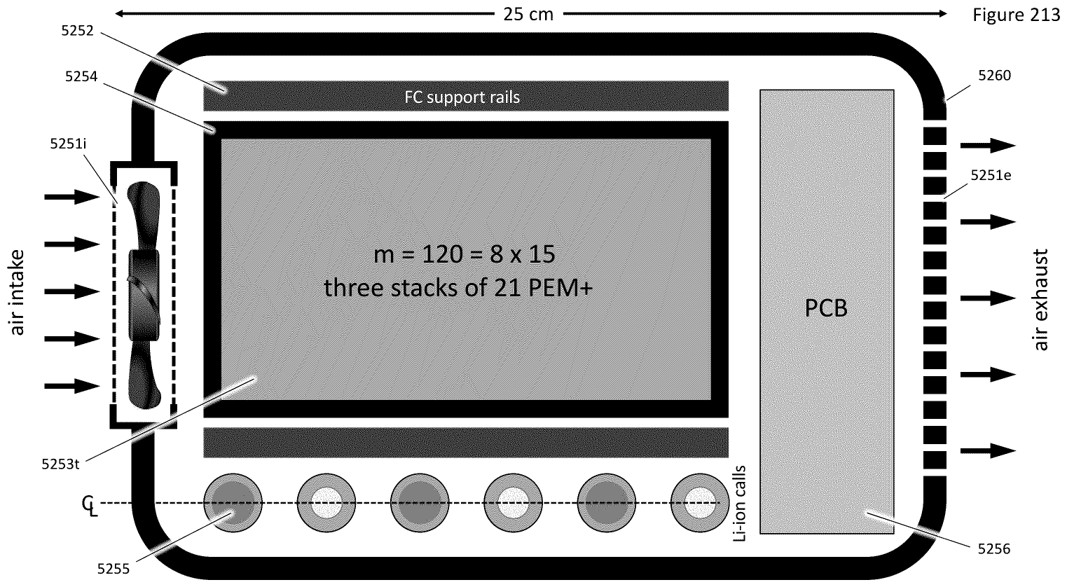

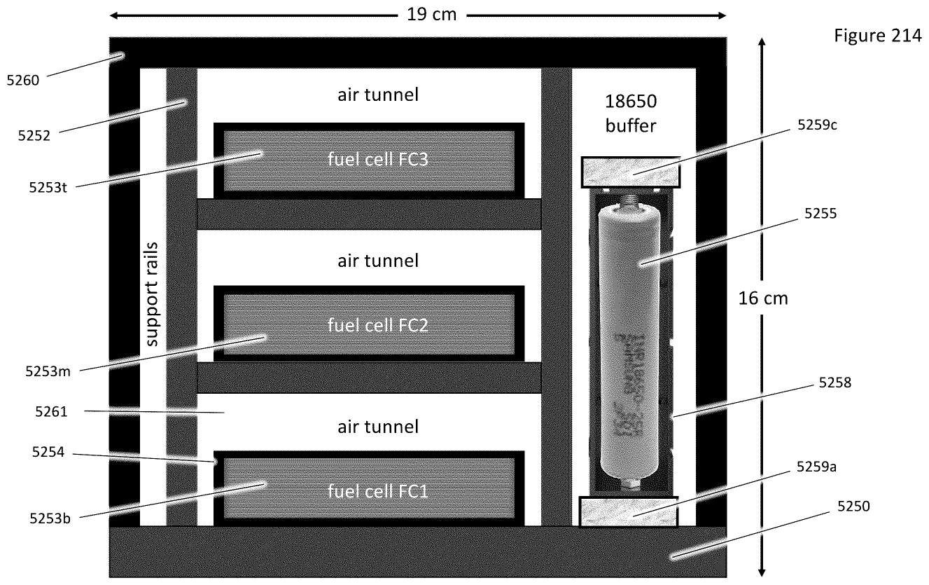

An exemplary schematic representation of a 24V iBFC module is shown in the top view of FIG. 213 and in endwise view FIG. 214 includes top, middle, and bottom 21s120p fuel cells 5253t, 5253m, and 5253b surrounded on two sides by support rails 5252 which may include electrical and gas conduits, together mounted on a base plate 5250. The base plate connects electrical connections and gas ports to an under chassis (not shown). It also includes a series of series connected 18650 Li-ion cells 5255 connected by conductive straps 5259a and 5259c. The entire module is enclosed in encasement 5260 forming wind tunnels 5261 to convectively cool fuel cell microstacks 5253t, 5253m, and 5253b. The forced-air powered by fan 5251i, transiting the length of the module, and exiting through grating 5251 located at opposite ends of 24V iBFC module enclosure 5260, delivers convective surface cooling along the exposed surfaces of the three fuel cell microstacks 5253t, 5253m, and 5253b.

The forced-air convective surface cooling of the microstacks occurs in addition to internal fuel cell cooling provided by cathode air flow for oxygen delivery or by any dedicated fluid cooling channel carried in tripolar plates internal to each fuel cell stack. Additional cooling may also be achieved by thermal conduction from the bottom surface of each fuel cell microstack in thermal contact with the metallic frame forming support shelves within the module

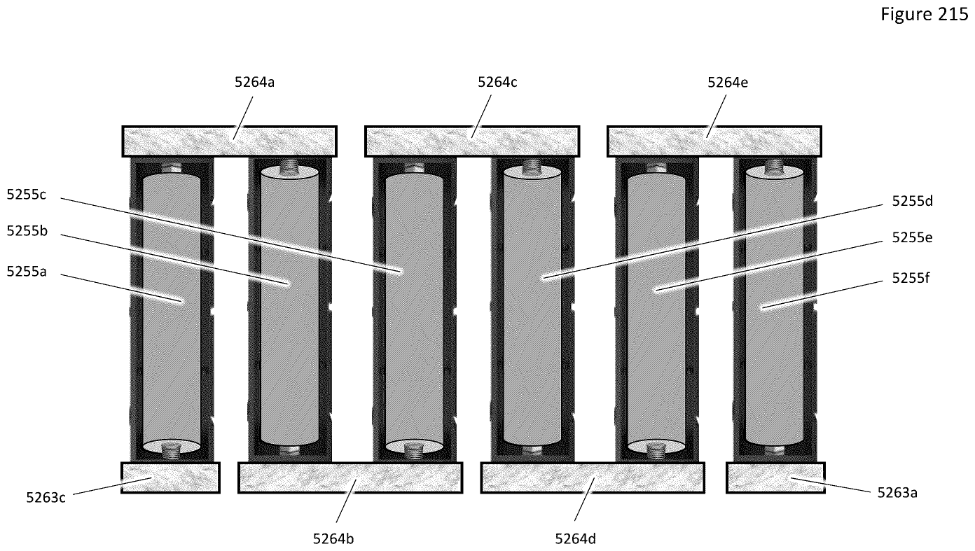

The electrochemical buffer cells comprising Li-ion, Na-ion, or other chemistries located along cutline CL identified in FIG. 213 are shown in side view in FIG. 215 comprising buffer cells 5255a through 5255f. Electrical contacts include cathode and anode terminals 5263c and 5263a along with conductive straps 5264a through 5264e. As indicated the Li-ion cells are connected alternating in antiparallel orientations, i.e. cathode up, anode up, cathode up, etc. where the conductive straps create a series connected stack. In the example shown, the cells comprise a single series string forming a 6s1p cell array.

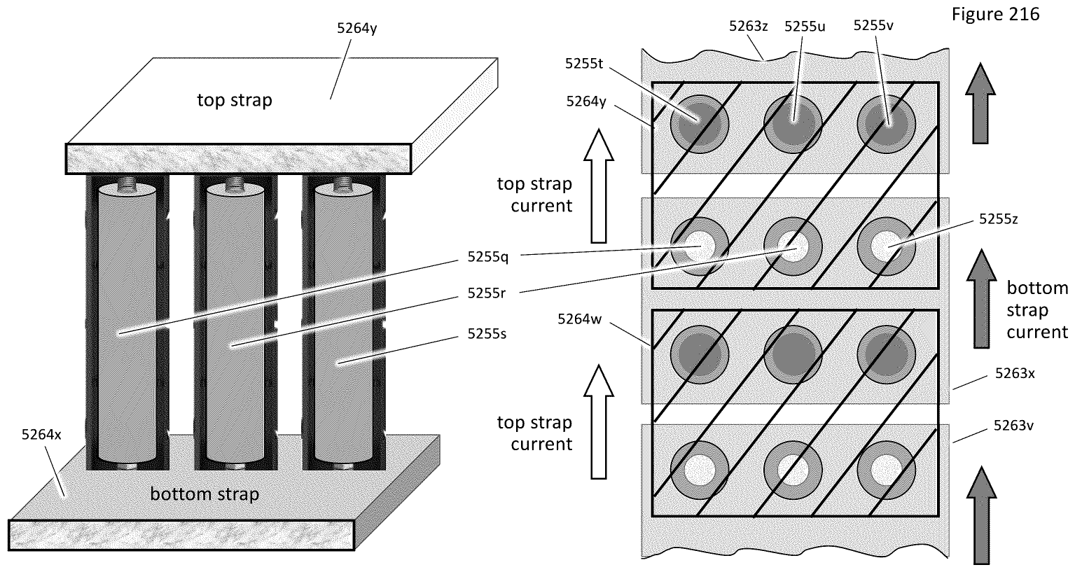

The array can be expanded to form a battery buffer comprising two series parallel strings 6s2p, three parallel strings 6s3p, four parallel strings 6s4p or more. In the case of parallel connected cells, it is beneficial to metallically strap the cathodes and anodes of parallel cells to ensure they maintain the same voltages. Referring to FIG. 216, an 24V array of buffer cells form a series-parallel buffer having a topology 6s3p comprising a series string of six 3p connected cells, only four of which are shown.

As shown, the array includes bottom metallic straps 5263v, 5263x, top metallic straps 5264w and 5264y connecting an array of electrochemical cells in alternating antiparallel orientations. For example, parallel cells 5525q, 5525r, and 5525s are oriented with anode-up cathode-down while parallel cells 5255t, 5255u, and 5255v are positioned cathode-up anode-down.

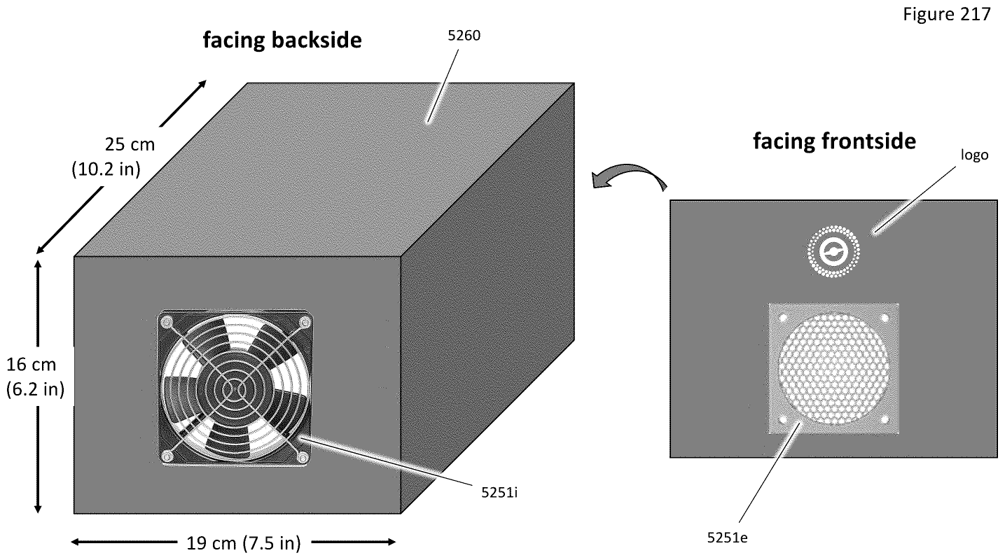

FIG. 217 illustrates the exterior view of encasement 5260 showing air intake fan 5251i and air exhaust grill 5251e. Exemplary dimensions of the 24V module comprise 19 cm (7.5 in) wide×16 cm (6.2 in) tall by 25 cm (10.2 in) deep comprising a total of 7,600 cm³. At 500 W, the module has a power density of 65 mW/cm³. With proper cooling, power can be doubled to 1 kW or 130 mW/cm².

The specifications of an exemplary 24V module may comprise two ratings—one for liquid cooling, the other for air cooling. Using liquid cooling the ratings are determined by electrical limitations while air cooled operation is primarily determined by thermal considerations. Fully charged voltage maintains a 24V constant voltage so long that the discharge rate is less than the fuel cell 20A output capability. Minimum output voltage of the disclosed module is 18V with the majority of stored energy at or above 21V.

| Specification | Typ Value | | Condition |
|---|---|---|---|
| Output Voltage | 18 V to 25 V | | RH > 27%, 25 V ≤ nV_{FC} ≤ 40 V, dynamic |
| Output Current, Continuous | 20 | A | I_{FC}/A = 167 mA/cm², m = 120 |
| Output Current, Power On Demand | 23 A to 26 A | | Specified at 1 C to 2 C rates |
| Output Current, Transient | 50 | A | 10 C transient rate |
| Power Output | 500 | W | Liquid cooled, three FC stacks |
| Efficiency | 75% | | |
| Power Dissipation | 125 | W | |
| Power Output | 250 | W | Air cooled per FC stack, three FC stacks |
| Thermal Impedance | 1.5° | C./W | Flow rate FR > 2 m/s |
| Maximum FC Temp | 70° | C. | Temp rise per stack 21 W(1.5° C./W) = 32° C. |
| Ambient Temp | 25° | C. | T_{FC} = 25° C. + 32° C. = 57° C. |
| Power Dissipation | 63 | W | |

As described, a buffered fuel cell provides power on-demand at any humidity, but loses its ability to fully refresh itself for any humidity level below 27%. Current output is 20 amps continuous with real-time refresh. On demand power ranges from 23 A at a 1C net discharge rate to 26 A at a 2C rate. Transient power can exceed (I_{FC}+I_{buf})=50 A where the I_{buf} current is at a 10C transient rate. The iBFC modules may be connected in series or in parallel to deliver greater power.

24V Microstack Design. Thermal design considerations play an important if not critical role in architecting and fabricating a reliable fuel cell. As described previously, one way to reduce internal heating in a fuel cell is to control overdrive, i.e. matching the unregulated output voltage of a fuel cell stack to the buffer it is intended to charge. Rather than employing a voltage regulator to control a fuel cell's output voltage, the inventive method disclosed herein uses a dynamically reconfigurable fuel cell stack to produce a quasi-constant voltage, importantly without regulation. By eliminating the need for a large high-current voltage regulator, an additional source of power dissipation and heat generation is eliminated.

In principle, a dynamic fuel cell changes the number of membranes electrically connected in series within a fuel cell stack to adjust for changing conditions of temperature, humidity, and current and their influence on output voltage. While using switches to include or remove individual membranes from a fuel cell's series circuit may benefit a six-volt array, in a 24V buffered fuel cell each individual membrane represents less than 3% of the output voltage. In a 400V stack, each layer contributes as little as 0.1% to the stack voltage.

So although dynamically reconfiguring individual ionomeric membranes may reduce waste heat, such an solution is costly and unwieldy to implement on a layer-by-layer basis, especially in higher voltage containing dozens or hundreds of connected layers. Moreover producing a spectrum of custom fuel cells of varying layer counts is inefficient and costly manufacturing. Instead it is advantageous to assemble a fixed-height fuel cell microstack reusable in a wide spectrum of fuel cell designs as a standard. In operation, one or more microstacks are dynamically switched in and out of the fuel cell series circuit to adjust the fuel cells output voltage.

Selection of the number of membranes in the microstack represents a compromise between too few layers having insignificant impact in controlling losses and requiring too many μstack assemblies and too many layers concentrating heat and not limiting the voltage range. As shown previously in FIG. 436, one possible implementation comprises three 21-layer μstacks which in operation functions with either 42 or 63 layers thereby limiting the total voltage between 24V to 43V. The disadvantage of this design is each μstack comprises 21 layers generating heat.

One solution to reduce heating is to divide the fuel cell into more μstacks each with fewer layers. For example by reducing the number of layers from 21 membranes down to 12 layers the heat within the μstack is reduced by 43%. Compared to a single 63-layer stack the electrochemically heat generated within a 12-layer fuel cell stack is reduced by 80%.

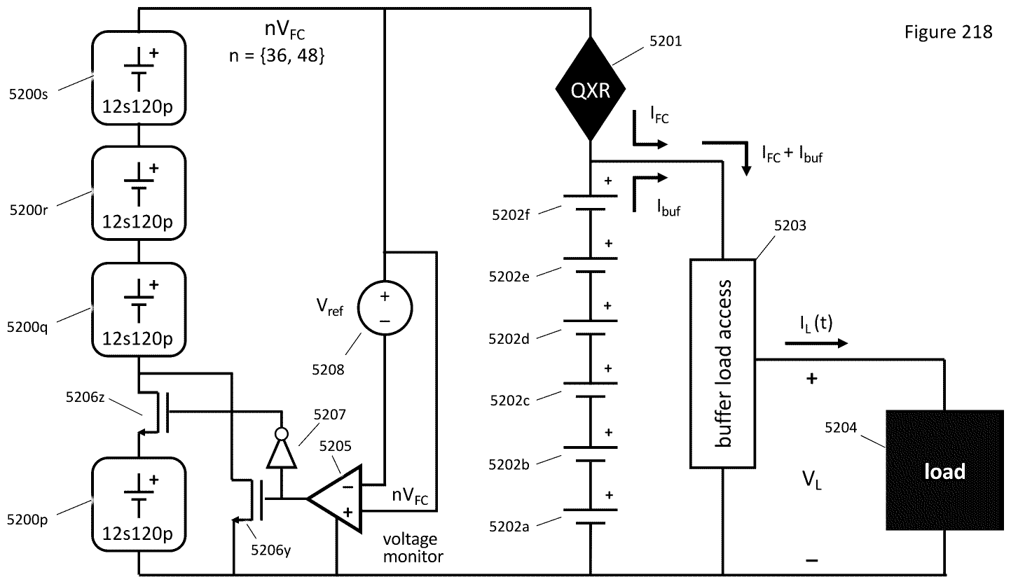

FIG. 218 illustrates one fuel cell implementation comprising four 12-layer μstacks 5200p to 5200s selectable as either a 36-or-48 layer fuel cell stack. Accordingly the dynamic fuel cell design is referred to as a n={36, 48} iBFC. In operation, the number of conducting μstacks depend on the state of voltage monitor 5205. The voltage monitor 5205 comprises a comparator which compares the aggregate fuel cell stack voltage V_{FC} to reference voltage V_{ref}. In the case where V_{FC}<V_{ref}, the comparator output of the voltage monitor 5205 is in its low state, i.e. a digital ‘0’ or 0V, turning off bypass MOSFET 5206y.

Concurrently inverter 5207 turns on pass-through MOSFET 5206z connecting μstack 5200p in series with μstacks 5200q to 5200s resulting in a fuel cell stack 48s120p. In the case where V_{FC}>V_{ref} the comparator output of the voltage monitor 5205 is in its high state, representing a digital ‘1’ such as +5V turning on bypass 5206y and disabling pass-through MOSFET 5206z. The resulting network is a series connection of μstacks 5200q to 5200s excluding μstack 5200p resulting in a fuel cell stack 36s120p.

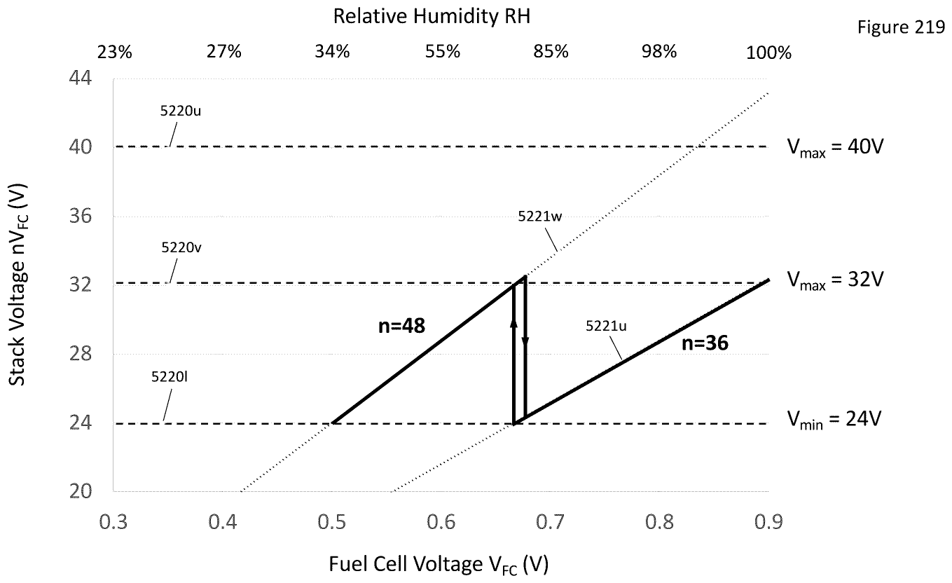

FIG. 219 illustrates the resulting transfer function of the n={36, 48} iBFC as described. In the high humidity case where V_{FC}>0.67V/layer, the fuel cell functions as a n=36 stack following curve 5221u between a maximum voltage 5220v of Vₘₐₓ=32V down to a minimum voltage 52201 of Vₘᵢₙ=24V. At this lower voltage, the dynamic fuel cell performs a state change increasing the array by one 12-layer μstack from n=36 to n=48 increasing the fuel cell stack back to the maximum voltage 5220v of Vₘₐₓ=32V.

For all voltages V_{FC}<0.67V the fuel cell follows the curve 5231w. At VF_{C}=0.5V/layer, the stack voltage drops to minimum voltage 52201 of Vₘᵢₙ=24V corresponding to a lower humidity level of RH=34%. As such a two-state dynamic fuel cell comprising four 12s120p μstacks is able to operate from 34%-to-100% relative humidity over a membrane voltage range from 0.5V-to-0.9V while maintaining a fuel cell stack output voltage bounded between 24V-to-32V.

This performance is contrasted to a fixed n=48 fuel cell following the dotted line extension of curve 5221w which is limited by a 40V maximum to 24V minimum by humidity within the range of 34% to 98.4%. At 100% humidity the fixed array voltage will rise to 43V exceeding the specific maximum value. Exceeding 40V has several disadvantages including (i) it requires UL safety certification as a ‘high’ voltage system, (ii) it requires the use of more costly less efficient power MOSFETs, (iii) it generates more heat in the fuel cell, and (iv) it reduces the efficiency of the charge transfer regulator QXR controlling the energy transfer from the fuel cell to the buffer stack.

For example because the maximum voltage exceeds 40V, charging a buffer stack to 24V using linear charging is only η=24V/40V=60% efficient, meaning forty percent of the power transferred is burned in the charger as heat. While excessive power loss can be ameliorated by using a switching charger, the transient current capability of a fuel cell is limited by its high internal impedance. By minimizing the maximum voltage differential ΔV=(Vₘₐₓ−Vₙₒₘ) between the fuel cell stack and the buffer, charger inrush currents are also minimized, reducing the required current rating of the charger devices.

As stated previously aside from better managing transient currents, another unique benefit of the μstack architecture made in accordance with this invention is heat dissipation. By spreading the membrane generated heat losses across four μstacks, the concentration of heat losses is reduced by 75%.

Wide Humidity 24V Fuel Cells. To electrically expand the operational range of a fuel cell to function at lower humidity levels, a dynamic buffered fuel cell made in accordance with this invention comprises additional series μstacks connected into the series stack only under extremely dry conditions. These extra μstacks are disconnected at higher humidity conditions to avoid producing over-voltages. To tailor a dynamic fuel cell to cover the widest humidity range, a number of μstacks can be connected in series in varying numbers or combinations.

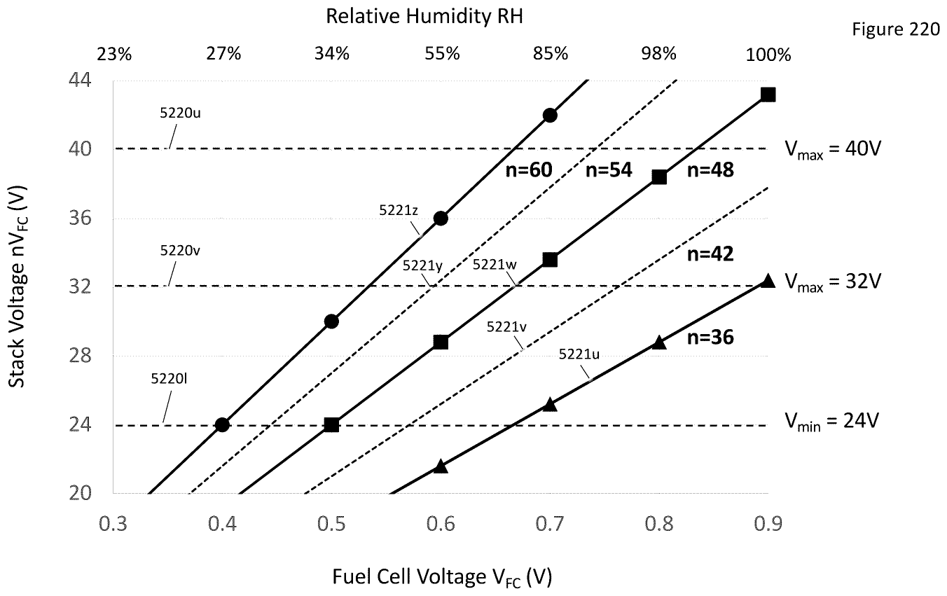

As shown in FIG. 220, the conduction characteristics for various combinations of twelve-layer μstacks shown by solid lines 5221u, 5221w, and 5221z corresponding to membrane counts of n=36, n=48, and n=60 respectively. Curves based on a lowest common denominator of six layers also include n=42 curve 5221v and n=54 curve 5221v. For maximum flexibility, six and twelve layer μstacks can be used in combination, while still only manufacturing two μstack variants. In most cases however, combining 12s120p μstacks is sufficiently versatile to accommodate a wide a range of applications. Of the curves shown, three configurations exceed the 40V maximum voltage limit 5220u within the specified range of fuel cell voltages. Specifically curve 5221w exceeds 40V when V_{FC}≥0.83V/layer or RH≥98.6%, curve 52214 exceeds 40V when V_{FC}≥0.74V/layer or RH≥90%, and curve 5221z exceeds 40V when V_{FC}≥0.67V/layer or RH≥73%. Notice the relationship between humidity RH and the single layer fuel cell voltage V_{FC} exhibits a non-linear characteristic. Although the relationship is chemistry specific, in the example shown the humidity variation is greatest in the range where 0.6V<VFC<<0.7V.

Similarly all curves shown drop below the minimum voltage 52201 of 24V within the specified range. Specifically the five curves 5221u, 5221v, 5221w, 5221y, and 5221z reach minimum voltage 52201 at per layer voltages of 0.67V, 0.57V, 0.5V, 0.44V, and 0.4V respectively, roughly corresponding to relative humidity values of 78%, 50%, 34%, 30%, and 27%. Clearly the higher membrane counts of n≥48 layers work at lower membrane voltages and humidity levels but exhibit too much voltage at normal humidity ranges. Conversely fuel cells where n≤42 avoid the overvoltage problem but can't function in dry air when RH 50%. To overcome this conflict, the dynamic buffered fuel cell made in accordance with this invention employs a switched array of fuel cell μstacks. This method is much more flexible and less costly than adjusting the number of active layers within one fuel cell stack.

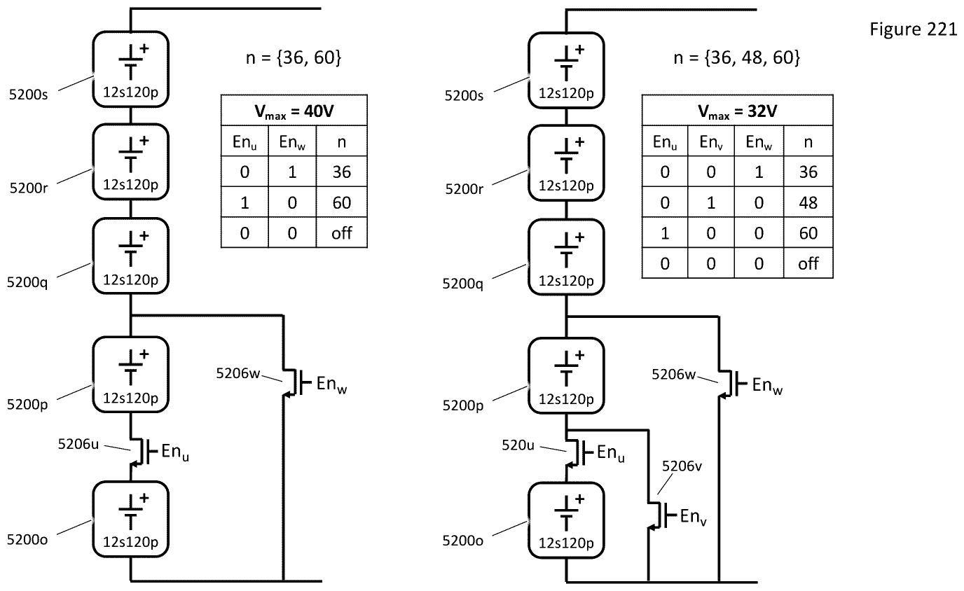

As shown in FIG. 221, fuel cells comprising five 12-layer μstacks can be combined in a variety of versatile ways. For example, in the dynamic FC construct n={36,60} shown on the left, a series of μstacks 5200o through 5220s are connected in series with a series MOSFET switch 5206u connected the network branch containing series μstacks 5200o and 5200p with bypass MOSFET switch 5206w. The enable gate input for series MOSFET switch 5206u is labelled as Enᵤ while the gate input for bypass MOSFET switch 5206w is labelled as En_{w}.

As depicted for the dynamic FC labelled n={36,60} shown on the left, the corresponding truth table contains three allowed states. In the case (Enᵤ, En_{w})=(0, 0) both transistors are in their open off state and the fuel cell stack is cutoff. When signals (Enᵤ, En_{w})=(0, 1) pass-transistor MOSFET 5206u is cutoff disconnecting μstacks 5200o and 5200p from the stack but bypass transistor 5206w is activated. The resulting fuel cell comprises a fuel cell stack where n=36. When signals (Enᵤ, En_{w})=(1, 0) bypass transistor 5206w is disabled but pass MOSFET switch 5206u is active inserting μstacks 5200o and 5200p into the network whereby n=60. As such the fuel cell stack may comprise an array where the number of membranes ‘n’ may comprise 60, 36 or zero (off).

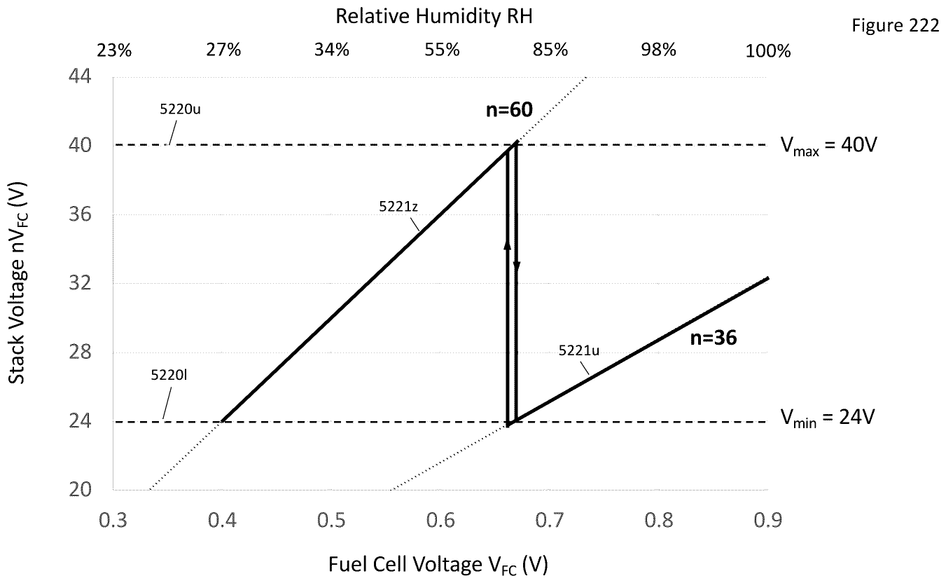

The output characteristics of this two-state fuel cell stack is illustrated in FIG. 222. As shown when fuel cell voltage V_{FC}≥0.67V corresponding to relative humidity levels exceeds 80% the fuel cell stack comprises a series connection of three μstacks. This configuration where n=follows curve 5221u spanning the voltage range from 32V down to a minimum value 52201 of Vₘᵢₙ=24V. For fuel cell voltage V_{FC}<0.67V corresponding to relative humidity levels below 80% the fuel cell dynamically switches to n=60 corresponding to curve 5221z. The resulting conduction characteristics span the voltage range from the maximum value 5220u where Vₘₐₓ=40V to a minimum value 52201 of Vₘᵢₙ=24V. This design is advantageous in that it function down to a fuel cell voltage of 0.4V/layer corresponding to RH=27% but exhibits a peak stack voltage of 40V.

In order to minimize the maximum voltage of the five μstack array, an additional state must be added. Returning to FIG. 447, in the configuration n={36, 48, 60} a three MOSFET switch network is used to control a FC μstack network by three digital signals: En_{w} controlling the gate of bypass MOSFET switch 5206w, Enᵥ controlling the gate of bypass MOSFET 5206v, and Enᵤ controlling the gate of series pass MOSFET 5206u. Of the various combinations articulated in the corresponding three-input truth table, only four combinations are allowed, one of which is the degenerate case (Enᵤ, Enᵥ, En_{w})=(0, 0, 0) when the fuel cell is disconnected.

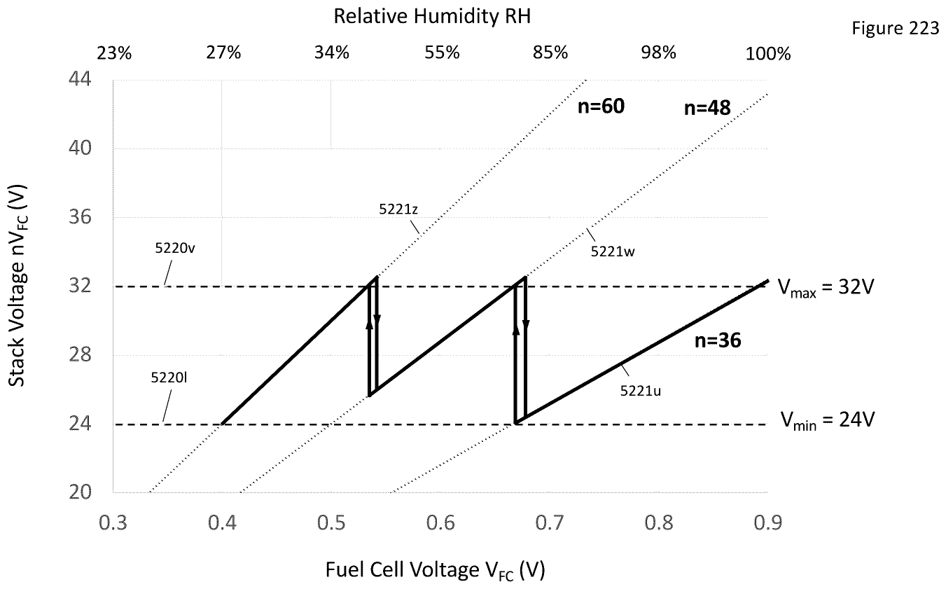

In the combination where input (Enᵤ, Enᵥ, En_{w})=(0, 0, 1), only bypass MOSFET switch 5206w is active whereby the fuel cell comprises μstacks 5200q, 5200r, and 5200s and the aggregate fuel cell stack comprises n=36 layers. In the combination where input (Enᵤ, Enᵥ, En_{w}) 4=(0, 1, 0), only bypass MOSFET switch 5206w is active whereby the fuel cell comprises four μstacks, namely 5200p, 5200q, 5200r, and 5200s, and n=48. Lastly, In the combination where input (Enᵤ, Enᵥ, En_{w})=(1, 0, 0), only pass-through MOSFET switch 5206wu is active comprising all five μstacks for a net fuel cell stack comprises n=60. The resulting characteristics are shown in the curves of FIG. 223, where operation occurs in three bands, namely
V_{FC}≥0.67V corresponding to a relative humidity range RH 80% where n=36 and the curve 5221u maintains operation within a 8V span from Vₘₐₓ=32V to Vₘᵢₙ=24V;
0.67V>V_{FC}≥0.53V corresponding to a relative humidity range 80%>RH 39% where n=48 and the curve 5221w maintains operation within a 6V span from Vₘₐₓ=32V to Vₘᵢₙ13=26V;
0.53V>V_{FC}≥0.4V corresponding to a relative humidity range 39%>RH 27% where n=48 and the curve 5221z maintains operation within a 8V span from Vₘₐₓ=32V to Vₘᵢₙ=24V;
   In a fourth band where V_{FC}<0.4V and relative humidity RH≤27%, the voltage of fuel cell stack falls below Vₘᵢₙ=24V and is unreliable at charging the buffer stack to full charge. This does not mean that no charging is possible but the minimum buffer voltage is limited to 3V/cell×6 cells or 18V to prevent over-discharging of Li-ion cells. As such limiting buffer charging between the fuel cell output voltage and 18V. The following table compares 24V fuel cell modules comprised of dynamic series-connected μstacks to that of a single fuel cell:

| Parameter | Fixed Array | Dynamic Array | |
|---|---|---|---|
| FC topology | fixed, n = 48 | n = 36, 48 | n = 36, 48, 60 |
| Number of stacks | 1 | 3, 4 | 3, 4, 5 |
| Target voltage Vₙₒₘ | 24 V | 24 V | 24 V |
| Voltage range (over RH range) | 19 V to 43 V | 24 V to 32 V | 24 V to 32 V |
| Humidity range | 34% to 98.4% | 34% to 100% | 27% to 100% |
| Self heating | concentrated (+6X) | reduced (−75%) | reduced (−85%) |
| Regulator for V ≥ Vₙₒₘ | Buck converter | none required | none required |

Advantages of the dynamic fuel cell using a switched array of FC μstacks made in accordance with invention include the following:
maintains a minimum output voltage of 24V over a wide range of operating conditions
limits the maximum voltage of a fuel cell stack to a defined voltage such as 40V or 32V
operates over a wide range of humidity levels from 100% down to 34% extendable down to 27% with a minor increase in component count
eliminates the need for a Buck or Buck-boost converter to charge a battery stack or buffer
reduces heating within a fuel cell by up to 80%

The enumerated advantages of a dynamic fuel cell comprising a switched array of FC μstacks over conventional fuel stack designs are significant in reducing heat, expanding the operating range, and improving reliability. No similar dynamic fuel cell design exists in the literature or in the market.

Heavy Duty BufferedFuel Cell. Another consideration of a fuel cell is instantaneous power output, referred to herein as “on-demand power”. The ability of a buffered fuel cell to deliver high currents to a load depends on a number of factors namely:
the voltage differential between the fuel stack voltage and the voltage of the electrical load being powered which is a function of the number of membranes per μstack, the number of μstacks connected in series, and ambient conditions such as temperature and humidity;
the transient and steady-state current demand of the load;
the thickness and composition of the ionomeric membrane;
the active area of the ionomeric membranes A_{FC};
the membrane current density I_{FC}/A_{FC} e.g. 200 mA/cm²;
current limiting imposed by the charge transfer regulator (QXR);
the number of parallel strings of battery buffer cells; and
parasitic resistances such as pass-through MOSFETs in the fuel cell array and access MOSFETs in the buffer load access circuit.

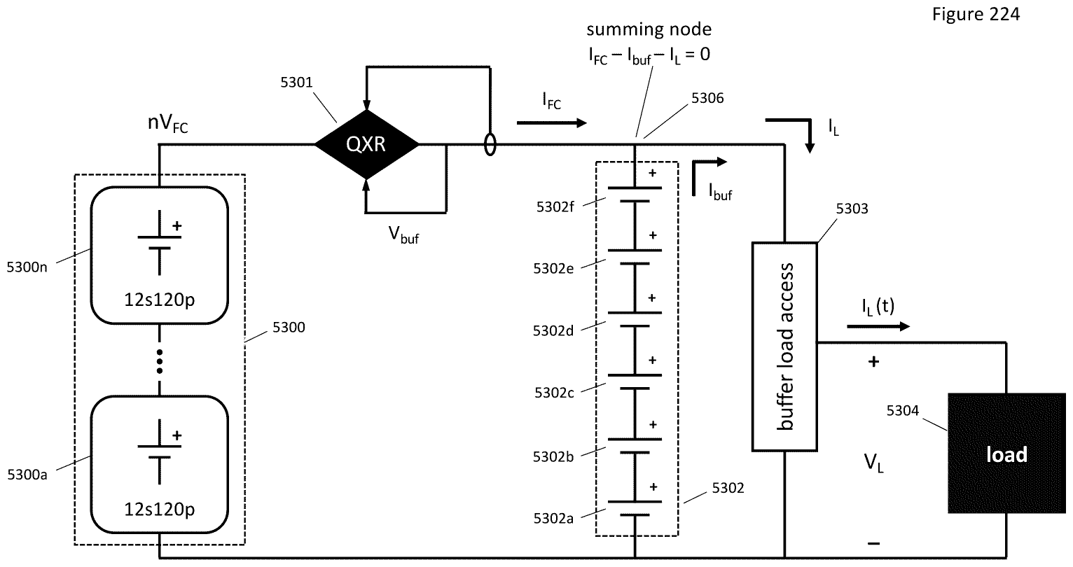

To analyze the relative contributions of these electrical elements in determining the on demand power capability of a given design buffered fuel cell made in accordance with this invention, the power-switch-load topology must be carefully considered. As shown in FIG. 224, a topological diagram of an iBFC comprises a series string of ‘n’ μstacks 5300a through 5300n, collectively as fuel cell stack 5300 which may be static or dynamically reconfigurable; a charge transfer regulator QXR 5301 controlling energy flow out of the fuel cell stack; an electrical buffer in this example comprising a series array of lithium ion batteries 5302a through 5302f, collectively comprising buffer 5303; and buffer load access (BLA) circuit 3203 protecting the electrochemical buffer from damage potentially caused by load 5304.

In operation, charge transfer regulator QXR 5301 employs both voltage and current feedback to control the current flowing between the fuel cell stack 5300 and buffer 5302. The current feedback performs two tasks (i) to prevent excessive current from being drawn from the fuel cell stack 5300 causing the stack voltage nV_{FC} to sag or collapse, and (ii) preventing excessive charging current to flow into buffer 5302 potentially damaging or overheating the electrochemical cells. Concurrently the buffer load access circuit 5303 protects the buffer 5302 from an electrical load 5304 by limiting the peak current output during discharging and preventing the buffer from over-discharge, i.e. when its voltage drops so low that damage can occur to the battery's internal separator film.

As shown the current I_{FC} flowing out of the fuel cell and through QXR is summed with the buffer current I_{buf} and delivered to the electrical load through the buffer load access circuit as load current I_{L} whereby

$${I}_{L} = {I}_{FC} + {I}_{buf}$$

While the fuel cell output current I_{FC} and the iBFC's load current I_{L} are both positive numbers, the polarity of the buffer current I_{buf} may be positive or negative—positive during discharging, negative during recharging. From the above equation it follows that during discharge when the buffer current is positive, the load current can exceed the fuel cell's output, i.e. I_{L}>I_{FC}. Conversely when the buffer is charging and fuel cell current I_{buf}<0 is negative, a portion of the fuel cell's current is diverted from the load to the buffer reducing the power available to an electrical load.

The role of the buffer cell is smooth out the current fluctuations by supplying extra current to a load when needed and recharging itself when the energy supply exceeds demand. Since periods of high demand are limited in duration, e.g. less than 10 seconds, the transient current rating of a heavy-duty buffered fuel cell (HD iBFC) can greatly exceed its continuous current rating. The expanded operating range however requires a change in the topological circuit for the HD iBFC compared to the standard buffered fuel cell described herein.

It should be noted unlike in conventional battery packs where a battery disconnect switch (BDS) prevents its batteries both overcharging and over-discharging, in a buffered fuel cell protection the responsibility for protecting the buffer cells is split between the charge transfer regulator and the buffer load access circuit. As shown, charge transfer regulator 5301 controls the charging rate and prevents overcharging of the buffer 5302, while the role of the buffer load access (BLA) 5303 is to prevent over-discharging of the buffer and over-discharging the battery cells. The BLA also protects against reverse charging where the electrical load acts as a power source and attempts to charge the buffer by having its load current flow into rather than out of the output of the buffered fuel cell.

The necessity of the split protective functions is obvious topologically. The charge transfer regulator 5201 can only control energy flowing from the fuel cell stack 5300 into battery buffer 5302 because it is interposed between the two. It has no ability to protect the buffer 5302 from electrical load 5304 because it is not located between them. Protecting buffer 5302 from the load is entirely the purview of the buffer load access circuit. Conversely, because the buffer load access circuit 5303 is interposed between load 5304 and buffer 5302, it has no control over charging of the buffer from fuel cell 5300. This distinction is completely different from the battery disconnect switch in a lithium ion battery pack which integrates all cell protection functions aside from charging and cell balancing.

As shown, the conventional buffered fuel cell contains a summing node 5306 where the inbound and outbound currents of the fuel cell stack, the buffer, and the load converge. Ostensibly, in the absence of any interference from charge transfer regulator QXR 5301 or buffer load access BLA 5303 circuitry, under normal operation the three blocks of the standard iBFC shown in FIG. 450, namely fuel cell stack 5300, buffer 5302, and load 5304 are essentially wired in parallel. In normal iBFC operation the load 5304 draws current from the buffer 5302, and the fuel cell 5300 recharges the buffer 5302 of the charge it lost.

The net function of the disclosed iBFC s therefore is that of a self recharging battery where the load is completely disconnected from and unaware of the presence of the fuel cell. Likewise the fuel cell never sees the current demand of the load or even aware of its power demands except that it detects when the buffer voltage decays with a lower state-of-charge (SoC). While this architecture of self recharging battery is essentially fool proof from a user perspective, it suffers one major drawback—it cannot invoke extra current capacity of the fuel cell to help supply high current load transients because the charge transfer regulator prevents it from doing so.

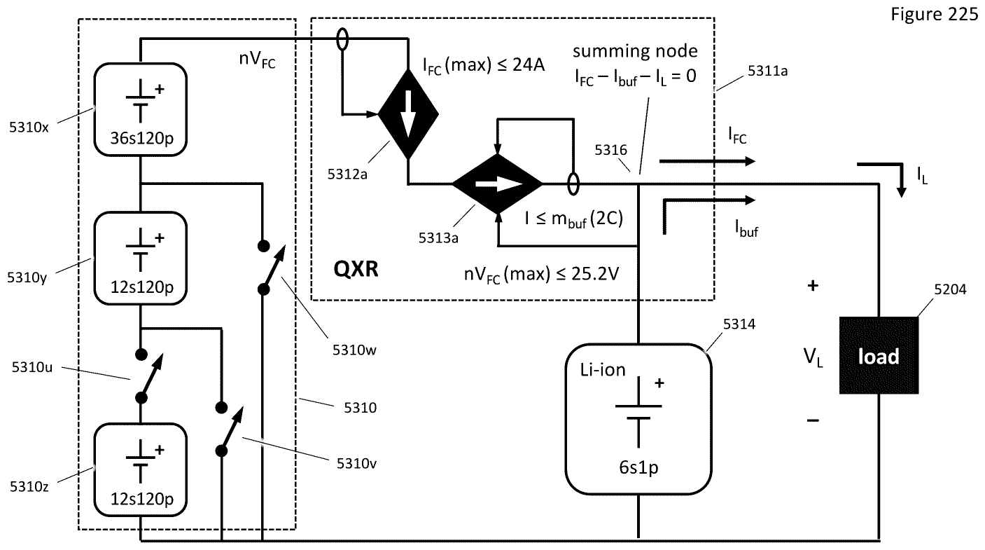

This limitation is better understood by considering the standard buffered fuel cell disclosed herein in the schematic form of FIG. 225. For simplicities sake, the buffer load access circuit is removed, the charge transfer regulator 5311a is expanded into its constituent subcomponents and the fuel cell is illustrated as a dynamic topology containing three μstacks and three switches. More specifically 36s120p microstack 5310x is connected in series with two 12s120p microstacks 5310y and 5310y with a single intervening switch 5310u. The switch is likely implemented using a low voltage power MOSFET such as a DMOS or trench DMOS as a discrete component or integrated into an integrated circuit. Additional bypass switches include 5310w and 5310v. In practice, 36s120p microstack 5310x actually comprises three series connected μstacks each using an identical a 12s120p μstack design. In this manner the fuel cell stack comprises five 12s120p μstacks selectable in combinations of n={0, 236, 48, 60} layers.

If all three switches are open, no complete circuit path exists in the fuel cell and the device is off. If bypass switch 5310x is conducting and the other switches are off then all the power is generated in 36s120p μstack 5310x and n=36. If bypass switch 5310v is conducting and the other switches are off then all the power is generated in the series connected 36s120p μstack 5310 and 12s120p μstack 5310y and n=48. If both bypass switches are open and pass-through switch 5310u is closed then the all three microstacks 5310x, 5310y, and 5310z are conducting whereby n=60.

Regardless of the voltage nV_{FC} of the dynamic stack the entirety of the stack's current is fed into charge transfer regulator QXR 5311a comprising two competing dependent current regulators—current source 5312a designed to protect the fuel cell from excessive current and voltage sag, and current source 5313a designed to properly charge the buffer cells 5314. The current source 5313a terminates into the aforementioned summing node 5316 along with buffer 5314 and load 5204.

To reiterate the role of charge transfer regulator 5311a is threefold, (i) to prevent excessive current from being drawn from the fuel cell stack 5310, (ii) to prevent excessive charging current to flow into buffer 5314, and (iii) to prevent charging the buffer to an unsafe voltage.

The first criteria, preventing excessive currents from flowing in fuel cell stack 5310 depends on the active area A_{FC} of the fuel cell membranes and the design criteria of a safe current density [I_{FC}/A_{FC}]. Selection of a target current density [I_{FC}/A_{FC}] is an iterative process because fuel cell voltage is a function of current density, i.e. V_{FC}=f([I_{FC}/A_{FC}I). Specifically higher current densities reduce a fuel cell's voltage. Despite the voltage sag phenomena, higher current densities also beneficially result in a higher output power but adversely impact self heating, temperature, and reliability. While current densities may run between 200 mA/cm² and 1000 mA/cm², reliability and overheating concerns favor lower current densities, e.g. where [I_{FC}/A_{FC}]=200 mA/cm².

To calculate the fuel cell voltage V_{FC} at a specific current, the precise relationship between fuel cell voltage and current density must be known in advance requiring an ionomeric polymer must first be fabricated and characterized. Because the depends on the chemistry of the polymer and the fabrication process used to synthesize it, there is no practical means to predict its voltage-current behavior a priori. Regardless of the numerical value chosen, once the current density and membrane size is decided, the maximum current of the fuel cell I_{FC}(max) and the instantaneous power output capability of the fuel cell stack is set.

Any current demand exceeding that current value will be electronically limited by the current source 5310a within charge transfer regulator 5311a. Specifically the current capability of the fuel cell therefore has a maximum value of I_{FC}(max) A_{FC} [I_{FC}/A_{FC}]. At this current the corresponding maximum power output of the fuel cell is limited to P_{FC}(max) V_{FC} I_{FC}(max)=V_{FC}A_{FC}[I_{FC}/A_{FC}] where V_{FC} is a function of current. For example, if [I_{FC}/A_{FC}] is selected to be 200 mA/cm² at V_{FC}=0.7V/layer, and cell is designed with A_{FC}=120 cm² then the maximum fuel cell current is

$${I}_{FC} ( max ) \leq {A}_{FC} [ {I}_{FC} / {A}_{FC} ] = ( 120 {cm}^{2} ) [ 200 mA / {cm}^{2} ] = 24 A$$

As such the current limit value for current source 5312a can be present to 24A.

With a nominal μstack voltage of n_{FC}V_{FC}=(12)(0.7V)=8.4V for a fuel cell μstack having n_{FC}=12 layers, the corresponding power output P_{μstack}(max) is

$${P}_{μ stack} ( max ) \leq {m}_{μ stack} ( {V}_{FC} ) ( {I}_{FC} ( max ) ) = 12 ( 0.7 V ) ( 24 A ) = 202 W$$

For a iBFC module comprising three microstacks fuel cell stack voltage is 25.2V and the theoretical peak power output of the fuel cell with only n=36 is PFC=3(202 W)=606 W. If all the μstacks are included the peak power output of the 60s120p array can be increased to 1010 W, i.e. a one kilowatt fuel cell stack. So although the each FC μstack can deliver a peak power of 202 W for short durations, for continuous operation other factors such as heat loss, cooling, and safe buffer charging rates must be considered. These consideration are discussed in the following section. Moreover, because charge transfer regulator 5313 includes a second dependent current source 5313a in series with the first current source 5312a, the maximum fuel cell current I_{FC} entering summing node 5315 is limited by whichever current limit is lower.

The second criteria, to avoid excessive charging currents in the battery is determined by the manufacturer-specified maximum charging C-rate of the cells and the number of parallel strings m_{buf} in the battery buffer but not by the number of buffer cells n_{buf} in series in each string. If we define the max charge rate as [I_{chg}(max)] then the maximum current safely delivered by the current limit for current source 5313

$${I}_{chg} \leq ( {m}_{buf} ) [ {I}_{chg} ( max ) ] \approx ( {m}_{buf} ) [ 2 C ]$$

If we assume a maximum charge rate for a Li-ion cell to be 2C, then for a 3500 mA Li-ion cell the current limit for a single string of six 18650 lithium ion batteries is

$${I}_{chg} ( max ) \leq ( {m}_{buf} ) [ {I}_{chg} ( max ) ] = ( 1 ) [ 7 A ) ] = 7 A$$

and is 14 A for a two-string pack where m_{buf}=2, 21 A for a three-string pack where m_{buf}=3, and so on. If the current limit of current source 5313a is set to 7 A and current source 5312a is set to 24 A, the lower current determines the maximum fuel cell output current. So although the fuel cell can conduct 24A the buffer protection feature limits it to 14A. As such, protective function of fuel cell current source 5312a is unnecessary and meaningless.

Made in accordance with this invention, charge transfer regulator 5311a may comprise only a single current source determined by the more restrictive current limitation of either the fuel cell stack or the buffer. Specifically when I_{FC}(max)>>I_{chg}(max) or more specifically when

A_{FC}[I_{FC}/A_{FC}]>>(m_{buf})[I_{chg}(max)]

then the fuel cell current limiter can be eliminated 5312a and the output current of the fuel cell is determined by buffer protective current source 5313a designed to prevent excessive buffer charging currents. As revealed, high fuel cell current densities and large fuel cell active areas charging a limited number of buffer strings easily can overpower the low C-rate of the buffer and cause buffer damage or fire without appropriate protection.

Conversely made in accordance with this invention, when the rated charging current pf a buffer I_{chg}(max) greatly exceed to current handling ability of a fuel cell, i.e. when I_{FC}(max)>>I_{chg}(max), that is when

(m_{buf})[I_{chg}(max)]>>A_{FC}[I_{FC}/A_{FC}]

then the and the fuel cell current needs to be limited to prevent voltage collapse by choosing a value well below the maximum charging C-rate of the cell. In such cases buffer current source 5313a can be eliminated and the current limiting of current source 5312a may suffice. As the equation suggests, this condition occurs only for extremely small fuel cells or those incapable of operating at higher current densities or when driving extremely large buffers from a small fuel cell, a condition referred to as trickle charging. Such cases may however occur in mobility solutions especially those in avionics and space such as drones, aircraft, spacecraft, and satellites.

In cases where the two fuel cell and buffer currents are comparable both current limiters 5312a and 5313a may be required whereby the circuit must sense, detect, and adjust the current to the applicable limit dynamically as operating condition or circuit topologies change, e.g. in high load or sleep mode conditions. It should be understood by those skilled in the art that the dual current limit function doesn't necessarily require two separate pass elements of control circuits but may involve a single power device whose gate drive is intelligently adjusted to protect the fuel cell and the buffer, whichever is more at risk at the time.

The third protective function of charge transfer regulator 5311a is its voltage clamping ability. In operation voltage feedback from the output of QXR 5201 monitoring the buffer string voltage prevents the overcharging buffer cells to an overvoltage condition V_{buf} >V_{buf}(max)/n_{buf}. Charging of an electrochemical cell or battery beyond its maximum specified voltage can cause electrolyte leakage, fire, or possibly explosion depending on the cell's chemistry. For lithium ion this voltage is approximately 4.2V per cell. Other circuitry is required to make sure all series connected cells maintain the same voltage irrespective of the state-of-charge.

While the charge transfer regulator design of FIG. 451 limits the fuel cell's contribution in supplying high transient load currents, the transient performance of the Li-ion buffers provide some assistance. Specifically, unlike the 2C limited charging rate of a Li-ion cell, the maximum discharge rate of the cells is significantly higher even as high as 10C. If we assume a maximum discharge rate for a Li-ion cell to be 10C, then for a 3500 mA Li-ion cell the discharge current limit for a single string of six 18650 lithium ion batteries is 35 A as given by

$${I}_{dchrg} ( max ) \leq ( {m}_{buf} ) [ {I}_{dchrg} ( max ) ] = ( 1 ) [ 35 A ) ] = 35 A$$

and is 70 A for a two-string pack where m_{buf}=2, and 105 A for a three-string pack where m_{buf}=3, and so on. If the current limit of current source 5313b is previously set to 7 A as limited by 2C charging then during discharging the output of the iBFC become

$${I}_{L} ( max ) = {I}_{FC} ( max ) + {I}_{dchrg} ( max ) = 7 A + 35 A = 42 A where {m}_{buf} = 1$$

which for a 24V pack nominally at V_{buf}=22.8V delivers a 10-second peak output power of Pₒᵤₜ=(22.8V) (42 A)=957.6 kW or nearly a kilowatt. This pulse power condition is limited by heating. Moreover pulling energy out of the buffer lowers it state-of-charge, stored energy and voltage. This loss must be replenished before more high current transients occur.

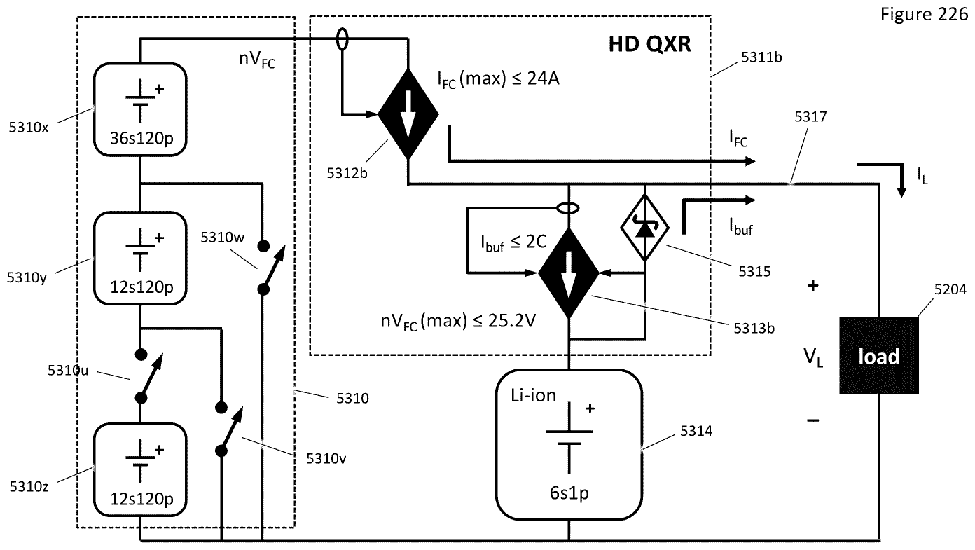

One solution to this problem is to modify the charge transfer regulator 5311 circuit into an inventive heavy duty charge transfer regulator 5311b shown in FIG. 226. This task is accomplished by relocating buffer current limiter 5313a which previously resided in the main current path I_{FC} between battery current limiter 5312 and current summing node 5316. Beneficially by moving the modified current limiter 5313b out of the main I_{FC} current path to a new location between output node 5317 and buffer 5314, limiter 5313b can no longer interfere with the fuel cell directly supplying load 5204 with a higher current. Instead, the current output capability of fuel cell 5310 jumps to 25A or even higher of a larger area fuel cell is used. For example if the fuel cell stack is modified to contain μstacks with 12s240p membranes either by doubling the active area or by placing two 12s240p μstacks in parallel the current out from the fuel cell jumps to 50A.

In its new location, buffer current limiter 5313b still protects buffer 5314 to a maximum charging current of 2C. During discharge, however introduction of a new element limiter bypass ILB circuit 5315 forms a new discharge path antiparallel to buffer current limiter 5313b from buffer 5314 to load 5317 or an intervening buffer load access circuit not shown. In operation, current flowing from fuel cell 5310 into buffer 5314 is limited to 2C per buffer string m_{buf} by current limiter 5313b. The current limiter does not let any appreciable current flow the opposite direction from buffer 5314 to load 5317. Current limiter bypass ILB circuit 5315 however acts like a low-voltage-drop diode allowing current to flow from buffer 5314 to load 5317 but not in the opposite direction. For this reason the device which is actually a power circuit is represented schematic as controlled Schottky rectifier.

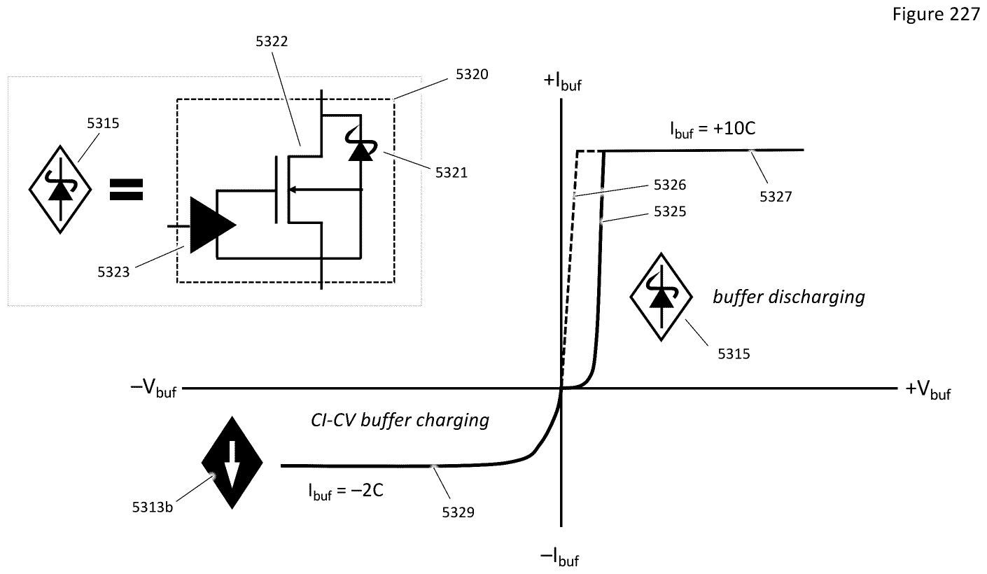

The bidirectional transfer characteristics between the output node 5317 and buffer 5314 are shown in the I-V graph of FIG. 227. In the negative polarity where current flows from the fuel cell 5310 into buffer 5314, the charging current is controlled by buffer current source 5312b to a safe value of −2C per battery string depicted by curve 2329. The charging curve does not mean that a combination of voltage mode and current mode charging is not possible but only that the ‘maximum’ charging current is limited by current limiter 5313b to −2C.

In the converse direction shown in quadrant I where positive discharge current flows out of buffer 5314 to the buffer load access protection and ultimately to load 5314, current limiter bypass ILB circuit 5315 according to diode curve 5325 then jumps to linear curve 5326 as soon as diode current is detected. The low drop is achieved by gate drive 5323 in bypass circuit 5320 turning on low resistance power MOSFET 5322 and shunting current around diode 5321. Bypass circuit 5320 circuit only allows current to flow unidirectionally from buffer 5314 to the output 5317 but not in the opposite polarity. As the current rises too high bypass circuit 5320 may current limit the discharge current to +10C shown by curve 5327.

In this manner current flowing out of the fuel cell is limited only by its specified maximum current density [I_{FC}/A_{FC}], the buffer can participate in supplying current to a load up to +10C all while the maximum charging current of buffer 5314 is limited to −2C. Assuming a single buffer string of lithium ion batteries rated at 3500 mA, the maximum charging rate of the buffer is limited to 2C or 7 A while the μstacks of fuel cells source 24A of current, 7 A of which is used for recharging the buffer with 17A remaining for powering the load. Once the buffer recharges the entire fuel cell output is available to the load as a steady state power limited only by cooling requirements. The steady state current capability of the iBFC without discharging the buffer is then 24 A at a nominal voltage Vₒᵤₜ=22.8V or 547 W per μstack, again limited only be heat management.

In a high current transient a 6s1p buffer string comprising 3500 mA Li-ion cells, the transient discharge current limit for a single string of six 18650 lithium ion batteries is 35 A for up to 10 seconds. Adding that to 24A from the fuel cell delivers a current of I_{load}=24 A+35 A=59 A. At a nominal voltage of 8.4V per μstack, each one delivers a peak power of 496 W per μstack. For a fuel cell comprising only three μstack the total iBFC transient power out is 1488 W, nearly 1.5 kW. If more power on demand is required the circuitry can sense the high currents and increase the stack height to n_{FC}=60 by connecting all the μstacks in series. while limiting the voltage to under 40V. The peak power output than jumps to Vₒᵤₜ=5(40V)=200V. With a current of 59 A, the peak power output is then 11.8 kW.

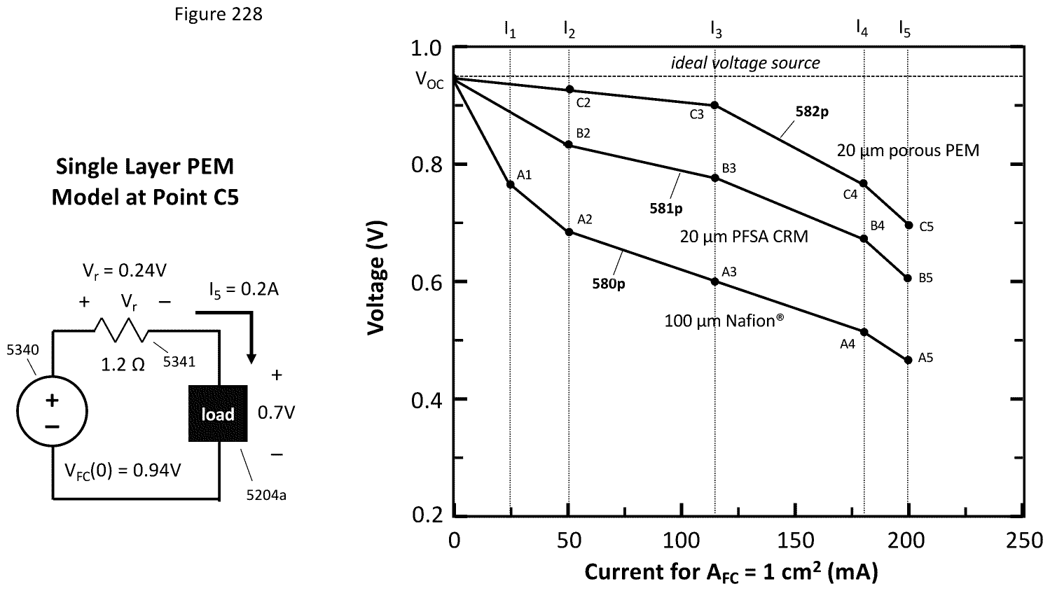

Modelling the electrical characteristics of various dynamic fuel cells starts with calibrating the voltage versus current polarization curve of a fabricated membrane. As shown in the graph of FIG. 228, a comparison of three membrane's characteristics—100 μm Nafion 580p, 20 am composite reinforced membrane (CRM) 581p, and an inventive porous membrane 582p including data point C5 comprises the coordinates V_{FC}=0.7V at a current density of 200 mA/cm². This voltage drop includes both low current activation losses and a resistance of 1.2Ω normalized to a 1 cm² area.

As shown in FIG. 228, this information is sufficient to extract the unloaded voltage V_{FC}(O) of a single layer membrane. Specifically with load 5204a having a voltage V_{L}=0.7V at I_{L}=0.2 A, and the equivalent resistance 5241 of the ionomer at 1.2Ω, the voltage drop V_{R} across the ohmic resistance is 0.24V making the voltage on fuel cell membrane 5340 with V_{FCref}(0)=V_{L}+V_{R}=0.7V +0.24V=0.94V. Once the model is calibrated a range of 24V iBFC modules based on fuel cell μstacks can be designed.

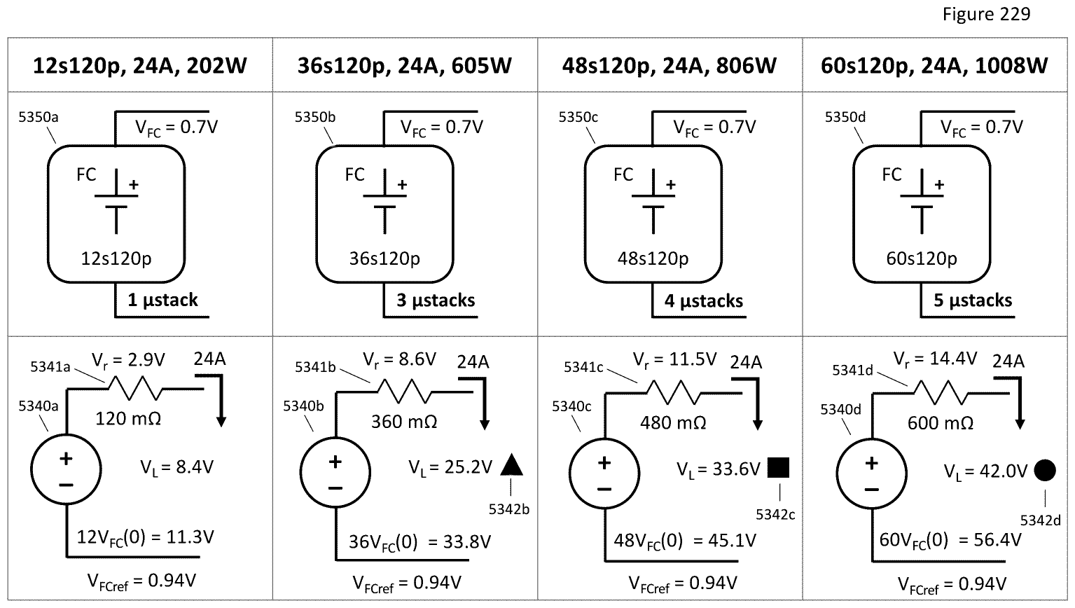

As shown in FIG. 229, basic μstack 5350a comprising a 12s120p design can be designed with a prescribed number of layer n_{FC}, a define area m_{FC}A_{FC}=m_{FC} cm², a single layer parasitic membrane resistance 5341aR_{FC}, a calculated current based on a design current density [I_{FC}/A_{FC}], and an intrinsic open-circuit fuel cell voltage 5340a V_{FC}(0). Accordingly
given a single layer terminal voltage of V_{L}=0.7V, a twelve layer μstack has a voltage of n_{FC}V_{FC}=(12)(0.7V)=8.4V
Given an area A_{FC}=120 cm² and a design criteria current density of [I_{FC}/A_{FC}]=200 mA/cm² the resulting current for the module is I_{FC}=(A_{FC})[FC/A_{FC}] _(120 cm²)[200 mA/cm²]=24 A.
The resistance 5341a of such a module is scaled from the reference model based on the ratio of the number of cells in series and the cross sectional area of the membrane. For a twelve-layer 120 cm² μstack the corresponding resistance R_{μstack}=(n_{FC}/m_{FC})(R_{FC})=(12/120)(1.2Ω)=120 mΩ.
Conducting 24A through a 120 mΩ parasitic resistor 5341 results in a voltage drop Vᵣ across parasitic resistor 5341 in the amount of Vᵣ=I_{FC}R_{μsStack}=(24 A)(120 mΩ)=2.9V. Although this resistance cannot be measured directly as a discrete component in can be confirmed by comparing the open circuit voltage of the cell V_{FC}(0) at the a defined current to the terminal voltage of the μstack.
With a terminal voltage of V_{L}=8.4V and 120 mΩ ohmic losses where Vᵣ=2.9V at I_{FC}=24 A, the open circuit voltage of the μstack is V_{FC}(0)=V_{L}+Vr=8.4V+2.9V=11.3V. The validity of the calculation can be confirmed by comparing to the base design where V_{FC}(0)=11.3V and n_{FC}=12 so that V_{FCref}(0)=V_{FC}(0)/n_{FC}=(11.3V)/(12)=0.94V. This value is consistent with the basic reference model extracted from measured data above.
The power output of the module is P_{L}=(V_{L})(I_{FC})=(8.4V)(24 A)=202 W.
The waste Joule heat generated resistively within the twelve layer module is Pᵣₗₒₛₛ=(I_{FC})(R_{μstack})=(24 A)(120 ml)=2.88 W.
The thermal efficiency of the module at this current is η_{θ}=(P_{L}−Pᵣₗₒₛₛ)/(P_{L})=(202 W−2.88 W)/(202 W)=(199 W)/(202 W)=98.5%
The overall efficiency of the μstack including ohmic and polarization losses is η_{μstack}=V_{L}/V_{FC}(0)=(8.4V)/(11.3V)=74%.
The overall power dissipation in the module is Pₗₒₛₛ=PL (1−η_{μstack})=(202 W)(100%−74%) =52.5 W which is approximately 4.4 W lost in each layer.
To maintain a temperature of T_{μstack}=80° C. in a T_{A}=25° C. ambient, cooling requirements require an overall thermal impedance of θ_{jc}=(T_{μstack}−T_{A})/(Pₗₒₛₛ)=55° C./52.5 W=1.0° C./W. As a reference the junction-to-case thermal resistance of a D₂PAK power package θ_{jc} is 0.4 0.8° C./W.
   This 12s120p μstack conducts 24A generating 202 W of usable power at an efficiency of 74%.

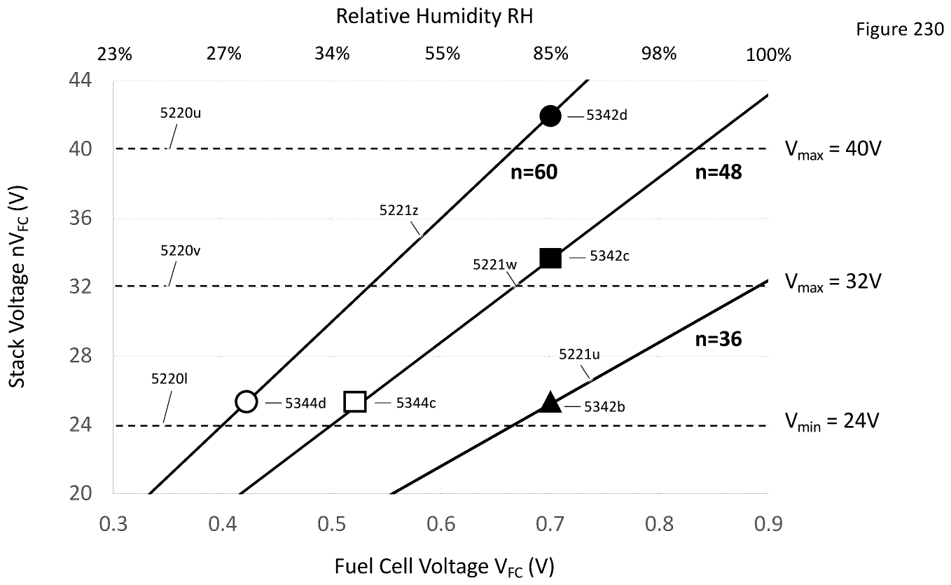

Scaling the one-μstack design 5350a to a 3-μstack design 5350b involves tripling the output voltage to 25.2V, tripling resistance 5341b to 360 mΩ, tripling the value V_{FC}(0) of the open circuit fuel cell voltage 5340b to 33.8V while maintaining a constant output current of 24 A. In such a case, the 3-μstack fuel cell design 5350b forming the basis of its 36s120p fuel cell conducts 24A generating 605 W of usable power at an efficiency of 74%. The power dissipation for each μstack is however no different than the 12s120p μstack 202W design 5250a described previously. The data point 5342b is shown on the stack voltage n_{FC}V_{FC} versus membrane voltage V_{FC} curve of FIG. 230.

Scaling the one-μstack design 5350a to a 4-μstack design 5350c involves quadrupling the output voltage to 33.6V, quadrupling resistance 5341c to 360 mΩ, quadrupling the value V_{FC}(0) of the open circuit fuel cell voltage 5340c to 45.1V while maintaining a constant output current of 24 A. In such a case, the 4-μstack fuel cell design 5350c forming the basis of its 48s120p fuel cell conducts 24 A generating 806 W of usable power at an efficiency of 74%. The power dissipation for each μstack is however no different than the 12s120p μstack 202W design 5250a described previously. The data point 5342c is shown on the stack voltage n_{FC}V_{FC} versus membrane voltage V_{FC} curve of FIG. 230.

Scaling the one-μstack design 5350a to a 5-μstack design 5350d involves pentupling the output voltage to 42.0V, pentupling resistance 5341d to 480 mΩ, pentupling the value V_{FC}(0) of the open circuit fuel cell voltage 5340d to 56.4V while maintaining a constant output current of 24 A. In such a case, the 6-μstack fuel cell design 5350c forming the basis of its 60s120p fuel cell conducts 24A generating 1008 W of usable power at an efficiency of 74%. The power dissipation for each μstack is however no different than the 12s120p μstack 202W design 5250a described previously. The data point 5342d is shown on the stack voltage n_{FC}V_{FC} versus membrane voltage V_{FC} curve of FIG. 230.

Although the design scales to any power level it produces every increasing fuel cell stack voltages, i.e. from 25.2V for a triple μstack, to 33.6V for a quadruple μstack to 42.0V for a pentuple μstack. While 33.6V is still in the target range 5220u of Vₘₐₓ=40V, the five μstack design is a little to high even when V_{FC}=0.7V.

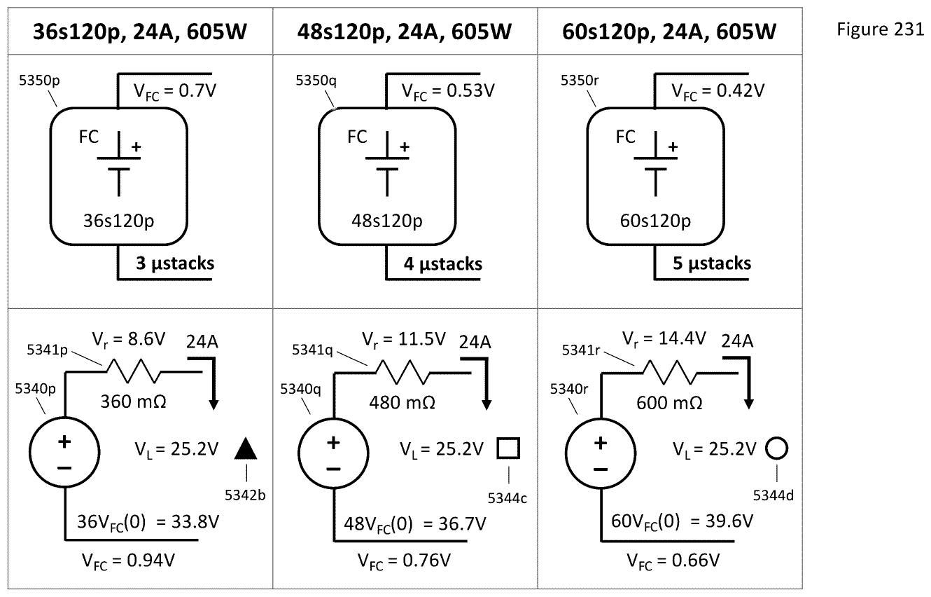

As detailed previously overvoltage above 40V is incompatible for powering a fixed height Li-ion 24V buffer stack. The dynamic fuel cell is able to adjust the number of cell accordingly according to its switch matrix and fuel cell control feature. For example, the proper number of μstacks in order to maintain a constant fuel cell output voltage of 25.2V and a constant output power of 605 W is shown in FIG. 231. To accomplish this the number of μstacks is dynamically switched to compensate for varying environmental conditions and fuel cell voltages V_{FC}.

As shown, three different 605 W, 24 A dynamic fuel cells are compared. In the three μstack 36s120p design 5350p the fuel cell terminal voltage of 25.2V corresponds to a fuel cell voltage of 0.7V with a 360 mΩ resistance 5341p and an open-circuit fuel cell voltage 5340p of 33.8V corresponding to a single layer reference voltage of 0.94V. The 25.2V output and 0.7V single layer fuel cell voltage is depicted as point 5342b on the graph of FIG. 230. The total energy conversion efficiency of the design is 1η_{μstack}=V_{L}/V_{FC}(0)=25.2V/33.8V=75%.

In the four μstack 48s120p design 5350q the fuel cell terminal voltage of 25.2V corresponds to a fuel cell voltage of 0.53V with a 480 mΩ resistance 5341q and an open-circuit fuel cell voltage 5340q of 36.7V corresponding to a single layer reference voltage of 0.76V, generally corresponding to operation in dry conditions or at elevated temperatures. The 25.2V output and 0.53V single layer fuel cell voltage is depicted as point 5344c on the graph of FIG. 230. The total energy conversion efficiency of the design is η_{μstack}=V_{L}/V_{FC}(O)=25.2V/36.7V=69%.

In the five μstack 60s120p design 5350r the fuel cell terminal voltage of 25.2V corresponds to a fuel cell voltage of 0.42V with a 600 mΩ resistance 5341r and an open-circuit fuel cell voltage 5340r of 39.6V corresponding to a single layer reference voltage of 0.66V, generally corresponding to operation in dry conditions or at elevated temperatures. The 25.2V output and 0.42V single layer fuel cell voltage is depicted as point 5344d on the graph of FIG. 230. The total energy conversion efficiency of the design is η_{μstack}=V_{L}/V_{FC}(0)=25.2V/39.6V=64%.

This chart indicates how the number of fuel cells in stack can be adjust by dynamically changing the number of μstacks in the circuit to maintain a minimum and maximum fuel cell stack voltage compatible with safely charging a lithium ion buffer. Although the dynamic fuel cell is slightly less efficient operating at low cell voltage and humidity levels, it is able to function over the entire spectrum down to RH=35% or lower without requiring humidification. The designs described herein can be scaled to high currents and power output levels, e.g. comprising compact 5 kW modules.

Buffered Electrolysis. Like the buffered fuel cell which converts hydrogen into electricity stores generated electric charge, a buffered electrolysis unit performs the inverse function. In this case electric current from the grid or from a PV solar cell is used to charge a buffer comprising an array of lithium ion cells. The energy stored in the buffer is then used to power electrolysis converting water into oxygen and hydrogen. By buffering, the conversion rate can be slowed down to facilitate hydrogen generation during night time or on cloudy days.

Although electrolysis can be performed at a rate contemporaneous with diurnal cycles, storing hydrogen in reasonable volumes requires pressurization. As an embodiment made in accordance with the invention, pressurization of generated hydrogen is performed by absorbing the gas into a hydride and then releasing the gas into a smaller volume at an elevated pressure.

### Glossary

The following is a list of definitions to clarify the terminology used throughout this application. This definition is not intended to be limiting.

Buffered Fuel Cell or BFC—A device combining a Fuel Cell Array, Charge Storage Buffer, and intervening Charge Transfer Regulator capable of electrochemically converting hydrogen or other fuels into electric power and contemporaneously storing the generated electricity in Charge Storage Buffer where energy transfer within the BFC is controlled by the Charge Transfer Regulator.

Charge Balance Circuit or CBC—A system level shunt voltage regulator present across each buffer in a serial string of BFC or iBFCs to ensure balanced charging and a uniform voltage distribution across the BFC stack. The CBC device are controlled by a shared voltage referenced using either DC coupling or galvanically isolated AC coupling to provide high voltage isolation.

Charge Storage Buffer or Electrical Buffer—A low-impedance charge storage device comprising one or more Li-ion cells, batteries, or supercapacitors able to store substantial quantities of electrical charge, and to subsequently deliver the charge to an Electrical Load as a Stiff Voltage Source.

Charge Transfer Regulator or QXR—A power electronic circuit capable of controlling the transfer of charge from a Fuel Cell Array into a Charge Storage Buffer whereby the maximum buffer voltage does not exceed a specified value, and where the transfer current is limited to a value not to exceed some maximum fuel cell current density [I_{FC}/A_{FC}] and not to exceed some maximum buffer charging current or C-rate.

C-rate—A measure of the charge-discharge rate of an electrochemical buffer specified ratiometrically as the buffer's capacity divided by its current or C-rate≡Q_{FC}/I_{buf}.

DC Current Summing Node—The electrical nexus point in a iBFC summing incoming and outgoing charge to the cathode of the charge storage buffer comprising (i) incoming current from the fuel cell array via the QXR, (ii) incoming current from an external electrical power source via the ER module, and/or (iii) outgoing current to an electrical load via the BLA module.

Dynamic Fuel Cell Array—A reconfigurable array of fuel cells where the number n of series connected fuel cells in the stack dynamically varies during operation. Fuel cell topologies may be varied using an analog multiplexer to select varying cell combinations or shunt transistors to bypass dormant cells.

Electrical Buffer—Same as Charge Storage Buffer.

Electrical Load—An electrical load is an electrical component, element, or sub-circuit that consumes electric power converting the electricity into heat, kinetic motion, light, electromagnetic radiation, or storing the absorbed energy as columbic charge through electrochemical reactions. In the context of this application, an electrical load is a device or apparatus powered by a buffer, fuel cell, buffered fuel cell, or intelligent buffered fuel cell.

Electrolysis—The process whereby electric current splits water into hydrogen and oxygen. Electrolysis represents the reverse reaction of that used by a fuel cell to combine hydrogen and oxygen to create electricity.

Fuel—The raw energy source consumed by a fuel cell in non-combustive generation of electricity generally involving a coupled redox reactions comprising catalytic cathodic oxidation followed by anodic reduction producing electricity with water as a byproduct.

Fuel Cell—An electrochemical energy conversion device able to convert fuels such as hydrogen, methane, and glucose into electric current without involving combustion by selectively transporting cations such as H⁺or various anions including divalent oxygen, carbonate, or hydroxide through a liquid or solid electrolyte or PEM membrane.

Fuel Cell Array—A fuel cell array is an electrical network comprising one or more fuel cells connected in series or in parallel where “n” is the number of series connected fuel cells and where “m” is the parallel scaling factor whereby m is the number of discrete fuel cells placed in parallel or the area scaling factor mA_{FC}of a unit sized fuel cell of area A_{FC} typically 1 cm² in size.

Green Hydrogen—Hydrogen produced using renewable energy sources such as solar or wind energy.

iBFC Buffer Load Access—An intelligent energy management feature of an iBFC controlling conduction between the iBFC and an Electrical Load. BLA functions include protecting the buffer against over-discharge, excessive current, and reverse conduction.

iBFC Energy Recovery Module or ER Module—An intelligent energy management feature of an iBFC controlling conduction between the iBFC and external electrical energy sources facilitating power conditioning, protection against excessive voltage and currents, and optimized multi-mode buffer charging. ER Module inputs include DC, galvanically isolated AC, and magnetically coupled inputs.

iBFC Energy Management—An intelligent feature of an iBFC controlling external electrical energy flow comprising an Energy Recovery Module managing energy inflow and a Buffer Load Access Module managing load current conduction.

iBFC Environmental Management—An intelligent feature of an iBFC facilitating humidity control and temperature control.

iBFC Fuel Cell Control—An intelligent feature of an iBFC for controlling the cell topology of a dynamically reconfigurable fuel cell array in accordance with maintaining a prescribed range of fuel cell stack voltages thereby improving buffer charging rates, conserving fuel, increasing the usable humidity range, and lowering the required voltage of the semiconductor fabrication process used to manufacture the QXR.

iBFC Fuel Management Interface or FMI—An iBFC electrical interface for controlling external gas valves, flow controllers, and pressure regulators affecting fuel supplies to the iBFC including the ability to cutoff fuel to dormant, disable, or bypassed iBFC modules.

iBFC Humidity Control—An intelligent environmental management feature of an iBFC controlling the humidity in the fuel cell and its gas supplies through humidification in dry ambient conditions and desiccation in high humidity atmospheres.

iBFC System Control—Microcontroller based host for intelligent functions in the iBFC including internal and external communication buses carrying control and sensing data packets.

iBFC Temperature Control—An intelligent environmental management feature of an iBFC for preventing excessively hot or cold temperatures in a fuel cell array through active heating and cooling of the fuel cell assembly and gas supply to extend the usable temperature range of the iBFC.

Intelligent Buffered Fuel Cell or iBFC—A Buffered Fuel Cell augmented by intelligent modules for Fuel Cell Control, Environmental Management, Energy Management, and iBFC System Control including internal and external communications.

μstack—A μstack or microstack in a fuel cell comprising a limited number of layers producing a low voltage such as 6V-to-8V which can be series connected to make 24V and 400V iBFCs with limited heat dissipation per μstack.

Parallel iBFC Charging—The concurrent charging of stacked iBFC modules using a galvanically-isolated parallel charging of stacked iBFC modules to avoid electric shock risks.

Proton Exchange Membrane or PEM—A porous polymeric membrane used in room temperature fuel cells able to transport positive ions but suppress electron conduction in hydrogen fuel cells.

nsmp Fuel Cell Topology—A description of an array of fuel cells comprising a stack of n series connected cells and m parallel cells. Parallel cells may be discrete, merged into a a single area mA_{FC}, or divided into multiple cells of differing areas, e.g., m₁ A_{FC}, m₂ A_{FC}, etc,

Series iBFC Charging—The concurrent charging of stacked iBFC modules using a DC current loop controlled by a single ER Module and Multi-mode charger. For reasons of safety, direct DC charging is limited to under 100V. Charging at voltages over 42V requires UL safety approval.

Stiff Voltage Source—A electrical voltage source whose voltage does not significantly decline with increased current conduction either because of ohmic or electrochemical polarization losses.

QXR Current Limiter—A unique function of the QXR charge transfer regulator able to limit currents between the fuel cell array and charge storage buffer in order to prevent excessive current (i) in the fuel cell exceeding a specified maximum current density [I_{FC}/A_{FC}], e.g., at 200 mA/cm², (ii) excessive buffer charging currents, e.g., 2C per paralleled Li-ion cell, or (iii) both, whichever one is more limiting. Regardless of which current limits condition, the resulting maximum current Iₘₐₓ may also be used during constant current CI-mode linear charging or in as the maximum pulse current in PWM charging methods.

QXR Voltage Clamp—A safety function of the QXR preventing the fuel cell array from overcharging the buffer to a potential of V_{OC}, the overcharge voltage of a cell, e.g., 4.2V for a Li-ion cell. As a series pass MOSFET interposed between the fuel cell array and the buffer, the QXR is incapable of protecting the buffer from overcharging from power from an external electrical source delivered into the iBFC's DC summing node via ER module.

usvp Buffer Topology—A description of an array of discrete buffers comprising “u” series connected buffer cells each further comprising “v” parallel connected buffers. The term u can also refer to a series stack of iBFC modules.

Feature Descriptions. The following section articulates features and several key elements of the disclosed methods and apparatus. The sections are broken into six exemplary sets of related inventive concepts and implementations. The descriptions not intended to be exhaustive nor limiting.

Apparatus Features—Set 1. This set of features describes elements of BFC and dynamic fuel cell operation including a variable width variable series stack of fuel cells powering a single electrochemical cell, an array of series connected cells, an array of parallel connected cells, or a parallel array of series connected cells.

A buffered fuel cell device or BFC comprises a fuel cell array, a charge transfer regulator, and an electrical buffer where; the fuel cell array comprises an array of one-or-more fuel cells connected in parallel and where the parallel-connected fuel cells are connected electrically in series into a fuel cell stack, the QXR charge transfer regulator comprises a current-limiting voltage clamp, the electrical buffer comprises one or more parallel-connected electrochemical cells able to store charge and deliver current to an electrical load, wherein the maximum QXR current is limited in magnitude by the fuel cell's specified output current capability or by the maximum charging current of the buffer cell whichever one is lower; and the maximum output voltage of the QXR is limited to a potential below the specified overcharge voltage V_{OC} of the electrochemical buffer cell.

Other features of the BFC include a device where the fuel cell comprises a proton exchange membrane and optionally where
The fuel comprises hydrogen.
The fuel comprises an organic or hydrocarbon compound such as methane, natural gas, or glucose.

Other features of the BFC include a device where the fuel cell comprises an anion exchange membrane and optionally where
The fuel comprises a source of hydroxyl ions such as KOH.
The fuel comprises an organic or hydrocarbon compound such as methane, natural gas, or glucose.

Other features of the BFC include a device where the fuel cell where the total number of series connected fuel cells in the array may be fixed or may vary dynamically during use and optionally where
The number of series connected cells in the fuel cell stack is adjusted in accordance with the fuel cell stack voltage nV_{FC} where n is the number of fuel cells connected in series.

Other features of the BFC include a device where the fuel cell where the maximum QXR current is limited to a value equal to the multiplicative product of the fuel cell area mA_{FC} and a specified maximum current density [I_{FC}/A_{FC}] and optionally where
The specified maximum current density [I_{FC}/A_{FC}] is 200 mA/cm².
The specified maximum current density [I_{FC}/A_{FC}] is 600 mA/cm².

Other features of the BFC include a device where the fuel cell where the electrochemical buffer cell comprises at least one lithium ion battery and optionally where
The maximum QXR current is limited to a 2C charging rate per paralleled cell.
The 2C charging rate is 6 A for a single 3000 mAh cell, 8 A for a single 4000 mAh cell, 12 A for two parallel 3000 mAh cells, and 16 A for a two parallel 4000 mAh cells.
The maximum QXR output voltage V_{buf} is limited to 4.2V
The fuel cell stack voltage nV_{FC} must exceed the nominal buffer cell voltage Vₙₒₘ of 3.6V in order to charge the buffer.

Other features of the BFC include a fuel cell where the electrochemical buffer cell comprises at least one sodium ion battery and optionally where
The maximum QXR output voltage is limited to 3.7V

Other features of the BFC include a electrical topology of the fuel cell stack may be fixed or varied dynamically including changing the number of series connected cells in the stack, the number of parallel fuel cells or equivalent area thereof, or both.

A dynamic fuel cell array comprises of an array of n series-connected fuel cells, whereby the fuel cell stack voltage nV_{FC} is maintained within a specified range by dynamically varying the number of fuel cells in the series circuit using one or more MOSFET switches.

Other features of a dynamic fuel cell include a device where unused fuel cells in the series connected fuel cell stack are shunted by MOSFET switches.

Other features of a dynamic fuel cell include a device where fuel cells are included in or exclude from the series fuel cell stack by an analog multiplexer comprising two or more MOSFET switches.

Other features of a dynamic fuel cell include a device where the output of the dynamic fuel cell array is connected to a electrochemical buffer through a QXR charge transfer regulator comprising a current-limiting voltage clamp.

Apparatus Features—Set2. This set of features describes elements of BFC and QXR operation.

A QXR charge transfer regulator charges an electrochemical buffer from a fuel cell array using multi-mode charging comprising constant current CI-mode charging and constant voltage CV-mode charging where the input voltage to the QXR is a function of fuel cell current.

Other features of a BFC and QXR includes switches able to dynamically change the fuel cell topology to charge fuel cell width mA_{FC} and current capability mA_{FC}[I_{FC}/A] where [I_{FC}/A] is the specified operating current density for the fuel cell.

Other features of a BFC and QXR include a buffer biased at a voltage below a minimum specified voltage Vₘᵢₙ whereby the QXR charges the buffer at a trickle current comprising a fraction of the CI-mode charging current.

Other features of a BFC and QXR comprise a QXR which charges the buffer cell at a constant current limited by the current of the fuel cell array to a value mA_{FC}[I_{FC}/A] where mA_{FC} is the area of the fuel cell and [I_{FC}/A] is its specified operating current density.

Other features of a BFC and QXR comprise a QXR which charges the buffer cell at a constant current limited by the maximum charge rate of the buffer at 2C per parallel buffer cell, and optionally where
the buffer comprises one 18650 lithium ion cell charged at a current up to 6 A or one 21700 lithium ion cell charged at a current up to 8 A.
the buffer comprises two parallel 18650 lithium ion cells charged at a total current up to 12 A or two parallel 21700 lithium ion cell charged at a total current up to 16 A.

Other features of a BFC and QXR comprise a CI-mode charger using linear current control.

Other features of a BFC and QXR comprise a CI-mode charger using a current-limited pulsed charger.

Other features of a BFC and QXR comprise a CV-mode constant voltage charger specified to a target voltage not to exceed a buffer's overcharge voltage V_{OC} and optionally where
the QXR comprises CV-mode charger using linear current control.
the QXR comprises CV-mode charger using a current-limited pulsed charger.

Other features of a BFC and QXR where the transistor controlling the CI-mode charging current is connected in series with a second transistor controlling the CV-mode charging current.

Other features of a BFC and QXR where the transistor controlling the CI-mode charging current is connected in parallel with a second transistor controlling the CV-mode charging current.

Other features of a BFC and QXR where the transistor controlling the CI-mode charging current is the same transistor controlling the CV-mode charging current.

Other features of a BFC and QXR where the fuel cell stack voltage nV_{FC} exceeds the overcharge voltage V_{OC} in order to fully charge a buffer.

Other features of a BFC and QXR where the fuel cell stack voltage nV_{FC} exceeds the nominal buffer voltage Vₙₒₘ in order to commence charging of a 1s buffer, or exceeds uVₙₒₘ in the case of “u” series connected buffers.

Other features of a BFC and QXR where the fuel cell is power by compressed hydrogen where a pressure regulator reduces the pressure of the gas in the fuel cell chamber.

Other features of a BFC and QXR where the fuel is contained in a canister at a pressure of 179 bar or higher.

Other features of a BFC and QXR where the voltages of the fuel cell stack nV_{FC} and the buffer V_{buf} or uV_{buf} in the case of series connected buffers are measured when the QXR is biased into an open circuit off state, and optionally where
the voltage is measured by an analog-to-digital converter and supplied to a microcontroller, the fuel cell control module, or through a communication bus to the system.
the measured voltage is used to dynamically reconfigure the fuel cell array topology for charging performance and fuel efficiency and further may include a device where the measured voltage is used to dynamically bypass or disconnect specific fuel cells from the array and optionally to cutoff the fuel supply to the disabled or dormant fuel cells.

Apparatus Features—Set 3. This set of features describes elements of iBFC with environmental regulation.

A buffered fuel cell comprising a fixed or dynamically reconfigurable array of fuel cells, an electrochemical buffer, and a charge transfer regulator controlling the charging of the buffer comprising current from the fuel cell array, where environmental conditions of the fuel cell and its fuel supply are actively regulated by functions within an intelligent buffered fuel cell module.

Other features of an iBFC where the fuel cell environmental conditions are regulated or modified using electrical power delivered by iBFC's electrical buffer.

Other features of an iBFC where the environmental control comprises a humidifier able to increase the water vapor in fuel cell, in its fuel supply such as hydrogen gas, and/or in its reducing agent such as air or oxygen supply and optionally where
the humidifier becomes active when relative humidities fall before a specified level determined by the fuel cell stack voltage nV_{FC} for a given fuel cell current density [I_{FC}/A]including cases where the humidifier becomes active the relative humidity drops below 40%, or where the water used by the humidifier is supplied by heating a solid containing absorbed or adsorbed water, releasing it into the fuel cell or its gasses.
the water used by the humidifier is supplied by a reservoir of liquid water including the case where the water stored in the reservoir is an effluent of fuel cell operation.

Other features of an iBFC where environmental control comprises a de-humidifier able to decrease water vapor in fuel cell, in its fuel supply, and/or in its gaseous reducing agent such as oxygen and optionally where
the humidity is reduced by using a condenser cooled to condense and remove water vapor from fuel cell gasses.
the humidity is reduced by diverting gas over a desiccant comprising a solid hydrophilic compound which absorbs or adsorbs water vapor from gasses.
de-humidification occurs above 70% relative humidity and only for fuel cells operating at current densities [I_{FC}/A] exceeding 600 mA/cm².

Other features of an iBFC where environmental control comprises active cooling to prevent fuel cell overheating.

Other features of an iBFC where air or liquid coolant conducted through elements of the fuel cell passes into a heat exchanger cooling the fluid transferring excess heat into the surrounding ambient, and optionally where
the heat exchanger is an air conditioner unit comprising a compressor, evaporator, and circulating refrigerants.
the heat exchanger is a solid state cooling thermoelectric device such as a Peltier junction.
active cooling is performed above 40° C.
active cooling is controlled by measuring the temperature in the ambient or within the fuel cell using a thermocouple or solid state temperature sensor like a P-N junction diode.

Other features of an iBFC where environmental control comprises active heating to enhance conversion efficiency at low temperatures and prevent freezing of residual water in the ion exchange membrane and optionally where
air or liquid coolant conducted through elements of the fuel cell passes into a heater or heat exchanger warming the fluid.
a resistive heater heats the fluid.
the heater is an HVAC unit transferring heat from an engine or from combustion.
the heater is an heat exchanger transferring heat absorbed from sunlight.
the heater is a solid state cooling thermoelectric device such as a Peltier junction.
a heater is activated at temperatures below 10° C.
active heating is controlled by measuring the temperature in the ambient or within the fuel cell using a thermocouple or solid state temperature sensor like a P-N junction diode including where the temperature of the fuel cell is regulated using thermal feedback to control heating.
where a heat pulse is used to thaw frozen water in the fuel cell during fuel cell startup after which the heater is disabled.

Apparatus Features—Set 5. This set of features describes elements of iBFC with energy recovery and pluggable power capability.

A buffered fuel cell comprising a fixed or dynamically reconfigurable array of fuel cells, an electrochemical buffer, and a charge transfer regulator controlling the charging of the buffer with current from the fuel cell array, which includes an ER module comprising one or more electrical inputs for charging the buffer.

Other features of an iBFC with an ER input where the ER module may include a DC input, and AC input, a wireless charging magnetic input, or some combination thereof and optionally where
an ER module's wireless charger input comprises a magnetic transmitter with a large area coil modulated by an AC power source and a corresponding magnetic receiver with a second large-area coil forming an air-core transformer whose output is rectified and filtered into a DC source.
the ER module's AC-power input connects power directly from a generator, DC-to-AC inverter, or windmill into its electrical input which is rectified and filtered into a DC source.
the ER module includes a galvanically-isolated AC power input from the AC mains, AC generator, DC-to-AC inverter, or windmill into its electrical input which is rectified and filtered into a DC source.
the ER module's DC input may comprise any DC source including photovoltaic panels, battery packs, DC generator outputs, or rectified regenerative power from the motor braking.
the iBFC's buffer prevents excessive input current by a voltage clamped fuse comprising a Zener diode and wire fuse or resettable electronic fuse to deliver failsafe input protection.

Other features of an iBFC with an ER input where the ER module includes a battery disconnect function providing protection against overcurrent above over-current shutdown I_{OCSD}, overvoltage above overcharge voltage V_{buf} >V_{OC}, reverse current where I_{RPE}<0, and optionally against over-discharge when V_{buf} Vₘᵢₙ in various combinations and at programmable values and optionally where
the ER module conduction between the electrical power input and the buffer is controlled by a pass transistor comprising a power MOSFET and its associated drive circuitry able to conduct current unidirectionally in its on state but block conduction bidirectionally in its off state.

Other features of an iBFC with an ER input where the ER module includes dual-mode or tri-mode charger including trickle charging, constant current CI-mode charging, and constant-voltage CV-mode charging, separately and distinct from the functions of the QXR.

A buffered fuel cell comprising a fixed or dynamically reconfigurable array of fuel cells, an electrochemical buffer, and a charge transfer regulator controlling the charging of the buffer with current from the fuel cell array, which includes a buffer load access BLA module controlling the current flow between the buffer and an electrical load.

Other features of an iBFC with BLA where the BLA module prevents excessive current from being delivered from the buffer to a load either by limiting the load current I_{L} to a defined current Iₛₐₜ or interrupting conduction altogether in the case of a shorted load whereby I_{L}=0.

Other features of an iBFC with BLA where BLA conduction between the buffer and the load is controlled by a pass transistor comprising a power MOSFET and its associated drive circuitry able to conduct current unidirectionally in its on state but block conduction bidirectionally in its off state.

Other features of an iBFC with BLA where BLA conduction between the buffer and the load can be externally controlled through a communication bus and interface.

Other features of an iBFC with BLA where the BLA interrupts, i.e., disconnects, conduction between the buffer and an electrical load and optionally where
current is shunted, i.e., diverted around a disconnected buffered fuel cell by a bypass power MOSFET including the cas where inactive or shunted fuel cells are cutoff from the gaseous fuel supply.

An electrical stack of two-or-more BFC buffered fuel cell modules in series using an anode-to-cathode totem-pole circuit topology, and where each buffered fuel cell comprises a fuel cell, a CXR, and a buffer.

Other features of a stacked BFC where the charge present on each fuel cell is maintained and balanced electrically to match the voltage of other buffer cells in the series string using circuitry to divert charging current around cells that are charged to a higher voltage than others including where
the voltage of the series-connected buffered fuel cells is balanced using a shunt regulator and a shared DC voltage reference to ensure each buffer voltage matches the other cells in the string.
the voltage of a fuel cell in a string of series connected buffered fuel cells is balanced with other fuel cells in the string as determined by a shunt regulator and a shared DC voltage reference, whereby the DC reference is converted to an AC voltage, transferred via transformer, and then converted back into a DC voltage reference.

Other features of a stacked BFC where each BFC includes its own dedicated buffer load access module controlling energy flow between the BFC stack and an electrical load.

Other features of a stacked BFC where the series string of BFCs share a single buffer load access module controlling energy flow between the BFC stack and an electrical load.

Other features of a stacked BFC where the series-connected BFC each include a dedicated ER module as an electrical input for electrical charging of the buffer via a charging circuit separate and distinct from the BLA load connection powering an electrical load, optionally where
the series-connected BFC modules can be charged from an external power source converted into AC and transformer coupled into every BFC for concurrent charging.
all BFC voltages are balanced to the same value by sharing a common galvanically isolated reference voltage.
the electrical load is a motor and where the incoming power is regenerative energy from motor braking.
the BFC stack powers an electrical load and where the incoming power comes from pluggable power of the AC mains.
the BFC stack powers an electrical load where the incoming power comes from a combination of electrical power generated from a solar converter and from hydrogen created from electrolysis of water either from photovoltaic electricity or solar heat converted by turbine and generator into electricity, both of which may be used by electrolysis of water to create hydrogen to power the iBFC fuel cells.
every iBFC module is powered from its own dedicated secondary winding in a multi-winding power transformer powered by a single AC primary. including the case where the AC transformer operates at a frequency between 50 Hz and 60 Hz and the case where the AC transformer operates at a frequency higher than 60 Hz.

Method Features—Set 5. This set of features describes methods, algorithms, and processes used in BFC buffered fuel cell and in an intelligent buffer cell for managing currents and voltages.

A method for generating and storing electric charge comprising a fixed topology or electrically reconfigurable array of fuel cells used to charge an array of one or more electrochemical buffer cells through an intervening QXR charge transfer regulator where; the QXR limits the magnitude of buffer charging current to mA_{FC}[I_{FC}/A] where [I_{FC}/A] is the specified operating current density for the fuel cell and mA_{FC} is the area of the fuel cell; or the QXR limits the magnitude of buffer charging current to some specified current or charge rate; or where the QXR limits the buffer voltage V_{buf} to a value not to exceed V_{OC}, whichever of the foregoing criteria is most limiting.

Other charging methods include a BFC where the fuel cell comprises a proton exchange membrane and optionally where
the fuel comprises hydrogen
the fuel comprises an organic or hydrocarbon compound such as methane, natural gas, or glucose.

Other charging methods include a BFC where the fuel cell comprises a anion exchange membrane and optionally where
the fuel cell comprises an anion exchange membrane.
the fuel comprises a source of hydroxyl ions such as KOH.
the fuel comprises an organic or hydrocarbon compound such as methane, natural gas, or glucose.

Other charging methods comprise a BFC where the total number of series connected fuel cells in the array may vary dynamically during use.

Other charging methods comprise a BFC where the specified maximum current density [I_{FC}/A_{FC}] is 200 mA/cm².

Other charging methods comprise a BFC where the specified maximum current density [I_{FC}/A_{FC}] is 600 mA/cm².

Other charging methods comprise a BFC where the electrochemical buffer cell comprises at least one lithium ion battery, and optionally where
the maximum QXR output voltage V_{buf} is limited to 4.2V.
the fuel cell stack voltage nV_{FC} must exceed the nominal buffer cell voltage Vₙₒₘ of 3.6V in order to charge the buffer where n is the number of active fuel cells connected in series

Other charging methods comprise a BFC where the maximum QXR current is limited to a 2C charging rate per paralleled cell, and optionally where
the 2C charging rate is 6 A for a single 3000 mAh cell, 8 A for a single 4000 mAh cell, 12 A for two parallel 3000 mAh cells, and 16 A for a two parallel 4000 mAh cells.

Other charging methods comprise a BFC where where the electrochemical buffer cell comprises at least one sodium ion battery, and optionally where
the maximum QXR output voltage is limited to 3.7V.

Other charging methods comprise a BFC where the QXR is temporarily disabled conducting no current to accommodate independent measurement the fuel stack voltage and the buffer voltage.

Other charging methods comprise a BFC where the number of series connected cells “n” is decreased by 1 whenever the series stack voltage nV_{FC} exceeds a maximum value Vₘₐₓ and where the number of series connected cells “n” is increased by 1 whenever the series stack voltage nV_{FC} falls below a minimum value V_{OC}, nd optionally where
unused fuel cells in the series connected fuel cell stack are shunted by MOSFET switches.
fuel cells are included in or excluded from the series fuel cell stack by an analog multiplexer comprising two or more MOSFET switches.

Method Features—Set 6. This set of features describes methods, algorithms, and processes used in BFC buffered fuel cell for charging and for environmental control.

A method for charging an electrochemical buffer from a dynamically reconfigurable fuel cell array where the fuel cell voltage is a function of current using a QXR charge transfer regulator to perform multi-mode charging where; commencing below a specified buffer cell voltage, charging is performed sequentially starting with constant current CI-mode charging and terminating with constant voltage CV-mode charging; wherein, in CI-mode buffer charging is performed at constant current equal to the lower of either a buffer charge rate of 2C per parallel cell or a fuel cell current of mA_{FC}[I_{FC}/A] where mA_{FC} is the fuel cell area and [I_{FC}/A] is specified maximum current density for the fuel cell; and in constant voltage CV-mode charging terminates at a voltage not to exceed the buffer's overcharge voltage V_{OC}.

Other charging methods for a reconfigurable iBFC where charging of a buffer cell below a defined voltage Vₘᵢₙ is performed by the QXR using trickle charging comprising constant current charging at a magnitude which is a fraction of the CI-mode current.

Other charging methods for a reconfigurable iBFC where the CI-mode charging uses linear current control.

Other charging methods for a reconfigurable iBFC where the CI-mode charging uses current-limited pulsed charging.

Other charging methods for a reconfigurable iBFC where CV-mode charging uses linear current control.

Other charging methods for a reconfigurable iBFC where CV-mode charging uses current-limited pulsed charging.

Other charging methods for a reconfigurable iBFC where the transistor controlling CI-mode charging current is connected in series with a second transistor controlling the CV-mode charging current.

Other charging methods for a reconfigurable iBFC where the transistor controlling CI-mode charging current is connected in parallel with a second transistor controlling the CV-mode charging current.

Other charging methods for a reconfigurable iBFC where the transistor controlling the CI-mode charging current is the same transistor controlling the CV-mode charging current.

Other charging methods for a reconfigurable iBFC involving a charging sequence starting by interrupting QXR conduction, measuring the voltages of the fuel cell stack and buffer, reconfiguring the cell array, retesting, and if required activating environmental controls, then commencing charging.

Other charging methods for a reconfigurable iBFC where charging commences by activating a watchdog timer and restarts the entire charging sequence when the timer expires.

A method to dynamically reconfigure a fuel cell array where the QXR is turned off disconnecting it from the buffer, all bypass transistors are turned off, the fuel cell stack voltage nV_{FC} is measured, whereby; if nV_{FC}>Vₘₐₓ the number of cells is decremented, the fuel cell stack voltage nV_{FC} is measured again and rechecked if nV_{FC}>Vₘₐₓ and if nV_{FC}<Vₘₐₓ, the QXR is activated and charging of the buffer commences.

Other methods to dynamically reconfigure a fuel cell array where the buffer comprises a lithium ion or sodium ion electrochemical cell.

Other methods to dynamically reconfigure a fuel cell array where the buffer comprises a lithium ion or sodium ion electrochemical cell.

Other methods to dynamically reconfigure a fuel cell array where the buffer where the buffer comprises a supercapacitor.

A method for expanding the environmental operating range of a buffered fuel cell comprising a dynamically reconfigurable fuel cell array, an electrical buffer, and a charge transfer regulator, to actively control or regulate humidity and temperature.

Other methods to extend the range of a dynamically reconfigurable fuel cell where a humidifier is activated to increase water vapor in the fuel cell in the event that either; the humidity measured by a sensor determines the relative humidity is too low; or the measured fuel cell stack voltage nV_{FC} is too low resulting from operating in an arid environment; where the humidifier increases water vapor in the fuel cell by evaporating water from a fluid reservoir or by heating water retaining solids, and optionally where
humidification commences whenever the relative humidity drops below 40%.

Other methods to extend the range of a dynamically reconfigurable fuel cell where the temperature of the fuel cell is temperature regulated using a coolant flowing through the plates of the fuel cell and into a heat exchanger, and optionally where
the active cooling commences for any temperature in excess of 40° C.
where the active heating commences for any temperature below 10° C.

Other methods to extend the range of a dynamically reconfigurable fuel cell where the fuel cell is momentarily heated to melt ice crystals when at startup by a heater whenever the temperature is at or below 0° C.

I claim:

1. A buffered fuel cell device comprising a fuel cell array, a QXR charge transfer regulator, and an electrical buffer wherein:
the fuel cell array comprises an array of one-or-more fuel cells connected in parallel and wherein the parallel-connected fuel cells are connected electrically in series into a fuel cell stack;
the QXR charge transfer regulator comprises a current-limiting voltage clamp;
the electrical buffer comprises one or more parallel-connected electrochemical cells able to store charge and deliver current to an electrical load, and wherein
a maximum QXR current in the QXR charge transfer regulator is limited in magnitude a specified output current capability of the fuel cell array or by a maximum charging current of an electrochemical cell in the electrical buffer, whichever is lower; and
a maximum output voltage of the QXR charge transfer regulator is limited to a potential that is lower than a specified overcharge voltage V_{OC} of the electrochemical buffer cell.

2. The buffered fuel cell device of claim 1 wherein the fuel cell comprises a proton exchange membrane.

3. The buffered fuel cell device of claim 2 wherein the fuel comprises hydrogen.

4. The buffered fuel cell device of claim 2 wherein the fuel comprises an organic or hydrocarbon compound such as methane, natural gas, or glucose.

5. The buffered fuel cell device of claim 1 wherein the fuel cell comprises an anion exchange membrane.

6. The buffered fuel cell device of claim 5 wherein the fuel comprises a source of hydroxyl ions such as KOH.

7. The buffered fuel cell device of claim 5 wherein the fuel comprises an organic or hydrocarbon compound such as methane, natural gas, or glucose.

8. The buffered fuel cell device of claim 1 wherein the total number of series connected fuel cells in the array may be fixed or may vary dynamically during use.

9. The buffered fuel cell device of claim 8 wherein the number of series connected cells in the fuel cell stack is adjusted in accordance with the fuel cell stack voltage nV_{FC} where n is the number of fuel cells connected in series.

10. The buffered fuel cell device of claim 1 wherein the maximum QXR current is limited to a value equal to the multiplicative product of the fuel cell area mA_{FC} and a specified maximum current density [I_{FC}/A_{FC}].

11. The buffered fuel cell device of claim 10 wherein the specified maximum current density [I_{FC}/A_{FC}] is 200 mA/cm².

12. The buffered fuel cell device of claim 10 wherein the specified maximum current density [I_{FC}/A_{FC}] is 600 mA/cm².

13. The buffered fuel cell device of claim 1 wherein the electrochemical buffer cell comprises at least one lithium ion battery.

14. The buffered fuel cell device of claim 13 wherein the maximum QXR current is limited to a 2C charging rate per paralleled cell.

15. The buffered fuel cell device of claim 14 where the 2C charging rate is 6 A for a single 3000 mAh cell, 8 A for a single 4000 mAh cell, 12 A for two parallel 3000 mAh cells, and 16 A for a two parallel 4000 mAh cells.

16. The buffered fuel cell device of claim 13 wherein the maximum output voltage of the QXR charge transfer regulator is limited to 4.2V.

17. The buffered fuel cell device of claim 13 wherein a fuel cell stack voltage nV_{FC} must exceed a nominal buffer cell voltage Vₙₒₘ of 3.6V in order to charge the buffer.

18. The buffered fuel cell device of claim 1 wherein the electrochemical buffer cell comprises at least one sodium ion battery.

19. The buffered fuel cell device of claim 18 wherein the maximum QXR output voltage is limited to 3.7V.

20. The buffered fuel cell device of claim 1 wherein the electrical topology of the fuel cell stack may be fixed or varied dynamically including changing the number of series connected cells in the stack, the number of parallel fuel cells or equivalent area thereof, or both.

21. A dynamic fuel cell array comprising of an array of n series-connected fuel cells, whereby a fuel cell stack voltage nV_{FC} is maintained within a specified range by dynamically varying the number of fuel cells in the series circuit using one or more MOSFET switches.

22. The dynamic fuel cell array of claim 21 wherein unused fuel cells in the series connected fuel cell stack are shunted by MOSFET switches.

23. The dynamic fuel cell array of claim 21 where fuel cells are included in or exclude from the series fuel cell stack by an analog multiplexer comprising two or more MOSFET switches.

24. The dynamic fuel cell array of claim 21 where the output of the dynamic fuel cell array is connected to a electrochemical buffer through a QXR charge transfer regulator comprising a current-limiting voltage clamp.
